(19) United States
(12) Patent Application Publication
(10) Pub. No.: US 2026/0015464 A1
(43) Pub. Date: Jan. 15, 2026

(54) COMPOUND, SURFACE TREATMENT AGENT, ARTICLE, AND METHOD FOR MANUFACTURING ARTICLE

(71) Applicant: AGC Inc., Tokyo (JP)

(72) Inventors: Hironobu SAKAGUCHI, Tokyo (JP); Yasuhiro HIRATA, Tokyo (JP); Eiichiro ANRAKU, Tokyo (JP); Hikaru ONO, Tokyo (JP); Koki WATANABE, Tokyo (JP); Shiori KAWAKAMI, Tokyo (JP); Keigo MATSUURA, Tokyo (JP); Motoshi AOYAMA, Tokyo (JP)

(73) Assignee: AGC Inc., Tokyo (JP)

(21) Appl. No.: 19/338,020

(22) Filed: Sep. 24, 2025

Related U.S. Application Data
(63) Continuation of application No. PCT/JP2024/011428, filed on Mar. 22, 2024.

(30) Foreign Application Priority Data
Mar. 27, 2023 (JP) 2023-050546

(51) Int. Cl. C08G 77/385; B05D 1/02; B05D 5/08; B05D 7/00; C09D 5/16

(52) U.S. Cl. CPC C08G 77/385; B05D 1/02; B05D 5/08; B05D 7/56; C09D 5/1625

(57) ABSTRACT

A compound capable of forming a surface layer excellent in oil repellency, a surface treatment agent containing such a compound, an article having a surface layer formed of such a compound, and a method for manufacturing such an article are provided. A compound according to the present invention is represented by (R^{f1}-L²)_{y1}-L³-R¹-L¹-(R²-T¹)ₓ₁. R^{f1} is a fluorine-containing group; L² is a single bond or a divalent linking group; L³ is an organopolysiloxane residue having a valence of 1+y1; R¹ is a single bond, a fluoroalkylene group, an alkylene group, or an alkylene group containing an etheric oxygen atom; L¹ is a single bond or a group having a valence of 1+x1; R² is an alkylene group or an alkylene group containing an etheric oxygen atom; T¹ is a reactive group; y1 is an integer of 1 or greater; and x1 is an integer of 1 to 10.

### INCORPORATION BY REFERENCE

This application is based upon and claims the benefit of priority from Japanese patent application No. 2023-50546, filed on Mar. 27, 2023, and PCT application No. PCT/JP2024/011428 filed on Mar. 22, 2024, the disclosure of which is incorporated herein in its entirety by reference.

### BACKGROUND

The present invention relates to a compound, a surface treatment agent, an article, and a method for manufacturing an article.

In various fields such as electrical and electronic materials, semiconductor materials, optical materials, building materials, and automobile parts, a method for forming a surface layer on the surface of a member (substrate) to be used in order to, for example, prevent dirt from sticking to the member is known. For example, Patent Literature 1 shows a method for forming an organic thin film on the surface of a substrate by using a composition containing n-octadecyltrimethoxysilane which is an organic silicon compound.
[Patent Literature 1] International Patent Publication No. 2008/016029

### SUMMARY

In recent years, the requirements for the performance of surface layers have increased, and surface layers excellent in oil repellency are required depending on their uses. The inventors of the present application have evaluated surface layers formed by using organosilicon compounds like those disclosed in Patent Literature 1, and found that there is room for improvement in the oil repellency of the surface layers.

The present invention has been made in view of the above-described problem, and an object thereof is to provide a compound capable of forming a surface layer excellent in oil repellency, a surface treatment agent containing such a compound, an article having a surface layer formed of such a compound, and a method for manufacturing such an article.

The inventors of the present application have earnestly studied the above-described problem and found that the above-described problem can be solved by compositions or the like described hereinafter.
[1] A compound represented by a below-shown Formula (1),

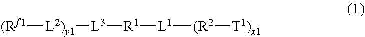

where
R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², monovalent cyclic hydrocarbon group containing a fluorine atom, and a monovalent heterocyclic group containing a fluorine atom; X¹⁰ is H, Cl, Br, or I; X¹¹ is a fluoroalkyl group; and X¹² is an alkyl group or a fluoroalkyl group,
L² is a single bond or a divalent linking group,
L³ is an organopolysiloxane residue having a valence of 1+y1,
R¹ is a single bond, a fluoroalkylene group having a carbon number of 1 to 20, an alkylene group having a carbon number of 1 to 20, or an alkylene group containing an etheric oxygen atom and having a carbon number of 1 to 20,
L¹ is a single bond or a group having a valence of 1+x1,
R² is an alkylene group or an alkylene group containing an etheric oxygen atom,
T¹ is a reactive group,
y1 is an integer of 1 or greater,
x1 is an integer of 1 to 10, and
when there are a plurality of R^{f1}, L², R², T¹, or X¹⁰, the plurality of R^{f1}, L², R², T¹, or X¹⁰ may be the same as each other or different from each other.
[2] The compound described in Item [1], wherein the compound represented by the above-shown Formula (1) is a compound represented by a below-shown Formula (1-1),

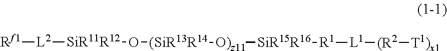

where
R¹¹ and R¹² are each independently an alkyl group or R^{f1}-L²-,
R¹³, R¹⁴, R¹⁵, and R¹⁶ are each independently an alkyl group,
R^{f1}, L², R¹, L¹, R², T¹, and x1 are synonymous with R^{f1}, L², R¹, L¹, R², T¹, and x1, respectively, in Formula (1),
z11 is an integer of 1 or greater, and
when there are a plurality of R¹³, R¹⁴, R², or T¹, the plurality of R¹³, R¹⁴, R², or T¹ may be the same as each other or different from each other.
[3] The compound described in Item [1], wherein the compound represented by the above-shown Formula (1) is a compound represented by a below-shown Formula (1-2),

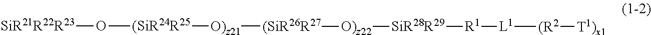

where
R²¹, R²², and R²³ are each independently an alkyl group or R^{f1}-L²-,
R²⁴ is R^{f1}-L²-,
R²⁵ is an alkyl group or R^{f1}-L²-,
R²⁶ and R²⁷ are each independently an alkyl group,
R²⁸ and R²⁹ are each independently an alkyl group or R^{f1}-L²-; and R^{f1}, L², R¹, L¹, R², T¹, and x1 are synonymous with R^{f1}, L², R¹, L¹, R², T¹, and x1, respectively, in Formula (1),
z21 is an integer of 1 or greater,
z22 is an integer of 0 or greater, and
when there are a plurality of R²⁴, R²⁵, R²⁶, R²⁷, R², or T¹, the plurality of R²⁴, R²⁵, R²⁶, R²⁷, R², or T¹ may be the same as each other or different from each other.
[4] The compound described in Item [1], wherein the compound represented by the above-shown Formula (1) is a compound represented by a below-shown Formula (1-3),

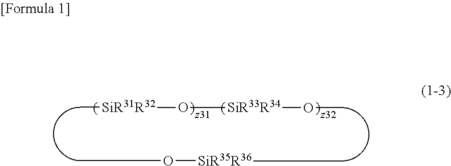

where
R³¹ is R^{f1}-L²-,
R³² is an alkyl group or R^{f1}-L²-,
R³³ and R³⁴ are each independently an alkyl group,
R³⁵ is —R¹-L¹-(R²-T¹)ₓ₁,
R³⁶ is an alkyl group, R^{f1}, L², R¹, L′, R², T¹, and x1 are synonymous with R^{f1}, L², R′,
L¹, R², T¹, and x1, respectively, in Formula (1),
z31 is an integer of 1 or greater,
z32 is an integer of 0 or greater,
a sum total of z31 and z32 is an integer of 2 or greater, and
when there are a plurality of R³¹, R³², R³³, R³⁴, R² or T¹, the plurality of R³¹, R³², R³³, R³⁴, R² or T¹ may be the same as each other or different from each other.
[5] The compound described in any one of Items [1] to [4], wherein the aforementioned T¹ is one of —Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+≡N, —N═NR¹⁰, —C(═O)OR¹⁰, —C(═O)OX², —C(═O)X⁴, —C(═O)OC(═O)R¹⁰, —SO₂R¹⁰, —SO₃H, —SO₃X², —O—P(═O)(—OR¹⁰)₂, —O—P(═O)(—OR¹⁰) (—OX²), —N═C═O, —SiR^{a1}_{z1}R^{a11}_{3-z1}, —C(R¹⁰)=C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰)₃, —NH—C(═O)R¹⁰, —C(═O)NHR¹⁰, —I, and

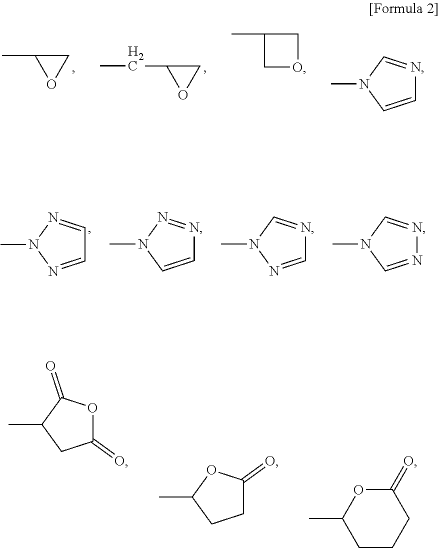

where
R¹⁰ is a hydrogen atom, an alkyl group having a carbon number of 1 to 6, which may have a substituent, a fluoroalkyl group having a carbon number of 1 to 6, which may have a substituent, or an aryl group which may have a substituent,
Ar is an aryl group which may have a substituent,
X² is an alkali metal ion or an ammonium ion,
X³ is a halide ion,
X⁴ is a halogen atom,
R^{a1} is a hydrolyzable group or a hydroxyl group,
R^{a11} is a hydrocarbon group,
z1 is an integer of 1 to 3, and
when there are a plurality of R¹⁰, R^{a1}, or R^{a11}, the plurality of R¹⁰, R^{a1}, or R^{a11} may be the same as each other or different from each other.
[6] The compound described in Item [5], wherein T¹ is —SiR^{a1}_{z1}R^{a11}_{3-z1}.
[7] The compound described in any one of Items [1] to [6], wherein the monovalent cyclic hydrocarbon group containing a fluorine atom is a group represented by a below-shown Formula (g-1), a below-shown Formula (g-2), a below-shown Formula (g-3), or a below-shown Formula (g-4),

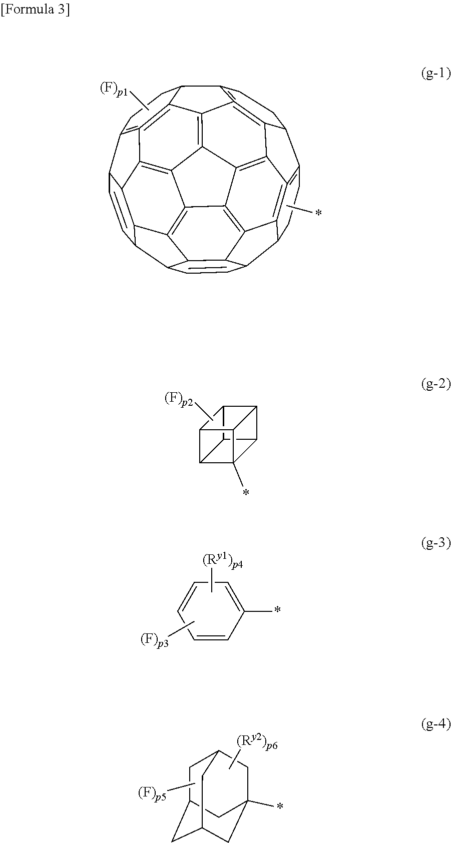

where
p1 is an integer of 1 or greater,
p2 is an integer of 1 or greater,
R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,
R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and
* indicates a position of a bond with L².
[8] The compound described in Item [7], wherein
   the monovalent substituents in R^{y1} and R^{y2} are each independently a halogen atom other than a fluorine atom, an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²², and
X²⁰ is H, Cl, Br, or I; when there are a plurality of X²⁰, the plurality of X²⁰ may be the same as each other or different from each other; X²¹ is a fluoroalkyl group; and X²² is an alkyl group or a fluoroalkyl group.
[9] A surface treatment agent containing a compound described in any one of Items [1] to [8].
[10] The surface treatment agent described in Item [9], further containing a liquid medium.
[11] The surface treatment agent described in Item [9] or [10], wherein the surface treatment agent is an antifouling coating agent or a waterproof coating agent.
[12] An article comprising, on a surface of its substrate, a surface layer formed by using a compound described in any one of Items [1] to [8].
[13] The article described in Item [12], comprising the surface layer on a surface of a member constituting a surface of a touch panel which a finger touches.
[14] The article described in Item or [13], wherein the article is an optical member.
[15] A method for manufacturing an article, wherein a surface layer is formed by a dry coating method by using a surface treatment agent described in any one of Items [9] to [11].
[16] A method for manufacturing an article, wherein a surface layer is formed by a wet coating method by using a surface treatment agent described in any one of Items [9] to [11].

According to the present invention, it is possible to provide a compound capable of forming a surface layer excellent in oil repellency, a surface treatment agent containing such a compound, an article having a surface layer formed of such a compound, and a method for manufacturing such an article.

The above and other objects, features and advantages of the present disclosure will become more fully understood from the detailed description given hereinbelow and the accompanying drawings.

### BRIEF DESCRIPTION OF DRAWINGS

FIG. 1 is a schematic cross-sectional diagram showing an example of an article according to the present invention.

### DESCRIPTION OF EMBODIMENT

The meanings of terms in the present invention are as follows. In this specification, a compound represented by Formula (1) is referred to as a compound 1. The same applies to compounds and the likes represented by other formulas.

The “fluoroalkyl group” is a generic term for perfluoroalkyl groups and partial fluoroalkyl groups. The “perfluoroalkyl group” means a group in which all hydrogen atoms of the alkyl group are substituted with fluorine atoms. Further, the term “partial fluoroalkyl group” means an alkyl group in which one or more hydrogen atoms are substituted with fluorine atoms and which contains one or more hydrogen atoms. That is, the fluoroalkyl group is an alkyl group containing one or more fluorine atoms. Note that the same applies to fluoroalkylene groups.

The “reactive silyl group” is a generic term for hydrolyzable silyl groups and silanol groups (Si—OH), and the “hydrolyzable silyl group” means a group capable of forming a silanol group through hydrolysis.

The “organic group” means a hydrocarbon group which may have a substituent and may have a heteroatom or other bonds in a carbon chain. The “hydrocarbon group” is a group consisting of an aliphatic hydrocarbon group (such as a linear alkylene group, a branched alkylene group, or a cycloalkylene group), an aromatic hydrocarbon group (such as a phenylene group), and a combination thereof.

The “surface layer” means a layer formed on the surface of a substrate.

The “number-average molecular weight” (Mn) is a value measured by size exclusion chromatography (gel permeation chromatography) using polystyrene as a reference material.

A symbol “-”, which indicates a range of numerical values, means that values in front of and behind this symbol are included in the range as lower and upper limit values, respectively.

The bonding order of divalent groups is not limited to any particular orders, unless otherwise specified. For example, when L¹ (which will be described later) is a group represented by —C(O)N(R²⁶)—, the bond on the left side may be bonded to R¹ side of Formula (1), and the bond on the right side may be bonded to R¹ side of Formula (1).

In this specification, when a compound or a group is represented by a specific formula (X), the compound or the group represented by this formula (X) may be expressed as a compound (X) or a compound X, and a group (X) or a group X, respectively.

Note that when there are the same symbols in one chemical formula, the same symbols may represent the same structure, or may represent different structures within a specified range.

In this specification, the “Me” may represent a methyl group.

### Compound 1

A compound according to the present invention is represented by the below-shown Formula (1).

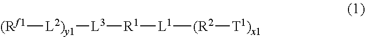

In Formula (1), R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom, and
X¹⁰ is H, Cl, Br, or I; X¹¹ is a fluoroalkyl group; and X¹² is an alkyl group or a fluoroalkyl group.

In Formula (1),
L² is a single bond or a divalent linking group,
L³ is an organopolysiloxane residue having a valence of 1+y1,
R¹ is a single bond, a fluoroalkylene group having a carbon number of 1 to 20, an alkylene group having a carbon number of 1 to 20, or an alkylene group containing an etheric oxygen atom and having a carbon number of 1 to 20,
L¹ is a single bond or a group having a valence of 1+x1,
R² is an alkylene group or an alkylene group containing an etheric oxygen atom,
T¹ is a reactive group,
y1 is an integer of 1 or greater,
x1 is an integer of 1 to 10, and when there are a plurality of R^{f1}, L², R², T¹, or X¹⁰, the plurality of R^{f1}, L², R², T¹, or X¹⁰ may be the same as each other or different from each other.

In the compound 1, R^{f1}, which is a fluorine-containing group containing a fluorine atom, is located at one end, and T¹, which is a reactive group, is located at the other end.

When a surface layer is formed by using the compound 1, the reactive group of the compound 1 tends to be located on the substrate side, and the reactive group is strongly chemically bonded to the substrate, so the obtained surface layer has excellent friction resistance property.

Further, by having R^{f1}, which is a fluorine-containing group, at one end of the compound 1, surprisingly, a surface layer having excellent oil repellency is obtained, though the particular reason for this is unknown.

Further, since the compound 1 contains a polysiloxane residue, a surface layer having excellent water repellency can be formed.

R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom.

The carbon number of the perfluoroalkyl group in R^{f1} is preferably 1 to 6, more preferably 1 to 4, and still more preferably 1 to 4.

When the carbon number of the perfluoroalkyl group is 3 or greater, the perfluoroalkyl group having a carbon number of 3 or greater may be linear, or may have a branched or ring structure.

In R^{f1}, X¹⁰ of —C(X¹⁰)F₂ and —C(X¹⁰)₂F is H, Cl, Br, or I.

Note that in —C(X¹⁰)₂F, the two X¹⁰ may be the same as each other or different from each other.

Specific examples of the fluorovinyl group in R^{f1} include CF₂=CF—, CF₂═CH—, CFH=CF—, CFH═CH—, and CH₂=CF—.

In —NX¹¹X¹² in R^{f1}, X¹¹ is a fluoroalkyl group, and X¹² is an alkyl group or a fluoroalkyl group. The carbon number of the fluoroalkyl group in X¹¹ and X¹² is preferably 1 to 6, more preferably 1 to 4, and still more preferably 1 to 3. When the carbon number of the fluoroalkyl group is 3 or greater, the fluoroalkyl group having a carbon number of 3 or greater may be linear, or may have a branched or ring structure. The carbon number of the alkyl group in X¹² is preferably 1 to 6, more preferably 1 to 4, and still more preferably 1 to 3. When the carbon number of the alkyl group is 3 or greater, the alkyl group having a carbon number of 3 or greater may be linear, or may have a branched or ring structure.

The monovalent cyclic hydrocarbon group containing a fluorine atom means a group in which at least one hydrogen atom contained in the cyclic hydrocarbon group is substituted with a fluorine atom or a substituent containing a fluorine atom. Note that all hydrogen atoms contained in the cyclic hydrocarbon group may be substituted with fluorine atoms or substituents containing fluorine atoms.

In the monovalent cyclic hydrocarbon group containing a fluorine atom, the cyclic hydrocarbon group may be an alicyclic hydrocarbon group or an aromatic hydrocarbon group.

The cyclic hydrocarbon constituting the monovalent cyclic hydrocarbon group containing a fluorine atom may be a monocyclic ring or a condensed ring. Alternatively, the cyclic hydrocarbon may be a bridged ring.

The cyclic hydrocarbon constituting the monovalent cyclic hydrocarbon group containing a fluorine atom may be a ring having a polyhedral structure such as tetrahedrane, cubane, dodecahedrane, or fullerene.

Examples of preferred forms of the monovalent cyclic hydrocarbon group containing a fluorine atom include groups g-1 to g-4.

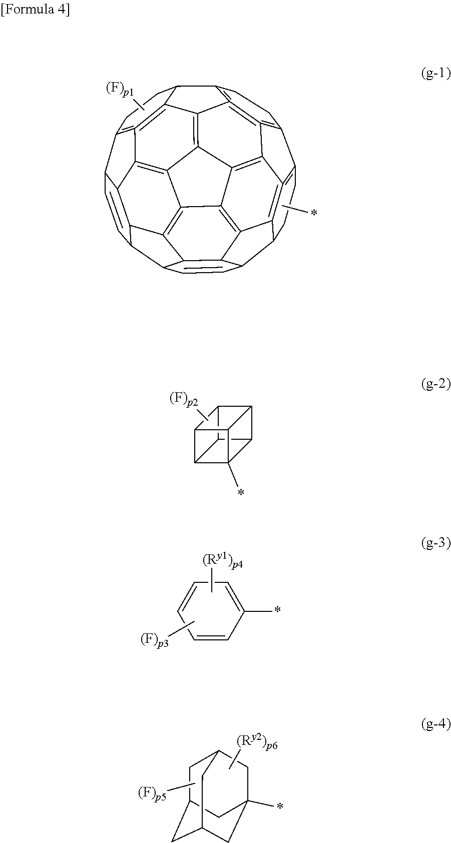

In the group g-1, p1 is an integer of 1 or greater,

In the group g-2, p2 is an integer of 1 or greater,

In the group g-3, R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,

In the group g-4, R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and

In the groups g-1 to g-4, * indicates the position of a bond with L²

The group g-1 is a monovalent group having a fullerene C₆₀ derivative in which a hydrogen atom is substituted with p1 fluorine atoms.

p1 is an integer of 1 or greater, preferably an integer of 1 to 59, and more preferably an integer of 8 to 59.

The group g-2 is a monovalent group having a cubane ring in which a hydrogen atom is substituted with p2 fluorine atoms.

p2 is an integer of 1 or greater, preferably an integer of 1 to 7, and more preferably an integer of 4 to 7.

The group g-3 is a monovalent group having a benzene ring in which a hydrogen atom is substituted with p3 fluorine atoms and p4 R^{y1}.

Specific examples of the monovalent substituent in R^{y1} include a halogen atom other than a fluorine atom (e.g., Cl, Br, or I), an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²².

The carbon number of each of the alkyl group, the alkenyl group, the alkoxy group, and the perfluoroalkyl group in the monovalent substituent is preferably 1 to 5, more preferably 1 to 4, and still more preferably 1 to 3.

When the carbon number of these groups is 3 or greater, these groups may be linear, or may have a branched or ring structure.

Specific examples of the fluorovinyl group in the monovalent substituent are similar to those of the fluorovinyl group in R^{f1}.

In —C(X²⁰)F₂ and —C(X²⁰)₂F, X²⁰ is H, Cl, Br, or I.

Note that in —C(X²⁰)₂F, the two X²⁰ may be the same as each other or different from each other.

In —NX²¹X²², X²¹ is a fluoroalkyl group, and X²² is an alkyl group or a fluoroalkyl group. The carbon number of the fluoroalkyl group in X²¹ and X²² is preferably 1 to 6, more preferably 1 to 4, and still more preferably 1 to 3. When the carbon number of the fluoroalkyl group is 3 or greater, the fluoroalkyl group having a carbon number of 3 or greater may be linear, or may have a branched or ring structure. The carbon number of the alkyl group in X²² is preferably 1 to 6, more preferably 1 to 4, and still more preferably 1 to 3.

When the carbon number of the alkyl group is 3 or greater, the alkyl group having a carbon number of 3 or greater may be linear, or may have a branched or ring structure.

When R^{y1} contains a fluorine atom, each of p3 and p4 is an integer of 0 or greater, and p3+p4 is an integer of 1 or greater. In this case, p3 is preferably an integer of 0 to 5, and more preferably 2 to 5. Further, p4 is preferably an integer of 0 to 5, and more preferably 0 to 3. Further, p3+p4 is preferably 1 to 5, and more preferably 1 to 5. When R^{y1} does not contain a fluorine atom, p3 is an integer of 1 or greater, and p4 is an integer of 0 or greater. In this case, p3 is preferably an integer of 1 to 5, and more preferably 1 to 3. Further, p4 is preferably an integer of 0 to 5, and more preferably 0 to 2. Note that p3+p4 is 5 or smaller.

The group g-4 is a monovalent group having an adamantane ring in which a hydrogen atom is substituted with p5 fluorine atoms and p6 R^{y2}.

Specific examples and preferred forms of the monovalent substituent in R^{y2} are similar to those of the monovalent substituent in R^{y1}.

When R^{y2} contains a fluorine atom, each of p5 and p6 is an integer of 0 or greater, and p5+p6 is an integer of 1 or greater. In this case, p5 is preferably an integer of 0 to 15, and more preferably an integer of 1 to 3. Further, p6 is preferably an integer of 0 to 14, and more preferably an integer of 3 to 12. Further, p5+p6 is preferably 1 to 15, and more preferably 1 to 10.

When R^{y2} does not contain a fluorine atom, p5 is an integer of 1 or greater, and p6 is an integer of 0 or greater. In this case, p5 is preferably an integer of 1 to 15, and more preferably an integer of 1 to 3. Meanwhile, p6 is preferably an integer of 0 to 14, and more preferably an integer of 3 to 12. Note that p5+p6 is 15 or smaller.

The monovalent heterocyclic group containing a fluorine atom means a group in which at least one hydrogen atom contained in the heterocyclic group is substituted with a fluorine atom or a substituent containing a fluorine atom.

In the monovalent heterocyclic group containing a fluorine atom, the heterocyclic group may be aromatic or non-aromatic.

Specific examples of heteroatoms contained in the monovalent heterocyclic group containing a fluorine atom include N, O, and S.

Specific examples of heterocycles constituting the monovalent heterocyclic group containing a fluorine atom include non-aromatic heterocycles such as pyrrolidine, piperidine, tetrahydrofuran, tetrahydropyran, dioxane, and quinuclidine, and aromatic heterocycles such as furan, pyrrole, thiophene, pyridine, triazine, triazole, pyrazole, thiazole, and benzothiazole.

L² is a single bond or a divalent linking group.

Specific examples of divalent linking groups in L² include a divalent hydrocarbon group, a divalent heterocyclic group, —O—, —S—, —SO₂—, —N(R^{d})—, —C(O)—, —Si(R^{e})₂—, and a combination of two or more of these groups.

The divalent hydrocarbon group may be a divalent saturated hydrocarbon group, a divalent aromatic hydrocarbon group, an alkenylene group, or an alkynylene group.

The divalent saturated hydrocarbon group may be linear, branched, or cyclic, and its examples include an alkylene group.

Its carbon number is preferably 1 to 20.

The divalent aromatic hydrocarbon group preferably has a carbon number of 5 to 20, and its examples include a phenylene group.

The alkenylene group preferably has a carbon number of 2 to 20.

The alkynylene group preferably has a carbon number of 2 to 20.

Specific examples of heteroatoms contained in the divalent heterocyclic group include N, O, and S.

The divalent heterocyclic group may be aromatic or non-aromatic.

Specific examples of heterocycles constituting the divalent heterocyclic group include non-aromatic heterocycles such as pyrrolidine, piperidine, tetrahydrofuran, tetrahydropyran, dioxane, and quinuclidine, and aromatic heterocycles such as furan, pyrrole, thiophene, pyridine, triazine, triazole, pyrazole, thiazole, and benzothiazole.

R^{e} is an alkyl group (preferably having a carbon number of 1 to 10) or a phenyl group.

R^{d} is a hydrogen atom or an alkyl group (preferably having a carbon number of 1 to 10).

Further, specific examples of groups in which two or more of the aforementioned groups are combined include: —C(O)O—, —C(O)S—, —C(O)N(R^{d})—, —N(R^{d})C(O)N(R^{d})—, —N(R^{d})C(O)O—, —SO₂N(R^{d})—, an alkylene group containing —C(O)N(R^{d})—, an alkylene group containing —N(R^{d})C(O)O—, an alkylene group containing an etheric oxygen atom, an alkylene group containing —S—, an alkylene group containing —C(O)O—, an alkylene group containing —C(O)S—, an alkylene group containing —N(R^{d})—, an alkylene group containing —N(R^{d})C(O)N(R^{d})—, an alkylene group containing —SO₂N(R^{d})—, and alkylene group —Si(R^{e})₂-phenylene group —Si(R^{e})₂—.

Among them, L² is preferably a divalent hydrocarbon group, a divalent heterocyclic group, —O—, —S—, —SO₂—, —N(R^{d})—, —C(O)—, —Si(R^{e})₂—, —C(O)O—, —C(O)S—, —C(O)N(R^{d})—, —N(R^{d})C(O)N(R^{d})—, —N(R^{d})C(O)O—, —SO₂N(R^{d})—, —N(R^{d}) SO₂—, an alkylene group containing —C(O)N(R^{d})—, an alkylene group containing —N(R^{d})C(O)—, an alkylene group containing —N(R^{d})C(O)O—, an alkylene group containing an etheric oxygen atom, an alkylene group containing —S—, an alkylene group containing —C(O)O—, an alkylene group containing —C(O)S—, an alkylene group containing —N(R^{d})—, an alkylene group containing —N(R^{d})C(O)N(R^{d})—, or an alkylene group containing —SO₂N(R^{d})—, and more preferably —C(O)O— or —C(O)N(R^{d})— (in particular, —C(O)NH—).

y1 is an integer of 1 or greater, preferably 1 to 10, more preferably 1 to 5, and still more preferably 1 to 3.

L³ is an organopolysiloxane residue having a valence of 1+y1.

The organopolysiloxane residue may be chain-like or cyclic.

R¹ is a single bond, a fluoroalkylene group having a carbon number of 1 to 20, an alkylene group having a carbon number of 1 to 20, or an alkylene group containing an etheric oxygen atom and having a carbon number of 1 to 20. When R¹ is a single bond, L³ is directly bonded to L¹.

When R¹ is a fluoroalkylene group having a carbon number of 3 to 20, this fluoroalkylene group may be linear, or may have a branched or ring structure.

When R¹ is an alkylene group having a carbon number of 3 to 20, this alkylene group may be linear, or may have a branched or ring structure.

When R¹ is an alkylene group containing an etheric oxygen atom and having a carbon number of 3 to 20, this alkylene group may be linear, or may have a branched or ring structure. Further, the etheric oxygen atom may be located at the end of the alkylene group or between carbon atoms.

When R¹ is a fluoroalkylene group, an alkylene group, or an alkylene group containing an etheric oxygen atom, the carbon number of R¹ is 1 to 20, preferably 1 to 10, and more preferably 1 to 6.

L¹ is a single bond or a group having a valence of 1+x1. The group having a valence of 1+x1 may have a heteroatom such as N, O, S, or Si, or may have a branch point. The atoms that are bonded to R¹ and R² in L¹ are preferably each independently N, O, S, Si, a carbon atom constituting a branch point, and a carbon atom having a hydroxyl group or an oxo group (═O).

When L¹ is a single bond, R¹ and R² in Formula (1) are directly bonded to each other. Further, when L¹ is a single bond and R¹ is also a single bond, L³ and R² are directly bonded to each other in the compound 1.

When L¹ is a group having a valence of 3 or greater, L¹ has at least one type of branch point selected from the group consisting of C, N, Si, a ring structure, and an organopolysiloxane residue having a valence of (1+x1) (hereinafter also referred to as a “branch point P¹”).

When N is the branch point P¹, the branch point P¹ is expressed as, for example, *—N(—**)₂. Note that * indicates a bond on the R¹ side, and ** indicates a bond on the R² side.

When C is the branch point P¹, the branch point P¹ is expressed as, for example, *—C(—**)₃ or *—CR²⁹(—**)₂. Note that * and ** are similar to those when N is the branch point P¹. Further, R²⁹ is a monovalent group, and its examples includes a hydrogen atom, a hydroxyl group, an alkyl group, and an alkoxy group.

When Si is the branch point P¹, the branch point P¹ is expressed as, for example, *—Si(—**)₃ or *—SiR²⁹(—**)₂. Note that * and ** are similar to those when N is the branch point P¹, and R²⁹ is similar to that when C is the branch point P¹.

The ring structure constituting the branch point P¹ is preferably one type of ring selected from the group consisting of a 3 to 8 membered aliphatic ring, a 3 to 8 membered aromatic ring, a 3 to 8 membered heterocycle, and a condensed ring consisting of two or more of these rings in view of the ease of synthesis and because the friction resistance property, light stability, and chemical resistance of the surface layer are more improved, and is more preferably ring structures shown in the below-shown formulae.

The ring structure may contain a substituent such as a halogen atom, an alkyl group (which may contain an etheric oxygen atom between carbon atoms), a cycloalkyl group, an alkenyl group, an allyl group, an alkoxy group, or an oxo group (═O).

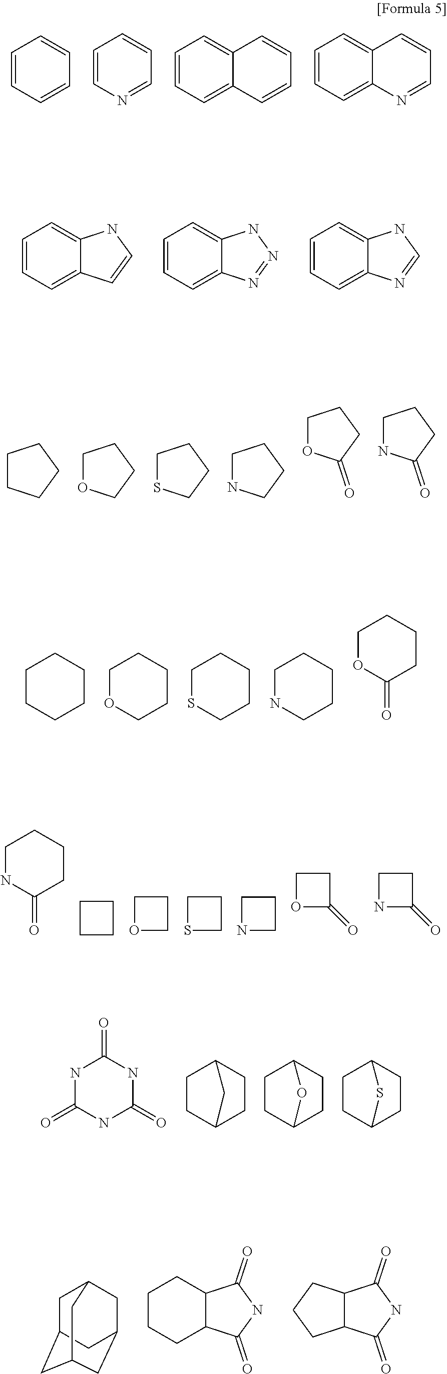

Examples of the organopolysiloxane residue constituting the branch point P¹ include groups described below. Note that R²⁵ in the below-shown formulae is a hydrogen atom, an alkyl group, an alkoxy group, or a phenyl group. The carbon number of the alkyl group and the alkoxy group of R²⁵ is preferably 1 to 10 and more preferably 1.

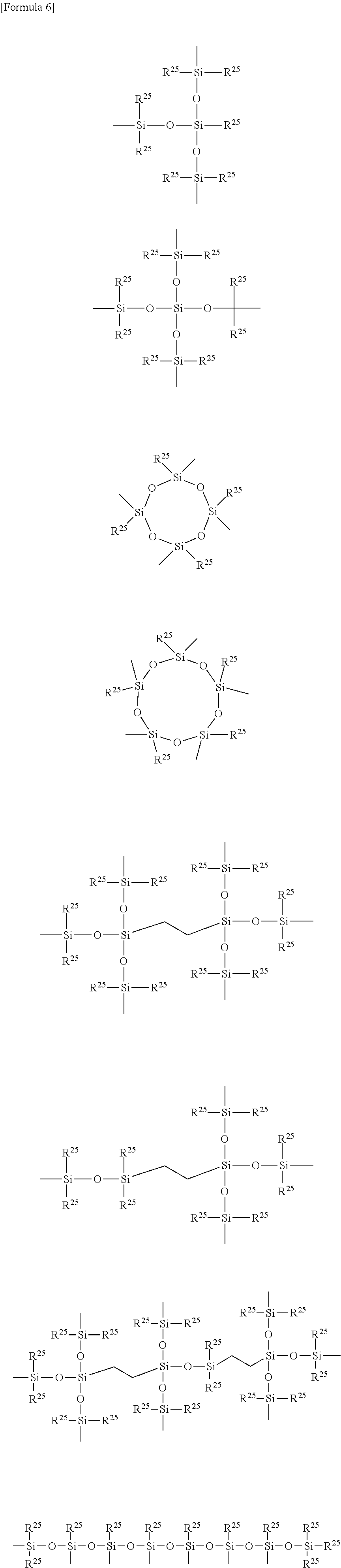

L¹ having a valence of 2 or greater may have at least one bond selected from the group consisting of —C(O)N(R²⁶)—, —C(O)O—, —C(O)—, —C(OH)—, —O—, —N(R²⁶)—, —S—, —OC(O)O—, —NHC(O)O—, —NHC(O)N(R²⁶)—, —SO₂N(R²⁶)—, —N(R²⁶) SO₂—, —Si(R²⁶)₂—, —OSi(R²⁶)₂—, —Si(CH₃)₂-Ph-Si(CH₃)₂—, and divalent organopolysiloxane residues (hereinafter also referred to as a “bond B¹”).

Note that R²⁶ is a hydrogen atom, or an alkyl group or a phenyl group having a carbon number of 1 to 6, and Ph is a phenylene group. The carbon number of the alkyl group of R²⁶ is preferably 1 to 6, more preferably 1 to 3, and still more preferably 1 to 2 in view of the ease of manufacturing of the compound 1.

Examples of divalent organopolysiloxane residues include groups shown in the below-shown formulae.

Note that R²⁷ in the below-shown formulae is a hydrogen atom, an alkyl group, an alkoxy group, or a phenyl group. The carbon number of the alkyl group and the alkoxy group of R²⁷ is preferably 1 to 10 and more preferably 1.

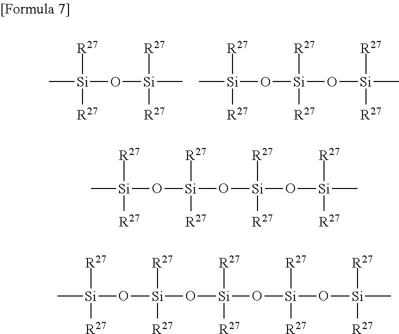

The bond B¹ is preferably at least one bond selected from the group consisting of —C(O)NR²⁶—, —C(O)—, and —NR²⁶— in view of the ease of synthesis, and more preferably —C(O)NR²⁶— or —C(O)— because the light stability and chemical resistance of the surface layer are more improved.

Regarding the divalent L¹, the atoms that are bonded to R¹ and R² are preferably each independently an N, O, S, or Si atom, or a carbon atom having a hydroxyl group or an oxo group (═O). That is, each of the atoms adjacent to R¹ and R² is preferably a constituent element of the bond B¹. Specific examples of L¹ having a valence of 2 or greater include one or more bonds B¹ (e.g., *—B¹—** or *—B¹—R²⁸—B¹-**). Note that R²⁸ is a single bond or a divalent organic group. Further, * represents a bond on the R¹ side, and ** represents a bond on the R² side.

Regarding L¹ having a valence of 3 or greater, the atoms that are bonded to R¹ and R² are N, O, S, Si, a carbon atom constituting a branch point, or a carbon atom having a hydroxyl group or an oxo group (═O). That is, each of the atoms adjacent to R¹ and R² is a constituent element of the bond B¹ or the branch point P¹. Specific examples of L¹ having a valence of 3 or greater include one or more branch points P¹ (e.g., {*—P¹(—**)ₓ₁}) and combinations of one or more branch points P¹ and one or more bonds B¹ (e.g., {*—B¹—R²⁸—P¹(—**)ₓ₁} and {*—B¹—R²⁸—P¹(—R²⁸—B¹—**)ₓ₁}). Note that R²⁸ is a single bond or a divalent organic group. Further, * represents a bond on the R¹ side, and ** represents a bond on the R² side.

Examples of the divalent organic group in the aforementioned R²⁸ include a divalent aliphatic hydrocarbon group (such as an alkylene group and a cycloalkylene group) and a divalent aromatic hydrocarbon group (such as a phenylene group). Further, the divalent organic group may have a bond B¹ between carbon atoms of a hydrocarbon group having a carbon number of 2 or greater. The carbon number of the divalent organic group is preferably 1 to 10, more preferably 1 to 6, and still more preferably 1 to 4.

The above-described L¹ is preferably a group represented by one of the below-shown Formulae (E1) to (E7) in view of the ease of manufacturing of the compound 1.

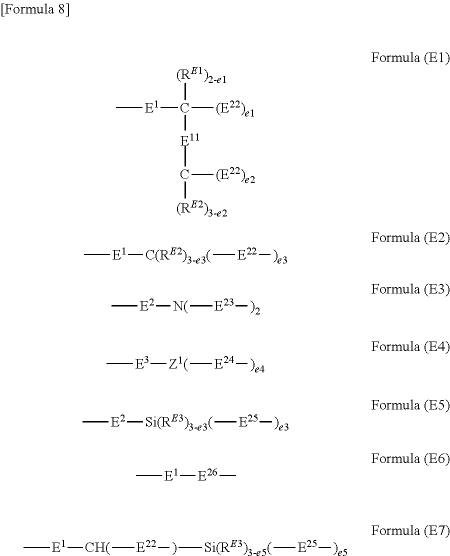

Note that in Formulae (E1) to (E7), the E1, E2, or E3 side is connected to R¹ in Formula (1), and the E22, E23, E24, E25, or E26 side is connected to R².

Note that E1 is a single bond, —B⁵—, —B⁶—R⁴⁰—, or —B⁶—R⁴⁰—B⁵—; R⁴⁰ is an alkylene group or a group containing —C(O)NR^{E6}—, —C(O)—, —NR^{E6}-or —O— between carbon atoms of an alkylene group having a carbon number of 2 or greater; B⁵ is —C(O)NR^{E6}—, —C(O)—, —NR^{E6}— or —O—; and B⁶ is —C(O)NR^{E6}—, —C(O)—, or —NR^{E6}—,
E² is a single bond or —B⁶—R⁴⁰—,
when the atom in Z¹ to which E³ is bonded is a carbon atom, E³ is E¹; and when the atom in Z¹ to which E³ is bonded is a nitrogen atom, E³ is E²,
E¹¹ is a single bond, —O—, an alkylene group, or a group containing —C(O)NR^{E6}—, —C(O)—, —NR^{E6}— or —O— between carbon atoms of an alkylene group having a carbon number of 2 or greater,
E²² is a single bond, —B⁵—, —R⁴⁰—B⁶—, or —B⁵—R⁴⁰—B⁶—; and when there are two or more E²², the two or more E²² may be the same as each other or different from each other,
E²³ is a single bond or —R⁴⁰—B⁶—, and two E²³ may be the same as each other or different from each other,
when the atom in Z¹ to which E²⁴ is bonded is a carbon atom, E²⁴ is E²²; and when the atom in Z¹ to which E²⁴ is bonded is a nitrogen atom, E²⁴ is E²³. Further, when there are two or more E²⁴, the two or more E²⁴ may be the same as each other or different from each other,
E²⁵ is a single bond or —R⁴⁰—B⁶—; and when there are two or more E²⁵, the two or more E²⁵ may be the same as each other or different from each other,
E²⁶ is a single bond or —R⁴⁰—B⁶—,
Z¹ is a group containing a ring structure containing a carbon atom or a nitrogen atom to which E³ is directly bonded and containing a carbon atom or a nitrogen atom to which E²⁴ is directly bonded, and having a valence of (e4+1),
R^{E1} is a hydrogen atom or an alkyl group, and when there are two or more R^{E1}, the two or more R^{E1} may be the same as each other or different from each other,
R^{E2} is a hydrogen atom, a hydroxyl group, an alkyl group, or an acyloxy group,
R^{E3} is an alkyl group,
R^{E6} is a hydrogen atom, or an alkyl group or a phenyl group having a carbon number of 1 to 6,
e1 is an integer of 0 to 2; e2 is an integer of 0 to 3; and e1+e2 is an integer of 1 to 5,
e3 is an integer of 1 to 3,
e4 is an integer of 1 or greater, and
e5 is an integer of 1 to 3.

Note that the following relations hold: e1+e2=x1, e3=x1, e4=x1, and e5+1=x1.

The carbon number of the alkylene group of R⁴⁰ is preferably 1 to 10, more preferably 1 to 6, and still more preferably 1 to 4 in view of the ease of manufacturing of the compound 1 and because the friction resistance property, light stability, and chemical resistance of the surface layer are more improved. Note that the lower limit value of the carbon number of the alkylene group when there is a specific bond between carbon atoms is 2.

Examples of the ring structure in Z¹ include those described above, and its preferred forms are also similar to those described above.

Note that since E²⁴ is directly bonded to the ring structure in Z¹, for example, an alkylene group is connected to the ring structure and E²⁴ is not bonded to this alkylene group.

The number of carbon atoms of the alkyl group of R^{E1}, R^{E2}, or R^{E3} is preferably 1 to 6, more preferably 1 to 3, and still more preferably 1 to 2 in view of the ease of manufacturing of the compound 1.

The number of carbon atoms of the alkyl group part of R^{E2} is preferably 1 to 6, more preferably 1 to 3, and still more preferably 1 to 2 in view of the ease of manufacturing of the compound 1.

e4 is preferably 2 to 6, more preferably 2 to 4, and still more preferably 2 or 3 in view of the ease of manufacturing of the compound 1 and because the friction resistance property and the fingerprint stain removal property of the surface layer are more improved.

Examples of other forms of L¹ include groups represented by the below-shown Formulae (E11) to (E17).

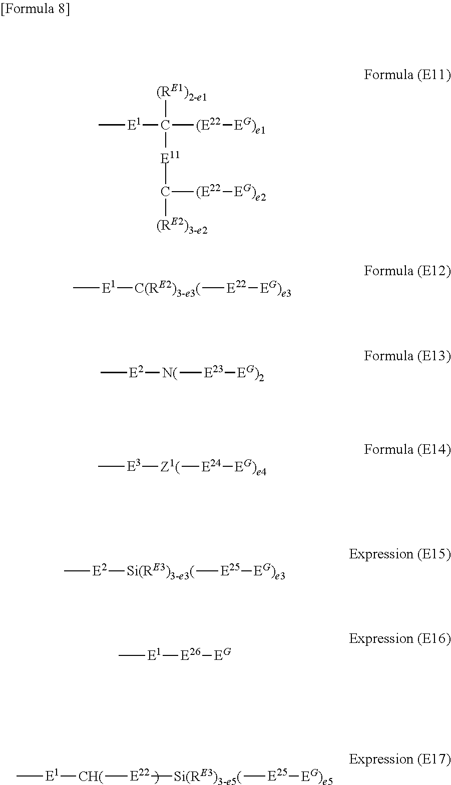

Note that in Formulae (E11) to (E17), the E¹, E², or E³ side is connected to R¹ in Formula (1), and the E²², E²³, E²⁴, E²⁵, or E²⁶ side is connected to R².

E^{G} is represented by the below-shown Formula (E^{G}), and two or more E^{G} of L¹ may be the same as each other or different from each other.

Symbols other than G are similar to those in Formulae (E1) to (E7).

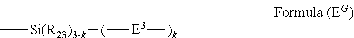

Notet that in Formula (E^{G}), the Si side is connected to E²², E²³, E²⁴, E²⁵ or E²⁶, and the E³ side is connected to R². R²³ is an alkyl group. E³ is a single bond or —R⁴⁵—B⁶—; R⁴⁵ is an alkylene group, a group containing —C(O)NR⁴⁶—, —C(O)—, —NR⁴⁶— or —O— between carbon atoms of an alkylene group having a carbon number of 2 or greater, or —(OSi(R²⁴)₂)ₚ—O—; and two or more E³ may be the same as each other or different from each other. k is 2 or 3. R⁴⁶ is a hydrogen atom, or an alkyl group or a phenyl group having a carbon number of 1 to 6. R²⁴ is an alkyl group, a phenyl group, or an alkoxy group, and two or more R²⁴ may be the same as each other or different from each other. p is an integer of 0 to 5. When p is 2 or greater, two or more (OSi(R²⁴)₂) may be the same as each other or different from each other.

The carbon number of the alkylene group of E³ is preferably 1 to 10, more preferably 1 to 6, and still more preferably 1 to 4 in view of the ease of manufacturing of the compound 1 and because the friction resistance property, light stability, and chemical resistance of the surface layer are more improved. Note that the lower limit value of the carbon number of the alkylene group when there is a specific bond between carbon atoms is 2.

The carbon number of the alkyl group of R²³ is preferably 1 to 6, more preferably 1 to 3, and still more preferably 1 to 2 in view of the ease of manufacturing of the compound 1.

The carbon number of the alkyl group of R²⁴ is preferably 1 to 6, more preferably 1 to 3, and still more preferably 1 to 2 in view of the ease of manufacturing of the compound 1.

The carbon number of the alkoxy group of R²⁴ is preferably 1 to 6, more preferably 1 to 3, and still more preferably 1 or 2 because the storage stability of the compound 1 is improved.

p is preferably 0 or 1.

R² is an alkylene group or an alkylene group containing an etheric oxygen atom.

When there are a plurality of R², the plurality of R² may be the same as each other or different from each other.

The carbon number of the alkylene group and the alkylene group containing an etheric oxygen atom in R² is preferably 1 to 20, more preferably 1 to 15, and still more preferably 1 to 11.

When the carbon number of the alkylene group or the alkylene group containing an etheric oxygen atom is 3 or greater, the carbon number of the alkylene group or the alkylene group containing an etheric oxygen atom having a carbon number of 3 or greater may be linear, or may have a branched or ring structure.

In the alkylene group containing an etheric oxygen atom, the atom bonded to L¹ may be an etheric oxygen atom or may have an etheric oxygen atom between carbon atoms.

R² is preferably a group represented by the below-shown Formula (H1).

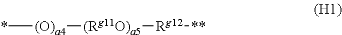

where
R^{g11} is an alkylene group having a carbon number of 1 to 12, and when there are a plurality of R^{g11}, the plurality of R^{g11} may be the same as each other or different from each other, and
R^{g12} is an alkylene group having a carbon number of 1 to 12,
a4 is 0 or 1,
a5 is an integer of 0 or greater,
* represents a bond that is bonded to L¹, and
** represents a bond that is bonded to T¹.

When a4 is 0, the atom having the bond * is a carbon atom, and when a4 is 1, the atom having the bond * is an oxygen atom.

In the compound 1, a4 may be either 0 or 1, and may be selected as appropriate in view of the ease of synthesis or the like.

a5 is a repetition number of R^{g11}O, and is preferably 0 to 6, more preferably 0 to 3, and still more preferably 0 or 1 in view of the durability or the like as the surface layer.

The alkylene group of R^{g11} may be an alkylene group having a carbon number of 1 to 12 and having a straight chain or a branch, and is preferably an alkylene group having a carbon number of 1 to 6, and more preferably an alkylene group having a carbon number of 1 to 3. Further, this alkylene group is preferably a linear alkylene group.

The alkylene group of R^{g12} may be an alkylene group having a carbon number of 1 to 12 and having a straight chain or a branch, and is preferably an alkylene group having a carbon number of 2 to 6, and more preferably an alkylene group having a carbon number of 2 or 3. Further, this alkylene group is preferably a linear alkylene group.

When L¹ is a single bond, —R¹-L¹-(R²-T¹)ₓ₁ can be expressed by the below-shown Formula (RL-1):

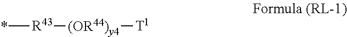

where
R⁴³ is a single bond or an alkylene group having a carbon number of 1 to 6,
R⁴⁴ is an alkylene group having a carbon number of 1 to 6. When there are a plurality of R⁴⁴, the plurality of R⁴⁴ may be the same as each other or different from each other,
y4 is an integer of 0 or greater,
* represents a bond that is bonded to L³ of Formula (1).

Note that when R⁴³ is a single bond, y4 is an integer of 1 or greater.

Note that when R⁴³ is a single bond, the compound 1 has a structure in which O at the end of (OR⁴⁴)_{y4} is directly bonded to L³ of Formula (1).

Further, when y4 is 0, the compound 1 has a structure in which R⁴³ is directly bonded to T¹.

T¹ is a reactive group, and the compound 1 exhibits various functions owing to the reactivity of T¹.

Examples of these functions include a function of improving the adhesive property to the surface of the substrate, a function of imparting photosetting and/or thermosetting properties to the compound 1, a function of imparting acidic/alkalinity or the like to the compound 1, a function of adjusting the solubility of the compound 1 in a specific solvent, and a function of serving as a precursor for the synthesis of other compounds.

Specific examples of T¹ include-Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+≡N, —N═NR¹⁰, —C(═O)OR¹⁰, —C(═O)OX², —C(═O)X⁴, —C(═O)OC(═O)R¹⁰, —SO₂R¹⁰, —SO₃H, —SO₃X², —O—P(═O)(—OR¹⁰)₂, —O—P(═O)(—OR¹⁰) (—OX²), —N═C═O, —SiR^{a1}_{z1}R^{a11}_{3-z1}, —C(R¹⁰)═C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰) 3, —NH—C(═O)R¹⁰, —C(═O)NHR¹⁰, —I, and groups represented by the below-shown formulae.

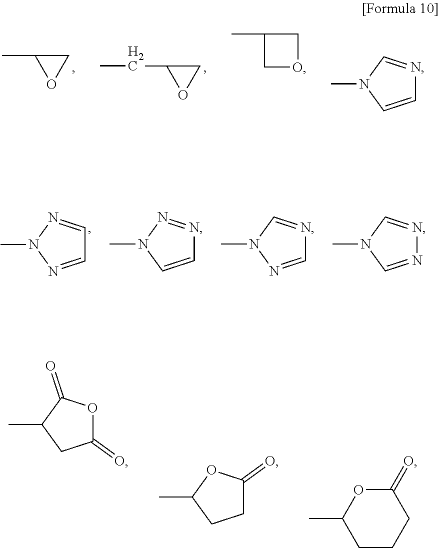

where
R¹⁰ is a hydrogen atom, an alkyl group having a carbon number of 1 to 6, which may have a substituent, or a fluoroalkyl group having a carbon number of 1 to 6, which may have a substituent, or an aryl group, which may have a substituent,
Ar is an aryl group, which may have a substituent,
X² is an alkali metal ion or an ammonium ion,
X³ is a halide ion,
X⁴ is a halogen atom,
R^{a1} is a hydrolyzable group or a hydroxyl group,
R^{a11} is a hydrocarbon group,
z1 is an integer of 1 to 3, and
When there are a plurality of R¹⁰, R^{a1} or R^{a11}, the plurality of R¹⁰, R^{a1} or R^{a11} may be the same as each other or different from each other.

The carbon number of the fluoroalkyl group in R¹⁰ is 1 to 6, and more preferably 1 to 4. This fluoroalkyl group may have other substituents. A compound 1 containing a fluoroalkyl group as T¹ becomes a compound of which the content of fluorine is high, and has various excellent properties such as a low refractive index, a low dielectric constant, water/oil repellency, heat resistance, chemical resistance, chemical stability, and transparency. Examples of substituents that the fluoroalkyl group may contain include a halogen atom such as a chlorine atom, and those that are shown as examples of a function-imparting group T.

Examples of the aryl group in Ar and R¹⁰ include a phenyl group and a naphthyl group, and the aryl group may further contain a substituent. Examples of substituents that the aryl group may contain include a fluorine atom, a halogen atom such as a chlorine atom, an alkyl group having a carbon number of 1 to 6, and those that are shown as examples of the function-imparting group T.

The carbon number of the alkyl group in R¹⁰ is 1 to 6, and preferably 1 to 4. This alkyl group may have other substituents. Substituents that the alkyl group may contain include a halogen atom such as a chlorine atom, and those that are shown as examples of the function-imparting group T (which will be described later).

Compounds 1 containing, as the reactive group T¹, a hydroxy group, an N-hydroxy group, an aldehyde group, a ketone group, an amino group, a quaternary ammonium group, a nitrile group, an imino group, a diazo group, a carboxy group, a carboxylate group, an acid anhydride group, a sulfo group, a sulfonate group, a phosphate group, and a phosphate group (hereinafter, these groups are also referred to as “function-imparting groups T”) are given, by this function-imparting groups T, various properties such as acidity, alkalinity, and hydrophilicity, and impart, for example, functions such as improved solubility in a specific solvent and an improved adhesive property to a specific substrate. Examples of counterions of quaternary ammonium groups include halide ions. Examples of counterions of carboxylate, sulfonate, and phosphate include alkali metal ions and ammonium ions.

A compound 1 containing a group containing a carbon-carbon double bond as the reactive group T¹ can make it possible to prepare a photocurable composition by combining it with a photo-initiator or the like, and a cured coating film obtained by this composition has both water/oil repellency and a hard coating property. Examples of groups having a carbon-carbon double bond include acryloyl groups, methacryloyl groups, vinyl groups, allyl groups, acryloyloxy groups, methacryloyloxy groups, and olefins.

Further, compounds 1 containing, as the reactive group T¹, an isocyanate group, an epoxy group, a glycidyl group, an oxetanyl group, and a mercapto group can make it possible to prepare a photocurable composition by combining it with a poxy curing agent, and a cured coating film obtained by this composition has both water/oil repellency and a hard coating property.

The amide bond, ester bond, ether bond, thioether bond, siloxane bond, and urea bond in the reactive group T¹ are bonded to the alkyl group, fluoroalkyl group, aryl group, heteroaryl group, and the like contained in T¹. It is also possible to have other function-imparting groups through these bonds.

The reactive group T¹ of the compound 1 is preferably a group containing a hydroxy group, an amino group, or a carbon-carbon double bond in view of the synthesis, the chemical stability, and the adhesive property to the substrate. Further, among the groups having a carbon-carbon double bond, an acryloyl group, a methacryloyl group, a vinyl group, an allyl group, or an olefin is preferred.

Further, when the compound 1 is used as a surface treatment agent for forming a surface layer having excellent durability such as friction resistance property, T¹ is preferably a group containing a reactive silyl group. The reactive silyl group is preferably a group represented by the below-shown Formula (2).

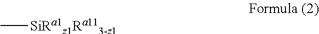

In Formula (2),
R^{a1} is a hydrolyzable group or a hydroxyl group,
R^{a11} is a hydrocarbon group,
z1 is an integer of 1 to 3, and
when there are a plurality of R^{a1} or R^{a11}, the plurality of R^{a1} or R^{a11} may be the same as each other or different from each other.

When R^{a1} is a hydroxyl group, it constitutes a silanol (Si—OH) group with an Si atom. Further, the hydrolyzable group is a group that becomes a hydroxyl group through a hydrolysis reaction. The silanol group further reacts between molecules, and thereby forms an Si—O—Si bond. Further, the silanol group has a dehydration condensation reaction with a hydroxyl group present on the surface of the substrate (substrate-OH), and thereby forms a chemical bond (substrate-O—Si). As the compound 1 contains one or more T¹, it has excellent friction resistance property after the surface layer is formed.

Examples of the hydrolyzable group of R^{a1} include alkoxy groups, aryloxy groups, halogen atoms, acyl groups, acyloxy groups, and isocyanate groups (—NCO). As the alkoxy group, an alkoxy group having a carbon number of 1 to 4 is preferred. As the acyl group, an acyl group having a carbon number of 1 to 6 is preferred. As the acyloxy group, an acyloxy group having a carbon number of 1 to 6 is preferred.

R^{a1} is preferably an alkoxy group having a carbon number of 1 to 4 or a halogen atom in view of the ease of synthesis. The alkoxy group in R^{a1} is preferably an alkoxy group having a carbon number of 1 to 4 because the storage stability of the compound 1 is improved and the outgassing during the reaction is suppressed, and more preferably an ethoxy group in view of the long-term storage stability, and is preferably a methoxy group in order to shorten the hydrolysis reaction time. Further, as the halogen atom, a chlorine atom is particularly preferred.

R^{a11} is a hydrocarbon group. Examples of hydrocarbon groups include alkyl groups, cycloalkyl groups, alkenyl groups, and allyl groups, and alkyl groups are preferred in view of the ease of synthesis or the like. Further, the carbon number of the hydrocarbon group is preferably 1 to 6, more preferably 1 to 3, and still more preferably 1 or 2 in view of the ease of synthesis or the like.

The number z1 of R^{a1} in the group represented by Formula (2) may be 1 to 3, and is preferably 2 or 3, and more preferably 3 in view of the adhesive property to the substrate.

Specific examples of groups represented by Formula (2) include —Si(OCH₃)₃, —SiCH₃(OCH₃)₂, —Si(OCH₂CH₃)₃, —SiCl₃, —Si(OCOCH₃)₃, and —Si(NCO)₃.—Si(OCH₃)₃ is preferred in view of ease of the handling in the manufacturing process.

The number x1 of T¹ in one molecule of the compound 1 may be 1 to 10, and x1 is preferably 1 to 6 and more preferably 1 to 3 in view of the ease of synthesis and the ease of handling of the compound 1. When there are two or more T¹ in one molecule of the compound 1, these T¹ may have structures identical to each other or different from each other.

Specific examples where T¹ does not have a reactive silyl group include the below-shown structures. Note that in the formula, R^{a} represents an alkyl group, which may have a substituent, a fluoroalkyl group, or an aryl group; R represents an alkyl group having a carbon number of 1 to 6, which may have a substituent, or a fluoroalkyl group having a carbon number of 1 to 6, which may have a substituent; L represents an aryl group, which may have a substituent, or a fluoroaryl group, which may have a substituent; c represents an integer of 0 to 3; R^{b} represents a fluoroalkyl group, which may have a substituent, or an aryl group; and * represents a bond.

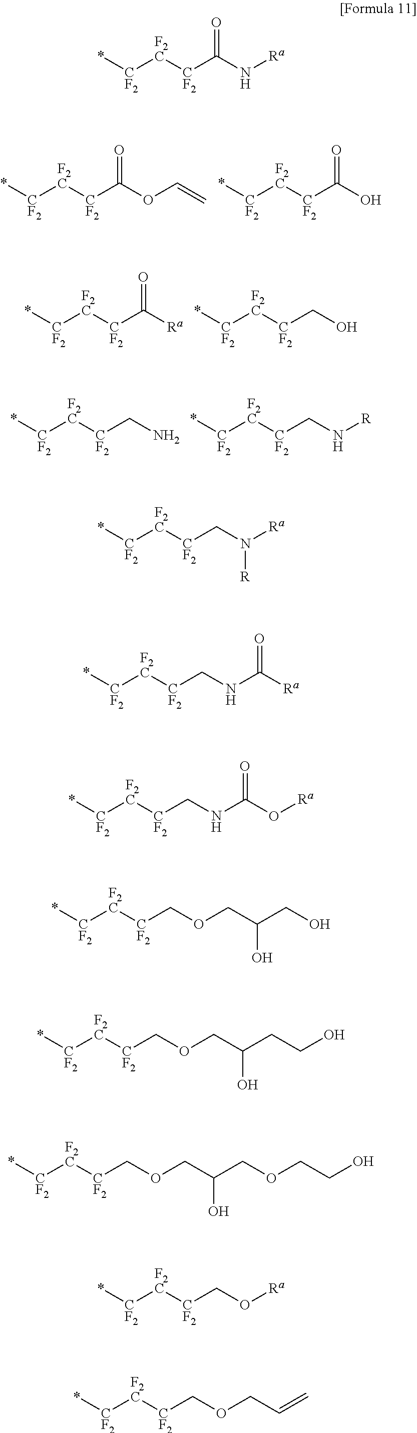

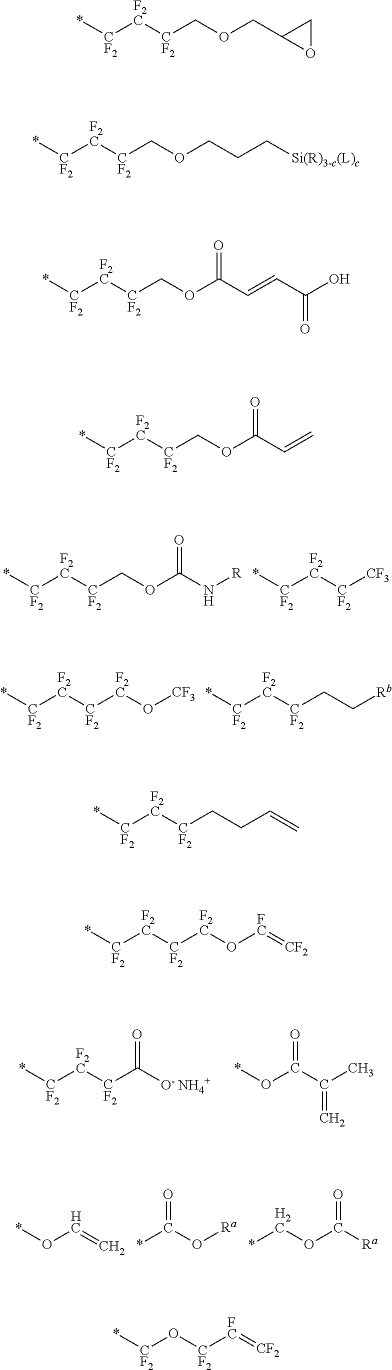

Further, specific examples of L¹-(R²-T¹)ₓ₁ include groups represented by the below-shown formulae.

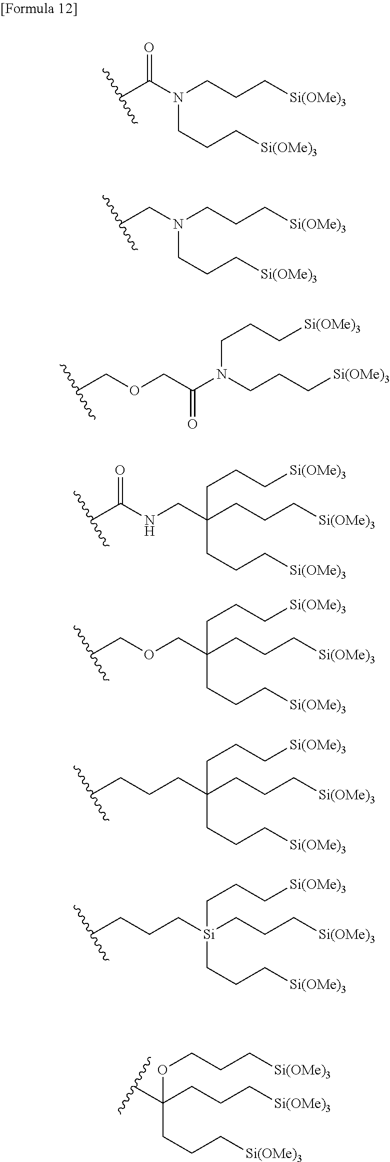

### Preferred Form of Compound 1

The compound 1 is preferably a compound represented by Formula (1-1) (hereinafter also referred to as “compound 1-1”), a compound represented by Formula (1-2) (hereinafter also referred to as “compound 1-2”), or a compound represented by Formula (1-3) (hereinafter also referred to as “compound 1-3”) because the effects of the present invention are more improved.

### Compound 1-1

The compound 1-1 is a compound represented by the below-shown Formula (1-1):

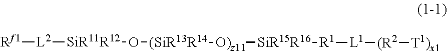

In Formula (1-1),
R¹¹ and R¹² are each independently an alkyl group or R^{f1}-L²-,
R¹³, R¹⁴, R¹⁵, and R¹⁶ are each independently an alkyl group,
R^{f1}, L², R¹, L¹, R², T¹, and x1 are synonymous with R^{f1}, L², R¹, L¹, R², T¹, and x1, respectively, in Formula (1),
z11 is an integer of 1 or greater, and
when there are a plurality of R¹³, R¹⁴, R², or T¹, the plurality of R¹³, R¹⁴, R², or T¹ may be the same as each other or different from each other.

The carbon number of the alkyl group in R¹¹, R¹², R¹³, R¹⁴, R¹⁵, and R¹⁶ is preferably 1 to 18, more preferably 1 to 6, and still more preferably 1 to 3. When the carbon number of the alkyl group is 3 or greater, the alkyl group having a carbon number of 3 or greater may be linear, or may have a branched or ring structure.

z11 is an integer of 1 or greater, and is preferably 1 to 100, more preferably 1 to 30, and still more preferably 5 to 20.

Specific examples of the compound 1-1 include compounds represented by the below-shown formulae. Note that in the following table, for example, a compound “No. 1” means a compound of the above-shown Formula (1-1) in which: R^{f1} is CF₃; L² is (CH₂)ₐ; a of (CH₂) a is 0 to 20; R¹¹ is Me; R¹² is Me; R¹³ is Me; R¹⁴ is Me; z11 is 5 to 100; R¹⁵ is Me; R¹⁶ is Me; R¹ is (CH₂)_{b}; b of (CH₂)_{b} is 0 to 20; L¹ is C(═O)NH; R² is (CH₂) c; c of (CH₂) c is 1 to 20; T¹ is Si(OMe)₃; and x1 is 1.

TABLE 1

| No. | R^{f1} | L² | a | R¹¹ | R¹² | R¹³ | R¹⁴ | z11 | R¹⁵ |
|---|---|---|---|---|---|---|---|---|---|
| 1 | CF₃ | (CH₂)ₐ | 0 to 20 | Me | Me | Me | Me | 5 to 100 | Me |
| 2 | (CF₃)₂CF | (CH₂)ₐ | 0 to 20 | Me | Me | Me | Me | 5 to 100 | Me |
| 3 | (CF₃)₃C | (CH₂)ₐ | 0 to 20 | Me | Me | Me | Me | 5 to 100 | Me |
| 4 | C₄F₉ | (CH₂)ₐ | 0 to 20 | Me | Me | Me | Me | 5 to 100 | Me |
| 5 | C₈F₁₇ | (CH₂)ₐ | 0 to 20 | Me | Me | Me | Me | 5 to 100 | Me |
| 6 | c-C₆F₁₁ | (CH₂)ₐ | 0 to 20 | Me | Me | Me | Me | 5 to 100 | Me |
| 7 | CHF₂ | (CH₂)ₐ | 0 to 20 | Me | Me | Me | Me | 5 to 100 | Me |
| 8 | CClF₂ | (CH₂)ₐ | 0 to 20 | Me | Me | Me | Me | 5 to 100 | Me |
| 9 | CBrF₂ | (CH₂)ₐ | 0 to 20 | Me | Me | Me | Me | 5 to 100 | Me |
| 10 | ClF₂ | (CH₂)ₐ | 0 to 20 | Me | Me | Me | Me | 5 to 100 | Me |
| 11 | CF═CF₂ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 1 | Me | (CH₂)_{b} | 0 to 20 | C(═O)NH | (CH₂)_{c} | 1 to 20 | Si(OMe)₃ | 1 |
| 2 | Me | (CH₂)_{b} | 0 to 20 | C(═O)NH | (CH₂)_{c} | 1 to 20 | Si(OMe)₃ | 1 |
| 3 | Me | (CH₂)_{b} | 0 to 20 | C(═O)NH | (CH₂)_{c} | 1 to 20 | Si(OMe)₃ | 1 |
| 4 | Me | (CH₂)_{b} | 0 to 20 | C(═O)NH | (CH₂)_{c} | 1 to 20 | Si(OMe)₃ | 1 |
| 5 | Me | (CH₂)_{b} | 0 to 20 | C(═O)NH | (CH₂)_{c} | 1 to 20 | Si(OMe)₃ | 1 |
| 6 | Me | (CH₂)_{b} | 0 to 20 | C(═O)NH | (CH₂)_{c} | 1 to 20 | Si(OMe)₃ | 1 |
| 7 | Me | (CH₂)_{b} | 0 to 20 | C(═O)NH | (CH₂)_{c} | 1 to 20 | Si(OMe)₃ | 1 |
| 8 | Me | (CH₂)_{b} | 0 to 20 | C(═O)NH | (CH₂)_{c} | 1 to 20 | Si(OMe)₃ | 1 |
| 9 | Me | (CH₂)_{b} | 0 to 20 | C(═O)NH | (CH₂)_{c} | 1 to 20 | Si(OMe)₃ | 1 |
| 10 | Me | (CH₂)_{b} | 0 to 20 | C(═O)NH | (CH₂)_{c} | 1 to 20 | Si(OMe)₃ | 1 |
| 11 | Me | (CH₂)_{b} | 0 to 20 | C(═O)NH | (CH₂)_{c} | 1 to 20 | Si(OMe)₃ | 1 |

TABLE 2

| No. | R^{f1} | L² | a | R¹¹ | R¹² | R¹³ | R¹⁴ | z11 | R¹⁵ |
|---|---|---|---|---|---|---|---|---|---|
| 12 | CF═CFCF₃ | (CH₂)ₐ | 0 to 20 | Me | Me | Me | Me | 5 to 100 | Me |
| 13 | CF═CFCF═CF₂ | (CH₂)ₐ | 0 to 20 | Me | Me | Me | Me | 5 to 100 | Me |
| 14 | C≡CCF₃ | (CH₂)ₐ | 0 to 20 | Me | Me | Me | Me | 5 to 100 | Me |
| 15 | CF₂CH₃ | (CH₂)ₐ | 0 to 20 | Me | Me | Me | Me | 5 to 100 | Me |
| 16 | (CF₂)₂H | (CH₂)ₐ | 0 to 20 | Me | Me | Me | Me | 5 to 100 | Me |
| 17 | (CF₂)₂CH₃ | (CH₂)ₐ | 0 to 20 | Me | Me | Me | Me | 5 to 100 | Me |
| 18 | (CF₂)₄H | (CH₂)ₐ | 0 to 20 | Me | Me | Me | Me | 5 to 100 | Me |
| 19 | C₆F₅ | (CH₂)ₐ | 0 to 20 | Me | Me | Me | Me | 5 to 100 | Me |
| 20 | 4-CF₃C₆F₄ | (CH₂)ₐ | 0 to 20 | Me | Me | Me | Me | 5 to 100 | Me |
| 21 | 4-SF₅C₆F₄ | (CH₂)ₐ | 0 to 20 | Me | Me | Me | Me | 5 to 100 | Me |
| 22 | 3,5-CF₃C₆F₃ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 12 | Me | (CH₂)_{b} | 0 to 20 | C(═O)NH | (CH₂)_{c} | 1 to 20 | Si(OMe)₃ | 1 |
| 13 | Me | (CH₂)_{b} | 0 to 20 | C(═O)NH | (CH₂)_{c} | 1 to 20 | Si(OMe)₃ | 1 |
| 14 | Me | (CH₂)_{b} | 0 to 20 | C(═O)NH | (CH₂)_{c} | 1 to 20 | Si(OMe)₃ | 1 |
| 15 | Me | (CH₂)_{b} | 0 to 20 | C(═O)NH | (CH₂)_{c} | 1 to 20 | Si(OMe)₃ | 1 |
| 16 | Me | (CH₂)_{b} | 0 to 20 | C(═O)NH | (CH₂)_{c} | 1 to 20 | Si(OMe)₃ | 1 |
| 17 | Me | (CH₂)_{b} | 0 to 20 | C(═O)NH | (CH₂)_{c} | 1 to 20 | Si(OMe)₃ | 1 |
| 18 | Me | (CH₂)_{b} | 0 to 20 | C(═O)NH | (CH₂)_{c} | 1 to 20 | Si(OMe)₃ | 1 |
| 19 | Me | (CH₂)_{b} | 0 to 20 | C(═O)NH | (CH₂)_{c} | 1 to 20 | Si(OMe)₃ | 1 |
| 20 | Me | (CH₂)_{b} | 0 to 20 | C(═O)NH | (CH₂)_{c} | 1 to 20 | Si(OMe)₃ | 1 |
| 21 | Me | (CH₂)_{b} | 0 to 20 | C(═O)NH | (CH₂)_{c} | 1 to 20 | Si(OMe)₃ | 1 |
| 22 | Me | (CH₂)_{b} | 0 to 20 | C(═O)NH | (CH₂)_{c} | 1 to 20 | Si(OMe)₃ | 1 |

TABLE 3

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 23 | 3,5-SF₅C₆F₃ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 24 | 4-CF₃C₆H₄ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 25 | 4-SF₅C₆H₄ | (CH₂)ₐ | 10 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 26 | 3,5-CF₃C₆H₃ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 27 | 3,5-SF₅C₆H₃ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 28 | 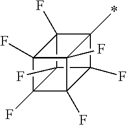 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 29 | 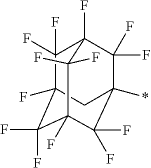 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 30 | 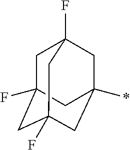 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 31 | SF₅ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 32 | OCF₃ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |
| 33 | SCF₃ | (CH₂)ₐ | 0 to 20 | Me | Me | Me | Me | 5 to 100 | Me | Me | (CH₂)_{b} | 0 to 20 | C(═O)NH | (CH₂)_{c} | 1 to 20 | Si(OMe)₃ | 1 |

TABLE 4

| No. | R^{f1} | L² | a | R¹¹ | R¹² | R¹³ | R¹⁴ | z11 | R¹⁵ |
|---|---|---|---|---|---|---|---|---|---|
| 34 | N(CH₂CF₃)₂ | (CH₂)ₐ | 0 to 20 | Me | Me | Me | Me | 5 to 100 | Me |
| 35 | N(CF₃)₂ | (CH₂)ₐ | 0 to 20 | Me | Me | Me | Me | 5 to 100 | Me |
| 36 | CF₃ | (CH₂)ₐ | 0 to 20 | Me | Me | Me | Me | 5 to 100 | Me |
| 37 | (CF₃)₂CF | (CH₂)ₐ | 0 to 20 | Me | Me | Me | Me | 5 to 100 | Me |
| 38 | (CF₃)₃C | (CH₂)ₐ | 0 to 20 | Me | Me | Me | Me | 5 to 100 | Me |
| 39 | C₄F₉ | (CH₂)ₐ | 0 to 20 | Me | Me | Me | Me | 5 to 100 | Me |
| 40 | C₈F₁₇ | (CH₂)ₐ | 0 to 20 | Me | Me | Me | Me | 5 to 100 | Me |
| 41 | c-C₆F₁₁ | (CH₂)ₐ | 0 to 20 | Me | Me | Me | Me | 5 to 100 | Me |
| 42 | CHF₂ | (CH₂)ₐ | 0 to 20 | Me | Me | Me | Me | 5 to 100 | Me |
| 43 | CClF₂ | (CH₂)ₐ | 0 to 20 | Me | Me | Me | Me | 5 to 100 | Me |
| 44 | CBrF₂ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 34 | Me | (CH₂)_{b} | 0 to 20 | C(═O)NH | (CH₂)_{c} | 1 to 20 | Si(OMe)₃ | 1 |
| 35 | Me | (CH₂)_{b} | 0 to 20 | C(═O)NH | (CH₂)_{c} | 1 to 20 | Si(OMe)₃ | 1 |
| 36 | Me | (CH₂)_{b} | 0 to 20 | NHC(═O) | (CH₂)_{c} | 1 to 20 | Si(OMe)₃ | 1 |
| 37 | Me | (CH₂)_{b} | 0 to 20 | NHC(═O) | (CH₂)_{c} | 1 to 20 | Si(OMe)₃ | 1 |
| 38 | Me | (CH₂)_{b} | 0 to 20 | NHC(═O) | (CH₂)_{c} | 1 to 20 | Si(OMe)₃ | 1 |
| 39 | Me | (CH₂)_{b} | 0 to 20 | NHC(═O) | (CH₂)_{c} | 1 to 20 | Si(OMe)₃ | 1 |
| 40 | Me | (CH₂)_{b} | 0 to 20 | NHC(═O) | (CH₂)_{c} | 1 to 20 | Si(OMe)₃ | 1 |
| 41 | Me | (CH₂)_{b} | 0 to 20 | NHC(═O) | (CH₂)_{c} | 1 to 20 | Si(OMe)₃ | 1 |
| 42 | Me | (CH₂)_{b} | 0 to 20 | NHC(═O) | (CH₂)_{c} | 1 to 20 | Si(OMe)₃ | 1 |
| 43 | Me | (CH₂)_{b} | 0 to 20 | NHC(═O) | (CH₂)_{c} | 1 to 20 | Si(OMe)₃ | 1 |
| 44 | Me | (CH₂)_{b} | 0 to 20 | NHC(═O) | (CH₂)_{c} | 1 to 20 | Si(OMe)₃ | 1 |

TABLE 5

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 45 | CIF₂ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 46 | CF=CF₂ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 47 | CF=CFCF₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 48 | CF=CFCF=CF₂ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 49 | C≡CCF₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 50 | CF₂CH₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 51 | (CF₂)₂H | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 52 | (CF₂)₂CH₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 53 | (CF₂)₄H | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 54 | C₆F₅ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 55 | 4-CF₃C₆F₄ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |

TABLE 6

| No. | R^{f1} | L² | a | R¹¹ | R¹² | R¹³ | R¹⁴ | z11 | R¹⁵ | R¹⁶ | R¹ | b | [L¹ | R² | c | T¹ | x1 |
|---|---|---|---|---|---|---|---|---|---|---|---|---|---|---|---|---|---|
| 56 | 4-SF₅C₆F₄ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 57 | 3,5-CF₃C₆F₃ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 58 | 3,5-SF₅C₆F₃ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 59 | 4-CF₃C₆H₄ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 60 | 4-SF₅C₆H₄ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 61 | 3,5-CF₃C₆H₃ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 62 | 3,5-SF₅C₆H₃ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 63 | 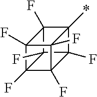 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 64 | 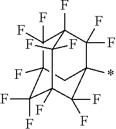 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 65 | 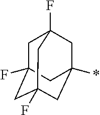 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |
| 66 | SF₅ | (CH₂)ₐ | 0 to 20 | Me | Me | Me | Me | 5 to 100 | Me | Me | (CH₂)_{b} | 0 to 20 | NHC(═O) | (CH₂)_{c} | 1 to 20 | Si(OMe)₃ | 1 |

TABLE 7

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 67 | OCF₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 68 | SCF₃ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 69 | N(CH₂CF₃)₂ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 70 | N(CF₃)₂ | (CH₂)ₐ | 0 to 20 | Me | Me | Me | Me | 5 to 100 | Me | Me | (CH₂)_{b} | 0 to 20 | NHC(=o) | (CH₂)_{c} | 1 to 20 | Si(OMe)₃ | 1 |
| 71 | CF₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 72 | (CF₃)₂CF | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 73 | (CF₃)₃C | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 74 | C₄F₉ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 75 | C₈F₁₇ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 76 | _{C}-C₆F₁₁ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 77 | CHF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |

TABLE 8

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 78 | CCIF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 79 | CBrF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 80 | CIF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 81 | CF=CF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 82 | CF=CFCF₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 83 | CF=CFCF=CF₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 84 | C≡CCF₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 85 | CF₂CH₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 86 | (CF₂)₂H | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 87 | (CF₂)₂CH₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 88 | (CF₂)₄H | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |

TABLE 9

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 89 | C₆F₅ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 90 | 4-CF₃C₆F₄ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 91 | 4-SF₅C₆F₄ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 92 | 3,5-CF₃C₆F₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 93 | 3,5-SF₅C₆F₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 94 | 4-CF₃C₆H₄ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 95 | 4-SF₅C₆H₄ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 96 | 3,5-CF₃C₆H₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 97 | 3,5-SF₅C₆H₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 98 | 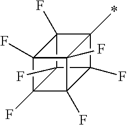 [SMILES: *C12C3(F)C4(F)C1(F)C1(F)C2(F)C3(F)C41F] | (CH₂)ₐ | \|0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 99 | 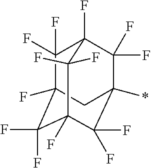 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |

TABLE 10

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 100 | 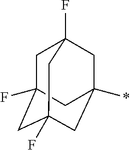 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 101 | SF₅ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 102 | OCF₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 103 | SCF₃ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 104 | N(CH₂CF₃)₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 105 | N(CF₃)₂ | (CH₂)ₐ | 0 to 20 | Me | Me | Me | Me | 5 to 100 | Me | Me | (CH₂)_{b} | 0 to 20 | SiMe₂ | (CH₂)_{c} | 1 to 20 | Si(OMe)₃ | 1 |
| 106 | CF₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 107 | (CF₃)₂CF | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 108 | (CF₃)₃C | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 109 | C₄F₉ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 110 | C₈F₁₇ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |

TABLE 11

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 111 | _{C}-C₆F₁₁ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 112 | CHF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 113 | CCIF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 114 | CBrF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 115 | CIF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 116 | CF=CF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 117 | CF=CFCF₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 118 | CF=CFCF=CF₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 119 | C≡CCF₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 120 | CF₂CH₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 121 | (CF₂)₂H | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |

TABLE 12

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 122 | (CF₂)₂CH₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 123 | (CF₂)₄H | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 124 | C₆F₅ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 125 | 4-CF₃C₆F₄ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 126 | 4-SF₅C₆F₄ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 127 | 3,5-CF₃C₆F₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 128 | 3,5-SF₅C₆F₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 129 | 4-CF₃C₆H₄ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 130 | 4-SF₅C₆H₄ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 131 | 3,5-CF₃C₆H₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 132 | 3,5-SF₅C₆H₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |

TABLE 13

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 133 | 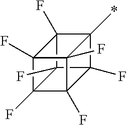 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 134 | 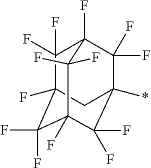 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 135 | 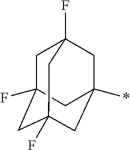 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 136 | SF₅ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 137 | OCF₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 138 | SCF₃ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 139 | N(CH₂CF₃)₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 140 | N(CF₃)₂ | (CH₂)ₐ | 0 to 20 | Me | Me | Me | Me | 5 to 100 | Me | Me | (CH₂)_{b} | 0 to 20 | CH₂ | (CH₂)_{c} | 1 to 20 | Si(OMe)₃ | 1 |
| 141 | CF₃ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 142 | (CF₃)₂CF | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 143 | (CF₃)₃C | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |

TABLE 14

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 144 | C₄F₉ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 145 | C₈F₁₇ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 146 | _{C}-C₆F₁₁ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 147 | CHF₂ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 148 | CCIF₂ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 149 | CBrF₂ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 150 | CIF₂ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 151 | CF=CF₂ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 152 | CF=CFCF₃ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |
| 153 | CF= | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | CFCF=CF₂ | | | | | | | | | | | | NHCH₂CH | | | | |
| 154 | C≡CCF₃ | (CH₂)ₐ | 0 to 20 | Me | Me | Me | Me | 5 to 100 | Me | Me | (CH₂)_{b} | 0 to 20 | C(=O) | (CH₂)_{c} | 1 to 20 | Si(OMe)₃ | 2 |
| | | | | | | | | | | | | | NHCH₂CH | | | | |

TABLE 15

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 155 | CF₂CH₃ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 156 | (CF₂)₂H | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 157 | (CF₂)₂CH₃ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 158 | (CF₂)₄H | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 159 | C₆F₅ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 160 | 4-CF₃C₆F₄ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 161 | 4-SF₅C₆F₄ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 162 | 3,5-CF₃C₆F₃ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 163 | 3,5-SF₅C₆F₃ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 164 | 4-CF₃C₆H₄ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |
| 165 | 4-SF₅C₆H₄ | (CH₂)ₐ | 0 to 20 | Me | Me | Me | Me | 5 to 100 | Me | Me | (CH₂)_{b} | 0 to 20 | C(=O)NHCH₂CH | (CH₂)_{c} | 1 to 20 | Si(OMe)₃ | 2 |

TABLE 16

| No. | R^{f1} | L² | a | R¹¹ | R¹² | R¹³ | R¹⁴ | z11 | R¹⁵ | R¹⁶ | R¹ | b | L¹ | R² | C | T¹ | x1 |
|---|---|---|---|---|---|---|---|---|---|---|---|---|---|---|---|---|---|
| 166 | 3,5-CF₃C₆H₃ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 167 | 3,5-SF₅C₆H₃ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 168 | 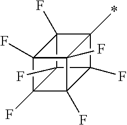 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 169 | 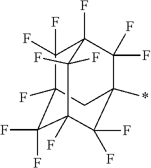 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 170 | 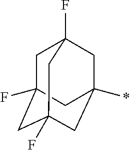 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 171 | SF₅ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 172 | OCF₃ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 173 | SCF₃ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 174 | N(CH₂CF₃)₂ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 175 | N(CF₃)₂ | (CH₂)ₐ | 0 to 20 | Me | Me | Me | Me | 5 to 100 | Me | Me | (CH₂)_{b} | 0 to 20 | C(═O)NHCH₂CH | (CH₂)_{c} | 1 to 20 | Si(OMe)₃ | 2 |
| 176 | CF₃ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |

TABLE 17

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 177 | (CF₃)₂CF | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 178 | (CF₃)₃C | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 179 | C₄F₉ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 180 | C₈F₁₇ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 181 | _{C}-C₆F₁₁ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 182 | CHF₂ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 183 | CCIF₂ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 184 | CBrF₂ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 185 | CIF₂ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 186 | CF=CF₂ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |
| 187 | CF=CFCF₃ | (CH₂)ₐ | 0 to 20 | Me | Me | Me | Me | 5 to 100 | Me | Me | (CH₂)_{b} | 0 to 20 | NHC(=O)CH₂CH | (CH₂)_{c} | 1 to 20 | Si(OMe)₃ | 2 |

TABLE 18

| No. | R^{f1} | L² | a | R¹¹ | R¹² | R¹³ | R¹⁴ | z11 | R¹⁵ |
|---|---|---|---|---|---|---|---|---|---|
| 188 | CF═CFCF═CF₂ | (CH₂)ₐ | 0 to 20 | Me | Me | Me | Me | 5 to 100 | Me |
| 189 | C≡CCF₃ | (CH₂)ₐ | 0 to 20 | Me | Me | Me | Me | 5 to 100 | Me |
| 190 | CF₂CH₃ | (CH₂)ₐ | 0 to 20 | Me | Me | Me | Me | 5 to 100 | Me |
| 191 | (CF₂)₂H | (CH₂)ₐ | 0 to 20 | Me | Me | Me | Me | 5 to 100 | Me |
| 192 | (CF₂)₂CH₃ | (CH₂)ₐ | 0 to 20 | Me | Me | Me | Me | 5 to 100 | Me |
| 193 | (CF₂)₄H | (CH₂)ₐ | 0 to 20 | Me | Me | Me | Me | 5 to 100 | Me |
| 194 | C₆F₅ | (CH₂)ₐ | 0 to 20 | Me | Me | Me | Me | 5 to 100 | Me |
| 195 | 4-CF₃C₆F₄ | (CH₂)ₐ | 0 to 20 | Me | Me | Me | Me | 5 to 100 | Me |
| 196 | 4-SF₅C₆F₄ | (CH₂)ₐ | 0 to 20 | Me | Me | Me | Me | 5 to 100 | Me |
| 197 | 3,5-CF₃C₆F₃ | (CH₂)ₐ | 0 to 20 | Me | Me | Me | Me | 5 to 100 | Me |
| 198 | 3,5-SF₅C₆F₃ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 188 | Me | (CH₂)_{b} | 0 to 20 | NHC(═O)CH₂CH | (CH₂)_{c} | 1 to 20 | Si(OMe)₃ | 2 |
| 189 | Me | (CH₂)_{b} | 0 to 20 | NHC(═O)CH₂CH | (CH₂)_{c} | 1 to 20 | Si(OMe)₃ | 2 |
| 190 | Me | (CH₂)_{b} | 0 to 20 | NHC(═O)CH₂CH | (CH₂)_{c} | 1 to 20 | Si(OMe)₃ | 2 |
| 191 | Me | (CH₂)_{b} | 0 to 20 | NHC(═O)CH₂CH | (CH₂)_{c} | 1 to 20 | Si(OMe)₃ | 2 |
| 192 | Me | (CH₂)_{b} | 0 to 20 | NHC(═O)CH₂CH | (CH₂)_{c} | 1 to 20 | Si(OMe)₃ | 2 |
| 193 | Me | (CH₂)_{b} | 0 to 20 | NHC(═O)CH₂CH | (CH₂)_{c} | 1 to 20 | Si(OMe)₃ | 2 |
| 194 | Me | (CH₂)_{b} | 0 to 20 | NHC(═O)CH₂CH | (CH₂)_{c} | 1 to 20 | Si(OMe)₃ | 2 |
| 195 | Me | (CH₂)_{b} | 0 to 20 | NHC(═O)CH₂CH | (CH₂)_{c} | 1 to 20 | Si(OMe)₃ | 2 |
| 196 | Me | (CH₂)_{b} | 0 to 20 | NHC(═O)CH₂CH | (CH₂)_{c} | 1 to 20 | Si(OMe)₃ | 2 |
| 197 | Me | (CH₂)_{b} | 0 to 20 | NHC(═O)CH₂CH | (CH₂)_{c} | 1 to 20 | Si(OMe)₃ | 2 |
| 198 | Me | (CH₂)_{b} | 0 to 20 | NHC(═O)CH₂CH | (CH₂)_{c} | 1 to 20 | Si(OMe)₃ | 2 |

TABLE 19

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 199 | 4-CF₃C₆H₄ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 200 | 4-SF₅C₆H₄ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 201 | 3,5-CF₃C₆H₃ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 202 | 3,5-SF₅C₆H₃ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 203 | 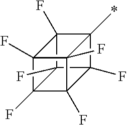 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 204 | 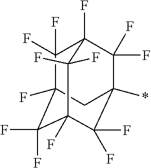 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 205 | 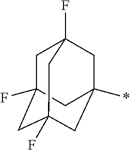 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 206 | SF₅ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 207 | OCF₃ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 208 | SCF₃ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |
| 209 | N(CH₂CF₃)₂ | (CH₂)ₐ | 0 to 20 | Me | Me | Me | Me | 5 to 100 | Me | Me | (CH₂)_{b} | 0 to 20 | NHC(═O)CH₂CH | (CH₂)_{c} | 1 to 20 | Si(OMe)₃ | 2 |

TABLE 20

| No. | R^{f1} | L² | a | R¹¹ | R¹² | R¹³ | R¹⁴ | z11 | R¹⁵ | R¹⁶ |
|---|---|---|---|---|---|---|---|---|---|---|
| 210 | N(CF₃)₂ | (CH₂)ₐ | 0 to 20 | Me | Me | Me | Me | 5 to 100 | Me | Me |
| 211 | CF₃ | (CH₂)ₐ | 0 to 20 | Me | Me | Me | Me | 5 to 100 | Me | Me |
| 212 | (CF₃)₂CF | (CH₂)ₐ | 0 to 20 | Me | Me | Me | Me | 5 to 100 | Me | Me |
| 213 | (CF₃)₃C | (CH₂)ₐ | 0 to 20 | Me | Me | Me | Me | 5 to 100 | Me | Me |
| 214 | C₄F₉ | (CH₂)ₐ | 0 to 20 | Me | Me | Me | Me | 5 to 100 | Me | Me |
| 215 | C₈F₁₇ | (CH₂)ₐ | 0 to 20 | Me | Me | Me | Me | 5 to 100 | Me | Me |
| 216 | c-C₆F₁₁ | (CH₂)ₐ | 0 to 20 | Me | Me | Me | Me | 5 to 100 | Me | Me |
| 217 | CHF₂ | (CH₂)ₐ | 0 to 20 | Me | Me | Me | Me | 5 to 100 | Me | Me |
| 218 | CClF₂ | (CH₂)ₐ | 0 to 20 | Me | Me | Me | Me | 5 to 100 | Me | Me |
| 219 | CBrF₂ | (CH₂)ₐ | 0 to 20 | Me | Me | Me | Me | 5 to 100 | Me | Me |
| 220 | ClF₂ | (CH₂)ₐ | 0 to 20 | Me | Me | Me | Me | 5 to 100 | Me | Me |

| No. | R¹ | b | L¹ | R² | c | T¹ | x1 |
|---|---|---|---|---|---|---|---|
| 210 | (CH₂)_{b} | 0 to 20 | NHC(═O)CH₂CH | (CH₂)_{c} | 1 to 20 | Si(OMe)₃ | 2 |
| 211 | (CH₂)_{b} | 0 to 20 | SiMe | (CH₂)_{c} | 1 to 20 | Si(OMe)₃ | 2 |
| 212 | (CH₂)_{b} | 0 to 20 | SiMe | (CH₂)_{c} | 1 to 20 | Si(OMe)₃ | 2 |
| 213 | (CH₂)_{b} | 0 to 20 | SiMe | (CH₂)_{c} | 1 to 20 | Si(OMe)₃ | 2 |
| 214 | (CH₂)_{b} | 0 to 20 | SiMe | (CH₂)_{c} | 1 to 20 | Si(OMe)₃ | 2 |
| 215 | (CH₂)_{b} | 0 to 20 | SiMe | (CH₂)_{c} | 1 to 20 | Si(OMe)₃ | 2 |
| 216 | (CH₂)_{b} | 0 to 20 | SiMe | (CH₂)_{c} | 1 to 20 | Si(OMe)₃ | 2 |
| 217 | (CH₂)_{b} | 0 to 20 | SiMe | (CH₂)_{c} | 1 to 20 | Si(OMe)₃ | 2 |
| 218 | (CH₂)_{b} | 0 to 20 | SiMe | (CH₂)_{c} | 1 to 20 | Si(OMe)₃ | 2 |
| 219 | (CH₂)_{b} | 0 to 20 | SiMe | (CH₂)_{c} | 1 to 20 | Si(OMe)₃ | 2 |
| 220 | (CH₂)_{b} | 0 to 20 | SiMe | (CH₂)_{c} | 1 to 20 | Si(OMe)₃ | 2 |

TABLE 21

| No. | R^{f1} | L² | a | R¹¹ | R¹² | R¹³ | R¹⁴ | z11 |
|---|---|---|---|---|---|---|---|---|
| 221 | CF═CF₂ | (CH₂)ₐ | 0 to 20 | Me | Me | Me | Me | 5 to 100 |
| 222 | CF═CFCF₃ | (CH₂)ₐ | 0 to 20 | Me | Me | Me | Me | 5 to 100 |
| 223 | CF═CFCF═CF₂ | (CH₂)ₐ | 0 to 20 | Me | Me | Me | Me | 5 to 100 |
| 224 | C═CCF₃ | (CH₂)ₐ | 0 to 20 | Me | Me | Me | Me | 5 to 100 |
| 225 | CF₂CH₃ | (CH₂)ₐ | 0 to 20 | Me | Me | Me | Me | 5 to 100 |
| 226 | (CF₂)₂H | (CH₂)ₐ | 0 to 20 | Me | Me | Me | Me | 5 to 100 |
| 227 | (CF₂)₂CH₃ | (CH₂)ₐ | 0 to 20 | Me | Me | Me | Me | 5 to 100 |
| 228 | (CF₂)₄H | (CH₂)ₐ | 0 to 20 | Me | Me | Me | Me | 5 to 100 |
| 229 | C₆F₅ | (CH₂)ₐ | 0 to 20 | Me | Me | Me | Me | 5 to 100 |
| 230 | ₄-CF₃C₆F₄ | (CH₂)ₐ | 0 to 20 | Me | Me | Me | Me | 5 to 100 |
| 231 | ₄-SF₅C₆F₄ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 221 | Me | Me | (CH₂)_{b} | 0 to 20 | SiMe | (CH₂)_{c} | 1 to 20 | Si(OMe)₃ | 2 |
| 222 | Me | Me | (CH₂)_{b} | 0 to 20 | SiMe | (CH₂)_{c} | 1 to 20 | Si(OMe)₃ | 2 |
| 223 | Me | Me | (CH₂)_{b} | 0 to 20 | SiMe | (CH₂)_{c} | 1 to 20 | Si(OMe)₃ | 2 |
| 224 | Me | Me | (CH₂)_{b} | 0 to 20 | SiMe | (CH₂)_{c} | 1 to 20 | Si(OMe)₃ | 2 |
| 225 | Me | Me | (CH₂)_{b} | 0 to 20 | SiMe | (CH₂)_{c} | 1 to 20 | Si(OMe)₃ | 2 |
| 226 | Me | Me | (CH₂)_{b} | 0 to 20 | SiMe | (CH₂)_{c} | 1 to 20 | Si(OMe)₃ | 2 |
| 227 | Me | Me | (CH₂)_{b} | 0 to 20 | SiMe | (CH₂)_{c} | 1 to 20 | Si(OMe)₃ | 2 |
| 228 | Me | Me | (CH₂)_{b} | 0 to 20 | SiMe | (CH₂)_{c} | 1 to 20 | Si(OMe)₃ | 2 |
| 229 | Me | Me | (CH₂)_{b} | 0 to 20 | SiMe | (CH₂)_{c} | 1 to 20 | Si(OMe)₃ | 2 |
| 230 | Me | Me | (CH₂)_{b} | 0 to 20 | SiMe | (CH₂)_{c} | 1 to 20 | Si(OMe)₃ | 2 |
| 231 | Me | Me | (CH₂)_{b} | 0 to 20 | SiMe | (CH₂)_{c} | 1 to 20 | Si(OMe)₃ | 2 |

TABLE 22

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 232 | 3,5-CF₃C₆F₃ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 233 | 3,5-SF₅C₆F₃ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 234 | 4-CF₃C₆H₄ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 235 | 4-SF₅C₆H₄ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 236 | 3,5-CF₃C₆H₃ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 237 | 3,5-SF₅C₆H₃ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 238 | 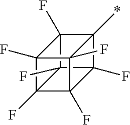 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 239 | 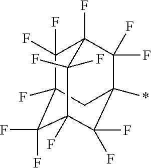 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 240 | 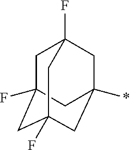 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |
| 241 | SF₅ | (CH₂)ₐ | 0 to 20 \| | Me | Me | Me | Me | 5 to 100 | Me | Me | (CH₂)_{b} | 0 to 20 | SiMe | (CH₂)_{c} | 1 to 20 | Si(OMe)₃ | 2 |
| 242 | OCF₃ | (CH₂)ₐ | 0 to 20 | Me | Me | Me | Me | 5 to 100 | Me | Me | (CH₂)_{b} | 0 to 20 | SiMe | (CH₂)_{c} | 1 to 20 | Si(OMe)₃ | 2 |

TABLE 23

| No. | R^{f1} | L² | a | R¹¹ | R¹² | R¹³ | R¹⁴ | z11 |
|---|---|---|---|---|---|---|---|---|
| 243 | SCF₃ | (CH₂)ₐ | 0 to 20 | Me | Me | Me | Me | 5 to 100 |
| 244 | N(CH₂CF₃)₂ | (CH₂)ₐ | 0 to 20 | Me | Me | Me | Me | 5 to 100 |
| 245 | N(CF₃)₂ | (CH₂)ₐ | 0 to 20 | Me | Me | Me | Me | 5 to 100 |
| 246 | CF₃ | (CH₂)ₐ | 0 to 20 | Me | Me | Me | Me | 5 to 100 |
| 247 | (CF₃)₂CF | (CH₂)ₐ | 0 to 20 | Me | Me | Me | Me | 5 to 100 |
| 248 | (CF₃)₃C | (CH₂)ₐ | 0 to 20 | Me | Me | Me | Me | 5 to 100 |
| 249 | C₄F₉ | (CH₂)ₐ | 0 to 20 | Me | Me | Me | Me | 5 to 100 |
| 250 | C₈F₁₇ | (CH₂)ₐ | 0 to 20 | Me | Me | Me | Me | 5 to 100 |
| 251 | c-C₆F₁₁ | (CH₂)ₐ | 0 to 20 | Me | Me | Me | Me | 5 to 100 |
| 252 | CHF₂ | (CH₂)ₐ | 0 to 20 | Me | Me | Me | Me | 5 to 100 |
| 253 | CClF₂ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 243 | Me | Me | (CH₂)_{b} | 0 to 20 | SiMe | (CH₂)_{c} | 1 to 20 | Si(OMe)₃ | 2 |
| 244 | Me | Me | (CH₂)_{b} | 0 to 20 | SiMe | (CH₂)_{c} | 1 to 20 | Si(OMe)₃ | 2 |
| 245 | Me | Me | (CH₂)_{b} | 0 to 20 | SiMe | (CH₂)_{c} | 1 to 20 | Si(OMe)₃ | 2 |
| 246 | Me | Me | (CH₂)_{b} | 0 to 20 | CH | (CH₂)_{c} | 1 to 20 | Si(OMe)₃ | 2 |
| 247 | Me | Me | (CH₂)_{b} | 0 to 20 | CH | (CH₂)_{c} | 1 to 20 | Si(OMe)₃ | 2 |
| 248 | Me | Me | (CH₂)_{b} | 0 to 20 | CH | (CH₂)_{c} | 1 to 20 | Si(OMe)₃ | 2 |
| 249 | Me | Me | (CH₂)_{b} | 0 to 20 | CH | (CH₂)_{c} | 1 to 20 | Si(OMe)₃ | 2 |
| 250 | Me | Me | (CH₂)_{b} | 0 to 20 | CH | (CH₂)_{c} | 1 to 20 | Si(OMe)₃ | 2 |
| 251 | Me | Me | (CH₂)_{b} | 0 to 20 | CH | (CH₂)_{c} | 1 to 20 | Si(OMe)₃ | 2 |
| 252 | Me | Me | (CH₂)_{b} | 0 to 20 | CH | (CH₂)_{c} | 1 to 20 | Si(OMe)₃ | 2 |
| 253 | Me | Me | (CH₂)_{b} | 0 to 20 | CH | (CH₂)_{c} | 1 to 20 | Si(OMe)₃ | 2 |

TABLE 24

| No. | R^{f1} | L² | a | R¹¹ | R¹² | R¹³ | R¹⁴ | z11 |
|---|---|---|---|---|---|---|---|---|
| 254 | CBrF₂ | (CH₂)ₐ | 0 to 20 | Me | Me | Me | Me | 5 to 100 |
| 255 | ClF₂ | (CH₂)ₐ | 0 to 20 | Me | Me | Me | Me | 5 to 100 |
| 256 | CF═CF₂ | (CH₂)ₐ | 0 to 20 | Me | Me | Me | Me | 5 to 100 |
| 257 | CF═CFCF₃ | (CH₂)ₐ | 0 to 20 | Me | Me | Me | Me | 5 to 100 |
| 258 | CF═CFCF═CF₂ | (CH₂)ₐ | 0 to 20 | Me | Me | Me | Me | 5 to 100 |
| 259 | C≡CCF₃ | (CH₂)ₐ | 0 to 20 | Me | Me | Me | Me | 5 to 100 |
| 260 | CF₂CH₃ | (CH₂)ₐ | 0 to 20 | Me | Me | Me | Me | 5 to 100 |
| 261 | (CF₂)₂H | (CH₂)ₐ | 0 to 20 | Me | Me | Me | Me | 5 to 100 |
| 262 | (CF₂)₂CH₃ | (CH₂)ₐ | 0 to 20 | Me | Me | Me | Me | 5 to 100 |
| 263 | (CF₂)₄H | (CH₂)ₐ | 0 to 20 | Me | Me | Me | Me | 5 to 100 |
| 264 | C₆F₅ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 254 | Me | Me | (CH₂)_{b} | 0 to 20 | CH | (CH₂)_{c} | 1 to 20 | Si(OMe)₃ | 2 |
| 255 | Me | Me | (CH₂)_{b} | 0 to 20 | CH | (CH₂)_{c} | 1 to 20 | Si(OMe)₃ | 2 |
| 256 | Me | Me | (CH₂)_{b} | 0 to 20 | CH | (CH₂)_{c} | 1 to 20 | Si(OMe)₃ | 2 |
| 257 | Me | Me | (CH₂)_{b} | 0 to 20 | CH | (CH₂)_{c} | 1 to 20 | Si(OMe)₃ | 2 |
| 258 | Me | Me | (CH₂)_{b} | 0 to 20 | CH | (CH₂)_{c} | 1 to 20 | Si(OMe)₃ | 2 |
| 259 | Me | Me | (CH₂)_{b} | 0 to 20 | CH | (CH₂)_{c} | 1 to 20 | Si(OMe)₃ | 2 |
| 260 | Me | Me | (CH₂)_{b} | 0 to 20 | CH | (CH₂)_{c} | 1 to 20 | Si(OMe)₃ | 2 |
| 261 | Me | Me | (CH₂)_{b} | 0 to 20 | CH | (CH₂)_{c} | 1 to 20 | Si(OMe)₃ | 2 |
| 262 | Me | Me | (CH₂)_{b} | 0 to 20 | CH | (CH₂)_{c} | 1 to 20 | Si(OMe)₃ | 2 |
| 263 | Me | Me | (CH₂)_{b} | 0 to 20 | CH | (CH₂)_{c} | 1 to 20 | Si(OMe)₃ | 2 |
| 264 | Me | Me | (CH₂)_{b} | 0 to 20 | CH | (CH₂)_{c} | 1 to 20 | Si(OMe)₃ | 2 |

TABLE 25

| No. | R^{f1} | L² | a | R¹¹ | R¹² | R¹³ | R¹⁴ | z11 | R¹⁵ | R¹⁶ | R¹ | b | L² | R² | c | T¹ | x1 |
|---|---|---|---|---|---|---|---|---|---|---|---|---|---|---|---|---|---|
| 265 | 4-CF₃C₆F₄ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 266 | 4-SF₅C₆F₄ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 267 | 3,5-CF₃C₆F₃ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 268 | 3,5-SF₅C₆F₃ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 269 | 4-CF₃C₆H₄ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 270 | 4-SF₅C₆H₄ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 271 | 3,5-CF₃C₆H₃ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 272 | 3,5-SF₅C₆H₃ | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 273 | 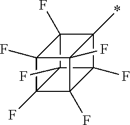 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 274 | 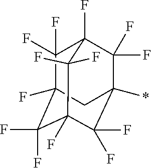 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |
| 275 | 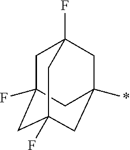 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | CH | (CH₂)_{c} | 1 to 20 | Si(OMe)₃ | 2 |

TABLE 26

| No. | R^{f1} | L² | a | R¹¹ | R¹² | R¹³ | R¹⁴ | z11 | R¹⁵ |
|---|---|---|---|---|---|---|---|---|---|
| 276 | SF₅ | (CH₂)ₐ | 0 to 20 | Me | Me | Me | Me | 5 to 100 | Me |
| 277 | OCF₃ | (CH₂)ₐ | 0 to 20 | Me | Me | Me | Me | 5 to 100 | Me |
| 278 | SCF₃ | (CH₂)ₐ | 0 to 20 | Me | Me | Me | Me | 5 to 100 | Me |
| 279 | N(CH₂CF₃)₂ | (CH₂)ₐ | 0 to 20 | Me | Me | Me | Me | 5 to 100 | Me |
| 280 | N(CF₃)₂ | (CH₂)ₐ | 0 to 20 | Me | Me | Me | Me | 5 to 100 | Me |
| 281 | CF₃ | (CH₂)ₐ | 0 to 20 | Me | Me | Me | Me | 5 to 100 | Me |
| 282 | (CF₃)₂CF | (CH₂)ₐ | 0 to 20 | Me | Me | Me | Me | 5 to 100 | Me |
| 283 | (CF₃)₃C | (CH₂)ₐ | 0 to 20 | Me | Me | Me | Me | 5 to 100 | Me |
| 284 | C₄F₉ | (CH₂)ₐ | 0 to 20 | Me | Me | Me | Me | 5 to 100 | Me |
| 285 | C₈F₁₇ | (CH₂)ₐ | 0 to 20 | Me | Me | Me | Me | 5 to 100 | Me |
| 286 | c-C₆F₁₁ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 276 | Me | (CH₂)_{b} | 0 to 20 | CH | (CH₂)_{c} | 1 to 20 | Si(OMe)₃ | 2 |
| 277 | Me | (CH₂)_{b} | 0 to 20 | CH | (CH₂)_{c} | 1 to 20 | Si(OMe)₃ | 2 |
| 278 | Me | (CH₂)_{b} | 0 to 20 | CH | (CH₂)_{c} | 1 to 20 | Si(OMe)₃ | 2 |
| 279 | Me | (CH₂)_{b} | 0 to 20 | CH | (CH₂)_{c} | 1 to 20 | Si(OMe)₃ | 2 |
| 280 | Me | (CH₂)_{b} | 0 to 20 | CH | (CH₂)_{c} | 1 to 20 | Si(OMe)₃ | 2 |
| 281 | Me | (CH₂)_{b} | 0 to 20 | C(═O)NHCH₂C | (CH₂)_{c} | 1 to 20 | Si(OMe)₃ | 3 |
| 282 | Me | (CH₂)_{b} | 0 to 20 | C(═O)NHCH₂C | (CH₂)_{c} | 1 to 20 | Si(OMe)₃ | 3 |
| 283 | Me | (CH₂)_{b} | 0 to 20 | C(═O)NHCH₂C | (CH₂)_{c} | 1 to 20 | Si(OMe)₃ | 3 |
| 284 | Me | (CH₂)_{b} | 0 to 20 | C(═O)NHCH₂C | (CH₂)_{c} | 1 to 20 | Si(OMe)₃ | 3 |
| 285 | Me | (CH₂)_{b} | 0 to 20 | C(═O)NHCH₂C | (CH₂)_{c} | 1 to 20 | Si(OMe)₃ | 3 |
| 286 | Me | (CH₂)_{b} | 0 to 20 | C(═O)NHCH₂C | (CH₂)_{c} | 1 to 20 | Si(OMe)₃ | 3 |

TABLE 27

| No. | R^{f1} | L² | a | R¹¹ | R¹² | R¹³ | R¹⁴ | z11 | R¹⁵ |
|---|---|---|---|---|---|---|---|---|---|
| 287 | CHF₂ | (CH₂)ₐ | 0 to 20 | Me | Me | Me | Me | 5 to 100 | Me |
| 288 | CClF₂ | (CH₂)ₐ | 0 to 20 | Me | Me | Me | Me | 5 to 100 | Me |
| 289 | CBrF₂ | (CH₂)ₐ | 0 to 20 | Me | Me | Me | Me | 5 to 100 | Me |
| 290 | ClF₂ | (CH₂)ₐ | 0 to 20 | Me | Me | Me | Me | 5 to 100 | Me |
| 291 | CF═CF₂ | (CH₂)ₐ | 0 to 20 | Me | Me | Me | Me | 5 to 100 | Me |
| 292 | CF═CFCF₃ | (CH₂)ₐ | 0 to 20 | Me | Me | Me | Me | 5 to 100 | Me |
| 293 | CF═CFCF═CF₂ | (CH₂)ₐ | 0 to 20 | Me | Me | Me | Me | 5 to 100 | Me |
| 294 | C≡CCF₃ | (CH₂)ₐ | 0 to 20 | Me | Me | Me | Me | 5 to 100 | Me |
| 295 | CF₂CH₃ | (CH₂)ₐ | 0 to 20 | Me | Me | Me | Me | 5 to 100 | Me |
| 296 | (CF₂)₂H | (CH₂)ₐ | 0 to 20 | Me | Me | Me | Me | 5 to 100 | Me |
| 297 | (CF₂)₂CH₃ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 287 | Me | (CH₂)_{b} | 0 to 20 | C(═O)NHCH₂C | (CH₂)_{c} | 1 to 20 | Si(OMe)₃ | 3 |
| 288 | Me | (CH₂)_{b} | 0 to 20 | C(═O)NHCH₂C | (CH₂)_{c} | 1 to 20 | Si(OMe)₃ | 3 |
| 289 | Me | (CH₂)_{b} | 0 to 20 | C(═O)NHCH₂C | (CH₂)_{c} | 1 to 20 | Si(OMe)₃ | 3 |
| 290 | Me | (CH₂)_{b} | 0 to 20 | C(═O)NHCH₂C | (CH₂)_{c} | 1 to 20 | Si(OMe)₃ | 3 |
| 291 | Me | (CH₂)_{b} | 0 to 20 | C(═O)NHCH₂C | (CH₂)_{c} | 1 to 20 | Si(OMe)₃ | 3 |
| 292 | Me | (CH₂)_{b} | 0 to 20 | C(═O)NHCH₂C | (CH₂)_{c} | 1 to 20 | Si(OMe)₃ | 3 |
| 293 | Me | (CH₂)_{b} | 0 to 20 | C(═O)NHCH₂C | (CH₂)_{c} | 1 to 20 | Si(OMe)₃ | 3 |
| 294 | Me | (CH₂)_{b} | 0 to 20 | C(═O)NHCH₂C | (CH₂)_{c} | 1 to 20 | Si(OMe)₃ | 3 |
| 295 | Me | (CH₂)_{b} | 0 to 20 | C(═O)NHCH₂C | (CH₂)_{c} | 1 to 20 | Si(OMe)₃ | 3 |
| 296 | Me | (CH₂)_{b} | 0 to 20 | C(═O)NHCH₂C | (CH₂)_{c} | 1 to 20 | Si(OMe)₃ | 3 |
| 297 | Me | (CH₂)_{b} | 0 to 20 | C(═O)NHCH₂C | (CH₂)_{c} | 1 to 20 | Si(OMe)₃ | 3 |

TABLE 28

| No. | R^{f1} | L² | a | R¹¹ | R¹² | R¹³ | R¹⁴ | z11 | R¹⁵ | R¹⁶ | R¹ | b | [L¹ | R² | c | T¹ | x1 |
|---|---|---|---|---|---|---|---|---|---|---|---|---|---|---|---|---|---|
| 298 | (CF₂)₄H | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 299 | C₆F₅ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 300 | 4-CF₃C₆F₄ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 301 | 4-SF₅C₆F₄ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 302 | 3,5-CF₃C₆F₃ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 303 | 3,5-SF5C6F3 | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 304 | 4-CF₃C₆H₄ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 305 | 4-SF₅C₆H₄ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 306 | 3,5-CF₃C₆H₃ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 307 | 3,5-SF₅C₆H₃ | (CH₂)ₐ | 0 to20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 308 | 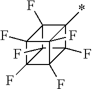 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |

TABLE 29

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 309 | 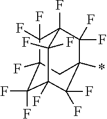 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 310 | 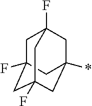 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 311 | SF₅ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 312 | OCF₃ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 313 | SCF₃ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 314 | N(CH₂CF₃)₂ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 315 | N(CF₃)₂ | (CH₂)ₐ | 0 to 20 | Me | Me | Me | Me | 5 to 100 | Me | Me | (CH₂)_{b} | 0 to 20 | C(═O)NHCH₂C | (CH₂)_{c} | 1 to 20 | Si(OMe)₃ | 3 |
| 316 | CF₃ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 317 | (CF₃)₂CF | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 318 | (CF₃)₃C | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 319 | C₄F₉ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |

TABLE 30

| No. | R^{f1} | L² | a | R¹¹ | R¹² | R¹³ | R¹⁴ | z11 | R¹⁵ |
|---|---|---|---|---|---|---|---|---|---|
| 320 | C₈F₁₇ | (CH₂)ₐ | 0 to 20 | Me | Me | Me | Me | 5 to 100 | Me |
| 321 | c-C₆F₁₁ | (CH₂)ₐ | 0 to 20 | Me | Me | Me | Me | 5 to 100 | Me |
| 322 | CHF₂ | (CH₂)ₐ | 0 to 20 | Me | Me | Me | Me | 5 to 100 | Me |
| 323 | CClF₂ | (CH₂)ₐ | 0 to 20 | Me | Me | Me | Me | 5 to 100 | Me |
| 324 | CBrF₂ | (CH₂)ₐ | 0 to 20 | Me | Me | Me | Me | 5 to 100 | Me |
| 325 | ClF₂ | (CH₂)ₐ | 0 to 20 | Me | Me | Me | Me | 5 to 100 | Me |
| 326 | CF═CF₂ | (CH₂)ₐ | 0 to 20 | Me | Me | Me | Me | 5 to 100 | Me |
| 327 | CF═CFCF₃ | (CH₂)ₐ | 0 to 20 | Me | Me | Me | Me | 5 to 100 | Me |
| 328 | CF═CFCF═CF₂ | (CH₂)ₐ | 0 to 20 | Me | Me | Me | Me | 5 to 100 | Me |
| 329 | C≡CCF₃ | (CH₂)ₐ | 0 to 20 | Me | Me | Me | Me | 5 to 100 | Me |
| 330 | CF₂CH₃ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 320 | Me | (CH₂)_{b} | 0 to 20 | NHC(═O)CH₂C | (CH₂)_{c} | 1 to 20 | Si(OMe)₃ | 3 |
| 321 | Me | (CH₂)_{b} | 0 to 20 | NHC(═O)CH₂C | (CH₂)_{c} | 1 to 20 | Si(OMe)₃ | 3 |
| 322 | Me | (CH₂)_{b} | 0 to 20 | NHC(═O)CH₂C | (CH₂)_{c} | 1 to 20 | Si(OMe)₃ | 3 |
| 323 | Me | (CH₂)_{b} | 0 to 20 | NHC(═O)CH₂C | (CH₂)_{c} | 1 to 20 | Si(OMe)₃ | 3 |
| 324 | Me | (CH₂)_{b} | 0 to 20 | NHC(═O)CH₂C | (CH₂)_{c} | 1 to 20 | Si(OMe)₃ | 3 |
| 325 | Me | (CH₂)_{b} | 0 to 20 | NHC(═O)CH₂C | (CH₂)_{c} | 1 to 20 | Si(OMe)₃ | 3 |
| 326 | Me | (CH₂)_{b} | 0 to 20 | NHC(═O)CH₂C | (CH₂)_{c} | 1 to 20 | Si(OMe)₃ | 3 |
| 327 | Me | (CH₂)_{b} | 0 to 20 | NHC(═O)CH₂C | (CH₂)_{c} | 1 to 20 | Si(OMe)₃ | 3 |
| 328 | Me | (CH₂)_{b} | 0 to 20 | NHC(═O)CH₂C | (CH₂)_{c} | 1 to 20 | Si(OMe)₃ | 3 |
| 329 | Me | (CH₂)_{b} | 0 to 20 | NHC(═O)CH₂C | (CH₂)_{c} | 1 to 20 | Si(OMe)₃ | 3 |
| 330 | Me | (CH₂)_{b} | 0 to 20 | NHC(═O)CH₂C | (CH₂)_{c} | 1 to 20 | Si(OMe)₃ | 3 |

TABLE 31

| No. | R^{f1} | L² | a | R¹¹ | R¹² | R¹³ | R¹⁴ | z11 | R¹⁵ |
|---|---|---|---|---|---|---|---|---|---|
| 331 | (CF₂)₂H | (CH₂)ₐ | 0 to 20 | Me | Me | Me | Me | 5 to 100 | Me |
| 332 | (CF₂)₂CH₃ | (CH₂)ₐ | 0 to 20 | Me | Me | Me | Me | 5 to 100 | Me |
| 333 | (CF₂)₄H | (CH₂)ₐ | 0 to 20 | Me | Me | Me | Me | 5 to 100 | Me |
| 334 | C₆F₅ | (CH₂)ₐ | 0 to 20 | Me | Me | Me | Me | 5 to 100 | Me |
| 335 | 4-CF₃C₆F₄ | (CH₂)ₐ | 0 to 20 | Me | Me | Me | Me | 5 to 100 | Me |
| 336 | 4-SF₅C₆F₄ | (CH₂)ₐ | 0 to 20 | Me | Me | Me | Me | 5 to 100 | Me |
| 337 | 3,5-CF₃C₆F₃ | (CH₂)ₐ | 0 to 20 | Me | Me | Me | Me | 5 to 100 | Me |
| 338 | 3,5-SF₅C₆F₃ | (CH₂)ₐ | 0 to 20 | Me | Me | Me | Me | 5 to 100 | Me |
| 339 | 4-CF₃C₆H₄ | (CH₂)ₐ | 0 to 20 | Me | Me | Me | Me | 5 to 100 | Me |
| 340 | 4-SF₅C₆H₄ | (CH₂)ₐ | 0 to 20 | Me | Me | Me | Me | 5 to 100 | Me |
| 341 | 3,5-CF₃C₆H₃ | (CH₂)ₐ | 0 to 20 | Me | Me | Me | Me | 5 to 100 | Me |

| No. | R¹⁶ | R¹ | b | L¹ | R² | c | T¹ | x1 |
|---|---|---|---|---|---|---|---|---|
| 331 | Me | (CH₂)_{b} | 0 to 20 | NHC(═O)CH₂C | (CH₂)_{c} | 1 to 20 | Si(OMe)₃ | 3 |
| 332 | Me | (CH₂)_{b} | 0 to 20 | NHC(═O)CH₂C | (CH₂)_{c} | 1 to 20 | Si(OMe)₃ | 3 |
| 333 | Me | (CH₂)_{b} | 0 to 20 | NHC(═O)CH₂C | (CH₂)_{c} | 1 to 20 | Si(OMe)₃ | 3 |
| 334 | Me | (CH₂)_{b} | 0 to 20 | NHC(═O)CH₂C | (CH₂)_{c} | 1 to 20 | Si(OMe)₃ | 3 |
| 335 | Me | (CH₂)_{b} | 0 to 20 | NHC(═O)CH₂C | (CH₂)_{c} | 1 to 20 | Si(OMe)₃ | 3 |
| 336 | Me | (CH₂)_{b} | 0 to 20 | NHC(═O)CH₂C | (CH₂)_{c} | 1 to 20 | Si(OMe)₃ | 3 |
| 337 | Me | (CH₂)_{b} | 0 to 20 | NHC(═O)CH₂C | (CH₂)_{c} | 1 to 20 | Si(OMe)₃ | 3 |
| 338 | Me | (CH₂)_{b} | 0 to 20 | NHC(═O)CH₂C | (CH₂)_{c} | 1 to 20 | Si(OMe)₃ | 3 |
| 339 | Me | (CH₂)_{b} | 0 to 20 | NHC(═O)CH₂C | (CH₂)_{c} | 1 to 20 | Si(OMe)₃ | 3 |
| 340 | Me | (CH₂)_{b} | 0 to 20 | NHC(═O)CH₂C | (CH₂)_{c} | 1 to 20 | Si(OMe)₃ | 3 |
| 341 | Me | (CH₂)_{b} | 0 to 20 | NHC(═O)CH₂C | (CH₂)_{c} | 1 to 20 | Si(OMe)₃ | 3 |

TABLE 32

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 342 | 3,5-SF₅C₆H₃ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 343 | 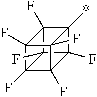 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 344 | 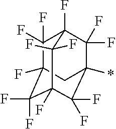 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 345 | 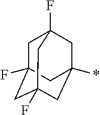 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 346 | SF₅ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 347 | OCF₃ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 348 | SCF₃ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 349 | N(CH₂CF₃)₂ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 350 | N(CF₃)₂ | (CH₂)ₐ | 0 to 20 | Me | Me | Me | Me | 5 to 100 | Me | Me | (CH₂)_{b} | 0 to 20 | NHC(═O)CH₂C | (CH₂)_{c} | 1 to 20 | Si(OMe)₃ | 3 |
| 351 | CF₃ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 352 | (CF₃)₂CF | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |

TABLE 33

| No. | R^{f1} | L² | a | R¹¹ | R¹² | R¹³ | R¹⁴ | z11 |
|---|---|---|---|---|---|---|---|---|
| 353 | (CF₃)₃C | (CH₂)ₐ | 0 to 20 | Me | Me | Me | Me | 5 to 100 |
| 354 | C₄F₉ | (CH₂)ₐ | 0 to 20 | Me | Me | Me | Me | 5 to 100 |
| 355 | C₈F₁₇ | (CH₂)ₐ | 0 to 20 | Me | Me | Me | Me | 5 to 100 |
| 356 | c-C₆F₁₁ | (CH₂)ₐ | 0 to 20 | Me | Me | Me | Me | 5 to 100 |
| 357 | CHF₂ | (CH₂)ₐ | 0 to 20 | Me | Me | Me | Me | 5 to 100 |
| 358 | CClF₂ | (CH₂)ₐ | 0 to 20 | Me | Me | Me | Me | 5 to 100 |
| 359 | CBrF₂ | (CH₂)ₐ | 0 to 20 | Me | Me | Me | Me | 5 to 100 |
| 360 | ClF₂ | (CH₂)ₐ | 0 to 20 | Me | Me | Me | Me | 5 to 100 |
| 361 | CF=CF₂ | (CH₂)ₐ | 0 to 20 | Me | Me | Me | Me | 5 to 100 |
| 362 | CF=CFCF₃ | (CH₂)ₐ | 0 to 20 | Me | Me | Me | Me | 5 to 100 |
| 363 | CF=CFCF=CF₂ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 353 | Me | Me | (CH₂)_{b} | 0 to 20 | Si | (CH₂)_{c} | 1 to 20 | Si(OMe)₃ | 3 |
| 354 | Me | Me | (CH₂)_{b} | 0 to 20 | Si | (CH₂)_{c} | 1 to 20 | Si(OMe)₃ | 3 |
| 355 | Me | Me | (CH₂)_{b} | 0 to 20 | Si | (CH₂)_{c} | 1 to 20 | Si(OMe)₃ | 3 |
| 356 | Me | Me | (CH₂)_{b} | 0 to 20 | Si | (CH₂)_{c} | 1 to 20 | Si(OMe)₃ | 3 |
| 357 | Me | Me | (CH₂)_{b} | 0 to 20 | Si | (CH₂)_{c} | 1 to 20 | Si(OMe)₃ | 3 |
| 358 | Me | Me | (CH₂)_{b} | 0 to 20 | Si | (CH₂)_{c} | 1 to 20 | Si(OMe)₃ | 3 |
| 359 | Me | Me | (CH₂)_{b} | 0 to 20 | Si | (CH₂)_{c} | 1 to 20 | Si(OMe)₃ | 3 |
| 360 | Me | Me | (CH₂)_{b} | 0 to 20 | Si | (CH₂)_{c} | 1 to 20 | Si(OMe)₃ | 3 |
| 361 | Me | Me | (CH₂)_{b} | 0 to 20 | Si | (CH₂)_{c} | 1 to 20 | Si(OMe)₃ | 3 |
| 362 | Me | Me | (CH₂)_{b} | 0 to 20 | Si | (CH₂)_{c} | 1 to 20 | Si(OMe)₃ | 3 |
| 363 | Me | Me | (CH₂)_{b} | 0 to 20 | Si | (CH₂)_{c} | 1 to 20 | Si(OMe)₃ | 3 |

TABLE 34

| No. | R^{f1} | L² | a | R¹¹ | R¹² | R¹³ | R¹⁴ | z11 |
|---|---|---|---|---|---|---|---|---|
| 364 | C≡CCF₃ | (CH₂)ₐ | 0 to 20 | Me | Me | Me | Me | 5 to 100 |
| 365 | CF₂CH₃ | (CH₂)ₐ | 0 to 20 | Me | Me | Me | Me | 5 to 100 |
| 366 | (CF₂)₂H | (CH₂)ₐ | 0 to 20 | Me | Me | Me | Me | 5 to 100 |
| 367 | (CF₂)₂CH₃ | (CH₂)ₐ | 0 to 20 | Me | Me | Me | Me | 5 to 100 |
| 368 | (CF₂)₄H | (CH₂)ₐ | 0 to 20 | Me | Me | Me | Me | 5 to 100 |
| 369 | C₆F₅ | (CH₂)ₐ | 0 to 20 | Me | Me | Me | Me | 5 to 100 |
| 370 | 4-CF₃C₆F₄ | (CH₂)ₐ | 0 to 20 | Me | Me | Me | Me | 5 to 100 |
| 371 | 4-SF₅C₆F₄ | (CH₂)ₐ | 0 to 20 | Me | Me | Me | Me | 5 to 100 |
| 372 | 3,5-CF₃C₆F₃ | (CH₂)ₐ | 0 to 20 | Me | Me | Me | Me | 5 to 100 |
| 373 | 3,5-SF₅C₆F₃ | (CH₂)ₐ | 0 to 20 | Me | Me | Me | Me | 5 to 100 |
| 374 | 4-CF₃C₆H₄ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 364 | Me | Me | (CH₂)_{b} | 0 to 20 | Si | (CH₂)_{c} | 1 to 20 | Si(OMe)₃ | 3 |
| 365 | Me | Me | (CH₂)_{b} | 0 to 20 | Si | (CH₂)_{c} | 1 to 20 | Si(OMe)₃ | 3 |
| 366 | Me | Me | (CH₂)_{b} | 0 to 20 | Si | (CH₂)_{c} | 1 to 20 | Si(OMe)₃ | 3 |
| 367 | Me | Me | (CH₂)_{b} | 0 to 20 | Si | (CH₂)_{c} | 1 to 20 | Si(OMe)₃ | 3 |
| 368 | Me | Me | (CH₂)_{b} | 0 to 20 | Si | (CH₂)_{c} | 1 to 20 | Si(OMe)₃ | 3 |
| 369 | Me | Me | (CH₂)_{b} | 0 to 20 | Si | (CH₂)_{c} | 1 to 20 | Si(OMe)₃ | 3 |
| 370 | Me | Me | (CH₂)_{b} | 0 to 20 | Si | (CH₂)_{c} | 1 to 20 | Si(OMe)₃ | 3 |
| 371 | Me | Me | (CH₂)_{b} | 0 to 20 | Si | (CH₂)_{c} | 1 to 20 | Si(OMe)₃ | 3 |
| 372 | Me | Me | (CH₂)_{b} | 0 to 20 | Si | (CH₂)_{c} | 1 to 20 | Si(OMe)₃ | 3 |
| 373 | Me | Me | (CH₂)_{b} | 0 to 20 | Si | (CH₂)_{c} | 1 to 20 | Si(OMe)₃ | 3 |
| 374 | Me | Me | (CH₂)_{b} | 0 to 20 | Si | (CH₂)_{c} | 1 to 20 | Si(OMe)₃ | 3 |

TABLE 35

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 375 | 4-SF₅C₆H₄ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 376 | 3,5-CF₃C₆H₃ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 377 | 3,5-SF₅C₆H₃ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 378 | 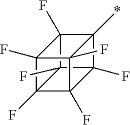 [SMILES: *C12C3(F)C4(F)C1(F)C1(F)C2(F)C3(F)C41F] | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 379 | 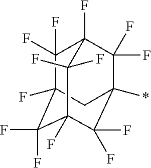 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 380 | 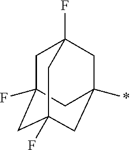 [SMILES: *C12CC3(F)CC(F)(C1)CC(F)(C2)C3] | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 381 | SF₅ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 382 | OCF₃ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 383 | SCF₃ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 384 | N(CH₂CF₃)₂ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |
| 385 | N(CF₃)₂ | (CH₂)ₐ | 0 to 20 | Me | Me | Me | Me | 5 to 100 | Me | Me | (CH₂)_{b} | 0 to 20 | Si | (CH₂)_{c} | 1 to 20 | Si(OMe)₃ | 3 |

TABLE 36

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 386 | CF₃ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 387 | (CF₃)₂CF | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 388 | (CF₃)₃C | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 389 | C₄F₉ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 390 | C₈F₁₇ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 391 | c-C₆F₁₁ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 392 | CHF₂ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 393 | CClF₂ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 394 | CBrF₂ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 395 | ClF₂ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |
| 396 | CF═CF₂ | (CH₂)ₐ | 0 to 20 | Me | Me | Me | Me | 5 to 100 | Me | Me | (CH₂)_{b} | 0 to 20 | C | (CH₂)_{c} | 1 to 20 | Si(OMe)₃ | 3 |

TABLE 37

| No. | R^{f1} | L² | a | R¹¹ | R¹² | R¹³ | R¹⁴ | z11 |
|---|---|---|---|---|---|---|---|---|
| 397 | CF═CFCF₃ | (CH₂)ₐ | 0 to 20 | Me | Me | Me | Me | 5 to 100 |
| 398 | CF═CFCF═CF₂ | (CH₂)ₐ | 0 to 20 | Me | Me | Me | Me | 5 to 100 |
| 399 | C≡CCF₃ | (CH₂)ₐ | 0 to 20 | Me | Me | Me | Me | 5 to 100 |
| 400 | CF₂CH₃ | (CH₂)ₐ | 0 to 20 | Me | Me | Me | Me | 5 to 100 |
| 401 | (CF₂)₂H | (CH₂)ₐ | 0 to 20 | Me | Me | Me | Me | 5 to 100 |
| 402 | (CF₂)₂CH₃ | (CH₂)ₐ | 0 to 20 | Me | Me | Me | Me | 5 to 100 |
| 403 | (CF₂)₄H | (CH₂)ₐ | 0 to 20 | Me | Me | Me | Me | 5 to 100 |
| 404 | C₆F₅ | (CH₂)ₐ | 0 to 20 | Me | Me | Me | Me | 5 to 100 |
| 405 | 4-CF₃C₆F₄ | (CH₂)ₐ | 0 to 20 | Me | Me | Me | Me | 5 to 100 |
| 406 | 4-SF₅C₆F₄ | (CH₂)ₐ | 0 to 20 | Me | Me | Me | Me | 5 to 100 |
| 407 | 3,5-CF₃C₆F₃ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 397 | Me | Me | (CH₂)_{b} | 0 to 20 | C | (CH₂)_{c} | 1 to 20 | Si(OMe)₃ | 3 |
| 398 | Me | Me | (CH₂)_{b} | 0 to 20 | C | (CH₂)_{c} | 1 to 20 | Si(OMe)₃ | 3 |
| 399 | Me | Me | (CH₂)_{b} | 0 to 20 | C | (CH₂)_{c} | 1 to 20 | Si(OMe)₃ | 3 |
| 400 | Me | Me | (CH₂)_{b} | 0 to 20 | C | (CH₂)_{c} | 1 to 20 | Si(OMe)₃ | 3 |
| 401 | Me | Me | (CH₂)_{b} | 0 to 20 | C | (CH₂)_{c} | 1 to 20 | Si(OMe)₃ | 3 |
| 402 | Me | Me | (CH₂)_{b} | 0 to 20 | C | (CH₂)_{c} | 1 to 20 | Si(OMe)₃ | 3 |
| 403 | Me | Me | (CH₂)_{b} | 0 to 20 | C | (CH₂)_{c} | 1 to 20 | Si(OMe)₃ | 3 |
| 404 | Me | Me | (CH₂)_{b} | 0 to 20 | C | (CH₂)_{c} | 1 to 20 | Si(OMe)₃ | 3 |
| 405 | Me | Me | (CH₂)_{b} | 0 to 20 | C | (CH₂)_{c} | 1 to 20 | Si(OMe)₃ | 3 |
| 406 | Me | Me | (CH₂)_{b} | 0 to 20 | C | (CH₂)_{c} | 1 to 20 | Si(OMe)₃ | 3 |
| 407 | Me | Me | (CH₂)_{b} | 0 to 20 | C | (CH₂)_{c} | 1 to 20 | Si(OMe)₃ | 3 |

TABLE 38

| No. | R^{f1} | L² | a | R¹¹ | R¹² | R¹³ | R¹⁴ | z11 |
|---|---|---|---|---|---|---|---|---|
| 408 | 3,5-SF₅C₆F₃ | (CH₂)ₐ | 0 to 20 | Me | Me | Me | Me | 5 to 100 |
| 409 | 4-CF₃C₆H₄ | (CH₂)ₐ | 0 to 20 | Me | Me | Me | Me | 5 to 100 |
| 410 | 4-SF₅C₆H₄ | (CH₂)ₐ | 0 to 20 | Me | Me | Me | Me | 5 to 100 |
| 411 | 3,5-CF₃C₆H₃ | (CH₂)ₐ | 0 to 20 | Me | Me | Me | Me | 5 to 100 |
| 412 | 3,5-SF₅C₆H₃ | (CH₂)ₐ | 0 to 20 | Me | Me | Me | Me | 5 to 100 |
| 413 | 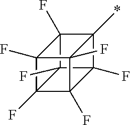 [SMILES: *C12C3(F)C4(F)C1(F)C1(F)C2(F)C3(F)C41F] | (CH₂)ₐ | 0 to 20 | Me | Me | Me | Me | 5 to 100 |
| 414 | 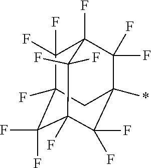 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 |
| 415 | 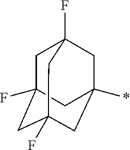 [SMILES: *C12CC3(F)CC(F)(C1)CC(F)(C2)C3] | (CH₂)ₐ | 0 to 20 | Me | Me | Me | Me | 5 to 100 |
| 416 | SF₅ | (CH₂)ₐ | 0 to 20 | Me | Me | Me | Me | 5 to 100 |
| 417 | OCF₃ | (CH₂)ₐ | 0 to 20 | Me | Me | Me | Me | 5 to 100 |
| 418 | SCF₃ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 408 | Me | Me | (CH₂)_{b} | 0 to 20 | C | (CH₂)_{c} | 1 to 20 | Si(OMe)₃ | 3 |
| 409 | Me | Me | (CH₂)_{b} | 0 to 20 | C | (CH₂)_{c} | 1 to 20 | Si(OMe)₃ | 3 |
| 410 | Me | Me | (CH₂)_{b} | 0 to 20 | C | (CH₂)_{c} | 1 to 20 | Si(OMe)₃ | 3 |
| 411 | Me | Me | (CH₂)_{b} | 0 to 20 | C | (CH₂)_{c} | 1 to 20 | Si(OMe)₃ | 3 |
| 412 | Me | Me | (CH₂)_{b} | 0 to 20 | C | (CH₂)_{c} | 1 to 20 | Si(OMe)₃ | 3 |
| 413 | Me | Me | (CH₂)_{b} | 0 to 20 | C | (CH₂)_{c} | 1 to 20 | Si(OMe)₃ | 3 |
| 414 | Me | Me | (CH₂)_{b} | 0 to 20 | C | (CH₂)_{c} | 1 to 20 | Si(OMe)₃ | 3 |
| 415 | Me | Me | (CH₂)_{b} | 0 to 20 | C | (CH₂)_{c} | 1 to 20 | Si(OMe)₃ | 3 |
| 416 | Me | Me | (CH₂)_{b} | 0 to 20 | C | (CH₂)_{c} | 1 to 20 | Si(OMe)₃ | 3 |
| 417 | Me | Me | (CH₂)_{b} | 0 to 20 | C | (CH₂)_{c} | 1 to 20 | Si(OMe)₃ | 3 |
| 418 | Me | Me | (CH₂)_{b} | 0 to 20 | C | (CH₂)_{c} | 1 to 20 | Si(OMe)₃ | 3 |

TABLE 39

| No. | R^{f1} | L² | a | R¹¹ | R¹² | R¹³ | R¹⁴ | z11 |
|---|---|---|---|---|---|---|---|---|
| 419 | N(CH₂CF₃)₂ | (CH₂)ₐ | 0 to 20 | Me | Me | Me | Me | 5 to 100 |
| 420 | N(CF₃)₂ | (CH₂)ₐ | 0 to 20 | Me | Me | Me | Me | 5 to 100 |
| 421 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 422 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 423 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 424 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 425 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 426 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 427 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 428 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 429 | CBrF₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 419 | Me | Me | (CH₂)_{b} | 0 to 20 | C | (CH₂)_{c} | 1 to 20 | Si(OMe)₃ | 3 |
| 420 | Me | Me | (CH₂)_{b} | 0 to 20 | C | (CH₂)_{c} | 1 to 20 | Si(OMe)₃ | 3 |
| 421 | Me | Me | (CH₂)_{b} | 0 to 20 | C(═O)NH | (CH₂)_{c} | 1 to 20 | Si(OMe)₃ | 1 |
| 422 | Me | Me | (CH₂)_{b} | 0 to 20 | C(═O)NH | (CH₂)_{c} | 1 to 20 | Si(OMe)₃ | 1 |
| 423 | Me | Me | (CH₂)_{b} | 0 to 20 | C(═O)NH | (CH₂)_{c} | 1 to 20 | Si(OMe)₃ | 1 |
| 424 | Me | Me | (CH₂)_{b} | 0 to 20 | C(═O)NH | (CH₂)_{c} | 1 to 20 | Si(OMe)₃ | 1 |
| 425 | Me | Me | (CH₂)_{b} | 0 to 20 | C(═O)NH | (CH₂)_{c} | 1 to 20 | Si(OMe)₃ | 1 |
| 426 | Me | Me | (CH₂)_{b} | 0 to 20 | C(═O)NH | (CH₂)_{c} | 1 to 20 | Si(OMe)₃ | 1 |
| 427 | Me | Me | (CH₂)_{b} | 0 to 20 | C(═O)NH | (CH₂)_{c} | 1 to 20 | Si(OMe)₃ | 1 |
| 428 | Me | Me | (CH₂)_{b} | 0 to 20 | C(═O)NH | (CH₂)_{c} | 1 to 20 | Si(OMe)₃ | 1 |
| 429 | Me | Me | (CH₂)_{b} | 0 to 20 | C(═O)NH | (CH₂)_{c} | 1 to 20 | Si(OMe)₃ | 1 |

TABLE 40

| No. | R^{f1} | L² | a | R¹¹ | R¹² | R¹³ | R¹⁴ |
|---|---|---|---|---|---|---|---|
| 430 | ClF₂ | (CH₂)ₐ | 0 to 20 | CH₂CH₂CF₃ | CH₂CH₂CF₃ | CH₂CH₂CF₃ | CH₂CH₂CF₃ |
| 431 | CF═CF₂ | (CH₂)ₐ | 0 to 20 | CH₂CH₂CF₃ | CH₂CH₂CF₃ | CH₂CH₂CF₃ | CH₂CH₂CF₃ |
| 432 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 433 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 434 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 435 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 436 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 437 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 438 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 439 | C₆F₅ | (CH₂)ₐ | 0 to 20 | CH₂CH₂CF₃ | CH₂CH₂CF₃ | CH₂CH₂CF₃ | CH₂CH₂CF₃ |
| 440 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 430 | 5 to 100 | Me | Me | (CH₂)_{b} | 0 to 20 | C(═O)NH | (CH₂)_{c} | 1 to 20 | Si(OMe)₃ | 1 |
| 431 | 5 to 100 | Me | Me | (CH₂)_{b} | 0 to 20 | C(═O)NH | (CH₂)_{c} | 1 to 20 | Si(OMe)₃ | 1 |
| 432 | 5 to 100 | Me | Me | (CH₂)_{b} | 0 to 20 | C(═O)NH | (CH₂)_{c} | 1 to 20 | Si(OMe)₃ | 1 |
| 433 | 5 to 100 | Me | Me | (CH₂)_{b} | 0 to 20 | C(═O)NH | (CH₂)_{c} | 1 to 20 | Si(OMe)₃ | 1 |
| 434 | 5 to 100 | Me | Me | (CH₂)_{b} | 0 to 20 | C(═O)NH | (CH₂)_{c} | 1 to 20 | Si(OMe)₃ | 1 |
| 435 | 5 to 100 | Me | Me | (CH₂)_{b} | 0 to 20 | C(═O)NH | (CH₂)_{c} | 1 to 20 | Si(OMe)₃ | 1 |
| 436 | 5 to 100 | Me | Me | (CH₂)_{b} | 0 to 20 | C(═O)NH | (CH₂)_{c} | 1 to 20 | Si(OMe)₃ | 1 |
| 437 | 5 to 100 | Me | Me | (CH₂)_{b} | 0 to 20 | C(═O)NH | (CH₂)_{c} | 1 to 20 | Si(OMe)₃ | 1 |
| 438 | 5 to 100 | Me | Me | (CH₂)_{b} | 0 to 20 | C(═O)NH | (CH₂)_{c} | 1 to 20 | Si(OMe)₃ | 1 |
| 439 | 5 to 100 | Me | Me | (CH₂)_{b} | 0 to 20 | C(═O)NH | (CH₂)_{c} | 1 to 20 | Si(OMe)₃ | 1 |
| 440 | 5 to 100 | Me | Me | (CH₂)_{b} | 0 to 20 | C(═O)NH | (CH₂)_{c} | 1 to 20 | Si(OMe)₃ | 1 |

TABLE 41

| No. | R^{f1} | L² | a | R¹¹ | R¹² | R¹³ | R¹⁴ | z11 |
|---|---|---|---|---|---|---|---|---|
| 441 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 442 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 443 | 3,5-SF₆C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 444 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 445 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 446 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 447 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 448 | 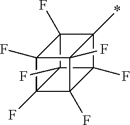 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 449 | 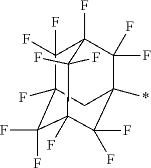 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 450 | 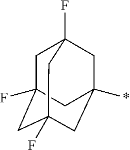 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 451 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 441 | Me | Me | (CH₂)_{b} | 0 to 20 | C(═O)NH | (CH₂)_{c} | 1 to 20 | Si(OMe)₃ | 1 |
| 442 | Me | Me | (CH₂)_{b} | 0 to 20 | C(═O)NH | (CH₂)_{c} | 1 to 20 | Si(OMe)₃ | 1 |
| 443 | Me | Me | (CH₂)_{b} | 0 to 20 | C(═O)NH | (CH₂)_{c} | 1 to 20 | Si(OMe)₃ | 1 |
| 444 | Me | Me | (CH₂)_{b} | 0 to 20 | C(═O)NH | (CH₂)_{c} | 1 to 20 | Si(OMe)₃ | 1 |
| 445 | Me | Me | (CH₂)_{b} | 0 to 20 | C(═O)NH | (CH₂)_{c} | 1 to 20 | Si(OMe)₃ | 1 |
| 446 | Me | Me | (CH₂)_{b} | 0 to 20 | C(═O)NH | (CH₂)_{c} | 1 to 20 | Si(OMe)₃ | 1 |
| 447 | Me | Me | (CH₂)_{b} | 0 to 20 | C(═O)NH | (CH₂)_{c} | 1 to 20 | Si(OMe)₃ | 1 |
| 448 | Me | Me | (CH₂)_{b} | 0 to 20 | C(═O)NH | (CH₂)_{c} | 1 to 20 | Si(OMe)₃ | 1 |
| 449 | Me | Me | (CH₂)_{b} | 0 to 20 | C(═O)NH | (CH₂)_{c} | 1 to 20 | Si(OMe)₃ | 1 |
| 450 | Me | Me | (CH₂)_{b} | 0 to 20 | C(═O)NH | (CH₂)_{c} | 1 to 20 | Si(OMe)₃ | 1 |
| 451 | Me | Me | (CH₂)_{b} | 0 to 20 | C(═O)NH | (CH₂)_{c} | 1 to 20 | Si(OMe)₃ | 1 |

TABLE 42

| No. | R^{f1} | L² | a | R¹¹ | R¹² | R¹³ | R¹⁴ | z11 |
|---|---|---|---|---|---|---|---|---|
| 452 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 453 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 454 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 455 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 456 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 457 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 458 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 459 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 460 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 461 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 462 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 452 | Me | Me | (CH₂)_{b} | 0 to 20 | C(═O)NH | (CH₂)_{c} | 1 to 20 | Si(OMe)₃ | 1 |
| 453 | Me | Me | (CH₂)_{b} | 0 to 20 | C(═O)NH | (CH₂)_{c} | 1 to 20 | Si(OMe)₃ | 1 |
| 454 | Me | Me | (CH₂)_{b} | 0 to 20 | C(═O)NH | (CH₂)_{c} | 1 to 20 | Si(OMe)₃ | 1 |
| 455 | Me | Me | (CH₂)_{b} | 0 to 20 | C(═O)NH | (CH₂)_{c} | 1 to 20 | Si(OMe)₃ | 1 |
| 456 | Me | Me | (CH₂)_{b} | 0 to 20 | NHC(═O) | (CH₂)_{c} | 1 to 20 | Si(OMe)₃ | 1 |
| 457 | Me | Me | (CH₂)_{b} | 0 to 20 | NHC(═O) | (CH₂)_{c} | 1 to 20 | Si(OMe)₃ | 1 |
| 458 | Me | Me | (CH₂)_{b} | 0 to 20 | NHC(═O) | (CH₂)_{c} | 1 to 20 | Si(OMe)₃ | 1 |
| 459 | Me | Me | (CH₂)_{b} | 0 to 20 | NHC(═O) | (CH₂)_{c} | 1 to 20 | Si(OMe)₃ | 1 |
| 460 | Me | Me | (CH₂)_{b} | 0 to 20 | NHC(═O) | (CH₂)_{c} | 1 to 20 | Si(OMe)₃ | 1 |
| 461 | Me | Me | (CH₂)_{b} | 0 to 20 | NHC(═O) | (CH₂)_{c} | 1 to 20 | Si(OMe)₃ | 1 |
| 462 | Me | Me | (CH₂)_{b} | 0 to 20 | NHC(═O) | (CH₂)_{c} | 1 to 20 | Si(OMe)₃ | 1 |

TABLE 43

| No. | R^{f1} | L² | a | R¹¹ | R¹² | R¹³ | R¹⁴ |
|---|---|---|---|---|---|---|---|
| 463 | CClF₂ | (CH₂)ₐ | 0 to 20 | CH₂CH₂CF₃ | CH₂CH₂CF₃ | CH₂CH₂CF₃ | CH₂CH₂CF₃ |
| 464 | CBrF₂ | (CH₂)ₐ | 0 to 20 | CH₂CH₂CF₃ | CH₂CH₂CF₃ | CH₂CH₂CF₃ | CH₂CH₂CF₃ |
| 465 | ClF₂ | (CH₂)ₐ | 0 to 20 | CH₂CH₂CF₃ | CH₂CH₂CF₃ | CH₂CH₂CF₃ | CH₂CH₂CF₃ |
| 466 | CF═CF₂ | (CH₂)ₐ | 0 to 20 | CH₂CH₂CF₃ | CH₂CH₂CF₃ | CH₂CH₂CF₃ | CH₂CH₂CF₃ |
| 467 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 468 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 469 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 470 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 471 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 472 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 473 | (CF₂)₄H | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 463 | 5 to 100 | Me | Me | (CH₂)_{b} | 0 to 20 | NHC(═O) | (CH₂)_{c} | 1 to 20 | Si(OMe)₃ | 1 |
| 464 | 5 to 100 | Me | Me | (CH₂)_{b} | 0 to 20 | NHC(═O) | (CH₂)_{c} | 1 to 20 | Si(OMe)₃ | 1 |
| 465 | 5 to 100 | Me | Me | (CH₂)_{b} | 0 to 20 | NHC(═O) | (CH₂)_{c} | 1 to 20 | Si(OMe)₃ | 1 |
| 466 | 5 to 100 | Me | Me | (CH₂)_{b} | 0 to 20 | NHC(═O) | (CH₂)_{c} | 1 to 20 | Si(OMe)₃ | 1 |
| 467 | 5 to 100 | Me | Me | (CH₂)_{b} | 0 to 20 | NHC(═O) | (CH₂)_{c} | 1 to 20 | Si(OMe)₃ | 1 |
| 468 | 5 to 100 | Me | Me | (CH₂)_{b} | 0 to 20 | NHC(═O) | (CH₂)_{c} | 1 to 20 | Si(OMe)₃ | 1 |
| 469 | 5 to 100 | Me | Me | (CH₂)_{b} | 0 to 20 | NHC(═O) | (CH₂)_{c} | 1 to 20 | Si(OMe)₃ | 1 |
| 470 | 5 to 100 | Me | Me | (CH₂)_{b} | 0 to 20 | NHC(═O) | (CH₂)_{c} | 1 to 20 | Si(OMe)₃ | 1 |
| 471 | 5 to 100 | Me | Me | (CH₂)_{b} | 0 to 20 | NHC(═O) | (CH₂)_{c} | 1 to 20 | Si(OMe)₃ | 1 |
| 472 | 5 to 100 | Me | Me | (CH₂)_{b} | 0 to 20 | NHC(═O) | (CH₂)_{c} | 1 to 20 | Si(OMe)₃ | 1 |
| 473 | 5 to 100 | Me | Me | (CH₂)_{b} | 0 to 20 | NHC(═O) | (CH₂)_{c} | 1 to 20 | Si(OMe)₃ | 1 |

TABLE 44

| No. | R^{f1} | L² | a | R¹¹ | R¹² | R¹³ | R¹⁴ | z11 |
|---|---|---|---|---|---|---|---|---|
| 474 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 475 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 476 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 477 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 478 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 479 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 480 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 481 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 482 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 483 | 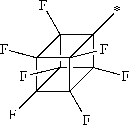 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 484 | 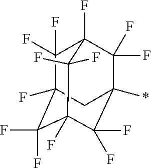 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 474 | Me | Me | (CH₂)_{b} | 0 to 20 | NHC(═O) | (CH₂)_{c} | 1 to 20 | Si(OMe)₃ | 1 |
| 475 | Me | Me | (CH₂)_{b} | 0 to 20 | NHC(═O) | (CH₂)_{c} | 1 to 20 | Si(OMe)₃ | 1 |
| 476 | Me | Me | (CH₂)_{b} | 0 to 20 | NHC(═O) | (CH₂)_{c} | 1 to 20 | Si(OMe)₃ | 1 |
| 477 | Me | Me | (CH₂)_{b} | 0 to 20 | NHC(═O) | (CH₂)_{c} | 1 to 20 | Si(OMe)₃ | 1 |
| 478 | Me | Me | (CH₂)_{b} | 0 to 20 | NHC(═O) | (CH₂)_{c} | 1 to 20 | Si(OMe)₃ | 1 |
| 479 | Me | Me | (CH₂)_{b} | 0 to 20 | NHC(═O) | (CH₂)_{c} | 1 to 20 | Si(OMe)₃ | 1 |
| 480 | Me | Me | (CH₂)_{b} | 0 to 20 | NHC(═O) | (CH₂)_{c} | 1 to 20 | Si(OMe)₃ | 1 |
| 481 | Me | Me | (CH₂)_{b} | 0 to 20 | NHC(═O) | (CH₂)_{c} | 1 to 20 | Si(OMe)₃ | 1 |
| 482 | Me | Me | (CH₂)_{b} | 0 to 20 | NHC(═O) | (CH₂)_{c} | 1 to 20 | Si(OMe)₃ | 1 |
| 483 | Me | Me | (CH₂)_{b} | 0 to 20 | NHC(═O) | (CH₂)_{c} | 1 to 20 | Si(OMe)₃ | 1 |
| 484 | Me | Me | (CH₂)_{b} | 0 to 20 | NHC(═O) | (CH₂)_{c} | 1 to 20 | Si(OMe)₃ | 1 |

TABLE 45

| No. | R^{f1} | L² | a | R¹¹ | R¹² | R¹³ | R¹⁴ | z11 |
|---|---|---|---|---|---|---|---|---|
| 485 | 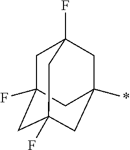 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 486 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 487 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 488 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 489 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 490 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 491 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 492 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 493 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 494 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 495 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 485 | Me | Me | (CH₂)_{b} | 0 to 20 | NHC(═O) | (CH₂)_{c} | 1 to 20 | Si(OMe)₃ | 1 |
| 486 | Me | Me | (CH₂)_{b} | 0 to 20 | NHC(═O) | (CH₂)_{c} | 1 to 20 | Si(OMe)₃ | 1 |
| 487 | Me | Me | (CH₂)_{b} | 0 to 20 | NHC(═O) | (CH₂)_{c} | 1 to 20 | Si(OMe)₃ | 1 |
| 488 | Me | Me | (CH₂)_{b} | 0 to 20 | NHC(═O) | (CH₂)_{c} | 1 to 20 | Si(OMe)₃ | 1 |
| 489 | Me | Me | (CH₂)_{b} | 0 to 20 | NHC(═O) | (CH₂)_{c} | 1 to 20 | Si(OMe)₃ | 1 |
| 490 | Me | Me | (CH₂)_{b} | 0 to 20 | NHC(═O) | (CH₂)_{c} | 1 to 20 | Si(OMe)₃ | 1 |
| 491 | Me | Me | (CH₂)_{b} | 0 to 20 | SiMe₂ | (CH₂)_{c} | 1 to 20 | Si(OMe)₃ | 1 |
| 492 | Me | Me | (CH₂)_{b} | 0 to 20 | SiMe₂ | (CH₂)_{c} | 1 to 20 | Si(OMe)₃ | 1 |
| 493 | Me | Me | (CH₂)_{b} | 0 to 20 | SiMe₂ | (CH₂)_{c} | 1 to 20 | Si(OMe)₃ | 1 |
| 494 | Me | Me | (CH₂)_{b} | 0 to 20 | SiMe₂ | (CH₂)_{c} | 1 to 20 | Si(OMe)₃ | 1 |
| 495 | Me | Me | (CH₂)_{b} | 0 to 20 | SiMe₂ | (CH₂)_{c} | 1 to 20 | Si(OMe)₃ | 1 |

TABLE 46

| No. | R^{f1} | L² | a | R¹¹ | R¹² | R¹³ | R¹⁴ |
|---|---|---|---|---|---|---|---|
| 496 | c-C₆F₁₁ | (CH₂)ₐ | 0 to 20 | CH₂CH₂CF₃ | CH₂CH₂CF₃ | CH₂CH₂CF₃ | CH₂CH₂CF₃ |
| 497 | CHF₂ | (CH₂)ₐ | 0 to 20 | CH₂CH₂CF₃ | CH₂CH₂CF₃ | CH₂CH₂CF₃ | CH₂CH₂CF₃ |
| 498 | CClF₂ | (CH₂)ₐ | 0 to 20 | CH₂CH₂CF₃ | CH₂CH₂CF₃ | CH₂CH₂CF₃ | CH₂CH₂CF₃ |
| 499 | CBrF₂ | (CH₂)ₐ | 0 to 20 | CH₂CH₂CF₃ | CH₂CH₂CF₃ | CH₂CH₂CF₃ | CH₂CH₂CF₃ |
| 500 | ClF₂ | (CH₂)ₐ | 0 to 20 | CH₂CH₂CF₃ | CH₂CH₂CF₃ | CH₂CH₂CF₃ | CH₂CH₂CF₃ |
| 501 | CF═CF₂ | (CH₂)ₐ | 0 to 20 | CH₂CH₂CF₃ | CH₂CH₂CF₃ | CH₂CH₂CF₃ | CH₂CH₂CF₃ |
| 502 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 503 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 504 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 505 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 506 | (CF₂)₂H | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 496 | 5 to 100 | Me | Me | (CH₂)_{b} | 0 to 20 | SiMe₂ | (CH₂)_{c} | 1 to 20 | Si(OMe)₃ | 1 |
| 497 | 5 to 100 | Me | Me | (CH₂)_{b} | 0 to 20 | SiMe₂ | (CH₂)_{c} | 1 to 20 | Si(OMe)₃ | 1 |
| 498 | 5 to 100 | Me | Me | (CH₂)_{b} | 0 to 20 | SiMe₂ | (CH₂)_{c} | 1 to 20 | Si(OMe)₃ | 1 |
| 499 | 5 to 100 | Me | Me | (CH₂)_{b} | 0 to 20 | SiMe₂ | (CH₂)_{c} | 1 to 20 | Si(OMe)₃ | 1 |
| 500 | 5 to 100 | Me | Me | (CH₂)_{b} | 0 to 20 | SiMe₂ | (CH₂)_{c} | 1 to 20 | Si(OMe)₃ | 1 |
| 501 | 5 to 100 | Me | Me | (CH₂)_{b} | 0 to 20 | SiMe₂ | (CH₂)_{c} | 1 to 20 | Si(OMe)₃ | 1 |
| 502 | 5 to 100 | Me | Me | (CH₂)_{b} | 0 to 20 | SiMe₂ | (CH₂)_{c} | 1 to 20 | Si(OMe)₃ | 1 |
| 503 | 5 to 100 | Me | Me | (CH₂)_{b} | 0 to 20 | SiMe₂ | (CH₂)_{c} | 1 to 20 | Si(OMe)₃ | 1 |
| 504 | 5 to 100 | Me | Me | (CH₂)_{b} | 0 to 20 | SiMe₂ | (CH₂)_{c} | 1 to 20 | Si(OMe)₃ | 1 |
| 505 | 5 to 100 | Me | Me | (CH₂)_{b} | 0 to 20 | SiMe₂ | (CH₂)_{c} | 1 to 20 | Si(OMe)₃ | 1 |
| 506 | 5 to 100 | Me | Me | (CH₂)_{b} | 0 to 20 | SiMe₂ | (CH₂)_{c} | 1 to 20 | Si(OMe)₃ | 1 |

TABLE 47

| No. | R^{f1} | L² | a | R¹¹ | R¹² | R¹³ | R¹⁴ |
|---|---|---|---|---|---|---|---|
| 507 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 508 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 509 | C₆F₅ | (CH₂)ₐ | 0 to 20 | CH₂CH₂CF₃ | CH₂CH₂CF₃ | CH₂CH₂CF₃ | CH₂CH₂CF₃ |
| 510 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ |
| 511 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ |
| 512 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ |
| 513 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ |
| 514 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ |
| 515 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ |
| 516 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ |
| 517 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 507 | 5 to 100 | Me | Me | (CH₂)_{b} | 0 to 20 | SiMe₂ | (CH₂)_{c} | 1 to 20 | Si(OMe)₃ | 1 |
| 508 | 5 to 100 | Me | Me | (CH₂)_{b} | 0 to 20 | SiMe₂ | (CH₂)_{c} | 1 to 20 | Si(OMe)₃ | 1 |
| 509 | 5 to 100 | Me | Me | (CH₂)_{b} | 0 to 20 | SiMe₂ | (CH₂)_{c} | 1 to 20 | Si(OMe)₃ | 1 |
| 510 | 5 to 100 | Me | Me | (CH₂)_{b} | 0 to 20 | SiMe₂ | (CH₂)_{c} | 1 to 20 | Si(OMe)₃ | 1 |
| 511 | 5 to 100 | Me | Me | (CH₂)_{b} | 0 to 20 | SiMe₂ | (CH₂)_{c} | 1 to 20 | Si(OMe)₃ | 1 |
| 512 | 5 to 100 | Me | Me | (CH₂)_{b} | 0 to 20 | SiMe₂ | (CH₂)_{c} | 1 to 20 | Si(OMe)₃ | 1 |
| 513 | 5 to 100 | Me | Me | (CH₂)_{b} | 0 to 20 | SiMe₂ | (CH₂)_{c} | 1 to 20 | Si(OMe)₃ | 1 |
| 514 | 5 to 100 | Me | Me | (CH₂)_{b} | 0 to 20 | SiMe₂ | (CH₂)_{c} | 1 to 20 | Si(OMe)₃ | 1 |
| 515 | 5 to 100 | Me | Me | (CH₂)_{b} | 0 to 20 | SiMe₂ | (CH₂)_{c} | 1 to 20 | Si(OMe)₃ | 1 |
| 516 | 5 to 100 | Me | Me | (CH₂)_{b} | 0 to 20 | SiMe₂ | (CH₂)_{c} | 1 to 20 | Si(OMe)₃ | 1 |
| 517 | 5 to 100 | Me | Me | (CH₂)_{b} | 0 to 20 | SiMe₂ | (CH₂)_{c} | 1 to 20 | Si(OMe)₃ | 1 |

TABLE 48

| No. | R^{f1} | L² | a | R¹¹ | R¹² | R¹³ | R¹⁴ | z11 |
|---|---|---|---|---|---|---|---|---|
| 518 | 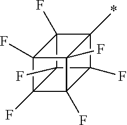 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 519 | 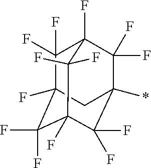 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 520 | 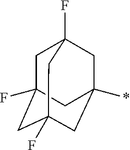 [SMILES: *C12CC3(F)CC(F)(C1)CC(F)(C2)C3] | (CH2)ₐ | 0 to 20 | CH₂CH₂CF₃ | CH₂CH₂CF₃ | CH₂CH₂CF₃ | CH₂CH₂CF₃ | 5 to 100 |
| 521 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 522 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 523 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 524 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 526 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 527 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 528 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 518 | Me | Me | (CH₂)_{b} | 0 to 20 | SiMe₂ | (CH₂)_{c} | 1 to 20 | Si(OMe)₃ | 1 |
| 519 | Me | Me | (CH₂)_{b} | 0 to 20 | SiMe₂ | (CH₂)_{c} | 1 to 20 | Si(OMe)₃ | 1 |
| 520 | Me | Me | (CH₂)_{b} | 0 to 20 | SiMe₂ | (CH₂)_{c} | 1 to 20 | Si(OMe)₃ | 1 |
| 521 | Me | Me | (CH₂)_{b} | 0 to 20 | SiMe₂ | (CH₂)_{c} | 1 to 20 | Si(OMe)₃ | 1 |
| 522 | Me | Me | (CH₂)_{b} | 0 to 20 | SiMe₂ | (CH₂)_{c} | 1 to 20 | Si(OMe)₃ | 1 |
| 523 | Me | Me | (CH₂)_{b} | 0 to 20 | SiMe₂ | (CH₂)_{c} | 1 to 20 | Si(OMe)₃ | 1 |
| 524 | Me | Me | (CH₂)_{b} | 0 to 20 | SiMe₂ | (CH₂)_{c} | 1 to 20 | Si(OMe)₃ | 1 |
| 525 | Me | Me | (CH₂)_{b} | 0 to 20 | SiMe₂ | (CH₂)_{c} | 1 to 20 | Si(OMe₃ | 1 |
| 526 | Me | Me | (CH₂)_{b} | 0 to 20 | CH₂ | CH₂)_{c} | 1 to 20 | Si(OMe)₃ | 1 |
| 527 | Me | Me | (CH₂)_{b} | 0 to 20 | CH₂ | (CH₂)_{c} | 1 to 20 | Si(OMe)₃ | 1 |
| 528 | Me | Me | (CH₂)_{b} | 0 to 20 | CH₂ | (CH₂)_{c} | 1 to 20 | Si(OMe)₃ | 1 |

TABLE 49

| No. | R^{f1} | L² | a | R¹¹ | R¹² | R¹³ | R¹⁴ |
|---|---|---|---|---|---|---|---|
| 529 | C₄F₉ | (CH₂)ₐ | 0 to 20 | CH₂CH₂CF₃ | CH₂CH₂CF₃ | CH₂CH₂CF₃ | CH₂CH₂CF₃ |
| 530 | C₈F₁₇ | (CH₂)ₐ | 0 to 20 | CH₂CH₂CF₃ | CH₂CH₂CF₃ | CH₂CH₂CF₃ | CH₂CH₂CF₃ |
| 531 | C-C₆F₁₁ | (CH₂)ₐ | 0 to 20 | CH₂CH₂CF₃ | CH₂CH₂CF₃ | CH₂CH₂CF₃ | CH₂CH₂CF₃ |
| 532 | CHF₂ | (CH₂)ₐ | 0 to 20 | CH₂CH₂CF₃ | CH₂CH₂CF₃ | CH₂CH₂CF₃ | CH₂CH₂CF₃ |
| 533 | CClF₂ | (CH₂)ₐ | 0 to 20 | CH₂CH₂CF₃ | CH₂CH₂CF₃ | CH₂CH₂CF₃ | CH₂CH₂CF₃ |
| 534 | CBrF₂ | (CH₂)ₐ | 0 to 20 | CH₂CH₂CF₃ | CH₂CH₂CF₃ | CH₂CH₂CF₃ | CH₂CH₂CF₃ |
| 535 | ClF₂ | (CH₂)ₐ | 0 to 20 | CH₂CH₂CF₃ | CH₂CH₂CF₃ | CH₂CH₂CF₃ | CH₂CH₂CF₃ |
| 536 | CF═CF₂ | (CH₂)ₐ | 0 to 20 | CH₂CH₂CF₃ | CH₂CH₂CF₃ | CH₂CH₂CF₃ | CH₂CH₂CF₃ |
| 537 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 538 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 539 | C≡CCF₃ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 529 | 5 to 100 | Me | Me | (CH₂)_{b} | 0 to 20 | CH₂ | (CH₂)_{c} | 1 to 20 | Si(OMe)₃ | 1 |
| 530 | 5 to 100 | Me | Me | (CH₂)_{b} | 0 to 20 | CH₂ | (CH₂)_{c} | 1 to 20 | Si(OMe)₃ | 1 |
| 531 | 5 to 100 | Me | Me | (CH₂)_{b} | 0 to 20 | CH₂ | (CH₂)_{c} | 1 to 20 | Si(OMe)₃ | 1 |
| 532 | 5 to 100 | Me | Me | (CH₂)_{b} | 0 to 20 | CH₂ | (CH₂)_{c} | 1 to 20 | Si(OMe)₃ | 1 |
| 533 | to 100 | Me | Me | (CH₂)_{b} | 0 to 20 | CH₂ | (CH₂)_{c} | 1 to 20 | Si(OMe)₃ | 1 |
| 534 | 5 to 100 | Me | Me | (CH₂)_{b} | 0 to 20 | CH₂ | (CH₂)_{c} | 1 to 20 | Si(OMe)₃ | 1 |
| 535 | 5 to 100 | Me | Me | (CH₂)_{b} | 0 to 20 | CH₂ | (CH₂)_{c} | 1 to 20 | Si(OMe)₃ | 1 |
| 536 | 5 to 100 | Me | Me | (CH₂)_{b} | 0 to 20 | CH₂ | (CH₂)_{c} | 1 to 20 | Si(OMe)₃ | 1 |
| 537 | 5 to 100 | Me | Me | (CH₂)_{b} | 0 to 20 | CH₂ | (CH₂)_{c} | 1 to 20 | Si(OMe)₃ | 1 |
| 538 | 5 to 100 | Me | Me | (CH₂)_{b} | 0 to 20 | CH₂ | (CH₂)_{c} | 1 to 20 | Si(OMe)₃ | 1 |
| 539 | 5 to 100 | Me | Me | (CH₂)_{b} | 0 to 20 | CH₂ | (CH₂)_{c} | 1 to 20 | Si(OMe)₃ | 1 |

TABLE 50

| No. | R^{f1} | L² | a | R¹¹ | R¹² | R¹³ | R¹⁴ |
|---|---|---|---|---|---|---|---|
| 540 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 541 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 542 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 543 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 544 | C₆F₅ | (CH₂)ₐ | 0 to 20 | CH₂CH₂CF₃ | CH₂CH₂CF₃ | CH₂CH₂CF₃ | CH₂CH₂CF₃ |
| 545 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ |
| 546 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ |
| 547 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ |
| 548 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ |
| 549 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ |
| 550 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 540 | 5 to 100 | Me | Me | (CH₂)_{b} | 0 to 20 | CH₂ | (CH₂)_{c} | 1 to 20 | Si(OMe)₃ | 1 |
| 541 | 5 to 100 | Me | Me | (CH₂)_{b} | 0 to 20 | CH₂ | (CH₂)_{c} | 1 to 20 | Si(OMe)₃ | 1 |
| 542 | 5 to 100 | Me | Me | (CH₂)_{b} | 0 to 20 | CH₂ | (CH₂)_{c} | 1 to 20 | Si(OMe)₃ | 1 |
| 543 | 5 to 100 | Me | Me | (CH₂)_{b} | 0 to 20 | CH₂ | (CH₂)_{c} | 1 to 20 | Si(OMe)₃ | 1 |
| 544 | 5 to 100 | Me | Me | (CH₂)_{b} | 0 to 20 | CH₂ | (CH₂)_{c} | 1 to 20 | Si(OMe)₃ | 1 |
| 545 | 5 to 100 | Me | Me | (CH₂)_{b} | 0 to 20 | CH₂ | (CH₂)_{c} | 1 to 20 | Si(OMe)₃ | 1 |
| 546 | 5 to 100 | Me | Me | (CH₂)_{b} | 0 to 20 | CH₂ | (CH₂)_{c} | 1 to 20 | Si(OMe)₃ | 1 |
| 547 | 5 to 100 | Me | Me | (CH₂)_{b} | 0 to 20 | CH₂ | (CH₂)_{c} | 1 to 20 | Si(OMe)₃ | 1 |
| 548 | 5 to 100 | Me | Me | (CH₂)_{b} | 0 to 20 | CH₂ | (CH₂)_{c} | 1 to 20 | Si(OMe)₃ | 1 |
| 549 | 5 to 100 | Me | Me | (CH₂)_{b} | 0 to 20 | CH₂ | (CH₂)_{c} | 1 to 20 | Si(OMe)₃ | 1 |
| 550 | 5 to 100 | Me | Me | (CH₂)_{b} | 0 to 20 | CH₂ | (CH₂)_{c} | 1 to 20 | Si(OMe)₃ | 1 |

TABLE 51

| No. | R^{f1} | L² | a | R¹¹ | R¹² | R¹³ | R¹⁴ | z11 |
|---|---|---|---|---|---|---|---|---|
| 551 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 552 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 553 | 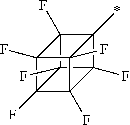 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 554 | 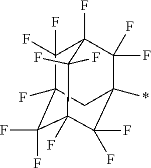 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 555 | 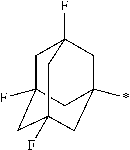 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 556 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 557 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 558 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 559 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 560 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 561 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | R¹ | x1 |
|---|---|---|---|---|---|---|---|---|---|
| 551 | Me | Me | (CH₂)_{b} | 0 to 20 | CH₂ | (CH₂)_{c} | 1 to 20 | Si(OMe)₃ | 1 |
| 552 | Me | Me | (CH₂)_{b} | 0 to 20 | CH₂ | (CH₂)_{c} | 1 to 20 | Si(OMe)₃ | 1 |
| 553 | Me | Me | (CH₂)_{b} | 0 to 20 | CH₂ | (CH₂)_{c} | 1 to 20 | Si(OMe)₃ | 1 |
| 554 | Me | Me | (CH₂)_{b} | 0 to 20 | CH₂ | (CH₂)_{c} | 1 to 20 | Si(OMe)₃ | 1 |
| 555 | Me | Me | (CH₂)_{b} | 0 to 20 | CH₂ | (CH₂)_{c} | 1 to 20 | Si(OMe)₃ | 1 |
| 556 | Me | Me | (CH₂)_{b} | 0 to 20 | CH₂ | (CH₂)_{c} | 1 to 20 | Si(OMe)₃ | 1 |
| 557 | Me | Me | (CH₂)_{b} | 0 to 20 | CH₂ | (CH₂)_{c} | 1 to 20 | Si(OMe)₃ | 1 |
| 558 | Me | Me | (CH₂)_{b} | 0 to 20 | CH₂ | (CH₂)_{c} | 1 to 20 | Si(OMe)₃ | 1 |
| 559 | Me | Me | (CH₂)_{b} | 0 to 20 | CH₂ | (CH₂)_{c} | 1 to 20 | Si(OMe)₃ | 1 |
| 560 | Me | Me | (CH₂)_{b} | 0 to 20 | CH₂ | (CH₂)_{c} | 1 to 20 | Si(OMe)₃ | 1 |
| 561 | Me | Me | (CH₂)_{b} | 0 to 20 | C(═O)NHCH₂CH | (CH₂)_{c} | 1 to 20 | Si(OMe)₃ | 2 |

TABLE 52

| No. | R^{f1} | L² | a | R¹¹ | R¹² | R¹³ | R¹⁴ | z11 |
|---|---|---|---|---|---|---|---|---|
| 562 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 563 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 564 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 565 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 566 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 567 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 568 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 569 | CBrF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 570 | ClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 571 | CF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 572 | CF═CFCF₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 562 | Me | Me | (CH₂)_{b} | 0 to 20 | C(═O)NHCH₂CH | (CH₂)_{c} | 1 to 20 | Si(OMe)₃ | 2 |
| 563 | Me | Me | (CH₂)_{b} | 0 to 20 | C(═O)NHCH₂CH | (CH₂)_{c} | 1 to 20 | Si(OMe)₃ | 2 |
| 564 | Me | Me | (CH₂)_{b} | 0 to 20 | C(═O)NHCH₂CH | (CH₂)_{c} | 1 to 20 | Si(OMe)₃ | 2 |
| 565 | Me | Me | (CH₂)_{b} | 0 to 20 | C(═O)NHCH₂CH | (CH₂)_{c} | 1 to 20 | Si(OMe)₃ | 2 |
| 566 | Me | Me | (CH₂)_{b} | 0 to 20 | C(═O)NHCH₂CH | (CH₂)_{c} | 1 to 20 | Si(OMe)₃ | 2 |
| 567 | Me | Me | (CH₂)_{b} | 0 to 20 | C(═O)NHCH₂CH | (CH₂)_{c} | 1 to 20 | Si(OMe)₃ | 2 |
| 568 | Me | Me | (CH₂)_{b} | 0 to 20 | C(═O)NHCH₂CH | (CH₂)_{c} | 1 to 20 | Si(OMe)₃ | 2 |
| 569 | Me | Me | (CH₂)_{b} | 0 to 20 | C(═O)NHCH₂CH | (CH₂)_{c} | 1 to 20 | Si(OMe)₃ | 2 |
| 570 | Me | Me | (CH₂)_{b} | 0 to 20 | C(═O)NHCH₂CH | (CH₂)_{c} | 1 to 20 | Si(OMe)₃ | 2 |
| 571 | Me | Me | (CH₂)_{b} | 0 to 20 | C(═O)NHCH₂CH | (CH₂)_{c} | 1 to 20 | Si(OMe)₃ | 2 |
| 572 | Me | Me | (CH₂)_{b} | 0 to 20 | C(═O)NHCH₂CH | (CH₂)_{c} | 1 to 20 | Si(OMe)₃ | 2 |

TABLE 53

| No. | R^{f1} | L² | a | R¹¹ | R¹² | R¹³ | R¹⁴ | z11 |
|---|---|---|---|---|---|---|---|---|
| 573 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 574 | C≡CCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 575 | CF₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 576 | (CF₂)₂H | (CH₂)ₐ | 0 to 20 | CH₂CH₂CF₃ | CH₂CH₂CF₃ | CH₂CH₂CF₃ | CH₂CH₂CF₃ | 5 to 100 |
| 577 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 578 | (CF₂)₄H | (CH₂)ₐ | 0 to 20 | CH₂CH₂CF₃ | CH₂CH₂CF₃ | CH₂CH₂CF₃ | CH₂CH₂CF₃ | 5 to 100 |
| 579 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 580 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 581 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 582 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 583 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 573 | Me | Me | (CH₂)_{b} | 0 to 20 | C(═O)NHCH₂CH | (CH₂)_{c} | 1 to 20 | Si(OMe)₃ | 2 |
| 574 | Me | Me | (CH₂)_{b} | 0 to 20 | C(═O)NHCH₂CH | (CH₂)_{c} | 1 to 20 | Si(OMe)₃ | 2 |
| 575 | Me | Me | (CH₂)_{b} | 0 to 20 | C(═O)NHCH₂CH | (CH₂)_{c} | 1 to 20 | Si(OMe)₃ | 2 |
| 576 | Me | Me | (CH₂)_{b} | 0 to 20 | C(═O)NHCH₂CH | (CH₂)_{c} | 1 to 20 | Si(OMe)₃ | 2 |
| 577 | Me | Me | (CH₂)_{b} | 0 to 20 | C(═O)NHCH₂CH | (CH₂)_{c} | 1 to 20 | Si(OMe)₃ | 2 |
| 578 | Me | Me | (CH₂)_{b} | 0 to 20 | C(═O)NHCH₂CH | (CH₂)_{c} | 1 to 20 | Si(OMe)₃ | 2 |
| 579 | Me | Me | (CH₂)_{b} | 0 to 20 | C(═O)NHCH₂CH | (CH₂)_{c} | 1 to 20 | Si(OMe)₃ | 2 |
| 580 | Me | Me | (CH₂)_{b} | 0 to 20 | C(═O)NHCH₂CH | (CH₂)_{c} | 1 to 20 | Si(OMe)₃ | 2 |
| 581 | Me | Me | (CH₂)_{b} | 0 to 20 | C(═O)NHCH₂CH | (CH₂)_{c} | 1 to 20 | Si(OMe)₃ | 2 |
| 582 | Me | Me | (CH₂)_{b} | 0 to 20 | C(═O)NHCH₂CH | (CH₂)_{c} | 1 to 20 | Si(OMe)₃ | 2 |
| 583 | Me | Me | (CH₂)_{b} | 0 to 20 | C(═O)NHCH₂CH | (CH₂)_{c} | 1 to 20 | Si(OMe)₃ | 2 |

TABLE 54

| No. | R^{f1} | L² | a | R¹¹ | R¹² | R¹³ | R¹⁴ | z11 |
|---|---|---|---|---|---|---|---|---|
| 584 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 585 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 586 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 587 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 588 | 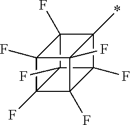 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 589 | 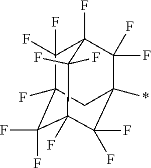 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 590 | 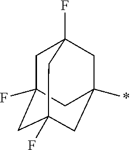 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 591 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 592 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 593 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 594 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 584 | Me | Me | (CH₂)_{b} | 0 to 20 | C(═O)NHCH₂CH | (CH₂)_{c} | 1 to 20 | Si(OMe)₃ | 2 |
| 585 | Me | Me | (CH₂)_{b} | 0 to 20 | C(═O)NHCH₂CH | (CH₂)_{c} | 1 to 20 | Si(OMe)₃ | 2 |
| 586 | Me | Me | (CH₂)_{b} | 0 to 20 | C(═O)NHCH₂CH | (CH₂)_{c} | 1 to 20 | Si(OMe)₃ | 2 |
| 587 | Me | Me | (CH₂)_{b} | 0 to 20 | C(═O)NHCH₂CH | (CH₂)_{c} | 1 to 20 | Si(OMe)₃ | 2 |
| 588 | Me | Me | (CH₂)_{b} | 0 to 20 | C(═O)NHCH₂CH | (CH₂)_{c} | 1 to 20 | Si(OMe)₃ | 2 |
| 589 | Me | Me | (CH₂)_{b} | 0 to 20 | C(═O)NHCH₂CH | (CH₂)_{c} | 1 to 20 | Si(OMe)₃ | 2 |
| 590 | Me | Me | (CH₂)_{b} | 0 to 20 | C(═O)NHCH₂CH | (CH₂)_{c} | 1 to 20 | Si(OMe)₃ | 2 |
| 591 | Me | Me | (CH₂)_{b} | 0 to 20 | C(═O)NHCH₂CH | (CH₂)_{c} | 1 to 20 | Si(OMe)₃ | 2 |
| 592 | Me | Me | (CH₂)_{b} | 0 to 20 | C(═O)NHCH₂CH | (CH₂)_{c} | 1 to 20 | Si(OMe)₃ | 2 |
| 593 | Me | Me | (CH₂)_{b} | 0 to 20 | C(═O)NHCH₂CH | (CH₂)_{c} | 1 to 20 | Si(OMe)₃ | 2 |
| 594 | Me | Me | (CH₂)_{b} | 0 to 20 | C(═O)NHCH₂CH | (CH₂)_{c} | 1 to 20 | Si(OMe)₃ | 2 |

TABLE 55

| No. | R^{f1} | L² | a | R¹¹ | R¹² | R¹³ | R¹⁴ | z11 |
|---|---|---|---|---|---|---|---|---|
| 595 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 596 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 597 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 598 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 599 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 600 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 601 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 602 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 603 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 604 | CBrF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 605 | ClF₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 595 | Me | Me | (CH₂)_{b} | 0 to 20 | C(═O)NHCH₂CH | (CH₂)_{c} | 1 to 20 | Si(OMe)₃ | 2 |
| 596 | Me | Me | (CH₂)_{b} | 0 to 20 | NHC(═O)CH₂CH | (CH₂)_{c} | 1 to 20 | Si(OMe)₃ | 2 |
| 597 | Me | Me | (CH₂)_{b} | 0 to 20 | NHC(═O)CH₂CH | (CH₂)_{c} | 1 to 20 | Si(OMe)₃ | 2 |
| 598 | Me | Me | (CH₂)_{b} | 0 to 20 | NHC(═O)CH₂CH | (CH₂)_{c} | 1 to 20 | Si(OMe)₃ | 2 |
| 599 | Me | Me | (CH₂)_{b} | 0 to 20 | NHC(═O)CH₂CH | (CH₂)_{c} | 1 to 20 | Si(OMe)₃ | 2 |
| 600 | Me | Me | (CH₂)_{b} | 0 to 20 | NHC(═O)CH₂CH | (CH₂)_{c} | 1 to 20 | Si(OMe)₃ | 2 |
| 601 | Me | Me | (CH₂)_{b} | 0 to 20 | NHC(═O)CH₂CH | (CH₂)_{c} | 1 to 20 | Si(OMe)₃ | 2 |
| 602 | Me | Me | (CH₂)_{b} | 0 to 20 | NHC(═O)CH₂CH | (CH₂)_{c} | 1 to 20 | Si(OMe)₃ | 2 |
| 603 | Me | Me | (CH₂)_{b} | 0 to 20 | NHC(═O)CH₂CH | (CH₂)_{c} | 1 to 20 | Si(OMe)₃ | 2 |
| 604 | Me | Me | (CH₂)_{b} | 0 to 20 | NHC(═O)CH₂CH | (CH₂)_{c} | 1 to 20 | Si(OMe)₃ | 2 |
| 605 | Me | Me | (CH₂)_{b} | 0 to 20 | NHC(═O)CH₂CH | (CH₂)_{c} | 1 to 20 | Si(OMe)₃ | 2 |

TABLE 56

| No. | R^{f1} | L² | a | R¹¹ | R¹² | R¹³ | R¹⁴ | z11 |
|---|---|---|---|---|---|---|---|---|
| 606 | CF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 607 | CF═CFCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 608 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 609 | C≡CCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 610 | CF₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 611 | (CF₂)₂H | (CH₂)ₐ | 0 to 20 | CH₂CH₂CF₃ | CH₂CH₂CF₃ | CH₂CH₂CF₃ | CH₂CH₂CF₃ | 5 to 100 |
| 612 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 613 | (CF₂)₄H | (CH₂)ₐ | 0 to 20 | CH₂CH₂CF₃ | CH₂CH₂CF₃ | CH₂CH₂CF₃ | CH₂CH₂CF₃ | 5 to 100 |
| 614 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 615 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 616 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 606 | Me | Me | (CH₂)_{b} | 0 to 20 | NHC(═O)CH₂CH | (CH₂)_{c} | 1 to 20 | Si(OMe)₃ | 2 |
| 607 | Me | Me | (CH₂)_{b} | 0 to 20 | NHC(═O)CH₂CH | (CH₂)_{c} | 1 to 20 | Si(OMe)₃ | 2 |
| 608 | Me | Me | (CH₂)_{b} | 0 to 20 | NHC(═O)CH₂CH | (CH₂)_{c} | 1 to 20 | Si(OMe)₃ | 2 |
| 609 | Me | Me | (CH₂)_{b} | 0 to 20 | NHC(═O)CH₂CH | (CH₂)_{c} | 1 to 20 | Si(OMe)₃ | 2 |
| 610 | Me | Me | (CH₂)_{b} | 0 to 20 | NHC(═O)CH₂CH | (CH₂)_{c} | 1 to 20 | Si(OMe)₃ | 2 |
| 611 | Me | Me | (CH₂)_{b} | 0 to 20 | NHC(═O)CH₂CH | (CH₂)_{c} | 1 to 20 | Si(OMe)₃ | 2 |
| 612 | Me | Me | (CH₂)_{b} | 0 to 20 | NHC(═O)CH₂CH | (CH₂)_{c} | 1 to 20 | Si(OMe)₃ | 2 |
| 613 | Me | Me | (CH₂)_{b} | 0 to 20 | NHC(═O)CH₂CH | (CH₂)_{c} | 1 to 20 | Si(OMe)₃ | 2 |
| 614 | Me | Me | (CH₂)_{b} | 0 to 20 | NHC(═O)CH₂CH | (CH₂)_{c} | 1 to 20 | Si(OMe)₃ | 2 |
| 615 | Me | Me | (CH₂)_{b} | 0 to 20 | NHC(═O)CH₂CH | (CH₂)_{c} | 1 to 20 | Si(OMe)₃ | 2 |
| 616 | Me | Me | (CH₂)_{b} | 0 to 20 | NHC(═O)CH₂CH | (CH₂)_{c} | 1 to 20 | Si(OMe)₃ | 2 |

TABLE 57

| No. | R^{f1} | L² | a | R¹¹ | R¹² | R¹³ | R¹⁴ | z11 |
|---|---|---|---|---|---|---|---|---|
| 617 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 618 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 619 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 620 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 621 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 622 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 623 | 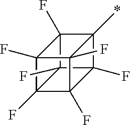 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 624 | 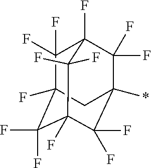 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 625 | 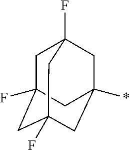 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 626 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 627 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | R¹ | x1 |
|---|---|---|---|---|---|---|---|---|---|
| 617 | Me | Me | (CH₂)_{b} | 0 to 20 | NHC(═O)CH₂CH | (CH₂)_{c} | 1 to 20 | Si(OMe)₃ | 2 |
| 618 | Me | Me | (CH₂)_{b} | 0 to 20 | NHC(═O)CH₂CH | (CH₂)_{c} | 1 to 20 | Si(OMe)₃ | 2 |
| 619 | Me | Me | (CH₂)_{b} | 0 to 20 | NHC(═O)CH₂CH | (CH₂)_{c} | 1 to 20 | Si(OMe)₃ | 2 |
| 620 | Me | Me | (CH₂)_{b} | 0 to 20 | NHC(═O)CH₂CH | (CH₂)_{c} | 1 to 20 | Si(OMe)₃ | 2 |
| 621 | Me | Me | (CH₂)_{b} | 0 to 20 | NHC(═O)CH₂CH | (CH₂)_{c} | 1 to 20 | Si(OMe)₃ | 2 |
| 622 | Me | Me | (CH₂)_{b} | 0 to 20 | NHC(═O)CH₂CH | (CH₂)_{c} | 1 to 20 | Si(OMe)₃ | 2 |
| 623 | Me | Me | (CH₂)_{b} | 0 to 20 | NHC(═O)CH₂CH | (CH₂)_{c} | 1 to 20 | Si(OMe)₃ | 2 |
| 624 | Me | Me | (CH₂)_{b} | 0 to 20 | NHC(═O)CH₂CH | (CH₂)_{c} | 1 to 20 | Si(OMe)₃ | 2 |
| 625 | Me | Me | (CH₂)_{b} | 0 to 20 | NHC(═O)CH₂CH | (CH₂)_{c} | 1 to 20 | Si(OMe)₃ | 2 |
| 626 | Me | Me | (CH₂)_{b} | 0 to 20 | NHC(═O)CH₂CH | (CH₂)_{c} | 1 to 20 | Si(OMe)₃ | 2 |
| 627 | Me | Me | (CH₂)_{b} | 0 to 20 | NHC(═O)CH₂CH | (CH₂)_{c} | 1 to 20 | Si(OMe)₃ | 2 |

TABLE 58

| No. | R^{f1} | L² | a | R¹¹ | R¹² | R¹³ | R¹⁴ | z11 |
|---|---|---|---|---|---|---|---|---|
| 628 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 629 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 630 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 631 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 632 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 633 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 634 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 635 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 636 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 637 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 638 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 628 | Me | Me | (CH₂)_{b} | 0 to 20 | NHC(═O)CH₂CH | (CH₂)_{c} | 1 to 20 | Si(OMe)₃ | 2 |
| 629 | Me | Me | (CH₂)_{b} | 0 to 20 | NHC(═O)CH₂CH | (CH₂)_{c} | 1 to 20 | Si(OMe)₃ | 2 |
| 630 | Me | Me | (CH₂)_{b} | 0 to 20 | NHC(═O)CH₂CH | (CH₂)_{c} | 1 to 20 | Si(OMe)₃ | 2 |
| 631 | Me | Me | (CH₂)_{b} | 0 to 20 | SiMe | (CH₂)_{c} | 1 to 20 | Si(OMe)₃ | 2 |
| 632 | Me | Me | (CH₂)_{b} | 0 to 20 | SiMe | (CH₂)_{c} | 1 to 20 | Si(OMe)₃ | 2 |
| 633 | Me | Me | (CH₂)_{b} | 0 to 20 | SiMe | (CH₂)_{c} | 1 to 20 | Si(OMe)₃ | 2 |
| 634 | Me | Me | (CH₂)_{b} | 0 to 20 | SiMe | (CH₂)_{c} | 1 to 20 | Si(OMe)₃ | 2 |
| 635 | Me | Me | (CH₂)_{b} | 0 to 20 | SiMe | (CH₂)_{c} | 1 to 20 | Si(OMe)₃ | 2 |
| 636 | Me | Me | (CH₂)_{b} | 0 to 20 | SiMe | (CH₂)_{c} | 1 to 20 | Si(OMe)₃ | 2 |
| 637 | Me | Me | (CH₂)_{b} | 0 to 20 | SiMe | (CH₂)_{c} | 1 to 20 | Si(OMe)₃ | 2 |
| 638 | Me | Me | (CH₂)_{b} | 0 to 20 | SiMe | (CH₂)_{c} | 1 to 20 | Si(OMe)₃ | 2 |

TABLE 59

| No. | R^{f1} | L² | a | R¹¹ | R¹² | R¹³ | R¹⁴ |
|---|---|---|---|---|---|---|---|
| 639 | CBrF₂ | (CH₂)ₐ | 0 to 20 | CH₂CH₂CF₃ | CH₂CH₂CF₃ | CH₂CH₂CF₃ | CH₂CH₂CF₃ |
| 640 | ClF₂ | (CH₂)ₐ | 0 to 20 | CH₂CH₂CF₃ | CH₂CH₂CF₃ | CH₂CH₂CF₃ | CH₂CH₂CF₃ |
| 641 | CF═CF₂ | (CH₂)ₐ | 0 to 20 | CH₂CH₂CF₃ | CH₂CH₂CF₃ | CH₂CH₂CF₃ | CH₂CH₂CF₃ |
| 642 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 643 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 644 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 645 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 646 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 647 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 648 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 649 | C₆F₅ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 639 | 5 to 100 | Me | Me | (CH₂)_{b} | 0 to 20 | SiMe | (CH₂)_{c} | 1 to 20 | Si(OMe)₃ | 2 |
| 640 | 5 to 100 | Me | Me | (CH₂)_{b} | 0 to 20 | SiMe | (CH₂)_{c} | 1 to 20 | Si(OMe)₃ | 2 |
| 641 | 5 to 100 | Me | Me | (CH₂)_{b} | 0 to 20 | SiMe | (CH₂)_{c} | 1 to 20 | Si(OMe)₃ | 2 |
| 642 | 5 to 100 | Me | Me | (CH₂)_{b} | 0 to 20 | SiMe | (CH₂)_{c} | 1 to 20 | Si(OMe)₃ | 2 |
| 643 | 5 to 100 | Me | Me | (CH₂)_{b} | 0 to 20 | SiMe | (CH₂)_{c} | 1 to 20 | Si(OMe)₃ | 2 |
| 644 | 5 to 100 | Me | Me | (CH₂)_{b} | 0 to 20 | SiMe | (CH₂)_{c} | 1 to 20 | Si(OMe)₃ | 2 |
| 645 | 5 to 100 | Me | Me | (CH₂)_{b} | 0 to 20 | SiMe | (CH₂)_{c} | 1 to 20 | Si(OMe)₃ | 2 |
| 646 | 5 to 100 | Me | Me | (CH₂)_{b} | 0 to 20 | SiMe | (CH₂)_{c} | 1 to 20 | Si(OMe)₃ | 2 |
| 647 | 5 to 100 | Me | Me | (CH₂)_{b} | 0 to 20 | SiMe | (CH₂)_{c} | 1 to 20 | Si(OMe)₃ | 2 |
| 648 | 5 to 100 | Me | Me | (CH₂)_{b} | 0 to 20 | SiMe | (CH₂)_{c} | 1 to 20 | Si(OMe)₃ | 2 |
| 649 | 5 to 100 | Me | Me | (CH₂)_{b} | 0 to 20 | SiMe | (CH₂)_{c} | 1 to 20 | Si(OMe)₃ | 2 |

TABLE 60

| No. | R^{f1} | L² | a | R¹¹ | R¹² | R¹³ | R¹⁴ | z11 |
|---|---|---|---|---|---|---|---|---|
| 650 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 651 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 652 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 653 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 654 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 655 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 656 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 657 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 658 | 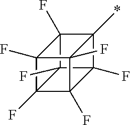 [SMILES: *C12C3(F)C4(F)C1(F)C1(F)C2(F)C3(F)C41F] | (CH₂)ₐ | 0 to 20 | CH₂CH₂CF₃ | CH₂CH₂CF3 | CH₂CH₂CF₃ | CH₂CH₂CF₃ | 5 to 100 |
| 659 | 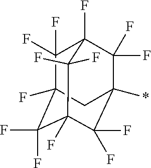 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 660 | 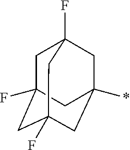 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L² | R² | c | T¹ | x1 |
|---|---|---|---|---|---|---|---|---|---|
| 650 | Me | Me | (CH₂)_{b} | 0 to 20 | SiMe | (CH₂)_{c} | 1 to 20 | Si(OMe)₃ | 2 |
| 651 | Me | Me | (CH₂)_{b} | 0 to 20 | SiMe | (CH₂)_{c} | 1 to 20 | Si(OMe)₃ | 2 |
| 652 | Me | Me | (CH₂)_{b} | 0 to 20 | SiMe | (CH₂)_{c} | 1 to 20 | Si(OMe)₃ | 2 |
| 653 | Me | Me | (CH₂)_{b} | 0 to 20 | SiMe | (CH₂)_{c} | 1 to 20 | Si(OMe)₃ | 2 |
| 654 | Me | Me | (CH₂)_{b} | 0 to 20 | SiMe | (CH₂)_{c} | 1 to 20 | Si(OMe)₃ | 2 |
| 655 | Me | Me | (CH₂)_{b} | 0 to 20 | SiMe | (CH₂)_{c} | 1 to 20 | Si(OMe)₃ | 2 |
| 656 | Me | Me | (CH₂)_{b} | 0 to 20 | SiMe | (CH₂)_{c} | 1 to 20 | Si(OMe)₃ | 2 |
| 657 | Me | Me | (CH₂)_{b} | 0 to 20 | SiMe | (CH₂)_{c} | 1 to 20 | Si(OMe)₃ | 2 |
| 658 | Me | Me | (CH₂)_{b} | 0 to 20 | SiMe | (CH₂)_{c} | 1 to 20 | Si(OMe)₃ | 2 |
| 659 | Me | Me | (CH₂)_{b} | 0 to 20 | SiMe | (CH₂)_{c} | 1 to 20 | Si(OMe)₃ | 2 |
| 660 | Me | Me | (CH₂)_{b} | 0 to 20 | SiMe | (CH₂)_{c} | 1 to 20 | Si(OMe)₃ | 2 |

TABLE 61

| No. | R^{f1} | L² | a | R¹¹ | R¹² | R¹³ | R¹⁴ |
|---|---|---|---|---|---|---|---|
| 661 | SF₅ | (CH₂)ₐ | 0 to 20 | CH₂CH₂CF₃ | CH₂CH₂CF₃ | CH₂CH₂CF₃ | CH₂CH₂CF₃ |
| 662 | OCF₃ | (CH₂)ₐ | 0 to 20 | CH₂CH₂CF₃ | CH₂CH₂CF₃ | CH₂CH₂CF₃ | CH₂CH₂CF₃ |
| 663 | SCF₃ | (CH₂)ₐ | 0 to 20 | CH₂CH₂CF₃ | CH₂CH₂CF₃ | CH₂CH₂CF₃ | CH₂CH₂CF₃ |
| 664 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ |
| 665 | N(CF₃)₂ | (CH₂)ₐ | 0 to 20 | CH₂CH₂CF₃ | CH₂CH₂CF₃ | CH₂CH₂CF₃ | CH₂CH₂CF₃ |
| 666 | CF₃ | (CH₂)ₐ | 0 to 20 | CH₂CH₂CF₃ | CH₂CH₂CF₃ | CH₂CH₂CF₃ | CH₂CH₂CF₃ |
| 667 | (CF₃)₂CF | (CH₂)ₐ | 0 to 20 | CH₂CH₂CF₃ | CH₂CH₂CF₃ | CH₂CH₂CF₃ | CH₂CH₂CF₃ |
| 668 | (CF₃)₃C | (CH₂)ₐ | 0 to 20 | CH₂CH₂CF₃ | CH₂CH₂CF₃ | CH₂CH₂CF₃ | CH₂CH₂CF₃ |
| 669 | C₄F₉ | (CH₂)ₐ | 0 to 20 | CH₂CH₂CF₃ | CH₂CH₂CF₃ | CH₂CH₂CF₃ | CH₂CH₂CF₃ |
| 670 | C₈F₁₇ | (CH₂)ₐ | 0 to 20 | CH₂CH₂CF₃ | CH₂CH₂CF₃ | CH₂CH₂CF₃ | CH₂CH₂CF₃ |
| 671 | c-C₆F₁₁ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 661 | 5 to 100 | Me | Me | (CH₂)_{b} | 0 to 20 | SiMe | (CH₂)_{c} | 1 to 20 | Si(OMe)₃ | 2 |
| 662 | 5 to 100 | Me | Me | (CH₂)_{b} | 0 to 20 | SiMe | (CH₂)_{c} | 1 to 20 | Si(OMe)₃ | 2 |
| 663 | 5 to 100 | Me | Me | (CH₂)_{b} | 0 to 20 | SiMe | (CH₂)_{c} | 1 to 20 | Si(OMe)₃ | 2 |
| 664 | 5 to 100 | Me | Me | (CH₂)_{b} | 0 to 20 | SiMe | (CH₂)_{c} | 1 to 20 | Si(OMe)₃ | 2 |
| 665 | 5 to 100 | Me | Me | (CH₂)_{b} | 0 to 20 | SiMe | (CH₂)_{c} | 1 to 20 | Si(OMe)₃ | 2 |
| 666 | 5 to 100 | Me | Me | (CH₂)_{b} | 0 to 20 | CH | (CH₂)_{c} | 1 to 20 | Si(OMe)₃ | 2 |
| 667 | 5 to 100 | Me | Me | (CH₂)_{b} | 0 to 20 | CH | (CH₂)_{c} | 1 to 20 | Si(OMe)₃ | 2 |
| 668 | 5 to 100 | Me | Me | (CH₂)_{b} | 0 to 20 | CH | (CH₂)_{c} | 1 to 20 | Si(OMe)₃ | 2 |
| 669 | 5 to 100 | Me | Me | (CH₂)_{b} | 0 to 20 | CH | (CH₂)_{c} | 1 to 20 | Si(OMe)₃ | 2 |
| 670 | 5 to 100 | Me | Me | (CH₂)_{b} | 0 to 20 | CH | (CH₂)_{c} | 1 to 20 | Si(OMe)₃ | 2 |
| 671 | 5 to 100 | Me | Me | (CH₂)_{b} | 0 to 20 | CH | (CH₂)_{c} | 1 to 20 | Si(OMe)₃ | 2 |

TABLE 62

| No. | R^{f1} | L² | a | R¹¹ | R¹² | R¹³ | R¹⁴ |
|---|---|---|---|---|---|---|---|
| 672 | CHF₂ | (CH₂)ₐ | 0 to 20 | CH₂CH₂CF₃ | CH₂CH₂CF₃ | CH₂CH₂CF₃ | CH₂CH₂CF₃ |
| 673 | CClF₂ | (CH₂)ₐ | 0 to 20 | CH₂CH₂CF₃ | CH₂CH₂CF₃ | CH₂CH₂CF₃ | CH₂CH₂CF₃ |
| 674 | CBrF₂ | (CH₂)ₐ | 0 to 20 | CH₂CH₂CF₃ | CH₂CH₂CF₃ | CH₂CH₂CF₃ | CH₂CH₂CF₃ |
| 675 | ClF₂ | (CH₂)ₐ | 0 to 20 | CH₂CH₂CF₃ | CH₂CH₂CF₃ | CH₂CH₂CF₃ | CH₂CH₂CF₃ |
| 676 | CF═CF₂ | (CH₂)ₐ | 0 to 20 | CH₂CH₂CF₃ | CH₂CH₂CF₃ | CH₂CH₂CF₃ | CH₂CH₂CF₃ |
| 677 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 678 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 679 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 680 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 681 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 682 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 672 | 5 to 100 | Me | Me | (CH₂)_{b} | 0 to 20 | CH | (CH₂)_{c} | 1 to 20 | Si(OMe)₃ | 2 |
| 673 | 5 to 100 | Me | Me | (CH₂)_{b} | 0 to 20 | CH | (CH₂)_{c} | 1 to 20 | Si(OMe)₃ | 2 |
| 674 | 5 to 100 | Me | Me | (CH₂)_{b} | 0 to 20 | CH | (CH₂)_{c} | 1 to 20 | Si(OMe)₃ | 2 |
| 675 | 5 to 100 | Me | Me | (CH₂)_{b} | 0 to 20 | CH | (CH₂)_{c} | 1 to 20 | Si(OMe)₃ | 2 |
| 676 | 5 to 100 | Me | Me | (CH₂)_{b} | 0 to 20 | CH | (CH₂)_{c} | 1 to 20 | Si(OMe)₃ | 2 |
| 677 | 5 to 100 | Me | Me | (CH₂)_{b} | 0 to 20 | CH | (CH₂)_{c} | 1 to 20 | Si(OMe)₃ | 2 |
| 678 | 5 to 100 | Me | Me | (CH₂)_{b} | 0 to 20 | CH | (CH₂)_{c} | 1 to 20 | Si(OMe)₃ | 2 |
| 679 | 5 to 100 | Me | Me | (CH₂)_{b} | 0 to 20 | CH | (CH₂)_{c} | 1 to 20 | Si(OMe)₃ | 2 |
| 680 | 5 to 100 | Me | Me | (CH₂)_{b} | 0 to 20 | CH | (CH₂)_{c} | 1 to 20 | Si(OMe)₃ | 2 |
| 681 | 5 to 100 | Me | Me | (CH₂)_{b} | 0 to 20 | CH | (CH₂)_{c} | 1 to 20 | Si(OMe)₃ | 2 |
| 682 | 5 to 100 | Me | Me | (CH₂)_{b} | 0 to 20 | CH | (CH₂)_{c} | 1 to 20 | Si(OMe)₃ | 2 |

TABLE 63

| No. | R^{f1} | L² | a | R¹¹ | R¹² | R¹³ | R¹⁴ | z11 |
|---|---|---|---|---|---|---|---|---|
| 683 | (CF₂)₄H | (CH₂)ₐ | 0 to 20 | CH₂CH₂CF₃ | CH₂CH₂CF₃ | CH₂CH₂CF₃ | CH₂CH₂CF₃ | 5 to 100 |
| 684 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 685 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 686 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 687 | 3,5-CF₃C₆F₃ | (CH₂)a | 0 to 20 | CH₂CH₂CF₃ | CH₂CH₂CF₃ | CH₂CH₂CF₃ | CH₂CH₂CF₃ | 5 to 100 |
| 688 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 689 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 690 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 691 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 692 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 693 | 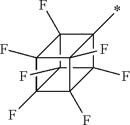 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 683 | Me | Me | (CH₂)_{b} | 0 to 20 | CH | (CH₂)_{c} | 1 to 20 | Si(OMe)₃ | 2 |
| 684 | Me | Me | (CH₂)_{b} | 0 to 20 | CH | (CH₂)_{c} | 1 to 20 | Si(OMe)₃ | 2 |
| 685 | Me | Me | (CH₂)_{b} | 0 to 20 | CH | (CH₂)_{c} | 1 to 20 | Si(OMe)₃ | 2 |
| 686 | Me | Me | (CH₂)_{b} | 0 to 20 | CH | (CH₂)_{c} | 1 to 20 | Si(OMe)₃ | 2 |
| 687 | Me | Me | (CH₂)_{b} | 0 to 20 | CH | (CH₂)_{c} | 1 to 20 | Si(OMe)₃ | 2 |
| 688 | Me | Me | (CH₂)_{b} | 0 to 20 | CH | (CH₂)_{c} | 1 to 20 | Si(OMe)₃ | 2 |
| 689 | Me | Me | (CH₂)_{b} | 0 to 20 | CH | (CH₂)_{c} | 1 to 20 | Si(OMe)₃ | 2 |
| 690 | Me | Me | (CH₂)_{b} | 0 to 20 | CH | (CH₂)_{c} | 1 to 20 | Si(OMe)₃ | 2 |
| 691 | Me | Me | (CH₂)_{b} | 0 to 20 | CH | (CH₂)_{c} | 1 to 20 | Si(OMe)₃ | 2 |
| 692 | Me | Me | (CH₂)_{b} | 0 to 20 | CH | (CH₂)_{c} | 1 to 20 | Si(OMe)₃ | 2 |
| 693 | Me | Me | (CH₂)_{b} | 0 to 20 | CH | (CH₂)_{c} | 1 to 20 | Si(OMe)₃ | 2 |

TABLE 64

| No. | R^{f1} | L² | a | R¹¹ | R¹² | R¹³ | R¹⁴ | z11 |
|---|---|---|---|---|---|---|---|---|
| 694 | 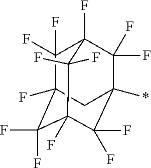 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 695 | 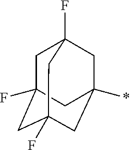 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 696 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 697 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 698 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 699 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 700 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 701 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 702 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |
| 703 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 704 | C₄F₉ | (CH₂)ₐ | 0 to 20 | CH₂CH₂CF₃ | CH₂CH₂CF₃ | CH₂CH₂ CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 694 | Me | Me | (CH₂)_{b} | 0 to 20 | CH | (CH₂)_{c} | 1 to 20 | Si(OMe)₃ | 2 |
| 695 | Me | Me | (CH₂)_{b} | 0 to 20 | CH | (CH₂)_{c} | 1 to 20 | Si(OMe)₃ | 2 |
| 696 | Me | Me | (CH₂)_{b} | 0 to 20 | CH | (CH₂)_{c} | 1 to 20 | Si(OMe)₃ | 2 |
| 697 | Me | Me | (CH₂)_{b} | 0 to 20 | CH | (CH₂)_{c} | 1 to 20 | Si(OMe)₃ | 2 |
| 698 | Me | Me | (CH₂)_{b} | 0 to 20 | CH | (CH₂)_{c} | 1 to 20 | Si(OMe)₃ | 2 |
| 699 | Me | Me | (CH₂)_{b} | 0 to 20 | CH | (CH₂)_{c} | 1 to 20 | Si(OMe)₃ | 2 |
| 700 | Me | Me | (CH₂)_{b} | 0 to 20 | CH | (CH₂)_{c} | 1 to 20 | Si(OMe)₃ | 2 |
| 701 | Me | Me | (CH₂)_{b} | 0 to 20 | C(═O)NHCH₂C | (CH₂)_{c} | 1 to 20 | Si(OMe)₃ | 3 |
| 702 | Me | Me | (CH₂)_{b} | 0 to 20 | C(═O)NHCH₂C | (CH₂)_{c} | 1 to 20 | Si(OMe)₃ | 3 |
| 703 | Me | Me | (CH₂)_{b} | 0 to 20 | C(═O)NHCH₂C | (CH₂)_{c} | 1 to 20 | Si(OMe)₃ | 3 |
| 704 | Me | Me | (CH₂)_{b} | 0 to 20 | C(═O)NHCH₂C | (CH₂)_{c} | 1 to 20 | Si(OMe)₃ | 3 |

TABLE 65

| No. | R^{f1} | L² | a | R¹¹ | R¹² | R¹³ | R¹⁴ | z11 |
|---|---|---|---|---|---|---|---|---|
| 705 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 706 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 707 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 708 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 709 | CBrF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 710 | ClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 711 | CF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 712 | CF═CFCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 713 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 714 | C≡CCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 715 | CF₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 705 | Me | Me | (CH₂)_{b} | 0 to 20 | C(═O)NHCH₂C | (CH₂)_{c} | 1 to 20 | Si(OMe)₃ | 3 |
| 706 | Me | Me | (CH₂)_{b} | 0 to 20 | C(═O)NHCH₂C | (CH₂)_{c} | 1 to 20 | Si(OMe)₃ | 3 |
| 707 | Me | Me | (CH₂)_{b} | 0 to 20 | C(═O)NHCH₂C | (CH₂)_{c} | 1 to 20 | Si(OMe)₃ | 3 |
| 708 | Me | Me | (CH₂)_{b} | 0 to 20 | C(═O)NHCH₂C | (CH₂)_{c} | 1 to 20 | Si(OMe)₃ | 3 |
| 709 | Me | Me | (CH₂)_{b} | 0 to 20 | C(═O)NHCH₂C | (CH₂)_{c} | 1 to 20 | Si(OMe)₃ | 3 |
| 710 | Me | Me | (CH₂)_{b} | 0 to 20 | C(═O)NHCH₂C | (CH₂)_{c} | 1 to 20 | Si(OMe)₃ | 3 |
| 711 | Me | Me | (CH₂)_{b} | 0 to 20 | C(═O)NHCH₂C | (CH₂)_{c} | 1 to 20 | Si(OMe)₃ | 3 |
| 712 | Me | Me | (CH₂)_{b} | 0 to 20 | C(═O)NHCH₂C | (CH₂)_{c} | 1 to 20 | Si(OMe)₃ | 3 |
| 713 | Me | Me | (CH₂)_{b} | 0 to 20 | C(═O)NHCH₂C | (CH₂)_{c} | 1 to 20 | Si(OMe)₃ | 3 |
| 714 | Me | Me | (CH₂)_{b} | 0 to 20 | C(═O)NHCH₂C | (CH₂)_{c} | 1 to 20 | Si(OMe)₃ | 3 |
| 715 | Me | Me | (CH₂)_{b} | 0 to 20 | C(═O)NHCH₂C | (CH₂)_{c} | 1 to 20 | Si(OMe)₃ | 3 |

TABLE 66

| No. | R^{f1} | L² | a | R¹¹ | R¹² | R¹³ | R¹⁴ | z11 |
|---|---|---|---|---|---|---|---|---|
| 716 | (CF₂)₂H | (CH₂)ₐ | 0 to 20 | CH₂CH₂CF₃ | CH₂CH₂CF₃ | CH₂CH₂CF₃ | CH₂CH₂CF₃ | 5 to 100 |
| 717 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 718 | (CF₂)₄H | (CH₂)ₐ | 0 to 20 | CH₂CH₂CF₃ | CH₂CH₂CF₃ | CH₂CH₂CF₃ | CH₂CH₂CF₃ | 5 to 100 |
| 719 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 720 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 721 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 722 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 723 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 724 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 725 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 726 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 716 | Me | Me | (CH₂)_{b} | 0 to 20 | C(═O)NHCH₂C | (CH₂)_{c} | 1 to 20 | Si(OMe)₃ | 3 |
| 717 | Me | Me | (CH₂)_{b} | 0 to 20 | C(═O)NHCH₂C | (CH₂)_{c} | 1 to 20 | Si(OMe)₃ | 3 |
| 718 | Me | Me | (CH₂)_{b} | 0 to 20 | C(═O)NHCH₂C | (CH₂)_{c} | 1 to 20 | Si(OMe)₃ | 3 |
| 719 | Me | Me | (CH₂)_{b} | 0 to 20 | C(═O)NHCH₂C | (CH₂)_{c} | 1 to 20 | Si(OMe)₃ | 3 |
| 720 | Me | Me | (CH₂)_{b} | 0 to 20 | C(═O)NHCH₂C | (CH₂)_{c} | 1 to 20 | Si(OMe)₃ | 3 |
| 721 | Me | Me | (CH₂)_{b} | 0 to 20 | C(═O)NHCH₂C | (CH₂)_{c} | 1 to 20 | Si(OMe)₃ | 3 |
| 722 | Me | Me | (CH₂)_{b} | 0 to 20 | C(═O)NHCH₂C | (CH₂)_{c} | 1 to 20 | Si(OMe)₃ | 3 |
| 723 | Me | Me | (CH₂)_{b} | 0 to 20 | C(═O)NHCH₂C | (CH₂)_{c} | 1 to 20 | Si(OMe)₃ | 3 |
| 724 | Me | Me | (CH₂)_{b} | 0 to 20 | C(═O)NHCH₂C | (CH₂)_{c} | 1 to 20 | Si(OMe)₃ | 3 |
| 725 | Me | Me | (CH₂)_{b} | 0 to 20 | C(═O)NHCH₂C | (CH₂)_{c} | 1 to 20 | Si(OMe)₃ | 3 |
| 726 | Me | Me | (CH₂)_{b} | 0 to 20 | C(═O)NHCH₂C | (CH₂)_{c} | 1 to 20 | Si(OMe)₃ | 3 |

TABLE 67

| No. | R^{f1} | L² | a | R¹¹ | R¹² | R¹³ | R¹⁴ | z11 |
|---|---|---|---|---|---|---|---|---|
| 727 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 728 | 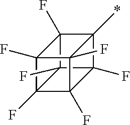 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 729 | 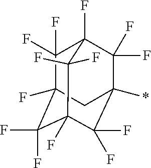 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 730 | 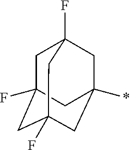 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 731 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 732 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 733 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 734 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 735 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 736 | CF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 737 | (CF₃)₂CF | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 727 | Me | Me | (CH₂)_{b} | 0 to 20 | C(═O)NHCH₂C | (CH₂)_{c} | 10 to 20 | Si(OMe)₃ | 3 |
| 728 | Me | Me | (CH₂)_{b} | 0 to 20 | C(═O)NHCH₂C | (CH₂)_{c} | 10 to 20 | Si(OMe)₃ | 3 |
| 729 | Me | Me | (CH₂)_{b} | 0 to 20 | C(═O)NHCH₂C | (CH₂)_{c} | 10 to 20 | Si(OMe)₃ | 3 |
| 730 | Me | Me | (CH₂)_{b} | 0 to 20 | C(═O)NHCH₂C | (CH₂)_{c} | 10 to 20 | Si(OMe)₃ | 3 |
| 731 | Me | Me | (CH₂)_{b} | 0 to 20 | C(═O)NHCH₂C | (CH₂)_{c} | 10 to 20 | Si(OMe)₃ | 3 |
| 732 | Me | Me | (CH₂)_{b} | 0 to 20 | C(═O)NHCH₂C | (CH₂)_{c} | 10 to 20 | Si(OMe)₃ | 3 |
| 733 | Me | Me | (CH₂)_{b} | 0 to 20 | C(═O)NHCH₂C | (CH₂)_{c} | 10 to 20 | Si(OMe)₃ | 3 |
| 734 | Me | Me | (CH₂)_{b} | 0 to 20 | C(═O)NHCH₂C | (CH₂)_{c} | 10 to 20 | Si(OMe)₃ | 3 |
| 735 | Me | Me | (CH₂)_{b} | 0 to 20 | C(═O)NHCH₂C | (CH₂)_{c} | 10 to 20 | Si(OMe)₃ | 3 |
| 736 | Me | Me | (CH₂)_{b} | 0 to 20 | NHC(═O)CH₂C | (CH₂)_{c} | 10 to 20 | Si(OMe)₃ | 3 |
| 737 | Me | Me | (CH₂)_{b} | 0 to 20 | NHC(═O)CH₂C | (CH₂)_{c} | 10 to 20 | Si(OMe)₃ | 3 |

TABLE 68

| No. | R^{f1} | L² | a | R¹¹ | R¹² | R¹³ | R¹⁴ | z11 |
|---|---|---|---|---|---|---|---|---|
| 738 | (CF₃)₃C | (CH₂)ₐ | 0 to 20 | CH₂CH₂CF₃ | CH₂CH₂CF₃ | CH₂CH₂CF₃ | CH₂CH₂CF₃ | 5 to 100 |
| 739 | C₄F₉ | (CH₂)ₐ | 0 to 20 | CH₂CH₂CF₃ | CH₂CH₂CF₃ | CH₂CH₂CF₃ | CH₂CH₂CF₃ | 5 to 100 |
| 740 | C₈F₁₇ | (CH₂)ₐ | 0 to 20 | CH₂CH₂CF₃ | CH₂CH₂CF₃ | CH₂CH₂CF₃ | CH₂CH₂CF₃ | 5 to 100 |
| 741 | c-C₆F₁₁ | (CH₂)ₐ | 0 to 20 | CH₂CH₂CF₃ | CH₂CH₂CF₃ | CH₂CH₂CF₃ | CH₂CH₂CF₃ | 5 to 100 |
| 742 | CHF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 743 | CClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 744 | CBrF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 745 | ClF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 746 | CF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 747 | CF═CFCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 748 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 738 | Me | Me | (CH₂)_{b} | 0 to 20 | NHC(═O)CH₂C | (CH₂)_{c} | 1 to 20 | Si(OMe)₃ | 3 |
| 739 | Me | Me | (CH₂)_{b} | 0 to 20 | NHC(═O)CH₂C | (CH₂)_{c} | 1 to 20 | Si(OMe)₃ | 3 |
| 740 | Me | Me | (CH₂)_{b} | 0 to 20 | NHC(═O)CH₂C | (CH₂)_{c} | 1 to 20 | Si(OMe)₃ | 3 |
| 741 | Me | Me | (CH₂)_{b} | 0 to 20 | NHC(═O)CH₂C | (CH₂)_{c} | 1 to 20 | Si(OMe)₃ | 3 |
| 742 | Me | Me | (CH₂)_{b} | 0 to 20 | NHC(═O)CH₂C | (CH₂)_{c} | 1 to 20 | Si(OMe)₃ | 3 |
| 743 | Me | Me | (CH₂)_{b} | 0 to 20 | NHC(═O)CH₂C | (CH₂)_{c} | 1 to 20 | Si(OMe)₃ | 3 |
| 744 | Me | Me | (CH₂)_{b} | 0 to 20 | NHC(═O)CH₂C | (CH₂)_{c} | 1 to 20 | Si(OMe)₃ | 3 |
| 745 | Me | Me | (CH₂)_{b} | 0 to 20 | NHC(═O)CH₂C | (CH₂)_{c} | 1 to 20 | Si(OMe)₃ | 3 |
| 746 | Me | Me | (CH₂)_{b} | 0 to 20 | NHC(═O)CH₂C | (CH₂)_{c} | 1 to 20 | Si(OMe)₃ | 3 |
| 747 | Me | Me | (CH₂)_{b} | 0 to 20 | NHC(═O)CH₂C | (CH₂)_{c} | 1 to 20 | Si(OMe)₃ | 3 |
| 748 | Me | Me | (CH₂)_{b} | 0 to 20 | NHC(═O)CH₂C | (CH₂)_{c} | 1 to 20 | Si(OMe)₃ | 3 |

TABLE 69

| No. | R^{f1} | L² | a | R¹¹ | R¹² | R¹³ | R¹⁴ | z11 |
|---|---|---|---|---|---|---|---|---|
| 749 | C≡CCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 750 | CF₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 751 | (CF₂)₂H | (CH₂)ₐ | 0 to 20 | CH₂CH₂CF₃ | CH₂CH₂CF₃ | CH₂CH₂CF₃ | CH₂CH₂CF₃ | 5 to 100 |
| 752 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 753 | (CF₂)₄H | (CH₂)ₐ | 0 to 20 | CH₂CH₂CF₃ | CH₂CH₂CF₃ | CH₂CH₂CF₃ | CH₂CH₂CF₃ | 5 to 100 |
| 754 | C₆F₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 755 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 756 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 757 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 758 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 759 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 749 | Me | Me | (CH₂)_{b} | 0 to 20 | NHC(═O)CH₂C | (CH₂)_{c} | 1 to 20 | Si(OMe)₃ | 3 |
| 750 | Me | Me | (CH₂)_{b} | 0 to 20 | NHC(═O)CH₂C | (CH₂)_{c} | 1 to 20 | Si(OMe)₃ | 3 |
| 751 | Me | Me | (CH₂)_{b} | 0 to 20 | NHC(═O)CH₂C | (CH₂)_{c} | 1 to 20 | Si(OMe)₃ | 3 |
| 752 | Me | Me | (CH₂)_{b} | 0 to 20 | NHC(═O)CH₂C | (CH₂)_{c} | 1 to 20 | Si(OMe)₃ | 3 |
| 753 | Me | Me | (CH₂)_{b} | 0 to 20 | NHC(═O)CH₂C | (CH₂)_{c} | 1 to 20 | Si(OMe)₃ | 3 |
| 754 | Me | Me | (CH₂)_{b} | 0 to 20 | NHC(═O)CH₂C | (CH₂)_{c} | 1 to 20 | Si(OMe)₃ | 3 |
| 755 | Me | Me | (CH₂)_{b} | 0 to 20 | NHC(═O)CH₂C | (CH₂)_{c} | 1 to 20 | Si(OMe)₃ | 3 |
| 756 | Me | Me | (CH₂)_{b} | 0 to 20 | NHC(═O)CH₂C | (CH₂)_{c} | 1 to 20 | Si(OMe)₃ | 3 |
| 757 | Me | Me | (CH₂)_{b} | 0 to 20 | NHC(═O)CH₂C | (CH₂)_{c} | 1 to 20 | Si(OMe)₃ | 3 |
| 758 | Me | Me | (CH₂)_{b} | 0 to 20 | NHC(═O)CH₂C | (CH₂)_{c} | 1 to 20 | Si(OMe)₃ | 3 |
| 759 | Me | Me | (CH₂)_{b} | 0 to 20 | NHC(═O)CH₂C | (CH₂)_{c} | 1 to 20 | Si(OMe)₃ | 3 |

TABLE 70

| No. | R^{f1} | L² | a | R¹¹ | R¹² | R¹³ | R¹⁴ | z11 |
|---|---|---|---|---|---|---|---|---|
| 760 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 761 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 762 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 763 | 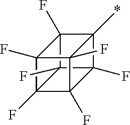 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 764 | 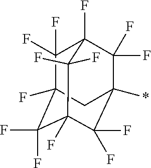 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 765 | 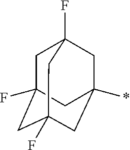 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 766 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 767 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 768 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 769 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |
| 770 | N(CF₃)₂ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 760 | Me | Me | (CH₂)_{b} | 0 to 20 | NHC(═O)CH₂C | (CH₂)_{c} | 1 to 20 | Si(OMe)₃ | 3 |
| 761 | Me | Me | (CH₂)_{b} | 0 to 20 | NHC(═O)CH₂C | (CH₂)_{c} | 1 to 20 | Si(OMe)₃ | 3 |
| 762 | Me | Me | (CH₂)_{b} | 0 to 20 | NHC(═O)CH₂C | (CH₂)_{c} | 1 to 20 | Si(OMe)₃ | 3 |
| 763 | Me | Me | (CH₂)_{b} | 0 to 20 | NHC(═O)CH₂C | (CH₂)_{c} | 1 to 20 | Si(OMe)₃ | 3 |
| 764 | Me | Me | (CH₂)_{b} | 0 to 20 | NHC(═O)CH₂C | (CH₂)_{c} | 1 to 20 | Si(OMe)₃ | 3 |
| 765 | Me | Me | (CH₂)_{b} | 0 to 20 | NHC(═O)CH₂C | (CH₂)_{c} | 1 to 20 | Si(OMe)₃ | 3 |
| 766 | Me | Me | (CH₂)_{b} | 0 to 20 | NHC(═O)CH₂C | (CH₂)_{c} | 1 to 20 | Si(OMe)₃ | 3 |
| 767 | Me | Me | (CH₂)_{b} | 0 to 20 | NHC(═O)CH₂C | (CH₂)_{c} | 1 to 20 | Si(OMe)₃ | 3 |
| 768 | Me | Me | (CH₂)_{b} | 0 to 20 | NHC(═O)CH₂C | (CH₂)_{c} | 1 to 20 | Si(OMe)₃ | 3 |
| 769 | Me | Me | (CH₂)_{b} | 0 to 20 | NHC(═O)CH₂C | (CH₂)_{c} | 1 to 20 | Si(OMe)₃ | 3 |
| 770 | Me | Me | (CH₂)_{b} | 0 to 20 | NHC(═O)CH₂C | (CH₂)_{c} | 1 to 20 | Si(OMe)₃ | 3 |

TABLE 71

| No. | R^{f1} | L² | a | R¹¹ | R¹² | R¹³ | R¹⁴ |
|---|---|---|---|---|---|---|---|
| 771 | CF₃ | (CH₂)ₐ | 0 to 20 | CH₂CH₂CF₃ | CH₂CH₂CF₃ | CH₂CH₂CF₃ | CH₂CH₂CF₃ |
| 772 | (CF₃)₂CF | (CH₂)ₐ | 0 to 20 | CH₂CH₂CF₃ | CH₂CH₂CF₃ | CH₂CH₂CF₃ | CH₂CH₂CF₃ |
| 773 | (CF₃)₃C | (CH₂)ₐ | 0 to 20 | CH₂CH₂CF₃ | CH₂CH₂CF₃ | CH₂CH₂CF₃ | CH₂CH₂CF₃ |
| 774 | C₄F₉ | (CH₂)ₐ | 0 to 20 | CH₂CH₂CF₃ | CH₂CH₂CF₃ | CH₂CH₂CF₃ | CH₂CH₂CF₃ |
| 775 | C₈F₁₇ | (CH₂)ₐ | 0 to 20 | CH₂CH₂CF₃ | CH₂CH₂CF₃ | CH₂CH₂CF₃ | CH₂CH₂CF₃ |
| 776 | C-C₆F₁₁ | (CH₂)ₐ | 0 to 20 | CH₂CH₂CF₃ | CH₂CH₂CF₃ | CH₂CH₂CF₃ | CH₂CH₂CF₃ |
| 777 | CHF₂ | (CH₂)ₐ | 0 to 20 | CH₂CH₂CF₃ | CH₂CH₂CF₃ | CH₂CH₂CF₃ | CH₂CH₂CF₃ |
| 778 | CClF₂ | (CH₂)ₐ | 0 to 20 | CH₂CH₂CF₃ | CH₂CH₂CF₃ | CH₂CH₂CF₃ | CH₂CH₂CF₃ |
| 779 | CBrF₂ | (CH₂)ₐ | 0 to 20 | CH₂CH₂CF₃ | CH₂CH₂CF₃ | CH₂CH₂CF₃ | CH₂CH₂CF₃ |
| 780 | ClF₂ | (CH₂)ₐ | 0 to 20 | CH₂CH₂CF₃ | CH₂CH₂CF₃ | CH₂CH₂CF₃ | CH₂CH₂CF₃ |
| 781 | CF═CF₂ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 771 | 5 to 100 | Me | Me | (CH₂)_{b} | 0 to 20 | Si | (CH₂)_{c} | 1 to 20 | Si(OMe)₃ | 3 |
| 772 | 5 to 100 | Me | Me | (CH₂)_{b} | 0 to 20 | Si | (CH₂)_{c} | 1 to 20 | Si(OMe)₃ | 3 |
| 773 | 5 to 100 | Me | Me | (CH₂)_{b} | 0 to 20 | Si | (CH₂)_{c} | 1 to 20 | Si(OMe)₃ | 3 |
| 774 | 5 to 100 | Me | Me | (CH₂)_{b} | 0 to 20 | Si | (CH₂)_{c} | 1 to 20 | Si(OMe)₃ | 3 |
| 775 | 5 to 100 | Me | Me | (CH₂)_{b} | 0 to 20 | Si | (CH₂)_{c} | 1 to 20 | Si(OMe)₃ | 3 |
| 776 | 5 to 100 | Me | Me | (CH₂)_{b} | 0 to 20 | Si | (CH₂)_{c} | 1 to 20 | Si(OMe)₃ | 3 |
| 777 | 5 to 100 | Me | Me | (CH₂)_{b} | 0 to 20 | Si | (CH₂)_{c} | 1 to 20 | Si(OMe)₃ | 3 |
| 778 | 5 to 100 | Me | Me | (CH₂)_{b} | 0 to 20 | Si | (CH₂)_{c} | 1 to 20 | Si(OMe)₃ | 3 |
| 779 | 5 to 100 | Me | Me | (CH₂)_{b} | 0 to 20 | Si | (CH₂)_{c} | 1 to 20 | Si(OMe)₃ | 3 |
| 780 | 5 to 100 | Me | Me | (CH₂)_{b} | 0 to 20 | Si | (CH₂)_{c} | 1 to 20 | Si(OMe)₃ | 3 |
| 781 | 5 to 100 | Me | Me | (CH₂)_{b} | 0 to 20 | Si | (CH₂)_{c} | 1 to 20 | Si(OMe)₃ | 3 |

TABLE 72

| No. | R^{f1} | L² | a | R¹¹ | R¹² | R¹³ | R¹⁴ |
|---|---|---|---|---|---|---|---|
| 782 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 783 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 784 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 785 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 786 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 787 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 788 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 789 | C₆F₅ | (CH₂)ₐ | 0 to 20 | CH₂CH₂CF₃ | CH₂CH₂CF₃ | CH₂CH₂CF₃ | CH₂CH₂CF₃ |
| 790 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ |
| 791 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ |
| 792 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 782 | 5 to 100 | Me | Me | (CH₂)_{b} | 0 to 20 | Si | (CH₂)_{c} | 1 to 20 | Si(OMe)₃ | 3 |
| 783 | 5 to 100 | Me | Me | (CH₂)_{b} | 0 to 20 | Si | (CH₂)_{c} | 1 to 20 | Si(OMe)₃ | 3 |
| 784 | 5 to 100 | Me | Me | (CH₂)_{b} | 0 to 20 | Si | (CH₂)_{c} | 1 to 20 | Si(OMe)₃ | 3 |
| 785 | 5 to 100 | Me | Me | (CH₂)_{b} | 0 to 20 | Si | (CH₂)_{c} | 1 to 20 | Si(OMe)₃ | 3 |
| 786 | 5 to 100 | Me | Me | (CH₂)_{b} | 0 to 20 | Si | (CH₂)_{c} | 1 to 20 | Si(OMe)₃ | 3 |
| 787 | 5 to 100 | Me | Me | (CH₂)_{b} | 0 to 20 | Si | (CH₂)_{c} | 1 to 20 | Si(OMe)₃ | 3 |
| 788 | 5 to 100 | Me | Me | (CH₂)_{b} | 0 to 20 | Si | (CH₂)_{c} | 1 to 20 | Si(OMe)₃ | 3 |
| 789 | 5 to 100 | Me | Me | (CH₂)_{b} | 0 to 20 | Si | (CH₂)_{c} | 1 to 20 | Si(OMe)₃ | 3 |
| 790 | 5 to 100 | Me | Me | (CH₂)_{b} | 0 to 20 | Si | (CH₂)_{c} | 1 to 20 | Si(OMe)₃ | 3 |
| 791 | 5 to 100 | Me | Me | (CH₂)_{b} | 0 to 20 | Si | (CH₂)_{c} | 1 to 20 | Si(OMe)₃ | 3 |
| 792 | 5 to 100 | Me | Me | (CH₂)_{b} | 0 to 20 | Si | (CH₂)_{c} | 1 to 20 | Si(OMe)₃ | 3 |

TABLE 73

| No. | R^{f1} | L² | a | R¹¹ | R¹² | R¹³ | R¹⁴ | z11 |
|---|---|---|---|---|---|---|---|---|
| 793 | 3,5-SF₅C₆F₃ | (CH₂)ₙ | 0 to 20 | CH₂CH₂CF₃ | CH₂CH₂CF₃ | CH₂CH₂CF₃ | CH₂CH₂CF₃ | 5 to 100 |
| 794 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 795 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 796 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 797 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 798 | 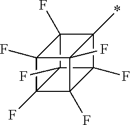 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 799 | 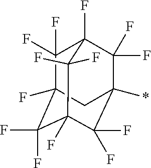 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 800 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |
| 801 | SF₅ | (CH₂)ₐ | 0 to 20 | CH₂CH₂CF₃ | CH₂CH₂CF₃ | CH₂CH2CF₃ | CH₂CH₂CF₃ | 5 to 100 |
| 802 | OCF₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 803 | SCF₃ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 793 | Me | Me | (CH₂)_{b} | 0 to 20 | Si | (CH₂)_{c} | 1 to 20 | Si(OMe)₃ | 3 |
| 794 | Me | Me | (CH₂)_{b} | 0 to 20 | Si | (CH₂)_{c} | 1 to 20 | Si(OMe)₃ | 3 |
| 795 | Me | Me | (CH₂)_{b} | 0 to 20 | Si | (CH₂)_{c} | 1 to 20 | Si(OMe)₃ | 3 |
| 796 | Me | Me | (CH₂)_{b} | 0 to 20 | Si | (CH₂ )_{c} | 1 to 20 | Si(OMe)₃ | 3 |
| 797 | Me | Me | (CH₂)_{b} | 0 to 20 | Si | (CH₂)_{c} | 1 to 20 | Si(OMe)₃ | 3 |
| 798 | Me | Me | (CH₂)_{b} | 0 to 20 | Si | (CH₂)_{c} | 1 to 20 | Si(OMe)₃ | 3 |
| 799 | Me | Me | (CH₂)_{b} | 0 to 20 | Si | (CH₂)_{c} | 1 to 20 | Si(OMe)₃ | 3 |
| 800 | Me | Me | (CH₂)_{b} | 0 to 20 | Si | (CH₂)_{c} | 1 to 20 | Si(OMe)₃ | 3 |
| 801 | Me | Me | (CH₂)_{b} | 0 to 20 | Si | (CH₂)_{c} | 1 to 20 | Si(OMe)₃ | 3 |
| 802 | Me | Me | (CH₂)_{b} | 0 to 20 | Si | (CH₂)_{c} | 1 to 20 | Si(OMe)₃ | 3 |
| 803 | Me | Me | (CH₂)_{b} | 0 to 20 | Si | (CH₂)_{c} | 1 to 20 | Si(OMe)₃ | 3 |

TABLE 74

| No. | R^{f1} | L² | a | R¹¹ | R¹² | R¹³ | R¹⁴ |
|---|---|---|---|---|---|---|---|
| 804 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ |
| 805 | N(CF₃)₂ | (CH₂)ₐ | 0 to 20 | CH₂CH₂CF₃ | CH₂CH₂CF₃ | CH₂CH₂CF₃ | CH₂CH₂CF₃ |
| 806 | CF₃ | (CH₂)ₐ | 0 to 20 | CH₂CH₂CF₃ | CH₂CH₂CF₃ | CH₂CH₂CF₃ | CH₂CH₂CF₃ |
| 807 | (CF₃)₂CF | (CH₂)ₐ | 0 to 20 | CH₂CH₂CF₃ | CH₂CH₂CF₃ | CH₂CH₂CF₃ | CH₂CH₂CF₃ |
| 808 | (CF₃)₃C | (CH₂)ₐ | 0 to 20 | CH₂CH₂CF₃ | CH₂CH₂CF₃ | CH₂CH₂CF₃ | CH₂CH₂CF₃ |
| 809 | C₄F₉ | (CH₂)ₐ | 0 to 20 | CH₂CH₂CF₃ | CH₂CH₂CF₃ | CH₂CH₂CF₃ | CH₂CH₂CF₃ |
| 810 | C₈F₁₇ | (CH₂)ₐ | 0 to 20 | CH₂CH₂CF₃ | CH₂CH₂CF₃ | CH₂CH₂CF₃ | CH₂CH₂CF₃ |
| 811 | c-C₆F₁₁ | (CH₂)ₐ | 0 to 20 | CH₂CH₂CF₃ | CH₂CH₂CF₃ | CH₂CH₂CF₃ | CH₂CH₂CF₃ |
| 812 | CHF₂ | (CH₂)ₐ | 0 to 20 | CH₂CH₂CF₃ | CH₂CH₂CF₃ | CH₂CH₂CF₃ | CH₂CH₂CF₃ |
| 813 | CClF₂ | (CH₂)ₐ | 0 to 20 | CH₂CH₂CF₃ | CH₂CH₂CF₃ | CH₂CH₂CF₃ | CH₂CH₂CF₃ |
| 814 | CBrF₂ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 804 | 5 to 100 | Me | Me | (CH₂)_{b} | 0 to 20 | Si | (CH₂)_{c} | 1 to 20 | Si(OMe)₃ | 3 |
| 805 | 5 to 100 | Me | Me | (CH₂)_{b} | 0 to 20 | Si | (CH₂)_{c} | 1 to 20 | Si(OMe)₃ | 3 |
| 806 | 5 to 100 | Me | Me | (CH₂)_{b} | 0 to 20 | C | (CH₂)_{c} | 1 to 20 | Si(OMe)₃ | 3 |
| 807 | 5 to 100 | Me | Me | (CH₂)_{b} | 0 to 20 | C | (CH₂)_{c} | 1 to 20 | Si(OMe)₃ | 3 |
| 808 | 5 to 100 | Me | Me | (CH₂)_{b} | 0 to 20 | C | (CH₂)_{c} | 1 to 20 | Si(OMe)₃ | 3 |
| 809 | 5 to 100 | Me | Me | (CH₂)_{b} | 0 to 20 | C | (CH₂)_{c} | 1 to 20 | Si(OMe)₃ | 3 |
| 810 | 5 to 100 | Me | Me | (CH₂)_{b} | 0 to 20 | C | (CH₂)_{c} | 1 to 20 | Si(OMe)₃ | 3 |
| 811 | 5 to 100 | Me | Me | (CH₂)_{b} | 0 to 20 | C | (CH₂)_{c} | 1 to 20 | Si(OMe)₃ | 3 |
| 812 | 5 to 100 | Me | Me | (CH₂)_{b} | 0 to 20 | C | (CH₂)_{c} | 1 to 20 | Si(OMe)₃ | 3 |
| 813 | 5 to 100 | Me | Me | (CH₂)_{b} | 0 to 20 | C | (CH₂)_{c} | 1 to 20 | Si(OMe)₃ | 3 |
| 814 | 5 to 100 | Me | Me | (CH₂)_{b} | 0 to 20 | C | (CH₂)_{c} | 1 to 20 | Si(OMe)₃ | 3 |

TABLE 75

| No. | R^{f1} | L² | a | R¹¹ | R¹² | R¹³ | R¹⁴ |
|---|---|---|---|---|---|---|---|
| 815 | ClF₂ | (CH₂)ₐ | 0 to 20 | CH₂CH₂CF₃ | CH₂CH₂CF₃ | CH₂CH₂CF₃ | CH₂CH₂CF₃ |
| 816 | CF═CF₂ | (CH₂)ₐ | 0 to 20 | CH₂CH₂CF₃ | CH₂CH₂CF₃ | CH₂CH₂CF₃ | CH₂CH₂CF₃ |
| 817 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 818 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 819 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 820 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 821 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 822 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 823 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 824 | C₆F₅ | (CH₂)ₐ | 0 to 20 | CH₂CH₂CF₃ | CH₂CH₂CF₃ | CH₂CH₂CF₃ | CH₂CH₂CF₃ |
| 825 | 4-CF₃C₆F₄ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 815 | 5 to 100 | Me | Me | (CH₂)_{b} | 0 to 20 | C | (CH₂)_{c} | 1 to 20 | Si(OMe)₃ | 3 |
| 816 | 5 to 100 | Me | Me | (CH₂)_{b} | 0 to 20 | C | (CH₂)_{c} | 1 to 20 | Si(OMe)₃ | 3 |
| 817 | 5 to 100 | Me | Me | (CH₂)_{b} | 0 to 20 | C | (CH₂)_{c} | 1 to 20 | Si(OMe)₃ | 3 |
| 818 | 5 to 100 | Me | Me | (CH₂)_{b} | 0 to 20 | C | (CH₂)_{c} | 1 to 20 | Si(OMe)₃ | 3 |
| 819 | 5 to 100 | Me | Me | (CH₂)_{b} | 0 to 20 | C | (CH₂)_{c} | 1 to 20 | Si(OMe)₃ | 3 |
| 820 | 5 to 100 | Me | Me | (CH₂)_{b} | 0 to 20 | C | (CH₂)_{c} | 1 to 20 | Si(OMe)₃ | 3 |
| 821 | 5 to 100 | Me | Me | (CH₂)_{b} | 0 to 20 | C | (CH₂)_{c} | 1 to 20 | Si(OMe)₃ | 3 |
| 822 | 5 to 100 | Me | Me | (CH₂)_{b} | 0 to 20 | C | (CH₂)_{c} | 1 to 20 | Si(OMe)₃ | 3 |
| 823 | 5 to 100 | Me | Me | (CH₂)_{b} | 0 to 20 | C | (CH₂)_{c} | 1 to 20 | Si(OMe)₃ | 3 |
| 824 | 5 to 100 | Me | Me | (CH₂)_{b} | 0 to 20 | C | (CH₂)_{c} | 1 to 20 | Si(OMe)₃ | 3 |
| 825 | 5 to 100 | Me | Me | (CH₂)_{b} | 0 to 20 | C | (CH₂)_{c} | 1 to 20 | Si(OMe)₃ | 3 |

TABLE 76

| No. | R^{f1} | L² | a | R¹¹ | R¹² | R¹³ | R¹⁴ | z11 |
|---|---|---|---|---|---|---|---|---|
| 826 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 827 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 828 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 829 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 830 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 |
| 831 | 3,5-CF₃C₆H₃ | (CH₂)ₐ | 0 to 20 | CH₂CH2CF₃ | CH₂CH₂CF₃ | CH₂CH₂CF₃ | CH₂CH₂CF₃ | 5 to 100 |
| 832 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 |
| 833 | 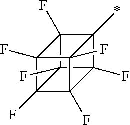 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 |
| 834 | 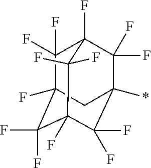 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 |
| 835 | 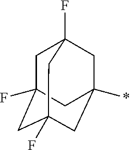 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 |
| 836 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 |

| No. | R¹⁵ | R¹⁶ | R¹ | b | L¹ | R² | c | T¹ | x1 |
|---|---|---|---|---|---|---|---|---|---|
| 826 | Me | Me | (CH₂)_{b} | 0 to 20 | C | (CH₂)_{c} | 1 to 20 | Si(OMe)₃ | 3 |
| 827 | Me | Me | (CH₂)_{b} | 0 to 20 | C | (CH₂)_{c} | 1 to 20 | Si(OMe)₃ | 3 |
| 828 | Me | Me | (CH₂)_{b} | 0 to 20 | C | (CH₂)_{c} | 1 to 20 | Si(OMe)₃ | 3 |
| 829 | Me | Me | (CH₂)_{b} | 0 to 20 | C | (CH₂)_{c} | 1 to 20 | Si(OMe)₃ | 3 |
| 830 | Me | Me | (CH₂)_{b} | 0 to 20 | C | (CH₂)_{c} | 1 to 20 | Si(OMe)₃ | 3 |
| 831 | Me | Me | (CH₂)_{b} | 0 to 20 | C | (CH₂)_{c} | 1 to 20 | Si(OMe)₃ | 3 |
| 832 | Me | Me | (CH₂)_{b} | 0 to 20 | C | (CH₂)_{c} | 1 to 20 | Si(OMe)₃ | 3 |
| 833 | Me | Me | (CH₂)_{b} | 0 to 20 | C | (CH₂)_{c} | 1 to 20 | Si(OMe)₃ | 3 |
| 834 | Me | Me | (CH₂)_{b} | 0 to 20 | C | (CH₂)_{c} | 1 to 20 | Si(OMe)₃ | 3 |
| 835 | Me | Me | (CH₂)_{b} | 0 to 20 | C | (CH₂)_{c} | 1 to 20 | Si(OMe)₃ | 3 |
| 836 | Me | Me | (CH₂)_{b} | 0 to 20 | C | (CH₂)_{c} | 1 to 20 | Si(OMe)₃ | 3 |

TABLE 77

| No. | R^{f1} | L² | a | R¹¹ | R¹² | R¹³ | R¹⁴ |
|---|---|---|---|---|---|---|---|
| 837 | OCF₃ | (CH₂)ₐ | 0 to 20 | CH₂CH₂CF₃ | CH₂CH₂CF₃ | CH₂CH₂CF₃ | CH₂CH₂CF₃ |
| 838 | SCF₃ | (CH₂)ₐ | 0 to 20 | CH₂CH₂CF₃ | CH₂CH₂CF₃ | CH₂CH₂CF₃ | CH₂CH₂CF₃ |
| 839 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ |
| 840 | N(CF₃)₂ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 837 | 5 to 100 | Me | Me | (CH₂)_{b} | 0 to 20 | C | (CH₂)_{c} | 1 to 20 | Si(OMe)₃ | 3 |
| 838 | 5 to 100 | Me | Me | (CH₂)_{b} | 0 to 20 | C | (CH₂)_{c} | 1 to 20 | Si(OMe)₃ | 3 |
| 839 | 5 to 100 | Me | Me | (CH₂)_{b} | 0 to 20 | C | (CH₂)_{c} | 1 to 20 | Si(OMe)₃ | 3 |
| 840 | 5 to 100 | Me | Me | (CH₂)_{b} | 0 to 20 | C | (CH₂)_{c} | 1 to 20 | Si(OMe)₃ | 3 |

TABLE 78

| No. | R^{f1} | L² | a | R¹¹ | R¹² | R¹³ | R¹⁴ | z11 |
|---|---|---|---|---|---|---|---|---|
| 841 | CF₃ | (CH₂)ₐ | 0 to 20 | Me | Me | Me | Me | 5 to 100 |
| 842 | (CF₃)₂CF | (CH₂)ₐ | 0 to 20 | Me | Me | Me | Me | 5 to 100 |
| 843 | (CF₃)₃C | (CH₂)ₐ | 0 to 20 | Me | Me | Me | Me | 5 to 100 |
| 844 | C₄F₉ | (CH₂)ₐ | 0 to 20 | Me | Me | Me | Me | 5 to 100 |
| 845 | C₈F₁₇ | (CH₂)ₐ | 0 to 20 | Me | Me | Me | Me | 5 to 100 |
| 846 | c-C₆F₁₁ | (CH₂)ₐ | 0 to 20 | Me | Me | Me | Me | 5 to 100 |
| 847 | CHF₂ | (CH₂)ₐ | 0 to 20 | Me | Me | Me | Me | 5 to 100 |
| 848 | CClF₂ | (CH₂)ₐ | 0 to 20 | Me | Me | Me | Me | 5 to 100 |
| 849 | CBrF₂ | (CH₂)ₐ | 0 to 20 | Me | Me | Me | Me | 5 to 100 |
| 850 | ClF₂ | (CH₂)ₐ | 0 to 20 | Me | Me | Me | Me | 5 to 100 |
| 851 | CF═CF₂ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 841 | Me | Me | (CH₂)_{b} | 0 to 20 | C(═O)N | (CH₂)_{c} | 1 to 20 | Si(OMe)₃ | 2 |
| 842 | Me | Me | (CH₂)_{b} | 0 to 20 | C(═O)N | (CH₂)_{c} | 1 to 20 | Si(OMe)₃ | 2 |
| 843 | Me | Me | (CH₂)_{b} | 0 to 20 | C(═O)N | (CH₂)_{c} | 1 to 20 | Si(OMe)₃ | 2 |
| 844 | Me | Me | (CH₂)_{b} | 0 to 20 | C(═O)N | (CH₂)_{c} | 1 to 20 | Si(OMe)₃ | 2 |
| 845 | Me | Me | (CH₂)_{b} | 0 to 20 | C(═O)N | (CH₂)_{c} | 1 to 20 | Si(OMe)₃ | 2 |
| 846 | Me | Me | (CH₂)_{b} | 0 to 20 | C(═O)N | (CH₂)_{c} | 1 to 20 | Si(OMe)₃ | 2 |
| 847 | Me | Me | (CH₂)_{b} | 0 to 20 | C(═O)N | (CH₂)_{c} | 1 to 20 | Si(OMe)₃ | 2 |
| 848 | Me | Me | (CH₂)_{b} | 0 to 20 | C(═O)N | (CH₂)_{c} | 1 to 20 | Si(OMe)₃ | 2 |
| 849 | Me | Me | (CH₂)_{b} | 0 to 20 | C(═O)N | (CH₂)_{c} | 1 to 20 | Si(OMe)₃ | 2 |
| 850 | Me | Me | (CH₂)_{b} | 0 to 20 | C(═O)N | (CH₂)_{c} | 1 to 20 | Si(OMe)₃ | 2 |
| 851 | Me | Me | (CH₂)_{b} | 0 to 20 | C(═O)N | (CH₂)_{c} | 1 to 20 | Si(OMe)₃ | 2 |

TABLE 79

| No. | R^{f1} | L² | a | R¹¹ | R¹² | R¹³ | R¹⁴ | z11 |
|---|---|---|---|---|---|---|---|---|
| 852 | CF═CFCF₃ | (CH₂)ₐ | 0 to 20 | Me | Me | Me | Me | 5 to 100 |
| 853 | CF═CFCF═CF₂ | (CH₂)ₐ | 0 to 20 | Me | Me | Me | Me | 5 to 100 |
| 854 | C≡CCF₃ | (CH₂)ₐ | 0 to 20 | Me | Me | Me | Me | 5 to 100 |
| 855 | CF₂CH₃ | (CH₂)ₐ | 0 to 20 | Me | Me | Me | Me | 5 to 100 |
| 856 | (CF₂)₂H | (CH₂)ₐ | 0 to 20 | Me | Me | Me | Me | 5 to 100 |
| 857 | (CF₂)₂CH₃ | (CH₂)ₐ | 0 to 20 | Me | Me | Me | Me | 5 to 100 |
| 858 | (CF₂)₄H | (CH₂)ₐ | 0 to 20 | Me | Me | Me | Me | 5 to 100 |
| 859 | C₆F₅ | (CH₂)ₐ | 0 to 20 | Me | Me | Me | Me | 5 to 100 |
| 860 | 4-CF₃CGF₄ | (CH₂)ₐ | 0 to 20 | Me | Me | Me | Me | 5 to 100 |
| 861 | 4-SF₅C₆F₄ | (CH₂)ₐ | 0 to 20 | Me | Me | Me | Me | 5 to 100 |
| 862 | 3,5-CF₃C₆F₃ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 852 | Me | Me | (CH₂)_{b} | 0 to 20 | C(═O)N | (CH₂)_{c} | 1 to 20 | Si(OMe)₃ | 2 |
| 853 | Me | Me | (CH₂)_{b} | 0 to 20 | C(═O)N | (CH₂)_{c} | 1 to 20 | Si(OMe)₃ | 2 |
| 854 | Me | Me | (CH₂)_{b} | 0 to 20 | C(═O)N | (CH₂)_{c} | 1 to 20 | Si(OMe)₃ | 2 |
| 855 | Me | Me | (CH₂)_{b} | 0 to 20 | C(═O)N | (CH₂)_{c} | 1 to 20 | Si(OMe)₃ | 2 |
| 856 | Me | Me | (CH₂)_{b} | 0 to 20 | C(═O)N | (CH₂)_{c} | 1 to 20 | Si(OMe)₃ | 2 |
| 857 | Me | Me | (CH₂)_{b} | 0 to 20 | C(═O)N | (CH₂)_{c} | 1 to 20 | Si(OMe)₃ | 2 |
| 858 | Me | Me | (CH₂)_{b} | 0 to 20 | C(═O)N | (CH₂)_{c} | 1 to 20 | Si(OMe)₃ | 2 |
| 859 | Me | Me | (CH₂)_{b} | 0 to 20 | C(═O)N | (CH₂)_{c} | 1 to 20 | Si(OMe)₃ | 2 |
| 860 | Me | Me | (CH₂)_{b} | 0 to 20 | C(═O)N | (CH₂)_{c} | 1 to 20 | Si(OMe)₃ | 2 |
| 861 | Me | Me | (CH₂)_{b} | 0 to 20 | C(═O)N | (CH₂)_{c} | 1 to 20 | Si(OMe)₃ | 2 |
| 862 | Me | Me | (CH₂)_{b} | 0 to 20 | C(═O)N | (CH₂)_{c} | 1 to 20 | Si(OMe)₃ | 2 |

TABLE 80

| No. | R^{f1} | L² | a | R¹¹ | R¹² | R¹³ | R¹⁴ | z11 |
|---|---|---|---|---|---|---|---|---|
| 863 | 3,5-SF₅C₆F₃ | (CH₂)ₐ | 0 to 20 | Me | Me | Me | Me | 5 to 100 |
| 864 | 4-CF₃C₆H₄ | (CH₂)ₐ | 0 to 20 | Me | Me | Me | Me | 5 to 100 |
| 865 | 4-SF₅C₆H₄ | (CH₂)ₐ | 0 to 20 | Me | Me | Me | Me | 5 to 100 |
| 866 | 3,5-CF₃C₆H₃ | (CH₂)ₐ | 0 to 20 | Me | Me | Me | Me | 5 to 100 |
| 867 | 3,5-SF₅C₆H₃ | (CH₂)ₐ | 0 to 20 | Me | Me | Me | Me | 5 to 100 |
| 868 | 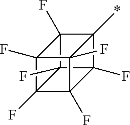 [SMILES: *C12C3(F)C4(F)C1(F)C1(F)C2(F)C3(F)C41F] | (CH₂)ₐ | 0 to 20 | Me | Me | Me | Me | 5 to 100 |
| 869 | 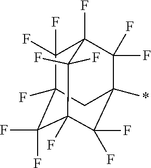 [SMILES: *C12CC3(F)C(F)(F)C(F)(C1(F)F)C(F)(F)C(F)(C2(F)F)C3(F)F] | (CH₂)ₐ | 0 to 20 | Me | Me | Me | Me | 5 to 100 |
| 870 | 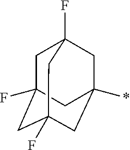 [SMILES: *C12CC3(F)CC(F)(C1)CC(F)(C2)C3] | (CH₂)ₐ | 0 to 20 | Me | Me | Me | Me | 5 to 100 |
| 871 | SF₅ | (CH₂)ₐ | 0 to 20 | Me | Me | Me | Me | 5 to 100 |
| 872 | OCF₃ | (CH₂)ₐ | 0 to 20 | Me | Me | Me | Me | 5 to 100 |
| 873 | SCF₃ | (CH₂)ₐ | 0 to 20 | Me | Me | Me | Me | 5 to 100 |

| No. | R¹⁵ | R¹⁶ | R¹ | b | L¹ | R² | c | T¹ | x1 |
|---|---|---|---|---|---|---|---|---|---|
| 863 | Me | Me | (CH₂)_{b} | 0 to 20 | C(═O)N | (CH₂)_{c} | 1 to 20 | Si(OMe)₃ | 2 |
| 864 | Me | Me | (CH₃)_{b} | 0 to 20 | C(═O)N | (CH₂)_{c} | 1 to 20 | Si(OMe)₃ | 2 |
| 865 | Me | Me | (CH₃)_{b} | 0 to 20 | C(═O)N | (CH₂)_{c} | 1 to 20 | Si(OMe)₃ | 2 |
| 866 | Me | Me | (CH₃)_{b} | 0 to 20 | C(═O)N | (CH₂)_{c} | 1 to 20 | Si(OMe)₃ | 2 |
| 867 | Me | Me | (CH₃)_{b} | 0 to 20 | C(═O)N | (CH₂)_{c} | 1 to 20 | Si(OMe)₃ | 2 |
| 868 | Me | Me | (CH₃)_{b} | 0 to 20 | C(═O)N | (CH₂)_{c} | 1 to 20 | Si(OMe)₃ | 2 |
| 869 | Me | Me | (CH₃)_{b} | 0 to 20 | C(═O)N | (CH₂)_{c} | 1 to 20 | Si(OMe)₃ | 2 |
| 870 | Me | Me | (CH₃)_{b} | 0 to 20 | C(═O)N | (CH₂)_{c} | 1 to 20 | Si(OMe)₃ | 2 |
| 871 | Me | Me | (CH₃)_{b} | 0 to 20 | C(═O)N | (CH₂)_{c} | 1 to 20 | Si(OMe)₃ | 2 |
| 872 | Me | Me | (CH₃)_{b} | 0 to 20 | C(═O)N | (CH₂)_{c} | 1 to 20 | Si(OMe)₃ | 2 |
| 873 | Me | Me | (CH₂)_{b} | 0 to 20 | C(═O)N | (CH₂)_{c} | 1 to 20 | Si(OMe)₃ | 2 |

TABLE 81

| No. | R^{f1} | L² | a | R¹¹ | R¹² | R¹³ | R¹⁴ |
|---|---|---|---|---|---|---|---|
| 874 | N(CH₂CF₃)₂ | (CH₂)ₐ | 0 to 20 | Me | Me | Me | Me |
| 875 | N(CF₃)₂ | (CH₂)ₐ | 0 to 20 | Me | Me | Me | Me |
| 876 | CF₃ | (CH₂)ₐ | 0 to 20 | CH₂CH₂CF₃ | CH₂CH₂CF₃ | CH₂CH₂CF₃ | CH₂CH₂CF₃ |
| 877 | (CF₃)₂CF | (CH₂)ₐ | 0 to 20 | CH₂CH₂CF₃ | CH₂CH₂CF₃ | CH₂CH₂CF₃ | CH₂CH₂CF₃ |
| 878 | (CF₃)₃C | (CH₂)ₐ | 0 to 20 | CH₂CH₂CF₃ | CH₂CH₂CF₃ | CH₂CH₂CF₃ | CH₂CH₂CF₃ |
| 879 | C₄F₉ | (CH₂)ₐ | 0 to 20 | CH₂CH₂CF₃ | CH₂CH₂CF₃ | CH₂CH₂CF₃ | CH₂CH₂CF₃ |
| 880 | C₈F₁₇ | (CH₂)ₐ | 0 to 20 | CH₂CH₂CF₃ | CH₂CH₂CF₃ | CH₂CH₂CF₃ | CH₂CH₂CF₃ |
| 881 | c-C₆F₁₁ | (CH₂)ₐ | 0 to 20 | CH₂CH₂CF₃ | CH₂CH₂CF₃ | CH₂CH₂CF₃ | CH₂CH₂CF₃ |
| 882 | CHF₂ | (CH₂)ₐ | 0 to 20 | CH₂CH₂CF₃ | CH₂CH₂CF₃ | CH₂CH₂CF₃ | CH₂CH₂CF₃ |
| 883 | CClF₂ | (CH₂)ₐ | 0 to 20 | CH₂CH₂CF₃ | CH₂CH₂CF₃ | CH₂CH₂CF₃ | CH₂CH₂CF₃ |
| 884 | CBrF₂ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 874 | 5 to 100 | Me | Me | (CH₂)_{b} | 0 to 20 | C(═O)N | (CH₂)_{c} | 1 to 20 | Si(OMe)₃ | 2 |
| 875 | 5 to 100 | Me | Me | (CH₂)_{b} | 0 to 20 | C(═O)N | (CH₂)_{c} | 1 to 20 | Si(OMe)₃ | 2 |
| 876 | 5 to 100 | Me | Me | (CH₂)_{b} | 0 to 20 | C(═O)N | (CH₂)_{c} | 1 to 20 | Si(OMe)₃ | 2 |
| 877 | 5 to 100 | Me | Me | (CH₂)_{b} | 0 to 20 | C(═O)N | (CH₂)_{c} | 1 to 20 | Si(OMe)₃ | 2 |
| 878 | 5 to 100 | Me | Me | (CH₂)_{b} | 0 to 20 | C(═O)N | (CH₂)_{c} | 1 to 20 | Si(OMe)₃ | 2 |
| 879 | 5 to 100 | Me | Me | (CH₂)_{b} | 0 to 20 | C(═O)N | (CH₂)_{c} | 1 to 20 | Si(OMe)₃ | 2 |
| 880 | 5 to 100 | Me | Me | (CH₂)_{b} | 0 to 20 | C(═O)N | (CH₂)_{c} | 1 to 20 | Si(OMe)₃ | 2 |
| 881 | 5 to 100 | Me | Me | (CH₂)_{b} | 0 to 20 | C(═O)N | (CH₂)_{c} | 1 to 20 | Si(OMe)₃ | 2 |
| 882 | 5 to 100 | Me | Me | (CH₂)_{b} | 0 to 20 | C(═O)N | (CH₂)_{c} | 1 to 20 | Si(OMe)₃ | 2 |
| 883 | 5 to 100 | Me | Me | (CH₂)_{b} | 0 to 20 | C(═O)N | (CH₂)_{c} | 1 to 20 | Si(OMe)₃ | 2 |
| 884 | 5 to 100 | Me | Me | (CH₂)_{b} | 0 to 20 | C(═O)N | (CH₂)_{c} | 1 to 20 | Si(OMe)₃ | 2 |

TABLE 82

| No. | R^{f1} | L² | a | R¹¹ | R¹² | R¹³ | R¹⁴ |
|---|---|---|---|---|---|---|---|
| 885 | ClF₂ | (CH₂)ₐ | 0 to 20 | CH₂CH₂CF₃ | CH₂CH₂CF₃ | CH₂CH₂CF₃ | CH₂CH₂CF₃ |
| 886 | CF═CF₂ | (CH₂)ₐ | 0 to 20 | CH₂CH₂CF₃ | CH₂CH₂CF₃ | CH₂CH₂CF₃ | CH₂CH₂CF₃ |
| 887 | CF═CFCF₃ | (CH₂)ₐ | 0 to 20 | CH₂CH₂CF₃ | CH₂CH₂CF₃ | CH₂CH₂CF₃ | CH₂CH₂CF₃ |
| 888 | CF═CFCF═CF₂ | (CH₂)ₐ | 0 to 20 | CH₂CH₂CF₃ | CH₂CH₂CF₃ | CH₂CH₂CF₃ | CH₂CH₂CF₃ |
| 889 | C≡CCF₃ | (CH₂)ₐ | 0 to 20 | CH₂CH₂CF₃ | CH₂CH₂CF₃ | CH₂CH₂CF₃ | CH₂CH₂CF₃ |
| 890 | CF₂CH₃ | (CH₂)ₐ | 0 to 20 | CH₂CH₂CF₃ | CH₂CH₂CF₃ | CH₂CH₂CF₃ | CH₂CH₂CF₃ |
| 891 | (CF₂)₂H | (CH₂)ₐ | 0 to 20 | CH₂CH₂CF₃ | CH₂CH₂CF₃ | CH₂CH₂CF₃ | CH₂CH₂CF₃ |
| 892 | (CF₂)₂CH₃ | (CH₂)ₐ | 0 to 20 | CH₂CH₂CF₃ | CH₂CH₂CF₃ | CH₂CH₂CF₃ | CH₂CH₂CF₃ |
| 893 | (CF₂)₄H | (CH₂)ₐ | 0 to 20 | CH₂CH₂CF₃ | CH₂CH₂CF₃ | CH₂CH₂CF₃ | CH₂CH₂CF₃ |
| 894 | C₆F₅ | (CH₂)ₐ | 0 to 20 | CH₂CH₂CF₃ | CH₂CH₂CF₃ | CH₂CH₂CF₃ | CH₂CH₂CF₃ |
| 895 | 4-CF₃CGF₄ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 885 | 5 to 100 | Me | Me | (CH₂)_{b} | 0 to 20 | C(═O)N | (CH₂)_{c} | 1 to 20 | Si(OMe)₃ | 2 |
| 886 | 5 to 100 | Me | Me | (CH₂)_{b} | 0 to 20 | C(═O)N | (CH₂)_{c} | 1 to 20 | Si(OMe)₃ | 2 |
| 887 | 5 to 100 | Me | Me | (CH₂)_{b} | 0 to 20 | C(═O)N | (CH₂)_{c} | 1 to 20 | Si(OMe)₃ | 2 |
| 888 | 5 to 100 | Me | Me | (CH₂)_{b} | 0 to 20 | C(═O)N | (CH₂)_{c} | 1 to 20 | Si(OMe)₃ | 2 |
| 889 | 5 to 100 | Me | Me | (CH₂)_{b} | 0 to 20 | C(═O)N | (CH₂)_{c} | 1 to 20 | Si(OMe)₃ | 2 |
| 890 | 5 to 100 | Me | Me | (CH₂)_{b} | 0 to 20 | C(═O)N | (CH₂)_{c} | 1 to 20 | Si(OMe)₃ | 2 |
| 891 | 5 to 100 | Me | Me | (CH₂)_{b} | 0 to 20 | C(═O)N | (CH₂)_{c} | 1 to 20 | Si(OMe)₃ | 2 |
| 892 | 5 to 100 | Me | Me | (CH₂)_{b} | 0 to 20 | C(═O)N | (CH₂)_{c} | 1 to 20 | Si(OMe)₃ | 2 |
| 893 | 5 to 100 | Me | Me | (CH₂)_{b} | 0 to 20 | C(═O)N | (CH₂)_{c} | 1 to 20 | Si(OMe)₃ | 2 |
| 894 | 5 to 100 | Me | Me | (CH₂)_{b} | 0 to 20 | C(═O)N | (CH₂)_{c} | 1 to 20 | Si(OMe)₃ | 2 |
| 895 | 5 to 100 | Me | Me | (CH₂)_{b} | 0 to 20 | C(═O)N | (CH₂)_{c} | 1 to 20 | Si(OMe)₃ | 2 |

TABLE 83

| No. | R^{f1} | L² | a | R¹¹ | R¹² | R¹³ | R¹⁴ | z11 | R¹⁵ | R¹⁶ | R¹ | b | L¹ | R² | c | T¹ | x1 |
|---|---|---|---|---|---|---|---|---|---|---|---|---|---|---|---|---|---|
| 896 | 4-SF₅C₆F₄ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 897 | 3,5-CF₃C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 898 | 3,5-SF₅C₆F₃ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 899 | 4-CF₃C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 900 | 4-SF₅C₆H₄ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 901 | 3,5-CF₃C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 902 | 3,5-SF₅C₆H₃ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 903 | 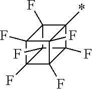 [SMILES: *C12C3(F)C4(F)C1(F)C1(F)C2(F)C3(F)C41F] | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 904 | 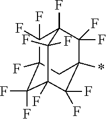 [SMILES: *C12CC3(F)C(F)(F)C(F)(C1(F)F)C(F)(F)C(F)(C2(F)F)C3(F)F] | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 905 | 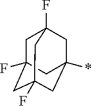 [SMILES: *C12CC3(F)CC(F)(C1)CC(F)(C2)C3] | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |
| 906 | SF₅ | (CH₂)ₐ | 0 to 20 | CH₂CH₂CF₃ | CH₂CH₂CF₃ | CH₂CH₂CF₃ | CH₂CH₂CF₃ | 5 to 100 | Me | Me | (CH₂)_{b} | 0 to 20 | C(═O)N | (CH₂)_{c} | 1 to 20 | Si(OMe)₃ | 2 |

TABLE 84

| No. | R^{f1} | L² | a | R¹¹ | R¹² | R¹³ | R¹⁴ |
|---|---|---|---|---|---|---|---|
| 907 | OCF₃ | (CH₂)ₐ | 0 to 20 | CH₂CH₂CF₃ | CH₂CH₂CF₃ | CH₂CH₂CF₃ | CH₂CH₂CF₃ |
| 908 | SCF₃ | (CH₂)ₐ | 0 to 20 | CH₂CH₂CF₃ | CH₂CH₂CF₃ | CH₂CH₂CF₃ | CH₂CH₂CF₃ |
| 909 | N(CH₂CF₃)₂ | (CH₂)ₐ | 0 to 20 | CH₂CH₂CF₃ | CH₂CH₂CF₃ | CH₂CH₂CF₃ | CH₂CH₂CF₃ |
| 910 | N(CF₃)₂ | (CH₂)ₐ | 0 to 20 | CH₂CH₂CF₃ | CH₂CH₂CF₃ | CH₂CH₂CF₃ | CH₂CH₂CF₃ |

| No. | z11 | R¹⁵ | R¹⁶ | R¹ | b | L¹ | R² | c | T¹ | x1 |
|---|---|---|---|---|---|---|---|---|---|---|
| 907 | 5 to 100 | Me | Me | (CH₂)_{b} | 0 to 20 | C(═O)N | (CH₂)_{c} | 1 to 20 | Si(OMe)₃ | 2 |
| 908 | 5 to 100 | Me | Me | (CH₂)_{b} | 0 to 20 | C(═O)N | (CH₂)_{c} | 1 to 20 | Si(OMe)₃ | 2 |
| 909 | 5 to 100 | Me | Me | (CH₂)_{b} | 0 to 20 | C(═O)N | (CH₂)_{c} | 1 to 20 | Si(OMe)₃ | 2 |
| 910 | 5 to 100 | Me | Me | (CH₂)_{b} | 0 to 20 | C(═O)N | (CH₂)_{c} | 1 to 20 | Si(OMe)₃ | 2 |

### Compound 1-2

The compound 1-2 is a compound represented by the below-shown Formula (1-2).

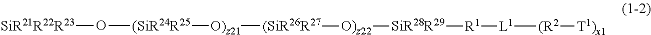

In Formula (1-2),
R²¹, R²², and R²³ are each independently an alkyl group or R^{f1}-L²-,
R²⁴ is R^{f1}-L²-,
R²⁵ is an alkyl group or R^{f1}-L²-,
R²⁶ and R²⁷ are each independently an alkyl group,
R²⁸ and R²⁹ are each independently an alkyl group or R^{f1}-L²-, and R^{f1}, L², R¹, L¹, R², T¹, and x1 are synonymous with R^{f1}, L², R¹, L¹, R², T¹, and x1, respectively, in Formula (1),
z21 is an integer of 1 or greater,
z22 is an integer of 0 or greater, and
when there are a plurality of R²⁴, R²⁵, R²⁶, R²⁷, R², or T¹, the plurality of R²⁴, R²⁵, R²⁶, R²⁷, R², or T¹ may be the same as each other or different from each other.

The carbon number of the alkyl group in R²¹, R²², R²³, R²⁵, R²⁶, R²⁷, R²⁸, and R²⁹ is preferably 1 to 18, more preferably 1 to 6, and still more preferably 1 to 3.

When the carbon number of the alkyl group is 3 or greater, the alkyl group having a carbon number of 3 or greater may be linear, or may have a branched or ring structure.

z21 is an integer of 1 or greater, preferably 1 to 100, more preferably 1 to 30, and still more preferably 5 to 20.

z22 is an integer of 0 or greater, preferably 0 to 100, more preferably 1 to 30, and still more preferably 5 to 20.

The bonding order of (SiR²⁴R²⁵—O) and (SiR²⁶R²⁷—O) in Formula (1-2) is arbitrary. z21 and z22 in Formula (1-2) represent the numbers of (SiR²⁴R²⁵—O) and (SiR²⁶R²⁷—O), respectively, and do not represent the arrangements. For example, (SiR²⁴R²⁵—O)_{z21} represents that the number of (SiR²⁴R²⁵—O) is z21, and does not represent the block arrangement structure of (SiR²⁴R²⁵—O)_{z21}. Similarly, the order in which (SiR²⁴R²⁵—O) and (SiR²⁶R²⁷—O) are listed does not represent the bonding order of the respective units.

For example, (SiR²⁴R²⁵—O) and (SiR²⁶R²⁷—O) may be alternately arranged, or (SiR²⁴R²⁵—O) and (SiR²⁶R²⁷—O) may be arranged in each block. Alternatively, they may be randomly arranged.

Specific examples of the compound 1-2 include compounds represented by the below-shown formulae. In the following table, for example, a compound “No. 1” means a compound of Formula (1-2) in which: R²¹ is Me-(CH₂)ₐ; a in Me-(CH₂)ₐ is 0 to 20; R²² is Me; R²³ is Me; R²⁴ is CF₃—(CH₂)ₐ; a in CF₃—(CH₂)ₐ is 0 to 20, R²⁵ is Me; z21 is 5 to 100, z22 is 0; R²⁸ is Me; R²⁹ is Me; R¹ is (CH₂)_{b}; b in (CH₂)_{b} is 0 to 20; L¹ is C(═O)NH; R² is (CH₂)_{c}; C in (CH₂)_{c} is 1 to 20; T¹ is Si(OMe)₃; and x1 is 1.

TABLE 85

| No. | R²¹ | | a | R²² | R²³ | R²⁴ | | | R²⁵ | z21 | z22 |
|---|---|---|---|---|---|---|---|---|---|---|---|
| 1 | Me | (CH₂)ₐ | 0 to 20 | Me | Me | CF₃ | (CH₂)ₐ | 0 to 20 | Me | 5 to 100 | 0 |
| 2 | CF₃ | (CH₂)ₐ | 0 to 20 | Me | Me | CF₃ | (CH₂)ₐ | 0 to 20 | Me | 5 to 100 | 0 |
| 3 | (CF₃)₂CF | (CH₂)ₐ | 0 to 20 | Me | Me | CF₃ | (CH₂)ₐ | 0 to 20 | Me | 5 to 100 | 0 |
| 4 | (CF₃)₃C | (CH₂)ₐ | 0 to 20 | Me | Me | CF₃ | (CH₂)ₐ | 0 to 20 | Me | 5 to 100 | 0 |
| 5 | C₄F₉ | (CH₂)ₐ | 0 to 20 | Me | Me | CF₃ | (CH₂)ₐ | 0 to 20 | Me | 5 to 100 | 0 |
| 6 | C₈F₁₇ | (CH₂)ₐ | 0 to 20 | Me | Me | CF₃ | (CH₂)ₐ | 0 to 20 | Me | 5 to 100 | 0 |
| 7 | c-C₆F₁₁ | (CH₂)ₐ | 0 to 20 | Me | Me | CF₃ | (CH₂)ₐ | 0 to 20 | Me | 5 to 100 | 0 |
| 8 | CHF₂ | (CH₂)ₐ | 0 to 20 | Me | Me | CF₃ | (CH₂)ₐ | 0 to 20 | Me | 5 to 100 | 0 |
| 9 | CClF₂ | (CH₂)ₐ | 0 to 20 | Me | Me | CF₃ | (CH₂)ₐ | 0 to 20 | Me | 5 to 100 | 0 |
| 10 | CBrF₂ | (CH₂)ₐ | 0 to 20 | Me | Me | CF₃ | (CH₂)ₐ | 0 to 20 | Me | 5 to 100 | 0 |
| 11 | ClF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 1 | Me | Me | (CH₂)_{b} | 0 to 20 | C(═O)NH | (CH₂)_{c} | 1 to 20 | Si(OMe)₃ | 1 |
| 2 | Me | Me | (CH₂)_{b} | 0 to 20 | C(═O)NH | (CH₂)_{c} | 1 to 20 | Si(OMe)₃ | 1 |
| 3 | Me | Me | (CH₂)_{b} | 0 to 20 | C(═O)NH | (CH₂)_{c} | 1 to 20 | Si(OMe)₃ | 1 |
| 4 | Me | Me | (CH₂)_{b} | 0 to 20 | C(═O)NH | (CH₂)_{c} | 1 to 20 | Si(OMe)₃ | 1 |
| 5 | Me | Me | (CH₂)_{b} | 0 to 20 | C(═O)NH | (CH₂)_{c} | 1 to 20 | Si(OMe)₃ | 1 |
| 6 | Me | Me | (CH₂)_{b} | 0 to 20 | C(═O)NH | (CH₂)_{c} | 1 to 20 | Si(OMe)₃ | 1 |
| 7 | Me | Me | (CH₂)_{b} | 0 to 20 | C(═O)NH | (CH₂)_{c} | 1 to 20 | Si(OMe)₃ | 1 |
| 8 | Me | Me | (CH₂)_{b} | 0 to 20 | C(═O)NH | (CH₂)_{c} | 1 to 20 | Si(OMe)₃ | 1 |
| 9 | Me | Me | (CH₂)_{b} | 0 to 20 | C(═O)NH | (CH₂)_{c} | 1 to 20 | Si(OMe)₃ | 1 |
| 10 | Me | Me | (CH₂)_{b} | 0 to 20 | C(═O)NH | (CH₂)_{c} | 1 to 20 | Si(OMe)₃ | 1 |
| 11 | Me | Me | (CH₂)_{b} | 0 to 20 | C(═O)NH | (CH₂)_{c} | 1 to 20 | Si(OMe)₃ | 1 |

TABLE 86

| No. | R²¹ | | a | R²² | R²³ | R²⁴ | | | R²⁵ | z21 |
|---|---|---|---|---|---|---|---|---|---|---|
| 12 | CF═CF₂ | (CH₂)ₐ | 0 to 20 | Me | Me | CF₃ | (CH₂)ₐ | 0 to 20 | Me | 5 to 100 |
| 13 | CF═CFCF₃ | (CH₂)ₐ | 0 to 20 | Me | Me | CF₃ | (CH₂)ₐ | 0 to 20 | Me | 5 to 100 |
| 14 | CF═CFCF═CF₂ | (CH₂)ₐ | 0 to 20 | Me | Me | CF₃ | (CH₂)ₐ | 0 to 20 | Me | 5 to 100 |
| 15 | C≡CCF₃ | (CH₂)ₐ | 0 to 20 | Me | Me | CF₃ | (CH₂)ₐ | 0 to 20 | Me | 5 to 100 |
| 16 | CF₂CH₃ | (CH₂)ₐ | 0 to 20 | Me | Me | CF₃ | (CH₂)ₐ | 0 to 20 | Me | 5 to 100 |
| 17 | (CF₂)₂H | (CH₂)ₐ | 0 to 20 | Me | Me | CF₃ | (CH₂)ₐ | 0 to 20 | Me | 5 to 100 |
| 18 | (CF₂)₂CH₃ | (CH₂)ₐ | 0 to 20 | Me | Me | CF₃ | (CH₂)ₐ | 0 to 20 | Me | 5 to 100 |
| 19 | (CF₂)₄H | (CH₂)ₐ | 0 to 20 | Me | Me | CF₃ | (CH₂)ₐ | 0 to 20 | Me | 5 to 100 |
| 20 | C₆F₅ | (CH₂)ₐ | 0 to 20 | Me | Me | CF₃ | (CH₂)ₐ | 0 to 20 | Me | 5 to 100 |
| 21 | 4-CF₃C₆F₄ | (CH₂)ₐ | 0 to 20 | Me | Me | CF₃ | (CH₂)ₐ | 0 to 20 | Me | 5 to 100 |
| 22 | 4-SF₅C₆F₄ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 12 | 0 | Me | Me | (CH₂)_{b} | 0 to 20 | C(═O)NH | (CH₂)_{c} | 1 to 20 | Si(OMe)₃ | 1 |
| 13 | 0 | Me | Me | (CH₂)_{b} | 0 to 20 | C(═O)NH | (CH₂)_{c} | 1 to 20 | Si(OMe)₃ | 1 |
| 14 | 0 | Me | Me | (CH₂)_{b} | 0 to 20 | C(═O)NH | (CH₂)_{c} | 1 to 20 | Si(OMe)₃ | 1 |
| 15 | 0 | Me | Me | (CH₂)_{b} | 0 to 20 | C(═O)NH | (CH₂)_{c} | 1 to 20 | Si(OMe)₃ | 1 |
| 16 | 0 | Me | Me | (CH₂)_{b} | 0 to 20 | C(═O)NH | (CH₂)_{c} | 1 to 20 | Si(OMe)₃ | 1 |
| 17 | 0 | Me | Me | (CH₂)_{b} | 0 to 20 | C(═O)NH | (CH₂)_{c} | 1 to 20 | Si(OMe)₃ | 1 |
| 18 | 0 | Me | Me | (CH₂)_{b} | 0 to 20 | C(═O)NH | (CH₂)_{c} | 1 to 20 | Si(OMe)₃ | 1 |
| 19 | 0 | Me | Me | (CH₂)_{b} | 0 to 20 | C(═O)NH | (CH₂)_{c} | 1 to 20 | Si(OMe)₃ | 1 |
| 20 | 0 | Me | Me | (CH₂)_{b} | 0 to 20 | C(═O)NH | (CH₂)_{c} | 1 to 20 | Si(OMe)₃ | 1 |
| 21 | 0 | Me | Me | (CH₂)_{b} | 0 to 20 | C(═O)NH | (CH₂)_{c} | 1 to 20 | Si(OMe)₃ | 1 |
| 22 | 0 | Me | Me | (CH₂)_{b} | 0 to 20 | C(═O)NH | (CH₂)_{c} | 1 to 20 | Si(OMe)₃ | 1 |

TABLE 87

| No. | R²¹ | | a | R²² | R²³ | R²⁴ | | | R²⁵ | z21 | z22 | R²⁸ | R²⁹ | R¹ | b | L¹ | R² | C | T¹ | x1 |
|---|---|---|---|---|---|---|---|---|---|---|---|---|---|---|---|---|---|---|---|---|
| 23 | 3,5-CF₃C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 24 | 3,5-SF₅C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 25 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 26 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 27 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 28 | 3,5-SF₅C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 29 | 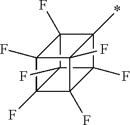 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 30 | 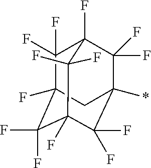 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 31 | 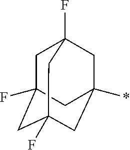 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 32 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 33 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 88

| No. | R²¹ | | a | R²² | R²³ | R²⁴ | | | R²⁵ | z21 |
|---|---|---|---|---|---|---|---|---|---|---|
| 34 | SCF₃ | (CH₂)ₐ | 0 to 20 | Me | Me | CF₃ | (CH₂)ₐ | 0 to 20 | Me | 5 to 100 |
| 35 | N(CH₂CF₃)₂ | (CH₂)ₐ | 0 to 20 | Me | Me | CF₃ | (CH₂)ₐ | 0 to 20 | Me | 5 to 100 |
| 36 | N(CF₃)₂ | (CH₂)ₐ | 0 to 20 | Me | Me | CF₃ | (CH₂)ₐ | 0 to 20 | Me | 5 to 100 |
| 37 | Me | (CH₂)ₐ | 0 to 20 | Me | Me | CHF₂ | (CH₂)ₐ | 0 to 20 | Me | 5 to 100 |
| 38 | CF₃ | (CH₂)ₐ | 0 to 20 | Me | Me | CHF₂ | (CH₂)ₐ | 0 to 20 | Me | 5 to 100 |
| 39 | (CF₃)₂CF | (CH₂)ₐ | 0 to 20 | Me | Me | CHF₂ | (CH₂)ₐ | 0 to 20 | Me | 5 to 100 |
| 40 | (CF₃)₃C | (CH₂)ₐ | 0 to 20 | Me | Me | CHF₂ | (CH₂)ₐ | 0 to 20 | Me | 5 to 100 |
| 41 | C₄F₉ | (CH₂)ₐ | 0 to 20 | Me | Me | CHF₂ | (CH₂)ₐ | 0 to 20 | Me | 5 to 100 |
| 42 | C₈F₁₇ | (CH₂)ₐ | 0 to 20 | Me | Me | CHF₂ | (CH₂)ₐ | 0 to 20 | Me | 5 to 100 |
| 43 | c-C₆F₁₁ | (CH₂)ₐ | 0 to 20 | Me | Me | CHF₂ | (CH₂)ₐ | 0 to 20 | Me | 5 to 100 |
| 44 | CHF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 34 | 0 | Me | Me | (CH₂)_{b} | 0 to 20 | C(═O)NH | (CH₂)_{c} | 1 to 20 | Si(OMe)₃ | 1 |
| 35 | 0 | Me | Me | (CH₂)_{b} | 0 to 20 | C(═O)NH | (CH₂)_{c} | 1 to 20 | Si(OMe)₃ | 1 |
| 36 | 0 | Me | Me | (CH₂)_{b} | 0 to 20 | C(═O)NH | (CH₂)_{c} | 1 to 20 | Si(OMe)₃ | 1 |
| 37 | 0 | Me | Me | (CH₂)_{b} | 0 to 20 | C(═O)NH | (CH₂)_{c} | 1 to 20 | Si(OMe)₃ | 1 |
| 38 | 0 | Me | Me | (CH₂)_{b} | 0 to 20 | C(═O)NH | (CH₂)_{c} | 1 to 20 | Si(OMe)₃ | 1 |
| 39 | 0 | Me | Me | (CH₂)_{b} | 0 to 20 | C(═O)NH | (CH₂)_{c} | 1 to 20 | Si(OMe)₃ | 1 |
| 40 | 0 | Me | Me | (CH₂)_{b} | 0 to 20 | C(═O)NH | (CH₂)_{c} | 1 to 20 | Si(OMe)₃ | 1 |
| 41 | 0 | Me | Me | (CH₂)_{b} | 0 to 20 | C(═O)NH | (CH₂)_{c} | 1 to 20 | Si(OMe)₃ | 1 |
| 42 | 0 | Me | Me | (CH₂)_{b} | 0 to 20 | C(═O)NH | (CH₂)_{c} | 1 to 20 | Si(OMe)₃ | 1 |
| 43 | 0 | Me | Me | (CH₂)_{b} | 0 to 20 | C(═O)NH | (CH₂)_{c} | 1 to 20 | Si(OMe)₃ | 1 |
| 44 | 0 | Me | Me | (CH₂)_{b} | 0 to 20 | C(═O)NH | (CH₂)_{c} | 1 to 20 | Si(OMe)₃ | 1 |

TABLE 89

| No. | R²¹ | | a | R²² | R²³ | R²⁴ | | | R²⁵ | z21 |
|---|---|---|---|---|---|---|---|---|---|---|
| 45 | CClF₂ | (CH₂)ₐ | 0 to 20 | Me | Me | CHF₂ | (CH₂)ₐ | 0 to 20 | Me | 5 to 100 |
| 46 | CBrF₂ | (CH₂)ₐ | 0 to 20 | Me | Me | CHF₂ | (CH₂)ₐ | 0 to 20 | Me | 5 to 100 |
| 47 | ClF₂ | (CH₂)ₐ | 0 to 20 | Me | Me | CHF₂ | (CH₂)ₐ | 0 to 20 | Me | 5 to 100 |
| 48 | CF═CF₂ | (CH₂)ₐ | 0 to 20 | Me | Me | CHF₂ | (CH₂)ₐ | 0 to 20 | Me | 5 to 100 |
| 49 | CF═CFCF₃ | (CH₂)ₐ | 0 to 20 | Me | Me | CHF₂ | (CH₂)ₐ | 0 to 20 | Me | 5 to 100 |
| 50 | CF═CFCF═CF₂ | (CH₂)ₐ | 0 to 20 | Me | Me | CHF₂ | (CH₂)ₐ | 0 to 20 | Me | 5 to 100 |
| 51 | C≡CCF₃ | (CH₂)ₐ | 0 to 20 | Me | Me | CHF₂ | (CH₂)ₐ | 0 to 20 | Me | 5 to 100 |
| 52 | CF₂CH₃ | (CH₂)ₐ | 0 to 20 | Me | Me | CHF₂ | (CH₂)ₐ | 0 to 20 | Me | 5 to 100 |
| 53 | (CF₂)₂H | (CH₂)ₐ | 0 to 20 | Me | Me | CHF₂ | (CH₂)ₐ | 0 to 20 | Me | 5 to 100 |
| 54 | (CF₂)₂CH₃ | (CH₂)ₐ | 0 to 20 | Me | Me | CHF₂ | (CH₂)ₐ | 0 to 20 | Me | 5 to 100 |
| 55 | (CF₂)₄H | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 45 | 0 | Me | Me | (CH₂)_{b} | 0 to 20 | C(═O)NH | (CH₂)_{c} | 1 to 20 | Si(OMe)₃ | 1 |
| 46 | 0 | Me | Me | (CH₂)_{b} | 0 to 20 | C(═O)NH | (CH₂)_{c} | 1 to 20 | Si(OMe)₃ | 1 |
| 47 | 0 | Me | Me | (CH₂)_{b} | 0 to 20 | C(═O)NH | (CH₂)_{c} | 1 to 20 | Si(OMe)₃ | 1 |
| 48 | 0 | Me | Me | (CH₂)_{b} | 0 to 20 | C(═O)NH | (CH₂)_{c} | 1 to 20 | Si(OMe)₃ | 1 |
| 49 | 0 | Me | Me | (CH₂)_{b} | 0 to 20 | C(═O)NH | (CH₂)_{c} | 1 to 20 | Si(OMe)₃ | 1 |
| 50 | 0 | Me | Me | (CH₂)_{b} | 0 to 20 | C(═O)NH | (CH₂)_{c} | 1 to 20 | Si(OMe)₃ | 1 |
| 51 | 0 | Me | Me | (CH₂)_{b} | 0 to 20 | C(═O)NH | (CH₂)_{c} | 1 to 20 | Si(OMe)₃ | 1 |
| 52 | 0 | 0Me | Me | (CH₂)_{b} | 0 to 20 | C(═O)NH | (CH₂)_{c} | 1 to 20 | Si(OMe)₃ | 1 |
| 53 | 0 | Me | Me | (CH₂)_{b} | 0 to 20 | C(═O)NH | (CH₂)_{c} | 1 to 20 | Si(OMe)₃ | 1 |
| 54 | 0 | Me | Me | (CH₂)_{b} | 0 to 20 | C(═O)NH | (CH₂)_{c} | 1 to 20 | Si(OMe)₃ | 1 |
| 55 | 0 | Me | Me | (CH₂)_{b} | 0 to 20 | C(═O)NH | (CH₂)_{c} | 1 to 20 | Si(OMe)₃ | 1 |

TABLE 90

| No. | R²¹ | | a | R²² | R²³ | R²⁴ | | | R²⁵ | z21 | z22 | R²⁸ | R²⁹ | R¹ | b | L¹ | R² | C | T¹ | x1 |
|---|---|---|---|---|---|---|---|---|---|---|---|---|---|---|---|---|---|---|---|---|
| 56 | C₆F₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 57 | 4-CF₃C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 58 | 4-SF₅C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 59 | 3,5-CF₃C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 60 | 3,5-SF₅C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 61 | 4-CF₃C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 62 | 4-SF₅C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 63 | 3,5-CF₃C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 64 | 3,5-SF₅C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 65 | 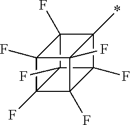 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 66 | 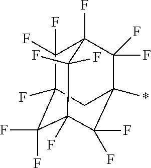 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 91

| No. | R²¹ | | a | R²² | R²³ | R²⁴ | | | R²⁵ | z21 | z22 | R²⁸ | R²⁹ | R¹ | b | L¹ | R² | C | T¹ | x1 |
|---|---|---|---|---|---|---|---|---|---|---|---|---|---|---|---|---|---|---|---|---|
| 67 | 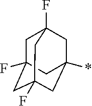 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 68 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 69 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 70 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 71 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 72 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 73 | Me | (CH₂)ₐ | 0 to 20 | Me | Me | 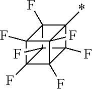 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 74 | CF₃ | (CH₂)ₐ | 0 to 20 | Me | Me | 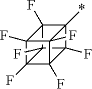 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 75 | (CF₃)₂CF | (CH₂)ₐ | 0 to 20 | Me | Me | 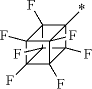 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 76 | (CF₃)₃C | (CH₂)ₐ | 0 to 20 | Me | Me | 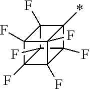 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 77 | C₄F₉ | (CH₂)ₐ | 0 to 20 | Me | Me | 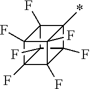 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 92

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 78 | C₈F₁₇ | (CH₂)ₐ | 0 to 20 | Me | Me | 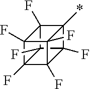 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 79 | c-C₆F₁₁ | (CH₂)ₐ | 0 to 20 | Me | Me | 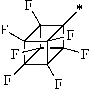 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 80 | CHF₂ | (CH₂)ₐ | 0 to 20 | Me | Me | 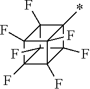 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 81 | CClF₂ | (CH₂)ₐ | 0 to 20 | Me | Me | 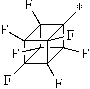 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 82 | CBrF₂ | (CH₂)ₐ | 0 to 20 | Me | Me | 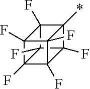 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 83 | ClF₂ | (CH₂)ₐ | 0 to 20 | Me | Me | 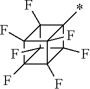 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 84 | CF═CF₂ | (CH₂)ₐ | 0 to 20 | Me | Me | 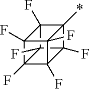 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 85 | CF═CFCF₃ | (CH₂)ₐ | 0 to 20 | Me | Me | 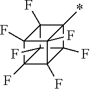 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 86 | CF═CFCF═CF₂ | (CH₂)ₐ | 0 to 20 | Me | Me | 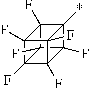 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 87 | C≡CCF₃ | (CH₂)ₐ | 0 to 20 | Me | Me | 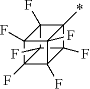 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 88 | CF₂CH₃ | (CH₂)ₐ | 0 to 20 | Me | Me | 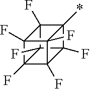 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 93

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 89 | (CF₂)₂H | (CH₂)ₐ | 0 to 20 | Me | Me | 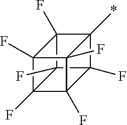 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 90 | (CF₂)₂CH₃ | (CH₂)ₐ | 0 to 20 | Me | Me | 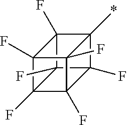 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 91 | (CF₂)₄H | (CH₂)ₐ | 0 to 20 | Me | Me | 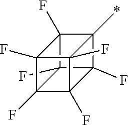 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 92 | C₆F₅ | (CH₂)ₐ | 0 to 20 | Me | Me | 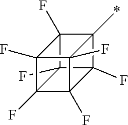 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 93 | 4-CF₃C₆F₄ | (CH₂)ₐ | 0 to 20 | Me | Me | 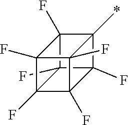 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 94 | 4-SF₅C₆F₄ | (CH₂)ₐ | 0 to 20 | Me | Me | 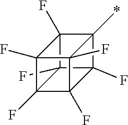 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 95 | 3,5-CF₃C₆F₃ | (CH₂)ₐ | 0 to 20 | Me | Me | 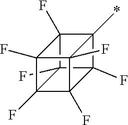 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 96 | 3,5-SF₅C₆F₃ | (CH₂)ₐ | 0 to 20 | Me | Me | 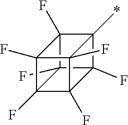 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 97 | 4-CF₃C₆H₄ | (CH₂)ₐ | 0 to 20 | Me | Me | 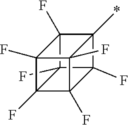 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 98 | 4-SF₅C₆H₄ | (CH₂)ₐ | 0 to 20 | Me | Me | 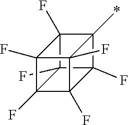 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 99 | 3,5-CF₃C₆H₃ | (CH₂)ₐ | 0 to 20 | Me | Me | 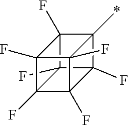 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 94

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 100 | 3,5-SF₅C₆H₃ | (CH₂)ₐ | 0 to 20 | Me | Me | 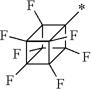 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 101 | 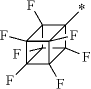 [SMILES: *C12C3(F)C4(F)C1(F)C1(F)C2(F)C3(F)C41F] | (CH₂)ₐ | 0 to 20 | Me | Me | 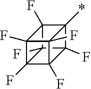 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 102 | 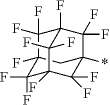 [SMILES: *C12CC3(F)C(F)(F)C(F)(C1(F)F)C(F)(F)C(F)(C2(F)F)C3(F)F] | (CH₂)ₐ | 0 to 20 | Me | Me | 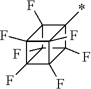 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 103 | 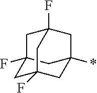 [SMILES: *C12CC3(F)CC(F)(C1)CC(F)(C2)C3] | (CH₂)ₐ | 0 to 20 | Me | Me | 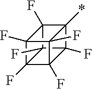 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 104 | SF₅ | (CH₂)ₐ | 0 to 20 | Me | Me | 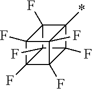 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 105 | OCF₃ | (CH₂)ₐ | 0 to 20 | Me | Me | 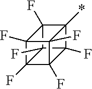 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 106 | SCF₃ | (CH₂)ₐ | 0 to 20 | Me | Me | 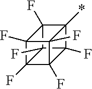 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 107 | N(CH₂CF₃)₂ | (CH₂)ₐ | 0 to 20 | Me | Me | 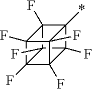 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 108 | N(CF₃)₂ | (CH₂)ₐ | 0 to 20 | Me | Me | 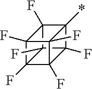 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 109 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 110 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 95

| No. | R²¹ | | a | R²² | R²³ | R²⁴ | | | R²⁵ | z21 |
|---|---|---|---|---|---|---|---|---|---|---|
| 111 | (CF₃)₂CF | (CH₂)ₐ | 0 to 20 | Me | Me | SF₅ | (CH₂)ₐ | 0 to 20 | Me | 5 to 100 |
| 112 | (CF₃)₃C | (CH₂)ₐ | 0 to 20 | Me | Me | SF₅ | (CH₂)ₐ | 0 to 20 | Me | 5 to 100 |
| 113 | C₄F₉ | (CH₂)ₐ | 0 to 20 | Me | Me | SF₅ | (CH₂)ₐ | 0 to 20 | Me | 5 to 100 |
| 114 | C₈F₁₇ | (CH₂)ₐ | 0 to 20 | Me | Me | SF₅ | (CH₂)ₐ | 0 to 20 | Me | 5 to 100 |
| 115 | c-C₆F₁₁ | (CH₂)ₐ | 0 to 20 | Me | Me | SF₅ | (CH₂)ₐ | 0 to 20 | Me | 5 to 100 |
| 116 | CHF₂ | (CH₂)ₐ | 0 to 20 | Me | Me | SF₅ | (CH₂)ₐ | 0 to 20 | Me | 5 to 100 |
| 117 | CClF₂ | (CH₂)ₐ | 0 to 20 | Me | Me | SF₅ | (CH₂)ₐ | 0 to 20 | Me | 5 to 100 |
| 118 | CBrF₂ | (CH₂)ₐ | 0 to 20 | Me | Me | SF₅ | (CH₂)ₐ | 0 to 20 | Me | 5 to 100 |
| 119 | ClF₂ | (CH₂)ₐ | 0 to 20 | Me | Me | SF₅ | (CH₂)ₐ | 0 to 20 | Me | 5 to 100 |
| 120 | CF═CF₂ | (CH₂)ₐ | 0 to 20 | Me | Me | SF₅ | (CH₂)ₐ | 0 to 20 | Me | 5 to 100 |
| 121 | CF═CFCF₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 111 | 0 | Me | Me | (CH₂)_{b} | 0 to 20 | C(═O)NH | (CH₂)_{c} | 1 to 20 | Si(OMe)₃ | 1 |
| 112 | 0 | Me | Me | (CH₂)_{b} | 0 to 20 | C(═O)NH | (CH₂)_{c} | 1 to 20 | Si(OMe)₃ | 1 |
| 113 | 0 | Me | Me | (CH₂)_{b} | 0 to 20 | C(═O)NH | (CH₂)_{c} | 1 to 20 | Si(OMe)₃ | 1 |
| 114 | 0 | Me | Me | (CH₂)_{b} | 0 to 20 | C(═O)NH | (CH₂)_{c} | 1 to 20 | Si(OMe)₃ | 1 |
| 115 | 0 | Me | Me | (CH₂)_{b} | 0 to 20 | C(═O)NH | (CH₂)_{c} | 1 to 20 | Si(OMe)₃ | 1 |
| 116 | 0 | Me | Me | (CH₂)_{b} | 0 to 20 | C(═O)NH | (CH₂)_{c} | 1 to 20 | Si(OMe)₃ | 1 |
| 117 | 0 | Me | Me | (CH₂)_{b} | 0 to 20 | C(═O)NH | (CH₂)_{c} | 1 to 20 | Si(OMe)₃ | 1 |
| 118 | 0 | Me | Me | (CH₂)_{b} | 0 to 20 | C(═O)NH | (CH₂)_{c} | 1 to 20 | Si(OMe)₃ | 1 |
| 119 | 0 | Me | Me | (CH₂)_{b} | 0 to 20 | C(═O)NH | (CH₂)_{c} | 1 to 20 | Si(OMe)₃ | 1 |
| 120 | 0 | Me | Me | (CH₂)_{b} | 0 to 20 | C(═O)NH | (CH₂)_{c} | 1 to 20 | Si(OMe)₃ | 1 |
| 121 | 0 | Me | Me | (CH₂)_{b} | 0 to 20 | C(═O)NH | (CH₂)_{c} | 1 to 20 | Si(OMe)₃ | 1 |

TABLE 96

| No. | R²¹ | | a | R²² | R²³ | R²⁴ | | | R²⁵ | z21 |
|---|---|---|---|---|---|---|---|---|---|---|
| 122 | CF═CFCF═CF₂ | (CH₂)ₐ | 0 to 20 | Me | Me | SF₅ | (CH₂)ₐ | 0 to 20 | Me | 5 to 100 |
| 123 | C≡CCF₃ | (CH₂)ₐ | 0 to 20 | Me | Me | SF₅ | (CH₂)ₐ | 0 to 20 | Me | 5 to 100 |
| 124 | CF₂CH₃ | (CH₂)ₐ | 0 to 20 | Me | Me | SF₅ | (CH₂)ₐ | 0 to 20 | Me | 5 to 100 |
| 125 | (CF₂)₂H | (CH₂)ₐ | 0 to 20 | Me | Me | SF₅ | (CH₂)ₐ | 0 to 20 | Me | 5 to 100 |
| 126 | (CF₂)₂CH₃ | (CH₂)ₐ | 0 to 20 | Me | Me | SF₅ | (CH₂)ₐ | 0 to 20 | Me | 5 to 100 |
| 127 | (CF₂)₄H | (CH₂)ₐ | 0 to 20 | Me | Me | SF₅ | (CH₂)ₐ | 0 to 20 | Me | 5 to 100 |
| 128 | C₆F₅ | (CH₂)ₐ | 0 to 20 | Me | Me | SF₅ | (CH₂)ₐ | 0 to 20 | Me | 5 to 100 |
| 129 | 4-CF₃C₆F₄ | (CH₂)ₐ | 0 to 20 | Me | Me | SF₅ | (CH₂)ₐ | 0 to 20 | Me | 5 to 100 |
| 130 | 4-SF₅C₆F₄ | (CH₂)ₐ | 0 to 20 | Me | Me | SF₅ | (CH₂)ₐ | 0 to 20 | Me | 5 to 100 |
| 131 | 3,5-CF₃C₆F₃ | (CH₂)ₐ | 0 to 20 | Me | Me | SF₅ | (CH₂)ₐ | 0 to 20 | Me | 5 to 100 |
| 132 | 3,5-SF₅C₆F₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 122 | 0 | Me | Me | (CH₂)_{b} | 0 to 20 | C(═O)NH | (CH₂)_{c} | 1 to 20 | Si(OMe)₃ | 1 |
| 123 | 0 | Me | Me | (CH₂)_{b} | 0 to 20 | C(═O)NH | (CH₂)_{c} | 1 to 20 | Si(OMe)₃ | 1 |
| 124 | 0 | Me | Me | (CH₂)_{b} | 0 to 20 | C(═O)NH | (CH₂)_{c} | 1 to 20 | Si(OMe)₃ | 1 |
| 125 | 0 | Me | Me | (CH₂)_{b} | 0 to 20 | C(═O)NH | (CH₂)_{c} | 1 to 20 | Si(OMe)₃ | 1 |
| 126 | 0 | Me | Me | (CH₂)_{b} | 0 to 20 | C(═O)NH | (CH₂)_{c} | 1 to 20 | Si(OMe)₃ | 1 |
| 127 | 0 | Me | Me | (CH₂)_{b} | 0 to 20 | C(═O)NH | (CH₂)_{c} | 1 to 20 | Si(OMe)₃ | 1 |
| 128 | 0 | Me | Me | (CH₂)_{b} | 0 to 20 | C(═O)NH | (CH₂)_{c} | 1 to 20 | Si(OMe)₃ | 1 |
| 129 | 0 | Me | Me | (CH₂)_{b} | 0 to 20 | C(═O)NH | (CH₂)_{c} | 1 to 20 | Si(OMe)₃ | 1 |
| 130 | 0 | Me | Me | (CH₂)_{b} | 0 to 20 | C(═O)NH | (CH₂)_{c} | 1 to 20 | Si(OMe)₃ | 1 |
| 131 | 0 | Me | Me | (CH₂)_{b} | 0 to 20 | C(═O)NH | (CH₂)_{c} | 1 to 20 | Si(OMe)₃ | 1 |
| 132 | 0 | Me | Me | (CH₂)_{b} | 0 to 20 | C(═O)NH | (CH₂)_{c} | 1 to 20 | Si(OMe)₃ | 1 |

TABLE 97

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 133 | 4-CF₃C₆H₄ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 134 | 4-SF₅C₆H₄ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 135 | 3,5-CF₃C₆H₃ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 136 | 3,5-SF₅C₆H₃ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 137 | 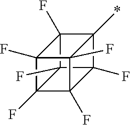 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si(OMe)₃ | 1 |
| 138 | 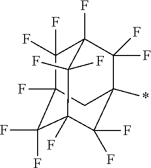 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si(OMe)₃ | 1 |
| 139 | 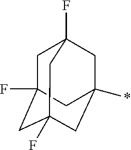 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si(OMe)₃ | 1 |
| 140 | SF₅ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 141 | OCF₃ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 142 | SCF₃ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 143 | N(CH₂CF₃)₂ | (CH₂)ₐ | 0 to | Me | Me | SF₅ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |

TABLE 98

| No. | R²¹ | | a | R²² | R²³ | R²⁴ | | | R²⁵ | z21 | z22 |
|---|---|---|---|---|---|---|---|---|---|---|---|
| 144 | N(CF₃)₂ | (CH₂)ₐ | 0 to 20 | Me | Me | SF₅ | (CH₂)ₐ | 0 to 20 | Me | 5 to 100 | 0 |
| 145 | Me | (CH₂)ₐ | 0 to 20 | Me | Me | OCF₃ | (CH₂)ₐ | 0 to 20 | Me | 5 to 100 | 0 |
| 146 | CF₃ | (CH₂)ₐ | 0 to 20 | Me | Me | OCF₃ | (CH₂)ₐ | 0 to 20 | Me | 5 to 100 | 0 |
| 147 | (CF₃)₂CF | (CH₂)ₐ | 0 to 20 | Me | Me | OCF₃ | (CH₂)ₐ | 0 to 20 | Me | 5 to 100 | 0 |
| 148 | (CF₃)₃C | (CH₂)ₐ | 0 to 20 | Me | Me | OCF₃ | (CH₂)ₐ | 0 to 20 | Me | 5 to 100 | 0 |
| 149 | C₄F₉ | (CH₂)ₐ | 0 to 20 | Me | Me | OCF₃ | (CH₂)ₐ | 0 to 20 | Me | 5 to 100 | 0 |
| 150 | C₈F₁₇ | (CH₂)ₐ | 0 to 20 | Me | Me | OCF₃ | (CH₂)ₐ | 0 to 20 | Me | 5 to 100 | 0 |
| 151 | c-C₆F₁₁ | (CH₂)ₐ | 0 to 20 | Me | Me | OCF₃ | (CH₂)ₐ | 0 to 20 | Me | 5 to 100 | 0 |
| 152 | CHF₂ | (CH₂)ₐ | 0 to 20 | Me | Me | OCF₃ | (CH₂)ₐ | 0 to 20 | Me | 5 to 100 | 0 |
| 153 | CClF₂ | (CH₂)ₐ | 0 to 20 | Me | Me | OCF₃ | (CH₂)ₐ | 0 to 20 | Me | 5 to 100 | 0 |
| 154 | CBrF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 144 | Me | Me | (CH₂)_{b} | 0 to 20 | C(═O)NH | (CH₂)_{c} | 1 to 20 | Si(OMe)₃ | 1 |
| 145 | Me | Me | (CH₂)_{b} | 0 to 20 | C(═O)NH | (CH₂)_{c} | 1 to 20 | Si(OMe)₃ | 1 |
| 146 | Me | Me | (CH₂)_{b} | 0 to 20 | C(═O)NH | (CH₂)_{c} | 1 to 20 | Si(OMe)₃ | 1 |
| 147 | Me | Me | (CH₂)_{b} | 0 to 20 | C(═O)NH | (CH₂)_{c} | 1 to 20 | Si(OMe)₃ | 1 |
| 148 | Me | Me | (CH₂)_{b} | 0 to 20 | C(═O)NH | (CH₂)_{c} | 1 to 20 | Si(OMe)₃ | 1 |
| 149 | Me | Me | (CH₂)_{b} | 0 to 20 | C(═O)NH | (CH₂)_{c} | 1 to 20 | Si(OMe)₃ | 1 |
| 150 | Me | Me | (CH₂)_{b} | 0 to 20 | C(═O)NH | (CH₂)_{c} | 1 to 20 | Si(OMe)₃ | 1 |
| 151 | Me | Me | (CH₂)_{b} | 0 to 20 | C(═O)NH | (CH₂)_{c} | 1 to 20 | Si(OMe)₃ | 1 |
| 152 | Me | Me | (CH₂)_{b} | 0 to 20 | C(═O)NH | (CH₂)_{c} | 1 to 20 | Si(OMe)₃ | 1 |
| 153 | Me | Me | (CH₂)_{b} | 0 to 20 | C(═O)NH | (CH₂)_{c} | 1 to 20 | Si(OMe)₃ | 1 |
| 154 | Me | Me | (CH₂)_{b} | 0 to 20 | C(═O)NH | (CH₂)_{c} | 1 to 20 | Si(OMe)₃ | 1 |

TABLE 99

| No. | R²¹ | | a | R²² | R²³ | R²⁴ | | | R²⁵ | z21 |
|---|---|---|---|---|---|---|---|---|---|---|
| 155 | ClF₂ | (CH₂)ₐ | 0 to 20 | Me | Me | OCF₃ | (CH₂)ₐ | 0 to 20 | Me | 5 to 100 |
| 156 | CF═CF₂ | (CH₂)ₐ | 0 to 20 | Me | Me | OCF₃ | (CH₂)ₐ | 0 to 20 | Me | 5 to 100 |
| 157 | CF═CFCF₃ | (CH₂)ₐ | 0 to 20 | Me | Me | OCF₃ | (CH₂)ₐ | 0 to 20 | Me | 5 to 100 |
| 158 | CF═CFCF═CF₂ | (CH₂)ₐ | 0 to 20 | Me | Me | OCF₃ | (CH₂)ₐ | 0 to 20 | Me | 5 to 100 |
| 159 | C≡CCF₃ | (CH₂)ₐ | 0 to 20 | Me | Me | OCF₃ | (CH₂)ₐ | 0 to 20 | Me | 5 to 100 |
| 160 | CF₂CH₃ | (CH₂)ₐ | 0 to 20 | Me | Me | OCF₃ | (CH₂)ₐ | 0 to 20 | Me | 5 to 100 |
| 161 | (CF₂)₂H | (CH₂)ₐ | 0 to 20 | Me | Me | OCF₃ | (CH₂)ₐ | 0 to 20 | Me | 5 to 100 |
| 162 | (CF₂)₂CH₃ | (CH₂)ₐ | 0 to 20 | Me | Me | OCF₃ | (CH₂)ₐ | 0 to 20 | Me | 5 to 100 |
| 163 | (CF₂)₄H | (CH₂)ₐ | 0 to 20 | Me | Me | OCF₃ | (CH₂)ₐ | 0 to 20 | Me | 5 to 100 |
| 164 | C₆F₅ | (CH₂)ₐ | 0 to 20 | Me | Me | OCF₃ | (CH₂)ₐ | 0 to 20 | Me | 5 to 100 |
| 165 | 4-CF₃C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 155 | 0 | Me | Me | (CH₂)_{b} | 0 to 20 | C(═O)NH | (CH₂)_{c} | 1 to 20 | Si(OMe)₃ | 1 |
| 156 | 0 | Me | Me | (CH₂)_{b} | 0 to 20 | C(═O)NH | (CH₂)_{c} | 1 to 20 | Si(OMe)₃ | 1 |
| 157 | 0 | Me | Me | (CH₂)_{b} | 0 to 20 | C(═O)NH | (CH₂)_{c} | 1 to 20 | Si(OMe)₃ | 1 |
| 158 | 0 | Me | Me | (CH₂)_{b} | 0 to 20 | C(═O)NH | (CH₂)_{c} | 1 to 20 | Si(OMe)₃ | 1 |
| 159 | 0 | Me | Me | (CH₂)_{b} | 0 to 20 | C(═O)NH | (CH₂)_{c} | 1 to 20 | Si(OMe)₃ | 1 |
| 160 | 0 | Me | Me | (CH₂)_{b} | 0 to 20 | C(═O)NH | (CH₂)_{c} | 1 to 20 | Si(OMe)₃ | 1 |
| 161 | 0 | Me | Me | (CH₂)_{b} | 0 to 20 | C(═O)NH | (CH₂)_{c} | 1 to 20 | Si(OMe)₃ | 1 |
| 162 | 0 | Me | Me | (CH₂)_{b} | 0 to 20 | C(═O)NH | (CH₂)_{c} | 1 to 20 | Si(OMe)₃ | 1 |
| 163 | 0 | Me | Me | (CH₂)_{b} | 0 to 20 | C(═O)NH | (CH₂)_{c} | 1 to 20 | Si(OMe)₃ | 1 |
| 164 | 0 | Me | Me | (CH₂)_{b} | 0 to 20 | C(═O)NH | (CH₂)_{c} | 1 to 20 | Si(OMe)₃ | 1 |
| 165 | 0 | 0Me | Me | (CH₂)_{b} | 0 to 20 | C(═O)NH | (CH₂)_{c} | 1 to 20 | Si(OMe)₃ | 1 |

TABLE 100

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 166 | 4-SF₅C₆F₄ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 167 | 3,5-CF₃C₆F₃ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 168 | 3,5-SF₅C₆F₃ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 169 | 4-CF₃C₆H₄ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 170 | 4-SF₅C₆H₄ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 171 | 3,5-CF₃C₆H₃ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 172 | 3,5-SF₅C₆H₃ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 173 | 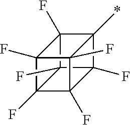 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 174 | 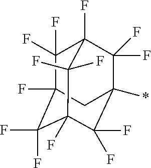 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 175 | 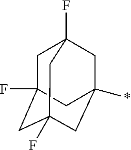 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 176 | SF₅ | (CH₂)ₐ | 0 to | Me | Me | OCF₃ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |

TABLE 101

| No. | R²¹ | | a | R²² | R²³ | R²⁴ | | | R²⁵ | z21 |
|---|---|---|---|---|---|---|---|---|---|---|
| 177 | OCF₃ | (CH₂)ₐ | 0 to 20 | Me | Me | OCF₃ | (CH₂)ₐ | 0 to 20 | Me | 5 to 100 |
| 178 | SCF₃ | (CH₂)ₐ | 0 to 20 | Me | Me | OCF₃ | (CH₂)ₐ | 0 to 20 | Me | 5 to 100 |
| 179 | N(CH₂CF₃)₂ | (CH₂)ₐ | 0 to 20 | Me | Me | OCF₃ | (CH₂)ₐ | 0 to 20 | Me | 5 to 100 |
| 180 | N(CF₃)₂ | (CH₂)ₐ | 0 to 20 | Me | Me | OCF₃ | (CH₂)ₐ | 0 to 20 | Me | 5 to 100 |
| 181 | Me | (CH₂)ₐ | 0 to 20 | Me | Me | SCF₃ | (CH₂)ₐ | 0 to 20 | Me | 5 to 100 |
| 182 | CF₃ | (CH₂)ₐ | 0 to 20 | Me | Me | SCF₃ | (CH₂)ₐ | 0 to 20 | Me | 5 to 100 |
| 183 | (CF₃)₂CF | (CH₂)ₐ | 0 to 20 | Me | Me | SCF₃ | (CH₂)ₐ | 0 to 20 | Me | 5 to 100 |
| 184 | (CF₃)₃C | (CH₂)ₐ | 0 to 20 | Me | Me | SCF₃ | (CH₂)ₐ | 0 to 20 | Me | 5 to 100 |
| 185 | C₄F₉ | (CH₂)ₐ | 0 to 20 | Me | Me | SCF₃ | (CH₂)ₐ | 0 to 20 | Me | 5 to 100 |
| 186 | C₈F₁₇ | (CH₂)ₐ | 0 to 20 | Me | Me | SCF₃ | (CH₂)ₐ | 0 to 20 | Me | 5 to 100 |
| 187 | c-C₆F₁₁ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 177 | 0 | Me | Me | (CH₂)_{b} | 0 to 20 | C(═O)NH | (CH₂)_{c} | 1 to 20 | Si(OMe)₃ | 1 |
| 178 | 0 | Me | Me | (CH₂)_{b} | 0 to 20 | C(═O)NH | (CH₂)_{c} | 1 to 20 | Si(OMe)₃ | 1 |
| 179 | 0 | Me | Me | (CH₂)_{b} | 0 to 20 | C(═O)NH | (CH₂)_{c} | 1 to 20 | Si(OMe)₃ | 1 |
| 180 | 0 | Me | Me | (CH₂)_{b} | 0 to 20 | C(═O)NH | (CH₂)_{c} | 1 to 20 | Si(OMe)₃ | 1 |
| 181 | 0 | Me | Me | (CH₂)_{b} | 0 to 20 | C(═O)NH | (CH₂)_{c} | 1 to 20 | Si(OMe)₃ | 1 |
| 182 | 0 | Me | Me | (CH₂)_{b} | 0 to 20 | C(═O)NH | (CH₂)_{c} | 1 to 20 | Si(OMe)₃ | 1 |
| 183 | 0 | Me | Me | (CH₂)_{b} | 0 to 20 | C(═O)NH | (CH₂)_{c} | 1 to 20 | Si(OMe)₃ | 1 |
| 184 | 0 | Me | Me | (CH₂)_{b} | 0 to 20 | C(═O)NH | (CH₂)_{c} | 1 to 20 | Si(OMe)₃ | 1 |
| 185 | 0 | Me | Me | (CH₂)_{b} | 0 to 20 | C(═O)NH | (CH₂)_{c} | 1 to 20 | Si(OMe)₃ | 1 |
| 186 | 0 | Me | Me | (CH₂)_{b} | 0 to 20 | C(═O)NH | (CH₂)_{c} | 1 to 20 | Si(OMe)₃ | 1 |
| 187 | 0 | Me | Me | (CH₂)_{b} | 0 to 20 | C(═O)NH | (CH₂)_{c} | 1 to 20 | Si(OMe)₃ | 1 |

TABLE 102

| No. | R²¹ | | a | R²² | R²³ | R²⁴ | | | R²⁵ | z21 |
|---|---|---|---|---|---|---|---|---|---|---|
| 188 | CHF₂ | (CH₂)ₐ | 0 to 20 | Me | Me | SCF₃ | (CH₂)ₐ | 0 to 20 | Me | 5 to 100 |
| 189 | CClF₂ | (CH₂)ₐ | 0 to 20 | Me | Me | SCF₃ | (CH₂)ₐ | 0 to 20 | Me | 5 to 100 |
| 190 | CBrF₂ | (CH₂)ₐ | 0 to 20 | Me | Me | SCF₃ | (CH₂)ₐ | 0 to 20 | Me | 5 to 100 |
| 191 | ClF₂ | (CH₂)ₐ | 0 to 20 | Me | Me | SCF₃ | (CH₂)ₐ | 0 to 20 | Me | 5 to 100 |
| 192 | CF═CF₂ | (CH₂)ₐ | 0 to 20 | Me | Me | SCF₃ | (CH₂)ₐ | 0 to 20 | Me | 5 to 100 |
| 193 | CF═CFCF₃ | (CH₂)ₐ | 0 to 20 | Me | Me | SCF₃ | (CH₂)ₐ | 0 to 20 | Me | 5 to 100 |
| 194 | CF═CFCF═CF₂ | (CH₂)ₐ | 0 to 20 | Me | Me | SCF₃ | (CH₂)ₐ | 0 to 20 | Me | 5 to 100 |
| 195 | C≡CCF₃ | (CH₂)ₐ | 0 to 20 | Me | Me | SCF₃ | (CH₂)ₐ | 0 to 20 | Me | 5 to 100 |
| 196 | CF₂CH₃ | (CH₂)ₐ | 0 to 20 | Me | Me | SCF₃ | (CH₂)ₐ | 0 to 20 | Me | 5 to 100 |
| 197 | (CF₂)₂H | (CH₂)ₐ | 0 to 20 | Me | Me | SCF₃ | (CH₂)ₐ | 0 to 20 | Me | 5 to 100 |
| 198 | (CF₂)₂CH₃ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 188 | 0 | Me | Me | (CH₂)_{b} | 0 to 20 | C(═O)NH | (CH₂)_{c} | 1 to 20 | Si(OMe)₃ | 1 |
| 189 | 0 | Me | Me | (CH₂)_{b} | 0 to 20 | C(═O)NH | (CH₂)_{c} | 1 to 20 | Si(OMe)₃ | 1 |
| 190 | 0 | Me | Me | (CH₂)_{b} | 0 to 20 | C(═O)NH | (CH₂)_{c} | 1 to 20 | Si(OMe)₃ | 1 |
| 191 | 0 | Me | Me | (CH₂)_{b} | 0 to 20 | C(═O)NH | (CH₂)_{c} | 1 to 20 | Si(OMe)₃ | 1 |
| 192 | 0 | Me | Me | (CH₂)_{b} | 0 to 20 | C(═O)NH | (CH₂)_{c} | 1 to 20 | Si(OMe)₃ | 1 |
| 193 | 0 | Me | Me | (CH₂)_{b} | 0 to 20 | C(═O)NH | (CH₂)_{c} | 1 to 20 | Si(OMe)₃ | 1 |
| 194 | 0 | Me | Me | (CH₂)_{b} | 0 to 20 | C(═O)NH | (CH₂)_{c} | 1 to 20 | Si(OMe)₃ | 1 |
| 195 | 0 | Me | Me | (CH₂)_{b} | 0 to 20 | C(═O)NH | (CH₂)_{c} | 1 to 20 | Si(OMe)₃ | 1 |
| 196 | 0 | Me | Me | (CH₂)_{b} | 0 to 20 | C(═O)NH | (CH₂)_{c} | 1 to 20 | Si(OMe)₃ | 1 |
| 197 | 0 | Me | Me | (CH₂)_{b} | 0 to 20 | C(═O)NH | (CH₂)_{c} | 1 to 20 | Si(OMe)₃ | 1 |
| 198 | 0 | Me | Me | (CH₂)_{b} | 0 to 20 | C(═O)NH | (CH₂)_{c} | 1 to 20 | Si(OMe)₃ | 1 |

TABLE 103

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 199 | (CF₂)₄H | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 200 | C₆F₅ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 201 | 4-CF₃C₆F₄ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 202 | 4-SF₅C₆F₄ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 203 | 3,5-CF₃C₆F₃ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 204 | 3,5-SF₅C₆F₃ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 205 | 4-CF₃C₆H₄ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 206 | 4-SF₅C₆H₄ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 207 | 3,5-CF₃C₆H₃ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 208 | 3,5-SF₅C₆H₃ | (CH₂)ₐ | 0 to | Me | Me | SCF₃ | (CH₂)ₐ | 0 to | Me | 5 to | 0 | Me | Me | (CH₂)_{b} | 0 to | C(═ | (CH₂)_{c} | 1 to | Si(OMe)₃ | 1 |
| | | | 20 | | | | | 20 | | 100 | | | | | 20 | O)NH | | 20 | | |
| 209 | 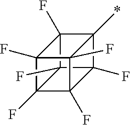 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si(OMe)₃ | 1 |

TABLE 104

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 210 | 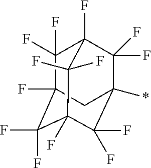 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 211 | 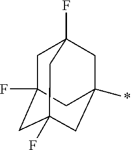 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 212 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 213 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 214 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 215 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 216 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 217 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 218 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 219 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |
| 220 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NH | (CH₂)_{c} | 1 to 20 | Si(OMe)₃ | 1 |

TABLE 105

| No. | R²¹ | | a | R²² | R²³ | R²⁴ | | | R²⁵ | z21 |
|---|---|---|---|---|---|---|---|---|---|---|
| 221 | C₄F₉ | (CH₂)ₐ | 0 to 20 | Me | Me | N(CF₃)₂ | (CH₂)ₐ | 0 to 20 | Me | 5 to 100 |
| 222 | C₈F₁₇ | (CH₂)ₐ | 0 to 20 | Me | Me | N(CF₃)₂ | (CH₂)ₐ | 0 to 20 | Me | 5 to 100 |
| 223 | c-C₆F₁₁ | (CH₂)ₐ | 0 to 20 | Me | Me | N(CF₃)₂ | (CH₂)ₐ | 0 to 20 | Me | 5 to 100 |
| 224 | CHF₂ | (CH₂)ₐ | 0 to 20 | Me | Me | N(CF₃)₂ | (CH₂)ₐ | 0 to 20 | Me | 5 to 100 |
| 225 | CClF₂ | (CH₂)ₐ | 0 to 20 | Me | Me | N(CF₃)₂ | (CH₂)ₐ | 0 to 20 | Me | 5 to 100 |
| 226 | CBrF₂ | (CH₂)ₐ | 0 to 20 | Me | Me | N(CF₃)₂ | (CH₂)ₐ | 0 to 20 | Me | 5 to 100 |
| 227 | ClF₂ | (CH₂)ₐ | 0 to 20 | Me | Me | N(CF₃)₂ | (CH₂)ₐ | 0 to 20 | Me | 5 to 100 |
| 228 | CF═CF₂ | (CH₂)ₐ | 0 to 20 | Me | Me | N(CF₃)₂ | (CH₂)ₐ | 0 to 20 | Me | 5 to 100 |
| 229 | CF═CFCF₃ | (CH₂)ₐ | 0 to 20 | Me | Me | N(CF₃)₂ | (CH₂)ₐ | 0 to 20 | Me | 5 to 100 |
| 230 | CF═CFCF═CF₂ | (CH₂)ₐ | 0 to 20 | Me | Me | N(CF₃)₂ | (CH₂)ₐ | 0 to 20 | Me | 5 to 100 |
| 231 | C≡CCF₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 221 | 0 | Me | Me | (CH₂)_{b} | 0 to 20 | C(═O)NH | (CH₂)_{c} | 1 to 20 | Si(OMe)₃ | 1 |
| 222 | 0 | Me | Me | (CH₂)_{b} | 0 to 20 | C(═O)NH | (CH₂)_{c} | 1 to 20 | Si(OMe)₃ | 1 |
| 223 | 0 | Me | Me | (CH₂)_{b} | 0 to 20 | C(═O)NH | (CH₂)_{c} | 1 to 20 | Si(OMe)₃ | 1 |
| 224 | 0 | Me | Me | (CH₂)_{b} | 0 to 20 | C(═O)NH | (CH₂)_{c} | 1 to 20 | Si(OMe)₃ | 1 |
| 225 | 0 | Me | Me | (CH₂)_{b} | 0 to 20 | C(═O)NH | (CH₂)_{c} | 1 to 20 | Si(OMe)₃ | 1 |
| 226 | 0 | Me | Me | (CH₂)_{b} | 0 to 20 | C(═O)NH | (CH₂)_{c} | 1 to 20 | Si(OMe)₃ | 1 |
| 227 | 0 | Me | Me | (CH₂)_{b} | 0 to 20 | C(═O)NH | (CH₂)_{c} | 1 to 20 | Si(OMe)₃ | 1 |
| 228 | 0 | Me | Me | (CH₂)_{b} | 0 to 20 | C(═O)NH | (CH₂)_{c} | 1 to 20 | Si(OMe)₃ | 1 |
| 229 | 0 | Me | Me | (CH₂)_{b} | 0 to 20 | C(═O)NH | (CH₂)_{c} | 1 to 20 | Si(OMe)₃ | 1 |
| 230 | 0 | Me | Me | (CH₂)_{b} | 0 to 20 | C(═O)NH | (CH₂)_{c} | 1 to 20 | Si(OMe)₃ | 1 |
| 231 | 0 | Me | Me | (CH₂)_{b} | 0 to 20 | C(═O)NH | (CH₂)_{c} | 1 to 20 | Si(OMe)₃ | 1 |

TABLE 106

| No. | R²¹ | | a | R²² | R²³ | R²⁴ | | | R²⁵ | z21 |
|---|---|---|---|---|---|---|---|---|---|---|
| 232 | CF₂CH₃ | (CH₂)ₐ | 0 to 20 | Me | Me | N(CF₃)₂ | (CH₂)ₐ | 0 to 20 | Me | 5 to 100 |
| 233 | (CF₂)₂H | (CH₂)ₐ | 0 to 20 | Me | Me | N(CF₃)₂ | (CH₂)ₐ | 0 to 20 | Me | 5 to 100 |
| 234 | (CF₂)₂CH₃ | (CH₂)ₐ | 0 to 20 | Me | Me | N(CF₃)₂ | (CH₂)ₐ | 0 to 20 | Me | 5 to 100 |
| 235 | (CF₂)₄H | (CH₂)ₐ | 0 to 20 | Me | Me | SCF₃ | (CH₂)ₐ | 0 to 20 | Me | 5 to 100 |
| 236 | C₆F₅ | (CH₂)ₐ | 0 to 20 | Me | Me | N(CF₃)₂ | (CH₂)ₐ | 0 to 20 | Me | 5 to 100 |
| 237 | 4-CF₃C₆F₄ | (CH₂)ₐ | 0 to 20 | Me | Me | N(CF₃)₂ | (CH₂)ₐ | 0 to 20 | Me | 5 to 100 |
| 238 | 4-SF₅C₆F₄ | (CH₂)ₐ | 0 to 20 | Me | Me | N(CF₃)₂ | (CH₂)ₐ | 0 to 20 | Me | 5 to 100 |
| 239 | 3,5-CF₃C₆F₃ | (CH₂)ₐ | 0 to 20 | Me | Me | N(CF₃)₂ | (CH₂)ₐ | 0 to 20 | Me | 5 to 100 |
| 240 | 3,5-SF₅C₆F₃ | (CH₂)ₐ | 0 to 20 | Me | Me | N(CF₃)₂ | (CH₂)ₐ | 0 to 20 | Me | 5 to 100 |
| 241 | 4-CF₃C₆H₄ | (CH₂)ₐ | 0 to 20 | Me | Me | N(CF₃)₂ | (CH₂)ₐ | 0 to 20 | Me | 5 to 100 |
| 242 | 4-SF₅C₆H₄ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 232 | 0 | Me | Me | (CH₂)_{b} | 0 to 20 | C(═O)NH | (CH₂)_{c} | 1 to 20 | Si(OMe)₃ | 1 |
| 233 | 0 | Me | Me | (CH₂)_{b} | 0 to 20 | C(═O)NH | (CH₂)_{c} | 1 to 20 | Si(OMe)₃ | 1 |
| 234 | 0 | Me | Me | (CH₂)_{b} | 0 to 20 | C(═O)NH | (CH₂)_{c} | 1 to 20 | Si(OMe)₃ | 1 |
| 235 | 0 | Me | Me | (CH₂)_{b} | 0 to 20 | C(═O)NH | (CH₂)_{c} | 1 to 20 | Si(OMe)₃ | 1 |
| 236 | 0 | Me | Me | (CH₂)_{b} | 0 to 20 | C(═O)NH | (CH₂)_{c} | 1 to 20 | Si(OMe)₃ | 1 |
| 237 | 0 | Me | Me | (CH₂)_{b} | 0 to 20 | C(═O)NH | (CH₂)_{c} | 1 to 20 | Si(OMe)₃ | 1 |
| 238 | 0 | Me | Me | (CH₂)_{b} | 0 to 20 | C(═O)NH | (CH₂)_{c} | 1 to 20 | Si(OMe)₃ | 1 |
| 239 | 0 | Me | Me | (CH₂)_{b} | 0 to 20 | C(═O)NH | (CH₂)_{c} | 1 to 20 | Si(OMe)₃ | 1 |
| 240 | 0 | Me | Me | (CH₂)_{b} | 0 to 20 | C(═O)NH | (CH₂)_{c} | 1 to 20 | Si(OMe)₃ | 1 |
| 241 | 0 | Me | Me | (CH₂)_{b} | 0 to 20 | C(═O)NH | (CH₂)_{c} | 1 to 20 | Si(OMe)₃ | 1 |
| 242 | 0 | Me | Me | (CH₂)_{b} | 0 to 20 | C(═O)NH | (CH₂)_{c} | 1 to 20 | Si(OMe)₃ | 1 |

TABLE 107

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 243 | 3,5-CF₃C₆H₃ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 244 | 3,5-SF₅C₆H₃ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 245 | 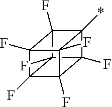 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 246 | 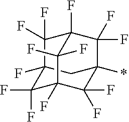 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 247 | 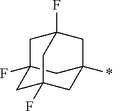 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═ O)NH | (CH₂)_{c} | 1 to 20 | Si (OMe)₃ | 1 |
| 248 | SF₅ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 249 | OCF₃ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 250 | SCF₃ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 251 | N(CH₂CF₃)₂ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 252 | N(CF₃)₂ | (CH₂)ₐ | 0 to | Me | Me | N(CF₃)₂ | (CH₂)ₐ | 0 to | Me | 5 to | 0 | Me | Me | (CH₂)_{b} | 0 to | C(═ | (CH₂)_{c} | 1 to | Si | 1 |
| | | | 20 | | | | | 20 | | 100 | | | | | 20 | O)NH | | 20 | (OMe)₃ | |
| 253 | Me | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si | 1 |
| | | | 20 | | | | | 20 | | 100 | | | | | 20 | (═O) | | 20 | (OMe)₃ | |

TABLE 108

| No. | R²¹ | | a | R²² | R²³ | R²⁴ | | | R²⁵ | z21 | z22 |
|---|---|---|---|---|---|---|---|---|---|---|---|
| 254 | CF₃ | (CH₂)ₐ | 0 to 20 | Me | Me | CF₃ | (CH₂)ₐ | 0 to 20 | Me | 5 to 100 | 0 |
| 255 | (CF₃)₂CF | (CH₂)ₐ | 0 to 20 | Me | Me | CF₃ | (CH₂)ₐ | 0 to 20 | Me | 5 to 100 | 0 |
| 256 | (CF₃)₃C | (CH₂)ₐ | 0 to 20 | Me | Me | CF₃ | (CH₂)ₐ | 0 to 20 | Me | 5 to 100 | 0 |
| 257 | C₄F₉ | (CH₂)ₐ | 0 to 20 | Me | Me | CF₃ | (CH₂)ₐ | 0 to 20 | Me | 5 to 100 | 0 |
| 258 | C₈F₁₇ | (CH₂)ₐ | 0 to 20 | Me | Me | CF₃ | (CH₂)ₐ | 0 to 20 | Me | 5 to 100 | 0 |
| 259 | c-C₆F₁₁ | (CH₂)ₐ | 0 to 20 | Me | Me | CF₃ | (CH₂)ₐ | 0 to 20 | Me | 5 to 100 | 0 |
| 260 | CHF₂ | (CH₂)ₐ | 0 to 20 | Me | Me | CF₃ | (CH₂)ₐ | 0 to 20 | Me | 5 to 100 | 0 |
| 261 | CClF₂ | (CH₂)ₐ | 0 to 20 | Me | Me | CF₃ | (CH₂)ₐ | 0 to 20 | Me | 5 to 100 | 0 |
| 262 | CBrF₂ | (CH₂)ₐ | 0 to 20 | Me | Me | CF₃ | (CH₂)ₐ | 0 to 20 | Me | 5 to 100 | 0 |
| 263 | ClF₂ | (CH₂)ₐ | 0 to 20 | Me | Me | CF₃ | (CH₂)ₐ | 0 to 20 | Me | 5 to 100 | 0 |
| 264 | CF═CF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 254 | Me | Me | (CH₂)_{b} | 0 to 20 | NHC(═O) | (CH₂)_{c} | 1 to 20 | Si(OMe)₃ | 1 |
| 255 | Me | Me | (CH₂)_{b} | 0 to 20 | NHC(═O) | (CH₂)_{c} | 1 to 20 | Si(OMe)₃ | 1 |
| 256 | Me | Me | (CH₂)_{b} | 0 to 20 | NHC(═O) | (CH₂)_{c} | 1 to 20 | Si(OMe)₃ | 1 |
| 257 | Me | Me | (CH₂)_{b} | 0 to 20 | NHC(═O) | (CH₂)_{c} | 1 to 20 | Si(OMe)₃ | 1 |
| 258 | Me | Me | (CH₂)_{b} | 0 to 20 | NHC(═O) | (CH₂)_{c} | 1 to 20 | Si(OMe)₃ | 1 |
| 259 | Me | Me | (CH₂)_{b} | 0 to 20 | NHC(═O) | (CH₂)_{c} | 1 to 20 | Si(OMe)₃ | 1 |
| 260 | Me | Me | (CH₂)_{b} | 0 to 20 | NHC(═O) | (CH₂)_{c} | 1 to 20 | Si(OMe)₃ | 1 |
| 261 | Me | Me | (CH₂)_{b} | 0 to 20 | NHC(═O) | (CH₂)_{c} | 1 to 20 | Si(OMe)₃ | 1 |
| 262 | Me | Me | (CH₂)_{b} | 0 to 20 | NHC(═O) | (CH₂)_{c} | 1 to 20 | Si(OMe)₃ | 1 |
| 263 | Me | Me | (CH₂)_{b} | 0 to 20 | NHC(═O) | (CH₂)_{c} | 1 to 20 | Si(OMe)₃ | 1 |
| 264 | Me | Me | (CH₂)_{b} | 0 to 20 | NHC(═O) | (CH₂)_{c} | 1 to 20 | Si(OMe)₃ | 1 |

TABLE 109

| No. | R²¹ | | a | R²² | R²³ | R²⁴ | | | R²⁵ | z21 |
|---|---|---|---|---|---|---|---|---|---|---|
| 265 | CF═CFCF₃ | (CH₂)ₐ | 0 to 20 | Me | Me | CF₃ | (CH₂)ₐ | 0 to 20 | Me | 5 to 100 |
| 266 | CF═CFCF═CF₂ | (CH₂)ₐ | 0 to 20 | Me | Me | CF₃ | (CH₂)ₐ | 0 to 20 | Me | 5 to 100 |
| 267 | C≡CCF₃ | (CH₂)ₐ | 0 to 20 | Me | Me | CF₃ | (CH₂)ₐ | 0 to 20 | Me | 5 to 100 |
| 268 | CF₂CH₃ | (CH₂)ₐ | 0 to 20 | Me | Me | CF₃ | (CH₂)ₐ | 0 to 20 | Me | 5 to 100 |
| 269 | (CF₂)₂H | (CH₂)ₐ | 0 to 20 | Me | Me | CF₃ | (CH₂)ₐ | 0 to 20 | Me | 5 to 100 |
| 270 | (CF₂)₂CH₃ | (CH₂)ₐ | 0 to 20 | Me | Me | CF₃ | (CH₂)ₐ | 0 to 20 | Me | 5 to 100 |
| 271 | (CF₂)₄H | (CH₂)ₐ | 0 to 20 | Me | Me | CF₃ | (CH₂)ₐ | 0 to 20 | Me | 5 to 100 |
| 272 | C₆F₅ | (CH₂)ₐ | 0 to 20 | Me | Me | CF₃ | (CH₂)ₐ | 0 to 20 | Me | 5 to 100 |
| 273 | 4-CF₃C₆F₄ | (CH₂)ₐ | 0 to 20 | Me | Me | CF₃ | (CH₂)ₐ | 0 to 20 | Me | 5 to 100 |
| 274 | 4-SF₅C₆F₄ | (CH₂)ₐ | 0 to 20 | Me | Me | CF₃ | (CH₂)ₐ | 0 to 20 | Me | 5 to 100 |
| 275 | 3,5-CF₃C₆F₃ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 265 | 0 | Me | Me | (CH₂)_{b} | 0 to 20 | NHC(═O) | (CH₂)_{c} | 1 to 20 | Si(OMe)₃ | 1 |
| 266 | 0 | Me | Me | (CH₂)_{b} | 0 to 20 | NHC(═O) | (CH₂)_{c} | 1 to 20 | Si(OMe)₃ | 1 |
| 267 | 0 | Me | Me | (CH₂)_{b} | 0 to 20 | NHC(═O) | (CH₂)_{c} | 1 to 20 | Si(OMe)₃ | 1 |
| 268 | 0 | Me | Me | (CH₂)_{b} | 0 to 20 | NHC(═O) | (CH₂)_{c} | 1 to 20 | Si(OMe)₃ | 1 |
| 269 | 0 | Me | Me | (CH₂)_{b} | 0 to 20 | NHC(═O) | (CH₂)_{c} | 1 to 20 | Si(OMe)₃ | 1 |
| 270 | 0 | Me | Me | (CH₂)_{b} | 0 to 20 | NHC(═O) | (CH₂)_{c} | 1 to 20 | Si(OMe)₃ | 1 |
| 271 | 0 | Me | Me | (CH₂)_{b} | 0 to 20 | NHC(═O) | (CH₂)_{c} | 1 to 20 | Si(OMe)₃ | 1 |
| 272 | 0 | Me | Me | (CH₂)_{b} | 0 to 20 | NHC(═O) | (CH₂)_{c} | 1 to 20 | Si(OMe)₃ | 1 |
| 273 | 0 | Me | Me | (CH₂)_{b} | 0 to 20 | NHC(═O) | (CH₂)_{c} | 1 to 20 | Si(OMe)₃ | 1 |
| 274 | 0 | Me | Me | (CH₂)_{b} | 0 to 20 | NHC(═O) | (CH₂)_{c} | 1 to 20 | Si(OMe)₃ | 1 |
| 275 | 0 | Me | Me | (CH₂)_{b} | 0 to 20 | NHC(═O) | (CH₂)_{c} | 1 to 20 | Si(OMe)₃ | 1 |

TABLE 110

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 276 | 3,5-SF₅C₆F₃ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 277 | 4-CF₃C₆H₄ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 278 | 4-SF₅C₆H₄ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 279 | 3,5-CF₃C₆H₃ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 280 | 3,5-SF₅C₆H₃ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 281 | 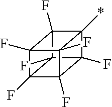 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |
| 282 | 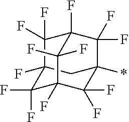 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |
| 283 | 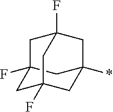 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |
| 284 | SF₅ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 285 | OCF₃ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 286 | SCF₃ | (CH₂)ₐ | 0 to | Me | Me | CF₃ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |

TABLE 111

| No. | R²¹ | | a | R²² | R²³ | R²⁴ | | | R²⁵ | z21 |
|---|---|---|---|---|---|---|---|---|---|---|
| 287 | N(CH₂CF₃)₂ | (CH₂)ₐ | 0 to 20 | Me | Me | CF₃ | (CH₂)ₐ | 0 to 20 | Me | 5 to 100 |
| 288 | N(CF₃)₂ | (CH₂)ₐ | 0 to 20 | Me | Me | CF₃ | (CH₂)ₐ | 0 to 20 | Me | 5 to 100 |
| 289 | Me | (CH₂)ₐ | 0 to 20 | Me | Me | CHF₂ | (CH₂)ₐ | 0 to 20 | Me | 5 to 100 |
| 290 | CF₃ | (CH₂)ₐ | 0 to 20 | Me | Me | CHF₂ | (CH₂)ₐ | 0 to 20 | Me | 5 to 100 |
| 291 | (CF₃)₂CF | (CH₂)ₐ | 0 to 20 | Me | Me | CHF₂ | (CH₂)ₐ | 0 to 20 | Me | 5 to 100 |
| 292 | (CF₃)₃C | (CH₂)ₐ | 0 to 20 | Me | Me | CHF₂ | (CH₂)ₐ | 0 to 20 | Me | 5 to 100 |
| 293 | C₄F₉ | (CH₂)ₐ | 0 to 20 | Me | Me | CHF₂ | (CH₂)ₐ | 0 to 20 | Me | 5 to 100 |
| 294 | C₈F₁₇ | (CH₂)ₐ | 0 to 20 | Me | Me | CHF₂ | (CH₂)ₐ | 0 to 20 | Me | 5 to 100 |
| 295 | c-C₆F₁₁ | (CH₂)ₐ | 0 to 20 | Me | Me | CHF₂ | (CH₂)ₐ | 0 to 20 | Me | 5 to 100 |
| 296 | CHF₂ | (CH₂)ₐ | 0 to 20 | Me | Me | CHF₂ | (CH₂)ₐ | 0 to 20 | Me | 5 to 100 |
| 297 | CClF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 287 | 0 | Me | Me | (CH₂)_{b} | 0 to 20 | NHC(═O) | (CH₂)_{c} | 1 to 20 | Si(OMe)₃ | 1 |
| 288 | 0 | Me | Me | (CH₂)_{b} | 0 to 20 | NHC(═O) | (CH₂)_{c} | 1 to 20 | Si(OMe)₃ | 1 |
| 289 | 0 | Me | Me | (CH₂)_{b} | 0 to 20 | NHC(═O) | (CH₂)_{c} | 1 to 20 | Si(OMe)₃ | 1 |
| 290 | 0 | Me | Me | (CH₂)_{b} | 0 to 20 | NHC(═O) | (CH₂)_{c} | 1 to 20 | Si(OMe)₃ | 1 |
| 291 | 0 | Me | Me | (CH₂)_{b} | 0 to 20 | NHC(═O) | (CH₂)_{c} | 1 to 20 | Si(OMe)₃ | 1 |
| 292 | 0 | Me | Me | (CH₂)_{b} | 0 to 20 | NHC(═O) | (CH₂)_{c} | 1 to 20 | Si(OMe)₃ | 1 |
| 293 | 0 | Me | Me | (CH₂)_{b} | 0 to 20 | NHC(═O) | (CH₂)_{c} | 1 to 20 | Si(OMe)₃ | 1 |
| 294 | 0 | Me | Me | (CH₂)_{b} | 0 to 20 | NHC(═O) | (CH₂)_{c} | 1 to 20 | Si(OMe)₃ | 1 |
| 295 | 0 | Me | Me | (CH₂)_{b} | 0 to 20 | NHC(═O) | (CH₂)_{c} | 1 to 20 | Si(OMe)₃ | 1 |
| 296 | 0 | Me | Me | (CH₂)_{b} | 0 to 20 | NHC(═O) | (CH₂)_{c} | 1 to 20 | Si(OMe)₃ | 1 |
| 297 | 0 | Me | Me | (CH₂)_{b} | 0 to 20 | NHC(═O) | (CH₂)_{c} | 1 to 20 | Si(OMe)₃ | 1 |

TABLE 112

| No. | R²¹ | | a | R²² | R²³ | R²⁴ | | | R²⁵ | z21 |
|---|---|---|---|---|---|---|---|---|---|---|
| 298 | CBrF₂ | (CH₂)ₐ | 0 to 20 | Me | Me | CHF₂ | (CH₂)ₐ | 0 to 20 | Me | 5 to 100 |
| 299 | ClF₂ | (CH₂)ₐ | 0 to 20 | Me | Me | CHF₂ | (CH₂)ₐ | 0 to 20 | Me | 5 to 100 |
| 300 | CF═CF₂ | (CH₂)ₐ | 0 to 20 | Me | Me | CHF₂ | (CH₂)ₐ | 0 to 20 | Me | 5 to 100 |
| 301 | CF═CFCF₃ | (CH₂)ₐ | 0 to 20 | Me | Me | CHF₂ | (CH₂)ₐ | 0 to 20 | Me | 5 to 100 |
| 302 | CF═CFCF═CF₂ | (CH₂)ₐ | 0 to 20 | Me | Me | CHF₂ | (CH₂)ₐ | 0 to 20 | Me | 5 to 100 |
| 303 | C≡CCF₃ | (CH₂)ₐ | 0 to 20 | Me | Me | CHF₂ | (CH₂)ₐ | 0 to 20 | Me | 5 to 100 |
| 304 | CF₂CH₃ | (CH₂)ₐ | 0 to 20 | Me | Me | CHF₂ | (CH₂)ₐ | 0 to 20 | Me | 5 to 100 |
| 305 | (CF₂)₂H | (CH₂)ₐ | 0 to 20 | Me | Me | CHF₂ | (CH₂)ₐ | 0 to 20 | Me | 5 to 100 |
| 306 | (CF₂)₂CH₃ | (CH₂)ₐ | 0 to 20 | Me | Me | CHF₂ | (CH₂)ₐ | 0 to 20 | Me | 5 to 100 |
| 307 | (CF₂)₄H | (CH₂)ₐ | 0 to 20 | Me | Me | CHF₂ | (CH₂)ₐ | 0 to 20 | Me | 5 to 100 |
| 308 | C₆F₅ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 298 | 0 | Me | Me | (CH₂)_{b} | 0 to 20 | NHC(═O) | (CH₂)_{c} | 1 to 20 | Si(OMe)₃ | 1 |
| 299 | 0 | Me | Me | (CH₂)_{b} | 0 to 20 | NHC(═O) | (CH₂)_{c} | 1 to 20 | Si(OMe)₃ | 1 |
| 300 | 0 | Me | Me | (CH₂)_{b} | 0 to 20 | NHC(═O) | (CH₂)_{c} | 1 to 20 | Si(OMe)₃ | 1 |
| 301 | 0 | Me | Me | (CH₂)_{b} | 0 to 20 | NHC(═O) | (CH₂)_{c} | 1 to 20 | Si(OMe)₃ | 1 |
| 302 | 0 | Me | Me | (CH₂)_{b} | 0 to 20 | NHC(═O) | (CH₂)_{c} | 1 to 20 | Si(OMe)₃ | 1 |
| 303 | 0 | Me | Me | (CH₂)_{b} | 0 to 20 | NHC(═O) | (CH₂)_{c} | 1 to 20 | Si(OMe)₃ | 1 |
| 304 | 0 | Me | Me | (CH₂)_{b} | 0 to 20 | NHC(═O) | (CH₂)_{c} | 1 to 20 | Si(OMe)₃ | 1 |
| 305 | 0 | Me | Me | (CH₂)_{b} | 0 to 20 | NHC(═O) | (CH₂)_{c} | 1 to 20 | Si(OMe)₃ | 1 |
| 306 | 0 | Me | Me | (CH₂)_{b} | 0 to 20 | NHC(═O) | (CH₂)_{c} | 1 to 20 | Si(OMe)₃ | 1 |
| 307 | 0 | Me | Me | (CH₂)_{b} | 0 to 20 | NHC(═O) | (CH₂)_{c} | 1 to 20 | Si(OMe)₃ | 1 |
| 308 | 0 | Me | Me | (CH₂)_{b} | 0 to 20 | NHC(═O) | (CH₂)_{c} | 1 to 20 | Si(OMe)₃ | 1 |

TABLE 113

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 309 | 4-CF₃C₆F₄ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 310 | 4-SF₅C₆F₄ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 311 | 3,5-CF₃C₆F₃ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 312 | 3,5-SF₅C₆F₃ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 313 | 4-CF₃C₆H₄ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 314 | 4-SF₅C₆H₄ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | | | | | | 20 | (═O) | | 20 | | |
| 315 | 3,5-CF₃C₆H₃ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 316 | 3,5-SF₅C₆H₃ | (CH₂)ₐ | 0 to | Me | Me | CHF₂ | (CH₂)ₐ | 0 to | Me | 5 to | 0 | Me | Me | (CH₂)_{b} | 0 to | NHC | (CH₂)_{c} | 1 to | Si(OMe)₃ | 1 |
| | | | 20 | | | | | 20 | | 100 | | | | | 20 | (═O) | | 20 | | |
| 317 | 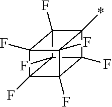 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |
| 318 | 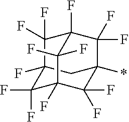 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |
| 319 | 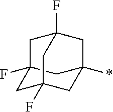 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC (═O) | (CH₂)_{c} | 1 to 20 | Si(OMe)₃ | 1 |

TABLE 114

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 320 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 321 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 322 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 323 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 324 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 325 | Me | (CH₂)ₐ | 0 to 20 | Me | Me | 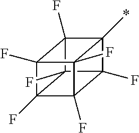 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 326 | CF₃ | (CH₂)ₐ | 0 to 20 | Me | Me | 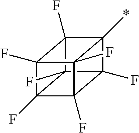 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 327 | (CF₃)₂CF | (CH₂)ₐ | 0 to 20 | Me | Me | 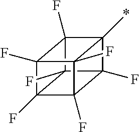 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 328 | (CF₃)₃C | (CH₂)ₐ | 0 to 20 | Me | Me | 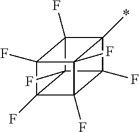 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 329 | C₄F₉ | (CH₂)ₐ | 0 to 20 | Me | Me | 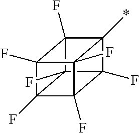 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 330 | C₈F₁₇ | (CH₂)ₐ | 0 to 20 | Me | Me | 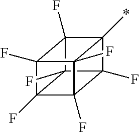 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |

TABLE 115

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 331 | c-C₆F₁₁ | (CH₂)ₐ | 0 to 20 | Me | Me | 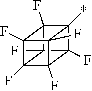 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 332 | CHF₂ | (CH₂)ₐ | 0 to 20 | Me | Me | 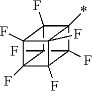 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 333 | CClF₂ | (CH₂)ₐ | 0 to 20 | Me | Me | 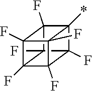 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 334 | CBrF₂ | (CH₂)ₐ | 0 to 20 | Me | Me | 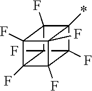 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 335 | ClF₂ | (CH₂)ₐ | 0 to 20 | Me | Me | 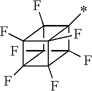 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 336 | CF═ CF₂ | (CH₂)ₐ | 0 to 20 | Me | Me | 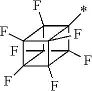 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 337 | CF═ CFCF₃ | (CH₂)ₐ | 0 to 20 | Me | Me | 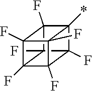 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 338 | CF═ CFCF═ CF₂ | (CH₂)ₐ | 0 to 20 | Me | Me | 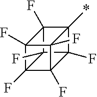 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 339 | C≡ CCF₃ | (CH₂)ₐ | 0 to 20 | Me | Me | 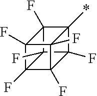 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 340 | CF₂CH₃ | (CH₂)ₐ | 0 to 20 | Me | Me | 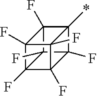 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 341 | (CF₂)₂H | (CH₂)ₐ | 0 to 20 | Me | Me | 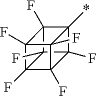 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |

TABLE 116

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 342 | (CF₂)₂ CH₃ | (CH₂)ₐ | 0 to 20 | Me | Me | 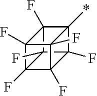 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 343 | (CF₂)₄H | (CH₂)ₐ | 0 to 20 | Me | Me | 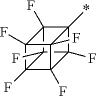 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 344 | C₆F₅ | (CH₂)ₐ | 0 to 20 | Me | Me | 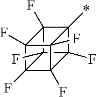 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 345 | 4- CF₃C₆F₄ | (CH₂)ₐ | 0 to 20 | Me | Me | 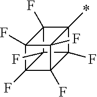 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 346 | 4- SF₅C₆F₄ | (CH₂)ₐ | 0 to 20 | Me | Me | 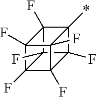 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 347 | 3,5- CF₃C₆F₃ | (CH₂)ₐ | 0 to 20 | Me | Me | 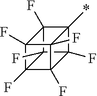 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 348 | 3,5- SF₅C₆F₃ | (CH₂)ₐ | 0 to 20 | Me | Me | 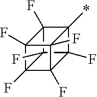 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 349 | 4- CF₃C₆H₄ | (CH₂)ₐ | 0 to 20 | Me | Me | 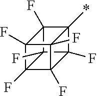 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 350 | 4- SF₅C₆H₄ | (CH₂)ₐ | 0 to 20 | Me | Me | 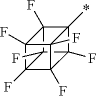 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 351 | 3,5- CF₃C₆H₃ | (CH₂)ₐ | 0 to 20 | Me | Me | 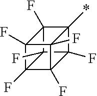 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |
| 352 | 3,5- SF₅C₆H₃ | (CH₂)ₐ | 0 to 20 | Me | Me | 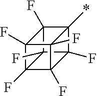 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC (═O) | (CH₂)_{c} | 1 to 20 | Si (OMe)₃ | 1 |

TABLE 117

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 353 | 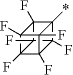 [SMILES: *C12C3(F)C4(F)C1(F)C1(F)C2(F)C3(F)C41F] | (CH₂)ₐ | 0 to 20 | Me | Me | 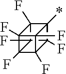 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 354 | 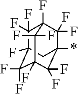 [SMILES: *C12CC3(F)C(F)(F)C(F)(C1(F)F)C(F)(F)C(F)(C2(F)F)C3(F)F] | (CH₂)ₐ | 0 to 20 | Me | Me | 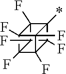 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 355 | 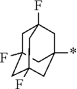 [SMILES: *C12CC3(F)CC(F)(C1)CC(F)(C2)C3] | (CH₂)ₐ | 0 to 20 | Me | Me | 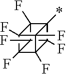 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 356 | SF₅ | (CH₂)ₐ | 0 to 20 | Me | Me | 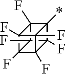 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 357 | OCF₃ | (CH₂)ₐ | 0 to 20 | Me | Me | 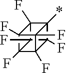 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 358 | SCF₃ | (CH₂)ₐ | 0 to 20 | Me | Me | 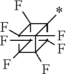 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 359 | N(CH₂CF₃)₂ | (CH₂)ₐ | 0 to 20 | Me | Me | 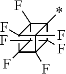 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 360 | N(CF₃)₂ | (CH₂)ₐ | 0 to 20 | Me | Me | 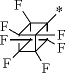 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 361 | Me | (CH₂)ₐ | 0 | Me | Me | SF₅ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 362 | CF₃ | (CH₂)ₐ | 0 | Me | Me | SF₅ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 363 | (CF₃)₂CF | (CH₂)ₐ | 0 | Me | Me | SF₅ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |

TABLE 118

| No. | R²¹ | | a | R²² | R²³ | R²⁴ | | | R²⁵ | z21 |
|---|---|---|---|---|---|---|---|---|---|---|
| 364 | (CF₃)₃C | (CH₂)ₐ | 0 to 20 | Me | Me | SF₅ | (CH₂)ₐ | 0 to 20 | Me | 5 to 100 |
| 365 | C₄F₉ | (CH₂)ₐ | 0 to 20 | Me | Me | SF₅ | (CH₂)ₐ | 0 to 20 | Me | 5 to 100 |
| 366 | C₈F₁₇ | (CH₂)ₐ | 0 to 20 | Me | Me | SF₅ | (CH₂)ₐ | 0 to 20 | Me | 5 to 100 |
| 367 | c-C₆F₁₁ | (CH₂)ₐ | 0 to 20 | Me | Me | SF₅ | (CH₂)ₐ | 0 to 20 | Me | 5 to 100 |
| 368 | CHF₂ | (CH₂)ₐ | 0 to 20 | Me | Me | SF₅ | (CH₂)ₐ | 0 to 20 | Me | 5 to 100 |
| 369 | CClF₂ | (CH₂)ₐ | 0 to 20 | Me | Me | SF₅ | (CH₂)ₐ | 0 to 20 | Me | 5 to 100 |
| 370 | CBrF₂ | (CH₂)ₐ | 0 to 20 | Me | Me | SF₅ | (CH₂)ₐ | 0 to 20 | Me | 5 to 100 |
| 371 | ClF₂ | (CH₂)ₐ | 0 to 20 | Me | Me | SF₅ | (CH₂)ₐ | 0 to 20 | Me | 5 to 100 |
| 372 | CF═CF₂ | (CH₂)ₐ | 0 to 20 | Me | Me | SF₅ | (CH₂)ₐ | 0 to 20 | Me | 5 to 100 |
| 373 | CF═CFCF₃ | (CH₂)ₐ | 0 to 20 | Me | Me | SF₅ | (CH₂)ₐ | 0 to 20 | Me | 5 to 100 |
| 374 | CF═CFCF═CF₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 364 | 0 | Me | Me | (CH₂)_{b} | 0 to 20 | NHC(═O) | (CH₂)_{c} | 1 to 20 | Si(OMe)₃ | 1 |
| 365 | 0 | Me | Me | (CH₂)_{b} | 0 to 20 | NHC(═O) | (CH₂)_{c} | 1 to 20 | Si(OMe)₃ | 1 |
| 366 | 0 | Me | Me | (CH₂)_{b} | 0 to 20 | NHC(═O) | (CH₂)_{c} | 1 to 20 | Si(OMe)₃ | 1 |
| 367 | 0 | Me | Me | (CH₂)_{b} | 0 to 20 | NHC(═O) | (CH₂)_{c} | 1 to 20 | Si(OMe)₃ | 1 |
| 368 | 0 | Me | Me | (CH₂)_{b} | 0 to 20 | NHC(═O) | (CH₂)_{c} | 1 to 20 | Si(OMe)₃ | 1 |
| 369 | 0 | Me | Me | (CH₂)_{b} | 0 to 20 | NHC(═O) | (CH₂)_{c} | 1 to 20 | Si(OMe)₃ | 1 |
| 370 | 0 | Me | Me | (CH₂)_{b} | 0 to 20 | NHC(═O) | (CH₂)_{c} | 1 to 20 | Si(OMe)₃ | 1 |
| 371 | 0 | Me | Me | (CH₂)_{b} | 0 to 20 | NHC(═O) | (CH₂)_{c} | 1 to 20 | Si(OMe)₃ | 1 |
| 372 | 0 | Me | Me | (CH₂)_{b} | 0 to 20 | NHC(═O) | (CH₂)_{c} | 1 to 20 | Si(OMe)₃ | 1 |
| 373 | 0 | Me | Me | (CH₂)_{b} | 0 to 20 | NHC(═O) | (CH₂)_{c} | 1 to 20 | Si(OMe)₃ | 1 |
| 374 | 0 | Me | Me | (CH₂)_{b} | 0 to 20 | NHC(═O) | (CH₂)_{c} | 1 to 20 | Si(OMe)₃ | 1 |

TABLE 119

| No. | R²¹ | | a | R²² | R²³ | R²⁴ | | | R²⁵ | z21 | z22 |
|---|---|---|---|---|---|---|---|---|---|---|---|
| 375 | C≡CCF₃ | (CH₂)ₐ | 0 to 20 | Me | Me | SF₅ | (CH₂)ₐ | 0 to 20 | Me | 5 to 100 | 0 |
| 376 | CF₂CH₃ | (CH₂)ₐ | 0 to 20 | Me | Me | SF₅ | (CH₂)ₐ | 0 to 20 | Me | 5 to 100 | 0 |
| 377 | (CF₂)₂H | (CH₂)ₐ | 0 to 20 | Me | Me | SF₅ | (CH₂)ₐ | 0 to 20 | Me | 5 to 100 | 0 |
| 378 | (CF₂)₂CH₃ | (CH₂)ₐ | 0 to 20 | Me | Me | SF₅ | (CH₂)ₐ | 0 to 20 | Me | 5 to 100 | 0 |
| 379 | (CF₂)₄H | (CH₂)ₐ | 0 to 20 | Me | Me | SF₅ | (CH₂)ₐ | 0 to 20 | Me | 5 to 100 | 0 |
| 380 | C₆F₅ | (CH₂)ₐ | 0 to 20 | Me | Me | SF₅ | (CH₂)ₐ | 0 to 20 | Me | 5 to 100 | 0 |
| 381 | 4-CF₃C₆F₄ | (CH₂)ₐ | 0 to 20 | Me | Me | SF₅ | (CH₂)ₐ | 0 to 20 | Me | 5 to 100 | 0 |
| 382 | 4-SF₅C₆F₄ | (CH₂)ₐ | 0 to 20 | Me | Me | SF₅ | (CH₂)ₐ | 0 to 20 | Me | 5 to 100 | 0 |
| 383 | 3,5-CF₃C₆F₃ | (CH₂)ₐ | 0 to 20 | Me | Me | SF₅ | (CH₂)ₐ | 0 to 20 | Me | 5 to 100 | 0 |
| 384 | 3,5-SF₅C₆F₃ | (CH₂)ₐ | 0 to 20 | Me | Me | SF₅ | (CH₂)ₐ | 0 to 20 | Me | 5 to 100 | 0 |
| 385 | 4-CF₃C₆H₄ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 375 | Me | Me | (CH₂)_{b} | 0 to 20 | NHC(═O) | (CH₂)_{c} | 1 to 20 | Si(OMe)₃ | 1 |
| 376 | Me | Me | (CH₂)_{b} | 0 to 20 | NHC(═O) | (CH₂)_{c} | 1 to 20 | Si(OMe)₃ | 1 |
| 377 | Me | Me | (CH₂)_{b} | 0 to 20 | NHC(═O) | (CH₂)_{c} | 1 to 20 | Si(OMe)₃ | 1 |
| 378 | Me | Me | (CH₂)_{b} | 0 to 20 | NHC(═O) | (CH₂)_{c} | 1 to 20 | Si(OMe)₃ | 1 |
| 379 | Me | Me | (CH₂)_{b} | 0 to 20 | NHC(═O) | (CH₂)_{c} | 1 to 20 | Si(OMe)₃ | 1 |
| 380 | Me | Me | (CH₂)_{b} | 0 to 20 | NHC(═O) | (CH₂)_{c} | 1 to 20 | Si(OMe)₃ | 1 |
| 381 | Me | Me | (CH₂)_{b} | 0 to 20 | NHC(═O) | (CH₂)_{c} | 1 to 20 | Si(OMe)₃ | 1 |
| 382 | Me | Me | (CH₂)_{b} | 0 to 20 | NHC(═O) | (CH₂)_{c} | 1 to 20 | Si(OMe)₃ | 1 |
| 383 | Me | Me | (CH₂)_{b} | 0 to 20 | NHC(═O) | (CH₂)_{c} | 1 to 20 | Si(OMe)₃ | 1 |
| 384 | Me | Me | (CH₂)_{b} | 0 to 20 | NHC(═O) | (CH₂)_{c} | 1 to 20 | Si(OMe)₃ | 1 |
| 385 | Me | Me | (CH₂)_{b} | 0 to 20 | NHC(═O) | (CH₂)_{c} | 1 to 20 | Si(OMe)₃ | 1 |

TABLE 120

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 386 | 4-SF₅C₆H₄ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 387 | 3,5-CF₃C₆H₃ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 388 | 3,5-SF₅C₆H₃ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 389 | 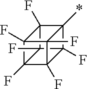 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 390 | 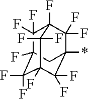 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 391 | 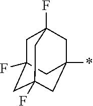 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 392 | SF₅ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 393 | OCF₃ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 394 | SCF₃ | (CH₂)ₐ | 0 | Me | Me | SF₅ | (CH₂)ₐ | 0 to 20 | Me | 5 | 0\| | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 395 | N(CH₂CF₃)₂ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |
| 396 | N(CF₃)₂ | (CH₂)ₐ | 0 | Me | Me | SF₅ | (CH₂)ₐ | 0 to 20 | Me | 5 | 0 | Me | Me | (CH₂)_{b} | 0 | NHC(═O) | (CH₂)_{c} | 1 | Si(OMe)₃ | 1 |
| | | | to | | | | | | | to | | | | | to | | | to | | |
| | | | 20 | | | | | | | 100 | | | | | 20 | | | 20 | | |

TABLE 121

| No. | R²¹ | | a | R²² | R²³ | R²⁴ | | | R²⁵ | z21 | z22 |
|---|---|---|---|---|---|---|---|---|---|---|---|
| 397 | Me | (CH₂)ₐ | 0 to 20 | Me | Me | OCF₃ | (CH₂)ₐ | 0 to 20 | Me | 5 to 100 | 0 |
| 398 | CF₃ | (CH₂)ₐ | 0 to 20 | Me | Me | OCF₃ | (CH₂)ₐ | 0 to 20 | Me | 5 to 100 | 0 |
| 399 | (CF₃)₂CF | (CH₂)ₐ | 0 to 20 | Me | Me | OCF₃ | (CH₂)ₐ | 0 to 20 | Me | 5 to 100 | 0 |
| 400 | (CF₃)₃C | (CH₂)ₐ | 0 to 20 | Me | Me | OCF₃ | (CH₂)ₐ | 0 to 20 | Me | 5 to 100 | 0 |
| 401 | C₄F₉ | (CH₂)ₐ | 0 to 20 | Me | Me | OCF₃ | (CH₂)ₐ | 0 to 20 | Me | 5 to 100 | 0 |
| 402 | C₈F₁₇ | (CH₂)ₐ | 0 to 20 | Me | Me | OCF₃ | (CH₂)ₐ | 0 to 20 | Me | 5 to 100 | 0 |
| 403 | c-C₆F₁₁ | (CH₂)ₐ | 0 to 20 | Me | Me | OCF₃ | (CH₂)ₐ | 0 to 20 | Me | 5 to 100 | 0 |
| 404 | CHF₂ | (CH₂)ₐ | 0 to 20 | Me | Me | OCF₃ | (CH₂)ₐ | 0 to 20 | Me | 5 to 100 | 0 |
| 405 | CClF₂ | (CH₂)ₐ | 0 to 20 | Me | Me | OCF₃ | (CH₂)ₐ | 0 to 20 | Me | 5 to 100 | 0 |
| 406 | CBrF₂ | (CH₂)ₐ | 0 to 20 | Me | Me | OCF₃ | (CH₂)ₐ | 0 to 20 | Me | 5 to 100 | 0 |
| 407 | ClF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 397 | Me | Me | (CH₂)_{b} | 0 to 20 | NHC(═O) | (CH₂)_{c} | 1 to 20 | Si(OMe)₃ | 1 |
| 398 | Me | Me | (CH₂)_{b} | 0 to 20 | NHC(═O) | (CH₂)_{c} | 1 to 20 | Si(OMe)₃ | 1 |
| 399 | Me | Me | (CH₂)_{b} | 0 to 20 | NHC(═O) | (CH₂)_{c} | 1 to 20 | Si(OMe)₃ | 1 |
| 400 | Me | Me | (CH₂)_{b} | 0 to 20 | NHC(═O) | (CH₂)_{c} | 1 to 20 | Si(OMe)₃ | 1 |
| 401 | Me | Me | (CH₂)_{b} | 0 to 20 | NHC(═O) | (CH₂)_{c} | 1 to 20 | Si(OMe)₃ | 1 |
| 402 | Me | Me | (CH₂)_{b} | 0 to 20 | NHC(═O) | (CH₂)_{c} | 1 to 20 | Si(OMe)₃ | 1 |
| 403 | Me | Me | (CH₂)_{b} | 0 to 20 | NHC(═O) | (CH₂)_{c} | 1 to 20 | Si(OMe)₃ | 1 |
| 404 | Me | Me | (CH₂)_{b} | 0 to 20 | NHC(═O) | (CH₂)_{c} | 1 to 20 | Si(OMe)₃ | 1 |
| 405 | Me | Me | (CH₂)_{b} | 0 to 20 | NHC(═O) | (CH₂)_{c} | 1 to 20 | Si(OMe)₃ | 1 |
| 406 | Me | Me | (CH₂)_{b} | 0 to 20 | NHC(═O) | (CH₂)_{c} | 1 to 20 | Si(OMe)₃ | 1 |
| 407 | Me | Me | (CH₂)_{b} | 0 to 20 | NHC(═O) | (CH₂)_{c} | 1 to 20 | Si(OMe)₃ | 1 |

TABLE 122

| No. | R²¹ | | a | R²² | R²³ | R²⁴ | | | R²⁵ | z21 | z22 |
|---|---|---|---|---|---|---|---|---|---|---|---|
| 408 | CF═CF₂ | (CH₂)ₐ | 0 to 20 | Me | Me | OCF₃ | (CH₂)ₐ | 0 to 20 | Me | 5 to 100 | 0 |
| 409 | CF═CFCF₃ | (CH₂)ₐ | 0 to 20 | Me | Me | OCF₃ | (CH₂)ₐ | 0 to 20 | Me | 5 to 100 | 0 |
| 410 | CF═CFCF═CF₂ | (CH₂)ₐ | 0 to 20 | Me | Me | OCF₃ | (CH₂)ₐ | 0 to 20 | Me | 5 to 100 | 0 |
| 411 | C≡CCF₃ | (CH₂)ₐ | 0 to 20 | Me | Me | OCF₃ | (CH₂)ₐ | 0 to 20 | Me | 5 to 100 | 0 |
| 412 | CF₂CH₃ | (CH₂)ₐ | 0 to 20 | Me | Me | OCF₃ | (CH₂)ₐ | 0 to 20 | Me | 5 to 100 | 0 |
| 413 | (CF₂)₂H | (CH₂)ₐ | 0 to 20 | Me | Me | OCF₃ | (CH₂)ₐ | 0 to 20 | Me | 5 to 100 | 0 |
| 414 | (CF₂)₂CH₃ | (CH₂)ₐ | 0 to 20 | Me | Me | OCF₃ | (CH₂)ₐ | 0 to 20 | Me | 5 to 100 | 0 |
| 415 | (CF₂)₄H | (CH₂)ₐ | 0 to 20 | Me | Me | OCF₃ | (CH₂)ₐ | 0 to 20 | Me | 5 to 100 | 0 |
| 416 | C₆F₅ | (CH₂)ₐ | 0 to 20 | Me | Me | OCF₃ | (CH₂)ₐ | 0 to 20 | Me | 5 to 100 | 0 |
| 417 | 4-CF₃C₆F₄ | (CH₂)ₐ | 0 to 20 | Me | Me | OCF₃ | (CH₂)ₐ | 0 to 20 | Me | 5 to 100 | 0 |
| 418 | 4-SF₅C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R₁ | b | L¹ | R² | c | T¹ | x1 |
|---|---|---|---|---|---|---|---|---|---|
| 408 | Me | Me | (CH₂)_{b} | 0 to 20 | NHC(═O) | (CH₂)_{c} | 1 to 20 | Si(OMe)₃ | 1 |
| 409 | Me | Me | (CH₂)_{b} | 0 to 20 | NHC(═O) | (CH₂)_{c} | 1 to 20 | Si(OMe)₃ | 1 |
| 410 | Me | Me | (CH₂)_{b} | 0 to 20 | NHC(═O) | (CH₂)_{c} | 1 to 20 | Si(OMe)₃ | 1 |
| 411 | Me | Me | (CH₂)_{b} | 0 to 20 | NHC(═O) | (CH₂)_{c} | 1 to 20 | Si(OMe)₃ | 1 |
| 412 | Me | Me | (CH₂)_{b} | 0 to 20 | NHC(═O) | (CH₂)_{c} | 1 to 20 | Si(OMe)₃ | 1 |
| 413 | Me | Me | (CH₂)_{b} | 0 to 20 | NHC(═O) | (CH₂)_{c} | 1 to 20 | Si(OMe)₃ | 1 |
| 414 | Me | Me | (CH₂)_{b} | 0 to 20 | NHC(═O) | (CH₂)_{c} | 1 to 20 | Si(OMe)₃ | 1 |
| 415 | Me | Me | (CH₂)_{b} | 0 to 20 | NHC(═O) | (CH₂)_{c} | 1 to 20 | Si(OMe)₃ | 1 |
| 416 | Me | Me | (CH₂)_{b} | 0 to 20 | NHC(═O) | (CH₂)_{c} | 1 to 20 | Si(OMe)₃ | 1 |
| 417 | Me | Me | (CH₂)_{b} | 0 to 20 | NHC(═O) | (CH₂)_{c} | 1 to 20 | Si(OMe)₃ | 1 |
| 418 | Me | Me | (CH₂)_{b} | 0 to 20 | NHC(═O) | (CH₂)_{c} | 1 to 20 | Si(OMe)₃ | 1 |

TABLE 123

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 419 | 3,5-CF₃C₆F₃ | (CH₂)ₐ | 0 | Me | Me | OCF₃ | (CH₂)ₐ | 0 | Me | 5 | 0 | Me | Me | (CH2)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 420 | 3,5-SF₅C₆F₃ | (CH₂)ₐ | 0 | Me | Me | OCF₃ | (CH₂)ₐ | 0 | Me | 5 | 0 | Me | Me | (CH2)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 421 | 4-CF₃C₆H₄ | (CH₂)ₐ | 0 | Me | Me | OCF₃ | (CH₂)ₐ | 0 | Me | 5 | 0\| | Me | Me | (CH2)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 422 | 4-SF₅C₆H₄ | (CH₂)ₐ | 0 | Me | Me | OCF₃ | (CH₂)ₐ | 0 | Me | 5 | 0 | Me | Me | (CH₂)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 423 | 3,5-CF₃C₆H₃ | (CH₂)ₐ | 0 | Me | Me | OCF₃ | (CH₂)ₐ | 0 | Me | 5 | 0 | Me | Me | (CH₂)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 424 | 3,5-SF₅C₆H₃ | (CH₂)ₐ | 0 | Me | Me | OCF₃ | (CH₂)ₐ | 0 | Me | 5 | 0 | Me | Me | (CH₂)_{b} | 0 | NHC(═O) | (CH2)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 425 | 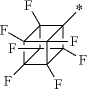 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O) | (CH2)_{c} | 1 to 20 | Si(OMe)₃ | 1 |
| 426 | 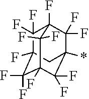 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 427 | 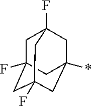 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 428 | SF₅ | (CH₂)ₐ | 0 | Me | Me | OCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 429 | OCF₃ | (CH₂)ₐ | 0 | Me | Me | OCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |

TABLE 124

| No. | R²¹ | | a | R²² | R²³ | R²⁴ | | | R²⁵ | z21 | z22 |
|---|---|---|---|---|---|---|---|---|---|---|---|
| 430 | SCF₃ | (CH₂)ₐ | 0 to 20 | Me | Me | OCF₃ | (CH₂)ₐ | 0 to 20 | Me | 5 to 100 | 0 |
| 431 | N(CH₂CF₃)₂ | (CH₂)ₐ | 0 to 20 | Me | Me | OCF₃ | (CH₂)ₐ | 0 to 20 | Me | 5 to 100 | 0 |
| 432 | N(CF₃)₂ | (CH₂)e | 0 to 20 | Me | Me | OCF₃ | (CH₂)ₐ | 0 to 20 | Me | 5 to 100 | 0 |
| 433 | Me | (CH₂)ₐ | 0 to 20 | Me | Me | SCF₃ | (CH₂)ₐ | 0 to 20 | Me | 5 to 100 | 0 |
| 434 | CF₃ | (CH₂)ₐ | 0 to 20 | Me | Me | SCF₃ | (CH₂)ₐ | 0 to 20 | Me | 5 to 100 | 0 |
| 435 | (CF₃)₂CF | (CH₂)ₐ | 0 to 20 | Me | Me | SCF₃ | (CH₂)ₐ | 0 to 20 | Me | 5 to 100 | 0 |
| 436 | (CF₃)₃C | (CH₂)ₐ | 0 to 20 | Me | Me | SCF₃ | (CH₂)ₐ | 0 to 20 | Me | 5 to 100 | 0 |
| 437 | C₄F₉ | (CH₂)ₐ | 0 to 20 | Me | Me | SCF₃ | (CH₂)ₐ | 0 to 20 | Me | 5 to 100 | 0 |
| 438 | C₈F₁₇ | (CH₂)ₐ | 0 to 20 | Me | Me | SCF₃ | (CH₂)ₐ | 0 to 20 | Me | 5 to 100 | 0 |
| 439 | c-C₆F₁₁ | (CH₂)ₐ | 0 to 20 | Me | Me | SCF₃ | (CH₂)ₐ | 0 to 20 | Me | 5 to 100 | 0 |
| 440 | CHF₂ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 430 | Me | Me | (CH₂)_{b} | 0 to 20 | NHC(═O) | (CH₂)_{c} | 1 to 20 | Si(OMe)₃ | 1 |
| 431 | Me | Me | (CH₂)_{b} | 0 to 20 | NHC(═O) | (CH₂)_{c} | 1 to 20 | Si(OMe)₃ | 1 |
| 432 | Me | Me | (CH₂)_{b} | 0 to 20 | NHC(═O) | (CH₂)_{c} | 1 to 20 | Si(OMe)₃ | 1 |
| 433 | Me | Me | (CH₂)_{b} | 0 to 20 | NHC(═O) | (CH₂)_{c} | 1 to 20 | Si(OMe)₃ | 1 |
| 434 | Me | Me | (CH₂)_{b} | 0 to 20 | NHC(═O) | (CH₂)_{c} | 1 to 20 | Si(OMe)₃ | 1 |
| 435 | Me | Me | (CH₂)_{b} | 0 to 20 | NHC(═O) | (CH₂)_{c} | 1 to 20 | Si(OMe)₃ | 1 |
| 436 | Me | Me | (CH₂)_{b} | 0 to 20 | NHC(═O) | (CH₂)_{c} | 1 to 20 | Si(OMe)₃ | 1 |
| 437 | Me | Me | (CH₂)_{b} | 0 to 20 | NHC(═O) | (CH₂)_{c} | 1 to 20 | Si(OMe)₃ | 1 |
| 438 | Me | Me | (CH₂)_{b} | 0 to 20 | NHC(═O) | (CH₂)_{c} | 1 to 20 | Si(OMe)₃ | 1 |
| 439 | Me | Me | (CH₂)_{b} | 0 to 20 | NHC(═O) | (CH₂)_{c} | 1 to 20 | Si(OMe)₃ | 1 |
| 440 | Me | Me | (CH₂)_{b} | 0 to 20 | NHC(═O) | (CH₂)_{c} | 1 to 20 | Si(OMe)₃ | 1 |

TABLE 125

| No. | R²¹ | | a | R²² | R²³ | R²⁴ | | | R²⁵ | z21 | z22 |
|---|---|---|---|---|---|---|---|---|---|---|---|
| 441 | CClF₂ | (CH₂)ₐ | 0 to 20 | Me | Me | SCF₃ | (CH₂)ₐ | 0 to 20 | Me | 5 to 100 | 0 |
| 442 | CBrF₂ | (CH₂)ₐ | 0 to 20 | Me | Me | SCF₃ | (CH₂)ₐ | 0 to 20 | Me | 5 to 100 | 0 |
| 443 | ClF₂ | (CH₂)ₐ | 0 to 20 | Me | Me | SCF₃ | (CH₂)ₐ | 0 to 20 | Me | 5 to 100 | 0 |
| 444 | CF═CF₂ | (CH₂)ₐ | 0 to 20 | Me | Me | SCF₃ | (CH₂)ₐ | 0 to 20 | Me | 5 to 100 | 0 |
| 445 | CF═CFCF₃ | (CH₂)ₐ | 0 to 20 | Me | Me | SCF₃ | (CH₂)ₐ | 0 to 20 | Me | 5 to 100 | 0 |
| 446 | CF═CFCF═CF₂ | (CH₂) | 0 to 20 | Me | Me | SCF₃ | (CH₂)ₐ | 0 to 20 | Me | 5 to 100 | 0 |
| 447 | C≡CCF₃ | (CH₂)ₐ | 0 to 20 | Me | Me | SCF₃ | (CH₂)ₐ | 0 to 20 | Me | 5 to 100 | 0 |
| 448 | CF₂CH₃ | (CH₂)ₐ | 0 to 20 | Me | Me | SCF₃ | (CH₂)ₐ | 0 to 20 | Me | 5 to 100 | 0 |
| 449 | (CF₂)₂H | (CH₂)ₐ | 0 to 20 | Me | Me | SCF₃ | (CH₂)ₐ | 0 to 20 | Me | 5 to 100 | 0 |
| 450 | (CF₂)₂CH₃ | (CH₂)ₐ | 0 to 20 | Me | Me | SCF₃ | (CH₂)ₐ | 0 to 20 | Me | 5 to 100 | 0 |
| 451 | (CF₂)₄H | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 441 | Me | Me | (CH₂)_{b} | 0 to 20 | NHC(═O) | (CH₂)_{c} | 1 to 20 | Si(OMe)₃ | 1 |
| 442 | Me | Me | (CH₂)_{b} | 0 to 20 | NHC(═O) | (CH₂)_{c} | 1 to 20 | Si(OMe)₃ | 1 |
| 443 | Me | Me | (CH₂)_{b} | 0 to 20 | NHC(═O) | (CH₂)_{c} | 1 to 20 | Si(OMe)₃ | 1 |
| 444 | Me | Me | (CH₂)_{b} | 0 to 20 | NHC(═O) | (CH₂)_{c} | 1 to 20 | Si(OMe)₃ | 1 |
| 445 | Me | Me | (CH₂)_{b} | 0 to 20 | NHC(═O) | (CH₂)_{c} | 1 to 20 | Si(OMe)₃ | 1 |
| 446 | Me | Me | (CH₂)_{b} | 0 to 20 | NHC(═O) | (CH₂)_{c} | 1 to 20 | Si(OMe)₃ | 1 |
| 447 | Me | Me | (CH₂)_{b} | 0 to 20 | NHC(═O) | (CH₂)_{c} | 1 to 20 | Si(OMe)₃ | 1 |
| 448 | Me | Me | (CH₂)_{b} | 0 to 20 | NHC(═O) | (CH₂)_{c} | 1 to 20 | Si(OMe)₃ | 1 |
| 449 | Me | Me | (CH₂)_{b} | 0 to 20 | NHC(═O) | (CH₂)_{c} | 1 to 20 | Si(OMe)₃ | 1 |
| 450 | Me | Me | (CH₂)_{b} | 0 to 20 | NHC(═O) | (CH₂)_{c} | 1 to 20 | Si(OMe)₃ | 1 |
| 451 | Me | Me | (CH₂)_{b} | 0 to 20 | NHC(═O) | (CH₂)_{c} | 1 to 20 | Si(OMe)₃ | 1 |

TABLE 126

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 452 | C₆F₅ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 453 | 4-CF₃C₆F₄ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 454 | 4-SF₅C₆F₄ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 455 | 3,5-CF₃C₆F₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 456 | 3,5-SF₅C₆F₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 457 | 4-CF₃C₆H₄ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 458 | 4-SF₅C₆H₄ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 459 | 3,5-CF₃C₆H₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 460 | 3,5-SF₅C₆H₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 461 | 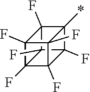 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 462 | 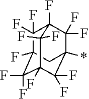 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |

TABLE 127

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 463 | 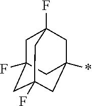 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 464 | SF₅ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 465 | OCF₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 466 | SCF₃ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 467 | N(CH₂CF₃)₂ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 468 | N(CF₃)₂ | (CH₂)ₐ | 0 | Me | Me | SCF₃ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 469 | Me | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 470 | CF₃ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 471 | (CF₃)₂CF | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 472 | (CF₃)₃C | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 473 | C₄F₉ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |

TABLE 128

| No. | R²¹ | | a | R²² | R²³ | R²⁴ | | | R²⁵ | z21 | z22 |
|---|---|---|---|---|---|---|---|---|---|---|---|
| 474 | C₈F₁₇ | (CH₂)ₐ | 0 to 20 | Me | Me | N(CF₃)₂ | (CH₂)ₐ | 0 to 20 | Me | 5 to 100 | 0 |
| 475 | c-C₆F₁₁ | (CH₂)ₐ | 0 to 20 | Me | Me | N(CF₃)₂ | (CH₂)ₐ | 0 to 20 | Me | 5 to 100 | 0 |
| 476 | CHF₂ | (CH₂)ₐ | 0 to 20 | Me | Me | N(CF₃)₂ | (CH₂)ₐ | 0 to 20 | Me | 5 to 100 | 0 |
| 477 | CClF₂ | (CH₂)ₐ | 0 to 20 | Me | Me | N(CF₃)₂ | (CH₂)ₐ | 0 to 20 | Me | 5 to 100 | 0 |
| 478 | CBrF₂ | (CH₂)ₐ | 0 to 20 | Me | Me | N(CF₃)₂ | (CH₂)ₐ | 0 to 20 | Me | 5 to 100 | 0 |
| 479 | ClF₂ | (CH₂)ₐ | 0 to 20 | Me | Me | N(CF₃)₂ | (CH₂)ₐ | 0 to 20 | Me | 5 to 100 | 0 |
| 480 | CF═CF₂ | (CH₂)ₐ | 0 to 20 | Me | Me | N(CF₃)₂ | (CH₂)ₐ | 0 to 20 | Me | 5 to 100 | 0 |
| 481 | CF═CFCF₃ | (CH₂)ₐ | 0 to 20 | Me | Me | N(CF₃)₂ | (CH₂)ₐ | 0 to 20 | Me | 5 to 100 | 0 |
| 482 | CF═CFCF═CF₂ | (CH₂)ₐ | 0 to 20 | Me | Me | N(CF₃)₂ | (CH₂)ₐ | 0 to 20 | Me | 5 to 100 | 0 |
| 483 | C≡CCF₃ | (CH₂)ₐ | 0 to 20 | Me | Me | N(CF₃)₂ | (CH₂)ₐ | 0 to 20 | Me | 5 to 100 | 0 |
| 484 | CF₂CH₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 474 | Me | Me | (CH₂)_{b} | 0 to 20 | NHC(═O) | (CH₂)_{c} | 1 to 20 | Si(OMe)₃ | 1 |
| 475 | Me | Me | (CH₂)_{b} | 0 to 20 | NHC(═O) | (CH₂)_{c} | 1 to 20 | Si(OMe)₃ | 1 |
| 476 | Me | Me | (CH₂)_{b} | 0 to 20 | NHC(═O) | (CH₂)_{c} | 1 to 20 | Si(OMe)₃ | 1 |
| 477 | Me | Me | (CH₂)_{b} | 0 to 20 | NHC(═O) | (CH₂)_{c} | 1 to 20 | Si(OMe)₃ | 1 |
| 478 | Me | Me | (CH₂)_{b} | 0 to 20 | NHC(═O) | (CH₂)_{c} | 1 to 20 | Si(OMe)₃ | 1 |
| 479 | Me | Me | (CH₂)_{b} | 0 to 20 | NHC(═O) | (CH₂)_{c} | 1 to 20 | Si(OMe)₃ | 1 |
| 480 | Me | Me | (CH₂)_{b} | 0 to 20 | NHC(═O) | (CH₂)_{c} | 1 to 20 | Si(OMe)₃ | 1 |
| 481 | Me | Me | (CH₂)_{b} | 0 to 20 | NHC(═O) | (CH₂)_{c} | 1 to 20 | Si(OMe)₃ | 1 |
| 482 | Me | Me | (CH₂)_{b} | 0 to 20 | NHC(═O) | (CH₂)_{c} | 1 to 20 | Si(OMe)₃ | 1 |
| 483 | Me | Me | (CH₂)_{b} | 0 to 20 | NHC(═O) | (CH₂)_{c} | 1 to 20 | Si(OMe)₃ | 1 |
| 484 | Me | Me | (CH₂)_{b} | 0 to 20 | NHC(═O) | (CH₂)_{c} | 1 to 20 | Si(OMe)₃ | 1 |

TABLE 129

| No. | R²¹ | | a | R²² | R²³ | R²⁴ | | | R²⁵ | z21 | z22 |
|---|---|---|---|---|---|---|---|---|---|---|---|
| 485 | (CF₂)₂H | (CH₂)ₐ | 0 to 20 | Me | Me | N(CF₃)₂ | (CH₂)ₐ | 0 to 20 | Me | 5 to 100 | 0 |
| 486 | (CF₂)₂CH₃ | (CH₂)ₐ | 0 to 20 | Me | Me | N(CF₃)₂ | (CH₂)ₐ | 0 to 20 | Me | 5 to 100 | 0 |
| 487 | (CF₂)₄H | (CH₂)ₐ | 0 to 20 | Me | Me | SCF₃ | (CH₂)ₐ | 0 to 20 | Me | 5 to 100 | 0 |
| 488 | C₆F₅ | (CH₂)ₐ | 0 to 20 | Me | Me | N(CF₃)₂ | (CH₂)ₐ | 0 to 20 | Me | 5 to 100 | 0 |
| 489 | 4-CF₃C₆F₄ | (CH₂)ₐ | 0 to 20 | Me | Me | N(CF₃)₂ | (CH₂)ₐ | 0 to 20 | Me | 5 to 100 | 0 |
| 490 | 4-SF₅C₆F₄ | (CH₂)ₐ | 0 to 20 | Me | Me | N(CF₃)₂ | (CH₂)ₐ | 0 to 20 | Me | 5 to 100 | 0 |
| 491 | 3,5-CF₃C₆F₃ | (CH₂)ₐ | 0 to 20 | Me | Me | N(CF₃)₂ | (CH₂)ₐ | 0 to 20 | Me | 5 to 100 | 0 |
| 492 | 3,5-SF₅C₆F₃ | (CH₂)ₐ | 0 to 20 | Me | Me | N(CF₃)₂ | (CH₂)ₐ | 0 to 20 | Me | 5 to 100 | 0 |
| 493 | 4-CF₃C₆H₄ | (CH₂)ₐ | 0 to 20 | Me | Me | N(CF₃)₂ | (CH₂)ₐ | 0 to 20 | Me | 5 to 100 | 0 |
| 494 | 4-SF₅C₆H₄ | (CH₂)ₐ | 0 to 20 | Me | Me | N(CF₃)₂ | (CH₂)ₐ | 0 to 20 | Me | 5 to 100 | 0 |
| 495 | 3,5-CF₃C₆H₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R | b | L¹ | R² | c | T¹ | x1 |
|---|---|---|---|---|---|---|---|---|---|
| 485 | Me | Me | (CH₂)_{b} | 0 to 20 | NHC(═O) | (CH₂)_{c} | 1 to 20 | Si(OMe)₃ | 1 |
| 486 | Me | Me | (CH₂)_{b} | 0 to 20 | NHC(═O) | (CH₂)_{c} | 1 to 20 | Si(OMe)₃ | 1 |
| 487 | Me | Me | (CH₂)_{b} | 0 to 20 | NHC(═O) | (CH₂)_{c} | 1 to 20 | Si(OMe)₃ | 1 |
| 488 | Me | Me | (CH₂)_{b} | 0 to 20 | NHC(═O) | (CH₂)_{c} | 1 to 20 | Si(OMe)₃ | 1 |
| 489 | Me | Me | (CH₂)_{b} | 0 to 20 | NHC(═O) | (CH₂)_{c} | 1 to 20 | Si(OMe)₃ | 1 |
| 490 | Me | Me | (CH₂)_{b} | 0 to 20 | NHC(═O) | (CH₂)_{c} | 1 to 20 | Si(OMe)₃ | 1 |
| 491 | Me | Me | (CH₂)_{b} | 0 to 20 | NHC(═O) | (CH₂)_{c} | 1 to 20 | Si(OMe)₃ | 1 |
| 492 | Me | Me | (CH₂)_{b} | 0 to 20 | NHC(═O) | (CH₂)_{c} | 1 to 20 | Si(OMe)₃ | 1 |
| 493 | Me | Me | (CH₂)_{b} | 0 to 20 | NHC(═O) | (CH₂)_{c} | 1 to 20 | Si(OMe)₃ | 1 |
| 494 | Me | Me | (CH₂)_{b} | 0 to 20 | NHC(═O) | (CH₂)_{c} | 1 to 20 | Si(OMe)₃ | 1 |
| 495 | Me | Me | (CH₂)_{b} | 0 to 20 | NHC(═O) | (CH₂)_{c} | 1 to 20 | Si(OMe)₃ | 1 |

TABLE 130

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 496 | 3,5-SF₅C₆H₃ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 497 | 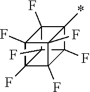 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 498 | 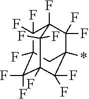 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 499 | 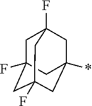 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O) | (CH₂)_{c} | 1 to 20 | Si(OMe)₃ | 1 |
| 500 | SF₅ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 501 | OCF₃ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 502 | SCF₃ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 503 | N(CH₂CF₃)₂ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 504 | N(CF₃)₂ | (CH₂)ₐ | 0 | Me | Me | N(CF₃)₂ | (CH₂)ₐ | 0 | Me | 5 | 0 | Me | Me | (CH₂)_{b} | 0 | NHC(═O) | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |

TABLE 131

| No. | R²¹ | | a | R²² | R²³ | R²⁴ | | | R²⁵ | z21 | z22 |
|---|---|---|---|---|---|---|---|---|---|---|---|
| 505 | Me | (CH₂)ₐ | 0 to 20 | Me | Me | CF₃ | (CH₂)ₐ | 0 to 20 | Me | 5 to 100 | 0 |
| 506 | CF₃ | (CH₂)ₐ | 0 to 20 | Me | Me | CF₃ | (CH₂)ₐ | 0 to 20 | Me | 5 to 100 | 0 |
| 507 | (CF₃)₂CF | (CH₂)ₐ | 0 to 20 | Me | Me | CF₃ | (CH₂)ₐ | 0 to 20 | Me | 5 to 100 | 0 |
| 508 | (CF₃)₃C | (CH₂)ₐ | 0 to 20 | Me | Me | CF₃ | (CH₂)ₐ | 0 to 20 | Me | 5 to 100 | 0 |
| 509 | C₄F₉ | (CH₂)ₐ | 0 to 20 | Me | Me | CF₃ | (CH₂)ₐ | 0 to 20 | Me | 5 to 100 | 0 |
| 510 | C₈F₁₇ | (CH₂)ₐ | 0 to 20 | Me | Me | CF₃ | (CH₂)ₐ | 0 to 20 | Me | 5 to 100 | 0 |
| 511 | c-C₆F₁₁ | (CH₂)ₐ | 0 to 20 | Me | Me | CF₃ | (CH₂)ₐ | 0 to 20 | Me | 5 to 100 | 0 |
| 512 | CHF₂ | (CH₂)ₐ | 0 to 20 | Me | Me | CF₃ | (CH₂)ₐ | 0 to 20 | Me | 5 to 100 | 0 |
| 513 | CClF₂ | (CH₂)ₐ | 0 to 20 | Me | Me | CF₃ | (CH₂)ₐ | 0 to 20 | Me | 5 to 100 | 0 |
| 514 | CBrF₂ | (CH₂)ₐ | 0 to 20 | Me | Me | CF₃ | (CH₂)ₐ | 0 to 20 | Me | 5 to 100 | 0 |
| 515 | ClF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 505 | Me | Me | (CH₂)_{b} | 0 to 20 | SiMe₂ | (CH₂)_{c} | 1 to 20 | Si(OMe)₃ | 1 |
| 506 | Me | Me | (CH₂)_{b} | 0 to 20 | SiMe₂ | (CH₂)_{c} | 1 to 20 | Si(OMe)₃ | 1 |
| 507 | Me | Me | (CH₂)_{b} | 0 to 20 | SiMe₂ | (CH₂)_{c} | 1 to 20 | Si(OMe)₃ | 1 |
| 508 | Me | Me | (CH₂)_{b} | 0 to 20 | SiMe₂ | (CH₂)_{c} | 1 to 20 | Si(OMe)₃ | 1 |
| 509 | Me | Me | (CH₂)_{b} | 0 to 20 | SiMe₂ | (CH₂)_{c} | 1 to 20 | Si(OMe)₃ | 1 |
| 510 | Me | Me | (CH₂)_{b} | 0 to 20 | SiMe₂ | (CH₂)_{c} | 1 to 20 | Si(OMe)₃ | 1 |
| 511 | Me | Me | (CH₂)_{b} | 0 to 20 | SiMe₂ | (CH₂)_{c} | 1 to 20 | Si(OMe)₃ | 1 |
| 512 | Me | Me | (CH₂)_{b} | 0 to 20 | SiMe₂ | (CH₂)_{c} | 1 to 20 | Si(OMe)₃ | 1 |
| 513 | Me | Me | (CH₂)_{b} | 0 to 20 | SiMe₂ | (CH₂)_{c} | 1 to 20 | Si(OMe)₃ | 1 |
| 514 | Me | Me | (CH₂)_{b} | 0 to 20 | SiMe₂ | (CH₂)_{c} | 1 to 20 | Si(OMe)₃ | 1 |
| 515 | Me | Me | (CH₂)_{b} | 0 to 20 | SiMe₂ | (CH₂)_{c} | 1 to 20 | Si(OMe)₃ | 1 |

TABLE 132

| No. | R²¹ | | a | R²² | R²³ | R²⁴ | | | R²⁵ | z21 | z22 |
|---|---|---|---|---|---|---|---|---|---|---|---|
| 516 | CF═CF₂ | (CH₂)ₐ | 0 to 20 | Me | Me | CF₃ | (CH₂)ₐ | 0 to 20 | Me | 5 to 100 | 0 |
| 517 | CF═CFCF₃ | (CH₂)ₐ | 0 to 20 | Me | Me | CF₃ | (CH₂)ₐ | 0 to 20 | Me | 5 to 100 | 0 |
| 518 | CF═CFCF═CF₂ | (CH₂)ₐ | 0 to 20 | Me | Me | CF₃ | (CH₂)ₐ | 0 to 20 | Me | 5 to 100 | 0 |
| 519 | C≡CCF₃ | (CH₂)ₐ | 0 to 20 | Me | Me | CF₃ | (CH₂)ₐ | 0 to 20 | Me | 5 to 100 | 0 |
| 520 | CF₂CH₃ | (CH₂)ₐ | 0 to 20 | Me | Me | CF₃ | (CH₂)ₐ | 0 to 20 | Me | 5 to 100 | 0 |
| 521 | (CF₂)₂H | (CH₂)ₐ | 0 to 20 | Me | Me | CF₃ | (CH₂)ₐ | 0 to 20 | Me | 5 to 100 | 0 |
| 522 | (CF₂)₂CH₃ | (CH₂)ₐ | 0 to 20 | Me | Me | CF₃ | (CH₂)ₐ | 0 to 20 | Me | 5 to 100 | 0 |
| 523 | (CF₂)₄H | (CH₂)ₐ | 0 to 20 | Me | Me | CF₃ | (CH₂)ₐ | 0 to 20 | Me | 5 to 100 | 0 |
| 524 | C₆F₅ | (CH₂)ₐ | 0 to 20 | Me | Me | CF₃ | (CH₂)ₐ | 0 to 20 | Me | 5 to 100 | 0 |
| 525 | 4-CF₃C₆F₄ | (CH₂)ₐ | 0 to 20 | Me | Me | CF₃ | (CH₂)ₐ | 0 to 20 | Me | 5 to 100 | 0 |
| 526 | 4-SF₅C₆F₄ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 516 | Me | Me | (CH₂)_{b} | 0 to 20 | SiMe₂ | (CH₂)_{c} | 1 to 20 | Si(OMe)₃ | 1 |
| 517 | Me | Me | (CH₂)_{b} | 0 to 20 | SiMe₂ | (CH₂)_{c} | 1 to 20 | Si(OMe)₃ | 1 |
| 518 | Me | Me | (CH₂)_{b} | 0 to 20 | SiMe₂ | (CH₂)_{c} | 1 to 20 | Si(OMe)₃ | 1 |
| 519 | Me | Me | (CH₂)_{b} | 0 to 20 | SiMe₂ | (CH₂)_{c} | 1 to 20 | Si(OMe)₃ | 1 |
| 520 | Me | Me | (CH₂)_{b} | 0 to 20 | SiMe₂ | (CH₂)_{c} | 1 to 20 | Si(OMe)₃ | 1 |
| 521 | Me | Me | (CH₂)_{b} | 0 to 20 | SiMe₂ | (CH₂)_{c} | 1 to 20 | Si(OMe)₃ | 1 |
| 522 | Me | Me | (CH₂)_{b} | 0 to 20 | SiMe₂ | (CH₂)_{c} | 1 to 20 | Si(OMe)₃ | 1 |
| 523 | Me | Me | (CH₂)_{b} | 0 to 20 | SiMe₂ | (CH₂)_{c} | 1 to 20 | Si(OMe)₃ | 1 |
| 524 | Me | Me | (CH₂)_{b} | 0 to 20 | SiMe₂ | (CH₂)_{c} | 1 to 20 | Si(OMe)₃ | 1 |
| 525 | Me | Me | (CH₂)_{b} | 0 to 20 | SiMe₂ | (CH₂)_{c} | 1 to 20 | Si(OMe)₃ | 1 |
| 526 | Me | Me | (CH₂)_{b} | 0 to 20 | SiMe₂ | (CH₂)_{c} | 1 to 20 | Si(OMe)₃ | 1 |

TABLE 133

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 527 | 3,5-CF₃C₆F₃ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 528 | 3,5-SF₅C₆F₃ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 529 | 4-CF₃C₆H₄ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 530 | 4-SF₅C₆H₄ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 531 | 3,5-CF₃C₆H₃ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 532 | 3,5-SF₅C₆H₃ | (CH₂)ₐ | 0 | Me | Me | CF₃ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 533 | 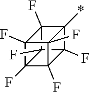 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 534 | 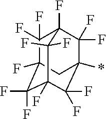 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 535 | 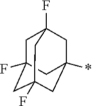 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | \|Me | Me | (CH₂)_{b} | 0 to 20 | SiMe₂ | (CH₂)_{c} | 1 to 20 | Si(OMe)₃ | 1 |
| 536 | SF₅ | (CH₂)ₐ | 0 | Me | Me | CF₃ | (CH₂)ₐ | 0 | Me | 5 | 0 | \|Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 537 | OCF₃ | (CH₂)ₐ | 0 | Me | Me | CF₃ | (CH₂)ₐ | 0 | Me | 5 | 0 | \|Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |

TABLE 134

| No. | R²¹ | | a | R²² | R²³ | R²⁴ | | | R²⁵ | z21 | z22 |
|---|---|---|---|---|---|---|---|---|---|---|---|
| 538 | SCF₃ | (CH₂)ₐ | 0 to 20 | Me | Me | CF₃ | (CH₂)ₐ | 0 to 20 | Me | 5 to 100 | 0 |
| 539 | N(CH₂CF₃)₂ | (CH₂)ₐ | 0 to 20 | Me | Me | CF₃ | (CH₂)ₐ | 0 to 20 | Me | 5 to 100 | 0 |
| 540 | N(CF₃)₂ | (CH₂)ₐ | 0 to 20 | Me | Me | CF₃ | (CH₂)ₐ | 0 to 20 | Me | 5 to 100 | 0 |
| 541 | Me | (CH₂)ₐ | 0 to 20 | Me | Me | CHF₂ | (CH₂)ₐ | 0 to 20 | Me | 5 to 100 | 0 |
| 542 | CF₃ | (CH₂)ₐ | 0 to 20 | Me | Me | CHF₂ | (CH₂)ₐ | 0 to 20 | Me | 5 to 100 | 0 |
| 543 | (CF₃)₂CF | (CH₂)ₐ | 0 to 20 | Me | Me | CHF₂ | (CH₂)ₐ | 0 to 20 | Me | 5 to 100 | 0 |
| 544 | (CF₃)₃C | (CH₂)ₐ | 0 to 20 | Me | Me | CHF₂ | (CH₂)ₐ | 0 to 20 | Me | 5 to 100 | 0 |
| 545 | C₄F₉ | (CH₂)ₐ | 0 to 20 | Me | Me | CHF₂ | (CH₂)ₐ | 0 to 20 | Me | 5 to 100 | 0 |
| 546 | C₈F₁₇ | (CH₂)ₐ | 0 to 20 | Me | Me | CHF₂ | (CH₂)ₐ | 0 to 20 | Me | 5 to 100 | 0 |
| 547 | c-C₆F₁₁ | (CH₂)ₐ | 0 to 20 | Me | Me | CHF₂ | (CH₂)ₐ | 0 to 20 | Me | 5 to 100 | 0 |
| 548 | CHF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 538 | Me | Me | (CH₂)_{b} | 0 to 20 | SiMe₂ | (CH₂)_{c} | 1 to 20 | Si(OMe)₃ | 1 |
| 539 | Me | Me | (CH₂)_{b} | 0 to 20 | SiMe₂ | (CH₂)_{c} | 1 to 20 | Si(OMe)₃ | 1 |
| 540 | Me | Me | (CH₂)_{b} | 0 to 20 | SiMe₂ | (CH₂)_{c} | 1 to 20 | Si(OMe)₃ | 1 |
| 541 | Me | Me | (CH₂)_{b} | 0 to 20 | SiMe₂ | (CH₂)_{c} | 1 to 20 | Si(OMe)₃ | 1 |
| 542 | Me | Me | (CH₂)_{b} | 0 to 20 | SiMe₂ | (CH₂)_{c} | 1 to 20 | Si(OMe)₃ | 1 |
| 543 | Me | Me | (CH₂)_{b} | 0 to 20 | SiMe₂ | (CH₂)_{c} | 1 to 20 | Si(OMe)₃ | 1 |
| 544 | Me | Me | (CH₂)_{b} | 0 to 20 | SiMe₂ | (CH₂)_{c} | 1 to 20 | Si(OMe)₃ | 1 |
| 545 | Me | Me | (CH₂)_{b} | 0 to 20 | SiMe₂ | (CH₂)_{c} | 1 to 20 | Si(OMe)₃ | 1 |
| 546 | Me | Me | (CH₂)_{b} | 0 to 20 | SiMe₂ | (CH₂)_{c} | 1 to 20 | Si(OMe)₃ | 1 |
| 547 | Me | Me | (CH₂)_{b} | 0 to 20 | SiMe₂ | (CH₂)_{c} | 1 to 20 | Si(OMe)₃ | 1 |
| 548 | Me | Me | (CH₂)_{b} | 0 to 20 | SiMe₂ | (CH₂)_{c} | 1 to 20 | Si(OMe)₃ | 1 |

TABLE 135

| No. | R²¹ | | a | R²² | R²³ | R²⁴ | | | R²⁵ | z21 | z22 |
|---|---|---|---|---|---|---|---|---|---|---|---|
| 549 | ClF₂ | (CH₂)ₐ | 0 to 20 | Me | Me | CHF₂ | (CH₂)ₐ | 0 to 20 | Me | 5 to 100 | 0 |
| 550 | CBrF₂ | (CH₂)ₐ | 0 to 20 | Me | Me | CHF₂ | (CH₂)ₐ | 0 to 20 | Me | 5 to 100 | 0 |
| 551 | ClF₂ | (CH₂)ₐ | 0 to 20 | Me | Me | CHF₂ | (CH₂)ₐ | 0 to 20 | Me | 5 to 100 | 0 |
| 552 | CF═CF₂ | (CH₂)ₐ | 0 to 20 | Me | Me | CHF₂ | (CH₂)ₐ | 0 to 20 | Me | 5 to 100 | 0 |
| 553 | CF═CFCF₃ | (CH₂)ₐ | 0 to 20 | Me | Me | CHF₂ | (CH₂)ₐ | 0 to 20 | Me | 5 to 100 | 0 |
| 554 | CF═CFCF═CF₂ | (CH₂)ₐ | 0 to 20 | Me | Me | CHF₂ | (CH₂)ₐ | 0 to 20 | Me | 5 to 100 | 0 |
| 555 | C≡CCF₃ | (CH₂)ₐ | 0 to 20 | Me | Me | CHF₂ | (CH₂)ₐ | 0 to 20 | Me | 5 to 100 | 0 |
| 556 | CF₂CH₃ | (CH₂)ₐ | 0 to 20 | Me | Me | CHF₂ | (CH₂)ₐ | 0 to 20 | Me | 5 to 100 | 0 |
| 557 | (CF₂)₂H | (CH₂)ₐ | 0 to 20 | Me | Me | CHF₂ | (CH₂)ₐ | 0 to 20 | Me | 5 to 100 | 0 |
| 558 | (CF₂)₂CH₃ | (CH₂)ₐ | 0 to 20 | Me | Me | CHF₂ | (CH₂)ₐ | 0 to 20 | Me | 5 to 100 | 0 |
| 559 | (CF₂)₄H | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 549 | Me | Me | (CH₂)_{b} | 0 to 20 | SiMe₂ | (CH₂)_{c} | 1 to 20 | Si(OMe)₃ | 1 |
| 550 | Me | Me | (CH₂)_{b} | 0 to 20 | SiMe₂ | (CH₂)_{c} | 1 to 20 | Si(OMe)₃ | 1 |
| 551 | Me | Me | (CH₂)_{b} | 0 to 20 | SiMe₂ | (CH₂)_{c} | 1 to 20 | Si(OMe)₃ | 1 |
| 552 | Me | Me | (CH₂)_{b} | 0 to 20 | SiMe₂ | (CH₂)_{c} | 1 to 20 | Si(OMe)₃ | 1 |
| 553 | Me | Me | (CH₂)_{b} | 0 to 20 | SiMe₂ | (CH₂)_{c} | 1 to 20 | Si(OMe)₃ | 1 |
| 554 | Me | Me | (CH₂)_{b} | 0 to 20 | SiMe₂ | (CH₂)_{c} | 1 to 20 | Si(OMe)₃ | 1 |
| 555 | Me | Me | (CH₂)_{b} | 0 to 20 | SiMe₂ | (CH₂)_{c} | 1 to 20 | Si(OMe)₃ | 1 |
| 556 | Me | Me | (CH₂)_{b} | 0 to 20 | SiMe₂ | (CH₂)_{c} | 1 to 20 | Si(OMe)₃ | 1 |
| 557 | Me | Me | (CH₂)_{b} | 0 to 20 | SiMe₂ | (CH₂)_{c} | 1 to 20 | Si(OMe)₃ | 1 |
| 558 | Me | Me | (CH₂)_{b} | 0 to 20 | SiMe₂ | (CH₂)_{c} | 1 to 20 | Si(OMe)₃ | 1 |
| 559 | Me | Me | (CH₂)_{b} | 0 to 20 | SiMe₂ | (CH₂)_{c} | 1 to 20 | Si(OMe)₃ | 1 |

TABLE 136

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 560 | C₆F₅ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 561 | 4-CF₃C₆F₄ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 562 | 4-SF₅C₆F₄ | (CH₂)ₐ | 0 | Me | Me | CHF₂ | (CH₂)ₐ | 0 | Me | 5 | 0 | \|Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 563 | 3,5-CF₃C₆F₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 564 | 3,5-SF₅C₆F₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 565 | 4-CF₃C₆H₄ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 566 | 4-SF₅C₆H₄ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 567 | 3,5-CF₃C₆H₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 568 | 3,5-SF₅C₆H₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)c | 1 | Si(OMe)₃ | 1 |
| | | | to | | | | | to | | to | | | | | to | | | to | | |
| | | | 20 | | | | | 20 | | 100 | | | | | 20 | | | 20 | | |
| 569 | 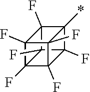 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe₂ | (CH₂)c | 1 to 20 | Si(OMe)₃ | 1 |
| 570 | 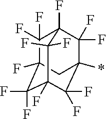 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe₂ | (CH₂)c | 1 to 20 | Si(OMe)₃ | 1 |

TABLE 137

| No. | R²¹ | | a | R²² | R²³ | R²⁴ | | | R²⁵ | z21 | z22 | R²⁸ | R²⁹ | R¹ | b | L¹ | R² | C | T¹ | ×1 |
|---|---|---|---|---|---|---|---|---|---|---|---|---|---|---|---|---|---|---|---|---|
| 571 | 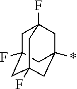 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 572 | SF₅ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 573 | OCF₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 574 | SCF₃ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 575 | N(CH₂CF₃)₂ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 576 | N(CF₃)₂ | (CH₂)ₐ | 0 | Me | Me | CHF₂ | (CH₂)ₐ | 0 | Me | 5 | 0 | Me | Me | (CH₂)_{b} | 0 | SiMe₂ | (CH₂)_{c} | 1 | Si(OMe)₃ | 1 |
| | | | to | | | | | to | | to | | | | | to | | | to | | |
| | | | 20 | | | | | 20 | | 100 | | | | | 20 | | | 20 | | |
| 577 | Me | (CH₂)ₐ | 0 to 20 | Me | Me | 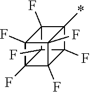 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 578 | CF₃ | (CH₂)ₐ | 0 to 20 | Me | Me | 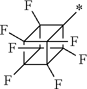 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 579 | (CF₃)₂CF | (CH₂)ₐ | 0 to 20 | Me | Me | 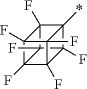 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 580 | (CF₃)₃C | (CH₂)ₐ | 0 to 20 | Me | Me | 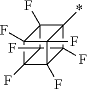 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 581 | C₄F₉ | (CH₂)ₐ | 0 to 20 | Me | Me | 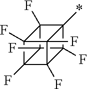 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |

TABLE 138

| No. | R²¹ | | a | R²² | R²³ | R²⁴ | | | R²⁵ | z21 | z22 | R²⁸ | R²⁹ | R¹ | b | L¹ | R² | c | T¹ | ×1 |
|---|---|---|---|---|---|---|---|---|---|---|---|---|---|---|---|---|---|---|---|---|
| 582 | C₈F₁₇ | (CH₂)ₐ | 0 to 20 | Me | Me | 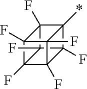 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 583 | c-C₆ F₁₁ | (CH₂)ₐ | 0 to 20 | Me | Me | 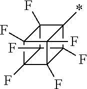 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 584 | CHF₂ | (CH₂)ₐ | 0 to 20 | Me | Me | 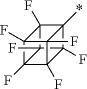 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 585 | CClF₂ | (CH₂)ₐ | 0 to 20 | Me | Me | 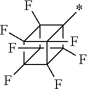 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 586 | CBrF₂ | (CH₂)ₐ | 0 to 20 | Me | Me | 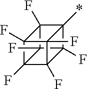 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 587 | ClF₂ | (CH₂)ₐ | 0 to 20 | Me | Me | 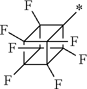 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 588 | CF═CF₂ | (CH₂)ₐ | 0 to 20 | Me | Me | 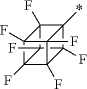 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 589 | CF═CFCF₃ | (CH₂)ₐ | 0 to 20 | Me | Me | 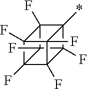 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 590 | CF═ CFCF═CF₂ | (CH₂)ₐ | 0 to 20 | Me | Me | 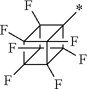 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 591 | C≡CCF3 | (CH₂)ₐ | 0 to 20 | Me | Me | 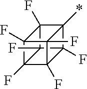 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |
| 592 | CF₂CH₃ | (CH₂)ₐ | 0 to 20 | Me | Me | 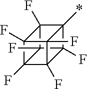 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe₂ | (CH₂)_{c} | 1 to 20 | Si(OMe)₃ | 1 |

TABLE 139

| No. | R²¹ | | a | R²² | R²³ | R²⁴ | | | R²⁵ | z21 |
|---|---|---|---|---|---|---|---|---|---|---|
| 593 | (CF₂)₂H | (CH₂)ₐ | 0 to 20 | Me | Me | 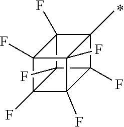 | (CH₂)ₐ | 0 to 20 | Me | 5 to 100 |
| 594 | (CF₂)₂CH₃ | (CH₂)ₐ | 0 to 20 | Me | Me | 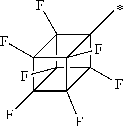 | (CH₂)ₐ | 0 to 20 | Me | 5 to 100 |
| 595 | (CF₂)₄H | (CH₂)ₐ | 0 to 20 | Me | Me | 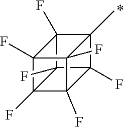 | (CH₂)ₐ | 0 to 20 | Me | 5 to 100 |
| 596 | C₆F₅ | (CH₂)ₐ | 0 to 20 | Me | Me | 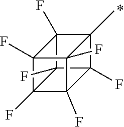 | (CH₂)ₐ | 0 to 20 | Me | 5 to 100 |
| 597 | 4-CF₃C₆F₄ | (CH₂)ₐ | 0 to 20 | Me | Me | 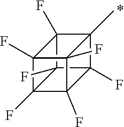 | (CH₂)ₐ | 0 to 20 | Me | 5 to 100 |
| 598 | 4-SF₅C₆F₄ | (CH₂)ₐ | 0 to 20 | Me | Me | 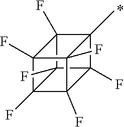 | (CH₂)ₐ | 0 to 20 | Me | 5 to 100 |
| 599 | 3,5-CF₃C₆F₃ | (CH₂)ₐ | 0 to 20 | Me | Me | 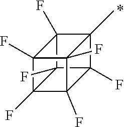 | (CH₂)ₐ | 0 to 20 | Me | 5 to 100 |
| 600 | 3,5-SF₅C₆F₃ | (CH₂)ₐ | 0 to 20 | Me | Me | 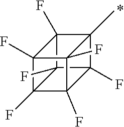 | (CH₂)ₐ | 0 to 20 | Me | 5 to 100 |
| 601 | 4-CF₃C₆H₄ | (CH₂)ₐ | 0 to 20 | Me | Me | 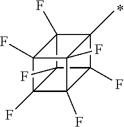 | (CH₂)ₐ | 0 to 20 | Me | 5 to 100 |
| 602 | 4-SF₅C₆H₄ | (CH₂)ₐ | 0 to 20 | Me | Me | 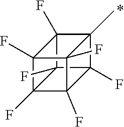 | (CH₂)ₐ | 0 to 20 | Me | 5 to 100 |
| 603 | 3,5-CF₃C₆H₃ | (CH₂)ₐ | 0 to 20 | Me | Me | 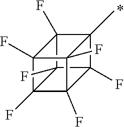 | (CH₂)ₐ | 0 to 20 | Me | 5 to 100 |
| No. | z22 | R²⁸ | R²⁹ | R¹ | b | L¹ | R² | c | T¹ | x1 |
| 593 | 0 | Me | Me | (CH₂)_{b} | 0 to 20 | SiMe₂ | (CH₂)_{c} | 1 to 20 | Si(OMe)₃ | 1 |
| 594 | 0 | Me | Me | (CH₂)_{b} | 0 to 20 | SiMe₂ | (CH₂)_{c} | 1 to 20 | Si(OMe)₃ | 1 |
| 595 | 0 | Me | Me | (CH₂)_{b} | 0 to 20 | SiMe₂ | (CH₂)_{c} | 1 to 20 | Si(OMe)₃ | 1 |
| 596 | 0 | Me | Me | (CH₂)_{b} | 0 to 20 | SiMe₂ | (CH₂)_{c} | 1 to 20 | Si(OMe)₃ | 1 |
| 597 | 0 | Me | Me | (CH₂)_{b} | 0 to 20 | SiMe₂ | (CH₂)_{c} | 1 to 20 | Si(OMe)₃ | 1 |
| 598 | 0 | Me | Me | (CH₂)_{b} | 0 to 20 | SiMe₂ | (CH₂)_{c} | 1 to 20 | Si(OMe)₃ | 1 |
| 599 | 0 | Me | Me | (CH₂)_{b} | 0 to 20 | SiMe₂ | (CH₂)_{c} | 1 to 20 | Si(OMe)₃ | 1 |
| 600 | 0 | Me | Me | (CH₂)_{b} | 0 to 20 | SiMe₂ | (CH₂)_{c} | 1 to 20 | Si(OMe)₃ | 1 |
| 601 | 0 | Me | Me | (CH₂)_{b} | 0 to 20 | SiMe₂ | (CH₂)_{c} | 1 to 20 | Si(OMe)₃ | 1 |
| 602 | 0 | Me | Me | (CH₂)_{b} | 0 to 20 | SiMe₂ | (CH₂)_{c} | 1 to 20 | Si(OMe)₃ | 1 |
| 603 | 0 | Me | Me | (CH₂)_{b} | 0 to 20 | SiMe₂ | (CH₂)_{c} | 1 to 20 | Si(OMe)₃ | 1 |

TABLE 140

| No. | R²¹ | | a | R²² | R²³ | R²⁴ | | | R²⁵ | z21 |
|---|---|---|---|---|---|---|---|---|---|---|
| 604 | 3,5-SF₅C₆H₃ | (CH₂)ₐ | 0 to 20 | Me | Me | 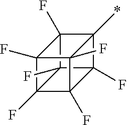 [SMILES: *C12C3(F)C4(F)C1(F)C1(F)C2(F)C3(F)C41F] | (CH₂)ₐ | 0 to 20 | Me | 5 to 100 |
| 605 | 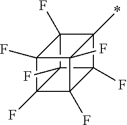 [SMILES: *C12C3(F)C4(F)C1(F)C1(F)C2(F)C3(F)C41F] | (CH₂)ₐ | 0 to 20 | Me | Me | 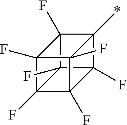 [SMILES: *C12C3(F)C4(F)C1(F)C1(F)C2(F)C3(F)C41F] | (CH₂)ₐ | 0 to 20 | Me | 5 to 100 |
| 606 | 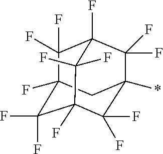 [SMILES: *C12CC3(F)C(F)(F)C(F)(C1(F)F)C(F)(F)C(F)(C2(F)F)C3(F)F] | (CH₂)ₐ | 0 to 20 | Me | Me | 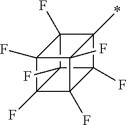 [SMILES: *C12C3(F)C4(F)C1(F)C1(F)C2(F)C3(F)C41F] | (CH₂)ₐ | 0 to 20 | Me | 5 to 100 |
| 607 | 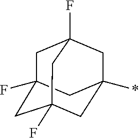 [SMILES: *C12CC3(F)CC(F)(C1)CC(F)(C2)C3] | (CH₂)ₐ | 0 to 20 | Me | Me | 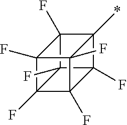 [SMILES: *C12C3(F)C4(F)C1(F)C1(F)C2(F)C3(F)C41F] | (CH₂)ₐ | 0 to 20 | Me | 5 to 100 |
| 608 | SF₅ | (CH₂)ₐ | 0 to 20 | Me | Me | 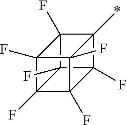 [SMILES: *C12C3(F)C4(F)C1(F)C1(F)C2(F)C3(F)C41F] | (CH₂)ₐ | 0 to 20 | Me | 5 to 100 |
| 609 | OCF₃ | (CH₂)ₐ | 0 to 20 | Me | Me | 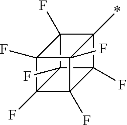 [SMILES: *C12C3(F)C4(F)C1(F)C1(F)C2(F)C3(F)C41F] | (CH₂)ₐ | 0 to 20 | Me | 5 to 100 |
| 610 | SCF₃ | (CH₂)ₐ | 0 to 20 | Me | Me | 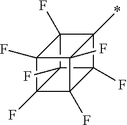 [SMILES: *C12C3(F)C4(F)C1(F)C1(F)C2(F)C3(F)C41F] | (CH₂)ₐ | 0 to 20 | Me | 5 to 100 |
| 611 | N(CH₂CF₃)₂ | (CH₂)ₐ | 0 to 20 | Me | Me | 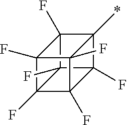 [SMILES: *C12C3(F)C4(F)C1(F)C1(F)C2(F)C3(F)C41F] | (CH₂)ₐ | 0 to 20 | Me | 5 to 100 |
| 612 | N(CF₃)₂ | (CH₂)ₐ | 0 to 20 | Me | Me | 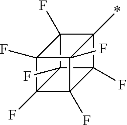 [SMILES: *C12C3(F)C4(F)C1(F)C1(F)C2(F)C3(F)C41F] | (CH₂)ₐ | 0 to 20 | Me | 5 to 100 |
| 613 | Me | (CH₂)ₐ | 0 to 20 | Me | Me | SF₅ | (CH₂)ₐ | 0 to 20 | Me | 5 to 100 |
| 614 | CF₃ | (CH₂)ₐ | 0 to 20 | Me | Me | SF₅ | (CH₂)ₐ | 0 to 20 | Me | 5 to 100 |
| No. | z22 | R²⁸ | R²⁹ | R¹ | b | L¹ | R² | c | T¹ | x1 |
| 604 | 0 | Me | Me | (CH₂)_{b} | 0 to 20 | SiMe₂ | (CH₂)_{c} | 1 to 20 | Si(OMe)₃ | 1 |
| 605 | 0 | Me | Me | (CH₂)_{b} | 0 to 20 | SiMe₂ | (CH₂)_{c} | 1 to 20 | Si(OMe)₃ | 1 |
| 606 | 0 | Me | Me | (CH₂)_{b} | 0 to 20 | SiMe₂ | (CH₂)_{c} | 1 to 20 | Si(OMe)₃ | 1 |
| 607 | 0 | Me | Me | (CH₂)_{b} | 0 to 20 | SiMe₂ | (CH₂)_{c} | 1 to 20 | Si(OMe)₃ | 1 |
| 608 | 0 | Me | Me | (CH₂)_{b} | 0 to 20 | SiMe₂ | (CH₂)_{c} | 1 to 20 | Si(OMe)₃ | 1 |
| 609 | 0 | Me | Me | (CH₂)_{b} | 0 to 20 | SiMe₂ | (CH₂)_{c} | 1 to 20 | Si(OMe)₃ | 1 |
| 610 | 0 | Me | Me | (CH₂)_{b} | 0 to 20 | SiMe₂ | (CH₂)_{c} | 1 to 20 | Si(OMe)₃ | 1 |
| 611 | 0 | Me | Me | (CH₂)_{b} | 0 to 20 | SiMe₂ | (CH₂)_{c} | 1 to 20 | Si(OMe)₃ | 1 |
| 612 | 0 | Me | Me | (CH₂)_{b} | 0 to 20 | SiMe₂ | (CH₂)_{c} | 1 to 20 | Si(OMe)₃ | 1 |
| 613 | 0 | Me | Me | (CH₂)_{b} | 0 to 20 | SiMe₂ | (CH₂)_{c} | 1 to 20 | Si(OMe)₃ | 1 |
| 614 | 0 | Me | Me | (CH₂)_{b} | 0 to 20 | SiMe₂ | (CH₂)_{c} | 1 to 20 | Si(OMe)₃ | 1 |

TABLE 141

| No. | R²¹ | | a | R²² | R²³ | R²⁴ | | | R²⁵ | z21 | z22 |
|---|---|---|---|---|---|---|---|---|---|---|---|
| 615 | (CF₃)₂CF | (CH₂)ₐ | 0 to 20 | Me | Me | SF₅ | (CH₂)ₐ | 0 to 20 | Me | 5 to 100 | 0 |
| 616 | (CF₃)₃C | (CH₂)ₐ | 0 to 20 | Me | Me | SF₅ | (CH₂)ₐ | 0 to 20 | Me | 5 to 100 | 0 |
| 617 | C₄F₉ | (CH₂)ₐ | 0 to 20 | Me | Me | SF₅ | (CH₂)ₐ | 0 to 20 | Me | 5 to 100 | 0 |
| 618 | C₈F₁₇ | (CH₂)ₐ | 0 to 20 | Me | Me | SF₅ | (CH₂)ₐ | 0 to 20 | Me | 5 to 100 | 0 |
| 619 | c-C₆F₁₁ | (CH₂)ₐ | 0 to 20 | Me | Me | SF₅ | (CH₂)ₐ | 0 to 20 | Me | 5 to 100 | 0 |
| 620 | CHF₂ | (CH₂)ₐ | 0 to 20 | Me | Me | SF₅ | (CH₂)ₐ | 0 to 20 | Me | 5 to 100 | 0 |
| 621 | CClF₂ | (CH₂)ₐ | 0 to 20 | Me | Me | SF₅ | (CH₂)ₐ | 0 to 20 | Me | 5 to 100 | 0 |
| 622 | CBrF₂ | (CH₂)ₐ | 0 to 20 | Me | Me | SF₅ | (CH₂)ₐ | 0 to 20 | Me | 5 to 100 | 0 |
| 623 | ClF₂ | (CH₂)ₐ | 0 to 20 | Me | Me | SF₅ | (CH₂)ₐ | 0 to 20 | Me | 5 to 100 | 0 |
| 624 | CF═CF₂ | (CH₂)ₐ | 0 to 20 | Me | Me | SF₅ | (CH₂)ₐ | 0 to 20 | Me | 5 to 100 | 0 |
| 625 | CF═CFCF₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 615 | Me | Me | (CH₂)_{b} | 0 to 20 | SiMe₂ | (CH₂)_{c} | 1 to 20 | Si(OMe)₃ | 1 |
| 616 | Me | Me | (CH₂)_{b} | 0 to 20 | SiMe₂ | (CH₂)_{c} | 1 to 20 | Si(OMe)₃ | 1 |
| 617 | Me | Me | (CH₂)_{b} | 0 to 20 | SiMe₂ | (CH₂)_{c} | 1 to 20 | Si(OMe)₃ | 1 |
| 618 | Me | Me | (CH₂)_{b} | 0 to 20 | SiMe₂ | (CH₂)_{c} | 1 to 20 | Si(OMe)₃ | 1 |
| 619 | Me | Me | (CH₂)_{b} | 0 to 20 | SiMe₂ | (CH₂)_{c} | 1 to 20 | Si(OMe)₃ | 1 |
| 620 | Me | Me | (CH₂)_{b} | 0 to 20 | SiMe₂ | (CH₂) | 1 to 20 | Si(OMe)₃ | 1 |
| 621 | Me | Me | (CH₂)_{b} | 0 to 20 | SiMe₂ | (CH₂)_{c} | 1 to 20 | Si(OMe)₃ | 1 |
| 622 | Me | Me | (CH₂)_{b} | 0 to 20 | SiMe₂ | (CH₂)_{c} | 1 to 20 | Si(OMe)₃ | 1 |
| 623 | Me | Me | (CH₂)_{b} | 0 to 20 | SiMe₂ | (CH₂)_{c} | 1 to 20 | Si(OMe)₃ | 1 |
| 624 | Me | Me | (CH₂)_{b} | 0 to 20 | SiMe₂ | (CH₂)_{c} | 1 to 20 | Si(OMe)₃ | 1 |
| 625 | Me | Me | (CH₂)_{b} | 0 to 20 | SiMe₂ | (CH₂)_{c} | 1 to 20 | Si(OMe)₃ | 1 |

TABLE 142

| No. | R²¹ | | a | R²² | R²³ | R²⁴ | | | R²⁵ | z21 | z22 |
|---|---|---|---|---|---|---|---|---|---|---|---|
| 626 | CF═CFCF═CF₂ | (CH₂)ₐ | 0 to 20 | Me | Me | SF₅ | (CH₂)ₐ | 0 to 20 | Me | 5 to 100 | 0 |
| 627 | C≡CCF₃ | (CH₂)ₐ | 0 to 20 | Me | Me | SF₅ | (CH₂)ₐ | 0 to 20 | Me | 5 to 100 | 0 |
| 628 | CF₂CH₃ | (CH₂)ₐ | 0 to 20 | Me | Me | SF₅ | (CH₂)ₐ | 0 to 20 | Me | 5 to 100 | 0 |
| 629 | (CF₂)₂H | (CH₂)ₐ | 0 to 20 | Me | Me | SF₅ | (CH₂)ₐ | 0 to 20 | Me | 5 to 100 | 0 |
| 630 | (CF₂)₂CH₃ | (CH₂)ₐ | 0 to 20 | Me | Me | SF₅ | (CH₂)ₐ | 0 to 20 | Me | 5 to 100 | 0 |
| 631 | (CF₂)₄H | (CH₂)ₐ | 0 to 20 | Me | Me | SF₅ | (CH₂)ₐ | 0 to 20 | Me | 5 to 100 | 0 |
| 632 | C₆F₅ | (CH₂)ₐ | 0 to 20 | Me | Me | SF₅ | (CH₂)ₐ | 0 to 20 | Me | 5 to 100 | 0 |
| 633 | 4-CF₃C₆F₄ | (CH₂)ₐ | 0 to 20 | Me | Me | SF₅ | (CH₂)ₐ | 0 to 20 | Me | 5 to 100 | 0 |
| 634 | 4-SF₅C₆F₄ | (CH₂)ₐ | 0 to 20 | Me | Me | SF₅ | (CH₂)ₐ | 0 to 20 | Me | 5 to 100 | 0 |
| 635 | 3,5-CF₃C₆F₃ | (CH₂)ₐ | 0 to 20 | Me | Me | SF₅ | (CH₂)ₐ | 0 to 20 | Me | 5 to 100 | 0 |
| 636 | 3,5-SF₅C₆F₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 626 | Me | Me | (CH₂)_{b} | 0 to 20 | SiMe₂ | (CH₂)_{c} | 1 to 20 | Si(OMe)₃ | 1 |
| 627 | Me | Me | (CH₂)_{b} | 0 to 20 | SiMe₂ | (CH₂)_{c} | 1 to 20 | Si(OMe)₃ | 1 |
| 628 | Me | Me | (CH₂)_{b} | 0 to 20 | SiMe₂ | (CH₂)_{c} | 1 to 20 | Si(OMe)₃ | 1 |
| 629 | Me | Me | (CH₂)_{b} | 0 to 20 | SiMe₂ | (CH₂)_{c} | 1 to 20 | Si(OMe)₃ | 1 |
| 630 | Me | Me | (CH₂)_{b} | 0 to 20 | SiMe₂ | (CH₂)_{c} | 1 to 20 | Si(OMe)₃ | 1 |
| 631 | Me | Me | (CH₂)_{b} | 0 to 20 | SiMe₂ | (CH₂)_{c} | 1 to 20 | Si(OMe)₃ | 1 |
| 632 | Me | Me | (CH₂)_{b} | 0 to 20 | SiMe₂ | (CH₂)_{c} | 1 to 20 | Si(OMe)₃ | 1 |
| 633 | Me | Me | (CH₂)_{b} | 0 to 20 | SiMe₂ | (CH₂)_{c} | 1 to 20 | Si(OMe)₃ | 1 |
| 634 | Me | Me | (CH₂)_{b} | 0 to 20 | SiMe₂ | (CH₂)_{c} | 1 to 20 | Si(OMe)₃ | 1 |
| 635 | Me | Me | (CH₂)_{b} | 0 to 20 | SiMe₂ | (CH₂)_{c} | 1 to 20 | Si(OMe)₃ | 1 |
| 636 | Me | Me | (CH₂)_{b} | 0 to 20 | SiMe₂ | (CH₂)_{c} | 1 to 20 | Si(OMe)₃ | 1 |

TABLE 143

| No. | R²¹ | | a | R²² | R²³ | R²⁴ | | | R²⁵ | z21 |
|---|---|---|---|---|---|---|---|---|---|---|
| 637 | 4-CF₃C₆H₄ | (CH₂)ₐ | 0 to 20 | Me | Me | SF₅ | (CH₂)ₐ | 0 to 20 | Me | 5 to 100 |
| 638 | 4-SF₅C₆H₄ | (CH₂)ₐ | 0 to 20 | Me | Me | SF₅ | (CH₂)ₐ | 0 to 20 | Me | 5 to 100 |
| 639 | 3,5-CF₃C₆H₃ | (CH₂)ₐ | 0 to 20 | Me | Me | SF₅ | (CH₂)ₐ | 0 to 20 | Me | 5 to 100 |
| 640 | 3,5-SF₅C₆H₃ | (CH₂)ₐ | 0 to 20 | Me | Me | SF₅ | (CH₂)ₐ | 0 to 20 | Me | 5 to 100 |
| 641 | 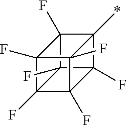 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 |
| 642 | 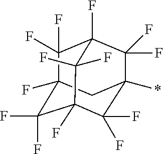 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 |
| 643 | 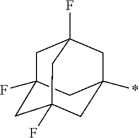 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 |
| 644 | SF₅ | (CH₂)ₐ | 0 to 20 | Me | Me | SF₅ | (CH₂)ₐ | 0 to 20 | Me | 5 to 100 |
| 645 | OCF₃ | (CH₂)ₐ | 0 to 20 | Me | Me | SF₅ | (CH₂)ₐ | 0 to 20 | Me | 5 to 100 |
| 646 | SCF₃ | (CH₂)ₐ | 0 to 20 | Me | Me | SF₅ | (CH₂)ₐ | 0 to 20 | Me | 5 to 100 |
| 647 | N(CH₂CF₃)₂ | (CH₂)ₐ | 0 to 20 | Me | Me | SF₅ | (CH₂)ₐ | 0 to 20 | Me | 5 to 100 |
| No. | z22 | R²⁸ | R²⁹ | R¹ | b | L¹ | R² | c | T¹ | x1 |
| 637 | 0 | Me | Me | (CH₂)_{b} | 0 to 20 | SiMe₂ | (CH₂)_{c} | 1 to 20 | Si(OMe)₃ | 1 |
| 638 | 0 | Me | Me | (CH₂)_{b} | 0 to 20 | SiMe₂ | (CH₂)_{c} | 1 to 20 | Si(OMe)₃ | 1 |
| 639 | 0 | Me | Me | (CH₂)_{b} | 0 to 20 | SiMe₂ | (CH₂)_{c} | 1 to 20 | Si(OMe)₃ | 1 |
| 640 | 0 | Me | Me | (CH₂)_{b} | 0 to 20 | SiMe₂ | (CH₂)_{c} | 1 to 20 | Si(OMe)₃ | 1 |
| 641 | 0 | Me | Me | (CH₂)_{b} | 0 to 20 | SiMe₂ | (CH₂)_{c} | 1 to 20 | Si(OMe)₃ | 1 |
| 642 | 0 | Me | Me | (CH₂)_{b} | 0 to 20 | SiMe₂ | (CH₂)_{c} | 1 to 20 | Si(OMe)₃ | 1 |
| 643 | 0 | Me | Me | (CH₂)_{b} | 0 to 20 | SiMe₂ | (CH₂)_{c} | 1 to 20 | Si(OMe)₃ | 1 |
| 644 | 0 | Me | Me | (CH₂)_{b} | 0 to 20 | SiMe₂ | (CH₂)_{c} | 1 to 20 | Si(OMe)₃ | 1 |
| 645 | 0 | Me | Me | (CH₂)_{b} | 0 to 20 | SiMe₂ | (CH₂)_{c} | 1 to 20 | Si(OMe)₃ | 1 |
| 646 | 0 | Me | Me | (CH₂)_{b} | 0 to 20 | SiMe₂ | (CH₂)_{c} | 1 to 20 | Si(OMe)₃ | 1 |
| 647 | 0 | Me | Me | (CH₂)_{b} | 0 to 20 | SiMe₂ | (CH₂)_{c} | 1 to 20 | Si(OMe)₃ | 1 |

TABLE 144

| No. | R²¹ | | a | R²² | R²³ | R²⁴ | | | R²⁵ | z21 | z22 |
|---|---|---|---|---|---|---|---|---|---|---|---|
| 648 | N(CF₃)₂ | (CH₂)ₐ | 0 to 20 | Me | Me | SF₅ | (CH₂)ₐ | 0 to 20 | Me | 5 to 100 | 0 |
| 649 | Me | (CH₂)ₐ | 0 to 20 | Me | Me | OCF₃ | (CH₂)ₐ | 0 to 20 | Me | 5 to 100 | 0 |
| 650 | CF₃ | (CH₂)ₐ | 0 to 20 | Me | Me | OCF₃ | (CH₂)ₐ | 0 to 20 | Me | 5 to 100 | 0 |
| 651 | (CF₃)₂CF | (CH₂)ₐ | 0 to 20 | Me | Me | OCF₃ | (CH₂)ₐ | 0 to 20 | Me | 5 to 100 | 0 |
| 652 | (CF₃)₃C | (CH₂)ₐ | 0 to 20 | Me | Me | OCF₃ | (CH₂)ₐ | 0 to 20 | Me | 5 to 100 | 0 |
| 653 | C₄F₉ | (CH₂)ₐ | 0 to 20 | Me | Me | OCF₃ | (CH₂)ₐ | 0 to 20 | Me | 5 to 100 | 0 |
| 654 | C₈F₁₇ | (CH₂)ₐ | 0 to 20 | Me | Me | OCF₃ | (CH₂)ₐ | 0 to 20 | Me | 5 to 100 | 0 |
| 655 | c-C₆F₁₁ | (CH₂)ₐ | 0 to 20 | Me | Me | OCF₃ | (CH₂)ₐ | 0 to 20 | Me | 5 to 100 | 0 |
| 656 | CHF₂ | (CH₂)ₐ | 0 to 20 | Me | Me | OCF₃ | (CH₂)ₐ | 0 to 20 | Me | 5 to 100 | 0 |
| 657 | CClF₂ | (CH₂)ₐ | 0 to 20 | Me | Me | OCF₃ | (CH₂)ₐ | 0 to 20 | Me | 5 to 100 | 0 |
| 658 | CBrF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 648 | Me | Me | (CH₂)_{b} | 0 to 20 | SiMe₂ | (CH₂)_{c} | 1 to 20 | Si(OMe)₃ | 1 |
| 649 | Me | Me | (CH₂)_{b} | 0 to 20 | SiMe₂ | (CH₂)_{c} | 1 to 20 | Si(OMe)₃ | 1 |
| 650 | Me | Me | (CH₂)_{b} | 0 to 20 | SiMe₂ | (CH₂)_{c} | 1 to 20 | Si(OMe)₃ | 1 |
| 651 | Me | Me | (CH₂)_{b} | 0 to 20 | SiMe₂ | (CH₂)_{c} | 1 to 20 | Si(OMe)₃ | 1 |
| 652 | Me | Me | (CH₂)_{b} | 0 to 20 | SiMe₂ | (CH₂)_{c} | 1 to 20 | Si(OMe)₃ | 1 |
| 653 | Me | Me | (CH₂)_{b} | 0 to 20 | SiMe₂ | (CH₂)_{c} | 1 to 20 | Si(OMe)₃ | 1 |
| 654 | Me | Me | (CH₂)_{b} | 0 to 20 | SiMe₂ | (CH₂)_{c} | 1 to 20 | Si(OMe)₃ | 1 |
| 655 | Me | Me | (CH₂)_{b} | 0 to 20 | SiMe₂ | (CH₂)_{c} | 1 to 20 | Si(OMe)₃ | 1 |
| 656 | Me | Me | (CH₂)_{b} | 0 to 20 | SiMe₂ | (CH₂)_{c} | 1 to 20 | Si(OMe)₃ | 1 |
| 657 | Me | Me | (CH₂)_{b} | 0 to 20 | SiMe₂ | (CH₂)_{c} | 1 to 20 | Si(OMe)₃ | 1 |
| 658 | Me | Me | (CH₂)_{b} | 0 to 20 | SiMe₂ | (CH₂)_{c} | 1 to 20 | Si(OMe)₃ | 1 |

TABLE 145

| No. | R²¹ | | a | R²² | R²³ | R²⁴ | | | R²⁵ | z21 | z22 |
|---|---|---|---|---|---|---|---|---|---|---|---|
| 659 | ClF₂ | (CH₂)ₐ | 0 to 20 | Me | Me | OCF₃ | (CH₂)ₐ | 0 to 20 | Me | 5 to 100 | 0 |
| 660 | CF═CF₂ | (CH₂)ₐ | 0 to 20 | Me | Me | OCF₃ | (CH₂)ₐ | 0 to 20 | Me | 5 to 100 | 0 |
| 661 | CF═CFCF₃ | (CH₂)ₐ | 0 to 20 | Me | Me | OCF₃ | (CH₂)ₐ | 0 to 20 | Me | 5 to 100 | 0 |
| 662 | CF═CFCF═CF₂ | (CH₂)ₐ | 0 to 20 | Me | Me | OCF₃ | (CH₂)ₐ | 0 to 20 | Me | 5 to 100 | 0 |
| 663 | C≡CCF₃ | (CH₂)ₐ | 0 to 20 | Me | Me | OCF₃ | (CH₂)ₐ | 0 to 20 | Me | 5 to 100 | 0 |
| 664 | CF₂CH₃ | (CH₂)ₐ | 0 to 20 | Me | Me | OCF₃ | (CH₂)ₐ | 0 to 20 | Me | 5 to 100 | 0 |
| 665 | (CF₂)₂H | (CH₂)ₐ | 0 to 20 | Me | Me | OCF₃ | (CH₂)ₐ | 0 to 20 | Me | 5 to 100 | 0 |
| 666 | (CF₂)₂CH₃ | (CH₂)ₐ | 0 to 20 | Me | Me | OCF₃ | (CH₂)ₐ | 0 to 20 | Me | 5 to 100 | 0 |
| 667 | (CF₂)₄H | (CH₂)ₐ | 0 to 20 | Me | Me | OCF₃ | (CH₂)ₐ | 0 to 20 | Me | 5 to 100 | 0 |
| 668 | C₆F₅ | (CH₂)ₐ | 0 to 20 | Me | Me | OCF₃ | (CH₂)ₐ | 0 to 20 | Me | 5 to 100 | 0 |
| 669 | 4-CF₃C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 659 | Me | Me | (CH₂)_{b} | 0 to 20 | SiMe₂ | (CH₂)_{c} | 1 to 20 | Si(OMe)₃ | 1 |
| 660 | Me | Me | (CH₂)_{b} | 0 to 20 | SiMe₂ | (CH₂)_{c} | 1 to 20 | Si(OMe)₃ | 1 |
| 661 | Me | Me | (CH₂)_{b} | 0 to 20 | SiMe₂ | (CH₂)_{c} | 1 to 20 | Si(OMe)₃ | 1 |
| 662 | Me | Me | (CH₂)_{b} | 0 to 20 | SiMe₂ | (CH₂)_{c} | 1 to 20 | Si(OMe)₃ | 1 |
| 663 | Me | Me | (CH₂)_{b} | 0 to 20 | SiMe₂ | (CH₂)_{c} | 1 to 20 | Si(OMe)₃ | 1 |
| 664 | Me | Me | (CH₂)_{b} | 0 to 20 | SiMe₂ | (CH₂)_{c} | 1 to 20 | Si(OMe)₃ | 1 |
| 665 | Me | Me | (CH₂)_{b} | 0 to 20 | SiMe₂ | (CH₂)_{c} | 1 to 20 | Si(OMe)₃ | 1 |
| 666 | Me | Me | (CH₂)_{b} | 0 to 20 | SiMe₂ | (CH₂)_{c} | 1 to 20 | Si(OMe)₃ | 1 |
| 667 | Me | Me | (CH₂)_{b} | 0 to 20 | SiMe₂ | (CH₂)_{c} | 1 to 20 | Si(OMe)₃ | 1 |
| 668 | Me | Me | (CH₂)_{b} | 0 to 20 | SiMe₂ | (CH₂)_{c} | 1 to 20 | Si(OMe)₃ | 1 |
| 669 | Me | Me | (CH₂)_{b} | 0 to 20 | SiMe₂ | (CH₂)_{c} | 1 to 20 | Si(OMe)₃ | 1 |

TABLE 146

| No. | R²¹ | | a | R²² | R²³ | R²⁴ | | | R²⁵ | z21 |
|---|---|---|---|---|---|---|---|---|---|---|
| 670 | 4-SF₅C₆F₄ | (CH₂)ₐ | 0 to 20 | Me | Me | OCF₃ | (CH₂)ₐ | 0 to 20 | Me | 5 to 100 |
| 671 | 3,5-CF₃C₆F₃ | (CH₂)ₐ | 0 to 20 | Me | Me | OCF₃ | (CH₂)ₐ | 0 to 20 | Me | 5 to 100 |
| 672 | 3,5-SF₅C₆F₃ | (CH₂)ₐ | 0 to 20 | Me | Me | OCF₃ | (CH₂)ₐ | 0 to 20 | Me | 5 to 100 |
| 673 | 4-CF₃C₆H₄ | (CH₂)ₐ | 0 to 20 | Me | Me | OCF₃ | (CH₂)ₐ | 0 to 20 | Me | 5 to 100 |
| 674 | 4-SF₅C₆H₄ | (CH₂)ₐ | 0 to 20 | Me | Me | OCF₃ | (CH₂)ₐ | 0 to 20 | Me | 5 to 100 |
| 675 | 3,5-CF₃C₆H₃ | (CH₂)ₐ | 0 to 20 | Me | Me | OCF₃ | (CH₂)ₐ | 0 to 20 | Me | 5 to 100 |
| 676 | 3,5-SF₅C₆H₃ | (CH₂)ₐ | 0 to 20 | Me | Me | OCF₃ | (CH₂)ₐ | 0 to 20 | Me | 5 to 100 |
| 677 | 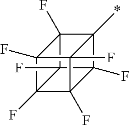 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 |
| 678 | 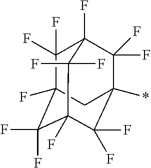 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 |
| 679 | 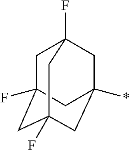 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 |
| 680 | SF₅ | (CH₂)ₐ | 0 to 20 | Me | Me | OCF₃ | (CH₂)ₐ | 0 to 20 | Me | 5 to 100 |
| No. | z22 | R²⁸ | R²⁹ | R¹ | b | L¹ | R² | c | T¹ | x1 |
| 670 | 0 | Me | Me | (CH₂)_{b} | 0 to 20 | SiMe₂ | (CH₂)_{c} | 1 to 20 | Si(OMe)₃ | 1 |
| 671 | 0 | Me | Me | (CH₂)_{b} | 0 to 20 | SiMe₂ | (CH₂)_{c} | 1 to 20 | Si(OMe)₃ | 1 |
| 672 | 0 | Me | Me | (CH₂)_{b} | 0 to 20 | SiMe₂ | (CH₂)_{c} | 1 to 20 | Si(OMe)₃ | 1 |
| 673 | 0 | Me | Me | (CH₂)_{b} | 0 to 20 | SiMe₂ | (CH₂)_{c} | 1 to 20 | Si(OMe)₃ | 1 |
| 674 | 0 | Me | Me | (CH₂)_{b} | 0 to 20 | SiMe₂ | (CH₂)_{c} | 1 to 20 | Si(OMe)₃ | 1 |
| 675 | 0 | Me | Me | (CH₂)_{b} | 0 to 20 | SiMe₂ | (CH₂)_{c} | 1 to 20 | Si(OMe)₃ | 1 |
| 676 | 0 | Me | Me | (CH₂)_{b} | 0 to 20 | SiMe₂ | (CH₂)_{c} | 1 to 20 | Si(OMe)₃ | 1 |
| 677 | 0 | Me | Me | (CH₂)_{b} | 0 to 20 | SiMe₂ | (CH₂)_{c} | 1 to 20 | Si(OMe)₃ | 1 |
| 678 | 0 | Me | Me | (CH₂)_{b} | 0 to 20 | SiMe₂ | (CH₂)_{c} | 1 to 20 | Si(OMe)₃ | 1 |
| 679 | 0 | Me | Me | (CH₂)_{b} | 0 to 20 | SiMe₂ | (CH₂)_{c} | 1 to 20 | Si(OMe)₃ | 1 |
| 680 | 0 | Me | Me | (CH₂)_{b} | 0 to 20 | SiMe₂ | (CH₂)_{c} | 1 to 20 | Si(OMe)₃ | 1 |

TABLE 147

| No. | R²¹ | | a | R²² | R²³ | R²⁴ | | | R²⁵ | z21 |
|---|---|---|---|---|---|---|---|---|---|---|
| 681 | OCF₃ | (CH₂)ₐ | 0 to 20 | Me | Me | OCF₃ | (CH₂)ₐ | 0 to 20 | Me | 5 to 100 |
| 682 | SCF₃ | (CH₂)ₐ | 0 to 20 | Me | Me | OCF₃ | (CH₂)ₐ | 0 to 20 | Me | 5 to 100 |
| 683 | N(CH₂CF₃)₂ | (CH₂)ₐ | 0 to 20 | Me | Me | OCF₃ | (CH₂)ₐ | 0 to 20 | Me | 5 to 100 |
| 684 | N(CF₃)₂ | (CH₂)ₐ | 0 to 20 | Me | Me | OCF₃ | (CH₂)ₐ | 0 to 20 | Me | 5 to 100 |
| 685 | Me | (CH₂)ₐ | 0 to 20 | Me | Me | SCF₃ | (CH₂)ₐ | 0 to 20 | Me | 5 to 100 |
| 686 | CF₃ | (CH₂)ₐ | 0 to 20 | Me | Me | SCF₃ | (CH₂)ₐ | 0 to 20 | Me | 5 to 100 |
| 687 | (CF₃)₂CF | (CH₂)ₐ | 0 to 20 | Me | Me | SCF₃ | (CH₂)ₐ | 0 to 20 | Me | 5 to 100 |
| 688 | (CF₃)₃C | (CH₂)ₐ | 0 to 20 | Me | Me | SCF₃ | (CH₂)ₐ | 0 to 20 | Me | 5 to 100 |
| 689 | C₄F₉ | (CH₂)ₐ | 0 to 20 | Me | Me | SCF₃ | (CH₂)ₐ | 0 to 20 | Me | 5 to 100 |
| 690 | C₈F₁₇ | (CH₂)ₐ | 0 to 20 | Me | Me | SCF₃ | (CH₂)ₐ | 0 to 20 | Me | 5 to 100 |
| 691 | c-C₆F₁₁ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 681 | 0 | Me | Me | (CH₂)_{b} | 0 to 20 | SiMe₂ | (CH₂)_{c} | 1 to 20 | Si(OMe)₃ | 1 |
| 682 | 0 | Me | Me | (CH₂)_{b} | 0 to 20 | SiMe₂ | (CH₂)_{c} | 1 to 20 | Si(OMe)₃ | 1 |
| 683 | 0 | Me | Me | (CH₂)_{b} | 0 to 20 | SiMe₂ | (CH₂)_{c} | 1 to 20 | Si(OMe)₃ | 1 |
| 684 | 0 | Me | Me | (CH₂)_{b} | 0 to 20 | SiMe₂ | (CH₂)_{c} | 1 to 20 | Si(OMe)₃ | 1 |
| 685 | 0 | Me | Me | (CH₂)_{b} | 0 to 20 | SiMe₂ | (CH₂)_{c} | 1 to 20 | Si(OMe)₃ | 1 |
| 686 | 0 | Me | Me | (CH₂)_{b} | 0 to 20 | SiMe₂ | (CH₂)_{c} | 1 to 20 | Si(OMe)₃ | 1 |
| 687 | 0 | Me | Me | (CH₂)_{b} | 0 to 20 | SiMe₂ | (CH₂)_{c} | 1 to 20 | Si(OMe)₃ | 1 |
| 688 | 0 | Me | Me | (CH₂)_{b} | 0 to 20 | SiMe₂ | (CH₂)_{c} | 1 to 20 | Si(OMe)₃ | 1 |
| 689 | 0 | Me | Me | (CH₂)_{b} | 0 to 20 | SiMe₂ | (CH₂)_{c} | 1 to 20 | Si(OMe)₃ | 1 |
| 690 | 0 | Me | Me | (CH₂)_{b} | 0 to 20 | SiMe₂ | (CH₂)_{c} | 1 to 20 | Si(OMe)₃ | 1 |
| 691 | 0 | Me | Me | (CH₂)_{b} | 0 to 20 | SiMe₂ | (CH₂)_{c} | 1 to 20 | Si(OMe)₃ | 1 |

TABLE 148

| No. | R²¹ | | a | R²² | R²³ | R²⁴ | | | R²⁵ | z21 |
|---|---|---|---|---|---|---|---|---|---|---|
| 692 | CHF | (CH₂)ₐ | 0 to 20 | Me | Me | SCF₃ | (CH₂)ₐ | 0 to 20 | Me | 5 to 100 |
| 693 | CClF₂ | (CH₂)ₐ | 0 to 20 | Me | Me | SCF₃ | (CH₂)ₐ | 0 to 20 | Me | 5 to 100 |
| 694 | CBrF₂ | (CH₂)ₐ | 0 to 20 | Me | Me | SCF₃ | (CH₂)ₐ | 0 to 20 | Me | 5 to 100 |
| 695 | ClF₂ | (CH₂)ₐ | 0 to 20 | Me | Me | SCF₃ | (CH₂)ₐ | 0 to 20 | Me | 5 to 100 |
| 696 | CF═CF₂ | (CH₂)ₐ | 0 to 20 | Me | Me | SCF₃ | (CH₂)ₐ | 0 to 20 | Me | 5 to 100 |
| 697 | CF═CFCF₃ | (CH₂)ₐ | 0 to 20 | Me | Me | SCF₃ | (CH₂)ₐ | 0 to 20 | Me | 5 to 100 |
| 698 | CF═CFCF═CF₂ | (CH₂)ₐ | 0 to 20 | Me | Me | SCF₃ | (CH₂)ₐ | 0 to 20 | Me | 5 to 100 |
| 699 | C≡CCF₃ | (CH₂)ₐ | 0 to 20 | Me | Me | SCF₃ | (CH₂)ₐ | 0 to 20 | Me | 5 to 100 |
| 700 | CF₂CH₃ | (CH₂)ₐ | 0 to 20 | Me | Me | SCF₃ | (CH₂)ₐ | 0 to 20 | Me | 5 to 100 |
| 701 | (CF₂)₂H | (CH₂)ₐ | 0 to 20 | Me | Me | SCF₃ | (CH₂)ₐ | 0 to 20 | Me | 5 to 100 |
| 702 | (CF₂)₂CH₃ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 692 | 0 | Me | Me | (CH₂)_{b} | 0 to 20 | SiMe₂ | (CH₂)_{c} | 1 to 20 | Si(OMe)₃ | 1 |
| 693 | 0 | Me | Me | (CH₂)_{b} | 0 to 20 | SiMe₂ | (CH₂)_{c} | 1 to 20 | Si(OMe)₃ | 1 |
| 694 | 0 | Me | Me | (CH₂)_{b} | 0 to 20 | SiMe₂ | (CH₂)_{c} | 1 to 20 | Si(OMe)₃ | 1 |
| 695 | 0 | Me | Me | (CH₂)_{b} | 0 to 20 | SiMe₂ | (CH₂)_{c} | 1 to 20 | Si(OMe)₃ | 1 |
| 696 | 0 | Me | Me | (CH₂)_{b} | 0 to 20 | SiMe₂ | (CH₂)_{c} | 1 to 20 | Si(OMe)₃ | 1 |
| 697 | 0 | Me | Me | (CH₂)_{b} | 0 to 20 | SiMe₂ | (CH₂)_{c} | 1 to 20 | Si(OMe)₃ | 1 |
| 698 | 0 | Me | Me | (CH₂)_{b} | 0 to 20 | SiMe₂ | (CH₂)_{c} | 1 to 20 | Si(OMe)₃ | 1 |
| 699 | 0 | Me | Me | (CH₂)_{b} | 0 to 20 | SiMe₂ | (CH₂)_{c} | 1 to 20 | Si(OMe)₃ | 1 |
| 700 | 0 | Me | Me | (CH₂)_{b} | 0 to 20 | SiMe₂ | (CH₂)_{c} | 1 to 20 | Si(OMe)₃ | 1 |
| 701 | 0 | Me | Me | (CH₂)_{b} | 0 to 20 | SiMe₂ | (CH₂)_{c} | 1 to 20 | Si(OMe)₃ | 1 |
| 702 | 0 | Me | Me | (CH₂)_{b} | 0 to 20 | SiMe₂ | (CH₂)_{c} | 1 to 20 | Si(OMe)₃ | 1 |

TABLE 149

| No. | R²¹ | | a | R²² | R²³ | R²⁴ | | | R²⁵ | z21 |
|---|---|---|---|---|---|---|---|---|---|---|
| 703 | (CF₂)₄H | (CH₂)ₐ | 0 to 20 | Me | Me | SCF₃ | (CH₂)ₐ | 0 to 20 | Me | 5 to 100 |
| 704 | C₆F₅ | (CH₂)ₐ | 0 to 20 | Me | Me | SCF₃ | (CH₂)ₐ | 0 to 20 | Me | 5 to 100 |
| 705 | 4-CF₃C₆F₄ | (CH₂)ₐ | 0 to 20 | Me | Me | SCF₃ | (CH₂)ₐ | 0 to 20 | Me | 5 to 100 |
| 706 | 4-SF₅C₆F₄ | (CH₂)ₐ | 0 to 20 | Me | Me | SCF₃ | (CH₂)ₐ | 0 to 20 | Me | 5 to 100 |
| 707 | 3,5-CF₃C₆F₃ | (CH₂)ₐ | 0 to 20 | Me | Me | SCF₃ | (CH₂)ₐ | 0 to 20 | Me | 5 to 100 |
| 708 | 3,5-SF₅C₆F₃ | (CH₂)ₐ | 0 to 20 | Me | Me | SCF₃ | (CH₂)ₐ | 0 to 20 | Me | 5 to 100 |
| 709 | 4-CF₃C₆H₄ | (CH₂)ₐ | 0 to 20 | Me | Me | SCF₃ | (CH₂)ₐ | 0 to 20 | Me | 5 to 100 |
| 710 | 4-SF₅C₆H₄ | (CH₂)ₐ | 0 to 20 | Me | Me | SCF₃ | (CH₂)ₐ | 0 to 20 | Me | 5 to 100 |
| 711 | 3,5-CF₃C₆H₃ | (CH₂)ₐ | 0 to 20 | Me | Me | SCF₃ | (CH₂)ₐ | 0 to 20 | Me | 5 to 100 |
| 712 | 3,5-SF₅C₆H₃ | (CH₂)ₐ | 0 to 20 | Me | Me | SCF₃ | (CH₂)ₐ | 0 to 20 | Me | 5 to 100 |
| 713 | 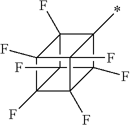 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 |
| No. | z22 | R²⁸ | R²⁹ | R¹ | b | L¹ | R² | c | T¹ | x1 |
| 703 | 0 | Me | Me | (CH₂)_{b} | 0 to 20 | SiMe₂ | (CH₂)_{c} | 1 to 20 | Si(OMe)₃ | 1 |
| 704 | 0 | Me | Me | (CH₂)_{b} | 0 to 20 | SiMe₂ | (CH₂)_{c} | 1 to 20 | Si(OMe)₃ | 1 |
| 705 | 0 | Me | Me | (CH₂)_{b} | 0 to 20 | SiMe₂ | (CH₂)_{c} | 1 to 20 | Si(OMe)₃ | 1 |
| 706 | 0 | Me | Me | (CH₂)_{b} | 0 to 20 | SiMe₂ | (CH₂)_{c} | 1 to 20 | Si(OMe)₃ | 1 |
| 707 | 0 | Me | Me | (CH₂)_{b} | 0 to 20 | SiMe₂ | (CH₂)_{c} | 1 to 20 | Si(OMe)₃ | 1 |
| 708 | 0 | Me | Me | (CH₂)_{b} | 0 to 20 | SiMe₂ | (CH₂)_{c} | 1 to 20 | Si(OMe)₃ | 1 |
| 709 | 0 | Me | Me | (CH₂)_{b} | 0 to 20 | SiMe₂ | (CH₂)_{c} | 1 to 20 | Si(OMe)₃ | 1 |
| 710 | 0 | Me | Me | (CH₂)_{b} | 0 to 20 | SiMe₂ | (CH₂)_{c} | 1 to 20 | Si(OMe)₃ | 1 |
| 711 | 0 | Me | Me | (CH₂)_{b} | 0 to 20 | SiMe₂ | (CH₂)_{c} | 1 to 20 | Si(OMe)₃ | 1 |
| 712 | 0 | Me | Me | (CH₂)_{b} | 0 to 20 | SiMe₂ | (CH₂)_{c} | 1 to 20 | Si(OMe)₃ | 1 |
| 713 | 0 | Me | Me | (CH₂)_{b} | 0 to 20 | SiMe₂ | (CH₂)_{c} | 1 to 20 | Si(OMe)₃ | 1 |

TABLE 150

| No. | R²¹ | | a | R²² | R²³ | R²⁴ | | | R²⁵ | z21 |
|---|---|---|---|---|---|---|---|---|---|---|
| 714 | 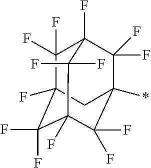 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 |
| 715 | 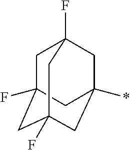 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 |
| 716 | SF₅ | (CH₂)ₐ | 0 to 20 | Me | Me | SCF₃ | (CH₂)ₐ | 0 to 20 | Me | 5 to 100 |
| 717 | OCF₃ | (CH₂)ₐ | 0 to 20 | Me | Me | SCF₃ | (CH₂)ₐ | 0 to 20 | Me | 5 to 100 |
| 718 | SCF₃ | (CH₂)ₐ | 0 to 20 | Me | Me | SCF₃ | (CH₂)ₐ | 0 to 20 | Me | 5 to 100 |
| 719 | N(CH₂CF₃)₂ | (CH₂)ₐ | 0 to 20 | Me | Me | SCF₃ | (CH₂)ₐ | 0 to 20 | Me | 5 to 100 |
| 720 | N(CF₃)₂ | (CH₂)ₐ | 0 to 20 | Me | Me | SCF₃ | (CH₂)ₐ | 0 to 20 | Me | 5 to 100 |
| 721 | Me | (CH₂)ₐ | 0 to 20 | Me | Me | N(CF₃)₂ | (CH₂)ₐ | 0 to 20 | Me | 5 to 100 |
| 722 | CF₃ | (CH₂)ₐ | 0 to 20 | Me | Me | N(CF₃)₂ | (CH₂)ₐ | 0 to 20 | Me | 5 to 100 |
| 723 | (CF₃)₂CF | (CH₂)e | 0 to 20 | Me | Me | N(CF₃)₂ | (CH₂)ₐ | 0 to 20 | Me | 5 to 100 |
| 724 | (CF₃)₃C | (CH₂)ₐ | 0 to 20 | Me | Me | N(CF₃)₂ | (CH₂)ₐ | 0 to 20 | Me | 5 to 100 |
| No. | z22 | R²⁸ | R²⁹ | R¹ | b | L¹ | R² | c | T¹ | x1 |
| 714 | 0 | Me | Me | (CH₂)_{b} | 0 to 20 | SiMe₂ | (CH₂)_{c} | 1 to 20 | Si(OMe)₃ | 1 |
| 715 | 0 | Me | Me | (CH₂)_{b} | 0 to 20 | SiMe₂ | (CH₂)_{c} | 1 to 20 | Si(OMe)₃ | 1 |
| 716 | 0 | Me | Me | (CH₂)_{b} | 0 to 20 | SiMe₂ | (CH₂)_{c} | 1 to 20 | Si(OMe)₃ | 1 |
| 717 | 0 | Me | Me | (CH₂)_{b} | 0 to 20 | SiMe₂ | (CH₂)_{c} | 1 to 20 | Si(OMe)₃ | 1 |
| 718 | 0 | \|Me | Me | (CH₂)_{b} | 0 to 20 | SiMe₂ | (CH₂)_{c} | 1 to 20 | Si(OMe)₃ | 1 |
| 719 | 0 | Me | Me | (CH₂)_{b} | 0 to 20 | SiMe₂ | (CH₂)_{c} | 1 to 20 | Si(OMe)₃ | 1 |
| 720 | 0 | Me | Me | (CH₂)_{b} | 0 to 20 | SiMe₂ | (CH₂)_{c} | 1 to 20 | Si(OMe)₃ | 1 |
| 721 | 0 | Me | Me | (CH₂)_{b} | 0 to 20 | SiMe₂ | (CH₂)_{c} | 1 to 20 | Si(OMe)₃ | 1 |
| 722 | 0 | Me | Me | (CH₂)_{b} | 0 to 20 | SiMe₂ | (CH₂)_{c} | 1 to 20 | Si(OMe)₃ | 1 |
| 723 | 0 | Me | Me | (CH₂)_{b} | 0 to 20 | SiMe₂ | (CH₂)_{c} | 1 to 20 | Si(OMe)₃ | 1 |
| 724 | 0 | Me | Me | (CH₂)_{b} | 0 to 20 | SiMe₂ | (CH₂)_{c} | 1 to 20 | Si(OMe)₃ | 1 |

TABLE 151

| No. | R²¹ | | a | R²² | R²³ | R²⁴ | | | R²⁵ | z21 |
|---|---|---|---|---|---|---|---|---|---|---|
| 725 | C₄F₉ | (CH₂)ₐ | 0 to 20 | Me | Me | N(CF₃)₂ | (CH₂)ₐ | 0 to 20 | Me | 5 to 100 |
| 726 | C₈F₁₇ | (CH₂)ₐ | 0 to 20 | Me | Me | N(CF₃)₂ | (CH₂)ₐ | 0 to 20 | Me | 5 to 100 |
| 727 | c-C₆F₁₁ | (CH₂)ₐ | 0 to 20 | Me | Me | N(CF₃)₂ | (CH₂)ₐ | 0 to 20 | Me | 5 to 100 |
| 728 | CHF₂ | (CH₂)ₐ | 0 to 20 | Me | Me | N(CF₃)₂ | (CH₂)ₐ | 0 to 20 | Me | 5 to 100 |
| 729 | CClF₂ | (CH₂)ₐ | 0 to 20 | Me | Me | N(CF₃)₂ | (CH₂)ₐ | 0 to 20 | Me | 5 to 100 |
| 730 | CBrF₂ | (CH₂)ₐ | 0 to 20 | Me | Me | N(CF₃)₂ | (CH₂)ₐ | 0 to 20 | Me | 5 to 100 |
| 731 | ClF₂ | (CH₂)ₐ | 0 to 20 | Me | Me | N(CF₃)₂ | (CH₂)ₐ | 0 to 20 | Me | 5 to 100 |
| 732 | CF═CF₂ | (CH₂)ₐ | 0 to 20 | Me | Me | N(CF₃)₂ | (CH₂)ₐ | 0 to 20 | Me | 5 to 100 |
| 733 | CF═CFCF₃ | (CH₂)ₐ | 0 to 20 | Me | Me | N(CF₃)₂ | (CH₂)ₐ | 0 to 20 | Me | 5 to 100 |
| 734 | CF═CFCF═CF₂ | (CH₂)ₐ | 0 to 20 | Me | Me | N(CF₃)₂ | (CH₂)ₐ | 0 to 20 | Me | 5 to 100 |
| 735 | C≡CCF₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 725 | 0 | Me | Me | (CH₂)_{b} | 0 to 20 | SiMe₂ | (CH₂)_{c} | 1 to 20 | Si(OMe)₃ | 1 |
| 726 | 0 | Me | Me | (CH₂)_{b} | 0 to 20 | SiMe₂ | (CH₂)_{c} | 1 to 20 | Si(OMe)₃ | 1 |
| 727 | 0 | Me | Me | (CH₂)_{b} | 0 to 20 | SiMe₂ | (CH₂)_{c} | 1 to 20 | Si(OMe)₃ | 1 |
| 728 | 0 | Me | Me | (CH₂)_{b} | 0 to 20 | SiMe₂ | (CH₂)_{c} | 1 to 20 | Si(OMe)₃ | 1 |
| 729 | 0 | Me | Me | (CH₂)_{b} | 0 to 20 | SiMe₂ | (CH₂)_{c} | 1 to 20 | Si(OMe)₃ | 1 |
| 730 | 0 | Me | Me | (CH₂)_{b} | 0 to 20 | SiMe₂ | (CH₂)_{c} | 1 to 20 | Si(OMe)₃ | 1 |
| 731 | 0 | Me | Me | (CH₂)_{b} | 0 to 20 | SiMe₂ | (CH₂)_{c} | 1 to 20 | Si(OMe)₃ | 1 |
| 732 | 0 | Me | Me | (CH₂)_{b} | 0 to 20 | SiMe₂ | (CH₂)_{c} | 1 to 20 | Si(OMe)₃ | 1 |
| 733 | 0 | Me | Me | (CH₂)_{b} | 0 to 20 | SiMe₂ | (CH₂)_{c} | 1 to 20 | Si(OMe)₃ | 1 |
| 734 | 0 | Me | Me | (CH₂)_{b} | 0 to 20 | SiMe₂ | (CH₂)_{c} | 1 to 20 | Si(OMe)₃ | 1 |
| 735 | 0 | Me | Me | (CH₂)_{b} | 0 to 20 | SiMe₂ | (CH₂)_{c} | 1 to 20 | Si(OMe)₃ | 1 |

TABLE 152

| No. | R²¹ | | a | R²² | R²³ | R²⁴ | | | R²⁵ | z21 |
|---|---|---|---|---|---|---|---|---|---|---|
| 736 | CF₂CH₃ | (CH₂)ₐ | 0 to 20 | Me | Me | N(CF₃)₂ | (CH₂)ₐ | 0 to 20 | Me | 5 to 100 |
| 737 | (CF₂)₂H | (CH₂)ₐ | 0 to 20 | Me | Me | N(CF₃)₂ | (CH₂)ₐ | 0 to 20 | Me | 5 to 100 |
| 738 | (CF₂)₂CH₃ | (CH₂)ₐ | 0 to 20 | Me | Me | N(CF₃)₂ | (CH₂)ₐ | 0 to 20 | Me | 5 to 100 |
| 739 | (CF₂)₄H | (CH₂)ₐ | 0 to 20 | Me | Me | SCF₃ | (CH₂)ₐ | 0 to 20 | Me | 5 to 100 |
| 740 | C₆F₅ | (CH₂)ₐ | 0 to 20 | Me | Me | N(CF₃)₂ | (CH₂)ₐ | 0 to 20 | Me | 5 to 100 |
| 741 | 4-CF₃C₆F₄ | (CH₂)ₐ | 0 to 20 | Me | Me | N(CF₃)₂ | (CH₂)ₐ | 0 to 20 | Me | 5 to 100 |
| 742 | 4-SF₅C₆F₄ | (CH₂)ₐ | 0 to 20 | Me | Me | N(CF₃)₂ | (CH₂)ₐ | 0 to 20 | Me | 5 to 100 |
| 743 | 3,5-CF₃C₆F₃ | (CH₂)ₐ | 0 to 20 | Me | Me | N(CF₃)₂ | (CH₂)ₐ | 0 to 20 | Me | 5 to 100 |
| 744 | 3,5-SF₅C₆F₃ | (CH₂)ₐ | 0 to 20 | Me | Me | N(CF₃)₂ | (CH₂)ₐ | 0 to 20 | Me | 5 to 100 |
| 745 | 4-CF₃C₆H₄ | (CH₂)ₐ | 0 to 20 | Me | Me | N(CF₃)₂ | (CH₂)ₐ | 0 to 20 | Me | 5 to 100 |
| 746 | 4-SF₅C₆H₄ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 736 | 0 | Me | Me | (CH₂)_{b} | 0 to 20 | SiMe₂ | (CH₂)_{c} | 1 to 20 | Si(OMe)₃ | 1 |
| 737 | 0 | Me | Me | (CH₂)_{b} | 0 to 20 | SiMe₂ | (CH₂)_{c} | 1 to 20 | Si(OMe)₃ | 1 |
| 738 | 0 | Me | Me | (CH₂)_{b} | 0 to 20 | SiMe₂ | (CH₂)_{c} | 1 to 20 | Si(OMe)₃ | 1 |
| 739 | 0 | Me | Me | (CH₂)_{b} | 0 to 20 | SiMe₂ | (CH₂)_{c} | 1 to 20 | Si(OMe)₃ | 1 |
| 740 | 0 | Me | Me | (CH₂)_{b} | 0 to 20 | SiMe₂ | (CH₂)_{c} | 1 to 20 | Si(OMe)₃ | 1 |
| 741 | 0 | Me | Me | (CH₂)_{b} | 0 to 20 | SiMe₂ | (CH₂)_{c} | 1 to 20 | Si(OMe)₃ | 1 |
| 742 | 0 | Me | Me | (CH₂)_{b} | 0 to 20 | SiMe₂ | (CH₂)_{c} | 1 to 20 | Si(OMe)₃ | 1 |
| 743 | 0 | Me | Me | (CH₂)_{b} | 0 to 20 | SiMe₂ | (CH₂)_{c} | 1 to 20 | Si(OMe)₃ | 1 |
| 744 | 0 | Me | Me | (CH₂)_{b} | 0 to 20 | SiMe₂ | (CH₂)_{c} | 1 to 20 | Si(OMe)₃ | 1 |
| 745 | 0 | Me | Me | (CH₂)_{b} | 0 to 20 | SiMe₂ | (CH₂)_{c} | 1 to 20 | Si(OMe)₃ | 1 |
| 746 | 0 | Me | Me | (CH₂)_{b} | 0 to 20 | SiMe₂ | (CH₂)_{c} | 1 to 20 | Si(OMe)₃ | 1 |

TABLE 153

| No. | R²¹ | | a | R²² | R²³ | R²⁴ | | | R²⁵ | z21 |
|---|---|---|---|---|---|---|---|---|---|---|
| 747 | 3,5-CF₃C₆H₃ | (CH₂)ₐ | 0 to 20 | Me | Me | N(CF₃)₂ | (CH₂)ₐ | 0 to 20 | Me | 5 to 100 |
| 748 | 3,5-SF₅C₆H₃ | (CH₂)ₐ | 0 to 20 | Me | Me | N(CF₃)₂ | (CH₂)ₐ | 0 to 20 | Me | 5 to 100 |
| 749 | 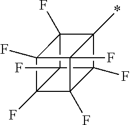 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 |
| 750 | 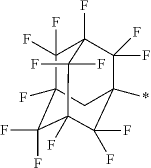 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 |
| 751 | 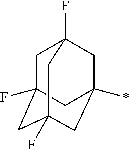 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 |
| 752 | SF₅ | (CH₂)ₐ | 0 to 20 | Me | Me | N(CF₃)₂ | (CH₂)ₐ | 0 to 20 | Me | 5 to 100 |
| 753 | OCF₃ | (CH₂)ₐ | 0 to 20 | Me | Me | N(CF₃)₂ | (CH₂)ₐ | 0 to 20 | Me | 5 to 100 |
| 754 | SCF₃ | (CH₂)ₐ | 0 to 20 | Me | Me | N(CF₃)₂ | (CH₂)ₐ | 0 to 20 | Me | 5 to 100 |
| 755 | N(CH₂CF₃)₂ | (CH₂)ₐ | 0 to 20 | Me | Me | N(CF₃)₂ | (CH₂)ₐ | 0 to 20 | Me | 5 to 100 |
| 756 | N(CF₃)₂ | (CH₂)ₐ | 0 to 20 | Me | Me | N(CF₃)₂ | (CH₂)ₐ | 0 to 20 | Me | 5 to 100 |
| 757 | Me | (CH₂)ₐ | 0 to 20 | Me | Me | CF₃ | (CH₂)ₐ | 0 to 20 | Me | 5 to 100 |
| No. | z22 | R²⁸ | R²⁹ | R¹ | b | L¹ | R² | c | T¹ | x1 |
| 747 | 0 | Me | Me | b | 0 to 20 | SiMe₂ | (CH₂)_{c} | 1 to 20 | Si(OMe)₃ | 1 |
| 748 | 0 | Me | Me | (CH₂)_{b} | 0 to 20 | SiMe₂ | (CH₂)_{c} | 1 to 20 | Si(OMe)₃ | 1 |
| 749 | 0 | Me | Me | (CH₂)_{b} | 0 to 20 | SiMe₂ | (CH₂)_{c} | 1 to 20 | Si(OMe)₃ | 1 |
| 750 | 0 | Me | Me | (CH₂)_{b} | 0 to 20 | SiMe₂ | (CH₂)_{c} | 1 to 20 | Si(OMe)₃ | 1 |
| 751 | 0 | Me | Me | (CH₂)_{b} | 0 to 20 | SiMe₂ | (CH₂)_{c} | 1 to 20 | Si(OMe)₃ | 1 |
| 752 | 0 | Me | Me | (CH₂)_{b} | 0 to 20 | SiMe₂ | (CH₂)_{c} | 1 to 20 | Si(OMe)₃ | 1 |
| 753 | 0 | Me | Me | (CH₂)_{b} | 0 to 20 | SiMe₂ | (CH₂)_{c} | 1 to 20 | Si(OMe)₃ | 1 |
| 754 | 0 | Me | Me | (CH₂)_{b} | 0 to 20 | SiMe₂ | (CH₂)_{c} | 1 to 20 | Si(OMe)₃ | 1 |
| 755 | 0 | Me | Me | (CH₂)_{b} | 0 to 20 | SiMe₂ | (CH₂)_{c} | 1 to 20 | Si(OMe)₃ | 1 |
| 756 | 0 | Me | Me | (CH₂)_{b} | 0 to 20 | SiMe₂ | (CH₂)_{c} | 1 to 20 | Si(OMe)₃ | 1 |
| 757 | 0 | Me | Me | (CH₂)_{b} | 0 to 20 | CH₂ | (CH₂)_{c} | 1 to 20 | Si(OMe)₃ | 1 |

TABLE 154

| No. | R²¹ | | a | R²² | R²³ | R²⁴ | | | R²⁵ | z21 |
|---|---|---|---|---|---|---|---|---|---|---|
| 758 | CF₃ | (CH₂)ₐ | 0 to 20 | Me | Me | CF₃ | (CH₂)ₐ | 0 to 20 | Me | 5 to 100 |
| 759 | (CF₃)₂CF | (CH₂)ₐ | 0 to 20 | Me | Me | CF₃ | (CH₂)ₐ | 0 to 20 | Me | 5 to 100 |
| 760 | (CF₃)₃C | (CH₂)ₐ | 0 to 20 | Me | Me | CF₃ | (CH₂)ₐ | 0 to 20 | Me | 5 to 100 |
| 761 | C₄F₉ | (CH₂)ₐ | 0 to 20 | Me | Me | CF₃ | (CH₂)ₐ | 0 to 20 | Me | 5 to 100 |
| 762 | C₈F₁₇ | (CH₂)ₐ | 0 to 20 | Me | Me | CF₃ | (CH₂)ₐ | 0 to 20 | Me | 5 to 100 |
| 763 | c-C₆F₁₁ | (CH₂)ₐ | 0 to 20 | Me | Me | CF₃ | (CH₂)ₐ | 0 to 20 | Me | 5 to 100 |
| 764 | CHF₂ | (CH₂)ₐ | 0 to 20 | Me | Me | CF₃ | (CH₂)ₐ | 0 to 20 | Me | 5 to 100 |
| 765 | CClF₂ | (CH₂)ₐ | 0 to 20 | Me | Me | CF₃ | (CH₂)ₐ | 0 to 20 | Me | 5 to 100 |
| 766 | CBrF₂ | (CH₂)ₐ | 0 to 20 | Me | Me | CF₃ | (CH₂)ₐ | 0 to 20 | Me | 5 to 100 |
| 767 | ClF₂ | (CH₂)ₐ | 0 to 20 | Me | Me | CF₃ | (CH₂)ₐ | 0 to 20 | Me | 5 to 100 |
| 768 | CF═CF₂ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 758 | 0 | Me | Me | (CH₂)_{b} | 0 to 20 | CH₂ | (CH₂)_{c} | 1 to 20 | Si(OMe)₃ | 1 |
| 759 | 0 | Me | Me | (CH₂)_{b} | 0 to 20 | CH₂ | (CH₂)_{c} | 1 to 20 | Si(OMe)₃ | 1 |
| 760 | 0 | Me | Me | (CH₂)_{b} | 0 to 20 | CH₂ | (CH₂)_{c} | 1 to 20 | Si(OMe)₃ | 1 |
| 761 | 0 | Me | Me | (CH₂)_{b} | 0 to 20 | CH₂ | (CH₂)_{c} | 1 to 20 | Si(OMe)₃ | 1 |
| 762 | 0 | Me | Me | (CH₂)_{b} | 0 to 20 | CH₂ | (CH₂)_{c} | 1 to 20 | Si(OMe)₃ | 1 |
| 763 | 0 | Me | Me | (CH₂)_{b} | 0 to 20 | CH₂ | (CH₂)_{c} | 1 to 20 | Si(OMe)₃ | 1 |
| 764 | 0 | Me | Me | (CH₂)_{b} | 0 to 20 | CH₂ | (CH₂)_{c} | 1 to 20 | Si(OMe)₃ | 1 |
| 765 | 0 | Me | Me | (CH₂)_{b} | 0 to 20 | CH₂ | (CH₂)_{c} | 1 to 20 | Si(OMe)₃ | 1 |
| 766 | 0 | Me | Me | (CH₂)_{b} | 0 to 20 | CH₂ | (CH₂)_{c} | 1 to 20 | Si(OMe)₃ | 1 |
| 767 | 0 | Me | Me | (CH₂)_{b} | 0 to 20 | CH₂ | (CH₂)_{c} | 1 to 20 | Si(OMe)₃ | 1 |
| 768 | 0 | Me | Me | (CH₂)_{b} | 0 to 20 | CH₂ | (CH₂)_{c} | 1 to 20 | Si(OMe)₃ | 1 |

TABLE 155

| No. | R²¹ | | a | R²² | R²³ | R²⁴ | | | R²⁵ | z21 |
|---|---|---|---|---|---|---|---|---|---|---|
| 769 | CF═CFCF₃ | (CH₂)ₐ | 0 to 20 | Me | Me | CF₃ | (CH₂)ₐ | 0 to 20 | Me | 5 to 100 |
| 770 | CF═CFCF═CF₂ | (CH₂)ₐ | 0 to 20 | Me | Me | CF₃ | (CH₂)ₐ | 0 to 20 | Me | 5 to 100 |
| 771 | C≡CCF₃ | (CH₂)ₐ | 0 to 20 | Me | Me | CF₃ | (CH₂)ₐ | 0 to 20 | Me | 5 to 100 |
| 772 | CF₂CH₃ | (CH₂)ₐ | 0 to 20 | Me | Me | CF₃ | (CH₂)ₐ | 0 to 20 | Me | 5 to 100 |
| 773 | (CF₂)₂H | (CH₂)ₐ | 0 to 20 | Me | Me | CF₃ | (CH₂)ₐ | 0 to 20 | Me | 5 to 100 |
| 774 | (CF₂)₂CH₃ | (CH₂)ₐ | 0 to 20 | Me | Me | CF₃ | (CH₂)ₐ | 0 to 20 | Me | 5 to 100 |
| 775 | (CF₂)₄H | (CH₂)ₐ | 0 to 20 | Me | Me | CF₃ | (CH₂)ₐ | 0 to 20 | Me | 5 to 100 |
| 776 | C₆F₅ | (CH₂)ₐ | 0 to 20 | Me | Me | CF₃ | (CH₂)ₐ | 0 to 20 | Me | 5 to 100 |
| 777 | 4-CF₃C₆F₄ | (CH₂)ₐ | 0 to 20 | Me | Me | CF₃ | (CH₂)ₐ | 0 to 20 | Me | 5 to 100 |
| 778 | 4-SF₅C₆F₄ | (CH₂)ₐ | 0 to 20 | Me | Me | CF₃ | (CH₂)ₐ | 0 to 20 | Me | 5 to 100 |
| 779 | 3,5-CF₃C₆F₃ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 769 | 0 | Me | Me | (CH₂)_{b} | 0 to 20 | CH₂ | (CH₂)_{c} | 1 to 20 | Si(OMe)₃ | 1 |
| 770 | 0 | Me | Me | (CH₂)_{b} | 0 to 20 | CH₂ | (CH₂)_{c} | 1 to 20 | Si(OMe)₃ | 1 |
| 771 | 0 | Me | Me | (CH₂)_{b} | 0 to 20 | CH₂ | (CH₂)_{c} | 1 to 20 | Si(OMe)₃ | 1 |
| 772 | 0 | Me | Me | (CH₂)_{b} | 0 to 20 | CH₂ | (CH₂)_{c} | 1 to 20 | Si(OMe)₃ | 1 |
| 773 | 0 | Me | Me | (CH₂)_{b} | 0 to 20 | CH₂ | (CH₂)_{c} | 1 to 20 | Si(OMe)₃ | 1 |
| 774 | 0 | Me | Me | (CH₂)_{b} | 0 to 20 | CH₂ | (CH₂)_{c} | 1 to 20 | Si(OMe)₃ | 1 |
| 775 | 0 | Me | Me | (CH₂)_{b} | 0 to 20 | CH₂ | (CH₂)_{c} | 1 to 20 | Si(OMe)₃ | 1 |
| 776 | 0 | Me | Me | (CH₂)_{b} | 0 to 20 | CH₂ | (CH₂)_{c} | 1 to 20 | Si(OMe)₃ | 1 |
| 777 | 0 | Me | Me | (CH₂)_{b} | 0 to 20 | CH₂ | (CH₂)_{c} | 1 to 20 | Si(OMe)₃ | 1 |
| 778 | 0 | Me | Me | (CH₂)_{b} | 0 to 20 | CH₂ | (CH₂)_{c} | 1 to 20 | Si(OMe)₃ | 1 |
| 779 | 0 | Me | Me | (CH₂)_{b} | 0 to 20 | CH₂ | (CH₂)_{c} | 1 to 20 | Si(OMe)₃ | 1 |

TABLE 156

| No. | R²¹ | | a | R²² | R²³ | R²⁴ | | | R²⁵ | z21 |
|---|---|---|---|---|---|---|---|---|---|---|
| 780 | 3,5-SF₅C₆F₃ | (CH₂)ₐ | 0 to 20 | Me | Me | CF₃ | (CH₂)ₐ | 0 to 20 | Me | 5 to 100 |
| 781 | 4-CF₃C₆H₄ | (CH₂)ₐ | 0 to 20 | Me | Me | CF₃ | (CH₂)ₐ | 0 to 20 | Me | 5 to 100 |
| 782 | 4-SF₅C₆H₄ | (CH₂)ₐ | 0 to 20 | Me | Me | CF₃ | (CH₂)ₐ | 0 to 20 | Me | 5 to 100 |
| 783 | 3,5-CF₃C₆H₃ | (CH₂)ₐ | 0 to 20 | Me | Me | CF₃ | (CH₂)ₐ | 0 to 20 | Me | 5 to 100 |
| 784 | 3,5-SF₅C₆H₃ | (CH₂)ₐ | 0 to 20 | Me | Me | CF₃ | (CH₂)ₐ | 0 to 20 | Me | 5 to 100 |
| 785 | 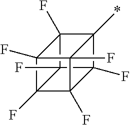 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 |
| 786 | 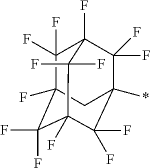 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 |
| 787 | 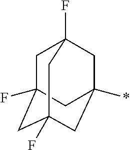 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 |
| 788 | SF₅ | (CH₂)ₐ | 0 to 20 | Me | Me | CF₃ | (CH₂)ₐ | 0 to 20 | Me | 5 to 100 |
| 789 | OCF₃ | (CH₂)ₐ | 0 to 20 | Me | Me | CF₃ | (CH₂)ₐ | 0 to 20 | Me | 5 to 100 |
| 790 | SCF₃ | (CH₂)ₐ | 0 to 20 | Me | Me | CF₃ | (CH₂)ₐ | 0 to 20 | Me | 5 to 100 |
| No. | z22 | R²⁸ | R²⁹ | R¹ | b | L¹ | R² | c | T¹ | x1 |
| 780 | 0 | Me | Me | (CH₂)_{b} | 0 to 20 | CH₂ | (CH₂)_{c} | 1 to 20 | Si(OMe)₃ | 1 |
| 781 | 0 | Me | Me | (CH₂)_{b} | 0 to 20 | CH₂ | (CH₂)_{c} | 1 to 20 | Si(OMe)₃ | 1 |
| 782 | 0 | Me | Me | (CH₂)_{b} | 0 to 20 | CH₂ | (CH₂)_{c} | 1 to 20 | Si(OMe)₃ | 1 |
| 783 | 0 | Me | Me | (CH₂)_{b} | 0 to 20 | CH₂ | (CH₂)_{c} | 1 to 20 | Si(OMe)₃ | 1 |
| 784 | 0 | Me | Me | (CH₂)_{b} | 0 to 20 | CH₂ | (CH₂)_{c} | 1 to 20 | Si(OMe)₃ | 1 |
| 785 | 0 | Me | Me | (CH₂)_{b} | 0 to 20 | CH₂ | (CH₂)_{c} | 1 to 20 | Si(OMe)₃ | 1 |
| 786 | 0 | Me | Me | (CH₂)_{b} | 0 to 20 | CH₂ | (CH₂)_{c} | 1 to 20 | Si(OMe)₃ | 1 |
| 787 | 0 | Me | Me | (CH₂)_{b} | 0 to 20 | CH₂ | (CH₂)_{c} | 1 to 20 | Si(OMe)₃ | 1 |
| 788 | 0 | Me | Me | (CH₂)_{b} | 0 to 20 | CH₂ | (CH₂)_{c} | 1 to 20 | Si(OMe)₃ | 1 |
| 789 | 0 | Me | Me | (CH₂)_{b} | 0 to 20 | CH₂ | (CH₂)_{c} | 1 to 20 | Si(OMe)₃ | 1 |
| 790 | 0 | Me | Me | (CH₂)_{b} | 0 to 20 | CH₂ | (CH₂)_{c} | 1 to 20 | Si(OMe)₃ | 1 |

TABLE 157

| No. | R²¹ | | a | R²² | R²³ | R²⁴ | | | R²⁵ | z21 |
|---|---|---|---|---|---|---|---|---|---|---|
| 791 | N(CH₂CF₃)₂ | (CH₂)ₐ | 0 to 20 | Me | Me | CF₃ | (CH₂)ₐ | 0 to 20 | Me | 5 to 100 |
| 792 | N(CF₃)₂ | (CH₂)ₐ | 0 to 20 | Me | Me | CF₃ | (CH₂)ₐ | 0 to 20 | Me | 5 to 100 |
| 793 | Me | (CH₂)ₐ | 0 to 20 | Me | Me | CHF₂ | (CH₂)ₐ | 0 to 20 | Me | 5 to 100 |
| 794 | CF₃ | (CH₂)ₐ | 0 to 20 | Me | Me | CHF₂ | (CH₂)ₐ | 0 to 20 | Me | 5 to 100 |
| 795 | (CF₃)₂CF | (CH₂)ₐ | 0 to 20 | Me | Me | CHF₂ | (CH₂)ₐ | 0 to 20 | Me | 5 to 100 |
| 796 | (CF3)₃C | (CH₂)ₐ | 0 to 20 | Me | Me | CHF₂ | (CH₂)ₐ | 0 to 20 | Me | 5 to 100 |
| 797 | C₄F₉ | (CH₂)ₐ | 0 to 20 | Me | Me | CHF₂ | (CH₂)ₐ | 0 to 20 | Me | 5 to 100 |
| 798 | C₈F₁₇ | (CH₂)ₐ | 0 to 20 | Me | Me | CHF | (CH₂)ₐ | 0 to 20 | Me | 5 to 100 |
| 799 | c-C₆F₁₁ | (CH₂)ₐ | 0 to 20 | Me | Me | CHF₂ | (CH₂)ₐ | 0 to 20 | Me | 5 to 100 |
| 800 | CHF₂ | (CH₂)ₐ | 0 to 20 | Me | Me | CHF₂ | (CH₂)ₐ | 0 to 20 | Me | 5 to 100 |
| 801 | CClF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 791 | 0 | Me | Me | (CH₂)_{b} | 0 to 20 | CH₂ | (CH₂)_{c} | 1 to 20 | Si(OMe)₃ | 1 |
| 792 | 0 | Me | Me | (CH₂)_{b} | 0 to 20 | CH₂ | (CH₂)_{c} | 1 to 20 | Si(OMe)₃ | 1 |
| 793 | 0 | Me | Me | (CH₂)_{b} | 0 to 20 | CH₂ | (CH₂)_{c} | 1 to 20 | Si(OMe)₃ | 1 |
| 794 | 0 | Me | Me | (CH₂)_{b} | 0 to 20 | CH₂ | (CH₂)_{c} | 1 to 20 | Si(OMe)₃ | 1 |
| 795 | 0 | Me | Me | (CH₂)_{b} | 0 to 20 | CH₂ | (CH₂)_{c} | 1 to 20 | Si(OMe)₃ | 1 |
| 796 | 0 | Me | Me | (CH₂)_{b} | 0 to 20 | CH₂ | (CH₂)_{c} | 1 to 20 | Si(OMe)₃ | 1 |
| 797 | 0 | Me | Me | (CH₂)_{b} | 0 to 20 | CH₂ | (CH₂)_{c} | 1 to 20 | Si(OMe)₃ | 1 |
| 798 | 0 | Me | Me | (CH₂)_{b} | 0 to 20 | CH₂ | (CH₂)_{c} | 1 to 20 | Si(OMe)₃ | 1 |
| 799 | 0 | Me | Me | (CH₂)_{b} | 0 to 20 | CH₂ | (CH₂)_{c} | 1 to 20 | Si(OMe)₃ | 1 |
| 800 | 0 | Me | Me | (CH₂)_{b} | 0 to 20 | CH₂ | (CH₂)_{c} | 1 to 20 | Si(OMe)₃ | 1 |
| 801 | 0 | Me | Me | (CH₂)_{b} | 0 to 20 | CH₂ | (CH₂)_{c} | 1 to 20 | Si(OMe)₃ | 1 |

TABLE 158

| No. | R²¹ | | a | R²² | R²³ | R²⁴ | | | R²⁵ | z21 |
|---|---|---|---|---|---|---|---|---|---|---|
| 802 | CBrF₂ | (CH₂)ₐ | 0 to 20 | Me | Me | CHF₂ | (CH₂)ₐ | 0 to 20 | Me | 5 to 100 |
| 803 | ClF₂ | (CH₂)ₐ | 0 to 20 | Me | Me | CHF₂ | (CH₂)ₐ | 0 to 20 | Me | 5 to 100 |
| 804 | CF═CF₂ | (CH₂)ₐ | 0 to 20 | Me | Me | CHF₂ | (CH₂)ₐ | 0 to 20 | Me | 5 to 100 |
| 805 | CF═CFCF₃ | (CH₂)ₐ | 0 to 20 | Me | Me | CHF₂ | (CH₂)ₐ | 0 to 20 | Me | 5 to 100 |
| 806 | CF═CFCF═CF₂ | (CH₂)ₐ | 0 to 20 | Me | Me | CHF₂ | (CH₂)ₐ | 0 to 20 | Me | 5 to 100 |
| 807 | C≡CCF₃ | (CH₂)ₐ | 0 to 20 | Me | Me | CHF₂ | (CH₂)ₐ | 0 to 20 | Me | 5 to 100 |
| 808 | CF₂CH₃ | (CH₂)ₐ | 0 to 20 | Me | Me | CHF₂ | (CH₂)ₐ | 0 to 20 | Me | 5 to 100 |
| 809 | (CF₂)₂H | (CH₂)ₐ | 0 to 20 | Me | Me | CHF₂ | (CH₂)ₐ | 0 to 20 | Me | 5 to 100 |
| 810 | (CF₂)₂CH₃ | (CH₂)ₐ | 0 to 20 | Me | Me | CHF₂ | (CH₂)ₐ | 0 to 20 | Me | 5 to 100 |
| 811 | (CF₂)₄H | (CH₂)ₐ | 0 to 20 | Me | Me | CHF₂ | (CH₂)ₐ | 0 to 20 | Me | 5 to 100 |
| 812 | C₆F₅ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 802 | 0 | Me | Me | (CH₂)_{b} | 0 to 20 | CH₂ | (CH₂)_{c} | 1 to 20 | Si(OMe)₃ | 1 |
| 803 | 0 | Me | Me | (CH₂)_{b} | 0 to 20 | CH₂ | (CH₂)_{c} | 1 to 20 | Si(OMe)₃ | 1 |
| 804 | 0 | Me | Me | (CH₂)_{b} | 0 to 20 | CH₂ | (CH₂)_{c} | 1 to 20 | Si(OMe)₃ | 1 |
| 805 | 0 | Me | Me | (CH₂)_{b} | 0 to 20 | CH₂ | (CH₂)_{c} | 1 to 20 | Si(OMe)₃ | 1 |
| 806 | 0 | Me | Me | (CH₂)_{b} | 0 to 20 | CH₂ | (CH₂)_{c} | 1 to 20 | Si(OMe)₃ | 1 |
| 807 | 0 | Me | Me | (CH₂)_{b} | 0 to 20 | CH₂ | (CH₂)_{c} | 1 to 20 | Si(OMe)₃ | 1 |
| 808 | 0 | Me | Me | (CH₂)_{b} | 0 to 20 | CH₂ | (CH₂)_{c} | 1 to 20 | Si(OMe)₃ | 1 |
| 809 | 0 | Me | Me | (CH₂)_{b} | 0 to 20 | CH₂ | (CH₂)_{c} | 1 to 20 | Si(OMe)₃ | 1 |
| 810 | 0 | Me | Me | (CH₂)_{b} | 0 to 20 | CH₂ | (CH₂)_{c} | 1 to 20 | Si(OMe)₃ | 1 |
| 811 | 0 | Me | Me | (CH₂)_{b} | 0 to 20 | CH₂ | (CH₂)_{c} | 1 to 20 | Si(OMe)₃ | 1 |
| 812 | 0 | Me | Me | (CH₂)_{b} | 0 to 20 | CH₂ | (CH₂)_{c} | 1 to 20 | Si(OMe)₃ | 1 |

TABLE 159

| No. | R²¹ | | a | R²² | R²³ | R²⁴ | | | R²⁵ | z21 |
|---|---|---|---|---|---|---|---|---|---|---|
| 813 | 4-CF₃C₆F₄ | (CH₂)ₐ | 0 to 20 | Me | Me | CHF₂ | (CH₂)ₐ | 0 to 20 | Me | 5 to 100 |
| 814 | 4-SF₅C₆F₄ | (CH₂)ₐ | 0 to 20 | Me | Me | CHF₂ | (CH₂)ₐ | 0 to 20 | Me | 5 to 100 |
| 815 | 3,5-CF₃C₆F₃ | (CH₂)ₐ | 0 to 20 | Me | Me | CHF₂ | (CH₂)ₐ | 0 to 20 | Me | 5 to 100 |
| 816 | 3,5-SF₅C₆F₃ | (CH₂)ₐ | 0 to 20 | Me | Me | CHF₂ | (CH₂)ₐ | 0 to 20 | Me | 5 to 100 |
| 817 | 4-CF₃C₆H₄ | (CH₂)ₐ | 0 to 20 | Me | Me | CHF₂ | (CH₂)ₐ | 0 to 20 | Me | 5 to 100 |
| 818 | 4-SF₅C₆H₄ | (CH₂)ₐ | 0 to 20 | Me | Me | CHF₂ | (CH₂)ₐ | 0 to 20 | Me | 5 to 100 |
| 819 | 3,5-CF₃C₆H₃ | (CH₂)ₐ | 0 to 20 | Me | Me | CHF₂ | (CH₂)ₐ | 0 to 20 | Me | 5 to 100 |
| 820 | 3,5-SF₅C₆H₃ | (CH₂)ₐ | 0 to 20 | Me | Me | CHF₂ | (CH₂)ₐ | 0 to 20 | Me | 5 to 100 |
| 821 | 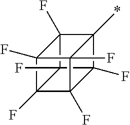 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 |
| 822 | 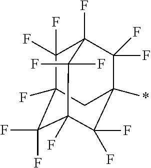 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 |
| 823 | 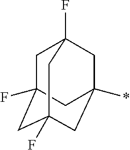 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 |
| No. | z22 | R²⁸ | R²⁹ | R¹ | b | L¹ | R² | c | T¹ | x1 |
| 813 | 0 | Me | Me | (CH₂)_{b} | 0 to 20 | CH₂ | (CH₂)_{c} | 1 to 20 | Si(OMe)₃ | 1 |
| 814 | 0 | Me | Me | (CH₂)_{b} | 0 to 20 | CH₂ | (CH₂)_{c} | 1 to 20 | Si(OMe)₃ | 1 |
| 815 | 0 | Me | Me | (CH₂)_{b} | 0 to 20 | CH₂ | (CH₂)_{c} | 1 to 20 | Si(OMe)₃ | 1 |
| 816 | 0 | Me | Me | (CH₂)_{b} | 0 to 20 | CH₂ | (CH₂)_{c} | 1 to 20 | Si(OMe)₃ | 1 |
| 817 | 0 | Me | Me | (CH₂)_{b} | 0 to 20 | CH₂ | (CH₂)_{c} | 1 to 20 | Si(OMe)₃ | 1 |
| 818 | 0 | Me | Me | (CH₂)_{b} | 0 to 20 | CH₂ | (CH₂)_{c} | 1 to 20 | Si(OMe)₃ | 1 |
| 819 | 0 | Me | Me | (CH₂)_{b} | 0 to 20 | CH₂ | (CH₂)_{c} | 1 to 20 | Si(OMe)₃ | 1 |
| 820 | 0 | Me | Me | (CH₂)_{b} | 0 to 20 | CH₂ | (CH₂)_{c} | 1 to 20 | Si(OMe)₃ | 1 |
| 821 | 0 | Me | Me | (CH₂)_{b} | 0 to 20 | CH₂ | (CH₂)_{c} | 1 to 20 | Si(OMe)₃ | 1 |
| 822 | 0 | Me | Me | (CH₂)_{b} | 0 to 20 | CH₂ | (CH₂)_{c} | 1 to 20 | Si(OMe)₃ | 1 |
| 823 | 0 | Me | Me | (CH₂)_{b} | 0 to 20 | CH₂ | (CH₂)_{c} | 1 to 20 | Si(OMe)₃ | 1 |

TABLE 160

| No. | R²¹ | | a | R²² | R²³ | R²⁴ | | | R²⁵ | z21 |
|---|---|---|---|---|---|---|---|---|---|---|
| 824 | SF₅ | (CH₂)ₐ | 0 to 20 | Me | Me | CHF₂ | (CH₂)ₐ | 0 to 20 | Me | 5 to 100 |
| 825 | OCF₃ | (CH₂)ₐ | 0 to 20 | Me | Me | CHF₂ | (CH₂)ₐ | 0 to 20 | Me | 5 to 100 |
| 826 | SCF₃ | (CH₂)ₐ | 0 to 20 | Me | Me | CHF₂ | (CH₂)ₐ | 0 to 20 | Me | 5 to 100 |
| 827 | N(CH₂CF₃)₂ | (CH₂)ₐ | 0 to 20 | Me | Me | CHF₂ | (CH₂)ₐ | 0 to 20 | Me | 5 to 100 |
| 828 | N(CF₃)₂ | (CH₂)ₐ | 0 to 20 | Me | Me | CHF₂ | (CH₂)ₐ | 0 to 20 | Me | 5 to 100 |
| 829 | Me | (CH₂)ₐ | 0 to 20 | Me | Me | 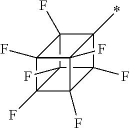 [SMILES: *C12C3(F)C4(F)C1(F)C1(F)C2(F)C3(F)C41F] | (CH₂)ₐ | 0 to 20 | Me | 5 to 100 |
| 830 | CF₃ | (CH₂)ₐ | 0 to 20 | Me | Me | 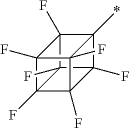 [SMILES: *C12C3(F)C4(F)C1(F)C1(F)C2(F)C3(F)C41F] | (CH₂)ₐ | 0 to 20 | Me | 5 to 100 |
| 831 | (CF₃)₂CF | (CH₂)ₐ | 0 to 20 | Me | Me | 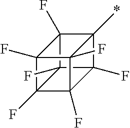 [SMILES: *C12C3(F)C4(F)C1(F)C1(F)C2(F)C3(F)C41F] | (CH₂)ₐ | 0 to 20 | Me | 5 to 100 |
| 832 | (CF₃)₃C | (CH₂)ₐ | 0 to 20 | Me | Me | 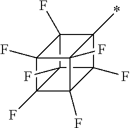 [SMILES: *C12C3(F)C4(F)C1(F)C1(F)C2(F)C3(F)C41F] | (CH₂)ₐ | 0 to 20 | Me | 5 to 100 |
| 833 | C₄F₉ | (CH₂)ₐ | 0 to 20 | Me | Me | 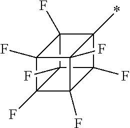 [SMILES: *C12C3(F)C4(F)C1(F)C1(F)C2(F)C3(F)C41F] | (CH₂)ₐ | 0 to 20 | Me | 5 to 100 |
| 834 | C₈F₁₇ | (CH₂)ₐ | 0 to 20 | Me | Me | 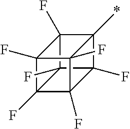 [SMILES: *C12C3(F)C4(F)C1(F)C1(F)C2(F)C3(F)C41F] | (CH₂)ₐ | 0 to 20 | Me | 5 to 100 |
| No. | z22 | R²⁸ | R²⁹ | R¹ | b | L¹ | R² | c | T¹ | x1 |
| 824 | 0 | Me | Me | (CH₂)_{b} | 0 to 20 | CH₂ | (CH₂)_{c} | 1 to 20 | Si(OMe)₃ | 1 |
| 825 | 0 | Me | Me | (CH₂)_{b} | 0 to 20 | CH₂ | (CH₂)_{c} | 1 to 20 | Si(OMe)₃ | 1 |
| 826 | 0 | Me | Me | (CH₂)_{b} | 0 to 20 | CH₂ | (CH₂)_{c} | 1 to 20 | Si(OMe)₃ | 1 |
| 827 | 0 | Me | Me | (CH₂)_{b} | 0 to 20 | CH₂ | (CH₂)_{c} | 1 to 20 | Si(OMe)₃ | 1 |
| 828 | 0 | Me | Me | (CH₂)_{b} | 0 to 20 | CH₂ | (CH₂)_{c} | 1 to 20 | Si(OMe)₃ | 1 |
| 829 | 0 | Me | Me | (CH₂)_{b} | 0 to 20 | CH₂ | (CH₂)_{c} | 1 to 20 | Si(OMe)₃ | 1 |
| 830 | 0 | Me | Me | (CH₂)_{b} | 0 to 20 | CH₂ | (CH₂)_{c} | 1 to 20 | Si(OMe)₃ | 1 |
| 831 | 0 | Me | Me | (CH₂)_{b} | 0 to 20 | CH₂ | (CH₂)_{c} | 1 to 20 | Si(OMe)₃ | 1 |
| 832 | 0 | Me | Me | (CH₂)_{b} | 0 to 20 | CH₂ | (CH₂)_{c} | 1 to 20 | Si(OMe)₃ | 1 |
| 833 | 0 | Me | Me | (CH₂)_{b} | 0 to 20 | CH₂ | (CH₂)_{c} | 1 to 20 | Si(OMe)₃ | 1 |
| 834 | 0 | Me | Me | (CH₂)_{b} | 0 to 20 | CH₂ | (CH₂)_{c} | 1 to 20 | Si(OMe)₃ | 1 |

TABLE 161

| No. | R²¹ | | a | R²² | R²³ | R²⁴ | | | R²⁵ | z21 |
|---|---|---|---|---|---|---|---|---|---|---|
| 835 | c-C₆F₁₁ | (CH₂)ₐ | 0 to 20 | Me | Me | 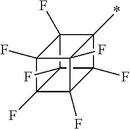 [SMILES: *C12C3(F)C4(F)C1(F)C1(F)C2(F)C3(F)C41F] | (CH₂)ₐ | 0 to 20 | Me | 5 to 100 |
| 836 | CHF₂ | (CH₂)ₐ | 0 to 20 | Me | Me | 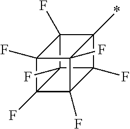 [SMILES: *C12C3(F)C4(F)C1(F)C1(F)C2(F)C3(F)C41F] | (CH₂)ₐ | 0 to 20 | Me | 5 to 100 |
| 837 | CCIF₂ | (CH₂)ₐ | 0 to 20 | Me | Me | 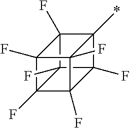 [SMILES: *C12C3(F)C4(F)C1(F)C1(F)C2(F)C3(F)C41F] | (CH₂)ₐ | 0 to 20 | Me | 5 to 100 |
| 838 | CBrF₂ | (CH₂)ₐ | 0 to 20 | Me | Me | 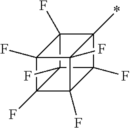 [SMILES: *C12C3(F)C4(F)C1(F)C1(F)C2(F)C3(F)C41F] | (CH₂)ₐ | 0 to 20 | Me | 5 to 100 |
| 839 | CIF₂ | (CH₂)ₐ | 0 to 20 | Me | Me | 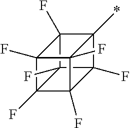 [SMILES: *C12C3(F)C4(F)C1(F)C1(F)C2(F)C3(F)C41F] | (CH₂)ₐ | 0 to 20 | Me | 5 to 100 |
| 840 | CF═CF₂ | (CH₂)ₐ | 0 to 20 | Me | Me | 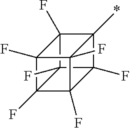 [SMILES: *C12C3(F)C4(F)C1(F)C1(F)C2(F)C3(F)C41F] | (CH₂)ₐ | 0 to 20 | Me | 5 to 100 |
| 841 | CF═CFCF₃ | (CH₂)ₐ | 0 to 20 | Me | Me | 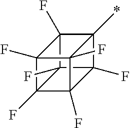 [SMILES: *C12C3(F)C4(F)C1(F)C1(F)C2(F)C3(F)C41F] | (CH₂)ₐ | 0 to 20 | Me | 5 to 100 |
| 842 | CF═CFCF═CF₂ | (CH₂)ₐ | 0 to 20 | Me | Me | 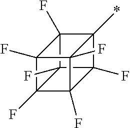 [SMILES: *C12C3(F)C4(F)C1(F)C1(F)C2(F)C3(F)C41F] | (CH₂)ₐ | 0 to 20 | Me | 5 to 100 |
| 843 | C═CCF₃ | (CH₂)ₐ | 0 to 20 | Me | Me | 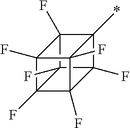 [SMILES: *C12C3(F)C4(F)C1(F)C1(F)C2(F)C3(F)C41F] | (CH₂)ₐ | 0 to 20 | Me | 5 to 100 |
| 844 | CF₂CH | (CH₂)ₐ | 0 to 20 | Me | Me | 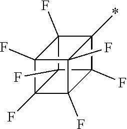 [SMILES: *C12C3(F)C4(F)C1(F)C1(F)C2(F)C3(F)C41F] | (CH₂)ₐ | 0 to 20 | Me | 5 to 100 |
| 845 | (CF₂)₂H | (CH₂)ₐ | 0 to 20 | Me | Me | 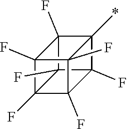 [SMILES: *C12C3(F)C4(F)C1(F)C1(F)C2(F)C3(F)C41F] | (CH₂)ₐ | 0 to 20 | Me | 5 to 100 |
| No. | z22 | R28 | R29 | R1 | b | L1 | R² | c | T1 | x1 |
| 835 | 0 | Me | Me | (CH₂)_{b} | 0 to 20 | CH₂ | (CH₂)_{c} | 1 to 20 | Si(OMe)₃ | 1 |
| 836 | 0 | Me | Me | (CH₂)_{b} | 0 to 20 | CH₂ | (CH₂)_{c} | 1 to 20 | Si(OMe)₃ | 1 |
| 837 | 0 | Me | Me | (CH₂)_{b} | 0 to 20 | CH₂ | (CH₂)_{c} | 1 to 20 | Si(OMe)₃ | 1 |
| 838 | 0 | Me | Me | (CH₂)_{b} | 0 to 20 | CH₂ | (CH₂)_{c} | 1 to 20 | Si(OMe)₃ | 1 |
| 839 | 0 | Me | Me | (CH₂)_{b} | 0 to 20 | CH₂ | (CH₂)_{c} | 1 to 20 | Si(OMe)₃ | 1 |
| 840 | 0 | Me | Me | (CH₂)_{b} | 0 to 20 | CH₂ | (CH₂)_{c} | 1 to 20 | Si(OMe)₃ | 1 |
| 841 | 0 | Me | Me | (CH₂)_{b} | 0 to 20 | CH₂ | (CH₂)_{c} | 1 to 20 | Si(OMe)₃ | 1 |
| 842 | 0 | Me | Me | (CH₂)_{b} | 0 to 20 | CH₂ | (CH₂)_{c} | 1 to 20 | Si(OMe)₃ | 1 |
| 843 | 0 | Me | Me | (CH₂)_{b} | 0 to 20 | CH₂ | (CH₂)_{c} | 1 to 20 | Si(OMe)₃ | 1 |
| 844 | 0 | Me | Me | (CH₂)_{b} | 0 to 20 | CH₂ | (CH₂)_{c} | 1 to 20 | Si(OMe)₃ | 1 |
| 845 | 0 | Me | Me | (CH₂)_{b} | 0 to 20 | CH₂ | (CH₂)_{c} | 1 to 20 | Si(OMe)₃ | 1 |

TABLE 162

| No. | R²¹ | | a | R²² | R²³ | R²⁴ | | | R²⁵ | z21 |
|---|---|---|---|---|---|---|---|---|---|---|
| 846 | (CF₂)₂CH₃ | (CH₂)ₐ | 0 to 20 | Me | Me | 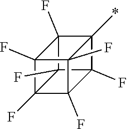 [SMILES: *C12C3(F)C4(F)C1(F)C1(F)C2(F)C3(F)C41F] | (CH₂)ₐ | 0 to 20 | Me | 5 to 100 |
| 847 | (CF₂)₄H | (CH₂)ₐ | 0 to 20 | Me | Me | 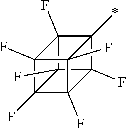 [SMILES: *C12C3(F)C4(F)C1(F)C1(F)C2(F)C3(F)C41F] | (CH₂)ₐ | 0 to 20 | Me | 5 to 100 |
| 848 | C₆F₅ | (CH₂)ₐ | 0 to 20 | Me | Me | 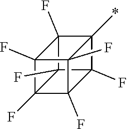 [SMILES: *C12C3(F)C4(F)C1(F)C1(F)C2(F)C3(F)C41F] | (CH₂)ₐ | 0 to 20 | Me | 5 to 100 |
| 849 | 4-CF₃C₆F₄ | (CH₂)ₐ | 0 to 20 | Me | Me | 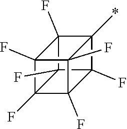 [SMILES: *C12C3(F)C4(F)C1(F)C1(F)C2(F)C3(F)C41F] | (CH₂)ₐ | 0 to 20 | Me | 5 to 100 |
| 850 | 4-SF₅C₆F₄ | (CH₂)ₐ | 0 to 20 | Me | Me | 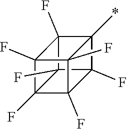 [SMILES: *C12C3(F)C4(F)C1(F)C1(F)C2(F)C3(F)C41F] | (CH₂)ₐ | 0 to 20 | Me | 5 to 100 |
| 851 | 3,5-CF₃C₆F₃ | (CH₂)ₐ | 0 to 20 | Me | Me | 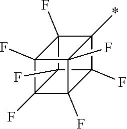 [SMILES: *C12C3(F)C4(F)C1(F)C1(F)C2(F)C3(F)C41F] | (CH₂)ₐ | 0 to 20 | Me | 5 to 100 |
| 852 | 3,5-SF₅C₆F₃ | (CH₂)ₐ | 0 to 20 | Me | Me | 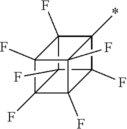 [SMILES: *C12C3(F)C4(F)C1(F)C1(F)C2(F)C3(F)C41F] | (CH₂)ₐ | 0 to 20 | Me | 5 to 100 |
| 853 | 4-CF₃C₆H₄ | (CH₂)ₐ | 0 to 20 | Me | Me | 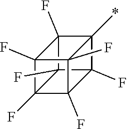 [SMILES: *C12C3(F)C4(F)C1(F)C1(F)C2(F)C3(F)C41F] | (CH₂)ₐ | 0 to 20 | Me | 5 to 100 |
| 854 | 4-SF₅C₆H₄ | (CH₂)ₐ | 0 to 20 | Me | Me | 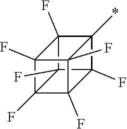 [SMILES: *C12C3(F)C4(F)C1(F)C1(F)C2(F)C3(F)C41F] | (CH₂)ₐ | 0 to 20 | Me | 5 to 100 |
| 855 | 3,5-CF₃C₆H₃ | (CH₂)ₐ | 0 to 20 | Me | Me | 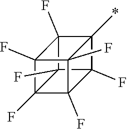 [SMILES: *C12C3(F)C4(F)C1(F)C1(F)C2(F)C3(F)C41F] | (CH₂)ₐ | 0 to 20 | Me | 5 to 100 |
| 856 | 3,5-SF₅C₆H₃ | (CH₂)ₐ | 0 to 20 | Me | Me | 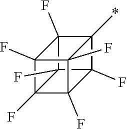 [SMILES: *C12C3(F)C4(F)C1(F)C1(F)C2(F)C3(F)C41F] | (CH₂)ₐ | 0 to 20 | Me | 5 to 100 |
| No. | z22 | R²⁸ | R²⁹ | R¹ | b | L¹ | R² | c | T¹ | x1 |
| 846 | 0 | Me | Me | (CH₂)_{b} | 0 to 20 | CH₂ | (CH₂)_{c} | 1 to 20 | Si(OMe)₃ | 1 |
| 847 | 0 | Me | Me | (CH₂)_{b} | 0 to 20 | CH₂ | (CH₂)_{c} | 1 to 20 | Si(OMe)₃ | 1 |
| 848 | 0 | Me | Me | (CH₂)_{b} | 0 to 20 | CH₂ | (CH₂)_{c} | 1 to 20 | Si(OMe)₃ | 1 |
| 849 | 0 | Me | Me | (CH₂)_{b} | 0 to 20 | CH₂ | (CH₂)_{c} | 1 to 20 | Si(OMe)₃ | 1 |
| 850 | 0 | Me | Me | (CH₂)_{b} | 0 to 20 | CH₂ | (CH₂)_{c} | 1 to 20 | Si(OMe)₃ | 1 |
| 851 | 0 | Me | Me | (CH₂)_{b} | 0 to 20 | CH₂ | (CH₂)_{c} | 1 to 20 | Si(OMe)₃ | 1 |
| 852 | 0 | Me | Me | (CH₂)_{b} | 0 to 20 | CH₂ | (CH₂)_{c} | 1 to 20 | Si(OMe)₃ | 1 |
| 853 | 0 | Me | Me | (CH₂)_{b} | 0 to 20 | CH₂ | (CH₂)_{c} | 1 to 20 | Si(OMe)₃ | 1 |
| 854 | 0 | Me | Me | (CH₂)_{b} | 0 to 20 | CH₂ | (CH₂)_{c} | 1 to 20 | Si(OMe)₃ | 1 |
| 855 | 0 | Me | Me | (CH₂)_{b} | 0 to 20 | CH₂ | (CH₂)_{c} | 1 to 20 | Si(OMe)₃ | 1 |
| 856 | 0 | Me | Me | (CH₂)_{b} | 0 to 20 | CH₂ | (CH₂)_{c} | 1 to 20 | Si(OMe)₃ | 1 |

TABLE 163

| No. | R²¹ | | a | R²² | R²³ | R²⁴ | | | R²⁵ | z21 |
|---|---|---|---|---|---|---|---|---|---|---|
| 857 | 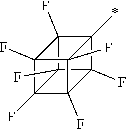 [SMILES: *C12C3(F)C4(F)C1(F)C1(F)C2(F)C3(F)C41F] | (CH₂)ₐ | 0 to 20 | Me | Me | 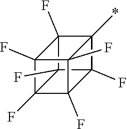 [SMILES: *C12C3(F)C4(F)C1(F)C1(F)C2(F)C3(F)C41F] | (CH₂)ₐ | 0 to 20 | Me | 5 to 100 |
| 858 | 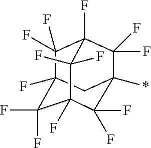 [SMILES: *C12CC3(F)C(F)(F)C(F)(C1(F)F)C(F)(F)C(F)(C2(F)F)C3(F)F] | (CH₂)ₐ | 0 to 20 | Me | Me | 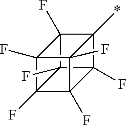 [SMILES: *C12C3(F)C4(F)C1(F)C1(F)C2(F)C3(F)C41F] | (CH₂)ₐ | 0 to 20 | Me | 5 to 100 |
| 859 | 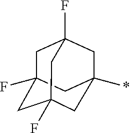 [SMILES: *C12CC3(F)CC(F)(C1)CC(F)(C2)C3] | (CH₂)ₐ | 0 to 20 | Me | Me | 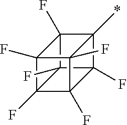 [SMILES: *C12C3(F)C4(F)C1(F)C1(F)C2(F)C3(F)C41F] | (CH₂)ₐ | 0 to 20 | Me | 5 to 100 |
| 860 | SF₅ | (CH₂)ₐ | 0 to 20 | Me | Me | 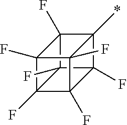 [SMILES: *C12C3(F)C4(F)C1(F)C1(F)C2(F)C3(F)C41F] | (CH₂)ₐ | 0 to 20 | Me | 5 to 100 |
| 861 | OCF₃ | (CH₂)ₐ | 0 to 20 | Me | Me | 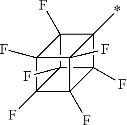 [SMILES: *C12C3(F)C4(F)C1(F)C1(F)C2(F)C3(F)C41F] | (CH₂)ₐ | 0 to 20 | Me | 5 to 100 |
| 862 | SCF₃ | (CH₂)ₐ | 0 to 20 | Me | Me | 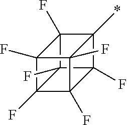 [SMILES: *C12C3(F)C4(F)C1(F)C1(F)C2(F)C3(F)C41F] | (CH₂)ₐ | 0 to 20 | Me | 5 to 100 |
| 863 | N(CH₂CF₃)₂ | (CH₂)ₐ | 0 to 20 | Me | Me | 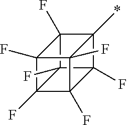 [SMILES: *C12C3(F)C4(F)C1(F)C1(F)C2(F)C3(F)C41F] | (CH₂)ₐ | 0 to 20 | Me | 5 to 100 |
| 864 | N(CF₃)₂ | (CH₂)ₐ | 0 to 20 | Me | Me | 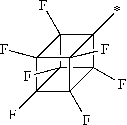 [SMILES: *C12C3(F)C4(F)C1(F)C1(F)C2(F)C3(F)C41F] | (CH₂)ₐ | 0 to 20 | Me | 5 to 100 |
| 865 | Me | (CH₂)ₐ | 0 to 20 | Me | Me | SF₅ | (CH₂)ₐ | 0 to 20 | Me | 5 to 100 |
| 866 | CF₃ | (CH₂)ₐ | 0 to 20 | Me | Me | SF₅ | (CH₂)ₐ | 0 to 20 | Me | 5 to 100 |
| 867 | (CF₃)₂CF | (CH₂)ₐ | 0 to 20 | Me | Me | SF₅ | (CH₂)ₐ | 0 to 20 | Me | 5 to 100 |
| No. | z22 | R²⁸ | R²⁹ | R¹ | b | L¹ | R² | c | T¹ | x1 |
| 857 | 0 | Me | Me | (CH₂)_{b} | 0 to 20 | CH₂ | (CH₂)_{c} | 1 to 20 | Si(OMe)₃ | 1 |
| 858 | 0 | Me | Me | (CH₂)_{b} | 0 to 20 | CH₂ | (CH₂)_{c} | 1 to 20 | Si(OMe)₃ | 1 |
| 859 | 0 | Me | Me | (CH₂)_{b} | 0 to 20 | CH₂ | (CH₂)_{c} | 1 to 20 | Si(OMe)₃ | 1 |
| 860 | 0 | Me | Me | (CH₂)_{b} | 0 to 20 | CH₂ | (CH₂)_{c} | 1 to 20 | Si(OMe)₃ | 1 |
| 861 | 0 | Me | Me | (CH₂)_{b} | 0 to 20 | CH₂ | (CH₂)_{c} | 1 to 20 | Si(OMe)₃ | 1 |
| 862 | 0 | Me | Me | (CH₂)_{b} | 0 to 20 | CH₂ | (CH₂)_{c} | 1 to 20 | Si(OMe)₃ | 1 |
| 863 | 0 | Me | Me | (CH₂)_{b} | 0 to 20 | CH₂ | (CH₂)_{c} | 1 to 20 | Si(OMe)₃ | 1 |
| 864 | 0 | Me | Me | (CH₂)_{b} | 0 to 20 | CH₂ | (CH₂)_{c} | 1 to 20 | Si(OMe)₃ | 1 |
| 865 | 0 | Me | Me | (CH₂)_{b} | 0 to 20 | CH₂ | (CH₂)_{c} | 1 to 20 | Si(OMe)₃ | 1 |
| 866 | 0 | Me | Me | (CH₂)_{b} | 0 to 20 | CH₂ | (CH₂)_{c} | 1 to 20 | Si(OMe)₃ | 1 |
| 867 | 0 | Me | Me | (CH₂)_{b} | 0 to 20 | CH₂ | (CH₂)_{c} | 1 to 20 | Si(OMe)₃ | 1 |

TABLE 164

| No. | R²¹ | | a | R²² | R²³ | R²⁴ | | | R²⁵ | z21 |
|---|---|---|---|---|---|---|---|---|---|---|
| 868 | (CF₃)₃C | (CH₂)ₐ | 0 to 20 | Me | Me | SF₅ | (CH₂)ₐ | 0 to 20 | Me | 5 to 100 |
| 869 | C₄F₉ | (CH₂)ₐ | 0 to 20 | Me | Me | SF₅ | (CH₂)ₐ | 0 to 20 | Me | 5 to 100 |
| 870 | C₈F₁₇ | (CH₂)ₐ | 0 to 20 | Me | Me | SF₅ | (CH₂)ₐ | 0 to 20 | Me | 5 to 100 |
| 871 | c-C₆F₁₁ | (CH₂)ₐ | 0 to 20 | Me | Me | SF₅ | (CH₂)ₐ | 0 to 20 | Me | 5 to 100 |
| 872 | CHF₂ | (CH₂)ₐ | 0 to 20 | Me | Me | SF₅ | (CH₂)ₐ | 0 to 20 | Me | 5 to 100 |
| 873 | CClF₂ | (CH₂)ₐ | 0 to 20 | Me | Me | SF₅ | (CH₂)ₐ | 0 to 20 | Me | 5 to 100 |
| 874 | CBrF₂ | (CH₂)ₐ | 0 to 20 | Me | Me | SF₅ | (CH₂)ₐ | 0 to 20 | Me | 5 to 100 |
| 875 | ClF₂ | (CH₂)ₐ | 0 to 20 | Me | Me | SF₅ | (CH₂)ₐ | 0 to 20 | Me | 5 to 100 |
| 876 | CF═CF₂ | (CH₂)ₐ | 0 to 20 | Me | Me | SF₅ | (CH₂)ₐ | 0 to 20 | Me | 5 to 100 |
| 877 | CF═CFCF₃ | (CH₂)ₐ | 0 to 20 | Me | Me | SF₅ | (CH₂)ₐ | 0 to 20 | Me | 5 to 100 |
| 878 | CF═CFCF═CF₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 868 | 0 | Me | Me | (CH₂)_{b} | 0 to 20 | CH₂ | (CH₂)_{c} | 1 to 20 | Si(OMe)₃ | 1 |
| 869 | 0 | Me | Me | (CH₂)_{b} | 0 to 20 | CH₂ | (CH₂)_{c} | 1 to 20 | Si(OMe)₃ | 1 |
| 870 | 0 | Me | Me | (CH₂)_{b} | 0 to 20 | CH₂ | (CH₂)_{c} | 1 to 20 | Si(OMe)₃ | 1 |
| 871 | 0 | Me | Me | (CH₂)_{b} | 0 to 20 | CH₂ | (CH₂)_{c} | 1 to 20 | Si(OMe)₃ | 1 |
| 872 | 0 | Me | Me | (CH₂)_{b} | 0 to 20 | CH₂ | (CH₂)_{c} | 1 to 20 | Si(OMe)₃ | 1 |
| 873 | 0 | Me | Me | (CH₂)_{b} | 0 to 20 | CH₂ | (CH₂)_{c} | 1 to 20 | Si(OMe)₃ | 1 |
| 874 | 0 | Me | Me | (CH₂)_{b} | 0 to 20 | CH₂ | (CH₂)_{c} | 1 to 20 | Si(OMe)₃ | 1 |
| 875 | 0 | Me | Me | (CH₂)_{b} | 0 to 20 | CH₂ | (CH₂)_{c} | 1 to 20 | Si(OMe)₃ | 1 |
| 876 | 0 | Me | Me | (CH₂)_{b} | 0 to 20 | CH₂ | (CH₂)_{c} | 1 to 20 | Si(OMe)₃ | 1 |
| 877 | 0 | Me | Me | (CH₂)_{b} | 0 to 20 | CH₂ | (CH₂)_{c} | 1 to 20 | Si(OMe)₃ | 1 |
| 878 | 0 | Me | Me | (CH₂)_{b} | 0 to 20 | CH₂ | (CH₂)_{c} | 1 to 20 | Si(OMe)₃ | 1 |

TABLE 165

| No. | R²¹ | | a | R²² | R²³ | R²⁴ | | | R²⁵ | z21 |
|---|---|---|---|---|---|---|---|---|---|---|
| 879 | C≡CCF₃ | (CH₂)ₐ | 0 to 20 | Me | Me | SF₅ | (CH₂)ₐ | 0 to 20 | Me | 5 to 100 |
| 880 | CF₂CH₃ | (CH₂)ₐ | 0 to 20 | Me | Me | SF₅ | (CH₂)ₐ | 0 to 20 | Me | 5 to 100 |
| 881 | (CF₂)₂H | (CH₂)ₐ | 0 to 20 | Me | Me | SF₅ | (CH₂)ₐ | 0 to 20 | Me | 5 to 100 |
| 882 | (CF₂)₂CH₃ | (CH₂)ₐ | 0 to 20 | Me | Me | SF₅ | (CH₂)ₐ | 0 to 20 | Me | 5 to 100 |
| 883 | (CF₂)₄H | (CH₂)ₐ | 0 to 20 | Me | Me | SF₅ | (CH₂)ₐ | 0 to 20 | Me | 5 to 100 |
| 884 | C₆F₅ | (CH₂)ₐ | 0 to 20 | Me | Me | SF₅ | (CH₂)ₐ | 0 to 20 | Me | 5 to 100 |
| 885 | 4-CF₃C₆F₄ | (CH₂)ₐ | 0 to 20 | Me | Me | SF₅ | (CH₂)ₐ | 0 to 20 | Me | 5 to 100 |
| 886 | 4-SF₅C₆F₄ | (CH₂)ₐ | 0 to 20 | Me | Me | SF₅ | (CH₂)ₐ | 0 to 20 | Me | 5 to 100 |
| 887 | 3,5-CF₃C₆F₃ | (CH₂)ₐ | 0 to 20 | Me | Me | SF₅ | (CH₂)ₐ | 0 to 20 | Me | 5 to 100 |
| 888 | 3,5-SF₅C₆F₃ | (CH₂)ₐ | 0 to 20 | Me | Me | SF₅ | (CH₂)ₐ | 0 to 20 | Me | 5 to 100 |
| 889 | 4-CF₃C₆H₄ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 879 | 0 | Me | Me | (CH₂)_{b} | 0 to 20 | CH₂ | (CH₂)_{c} | 1 to 20 | Si(OMe)₃ | 1 |
| 880 | 0 | Me | Me | (CH₂)_{b} | 0 to 20 | CH₂ | (CH₂)_{c} | 1 to 20 | Si(OMe)₃ | 1 |
| 881 | 0 | Me | Me | (CH₂)_{b} | 0 to 20 | CH₂ | (CH₂)_{c} | 1 to 20 | Si(OMe)₃ | 1 |
| 882 | 0 | Me | Me | (CH₂)_{b} | 0 to 20 | CH₂ | (CH₂)_{c} | 1 to 20 | Si(OMe)₃ | 1 |
| 883 | 0 | Me | Me | (CH₂)_{b} | 0 to 20 | CH₂ | (CH₂)_{c} | 1 to 20 | Si(OMe)₃ | 1 |
| 884 | 0 | Me | Me | (CH₂)_{b} | 0 to 20 | CH₂ | (CH₂)_{c} | 1 to 20 | Si(OMe)₃ | 1 |
| 885 | 0 | Me | Me | (CH₂)_{b} | 0 to 20 | CH₂ | (CH₂)_{c} | 1 to 20 | Si(OMe)₃ | 1 |
| 886 | 0 | Me | Me | (CH₂)_{b} | 0 to 20 | CH₂ | (CH₂)_{c} | 1 to 20 | Si(OMe)₃ | 1 |
| 887 | 0 | Me | Me | (CH₂)_{b} | 0 to 20 | CH₂ | (CH₂)_{c} | 1 to 20 | Si(OMe)₃ | 1 |
| 888 | 0 | Me | Me | (CH₂)_{b} | 0 to 20 | CH₂ | (CH₂)_{c} | 1 to 20 | Si(OMe)₃ | 1 |
| 889 | 0 | Me | Me | (CH₂)_{b} | 0 to 20 | CH₂ | (CH₂)_{c} | 1 to 20 | Si(OMe)₃ | 1 |

TABLE 166

| No. | R²¹ | | a | R²² | R²³ | R²⁴ | | | R²⁵ | z21 |
|---|---|---|---|---|---|---|---|---|---|---|
| 890 | 4-SF₅C₆H₄ | (CH₂)ₐ | 0 to 20 | Me | Me | SF₅ | (CH₂)ₐ | 0 to 20 | Me | 5 to 100 |
| 891 | 3,5-CF₃C₆H₃ | (CH₂)ₐ | 0 to 20 | Me | Me | SF₅ | (CH₂)ₐ | 0 to 20 | Me | 5 to 100 |
| 892 | 3,5-SF₅C₆H₃ | (CH₂)ₐ | 0 to 20 | Me | Me | SF₅ | (CH₂)ₐ | 0 to 20 | Me | 5 to 100 |
| 893 | 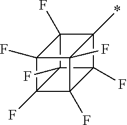 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 |
| 894 | 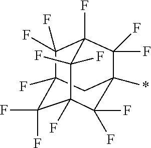 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 |
| 895 | 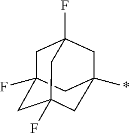 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 |
| 896 | SF₅ | (CH₂)ₐ | 0 to 20 | Me | Me | SF₅ | (CH₂)ₐ | 0 to 20 | Me | 5 to 100 |
| 897 | OCF₃ | (CH₂)ₐ | 0 to 20 | Me | Me | SF₅ | (CH₂)ₐ | 0 to 20 | Me | 5 to 100 |
| 898 | SCF₃ | (CH₂)ₐ | 0 to 20 | Me | Me | SF₅ | (CH₂)ₐ | 0 to 20 | Me | 5 to 100 |
| 899 | N(CH₂CF₃)₂ | (CH₂)ₐ | 0 to 20 | Me | Me | SF₅ | (CH₂)ₐ | 0 to 20 | Me | 5 to 100 |
| 900 | N(CF₃)₂ | (CH₂)ₐ | 0 to 20 | Me | Me | SF₅ | (CH₂)ₐ | 0 to 20 | Me | 5 to 100 |
| No. | z22 | R²⁸ | R²⁹ | R¹ | b | L¹ | R² | c | T¹ | x1 |
| 890 | 0 | Me | Me | (CH₂)_{b} | 0 to 20 | CH₂ | (CH₂)_{c} | 1 to 20 | Si(OMe)₃ | 1 |
| 891 | 0 | Me | Me | (CH₂)_{b} | 0 to 20 | CH₂ | (CH₂)_{c} | 1 to 20 | Si(OMe)₃ | 1 |
| 892 | 0 | Me | Me | (CH₂)_{b} | 0 to 20 | CH₂ | (CH₂)_{c} | 1 to 20 | Si(OMe)₃ | 1 |
| 893 | 0 | Me | Me | (CH₂)_{b} | 0 to 20 | CH₂ | (CH₂)_{c} | 1 to 20 | Si(OMe)₃ | 1 |
| 894 | 0 | Me | Me | (CH₂)_{b} | 0 to 20 | CH₂ | (CH₂)_{c} | 1 to 20 | Si(OMe)₃ | 1 |
| 895 | 0 | Me | Me | (CH₂)_{b} | 0 to 20 | CH₂ | (CH₂)_{c} | 1 to 20 | Si(OMe)₃ | 1 |
| 896 | 0 | Me | Me | (CH₂)_{b} | 0 to 20 | CH₂ | (CH₂)_{c} | 1 to 20 | Si(OMe)₃ | 1 |
| 897 | 0 | Me | Me | (CH₂)_{b} | 0 to 20 | CH₂ | (CH₂)_{c} | 1 to 20 | Si(OMe)₃ | 1 |
| 898 | 0 | Me | Me | (CH₂)_{b} | 0 to 20 | CH₂ | (CH₂)_{c} | 1 to 20 | Si(OMe)₃ | 1 |
| 899 | 0 | Me | Me | (CH₂)_{b} | 0 to 20 | CH₂ | (CH₂)_{c} | 1 to 20 | Si(OMe)₃ | 1 |
| 900 | 0 | Me | Me | (CH₂)_{b} | 0 to 20 | CH₂ | (CH₂)_{c} | 1 to 20 | Si(OMe)₃ | 1 |

TABLE 167

| No. | R²¹ | | a | R²² | R²³ | R²⁴ | | | R²⁵ | z21 |
|---|---|---|---|---|---|---|---|---|---|---|
| 901 | Me | (CH₂)ₐ | 0 to 20 | Me | Me | OCF₃ | (CH₂)ₐ | 0 to 20 | Me | 5 to 100 |
| 902 | CF₃ | (CH₂)ₐ | 0 to 20 | Me | Me | OCF₃ | (CH₂)ₐ | 0 to 20 | Me | 5 to 100 |
| 903 | (CF₃)₂CF | (CH₂)ₐ | 0 to 20 | Me | Me | OCF₃ | (CH₂)ₐ | 0 to 20 | Me | 5 to 100 |
| 904 | (CF₃)₃C | (CH₂)ₐ | 0 to 20 | Me | Me | OCF₃ | (CH₂)ₐ | 0 to 20 | Me | 5 to 100 |
| 905 | C₄F₉ | (CH₂)ₐ | 0 to 20 | Me | Me | OCF₃ | (CH₂)ₐ | 0 to 20 | Me | 5 to 100 |
| 906 | C₈F₁₇ | (CH₂)ₐ | 0 to 20 | Me | Me | OCF₃ | (CH₂)ₐ | 0 to 20 | Me | 5 to 100 |
| 907 | c-C₆F₁₁ | (CH₂)ₐ | 0 to 20 | Me | Me | OCF₃ | (CH₂)ₐ | 0 to 20 | Me | 5 to 100 |
| 908 | CHF₂ | (CH₂)ₐ | 0 to 20 | Me | Me | OCF₃ | (CH₂)ₐ | 0 to 20 | Me | 5 to 100 |
| 909 | CClF₂ | (CH₂)ₐ | 0 to 20 | Me | Me | OCF₃ | (CH₂)ₐ | 0 to 20 | Me | 5 to 100 |
| 910 | CBrF₂ | (CH₂)ₐ | 0 to 20 | Me | Me | OCF₃ | (CH₂)ₐ | 0 to 20 | Me | 5 to 100 |
| 911 | ClF₂ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 901 | 0 | Me | Me | (CH₂)_{b} | 0 to 20 | CH₂ | (CH₂)_{c} | 1 to 20 | Si(OMe)₃ | 1 |
| 902 | 0 | Me | Me | (CH₂)_{b} | 0 to 20 | CH₂ | (CH₂)_{c} | 1 to 20 | Si(OMe)₃ | 1 |
| 903 | 0 | Me | Me | (CH₂)_{b} | 0 to 20 | CH₂ | (CH₂)_{c} | 1 to 20 | Si(OMe)₃ | 1 |
| 904 | 0 | Me | Me | (CH₂)_{b} | 0 to 20 | CH₂ | (CH₂)_{c} | 1 to 20 | Si(OMe)₃ | 1 |
| 905 | 0 | Me | Me | (CH₂)_{b} | 0 to 20 | CH₂ | (CH₂)_{c} | 1 to 20 | Si(OMe)₃ | 1 |
| 906 | 0 | Me | Me | (CH₂)_{b} | 0 to 20 | CH₂ | (CH₂)_{c} | 1 to 20 | Si(OMe)₃ | 1 |
| 907 | 0 | Me | Me | (CH₂)_{b} | 0 to 20 | CH₂ | (CH₂)_{c} | 1 to 20 | Si(OMe)₃ | 1 |
| 908 | 0 | Me | Me | (CH₂)_{b} | 0 to 20 | CH₂ | (CH₂)_{c} | 1 to 20 | Si(OMe)₃ | 1 |
| 909 | 0 | Me | Me | (CH₂)_{b} | 0 to 20 | CH₂ | (CH₂)_{c} | 1 to 20 | Si(OMe)₃ | 1 |
| 910 | 0 | Me | Me | (CH₂)_{b} | 0 to 20 | CH₂ | (CH₂)_{c} | 1 to 20 | Si(OMe)₃ | 1 |
| 911 | 0 | Me | Me | (CH₂)_{b} | 0 to 20 | CH₂ | (CH₂)_{c} | 1 to 20 | Si(OMe)₃ | 1 |

TABLE 168

| No. | R²¹ | | a | R²² | R²³ | R²⁴ | | | R²⁵ | z21 |
|---|---|---|---|---|---|---|---|---|---|---|
| 912 | CF═CF₂ | (CH₂)ₐ | 0 to 20 | Me | Me | OCF₃ | (CH₂)ₐ | 0 to 20 | Me | 5 to 100 |
| 913 | CF═CFCF₃ | (CH₂)ₐ | 0 to 20 | Me | Me | OCF₃ | (CH₂)ₐ | 0 to 20 | Me | 5 to 100 |
| 914 | CF═CFCF═CF₂ | (CH₂)ₐ | 0 to 20 | Me | Me | OCF₃ | (CH₂)ₐ | 0 to 20 | Me | 5 to 100 |
| 915 | C≡CCF₃ | (CH₂)ₐ | 0 to 20 | Me | Me | OCF₃ | (CH₂)ₐ | 0 to 20 | Me | 5 to 100 |
| 916 | CF₂CH₃ | (CH₂)ₐ | 0 to 20 | Me | Me | OCF₃ | (CH₂)ₐ | 0 to 20 | Me | 5 to 100 |
| 917 | (CF₂)₂H | (CH₂)ₐ | 0 to 20 | Me | Me | OCF₃ | (CH₂)ₐ | 0 to 20 | Me | 5 to 100 |
| 918 | (CF₂)₂CH₃ | (CH₂)ₐ | 0 to 20 | Me | Me | OCF₃ | (CH₂)ₐ | 0 to 20 | Me | 5 to 100 |
| 919 | (CF₂)₄H | (CH₂)ₐ | 0 to 20 | Me | Me | OCF₃ | (CH₂)ₐ | 0 to 20 | Me | 5 to 100 |
| 920 | C₆F₅ | (CH₂)ₐ | 0 to 20 | Me | Me | OCF₃ | (CH₂)ₐ | 0 to 20 | Me | 5 to 100 |
| 921 | 4-CF₃C₆F₄ | (CH₂)ₐ | 0 to 20 | Me | Me | OCF₃ | (CH₂)ₐ | 0 to 20 | Me | 5 to 100 |
| 922 | 4-SF₅C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 912 | 0 | Me | Me | (CH₂)_{b} | 0 to 20 | CH₂ | (CH₂)_{c} | 1 to 20 | Si(OMe)₃ | 1 |
| 913 | 0 | Me | Me | (CH₂)_{b} | 0 to 20 | CH₂ | (CH₂)_{c} | 1 to 20 | Si(OMe)₃ | 1 |
| 914 | 0 | Me | Me | (CH₂)_{b} | 0 to 20 | CH₂ | (CH₂)_{c} | 1 to 20 | Si(OMe)₃ | 1 |
| 915 | 0 | Me | Me | (CH₂)_{b} | 0 to 20 | CH₂ | (CH₂)_{c} | 1 to 20 | Si(OMe)₃ | 1 |
| 916 | 0 | Me | Me | (CH₂)_{b} | 0 to 20 | CH₂ | (CH₂)_{c} | 1 to 20 | Si(OMe)₃ | 1 |
| 917 | 0 | Me | Me | (CH₂)_{b} | 0 to 20 | CH₂ | (CH₂)_{c} | 1 to 20 | Si(OMe)₃ | 1 |
| 918 | 0 | Me | Me | (CH₂)_{b} | 0 to 20 | CH₂ | (CH₂)_{c} | 1 to 20 | Si(OMe)₃ | 1 |
| 919 | 0 | Me | Me | (CH₂)_{b} | 0 to 20 | CH₂ | (CH₂)_{c} | 1 to 20 | Si(OMe)₃ | 1 |
| 920 | 0 | Me | Me | (CH₂)_{b} | 0 to 20 | CH₂ | (CH₂)_{c} | 1 to 20 | Si(OMe)₃ | 1 |
| 921 | 0 | Me | Me | (CH₂)_{b} | 0 to 20 | CH₂ | (CH₂)_{c} | 1 to 20 | Si(OMe)₃ | 1 |
| 922 | 0 | Me | Me | (CH₂)_{b} | 0 to 20 | CH₂ | (CH₂)_{c} | 1 to 20 | Si(OMe)₃ | 1 |

TABLE 169

| No. | R²¹ | | a | R²² | R²³ | R²⁴ | | | R²⁵ | z21 |
|---|---|---|---|---|---|---|---|---|---|---|
| 923 | 3,5-CF₃C₆F₃ | (CH2)ₐ | 0 to 20 | Me | Me | OCF₃ | (CH₂)ₐ | 0 to 20 | Me | 5 to 100 |
| 924 | 3,5-SF₅C₆F₃ | (CH2)ₐ | 0 to 20 | Me | Me | OCF₃ | (CH₂)ₐ | 0 to 20 | Me | 5 to 100 |
| 925 | 4-CF₃C₆H₄ | (CH2)ₐ | 0 to 20 | Me | Me | OCF₃ | (CH₂)ₐ | 0 to 20 | Me | 5 to 100 |
| 926 | 4-SF₅C₆H₄ | (CH2)ₐ | 0 to 20 | Me | Me | OCF₃ | (CH₂)ₐ | 0 to 20 | Me | 5 to 100 |
| 927 | 3,5-CF₃C₆H₃ | (CH2)ₐ | 0 to 20 | Me | Me | OCF₃ | (CH₂)ₐ | 0 to 20 | Me | 5 to 100 |
| 928 | 3,5-SF₅C₆H₃ | (CH2)ₐ | 0 to 20 | Me | Me | OCF₃ | (CH₂)ₐ | 0 to 20 | Me | 5 to 100 |
| 929 | 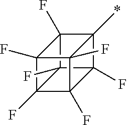 [SMILES: *C12C3(F)C4(F)C1(F)C1(F)C2(F)C3(F)C41F] | (CH2)ₐ | 0 to 20 | Me | Me | OCF₃ | (CH₂)ₐ | 0 to 20 | Me | 5 to 100 |
| 930 | 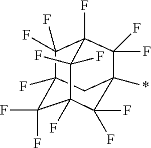 [SMILES: *C12CC3(F)C(F)(F)C(F)(C1(F)F)C(F)(F)C(F)(C2(F)F)C3(F)F] | (CH2)ₐ | 0 to 20 | Me | Me | OCF₃ | (CH₂)ₐ | 0 to 20 | Me | 5 to 100 |
| 931 | 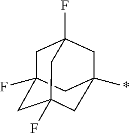 [SMILES: *C12CC3(F)CC(F)(C1)CC(F)(C2)C3] | (CH2)ₐ | 0 to 20 | Me | Me | OCF₃ | (CH₂)ₐ | 0 to 20 | Me | 5 to 100 |
| 932 | SF₅ | (CH2)ₐ | 0 to 20 | Me | Me | OCF₃ | (CH₂)ₐ | 0 to 20 | Me | 5 to 100 |
| 933 | OCF₃ | (CH2)ₐ | 0 to 20 | Me | Me | OCF₃ | (CH₂)ₐ | 0 to 20 | Me | 5 to 100 |
| No. | z22 | R²⁸ | R²⁹ | R¹ | b | L¹ | R² | c | T¹ | x1 |
| 923 | 0 | Me | Me | (CH₂)_{b} | 0 to 20 | CH₂ | (CH₂)_{c} | 1 to 20 | Si(OMe)₃ | 1 |
| 924 | 0 | Me | Me | (CH₂)_{b} | 0 to 20 | CH₂ | (CH₂)_{c} | 1 to 20 | Si(OMe)₃ | 1 |
| 925 | 0 | Me | Me | (CH₂)_{b} | 0 to 20 | CH₂ | (CH₂)_{c} | 1 to 20 | Si(OMe)₃ | 1 |
| 926 | 0 | Me | Me | (CH₂)_{b} | 0 to 20 | CH₂ | (CH₂)_{c} | 1 to 20 | Si(OMe)₃ | 1 |
| 927 | 0 | Me | Me | (CH₂)_{b} | 0 to 20 | CH₂ | (CH₂)_{c} | 1 to 20 | Si(OMe)₃ | 1 |
| 928 | 0 | Me | Me | (CH₂)_{b} | 0 to 20 | CH₂ | (CH₂)_{c} | 1 to 20 | Si(OMe)₃ | 1 |
| 929 | 0 | Me | Me | (CH₂)_{b} | 0 to 20 | CH₂ | (CH₂)_{c} | 1 to 20 | Si(OMe)₃ | 1 |
| 930 | 0 | Me | Me | (CH₂)_{b} | 0 to 20 | CH₂ | (CH₂)_{c} | 1 to 20 | Si(OMe)₃ | 1 |
| 931 | 0 | Me | Me | (CH₂)_{b} | 0 to 20 | CH₂ | (CH₂)_{c} | 1 to 20 | Si(OMe)₃ | 1 |
| 932 | 0 | Me | Me | (CH₂)_{b} | 0 to 20 | CH₂ | (CH₂)_{c} | 1 to 20 | Si(OMe)₃ | 1 |
| 933 | 0 | Me | Me | (CH₂)_{b} | 0 to 20 | CH₂ | (CH₂)_{c} | 1 to 20 | Si(OMe)₃ | 1 |

TABLE 170

| No. | R²¹ | | a | R²² | R²³ | R²⁴ | | | R²⁵ | z21 |
|---|---|---|---|---|---|---|---|---|---|---|
| 934 | SCF₃ | (CH₂)ₐ | 0 to 20 | Me | Me | OCF₃ | (CH₂)ₐ | 0 to 20 | Me | 5 to 100 |
| 935 | N(CH₂CF₃)₂ | (CH₂)ₐ | 0 to 20 | Me | Me | OCF₃ | (CH₂)ₐ | 0 to 20 | Me | 5 to 100 |
| 936 | N(CF₃)₂ | (CH₂)ₐ | 0 to 20 | Me | Me | OCF₃ | (CH₂)ₐ | 0 to 20 | Me | 5 to 100 |
| 937 | Me | (CH₂)ₐ | 0 to 20 | Me | Me | SCF₃ | (CH₂)ₐ | 0 to 20 | Me | 5 to 100 |
| 938 | CF₃ | (CH₂)ₐ | 0 to 20 | Me | Me | SCF₃ | (CH₂)ₐ | 0 to 20 | Me | 5 to 100 |
| 939 | (CF₃)₂CF | (CH₂)ₐ | 0 to 20 | Me | Me | SCF₃ | (CH₂)ₐ | 0 to 20 | Me | 5 to 100 |
| 940 | (CF₃)₃C | (CH₂)ₐ | 0 to 20 | Me | Me | SCF₃ | (CH₂)ₐ | 0 to 20 | Me | 5 to 100 |
| 941 | C₄F₉ | (CH₂)ₐ | 0 to 20 | Me | Me | SCF₃ | (CH₂)ₐ | 0 to 20 | Me | 5 to 100 |
| 942 | C₈F₁₇ | (CH₂)ₐ | 0 to 20 | Me | Me | SCF₃ | (CH₂)ₐ | 0 to 20 | Me | 5 to 100 |
| 943 | c-C₆F₁₁ | (CH₂)ₐ | 0 to 20 | Me | Me | SCF₃ | (CH₂)ₐ | 0 to 20 | Me | 5 to 100 |
| 944 | CHF₂ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 934 | 0 | Me | Me | (CH₂)_{b} | 0 to 20 | CH₂ | (CH₂)_{c} | 1 to 20 | Si(OMe)₃ | 1 |
| 935 | 0 | Me | Me | (CH₂)_{b} | 0 to 20 | CH₂ | (CH₂)_{c} | 1 to 20 | Si(OMe)₃ | 1 |
| 936 | 0 | Me | Me | (CH₂)_{b} | 0 to 20 | CH₂ | (CH₂)_{c} | 1 to 20 | Si(OMe)₃ | 1 |
| 937 | 0 | Me | Me | (CH₂)_{b} | 0 to 20 | CH₂ | (CH₂)_{c} | 1 to 20 | Si(OMe)₃ | 1 |
| 938 | 0 | Me | Me | (CH₂)_{b} | 0 to 20 | CH₂ | (CH₂)_{c} | 1 to 20 | Si(OMe)₃ | 1 |
| 939 | 0 | Me | Me | (CH₂)_{b} | 0 to 20 | CH₂ | (CH₂)_{c} | 1 to 20 | Si(OMe)₃ | 1 |
| 940 | 0 | Me | Me | (CH₂)_{b} | 0 to 20 | CH₂ | (CH₂)_{c} | 1 to 20 | Si(OMe)₃ | 1 |
| 941 | 0 | Me | Me | (CH₂)_{b} | 0 to 20 | CH₂ | (CH₂)_{c} | 1 to 20 | Si(OMe)₃ | 1 |
| 942 | 0 | Me | Me | (CH₂)_{b} | 0 to 20 | CH₂ | (CH₂)_{c} | 1 to 20 | Si(OMe)₃ | 1 |
| 943 | 0 | Me | Me | (CH₂)_{b} | 0 to 20 | CH₂ | (CH₂)_{c} | 1 to 20 | Si(OMe)₃ | 1 |
| 944 | 0 | Me | Me | (CH₂)_{b} | 0 to 20 | CH₂ | (CH₂)_{c} | 1 to 20 | Si(OMe)₃ | 1 |

TABLE 171

| No. | R²¹ | | a | R²² | R²³ | R²⁴ | | | R²⁵ | z21 |
|---|---|---|---|---|---|---|---|---|---|---|
| 945 | CClF₂ | (CH₂)ₐ | 0 to 20 | Me | Me | SCF₃ | (CH₂)ₐ | 0 to 20 | Me | 5 to 100 |
| 946 | CBrF₂ | (CH₂)ₐ | 0 to 20 | Me | Me | SCF₃ | (CH₂)ₐ | 0 to 20 | Me | 5 to 100 |
| 947 | ClF₂ | (CH₂)ₐ | 0 to 20 | Me | Me | SCF₃ | (CH₂)ₐ | 0 to 20 | Me | 5 to 100 |
| 948 | CF═CF₂ | (CH₂)ₐ | 0 to 20 | Me | Me | SCF₃ | (CH₂)ₐ | 0 to 20 | Me | 5 to 100 |
| 949 | CF═CFCF₃ | (CH₂)ₐ | 0 to 20 | Me | Me | SCF₃ | (CH₂)ₐ | 0 to 20 | Me | 5 to 100 |
| 950 | CF═CFCF═CF₂ | (CH₂)ₐ | 0 to 20 | Me | Me | SCF₃ | (CH₂)ₐ | 0 to 20 | Me | 5 to 100 |
| 951 | C≡CCF₃ | (CH₂)ₐ | 0 to 20 | Me | Me | SCF₃ | (CH₂)ₐ | 0 to 20 | Me | 5 to 100 |
| 952 | CF₂CH₃ | (CH₂)ₐ | 0 to 20 | Me | Me | SCF₃ | (CH₂)ₐ | 0 to 20 | Me | 5 to 100 |
| 953 | (CF₂)₂H | (CH₂)ₐ | 0 to 20 | Me | Me | SCF₃ | (CH₂)ₐ | 0 to 20 | Me | 5 to 100 |
| 954 | (CF₂)₂CH₃ | (CH₂)ₐ | 0 to 20 | Me | Me | SCF₃ | (CH₂)ₐ | 0 to 20 | Me | 5 to 100 |
| 955 | (CF₂)₄H | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 945 | 0 | Me | Me | (CH₂)_{b} | 0 to 20 | CH₂ | (CH₂)_{c} | 1 to 20 | Si(OMe)₃ | 1 |
| 946 | 0 | Me | Me | (CH₂)_{b} | 0 to 20 | CH₂ | (CH₂)_{c} | 1 to 20 | Si(OMe)₃ | 1 |
| 947 | 0 | Me | Me | (CH₂)_{b} | 0 to 20 | CH₂ | (CH₂)_{c} | 1 to 20 | Si(OMe)₃ | 1 |
| 948 | 0 | Me | Me | (CH₂)_{b} | 0 to 20 | CH₂ | (CH₂)_{c} | 1 to 20 | Si(OMe)₃ | 1 |
| 949 | 0 | Me | Me | (CH₂)_{b} | 0 to 20 | CH₂ | (CH₂)_{c} | 1 to 20 | Si(OMe)₃ | 1 |
| 950 | 0 | Me | Me | (CH₂)_{b} | 0 to 20 | CH₂ | (CH₂)_{c} | 1 to 20 | Si(OMe)₃ | 1 |
| 951 | 0 | Me | Me | (CH₂)_{b} | 0 to 20 | CH₂ | (CH₂)_{c} | 1 to 20 | Si(OMe)₃ | 1 |
| 952 | 0 | Me | Me | (CH₂)_{b} | 0 to 20 | CH₂ | (CH₂)_{c} | 1 to 20 | Si(OMe)₃ | 1 |
| 953 | 0 | Me | Me | (CH₂)_{b} | 0 to 20 | CH₂ | (CH₂)_{c} | 1 to 20 | Si(OMe)₃ | 1 |
| 954 | 0 | Me | Me | (CH₂)_{b} | 0 to 20 | CH₂ | (CH₂)_{c} | 1 to 20 | Si(OMe)₃ | 1 |
| 955 | 0 | Me | Me | (CH₂)_{b} | 0 to 20 | CH₂ | (CH₂)_{c} | 1 to 20 | Si(OMe)₃ | 1 |

TABLE 172

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 956 | C₆F₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 957 | 4-CF₃C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 958 | 4-SF₅C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 959 | 3,5-CF₃C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 960 | 3,5-SF₅C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 961 | 4-CF₃C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 962 | 4-SF₅C₆H4 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 963 | 3,5-CF₃C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 964 | 3,5-SF₅C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 965 | 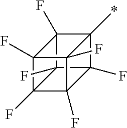 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 966 | 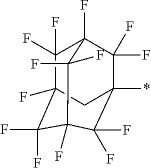 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |

TABLE 173

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 967 | 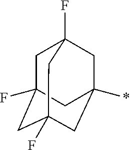 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 968 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 969 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 970 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 971 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 972 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 973 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 974 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 975 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 976 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 977 | C₄F₉ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |

TABLE 174

| No. | R²¹ | | a | R²² | R²³ | R²⁴ | | | R²⁵ | z21 |
|---|---|---|---|---|---|---|---|---|---|---|
| 978 | C₈F₁₇ | (CH₂)ₐ | 0 to 20 | Me | Me | N(CF₃)₂ | (CH₂)ₐ | 0 to 20 | Me | 5 to 100 |
| 979 | c-C₆F₁₁ | (CH₂)ₐ | 0 to 20 | Me | Me | N(CF₃)₂ | (CH₂)ₐ | 0 to 20 | Me | 5 to 100 |
| 980 | CHF₂ | (CH₂)ₐ | 0 to 20 | Me | Me | N(CF₃)₂ | (CH₂)ₐ | 0 to 20 | Me | 5 to 100 |
| 981 | CClF₂ | (CH₂)ₐ | 0 to 20 | Me | Me | N(CF₃)₂ | (CH₂)ₐ | 0 to 20 | Me | 5 to 100 |
| 982 | CBrF₂ | (CH₂)ₐ | 0 to 20 | Me | Me | N(CF₃)₂ | (CH₂)ₐ | 0 to 20 | Me | 5 to 100 |
| 983 | ClF₂ | (CH₂)ₐ | 0 to 20 | Me | Me | N(CF₃)₂ | (CH₂)ₐ | 0 to 20 | Me | 5 to 100 |
| 984 | CF═CF₂ | (CH₂)ₐ | 0 to 20 | Me | Me | N(CF₃)₂ | (CH₂)ₐ | 0 to 20 | Me | 5 to 100 |
| 985 | CF═CFCF₃ | (CH₂)ₐ | 0 to 20 | Me | Me | N(CF₃)₂ | (CH₂)ₐ | 0 to 20 | Me | 5 to 100 |
| 986 | CF═CFCF═CF₂ | (CH₂)ₐ | 0 to 20 | Me | Me | N(CF₃)₂ | (CH₂)ₐ | 0 to 20 | Me | 5 to 100 |
| 987 | C≡CCF₃ | (CH₂)ₐ | 0 to 20 | Me | Me | N(CF₃)₂ | (CH₂)ₐ | 0 to 20 | Me | 5 to 100 |
| 988 | CF₂CH₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 978 | 0 | Me | Me | (CH₂)_{b} | 0 to 20 | CH₂ | (CH₂)_{c} | 1 to 20 | Si(OMe)₃ | 1 |
| 979 | 0 | Me | Me | (CH₂)_{b} | 0 to 20 | CH₂ | (CH₂)_{c} | 1 to 20 | Si(OMe)₃ | 1 |
| 980 | 0 | Me | Me | (CH₂)_{b} | 0 to 20 | CH₂ | (CH₂)_{c} | 1 to 20 | Si(OMe)₃ | 1 |
| 981 | 0 | Me | Me | (CH₂)_{b} | 0 to 20 | CH₂ | (CH₂)_{c} | 1 to 20 | Si(OMe)₃ | 1 |
| 982 | 0 | Me | Me | (CH₂)_{b} | 0 to 20 | CH₂ | (CH₂)_{c} | 1 to 20 | Si(OMe)₃ | 1 |
| 983 | 0 | Me | Me | (CH₂)_{b} | 0 to 20 | CH₂ | (CH₂)_{c} | 1 to 20 | Si(OMe)₃ | 1 |
| 984 | 0 | Me | Me | (CH₂)_{b} | 0 to 20 | CH₂ | (CH₂)_{c} | 1 to 20 | Si(OMe)₃ | 1 |
| 985 | 0 | Me | Me | (CH₂)_{b} | 0 to 20 | CH₂ | (CH₂)_{c} | 1 to 20 | Si(OMe)₃ | 1 |
| 986 | 0 | Me | Me | (CH₂)_{b} | 0 to 20 | CH₂ | (CH₂)_{c} | 1 to 20 | Si(OMe)₃ | 1 |
| 987 | 0 | Me | Me | (CH₂)_{b} | 0 to 20 | CH₂ | (CH₂)_{c} | 1 to 20 | Si(OMe)₃ | 1 |
| 988 | 0 | Me | Me | (CH₂)_{b} | 0 to 20 | CH₂ | (CH₂)_{c} | 1 to 20 | Si(OMe)₃ | 1 |

TABLE 175

| No. | R²¹ | | a | R²² | R²³ | R²⁴ | | | R²⁵ | z21 |
|---|---|---|---|---|---|---|---|---|---|---|
| 989 | (CF₂)₂H | (CH₂)ₐ | 0 to 20 | Me | Me | N(CF₃)₂ | (CH₂)ₐ | 0 to 20 | Me | 5 to 100 |
| 990 | (CF₂)₂CH₃ | (CH₂)ₐ | 0 to 20 | Me | Me | N(CF₃)₂ | (CH₂)ₐ | 0 to 20 | Me | 5 to 100 |
| 991 | (CF₂)₄H | (CH₂)ₐ | 0 to 20 | Me | Me | SCF₃ | (CH₂)ₐ | 0 to 20 | Me | 5 to 100 |
| 992 | C₆F₅ | (CH₂)ₐ | 0 to 20 | Me | Me | N(CF₃)₂ | (CH₂)ₐ | 0 to 20 | Me | 5 to 100 |
| 993 | 4-CF₃C₆F₄ | (CH₂)ₐ | 0 to 20 | Me | Me | N(CF₃)₂ | (CH₂)ₐ | 0 to 20 | Me | 5 to 100 |
| 994 | 4-SF₅C₆F₄ | (CH₂)ₐ | 0 to 20 | Me | Me | N(CF₃)₂ | (CH₂)ₐ | 0 to 20 | Me | 5 to 100 |
| 995 | 3,5-CF₃C₆F₃ | (CH₂)ₐ | 0 to 20 | Me | Me | N(CF₃)₂ | (CH₂)ₐ | 0 to 20 | Me | 5 to 100 |
| 996 | 3,5-SF₅C₆F₃ | (CH₂)ₐ | 0 to 20 | Me | Me | N(CF₃)₂ | (CH₂)ₐ | 0 to 20 | Me | 5 to 100 |
| 997 | 4-CF₃C₆H₄ | (CH₂)ₐ | 0 to 20 | Me | Me | N(CF₃)₂ | (CH₂)ₐ | 0 to 20 | Me | 5 to 100 |
| 998 | 4-SF₅C₆H₄ | (CH₂)ₐ | 0 to 20 | Me | Me | N(CF₃)₂ | (CH₂)ₐ | 0 to 20 | Me | 5 to 100 |
| 999 | 3,5-CF₃C₆H₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 989 | 0 | Me | Me | (CH₂)_{b} | 0 to 20 | CH₂ | (CH₂)_{c} | 1 to 20 | Si(OMe)₃ | 1 |
| 990 | 0 | Me | Me | (CH₂)_{b} | 0 to 20 | CH₂ | (CH₂)_{c} | 1 to 20 | Si(OMe)₃ | 1 |
| 991 | 0 | Me | Me | (CH₂)_{b} | 0 to 20 | CH₂ | (CH₂)_{c} | 1 to 20 | Si(OMe)₃ | 1 |
| 992 | 0 | Me | Me | (CH₂)_{b} | 0 to 20 | CH₂ | (CH₂)_{c} | 1 to 20 | Si(OMe)₃ | 1 |
| 993 | 0 | Me | Me | (CH₂)_{b} | 0 to 20 | CH₂ | (CH₂)_{c} | 1 to 20 | Si(OMe)₃ | 1 |
| 994 | 0 | Me | Me | (CH₂)_{b} | 0 to 20 | CH₂ | (CH₂)_{c} | 1 to 20 | Si(OMe)₃ | 1 |
| 995 | 0 | Me | Me | (CH₂)_{b} | 0 to 20 | CH₂ | (CH₂)_{c} | 1 to 20 | Si(OMe)₃ | 1 |
| 996 | 0 | Me | Me | (CH₂)_{b} | 0 to 20 | CH₂ | (CH₂)_{c} | 1 to 20 | Si(OMe)₃ | 1 |
| 997 | 0 | Me | Me | (CH₂)_{b} | 0 to 20 | CH₂ | (CH₂)_{c} | 1 to 20 | Si(OMe)₃ | 1 |
| 998 | 0 | Me | Me | (CH₂)_{b} | 0 to 20 | CH₂ | (CH₂)_{c} | 1 to 20 | Si(OMe)₃ | 1 |
| 999 | 0 | Me | Me | (CH₂)_{b} | 0 to 20 | CH₂ | (CH₂)_{c} | 1 to 20 | Si(OMe)₃ | 1 |

TABLE 176

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1000 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1001 | 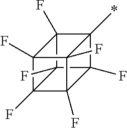 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1002 | 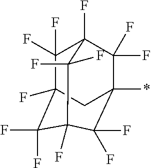 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1003 | 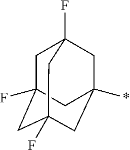 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1004 | SF₅ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1005 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1006 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1007 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |
| 1008 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | CH₂ | (CH₂)_{c} | 1 to 20 | Si(OMe)₃ | 1 |

TABLE 177

| No. | R²¹ | | a | R²² | R²³ | R²⁴ | | | R²⁵ | z21 | z22 |
|---|---|---|---|---|---|---|---|---|---|---|---|
| 1 | Me | (CH₂)ₐ | 0 to 20 | Me | Me | CF₃ | (CH₂)ₐ | 0 to 20 | Me | 5 to 100 | 0 |
| 2 | CF₃ | (CH₂)ₐ | 0 to 20 | Me | Me | CF₃ | (CH₂)ₐ | 0 to 20 | Me | 5 to 100 | 0 |
| 3 | (CF₃)₂CF | (CH₂)ₐ | 0 to 20 | Me | Me | CF₃ | (CH₂)ₐ | 0 to 20 | Me | 5 to 100 | 0 |
| 4 | (CF₃)₃C | (CH₂)ₐ | 0 to 20 | Me | Me | CF₃ | (CH₂)ₐ | 0 to 20 | Me | 5 to 100 | 0 |
| 5 | C₄F₉ | (CH₂)ₐ | 0 to 20 | Me | Me | CF₃ | (CH₂)ₐ | 0 to 20 | Me | 5 to 100 | 0 |
| 6 | C₈F₁₇ | (CH₂)ₐ | 0 to 20 | Me | Me | CF₃ | (CH₂)ₐ | 0 to 20 | Me | 5 to 100 | 0 |
| 7 | c-C₆F₁₁ | (CH₂)ₐ | 0 to 20 | Me | Me | CF₃ | (CH₂)ₐ | 0 to 20 | Me | 5 to 100 | 0 |
| 8 | CHF₂ | (CH₂)ₐ | 0 to 20 | Me | Me | CF₃ | (CH₂)ₐ | 0 to 20 | Me | 5 to 100 | 0 |
| 9 | CClF₂ | (CH₂)ₐ | 0 to 20 | Me | Me | CF₃ | (CH₂)ₐ | 0 to 20 | Me | 5 to 100 | 0 |
| 10 | CBrF₂ | (CH₂)ₐ | 0 to 20 | Me | Me | CF₃ | (CH₂)ₐ | 0 to 20 | Me | 5 to 100 | 0 |
| 11 | ClF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 1 | Me | Me | (CH₂)_{b} | 0 to 20 | C(═O)NHCH₂CH | (CH₂)_{c} | 1 to 20 | Si(OMe)₃ | 2 |
| 2 | Me | Me | (CH₂)_{b} | 0 to 20 | C(═O)NHCH₂CH | (CH₂)_{c} | 1 to 20 | Si(OMe)₃ | 2 |
| 3 | Me | Me | (CH₂)_{b} | 0 to 20 | C(═O)NHCH₂CH | (CH₂)_{c} | 1 to 20 | Si(OMe)₃ | 2 |
| 4 | Me | Me | (CH₂)_{b} | 0 to 20 | C(═O)NHCH₂CH | (CH₂)_{c} | 1 to 20 | Si(OMe)₃ | 2 |
| 5 | Me | Me | (CH₂)_{b} | 0 to 20 | C(═O)NHCH₂CH | (CH₂)_{c} | 1 to 20 | Si(OMe)₃ | 2 |
| 6 | Me | Me | (CH₂)_{b} | 0 to 20 | C(═O)NHCH₂CH | (CH₂)_{c} | 1 to 20 | Si(OMe)₃ | 2 |
| 7 | Me | Me | (CH₂)_{b} | 0 to 20 | C(═O)NHCH₂CH | (CH₂)_{c} | 1 to 20 | Si(OMe)₃ | 2 |
| 8 | Me | Me | (CH₂)_{b} | 0 to 20 | C(═O)NHCH₂CH | (CH₂)_{c} | 1 to 20 | Si(OMe)₃ | 2 |
| 9 | Me | Me | (CH₂)_{b} | 0 to 20 | C(═O)NHCH₂CH | (CH₂)_{c} | 1 to 20 | Si(OMe)₃ | 2 |
| 10 | Me | Me | (CH₂)_{b} | 0 to 20 | C(═O)NHCH₂CH | (CH₂)_{c} | 1 to 20 | Si(OMe)₃ | 2 |
| 11 | Me | Me | (CH₂)_{b} | 0 to 20 | C(═O)NHCH₂CH | (CH₂)_{c} | 1 to 20 | Si(OMe)₃ | 2 |

TABLE 178

| No. | R²¹ | | a | R²² | R²³ | R²⁴ | | | R²⁵ | z21 | z22 |
|---|---|---|---|---|---|---|---|---|---|---|---|
| 12 | CF═CF₂ | (CH₂)ₐ | 0 to 20 | Me | Me | CF₃ | (CH₂)ₐ | 0 to 20 | Me | 5 to 100 | 0 |
| 13 | CF═CFCF₃ | (CH₂)ₐ | 0 to 20 | Me | Me | CF₃ | (CH₂)ₐ | 0 to 20 | Me | 5 to 100 | 0 |
| 14 | CF═CFCF═CF₂ | (CH₂)ₐ | 0 to 20 | Me | Me | CF₃ | (CH₂)ₐ | 0 to 20 | Me | 5 to 100 | 0 |
| 15 | C≡CCF₃ | (CH₂)ₐ | 0 to 20 | Me | Me | CF₃ | (CH₂)ₐ | 0 to 20 | Me | 5 to 100 | 0 |
| 16 | CF₂CH₃ | (CH₂)ₐ | 0 to 20 | Me | Me | CF₃ | (CH₂)ₐ | 0 to 20 | Me | 5 to 100 | 0 |
| 17 | (CF₂)₂H | (CH₂)ₐ | 0 to 20 | Me | Me | CF₃ | (CH₂)ₐ | 0 to 20 | Me | 5 to 100 | 0 |
| 18 | (CF₂)₂CH₃ | (CH₂)ₐ | 0 to 20 | Me | Me | CF₃ | (CH₂)ₐ | 0 to 20 | Me | 5 to 100 | 0 |
| 19 | (CF₂)₄H | (CH₂)ₐ | 0 to 20 | Me | Me | CF₃ | (CH₂)ₐ | 0 to 20 | Me | 5 to 100 | 0 |
| 20 | C₆F₅ | (CH₂)ₐ | 0 to 20 | Me | Me | CF₃ | (CH₂)ₐ | 0 to 20 | Me | 5 to 100 | 0 |
| 21 | 4-CF₃C₆F4 | (CH₂)ₐ | 0 to 20 | Me | Me | CF₃ | (CH₂)ₐ | 0 to 20 | Me | 5 to 100 | 0 |
| 22 | 4-SF₅C₆F₄ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 12 | Me | Me | (CH₂)_{b} | 0 to 20 | C(═O)NHCH₂CH | (CH₂)_{c} | 1 to 20 | Si(OMe)₃ | 2 |
| 13 | Me | Me | (CH₂)_{b} | 0 to 20 | C(═O)NHCH₂CH | (CH₂)_{c} | 1 to 20 | Si(OMe)₃ | 2 |
| 14 | Me | Me | (CH₂)_{b} | 0 to 20 | C(═O)NHCH₂CH | (CH₂)_{c} | 1 to 20 | Si(OMe)₃ | 2 |
| 15 | Me | Me | (CH₂)_{b} | 0 to 20 | C(═O)NHCH₂CH | (CH₂)_{c} | 1 to 20 | Si(OMe)₃ | 2 |
| 16 | Me | Me | (CH₂)_{b} | 0 to 20 | C(═O)NHCH₂CH | (CH₂)_{c} | 1 to 20 | Si(OMe)₃ | 2 |
| 17 | Me | Me | (CH₂)_{b} | 0 to 20 | C(═O)NHCH₂CH | (CH₂)_{c} | 1 to 20 | Si(OMe)₃ | 2 |
| 18 | Me | Me | (CH₂)_{b} | 0 to 20 | C(═O)NHCH₂CH | (CH₂)_{c} | 1 to 20 | Si(OMe)₃ | 2 |
| 19 | Me | Me | (CH₂)_{b} | 0 to 20 | C(═O)NHCH₂CH | (CH₂)_{c} | 1 to 20 | Si(OMe)₃ | 2 |
| 20 | Me | Me | (CH₂)_{b} | 0 to 20 | C(═O)NHCH₂CH | (CH₂)_{c} | 1 to 20 | Si(OMe)₃ | 2 |
| 21 | Me | Me | (CH₂)_{b} | 0 to 20 | C(═O)NHCH₂CH | (CH₂)_{c} | 1 to 20 | Si(OMe)₃ | 2 |
| 22 | Me | Me | (CH₂)_{b} | 0 to 20 | C(═O)NHCH₂CH | (CH₂)_{c} | 1 to 20 | Si(OMe)₃ | 2 |

TABLE 179

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 23 | 3,5-CF₃C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 24 | 3,5-SF₅C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 25 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 26 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 27 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 28 | 3,5-SF₅C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 29 | 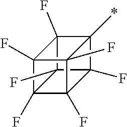 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 30 | 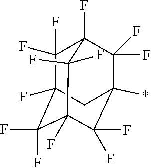 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 31 | 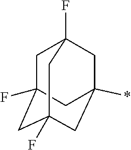 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 32 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 33 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 180

| No. | R²¹ | | a | R²² | R²³ | R²⁴ | | | R²⁵ | z21 | z22 |
|---|---|---|---|---|---|---|---|---|---|---|---|
| 34 | SCF₃ | (CH₂)ₐ | 0 to 20 | Me | Me | CF₃ | (CH₂)ₐ | 0 to 20 | Me | 5 to 100 | 0 |
| 35 | N(CH₂CF₃)₂ | (CH₂)ₐ | 0 to 20 | Me | Me | CF₃ | (CH₂)ₐ | 0 to 20 | Me | 5 to 100 | 0 |
| 36 | N(CF₃)₂ | (CH₂)ₐ | 0 to 20 | Me | Me | CF₃ | (CH₂)ₐ | 0 to 20 | Me | 5 to 100 | 0 |
| 37 | Me | (CH₂)ₐ | 0 to 20 | Me | Me | CHF₂ | (CH₂)ₐ | 0 to 20 | Me | 5 to 100 | 0 |
| 38 | CF₃ | (CH₂)ₐ | 0 to 20 | Me | Me | CHF₂ | (CH₂)ₐ | 0 to 20 | Me | 5 to 100 | 0 |
| 39 | (CF₃)₂CF | (CH₂)ₐ | 0 to 20 | Me | Me | CHF₂ | (CH₂)ₐ | 0 to 20 | Me | 5 to 100 | 0 |
| 40 | (CF₃)₃C | (CH₂)ₐ | 0 to 20 | Me | Me | CHF₂ | (CH₂)ₐ | 0 to 20 | Me | 5 to 100 | 0 |
| 41 | C₄F₉ | (CH₂)ₐ | 0 to 20 | Me | Me | CHF₂ | (CH₂)ₐ | 0 to 20 | Me | 5 to 100 | 0 |
| 42 | C₈F₁₇ | (CH₂)ₐ | 0 to 20 | Me | Me | CHF₂ | (CH₂)ₐ | 0 to 20 | Me | 5 to 100 | 0 |
| 43 | c-C₆F₁₁ | (CH₂)ₐ | 0 to 20 | Me | Me | CHF₂ | (CH₂)ₐ | 0 to 20 | Me | 5 to 100 | 0 |
| 44 | CHF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 34 | Me | Me | (CH₂)_{b} | 0 to 20 | C(═O)NHCH₂CH | (CH₂)_{c} | 1 to 20 | Si(OMe)₃ | 2 |
| 35 | Me | Me | (CH₂)_{b} | 0 to 20 | C(═O)NHCH₂CH | (CH₂)_{c} | 1 to 20 | Si(OMe)₃ | 2 |
| 36 | Me | Me | (CH₂)_{b} | 0 to 20 | C(═O)NHCH₂CH | (CH₂)_{c} | 1 to 20 | Si(OMe)₃ | 2 |
| 37 | Me | Me | (CH₂)_{b} | 0 to 20 | C(═O)NHCH₂CH | (CH₂)_{c} | 1 to 20 | Si(OMe)₃ | 2 |
| 38 | Me | Me | (CH₂)_{b} | 0 to 20 | C(═O)NHCH₂CH | (CH₂)_{c} | 1 to 20 | Si(OMe)₃ | 2 |
| 39 | Me | Me | (CH₂)_{b} | 0 to 20 | C(═O)NHCH₂CH | (CH₂)_{c} | 1 to 20 | Si(OMe)₃ | 2 |
| 40 | Me | Me | (CH₂)_{b} | 0 to 20 | C(═O)NHCH₂CH | (CH₂)_{c} | 1 to 20 | Si(OMe)₃ | 2 |
| 41 | Me | Me | (CH₂)_{b} | 0 to 20 | C(═O)NHCH₂CH | (CH₂)_{c} | 1 to 20 | Si(OMe)₃ | 2 |
| 42 | Me | Me | (CH₂)_{b} | 0 to 20 | C(═O)NHCH₂CH | (CH₂)_{c} | 1 to 20 | Si(OMe)₃ | 2 |
| 43 | Me | Me | (CH₂)_{b} | 0 to 20 | C(═O)NHCH₂CH | (CH₂)_{c} | 1 to 20 | Si(OMe)₃ | 2 |
| 44 | Me | Me | (CH₂)_{b} | 0 to 20 | C(═O)NHCH₂CH | (CH₂)_{c} | 1 to 20 | Si(OMe)₃ | 2 |

TABLE 181

| No. | R²¹ | | a | R²² | R²³ | R²⁴ | | | R²⁵ | z21 | z22 |
|---|---|---|---|---|---|---|---|---|---|---|---|
| 45 | CClF₂ | (CH₂) | 0 to 20 | Me | Me | CHF₂ | (CH₂)ₐ | 0 to 20 | Me | 5 to 100 | 0 |
| 46 | CBrF₂ | (CH₂)ₐ | 0 to 20 | Me | Me | CHF₂ | (CH₂)ₐ | 0 to 20 | Me | 5 to 100 | 0 |
| 47 | ClF₂ | (CH₂)ₐ | 0 to 20 | Me | Me | CHF₂ | (CH₂)ₐ | 0 to 20 | Me | 5 to 100 | 0 |
| 48 | CF═CF₂ | (CH₂)ₐ | 0 to 20 | Me | Me | CHF₂ | (CH₂)ₐ | 0 to 20 | Me | 5 to 100 | 0 |
| 49 | CF═CFCF₃ | (CH₂)ₐ | 0 to 20 | Me | Me | CHF₂ | (CH₂)ₐ | 0 to 20 | Me | 5 to 100 | 0 |
| 50 | CF═CFCF═CF₂ | (CH₂)ₐ | 0 to 20 | Me | Me | CHF₂ | (CH₂)ₐ | 0 to 20 | Me | 5 to 100 | 0 |
| 51 | C≡CCF₃ | (CH₂)ₐ | 0 to 20 | Me | Me | CHF₂ | (CH₂)ₐ | 0 to 20 | Me | 5 to 100 | 0 |
| 52 | CF₂CH₃ | (CH₂)ₐ | 0 to 20 | Me | Me | CHF₂ | (CH₂)ₐ | 0 to 20 | Me | 5 to 100 | 0 |
| 53 | (CF₂)₂H | (CH₂)ₐ | 0 to 20 | Me | Me | CHF₂ | (CH₂)ₐ | 0 to 20 | Me | 5 to 100 | 0 |
| 54 | (CF₂)₂CH₃ | (CH₂)ₐ | 0 to 20 | Me | Me | CHF₂ | (CH₂)ₐ | 0 to 20 | Me | 5 to 100 | 0 |
| 55 | (CF₂)₄H | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 45 | Me | Me | (CH₂)_{b} | 0 to 20 | C(═O)NHCH₂CH | (CH₂)_{c} | 1 to 20 | Si(OMe)₃ | 2 |
| 46 | Me | Me | (CH₂)_{b} | 0 to 20 | C(═O)NHCH₂CH | (CH₂)_{c} | 1 to 20 | Si(OMe)₃ | 2 |
| 47 | Me | Me | (CH₂)_{b} | 0 to 20 | C(═O)NHCH₂CH | (CH₂)_{c} | 1 to 20 | Si(OMe)₃ | 2 |
| 48 | Me | Me | (CH₂)_{b} | 0 to 20 | C(═O)NHCH₂CH | (CH₂)_{c} | 1 to 20 | Si(OMe)₃ | 2 |
| 49 | Me | Me | (CH₂)_{b} | 0 to 20 | C(═O)NHCH₂CH | (CH₂)_{c} | 1 to 20 | Si(OMe)₃ | 2 |
| 50 | Me | Me | (CH₂)_{b} | 0 to 20 | C(═O)NHCH₂CH | (CH₂)_{c} | 1 to 20 | Si(OMe)₃ | 2 |
| 51 | Me | Me | (CH₂)_{b} | 0 to 20 | C(═O)NHCH₂CH | (CH₂)_{c} | 1 to 20 | Si(OMe)₃ | 2 |
| 52 | Me | Me | (CH₂)_{b} | 0 to 20 | C(═O)NHCH₂CH | (CH₂)_{c} | 1 to 20 | Si(OMe)₃ | 2 |
| 53 | Me | Me | (CH₂)_{b} | 0 to 20 | C(═O)NHCH₂CH | (CH₂)_{c} | 1 to 20 | Si(OMe)₃ | 2 |
| 54 | Me | Me | (CH₂)_{b} | 0 to 20 | C(═O)NHCH₂CH | (CH₂)_{c} | 1 to 20 | Si(OMe)₃ | 2 |
| 55 | Me | Me | (CH₂)_{b} | 0 to 20 | C(═O)NHCH₂CH | (CH₂)_{c} | 1 to 20 | Si(OMe)₃ | 2 |

TABLE 182

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 56 | C₆F₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 57 | 4-CF₃C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 58 | 4-SF₅C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 59 | 3,5-CF₃C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 60 | 3,5-SF₅C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 61 | 4-CF₃C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 62 | 4-SF₅C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 63 | 3,5-CF₃C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 64 | 3,5-SF₅C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 65 | 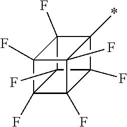 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 66 | 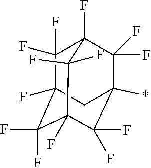 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 183

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 67 | 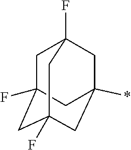 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 68 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 69 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 70 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 71 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 72 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 73 | Me | (CH₂)ₐ | 0 to 20 | Me | Me | 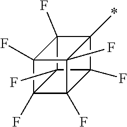 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 74 | CF₃ | (CH₂)ₐ | 0 to 20 | Me | Me | 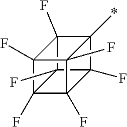 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 75 | (CF₃)₂CF | (CH₂)ₐ | 0 to 20 | Me | Me | 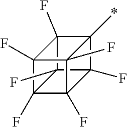 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 76 | (CF₃)₃C | (CH₂)ₐ | 0 to 20 | Me | Me | 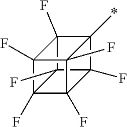 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 77 | C₄F₉ | (CH₂)ₐ | 0 to 20 | Me | Me | 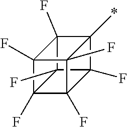 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 184

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 78 | C₈F₁₇ | (CH₂)ₐ | 0 to 20 | Me | Me | 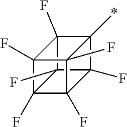 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 79 | c-C₆F₁₁ | (CH₂)ₐ | 0 to 20 | Me | Me | 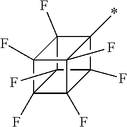 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 80 | CHF₂ | (CH₂)ₐ | 0 to 20 | Me | Me | 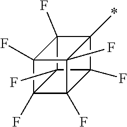 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 81 | CClF₂ | (CH₂)ₐ | 0 to 20 | Me | Me | 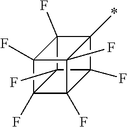 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 82 | CBrF₂ | (CH₂)ₐ | 0 to 20 | Me | Me | 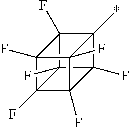 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 83 | ClF₂ | (CH₂)ₐ | 0 to 20 | Me | Me | 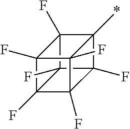 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 84 | CF═CF₂ | (CH₂)ₐ | 0 to 20 | Me | Me | 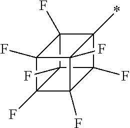 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 85 | CF═CFCF₃ | (CH₂)ₐ | 0 to 20 | Me | Me | 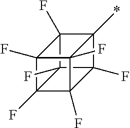 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 86 | CF═CFCF═CF₂ | (CH₂)ₐ | 0 to 20 | Me | Me | 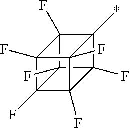 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 87 | C≡CCF₃ | (CH₂)ₐ | 0 to 20 | Me | Me | 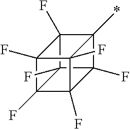 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 88 | CF₂CH₃ | (CH₂)ₐ | 0 to 20 | Me | Me | 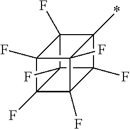 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 185

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 89 | (CF₂)₂H | (CH₂)ₐ | 0 to 20 | Me | Me | 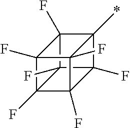 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 90 | (CF₂)₂CH₃ | (CH₂)ₐ | 0 to 20 | Me | Me | 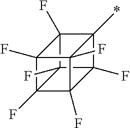 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 91 | (CF₂)₄H | (CH₂)ₐ | 0 to 20 | Me | Me | 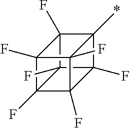 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 92 | C₆F₅ | (CH₂)ₐ | 0 to 20 | Me | Me | 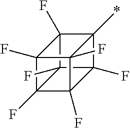 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 93 | 4-CF₃C₆F₄ | (CH₂)ₐ | 0 to 20 | Me | Me | 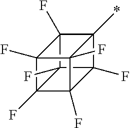 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 94 | 4-SF₅C₆F₄ | (CH₂)ₐ | 0 to 20 | Me | Me | 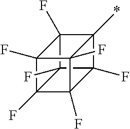 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 95 | 3,5-CF₃C₆F₃ | (CH₂)ₐ | 0 to 20 | Me | Me | 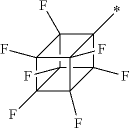 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 96 | 3,5-SF₅C₆F₃ | (CH₂)ₐ | 0 to 20 | Me | Me | 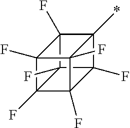 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 97 | 4-CF₃C₆H₄ | (CH₂)ₐ | 0 to 20 | Me | Me | 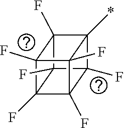 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 98 | 4-SF₅C₆H₄ | (CH₂)ₐ | 0 to 20 | Me | Me | 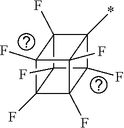 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 99 | 3,5-CF₃C₆H₃ | (CH₂)ₐ | 0 to 20 | Me | Me | 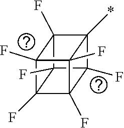 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 186

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 100 | 3,5-SF₅C₆H₃ | (CH₂)ₐ | 0 to 20 | Me | Me | 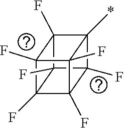 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 101 | 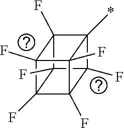 [SMILES: *C12C3(F)C4(F)C1(F)C1(F)C2(F)C3(F)C41F] | (CH₂)ₐ | 0 to 20 | Me | Me | 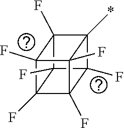 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 102 | 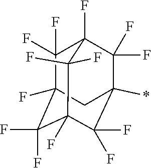 [SMILES: *C12CC3(F)C(F)(F)C(F)(C1(F)F)C(F)(F)C(F)(C2(F)F)C3(F)F] | (CH₂)ₐ | 0 to 20 | Me | Me | 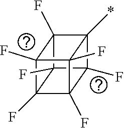 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 103 | 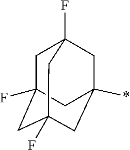 [SMILES: *C12CC3(F)CC(F)(C1)CC(F)(C2)C3] | (CH₂)ₐ | 0 to 20 | Me | Me | 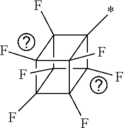 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 104 | SF₅ | (CH₂)ₐ | 0 to 20 | Me | Me | 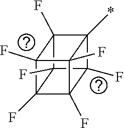 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 105 | OCF₃ | (CH₂)ₐ | 0 to 20 | Me | Me | 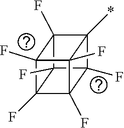 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 106 | SCF₃ | (CH₂)ₐ | 0 to 20 | Me | Me | 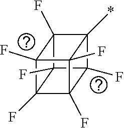 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 107 | N(CH₂CF₃)₂ | (CH₂)ₐ | 0 to 20 | Me | Me | 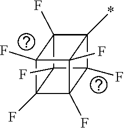 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 108 | N(CF₃)₂ | (CH₂)ₐ | 0 to 20 | Me | Me | 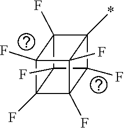 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 109 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 110 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 187

| No. | R²¹ | | a | R²² | R²³ | R²⁴ | | | R²⁵ | z21 | z22 |
|---|---|---|---|---|---|---|---|---|---|---|---|
| 111 | (CF₃)₂CF | (CH₂)ₐ | 0 to 20 | Me | Me | SF₅ | (CH₂)ₐ | 0 to 20 | Me | 5 to 100 | 0 |
| 112 | (CF₃)₃C | (CH₂)ₐ | 0 to 20 | Me | Me | SF₅ | (CH₂)ₐ | 0 to 20 | Me | 5 to 100 | 0 |
| 113 | C₄F₉ | (CH₂)ₐ | 0 to 20 | Me | Me | SF₅ | (CH₂)ₐ | 0 to 20 | Me | 5 to 100 | 0 |
| 114 | C₈F₁₇ | (CH₂)ₐ | 0 to 20 | Me | Me | SF₅ | (CH₂)ₐ | 0 to 20 | Me | 5 to 100 | 0 |
| 115 | c-C₆F₁₁ | (CH₂)ₐ | 0 to 20 | Me | Me | SF₅ | (CH₂)ₐ | 0 to 20 | Me | 5 to 100 | 0 |
| 116 | CHF₂ | (CH₂)ₐ | 0 to 20 | Me | Me | SF₅ | (CH₂)ₐ | 0 to 20 | Me | 5 to 100 | 0 |
| 117 | CClF₂ | (CH₂)ₐ | 0 to 20 | Me | Me | SF₅ | (CH₂)ₐ | 0 to 20 | Me | 5 to 100 | 0 |
| 118 | CBrF₂ | (CH₂)ₐ | 0 to 20 | Me | Me | SF₅ | (CH₂)ₐ | 0 to 20 | Me | 5 to 100 | 0 |
| 119 | ClF₂ | (CH₂)ₐ | 0 to 20 | Me | Me | SF₅ | (CH₂)ₐ | 0 to 20 | Me | 5 to 100 | 0 |
| 120 | CF═CF₂ | (CH₂)ₐ | 0 to 20 | Me | Me | SF₅ | (CH₂)ₐ | 0 to 20 | Me | 5 to 100 | 0 |
| 121 | CF═CFCF₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 111 | Me | Me | (CH₂)_{b} | 0 to 20 | C(═O)NHCH₂CH | (CH₂)_{c} | 1 to 20 | Si(OMe)₃ | 2 |
| 112 | Me | Me | (CH₂)_{b} | 0 to 20 | C(═O)NHCH₂CH | (CH₂)_{c} | 1 to 20 | Si(OMe)₃ | 2 |
| 113 | Me | Me | (CH₂)_{b} | 0 to 20 | C(═O)NHCH₂CH | (CH₂)_{c} | 1 to 20 | Si(OMe)₃ | 2 |
| 114 | Me | Me | (CH₂)_{b} | 0 to 20 | C(═O)NHCH₂CH | (CH₂)_{c} | 1 to 20 | Si(OMe)₃ | 2 |
| 115 | Me | Me | (CH₂)_{b} | 0 to 20 | C(═O)NHCH₂CH | (CH₂)_{c} | 1 to 20 | Si(OMe)₃ | 2 |
| 116 | Me | Me | (CH₂)_{b} | 0 to 20 | C(═O)NHCH₂CH | (CH₂)_{c} | 1 to 20 | Si(OMe)₃ | 2 |
| 117 | Me | Me | (CH₂)_{b} | 0 to 20 | C(═O)NHCH₂CH | (CH₂)_{c} | 1 to 20 | Si(OMe)₃ | 2 |
| 118 | Me | Me | (CH₂)_{b} | 0 to 20 | C(═O)NHCH₂CH | (CH₂)_{c} | 1 to 20 | Si(OMe)₃ | 2 |
| 119 | Me | Me | (CH₂)_{b} | 0 to 20 | C(═O)NHCH₂CH | (CH₂)_{c} | 1 to 20 | Si(OMe)₃ | 2 |
| 120 | Me | Me | (CH₂)_{b} | 0 to 20 | C(═O)NHCH₂CH | (CH₂)_{c} | 1 to 20 | Si(OMe)₃ | 2 |
| 121 | Me | Me | (CH₂)_{b} | 0 to 20 | C(═O)NHCH₂CH | (CH₂)_{c} | 1 to 20 | Si(OMe)₃ | 2 |

TABLE 188

| No. | R²¹ | | a | R²² | R²³ | R²⁴ | | | R²⁵ | z21 | z22 |
|---|---|---|---|---|---|---|---|---|---|---|---|
| 122 | CF═CFCF═CF₂ | (CH₂)ₐ | 0 to 20 | Me | Me | SF₅ | (CH₂)ₐ | 0 to 20 | Me | 5 to 100 | 0 |
| 123 | C≡CCF₃ | (CH₂)ₐ | 0 to 20 | Me | Me | SF₅ | (CH₂)ₐ | 0 to 20 | Me | 5 to 100 | 0 |
| 124 | CF₂CH₃ | (CH₂)ₐ | 0 to 20 | Me | Me | SF₅ | (CH₂)ₐ | 0 to 20 | Me | 5 to 100 | 0 |
| 125 | (CF₂)₂H | (CH₂)ₐ | 0 to 20 | Me | Me | SF₅ | (CH₂)ₐ | 0 to 20 | Me | 5 to 100 | 0 |
| 126 | (CF₂)₂CH₃ | (CH₂)ₐ | 0 to 20 | Me | Me | SF₅ | (CH₂)ₐ | 0 to 20 | Me | 5 to 100 | 0 |
| 127 | (CF₂)₄H | (CH₂)ₐ | 0 to 20 | Me | Me | SF₅ | (CH₂)ₐ | 0 to 20 | Me | 5 to 100 | 0 |
| 128 | C₆F₅ | (CH₂)ₐ | 0 to 20 | Me | Me | SF₅ | (CH₂)ₐ | 0 to 20 | Me | 5 to 100 | 0 |
| 129 | 4-CF₃C₆F₄ | (CH₂)ₐ | 0 to 20 | Me | Me | SF₅ | (CH₂)ₐ | 0 to 20 | Me | 5 to 100 | 0 |
| 130 | 4-SF₅C₆F₄ | (CH₂)ₐ | 0 to 20 | Me | Me | SF₅ | (CH₂)ₐ | 0 to 20 | Me | 5 to 100 | 0 |
| 131 | 3,5-CF₃C₆F₃ | (CH₂)ₐ | 0 to 20 | Me | Me | SF₅ | (CH₂)ₐ | 0 to 20 | Me | 5 to 100 | 0 |
| 132 | 3,5-SF₅C₆F₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 122 | Me | Me | (CH₂)_{b} | 0 to 20 | C(═O)NHCH₂CH | (CH₂)_{c} | 1 to 20 | Si(OMe)₃ | 2 |
| 123 | Me | Me | (CH₂)_{b} | 0 to 20 | C(═O)NHCH₂CH | (CH₂)_{c} | 1 to 20 | Si(OMe)₃ | 2 |
| 124 | Me | Me | (CH₂)_{b} | 0 to 20 | C(═O)NHCH₂CH | (CH₂)_{c} | 1 to 20 | Si(OMe)₃ | 2 |
| 125 | Me | Me | (CH₂)_{b} | 0 to 20 | C(═O)NHCH₂CH | (CH₂)_{c} | 1 to 20 | Si(OMe)₃ | 2 |
| 126 | Me | Me | (CH₂)_{b} | 0 to 20 | C(═O)NHCH₂CH | (CH₂)_{c} | 1 to 20 | Si(OMe)₃ | 2 |
| 127 | Me | Me | (CH₂)_{b} | 0 to 20 | C(═O)NHCH₂CH | (CH₂)_{c} | 1 to 20 | Si(OMe)₃ | 2 |
| 128 | Me | Me | (CH₂)_{b} | 0 to 20 | C(═O)NHCH₂CH | (CH₂)_{c} | 1 to 20 | Si(OMe)₃ | 2 |
| 129 | Me | Me | (CH₂)_{b} | 0 to 20 | C(═O)NHCH₂CH | (CH₂)_{c} | 1 to 20 | Si(OMe)₃ | 2 |
| 130 | Me | Me | (CH₂)_{b} | 0 to 20 | C(═O)NHCH₂CH | (CH₂)_{c} | 1 to 20 | Si(OMe)₃ | 2 |
| 131 | Me | Me | (CH₂)_{b} | 0 to 20 | C(═O)NHCH₂CH | (CH₂)_{c} | 1 to 20 | Si(OMe)₃ | 2 |
| 132 | Me | Me | (CH₂)_{b} | 0 to 20 | C(═O)NHCH₂CH | (CH₂)_{c} | 1 to 20 | Si(OMe)₃ | 2 |

TABLE 189

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 133 | 4-CF₃C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 134 | 4-SF₅C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 135 | 3,5-CF₃C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 136 | 3,5-SF₅C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 137 | 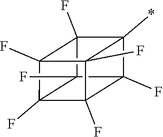 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 138 | 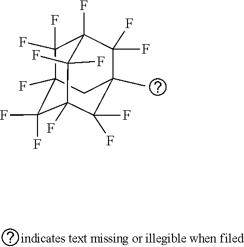 | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 139 | 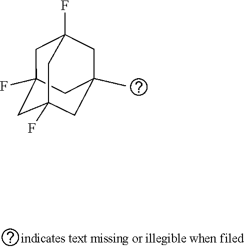 | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 140 | SF₅ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 141 | OCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 142 | SCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 143 | N(CH₂CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 190

| No. | R²¹ | | a | R²² | R²³ | R²⁴ | | | R²⁵ | z21 | z22 |
|---|---|---|---|---|---|---|---|---|---|---|---|
| 144 | N(CF₃)₂ | (CH₂)ₐ | 0 to 20 | Me | Me | SF₅ | (CH₂)ₐ | 0 to 20 | Me | 5 to 100 | 0 |
| 145 | Me | (CH₂)ₐ | 0 to 20 | Me | Me | OCF₃ | (CH₂)ₐ | 0 to 20 | Me | 5 to 100 | 0 |
| 146 | CF₃ | (CH₂)ₐ | 0 to 20 | Me | Me | OCF₃ | (CH₂)ₐ | 0 to 20 | Me | 5 to 100 | 0 |
| 147 | (CF₃)₂CF | (CH₂)ₐ | 0 to 20 | Me | Me | OCF₃ | (CH₂)ₐ | 0 to 20 | Me | 5 to 100 | 0 |
| 148 | (CF₃)₃C | (CH₂)ₐ | 0 to 20 | Me | Me | OCF₃ | (CH₂)ₐ | 0 to 20 | Me | 5 to 100 | 0 |
| 149 | C₄F₉ | (CH₂)ₐ | 0 to 20 | Me | Me | OCF₃ | (CH₂)ₐ | 0 to 20 | Me | 5 to 100 | 0 |
| 150 | C₈F₁₇ | (CH₂)ₐ | 0 to 20 | Me | Me | OCF₃ | (CH₂)ₐ | 0 to 20 | Me | 5 to 100 | 0 |
| 151 | c-C₆F₁₁ | (CH₂)ₐ | 0 to 20 | Me | Me | OCF₃ | (CH₂)ₐ | 0 to 20 | Me | 5 to 100 | 0 |
| 152 | CHF₂ | (CH₂)ₐ | 0 to 20 | Me | Me | OCF₃ | (CH₂)ₐ | 0 to 20 | Me | 5 to 100 | 0 |
| 153 | CClF₂ | (CH₂)ₐ | 0 to 20 | Me | Me | OCF₃ | (CH₂)ₐ | 0 to 20 | Me | 5 to 100 | 0 |
| 154 | CBrF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 144 | Me | Me | (CH₂)_{b} | 0 to 20 | C(═O)NHCH₂CH | (CH₂)_{c} | 1 to 20 | Si(OMe)₃ | 2 |
| 145 | Me | Me | (CH₂)_{b} | 0 to 20 | C(═O)NHCH₂CH | (CH₂)_{c} | 1 to 20 | Si(OMe)₃ | 2 |
| 146 | Me | Me | (CH₂)_{b} | 0 to 20 | C(═O)NHCH₂CH | (CH₂)_{c} | 1 to 20 | Si(OMe)₃ | 2 |
| 147 | Me | Me | (CH₂)_{b} | 0 to 20 | C(═O)NHCH₂CH | (CH₂)_{c} | 1 to 20 | Si(OMe)₃ | 2 |
| 148 | Me | Me | (CH₂)_{b} | 0 to 20 | C(═O)NHCH₂CH | (CH₂)_{c} | 1 to 20 | Si(OMe)₃ | 2 |
| 149 | Me | Me | (CH₂)_{b} | 0 to 20 | C(═O)NHCH₂CH | (CH₂)_{c} | 1 to 20 | Si(OMe)₃ | 2 |
| 150 | Me | Me | (CH₂)_{b} | 0 to 20 | C(═O)NHCH₂CH | (CH₂)_{c} | 1 to 20 | Si(OMe)₃ | 2 |
| 151 | Me | Me | (CH₂)_{b} | 0 to 20 | C(═O)NHCH₂CH | (CH₂)_{c} | 1 to 20 | Si(OMe)₃ | 2 |
| 152 | Me | Me | (CH₂)_{b} | 0 to 20 | C(═O)NHCH₂CH | (CH₂)_{c} | 1 to 20 | Si(OMe)₃ | 2 |
| 153 | Me | Me | (CH₂)_{b} | 0 to 20 | C(═O)NHCH₂CH | (CH₂)_{c} | 1 to 20 | Si(OMe)₃ | 2 |
| 154 | Me | Me | (CH₂)_{b} | 0 to 20 | C(═O)NHCH₂CH | (CH₂)_{c} | 1 to 20 | Si(OMe)₃ | 2 |

TABLE 191

| No. | R²¹ | | a | R²² | R²³ | R²⁴ | | | R²⁵ | z21 | z22 |
|---|---|---|---|---|---|---|---|---|---|---|---|
| 155 | ClF₂ | (CH₂)ₐ | 0 to 20 | Me | Me | OCF₃ | (CH₂)ₐ | 0 to 20 | Me | 5 to 100 | 0 |
| 156 | CF═CF₂ | (CH₂)ₐ | 0 to 20 | Me | Me | OCF₃ | (CH₂)ₐ | 0 to 20 | Me | 5 to 100 | 0 |
| 157 | CF═CFCF₃ | (CH₂)ₐ | 0 to 20 | Me | Me | OCF₃ | (CH₂)ₐ | 0 to 20 | Me | 5 to 100 | 0 |
| 158 | CF═CFCF═CF₂ | (CH₂)ₐ | 0 to 20 | Me | Me | OCF₃ | (CH₂)ₐ | 0 to 20 | Me | 5 to 100 | 0 |
| 159 | C≡CCF₃ | (CH₂)ₐ | 0 to 20 | Me | Me | OCF₃ | (CH₂)ₐ | 0 to 20 | Me | 5 to 100 | 0 |
| 160 | CF₂CH₃ | (CH₂)ₐ | 0 to 20 | Me | Me | OCF₃ | (CH₂)ₐ | 0 to 20 | Me | 5 to 100 | 0 |
| 161 | (CF₂)₂H | (CH₂)ₐ | 0 to 20 | Me | Me | OCF₃ | (CH₂)ₐ | 0 to 20 | Me | 5 to 100 | 0 |
| 162 | (CF₂)₂CH₃ | (CH₂)ₐ | 0 to 20 | Me | Me | OCF₃ | (CH₂)ₐ | 0 to 20 | Me | 5 to 100 | 0 |
| 163 | (CF₂)₄H | (CH₂)ₐ | 0 to 20 | Me | Me | OCF₃ | (CH₂)ₐ | 0 to 20 | Me | 5 to 100 | 0 |
| 164 | C₆F₅ | (CH₂)ₐ | 0 to 20 | Me | Me | OCF₃ | (CH₂)ₐ | 0 to 20 | Me | 5 to 100 | 0 |
| 165 | 4-CF₃C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 155 | Me | Me | (CH₂)_{b} | 0 to 20 | C(═O)NHCH₂CH | (CH₂)_{c} | 1 to 20 | Si(OMe)₃ | 2 |
| 156 | Me | Me | (CH₂)_{b} | 0 to 20 | C(═O)NHCH₂CH | (CH₂)_{c} | 1 to 20 | Si(OMe)₃ | 2 |
| 157 | Me | Me | (CH₂)_{b} | 0 to 20 | C(═O)NHCH₂CH | (CH₂)_{c} | 1 to 20 | Si(OMe)₃ | 2 |
| 158 | Me | Me | (CH₂)_{b} | 0 to 20 | C(═O)NHCH₂CH | (CH₂)_{c} | 1 to 20 | Si(OMe)₃ | 2 |
| 159 | Me | Me | (CH₂)_{b} | 0 to 20 | C(═O)NHCH₂CH | (CH₂)_{c} | 1 to 20 | Si(OMe)₃ | 2 |
| 160 | Me | Me | (CH₂)_{b} | 0 to 20 | C(═O)NHCH₂CH | (CH₂)_{c} | 1 to 20 | Si(OMe)₃ | 2 |
| 161 | Me | Me | (CH₂)_{b} | 0 to 20 | C(═O)NHCH₂CH | (CH₂)_{c} | 1 to 20 | Si(OMe)₃ | 2 |
| 162 | Me | Me | (CH₂)_{b} | 0 to 20 | C(═O)NHCH₂CH | (CH₂)_{c} | 1 to 20 | Si(OMe)₃ | 2 |
| 163 | Me | Me | (CH₂)_{b} | 0 to 20 | C(═O)NHCH₂CH | (CH₂)_{c} | 1 to 20 | Si(OMe)₃ | 2 |
| 164 | Me | Me | (CH₂)_{b} | 0 to 20 | C(═O)NHCH₂CH | (CH₂)_{c} | 1 to 20 | Si(OMe)₃ | 2 |
| 165 | Me | Me | (CH₂)_{b} | 0 to 20 | C(═O)NHCH₂CH | (CH₂)_{c} | 1 to 20 | Si(OMe)₃ | 2 |

TABLE 192

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 166 | 4-SF₅C₆F₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 167 | 3,5-CF₃C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 168 | 3,5-SF₅C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 169 | 4-CF₃C₆H₄ | (CH₂)ₐ | 0 to 20 | Me | Me | OCF₃ | (CH₂)ₐ | 0 to 20 | M? | 5 to 100 | 0 | Me | Me | (CH₂)_{b} | 0 to 20 | C(═O)NHCH₂CH | (CH₂)_{c} | 1 to 20 | Si(OMe)₃ | 2 |
| 170 | 4-SF₅C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 171 | 3,5-CF₃C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 172 | 3,5-SF₅C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 173 | 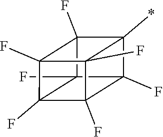 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 174 | 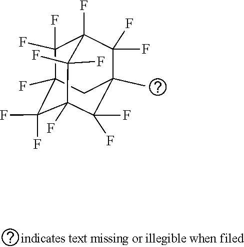 | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 175 | 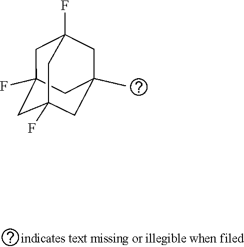 | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 176 | SF₅ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 193

| No. | R²¹ | | a | R²² | R²³ | R²⁴ | | | R²⁵ | z21 | z22 |
|---|---|---|---|---|---|---|---|---|---|---|---|
| 177 | OCF₃ | (CH₂)ₐ | 0 to 20 | Me | Me | OCF₃ | (CH₂)ₐ | 0 to 20 | Me | 5 to 100 | 0 |
| 178 | SCF₃ | (CH₂)ₐ | 0 to 20 | Me | Me | OCF₃ | (CH₂)ₐ | 0 to 20 | Me | 5 to 100 | 0 |
| 179 | N(CH₂CF₃)₂ | (CH₂)ₐ | 0 to 20 | Me | Me | OCF₃ | (CH₂)ₐ | 0 to 20 | Me | 5 to 100 | 0 |
| 180 | N(CF₃)₂ | (CH₂)ₐ | 0 to 20 | Me | Me | OCF₃ | (CH₂)ₐ | 0 to 20 | Me | 5 to 100 | 0 |
| 181 | Me | (CH₂)ₐ | 0 to 20 | Me | Me | SCF₃ | (CH₂)ₐ | 0 to 20 | Me | 5 to 100 | 0 |
| 182 | CF₃ | (CH₂)ₐ | 0 to 20 | Me | Me | SCF₃ | (CH₂)ₐ | 0 to 20 | Me | 5 to 100 | 0 |
| 183 | (CF₃)₂CF | (CH₂)ₐ | 0 to 20 | Me | Me | SCF₃ | (CH₂)ₐ | 0 to 20 | Me | 5 to 100 | 0 |
| 184 | (CF₃)₃C | (CH₂)ₐ | 0 to 20 | Me | Me | SCF₃ | (CH₂)ₐ | 0 to 20 | Me | 5 to 100 | 0 |
| 185 | C₄F₉ | (CH₂)ₐ | 0 to 20 | Me | Me | SCF₃ | (CH₂)ₐ | 0 to 20 | Me | 5 to 100 | 0 |
| 186 | C₈F₁₇ | (CH₂)ₐ | 0 to 20 | Me | Me | SCF₃ | (CH₂)ₐ | 0 to 20 | Me | 5 to 100 | 0 |
| 187 | c-C₆F₁₁ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 177 | Me | Me | (CH₂)_{b} | 0 to 20 | C(═O)NHCH₂CH | (CH₂)_{c} | 1 to 20 | Si(OMe)₃ | 2 |
| 178 | Me | Me | (CH₂)_{b} | 0 to 20 | C(═O)NHCH₂CH | (CH₂)_{c} | 1 to 20 | Si(OMe)₃ | 2 |
| 179 | Me | Me | (CH₂)_{b} | 0 to 20 | C(═O)NHCH₂CH | (CH₂)_{c} | 1 to 20 | Si(OMe)₃ | 2 |
| 180 | Me | Me | (CH₂)_{b} | 0 to 20 | C(═O)NHCH₂CH | (CH₂)_{c} | 1 to 20 | Si(OMe)₃ | 2 |
| 181 | Me | Me | (CH₂)_{b} | 0 to 20 | C(═O)NHCH₂CH | (CH₂)_{c} | 1 to 20 | Si(OMe)₃ | 2 |
| 182 | Me | Me | (CH₂)_{b} | 0 to 20 | C(═O)NHCH₂CH | (CH₂)_{c} | 1 to 20 | Si(OMe)₃ | 2 |
| 183 | Me | Me | (CH₂)_{b} | 0 to 20 | C(═O)NHCH₂CH | (CH₂)_{c} | 1 to 20 | Si(OMe)₃ | 2 |
| 184 | Me | Me | (CH₂)_{b} | 0 to 20 | C(═O)NHCH₂CH | (CH₂)_{c} | 1 to 20 | Si(OMe)₃ | 2 |
| 185 | Me | Me | (CH₂)_{b} | 0 to 20 | C(═O)NHCH₂CH | (CH₂)_{c} | 1 to 20 | Si(OMe)₃ | 2 |
| 186 | Me | Me | (CH₂)_{b} | 0 to 20 | C(═O)NHCH₂CH | (CH₂)_{c} | 1 to 20 | Si(OMe)₃ | 2 |
| 187 | Me | Me | (CH₂)_{b} | 0 to 20 | C(═O)NHCH₂CH | (CH₂)_{c} | 1 to 20 | Si(OMe)₃ | 2 |

TABLE 194

| No. | R²¹ | | a | R²² | R²³ | R²⁴ | | | R²⁵ | z21 | z22 |
|---|---|---|---|---|---|---|---|---|---|---|---|
| 188 | CHF₂ | (CH₂)ₐ | 0 to 20 | Me | Me | SCF₃ | (CH₂)ₐ | 0 to 20 | Me | 5 to 100 | 0 |
| 189 | CClF₂ | (CH₂)ₐ | 0 to 20 | Me | Me | SCF₃ | (CH₂)ₐ | 0 to 20 | Me | 5 to 100 | 0 |
| 190 | CBrF₂ | (CH₂)ₐ | 0 to 20 | Me | Me | SCF₃ | (CH₂)ₐ | 0 to 20 | Me | 5 to 100 | 0 |
| 191 | ClF₂ | (CH₂)ₐ | 0 to 20 | Me | Me | SCF₃ | (CH₂)ₐ | 0 to 20 | Me | 5 to 100 | 0 |
| 192 | CF═CF₂ | (CH₂)ₐ | 0 to 20 | Me | Me | SCF₃ | (CH₂)ₐ | 0 to 20 | Me | 5 to 100 | 0 |
| 193 | CF═CFCF₃ | (CH₂)ₐ | 0 to 20 | Me | Me | SCF₃ | (CH₂)ₐ | 0 to 20 | Me | 5 to 100 | 0 |
| 194 | CF═CFCF═CF₂ | (CH₂)ₐ | 0 to 20 | Me | Me | SCF₃ | (CH₂)ₐ | 0 to 20 | Me | 5 to 100 | 0 |
| 195 | C≡CCF₃ | (CH₂)ₐ | 0 to 20 | Me | Me | SCF₃ | (CH₂)ₐ | 0 to 20 | Me | 5 to 100 | 0 |
| 196 | CF₂CH₃ | (CH₂)ₐ | 0 to 20 | Me | Me | SCF₃ | (CH₂)ₐ | 0 to 20 | Me | 5 to 100 | 0 |
| 197 | (CF₂)₂H | (CH₂)ₐ | 0 to 20 | Me | Me | SCF₃ | (CH₂)ₐ | 0 to 20 | Me | 5 to 100 | 0 |
| 198 | (CF₂)₂CH₃ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 188 | Me | Me | (CH₂)_{b} | 0 to 20 | C(═O)NHCH₂CH | (CH₂)_{c} | 1 to 20 | Si(OMe)₃ | 2 |
| 189 | Me | Me | (CH₂)_{b} | 0 to 20 | C(═O)NHCH₂CH | (CH₂)_{c} | 1 to 20 | Si(OMe)₃ | 2 |
| 190 | Me | Me | (CH₂)_{b} | 0 to 20 | C(═O)NHCH₂CH | (CH₂)_{c} | 1 to 20 | Si(OMe)₃ | 2 |
| 191 | Me | Me | (CH₂)_{b} | 0 to 20 | C(═O)NHCH₂CH | (CH₂)_{c} | 1 to 20 | Si(OMe)₃ | 2 |
| 192 | Me | Me | (CH₂)_{b} | 0 to 20 | C(═O)NHCH₂CH | (CH₂)_{c} | 1 to 20 | Si(OMe)₃ | 2 |
| 193 | Me | Me | (CH₂)_{b} | 0 to 20 | C(═O)NHCH₂CH | (CH₂)_{c} | 1 to 20 | Si(OMe)₃ | 2 |
| 194 | Me | Me | (CH₂)_{b} | 0 to 20 | C(═O)NHCH₂CH | (CH₂)_{c} | 1 to 20 | Si(OMe)₃ | 2 |
| 195 | Me | Me | (CH₂)_{b} | 0 to 20 | C(═O)NHCH₂CH | (CH₂)_{c} | 1 to 20 | Si(OMe)₃ | 2 |
| 196 | Me | Me | (CH₂)_{b} | 0 to 20 | C(═O)NHCH₂CH | (CH₂)_{c} | 1 to 20 | Si(OMe)₃ | 2 |
| 197 | Me | Me | (CH₂)_{b} | 0 to 20 | C(═O)NHCH₂CH | (CH₂)_{c} | 1 to 20 | Si(OMe)₃ | 2 |
| 198 | Me | Me | (CH₂)_{b} | 0 to 20 | C(═O)NHCH₂CH | (CH₂)_{c} | 1 to 20 | Si(OMe)₃ | 2 |

TABLE 195

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 199 | (CF₂)₄H | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 200 | C₆F₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 201 | 4-CF₃C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 202 | 4-SF₅C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 203 | 3,5-CF₃C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 204 | 3,5-SF₅C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 205 | 4-CF₃C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 206 | 4-SF₅C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 207 | 3,5-CF₃C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 208 | 3,5-SF₅C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 209 | 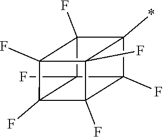 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 196

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 210 | 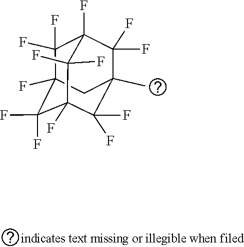 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 211 | 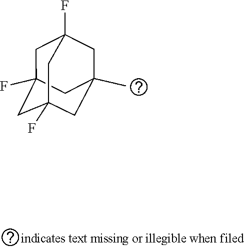 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 212 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 213 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 214 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 215 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 216 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 217 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 218 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 219 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 220 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |

TABLE 197

| No. | R²¹ | | a | R²² | R²³ | R²⁴ | | | R²⁵ | z21 | z22 |
|---|---|---|---|---|---|---|---|---|---|---|---|
| 221 | C₄F₉ | (CH₂)ₐ | 0 to 20 | Me | Me | N(CF₃)₂ | (CH₂)ₐ | 0 to 20 | Me | 5 to 100 | 0 |
| 222 | C₈F₁₇ | (CH₂)ₐ | 0 to 20 | Me | Me | N(CF₃)₂ | (CH₂)ₐ | 0 to 20 | Me | 5 to 100 | 0 |
| 223 | c-C₆F₁₁ | (CH₂)ₐ | 0 to 20 | Me | Me | N(CF₃)₂ | (CH₂)ₐ | 0 to 20 | Me | 5 to 100 | 0 |
| 224 | CHF₂ | (CH₂)ₐ | 0 to 20 | Me | Me | N(CF₃)₂ | (CH₂)ₐ | 0 to 20 | Me | 5 to 100 | 0 |
| 225 | CClF₂ | (CH₂)ₐ | 0 to 20 | Me | Me | N(CF₃)₂ | (CH₂)ₐ | 0 to 20 | Me | 5 to 100 | 0 |
| 226 | CBrF₂ | (CH₂)ₐ | 0 to 20 | Me | Me | N(CF₃)₂ | (CH₂)ₐ | 0 to 20 | Me | 5 to 100 | 0 |
| 227 | ClF₂ | (CH₂)ₐ | 0 to 20 | Me | Me | N(CF₃)₂ | (CH₂)ₐ | 0 to 20 | Me | 5 to 100 | 0 |
| 228 | CF═CF₂ | (CH₂)ₐ | 0 to 20 | Me | Me | N(CF₃)₂ | (CH₂)ₐ | 0 to 20 | Me | 5 to 100 | 0 |
| 229 | CF═CFCF₃ | (CH₂)ₐ | 0 to 20 | Me | Me | N(CF₃)₂ | (CH₂)ₐ | 0 to 20 | Me | 5 to 100 | 0 |
| 230 | CF═CFCF═CF₂ | (CH₂)ₐ | 0 to 20 | Me | Me | N(CF₃)₂ | (CH₂)ₐ | 0 to 20 | Me | 5 to 100 | 0 |
| 231 | C≡CCF₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 221 | Me | Me | (CH₂)_{b} | 0 to 20 | C(═O)NHCH₂CH | (CH₂)_{c} | 1 to 20 | Si(OMe)₃ | 2 |
| 222 | Me | Me | (CH₂)_{b} | 0 to 20 | C(═O)NHCH₂CH | (CH₂)_{c} | 1 to 20 | Si(OMe)₃ | 2 |
| 223 | Me | Me | (CH₂)_{b} | 0 to 20 | C(═O)NHCH₂CH | (CH₂)_{c} | 1 to 20 | Si(OMe)₃ | 2 |
| 224 | Me | Me | (CH₂)_{b} | 0 to 20 | C(═O)NHCH₂CH | (CH₂)_{c} | 1 to 20 | Si(OMe)₃ | 2 |
| 225 | Me | Me | (CH₂)_{b} | 0 to 20 | C(═O)NHCH₂CH | (CH₂)_{c} | 1 to 20 | Si(OMe)₃ | 2 |
| 226 | Me | Me | (CH₂)_{b} | 0 to 20 | C(═O)NHCH₂CH | (CH₂)_{c} | 1 to 20 | Si(OMe)₃ | 2 |
| 227 | Me | Me | (CH₂)_{b} | 0 to 20 | C(═O)NHCH₂CH | (CH₂)_{c} | 1 to 20 | Si(OMe)₃ | 2 |
| 228 | Me | Me | (CH₂)_{b} | 0 to 20 | C(═O)NHCH₂CH | (CH₂)_{c} | 1 to 20 | Si(OMe)₃ | 2 |
| 229 | Me | Me | (CH₂)_{b} | 0 to 20 | C(═O)NHCH₂CH | (CH₂)_{c} | 1 to 20 | Si(OMe)₃ | 2 |
| 230 | Me | Me | (CH₂)_{b} | 0 to 20 | C(═O)NHCH₂CH | (CH₂)_{c} | 1 to 20 | Si(OMe)₃ | 2 |
| 231 | Me | Me | (CH₂)_{b} | 0 to 20 | C(═O)NHCH₂CH | (CH₂)_{c} | 1 to 20 | Si(OMe)₃ | 2 |

TABLE 198

| No. | R²¹ | | a | R²² | R²³ | R²⁴ | | | R²⁵ | z21 | z22 |
|---|---|---|---|---|---|---|---|---|---|---|---|
| 232 | CF₂CH₃ | (CH₂)ₐ | 0 to 20 | Me | Me | N(CF₃)₂ | (CH₂)ₐ | 0 to 20 | Me | 5 to 100 | 0 |
| 233 | (CF₂)₂H | (CH₂)ₐ | 0 to 20 | Me | Me | N(CF₃)₂ | (CH₂)ₐ | 0 to 20 | Me | 5 to 100 | 0 |
| 234 | (CF₂)₂CH₃ | (CH₂)ₐ | 0 to 20 | Me | Me | N(CF₃)₂ | (CH₂)ₐ | 0 to 20 | Me | 5 to 100 | 0 |
| 235 | (CF₂)₄H | (CH₂)ₐ | 0 to 20 | Me | Me | SCF₃ | (CH₂)ₐ | 0 to 20 | Me | 5 to 100 | 0 |
| 236 | C₆F₅ | (CH₂)ₐ | 0 to 20 | Me | Me | N(CF₃)₂ | (CH₂)ₐ | 0 to 20 | Me | 5 to 100 | 0 |
| 237 | 4-CF₃C₆F₄ | (CH₂)ₐ | 0 to 20 | Me | Me | N(CF₃)₂ | (CH₂)ₐ | 0 to 20 | Me | 5 to 100 | 0 |
| 238 | 4-SF₅C₆F₄ | (CH₂)ₐ | 0 to 20 | Me | Me | N(CF₃)₂ | (CH₂)ₐ | 0 to 20 | Me | 5 to 100 | 0 |
| 239 | 3,5-CF₃C₆F₃ | (CH₂)ₐ | 0 to 20 | Me | Me | N(CF₃)₂ | (CH₂)ₐ | 0 to 20 | Me | 5 to 100 | 0 |
| 240 | 3,5-SF₅C₆F₃ | (CH₂)ₐ | 0 to 20 | Me | Me | N(CF₃)₂ | (CH₂)ₐ | 0 to 20 | Me | 5 to 100 | 0 |
| 241 | 4-CF₃C₆H₄ | (CH₂)ₐ | 0 to 20 | Me | Me | N(CF₃)₂ | (CH₂)ₐ | 0 to 20 | Me | 5 to 100 | 0 |
| 242 | 4-SF₅C₆H₄ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 232 | Me | Me | (CH₂)_{b} | 0 to 20 | C(═O)NHCH₂CH | (CH₂)_{c} | 1 to 20 | Si(OMe)₃ | 2 |
| 233 | Me | Me | (CH₂)_{b} | 0 to 20 | C(═O)NHCH₂CH | (CH₂)_{c} | 1 to 20 | Si(OMe)₃ | 2 |
| 234 | Me | Me | (CH₂)_{b} | 0 to 20 | C(═O)NHCH₂CH | (CH₂)_{c} | 1 to 20 | Si(OMe)₃ | 2 |
| 235 | Me | Me | (CH₂)_{b} | 0 to 20 | C(═O)NHCH₂CH | (CH₂)_{c} | 1 to 20 | Si(OMe)₃ | 2 |
| 236 | Me | Me | (CH₂)_{b} | 0 to 20 | C(═O)NHCH₂CH | (CH₂)_{c} | 1 to 20 | Si(OMe)₃ | 2 |
| 237 | Me | Me | (CH₂)_{b} | 0 to 20 | C(═O)NHCH₂CH | (CH₂)_{c} | 1 to 20 | Si(OMe)₃ | 2 |
| 238 | Me | Me | (CH₂)_{b} | 0 to 20 | C(═O)NHCH₂CH | (CH₂)_{c} | 1 to 20 | Si(OMe)₃ | 2 |
| 239 | Me | Me | (CH₂)_{b} | 0 to 20 | C(═O)NHCH₂CH | (CH₂)_{c} | 1 to 20 | Si(OMe)₃ | 2 |
| 240 | Me | Me | (CH₂)_{b} | 0 to 20 | C(═O)NHCH₂CH | (CH₂)_{c} | 1 to 20 | Si(OMe)₃ | 2 |
| 241 | Me | Me | (CH₂)_{b} | 0 to 20 | C(═O)NHCH₂CH | (CH₂)_{c} | 1 to 20 | Si(OMe)₃ | 2 |
| 242 | Me | Me | (CH₂)_{b} | 0 to 20 | C(═O)NHCH₂CH | (CH₂)_{c} | 1 to 20 | Si(OMe)₃ | 2 |

TABLE 199

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 243 | 3,5-CF₃C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 244 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 245 | 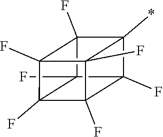 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 246 | 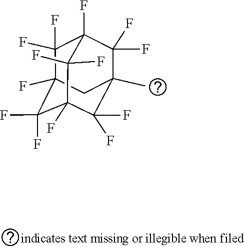 | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 247 | 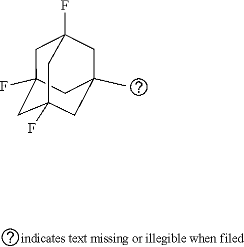 | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 248 | SF₅ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 249 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 250 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 251 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 252 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)NHCH₂CH | (CH₂)_{c} | 1 to 20 | Si(OMe)₃ | 2 |
| 253 | Me | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 200

| No. | R²¹ | | a | R²² | R²³ | R²⁴ | | | R²⁵ | z21 | z22 |
|---|---|---|---|---|---|---|---|---|---|---|---|
| 254 | CF₃ | (CH₂)ₐ | 0 to 20 | Me | Me | CF₃ | (CH₂)ₐ | 0 to 20 | Me | 5 to 100 | 0 |
| 255 | (CF₃)₂CF | (CH₂)ₐ | 0 to 20 | Me | Me | CF₃ | (CH₂)ₐ | 0 to 20 | Me | 5 to 100 | 0 |
| 256 | (CF₃)₃C | (CH₂)ₐ | 0 to 20 | Me | Me | CF₃ | (CH₂)ₐ | 0 to 20 | Me | 5 to 100 | 0 |
| 257 | C₄F₉ | (CH₂)ₐ | 0 to 20 | Me | Me | CF₃ | (CH₂)ₐ | 0 to 20 | Me | 5 to 100 | 0 |
| 258 | C₈F₁₇ | (CH₂)ₐ | 0 to 20 | Me | Me | CF₃ | (CH₂)ₐ | 0 to 20 | Me | 5 to 100 | 0 |
| 259 | c-C₆F₁₁ | (CH₂)ₐ | 0 to 20 | Me | Me | CF₃ | (CH₂)ₐ | 0 to 20 | Me | 5 to 100 | 0 |
| 260 | CHF₂ | (CH₂)ₐ | 0 to 20 | Me | Me | CF₃ | (CH₂)ₐ | 0 to 20 | Me | 5 to 100 | 0 |
| 261 | CClF₂ | (CH₂)ₐ | 0 to 20 | Me | Me | CF₃ | (CH₂)ₐ | 0 to 20 | Me | 5 to 100 | 0 |
| 262 | CBrF₂ | (CH₂)ₐ | 0 to 20 | Me | Me | CF₃ | (CH₂)ₐ | 0 to 20 | Me | 5 to 100 | 0 |
| 263 | ClF₂ | (CH₂)ₐ | 0 to 20 | Me | Me | CF₃ | (CH₂)ₐ | 0 to 20 | Me | 5 to 100 | 0 |
| 264 | CF═CF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 254 | Me | Me | (CH₂)_{b} | 0 to 20 | NHC(═O)CH₂CH | (CH₂)_{c} | 1 to 20 | Si(OMe)₃ | 2 |
| 255 | Me | Me | (CH₂)_{b} | 0 to 20 | NHC(═O)CH₂CH | (CH₂)_{c} | 1 to 20 | Si(OMe)₃ | 2 |
| 256 | Me | Me | (CH₂)_{b} | 0 to 20 | NHC(═O)CH₂CH | (CH₂)_{c} | 1 to 20 | Si(OMe)₃ | 2 |
| 257 | Me | Me | (CH₂)_{b} | 0 to 20 | NHC(═O)CH₂CH | (CH₂)_{c} | 1 to 20 | Si(OMe)₃ | 2 |
| 258 | Me | Me | (CH₂)_{b} | 0 to 20 | NHC(═O)CH₂CH | (CH₂)_{c} | 1 to 20 | Si(OMe)₃ | 2 |
| 259 | Me | Me | (CH₂)_{b} | 0 to 20 | NHC(═O)CH₂CH | (CH₂)_{c} | 1 to 20 | Si(OMe)₃ | 2 |
| 260 | Me | Me | (CH₂)_{b} | 0 to 20 | NHC(═O)CH₂CH | (CH₂)_{c} | 1 to 20 | Si(OMe)₃ | 2 |
| 261 | Me | Me | (CH₂)_{b} | 0 to 20 | NHC(═O)CH₂CH | (CH₂)_{c} | 1 to 20 | Si(OMe)₃ | 2 |
| 262 | Me | Me | (CH₂)_{b} | 0 to 20 | NHC(═O)CH₂CH | (CH₂)_{c} | 1 to 20 | Si(OMe)₃ | 2 |
| 263 | Me | Me | (CH₂)_{b} | 0 to 20 | NHC(═O)CH₂CH | (CH₂)_{c} | 1 to 20 | Si(OMe)₃ | 2 |
| 264 | Me | Me | (CH₂)_{b} | 0 to 20 | NHC(═O)CH₂CH | (CH₂)_{c} | 1 to 20 | Si(OMe)₃ | 2 |

TABLE 201

| No. | R²¹ | | a | R²² | R²³ | R²⁴ | | | R²⁵ | z21 | z22 |
|---|---|---|---|---|---|---|---|---|---|---|---|
| 265 | CF═CFCF₃ | (CH₂)ₐ | 0 to 20 | Me | Me | CF₃ | (CH₂)ₐ | 0 to 20 | Me | 5 to 100 | 0 |
| 266 | CF═CFCF═CF₂ | (CH₂)ₐ | 0 to 20 | Me | Me | CF₃ | (CH₂)ₐ | 0 to 20 | Me | 5 to 100 | 0 |
| 267 | C≡CCF₃ | (CH₂)ₐ | 0 to 20 | Me | Me | CF₃ | (CH₂)ₐ | 0 to 20 | Me | 5 to 100 | 0 |
| 268 | CF₂CH₃ | (CH₂)ₐ | 0 to 20 | Me | Me | CF₃ | (CH₂)ₐ | 0 to 20 | Me | 5 to 100 | 0 |
| 269 | (CF₂)₂H | (CH₂)ₐ | 0 to 20 | Me | Me | CF₃ | (CH₂)ₐ | 0 to 20 | Me | 5 to 100 | 0 |
| 270 | (CF₂)₂CH₃ | (CH₂)ₐ | 0 to 20 | Me | Me | CF₃ | (CH₂)ₐ | 0 to 20 | Me | 5 to 100 | 0 |
| 271 | (CF₂)₄H | (CH₂)ₐ | 0 to 20 | Me | Me | CF₃ | (CH₂)ₐ | 0 to 20 | Me | 5 to 100 | 0 |
| 272 | C₆F₅ | (CH₂)ₐ | 0 to 20 | Me | Me | CF₃ | (CH₂)ₐ | 0 to 20 | Me | 5 to 100 | 0 |
| 273 | 4-CF₃C₆F₄ | (CH₂)ₐ | 0 to 20 | Me | Me | CF₃ | (CH₂)ₐ | 0 to 20 | Me | 5 to 100 | 0 |
| 274 | 4-SF₅C₆F₄ | (CH₂)ₐ | 0 to 20 | Me | Me | CF₃ | (CH₂)ₐ | 0 to 20 | Me | 5 to 100 | 0 |
| 275 | 3,5-CF₃C₆F₃ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 265 | Me | Me | (CH₂)_{b} | 0 to 20 | NHC(═O)CH₂CH | (CH₂)_{c} | 1 to 20 | Si(OMe)₃ | 2 |
| 266 | Me | Me | (CH₂)_{b} | 0 to 20 | NHC(═O)CH₂CH | (CH₂)_{c} | 1 to 20 | Si(OMe)₃ | 2 |
| 267 | Me | Me | (CH₂)_{b} | 0 to 20 | NHC(═O)CH₂CH | (CH₂)_{c} | 1 to 20 | Si(OMe)₃ | 2 |
| 268 | Me | Me | (CH₂)_{b} | 0 to 20 | NHC(═O)CH₂CH | (CH₂)_{c} | 1 to 20 | Si(OMe)₃ | 2 |
| 269 | Me | Me | (CH₂)_{b} | 0 to 20 | NHC(═O)CH₂CH | (CH₂)_{c} | 1 to 20 | Si(OMe)₃ | 2 |
| 270 | Me | Me | (CH₂)_{b} | 0 to 20 | NHC(═O)CH₂CH | (CH₂)_{c} | 1 to 20 | Si(OMe)₃ | 2 |
| 271 | Me | Me | (CH₂)_{b} | 0 to 20 | NHC(═O)CH₂CH | (CH₂)_{c} | 1 to 20 | Si(OMe)₃ | 2 |
| 272 | Me | Me | (CH₂)_{b} | 0 to 20 | NHC(═O)CH₂CH | (CH₂)_{c} | 1 to 20 | Si(OMe)₃ | 2 |
| 273 | Me | Me | (CH₂)_{b} | 0 to 20 | NHC(═O)CH₂CH | (CH₂)_{c} | 1 to 20 | Si(OMe)₃ | 2 |
| 274 | Me | Me | (CH₂)_{b} | 0 to 20 | NHC(═O)CH₂CH | (CH₂)_{c} | 1 to 20 | Si(OMe)₃ | 2 |
| 275 | Me | Me | (CH₂)_{b} | 0 to 20 | NHC(═O)CH₂CH | (CH₂)_{c} | 1 to 20 | Si(OMe)₃ | 2 |

TABLE 202

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 276 | 3,5-SF₅C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 277 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 278 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 279 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 280 | 3,5-SF₅C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 281 | 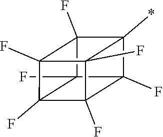 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 282 | 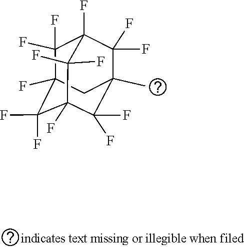 | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 283 | 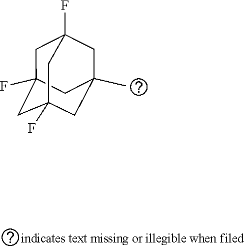 | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 284 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 285 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 286 | SCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 203

| No. | R²¹ | | a | R²² | R²³ | R²⁴ | | | R²⁵ | z21 | z22 |
|---|---|---|---|---|---|---|---|---|---|---|---|
| 287 | N(CH₂CF₃)₂ | (CH₂)ₐ | 0 to 20 | Me | Me | CF₃ | (CH₂)ₐ | 0 to 20 | Me | 5 to 100 | 0 |
| 288 | N(CF₃)₂ | (CH₂)ₐ | 0 to 20 | Me | Me | CF₃ | (CH₂)ₐ | 0 to 20 | Me | 5 to 100 | 0 |
| 289 | Me | (CH₂)ₐ | 0 to 20 | Me | Me | CHF₂ | (CH₂)ₐ | 0 to 20 | Me | 5 to 100 | 0 |
| 290 | CF₃ | (CH₂)ₐ | 0 to 20 | Me | Me | CHF₂ | (CH₂)ₐ | 0 to 20 | Me | 5 to 100 | 0 |
| 291 | (CF₃)₂CF | (CH₂)ₐ | 0 to 20 | Me | Me | CHF₂ | (CH₂)ₐ | 0 to 20 | Me | 5 to 100 | 0 |
| 292 | (CF₃)₃C | (CH₂)ₐ | 0 to 20 | Me | Me | CHF₂ | (CH₂)ₐ | 0 to 20 | Me | 5 to 100 | 0 |
| 293 | C₄F₉ | (CH₂)ₐ | 0 to 20 | Me | Me | CHF₂ | (CH₂)ₐ | 0 to 20 | Me | 5 to 100 | 0 |
| 294 | C₈F₁₇ | (CH₂)ₐ | 0 to 20 | Me | Me | CHF₂ | (CH₂)ₐ | 0 to 20 | Me | 5 to 100 | 0 |
| 295 | c-C₆F₁₁ | (CH₂)ₐ | 0 to 20 | Me | Me | CHF₂ | (CH₂)ₐ | 0 to 20 | Me | 5 to 100 | 0 |
| 296 | CHF₂ | (CH₂)ₐ | 0 to 20 | Me | Me | CHF₂ | (CH₂)ₐ | 0 to 20 | Me | 5 to 100 | 0 |
| 297 | CClF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 287 | Me | Me | (CH₂)_{b} | 0 to 20 | NHC(═O)CH₂CH | (CH₂)_{c} | 1 to 20 | Si(OMe)₃ | 2 |
| 288 | Me | Me | (CH₂)_{b} | 0 to 20 | NHC(═O)CH₂CH | (CH₂)_{c} | 1 to 20 | Si(OMe)₃ | 2 |
| 289 | Me | Me | (CH₂)_{b} | 0 to 20 | NHC(═O)CH₂CH | (CH₂)_{c} | 1 to 20 | Si(OMe)₃ | 2 |
| 290 | Me | Me | (CH₂) | 0 to 20 | NHC(═O)CH₂CH | (CH₂)_{c} | 1 to 20 | Si(OMe)₃ | 2 |
| 291 | Me | Me | (CH₂)_{b} | 0 to 20 | NHC(═O)CH₂CH | (CH₂)_{c} | 1 to 20 | Si(OMe)₃ | 2 |
| 292 | Me | Me | (CH₂)_{b} | 0 to 20 | NHC(═O)CH₂CH | (CH₂)_{c} | 1 to 20 | Si(OMe)₃ | 2 |
| 293 | Me | Me | (CH₂)_{b} | 0 to 20 | NHC(═O)CH₂CH | (CH₂)_{c} | 1 to 20 | Si(OMe)₃ | 2 |
| 294 | Me | Me | (CH₂) | 0 to 20 | NHC(═O)CH₂CH | (CH₂)_{c} | 1 to 20 | Si(OMe)₃ | 2 |
| 295 | Me | Me | (CH₂) | 0 to 20 | NHC(═O)CH₂CH | (CH₂)_{c} | 1 to 20 | Si(OMe)₃ | 2 |
| 296 | Me | Me | (CH₂)_{b} | 0 to 20 | NHC(═O)CH₂CH | (CH₂)_{c} | 1 to 20 | Si(OMe)₃ | 2 |
| 297 | Me | Me | (CH₂)_{b} | 0 to 20 | NHC(═O)CH₂CH | (CH₂)_{c} | 1 to 20 | Si(OMe)₃ | 2 |

TABLE 204

| No. | R²¹ | | a | R²² | R²³ | R²⁴ | | | R²⁵ | z21 | z22 |
|---|---|---|---|---|---|---|---|---|---|---|---|
| 298 | CBrF₂ | (CH₂)ₐ | 0 to 20 | Me | Me | CHF₂ | (CH₂)ₐ | 0 to 20 | Me | 5 to 100 | 0 |
| 299 | ClF₂ | (CH₂)ₐ | 0 to 20 | Me | Me | CHF₂ | (CH₂)ₐ | 0 to 20 | Me | 5 to 100 | 0 |
| 300 | CF═CF₂ | (CH₂)ₐ | 0 to 20 | Me | Me | CHF₂ | (CH₂)ₐ | 0 to 20 | Me | 5 to 100 | 0 |
| 301 | CF═CFCF₃ | (CH₂)ₐ | 0 to 20 | Me | Me | CHF₂ | (CH₂)ₐ | 0 to 20 | Me | 5 to 100 | 0 |
| 302 | CF═CFCF═CF₂ | (CH₂)ₐ | 0 to 20 | Me | Me | CHF₂ | (CH₂)ₐ | 0 to 20 | Me | 5 to 100 | 0 |
| 303 | C≡CCF₃ | (CH₂)ₐ | 0 to 20 | Me | Me | CHF₂ | (CH₂)ₐ | 0 to 20 | Me | 5 to 100 | 0 |
| 304 | CF₂CH₃ | (CH₂)ₐ | 0 to 20 | Me | Me | CHF₂ | (CH₂)ₐ | 0 to 20 | Me | 5 to 100 | 0 |
| 305 | (CF₂)₂H | (CH₂)ₐ | 0 to 20 | Me | Me | CHF₂ | (CH₂)ₐ | 0 to 20 | Me | 5 to 100 | 0 |
| 306 | (CF₂)₂CH₃ | (CH₂)ₐ | 0 to 20 | Me | Me | CHF₂ | (CH₂)ₐ | 0 to 20 | Me | 5 to 100 | 0 |
| 307 | (CF₂)₄H | (CH₂)ₐ | 0 to 20 | Me | Me | CHF₂ | (CH₂)ₐ | 0 to 20 | Me | 5 to 100 | 0 |
| 308 | C₆F₅ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 298 | Me | Me | (CH₂)_{b} | 0 to 20 | NHC(═O)CH₂CH | (CH₂)_{c} | 1 to 20 | Si(OMe)₃ | 2 |
| 299 | Me | Me | (CH₂)_{b} | 0 to 20 | NHC(═O)CH₂CH | (CH₂)_{c} | 1 to 20 | Si(OMe)₃ | 2 |
| 300 | Me | Me | (CH₂)_{b} | 0 to 20 | NHC(═O)CH₂CH | (CH₂)_{c} | 1 to 20 | Si(OMe)₃ | 2 |
| 301 | Me | Me | (CH₂)_{b} | 0 to 20 | NHC(═O)CH₂CH | (CH₂)_{c} | 1 to 20 | Si(OMe)₃ | 2 |
| 302 | Me | Me | (CH₂)_{b} | 0 to 20 | NHC(═O)CH₂CH | (CH₂)_{c} | 1 to 20 | Si(OMe)₃ | 2 |
| 303 | Me | Me | (CH₂)_{b} | 0 to 20 | NHC(═O)CH₂CH | (CH₂)_{c} | 1 to 20 | Si(OMe)₃ | 2 |
| 304 | Me | Me | (CH₂)_{b} | 0 to 20 | NHC(═O)CH₂CH | (CH₂)_{c} | 1 to 20 | Si(OMe)₃ | 2 |
| 305 | Me | Me | (CH₂)_{b} | 0 to 20 | NHC(═O)CH₂CH | (CH₂)_{c} | 1 to 20 | Si(OMe)₃ | 2 |
| 306 | Me | Me | (CH₂)_{b} | 0 to 20 | NHC(═O)CH₂CH | (CH₂)_{c} | 1 to 20 | Si(OMe)₃ | 2 |
| 307 | Me | Me | (CH₂)_{b} | 0 to 20 | NHC(═O)CH₂CH | (CH₂)_{c} | 1 to 20 | Si(OMe)₃ | 2 |
| 308 | Me | Me | (CH₂)_{b} | 0 to 20 | NHC(═O)CH₂CH | (CH₂)_{c} | 1 to 20 | Si(OMe)₃ | 2 |

TABLE 205

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 309 | 4-CF₃C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 310 | 4-SF₅C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 311 | 3,5-CF₃C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 312 | 3,5-SF₅C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 313 | 4-CF₃C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 314 | 4-SF₅C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 315 | 3,5-CF₃C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 316 | 3,5-SF₅C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 317 | 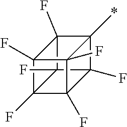 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 318 | 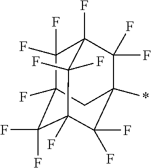 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 319 | 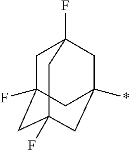 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 206

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 320 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 321 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 322 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 323 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 324 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 325 | Me | (CH₂)ₐ | 0 to 20 | Me | Me | 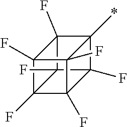 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 326 | CF₃ | (CH₂)ₐ | 0 to 20 | Me | Me | 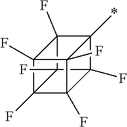 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 327 | (CF₃)₂CF | (CH₂)ₐ | 0 to 20 | Me | Me | 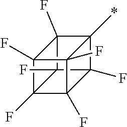 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 328 | (CF₃)₃C | (CH₂)ₐ | 0 to 20 | Me | Me | 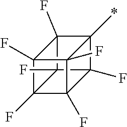 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 329 | C₄F₉ | (CH₂)ₐ | 0 to 20 | Me | Me | 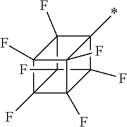 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 330 | C₈F₁₇ | (CH₂)ₐ | 0 to 20 | Me | Me | 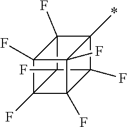 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 207

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 331 | c-C₆F₁₁ | (CH₂)ₐ | 0 to 20 | Me | Me | 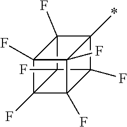 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 332 | CHF₂ | (CH₂)ₐ | 0 to 20 | Me | Me | 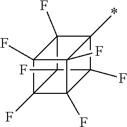 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 333 | CClF₂ | (CH₂)ₐ | 0 to 20 | Me | Me | 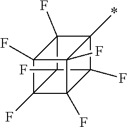 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 334 | CBrF₂ | (CH₂)ₐ | 0 to 20 | Me | Me | 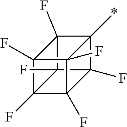 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 335 | ClF₂ | (CH₂)ₐ | 0 to 20 | Me | Me | 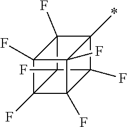 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 336 | CF═CF₂ | (CH₂)ₐ | 0 to 20 | Me | Me | 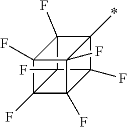 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 337 | CF═CFCF₃ | (CH₂)ₐ | 0 to 20 | Me | Me | 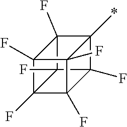 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 338 | CF═CFCF═CF₂ | (CH₂)ₐ | 0 to 20 | Me | Me | 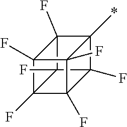 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 339 | C≡CCF₃ | (CH₂)ₐ | 0 to 20 | Me | Me | 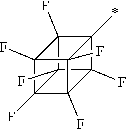 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 340 | CF₂CH₃ | (CH₂)ₐ | 0 to 20 | Me | Me | 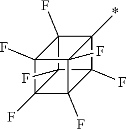 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 341 | (CF₂)₂H | (CH₂)ₐ | 0 to 20 | Me | Me | 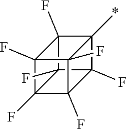 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 208

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 342 | (CF₂)₂CH₃ | (CH₂)ₐ | 0 to 20 | Me | Me | 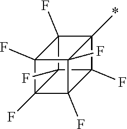 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 343 | (CF₂)₄H | (CH₂)ₐ | 0 to 20 | Me | Me | 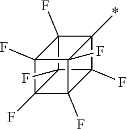 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 344 | C₆F₅ | (CH₂)ₐ | 0 to 20 | Me | Me | 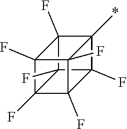 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 345 | 4-CF₃C₆F₄ | (CH₂)ₐ | 0 to 20 | Me | Me | 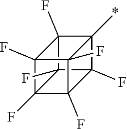 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 346 | 4-SF₅C₆F₄ | (CH₂)ₐ | 0 to 20 | Me | Me | 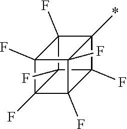 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 347 | 3,5-CF₃C₆F₃ | (CH₂)ₐ | 0 to 20 | Me | Me | 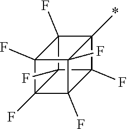 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 348 | 3,5-SF₅C₆F₃ | (CH₂)ₐ | 0 to 20 | Me | Me | 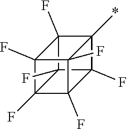 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 349 | 4-CF₃C₆H₄ | (CH₂)ₐ | 0 to 20 | Me | Me | 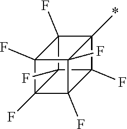 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 350 | 4-SF₅C₆H₄ | (CH₂)ₐ | 0 to 20 | Me | Me | 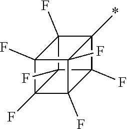 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 351 | 3,5-CF₃C₆H₃ | (CH₂)ₐ | 0 to 20 | Me | Me | 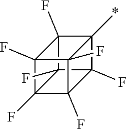 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 352 | 3,5-SF₅C₆H₃ | (CH₂)ₐ | 0 to 20 | Me | Me | 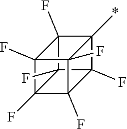 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 209

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 353 | 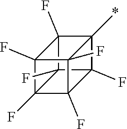 [SMILES: *C12C3(F)C4(F)C1(F)C1(F)C2(F)C3(F)C41F] | (CH₂)ₐ | 0 to 20 | Me | Me | 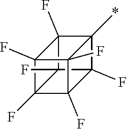 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 354 | 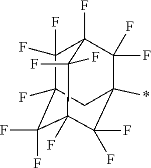 [SMILES: *C12CC3(F)C(F)(F)C(F)(C1(F)F)C(F)(F)C(F)(C2(F)F)C3(F)F] | (CH₂)ₐ | 0 to 20 | Me | Me | 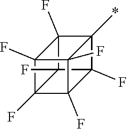 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 355 | 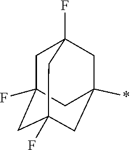 [SMILES: *C12CC3(F)CC(F)(C1)CC(F)(C2)C3] | (CH₂)ₐ | 0 to 20 | Me | Me | 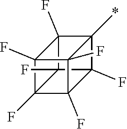 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 356 | SF₅ | (CH₂)ₐ | 0 to 20 | Me | Me | 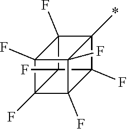 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 357 | OCF₃ | (CH₂)ₐ | 0 to 20 | Me | Me | 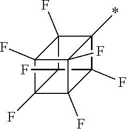 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 358 | SCF₃ | (CH₂)ₐ | 0 to 20 | Me | Me | 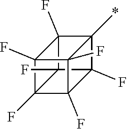 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 359 | N(CH₂CF₃)₂ | (CH₂)ₐ | 0 to 20 | Me | Me | 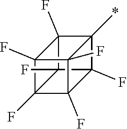 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 360 | N(CF₃)₂ | (CH₂)ₐ | 0 to 20 | Me | Me | 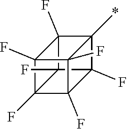 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 361 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 362 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 363 | (CF₃)₂CF | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 210

| No. | R²¹ | | a | R²² | R²³ | R²⁴ | | | R²⁵ | z21 | z22 |
|---|---|---|---|---|---|---|---|---|---|---|---|
| 364 | (CF₃)₃C | (CH₂)ₐ | 0 to 20 | Me | Me | SF₅ | (CH₂)ₐ | 0 to 20 | Me | 5 to 100 | 0 |
| 365 | C₄F₉ | (CH₂)ₐ | 0 to 20 | Me | Me | SF₅ | (CH₂)ₐ | 0 to 20 | Me | 5 to 100 | 0 |
| 366 | C₈F₁₇ | (CH₂)ₐ | 0 to 20 | Me | Me | SF₅ | (CH₂)ₐ | 0 to 20 | Me | 5 to 100 | 0 |
| 367 | c-C₆F₁₁ | (CH₂)ₐ | 0 to 20 | Me | Me | SF₅ | (CH₂)ₐ | 0 to 20 | Me | 5 to 100 | 0 |
| 368 | CHF₂ | (CH₂)ₐ | 0 to 20 | Me | Me | SF₅ | (CH₂)ₐ | 0 to 20 | Me | 5 to 100 | 0 |
| 369 | CClF₂ | (CH₂)ₐ | 0 to 20 | Me | Me | SF₅ | (CH₂)ₐ | 0 to 20 | Me | 5 to 100 | 0 |
| 370 | CBrF₂ | (CH₂)ₐ | 0 to 20 | Me | Me | SF₅ | (CH₂)ₐ | 0 to 20 | Me | 5 to 100 | 0 |
| 371 | ClF₂ | (CH₂)ₐ | 0 to 20 | Me | Me | SF₅ | (CH₂)ₐ | 0 to 20 | Me | 5 to 100 | 0 |
| 372 | CF═CF₂ | (CH₂)ₐ | 0 to 20 | Me | Me | SF₅ | (CH₂)ₐ | 0 to 20 | Me | 5 to 100 | 0 |
| 373 | CF═CFCF₃ | (CH₂)ₐ | 0 to 20 | Me | Me | SF₅ | (CH₂)ₐ | 0 to 20 | Me | 5 to 100 | 0 |
| 374 | CF═CFCF═CF₂ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 364 | Me | Me | (CH₂)_{b} | 0 to 20 | NHC(═O)CH₂CH | (CH₂)_{c} | 1 to 20 | Si(OMe)₃ | 2 |
| 365 | Me | Me | (CH₂)_{b} | 0 to 20 | NHC(═O)CH₂CH | (CH₂)_{c} | 1 to 20 | Si(OMe)₃ | 2 |
| 366 | Me | Me | (CH₂)_{b} | 0 to 20 | NHC(═O)CH₂CH | (CH₂)_{c} | 1 to 20 | Si(OMe)₃ | 2 |
| 367 | Me | Me | (CH₂)_{b} | 0 to 20 | NHC(═O)CH₂CH | (CH₂)_{c} | 1 to 20 | Si(OMe)₃ | 2 |
| 368 | Me | Me | (CH₂)_{b} | 0 to 20 | NHC(═O)CH₂CH | (CH₂)_{c} | 1 to 20 | Si(OMe)₃ | 2 |
| 369 | Me | Me | (CH₂)_{b} | 0 to 20 | NHC(═O)CH₂CH | (CH₂)_{c} | 1 to 20 | Si(OMe)₃ | 2 |
| 370 | Me | Me | (CH₂)_{b} | 0 to 20 | NHC(═O)CH₂CH | (CH₂)_{c} | 1 to 20 | Si(OMe)₃ | 2 |
| 371 | Me | Me | (CH₂)_{b} | 0 to 20 | NHC(═O)CH₂CH | (CH₂)_{c} | 1 to 20 | Si(OMe)₃ | 2 |
| 372 | Me | Me | (CH₂)_{b} | 0 to 20 | NHC(═O)CH₂CH | (CH₂)_{c} | 1 to 20 | Si(OMe)₃ | 2 |
| 373 | Me | Me | (CH₂)_{b} | 0 to 20 | NHC(═O)CH₂CH | (CH₂)_{c} | 1 to 20 | Si(OMe)₃ | 2 |
| 374 | Me | Me | (CH₂)_{b} | 0 to 20 | NHC(═O)CH₂CH | (CH₂)_{c} | 1 to 20 | Si(OMe)₃ | 2 |

TABLE 211

| No. | R²¹ | | a | R²² | R²³ | R²⁴ | | | R²⁵ | z21 | z22 |
|---|---|---|---|---|---|---|---|---|---|---|---|
| 375 | C≡CCF₃ | (CH₂)ₐ | 0 to 20 | Me | Me | SF₅ | (CH₂)ₐ | 0 to 20 | Me | 5 to 100 | 0 |
| 376 | CF₂CH₃ | (CH₂)ₐ | 0 to 20 | Me | Me | SF₅ | (CH₂)ₐ | 0 to 20 | Me | 5 to 100 | 0 |
| 377 | (CF₂)₂H | (CH₂)ₐ | 0 to 20 | Me | Me | SF₅ | (CH₂)ₐ | 0 to 20 | Me | 5 to 100 | 0 |
| 378 | (CF₂)₂CH₃ | (CH₂)ₐ | 0 to 20 | Me | Me | SF₅ | (CH₂)ₐ | 0 to 20 | Me | 5 to 100 | 0 |
| 379 | (CF₂)₄H | (CH₂)ₐ | 0 to 20 | Me | Me | SF₅ | (CH₂)ₐ | 0 to 20 | Me | 5 to 100 | 0 |
| 380 | C₆F₅ | (CH₂)ₐ | 0 to 20 | Me | Me | SF₅ | (CH₂)ₐ | 0 to 20 | Me | 5 to 100 | 0 |
| 381 | 4-CF₃C₆F₄ | (CH₂)ₐ | 0 to 20 | Me | Me | SF₅ | (CH₂)ₐ | 0 to 20 | Me | 5 to 100 | 0 |
| 382 | 4-SF₅C₆F₄ | (CH₂)ₐ | 0 to 20 | Me | Me | SF₅ | (CH₂)ₐ | 0 to 20 | Me | 5 to 100 | 0 |
| 383 | 3,5-CF₃C₆F₃ | (CH₂)ₐ | 0 to 20 | Me | Me | SF₅ | (CH₂)ₐ | 0 to 20 | Me | 5 to 100 | 0 |
| 384 | 3,5-SF₅C₆F₃ | (CH₂)ₐ | 0 to 20 | Me | Me | SF₅ | (CH₂)ₐ | 0 to 20 | Me | 5 to 100 | 0 |
| 385 | 4-CF₃C₆H₄ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 375 | Me | Me | (CH₂)_{b} | 0 to 20 | NHC(═O)CH₂CH | (CH₂)_{c} | 1 to 20 | Si(OMe)₃ | 2 |
| 376 | Me | Me | (CH₂)_{b} | 0 to 20 | NHC(═O)CH₂CH | (CH₂)_{c} | 1 to 20 | Si(OMe)₃ | 2 |
| 377 | Me | Me | (CH₂)_{b} | 0 to 20 | NHC(═O)CH₂CH | (CH₂)_{c} | 1 to 20 | Si(OMe)₃ | 2 |
| 378 | Me | Me | (CH₂)_{b} | 0 to 20 | NHC(═O)CH₂CH | (CH₂)_{c} | 1 to 20 | Si(OMe)₃ | 2 |
| 379 | Me | Me | (CH₂)_{b} | 0 to 20 | NHC(═O)CH₂CH | (CH₂)_{c} | 1 to 20 | Si(OMe)₃ | 2 |
| 380 | Me | Me | (CH₂)_{b} | 0 to 20 | NHC(═O)CH₂CH | (CH₂)_{c} | 1 to 20 | Si(OMe)₃ | 2 |
| 381 | Me | Me | (CH₂)_{b} | 0 to 20 | NHC(═O)CH₂CH | (CH₂)_{c} | 1 to 20 | Si(OMe)₃ | 2 |
| 382 | Me | Me | (CH₂)_{b} | 0 to 20 | NHC(═O)CH₂CH | (CH₂)_{c} | 1 to 20 | Si(OMe)₃ | 2 |
| 383 | Me | Me | (CH₂)_{b} | 0 to 20 | NHC(═O)CH₂CH | (CH₂)_{c} | 1 to 20 | Si(OMe)₃ | 2 |
| 384 | Me | Me | (CH₂)_{b} | 0 to 20 | NHC(═O)CH₂CH | (CH₂)_{c} | 1 to 20 | Si(OMe)₃ | 2 |
| 385 | Me | Me | (CH₂)_{b} | 0 to 20 | NHC(═O)CH₂CH | (CH₂)_{c} | 1 to 20 | Si(OMe)₃ | 2 |

TABLE 212

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 386 | 4-SF₅C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 387 | 3,5-CF₃C₆H₃ | (CH₂)ₐ | 0 to 20 | Me | Me | SF₅ | (CH₂)ₐ | 0 to 20 | Me | 5 to 100 | 0 | \|Me | Me | (CH₂)_{b} | 0 to 20 | NHC(═O)CH₂CH | (CH₂)_{c} | 1 to 20 | Si(OMe)₃ | 2 |
| 388 | 3,5-SF₅C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 389 | 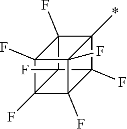 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 390 | 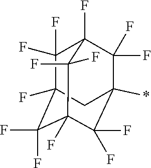 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 391 | 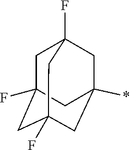 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | \|Me | Me | (CH₂)_{b} | 0 to 20 | NHC(═O)CH₂CH | (CH₂)_{c} | 1 to 20 | Si(OMe)₃ | 2 |
| 392 | SF₅ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 393 | OCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 394 | SCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 395 | N(CH₂CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 396 | N(CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 213

| No. | R²¹ | | a | R²² | R²³ | R²⁴ | | | R²⁵ | z21 | z22 |
|---|---|---|---|---|---|---|---|---|---|---|---|
| 397 | Me | (CH₂)ₐ | 0 to 20 | Me | Me | OCF₃ | (CH₂)ₐ | 0 to 20 | Me | 5 to 100 | 0 |
| 398 | CF₃ | (CH₂)ₐ | 0 to 20 | Me | Me | OCF₃ | (CH₂)ₐ | 0 to 20 | Me | 5 to 100 | 0 |
| 399 | (CF₃)₂CF | (CH₂)ₐ | 0 to 20 | Me | Me | OCF₃ | (CH₂)ₐ | 0 to 20 | Me | 5 to 100 | 0 |
| 400 | (CF₃)₃C | (CH₂)ₐ | 0 to 20 | Me | Me | OCF₃ | (CH₂)ₐ | 0 to 20 | Me | 5 to 100 | 0 |
| 401 | C₄F₉ | (CH₂)ₐ | 0 to 20 | Me | Me | OCF₃ | (CH₂)ₐ | 0 to 20 | Me | 5 to 100 | 0 |
| 402 | C₈F₁₇ | (CH₂)ₐ | 0 to 20 | Me | Me | OCF₃ | (CH₂)ₐ | 0 to 20 | Me | 5 to 100 | 0 |
| 403 | c-C₆F₁₁ | (CH₂)ₐ | 0 to 20 | Me | Me | OCF₃ | (CH₂)ₐ | 0 to 20 | Me | 5 to 100 | 0 |
| 404 | CHF₂ | (CH₂)ₐ | 0 to 20 | Me | Me | OCF₃ | (CH₂)ₐ | 0 to 20 | Me | 5 to 100 | 0 |
| 405 | CClF₂ | (CH₂)ₐ | 0 to 20 | Me | Me | OCF₃ | (CH₂)ₐ | 0 to 20 | Me | 5 to 100 | 0 |
| 406 | CBrF₂ | (CH₂)ₐ | 0 to 20 | Me | Me | OCF₃ | (CH₂)ₐ | 0 to 20 | Me | 5 to 100 | 0 |
| 407 | ClF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 397 | Me | Me | (CH₂)_{b} | 0 to 20 | NHC(═O)CH₂CH | (CH₂)_{c} | 1 to 20 | Si(OMe)₃ | 2 |
| 398 | Me | Me | (CH₂)_{b} | 0 to 20 | NHC(═O)CH₂CH | (CH₂)_{c} | 1 to 20 | Si(OMe)₃ | 2 |
| 399 | Me | Me | (CH₂)_{b} | 0 to 20 | NHC(═O)CH₂CH | (CH₂)_{c} | 1 to 20 | Si(OMe)₃ | 2 |
| 400 | Me | Me | (CH₂)_{b} | 0 to 20 | NHC(═O)CH₂CH | (CH₂)_{c} | 1 to 20 | Si(OMe)₃ | 2 |
| 401 | Me | Me | (CH₂)_{b} | 0 to 20 | NHC(═O)CH₂CH | (CH₂)_{c} | 1 to 20 | Si(OMe)₃ | 2 |
| 402 | Me | Me | (CH₂)_{b} | 0 to 20 | NHC(═O)CH₂CH | (CH₂)_{c} | 1 to 20 | Si(OMe)₃ | 2 |
| 403 | Me | Me | (CH₂)_{b} | 0 to 20 | NHC(═O)CH₂CH | (CH₂)_{c} | 1 to 20 | Si(OMe)₃ | 2 |
| 404 | Me | Me | (CH₂)_{b} | 0 to 20 | NHC(═O)CH₂CH | (CH₂)_{c} | 1 to 20 | Si(OMe)₃ | 2 |
| 405 | Me | Me | (CH₂)_{b} | 0 to 20 | NHC(═O)CH₂CH | (CH₂)_{c} | 1 to 20 | Si(OMe)₃ | 2 |
| 406 | Me | Me | (CH₂)_{b} | 0 to 20 | NHC(═O)CH₂CH | (CH₂)_{c} | 1 to 20 | Si(OMe)₃ | 2 |
| 407 | Me | Me | (CH₂)_{b} | 0 to 20 | NHC(═O)CH₂CH | (CH₂)_{c} | 1 to 20 | Si(OMe)₃ | 2 |

TABLE 214

| No. | R²¹ | | a | R²² | R²³ | R²⁴ | | | R²⁵ | z21 | z22 |
|---|---|---|---|---|---|---|---|---|---|---|---|
| 408 | CF═CF₂ | (CH₂)ₐ | 0 to 20 | Me | Me | OCF₃ | (CH₂)ₐ | 0 to 20 | Me | 5 to 100 | 0 |
| 409 | CF═CFCF₃ | (CH₂)ₐ | 0 to 20 | Me | Me | OCF₃ | (CH₂)ₐ | 0 to 20 | Me | 5 to 100 | 0 |
| 410 | CF═CFCF═CF₂ | (CH₂)ₐ | 0 to 20 | Me | Me | OCF₃ | (CH₂)ₐ | 0 to 20 | Me | 5 to 100 | 0 |
| 411 | C≡CCF₃ | (CH₂)ₐ | 0 to 20 | Me | Me | OCF₃ | (CH₂)ₐ | 0 to 20 | Me | 5 to 100 | 0 |
| 412 | CF₂CH₃ | (CH₂)ₐ | 0 to 20 | Me | Me | OCF₃ | (CH₂)ₐ | 0 to 20 | Me | 5 to 100 | 0 |
| 413 | (CF₂)₂H | (CH₂)ₐ | 0 to 20 | Me | Me | OCF₃ | (CH₂)ₐ | 0 to 20 | Me | 5 to 100 | 0 |
| 414 | (CF₂)₂CH₃ | (CH₂)ₐ | 0 to 20 | Me | Me | OCF₃ | (CH₂)ₐ | 0 to 20 | Me | 5 to 100 | 0 |
| 415 | (CF₂)₄H | (CH₂)ₐ | 0 to 20 | Me | Me | OCF₃ | (CH₂)ₐ | 0 to 20 | Me | 5 to 100 | 0 |
| 416 | C₆F₅ | (CH₂)ₐ | 0 to 20 | Me | Me | OCF₃ | (CH₂)ₐ | 0 to 20 | Me | 5 to 100 | 0 |
| 417 | 4-CF₃C₆F₄ | (CH₂)ₐ | 0 to 20 | Me | Me | OCF₃ | (CH₂)ₐ | 0 to 20 | Me | 5 to 100 | 0 |
| 418 | 4-SF₅C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 408 | Me | Me | (CH₂)_{b} | 0 to 20 | NHC(═O)CH₂CH | (CH₂)_{c} | 1 to 20 | Si(OMe)₃ | 2 |
| 409 | Me | Me | (CH₂)_{b} | 0 to 20 | NHC(═O)CH₂CH | (CH₂)_{c} | 1 to 20 | Si(OMe)₃ | 2 |
| 410 | Me | Me | (CH₂)_{b} | 0 to 20 | NHC(═O)CH₂CH | (CH₂)_{c} | 1 to 20 | Si(OMe)₃ | 2 |
| 411 | Me | Me | (CH₂)_{b} | 0 to 20 | NHC(═O)CH₂CH | (CH₂)_{c} | 1 to 20 | Si(OMe)₃ | 2 |
| 412 | Me | Me | (CH₂)_{b} | 0 to 20 | NHC(═O)CH₂CH | (CH₂)_{c} | 1 to 20 | Si(OMe)₃ | 2 |
| 413 | Me | Me | (CH₂)_{b} | 0 to 20 | NHC(═O)CH₂CH | (CH₂)_{c} | 1 to 20 | Si(OMe)₃ | 2 |
| 414 | Me | Me | (CH₂)_{b} | 0 to 20 | NHC(═O)CH₂CH | (CH₂)_{c} | 1 to 20 | Si(OMe)₃ | 2 |
| 415 | Me | Me | (CH₂)_{b} | 0 to 20 | NHC(═O)CH₂CH | (CH₂)_{c} | 1 to 20 | Si(OMe)₃ | 2 |
| 416 | Me | Me | (CH₂)_{b} | 0 to 20 | NHC(═O)CH₂CH | (CH₂)_{c} | 1 to 20 | Si(OMe)₃ | 2 |
| 417 | Me | Me | (CH₂)_{b} | 0 to 20 | NHC(═O)CH₂CH | (CH₂)_{c} | 1 to 20 | Si(OMe)₃ | 2 |
| 418 | Me | Me | (CH₂)_{b} | 0 to 20 | NHC(═O)CH₂CH | (CH₂)_{c} | 1 to 20 | Si(OMe)₃ | 2 |

TABLE 215

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 419 | 3,5-CF₃C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 420 | 3,5-SF₅C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 421 | 4-CF₃C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 422 | 4-SF₅C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 423 | 3,5-CF₃C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 424 | 3,5-SF₅C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 425 | 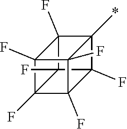 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 426 | 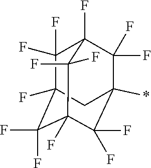 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 427 | 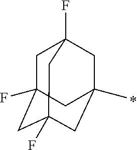 | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 428 | SF₅ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 429 | OCF₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 216

| No. | R²¹ | | a | R²² | R²³ | R²⁴ | | | R²⁵ | z21 | z22 |
|---|---|---|---|---|---|---|---|---|---|---|---|
| 430 | SCF₃ | (CH₂)ₐ | 0 to 20 | Me | Me | OCF₃ | (CH₂)ₐ | 0 to 20 | Me | 5 to 100 | 0 |
| 431 | N(CH₂CF₃)₂ | (CH₂)ₐ | 0 to 20 | Me | Me | OCF₃ | (CH₂)ₐ | 0 to 20 | Me | 5 to 100 | 0 |
| 432 | N(CF₃)₂ | (CH₂)ₐ | 0 to 20 | Me | Me | OCF₃ | (CH₂)ₐ | 0 to 20 | Me | 5 to 100 | 0 |
| 433 | Me | (CH₂)ₐ | 0 to 20 | Me | Me | SCF₃ | (CH₂)ₐ | 0 to 20 | Me | 5 to 100 | 0 |
| 434 | CF₃ | (CH₂)ₐ | 0 to 20 | Me | Me | SCF₃ | (CH₂)ₐ | 0 to 20 | Me | 5 to 100 | 0 |
| 435 | (CF₃)₂CF | (CH₂)ₐ | 0 to 20 | Me | Me | SCF₃ | (CH₂)ₐ | 0 to 20 | Me | 5 to 100 | 0 |
| 436 | (CF₃)₃C | (CH₂)ₐ | 0 to 20 | Me | Me | SCF₃ | (CH₂)ₐ | 0 to 20 | Me | 5 to 100 | 0 |
| 437 | C₄F₉ | (CH₂)ₐ | 0 to 20 | Me | Me | SCF₃ | (CH₂)ₐ | 0 to 20 | Me | 5 to 100 | 0 |
| 438 | C₈F₁₇ | (CH₂)ₐ | 0 to 20 | Me | Me | SCF₃ | (CH₂)ₐ | 0 to 20 | Me | 5 to 100 | 0 |
| 439 | c-C₆F₁₁ | (CH₂)ₐ | 0 to 20 | Me | Me | SCF₃ | (CH₂)ₐ | 0 to 20 | Me | 5 to 100 | 0 |
| 440 | CHF₂ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 430 | Me | Me | (CH₂)_{b} | 0 to 20 | NHC(═O)CH₂CH | (CH₂)_{c} | 1 to 20 | Si(OMe)₃ | 2 |
| 431 | Me | Me | (CH₂)_{b} | 0 to 20 | NHC(═O)CH₂CH | (CH₂)_{c} | 1 to 20 | Si(OMe)₃ | 2 |
| 432 | Me | Me | (CH₂)_{b} | 0 to 20 | NHC(═O)CH₂CH | (CH₂)_{c} | 1 to 20 | Si(OMe)₃ | 2 |
| 433 | Me | Me | (CH₂)_{b} | 0 to 20 | NHC(═O)CH₂CH | (CH₂)_{c} | 1 to 20 | Si(OMe)₃ | 2 |
| 434 | Me | Me | (CH₂)_{b} | 0 to 20 | NHC(═O)CH₂CH | (CH₂)_{c} | 1 to 20 | Si(OMe)₃ | 2 |
| 435 | Me | Me | (CH₂)_{b} | 0 to 20 | NHC(═O)CH₂CH | (CH₂)_{c} | 1 to 20 | Si(OMe)₃ | 2 |
| 436 | Me | Me | (CH₂)_{b} | 0 to 20 | NHC(═O)CH₂CH | (CH₂)_{c} | 1 to 20 | Si(OMe)₃ | 2 |
| 437 | Me | Me | (CH₂)_{b} | 0 to 20 | NHC(═O)CH₂CH | (CH₂)_{c} | 1 to 20 | Si(OMe)₃ | 2 |
| 438 | Me | Me | (CH₂)_{b} | 0 to 20 | NHC(═O)CH₂CH | (CH₂)_{c} | 1 to 20 | Si(OMe)₃ | 2 |
| 439 | Me | Me | (CH₂)_{b} | 0 to 20 | NHC(═O)CH₂CH | (CH₂)_{c} | 1 to 20 | Si(OMe)₃ | 2 |
| 440 | Me | Me | (CH₂)_{b} | 0 to 20 | NHC(═O)CH₂CH | (CH₂)_{c} | 1 to 20 | Si(OMe)₃ | 2 |

TABLE 217

| No. | R²¹ | | a | R²² | R²³ | R²⁴ | | | R²⁵ | z21 | z22 |
|---|---|---|---|---|---|---|---|---|---|---|---|
| 441 | CClF₂ | (CH₂)ₐ | 0 to 20 | Me | Me | SCF₃ | (CH₂)ₐ | 0 to 20 | Me | 5 to 100 | 0 |
| 442 | CBrF₂ | (CH₂)ₐ | 0 to 20 | Me | Me | SCF₃ | (CH₂)ₐ | 0 to 20 | Me | 5 to 100 | 0 |
| 443 | ClF₂ | (CH₂)ₐ | 0 to 20 | Me | Me | SCF₃ | (CH₂)ₐ | 0 to 20 | Me | 5 to 100 | 0 |
| 444 | CF═CF₂ | (CH₂)ₐ | 0 to 20 | Me | Me | SCF₃ | (CH₂)ₐ | 0 to 20 | Me | 5 to 100 | 0 |
| 445 | CF═CFCF₃ | (CH₂)ₐ | 0 to 20 | Me | Me | SCF₃ | (CH₂)ₐ | 0 to 20 | Me | 5 to 100 | 0 |
| 446 | CF═CFCF═CF₂ | (CH₂)ₐ | 0 to 20 | Me | Me | SCF₃ | (CH₂)ₐ | 0 to 20 | Me | 5 to 100 | 0 |
| 447 | C≡CCF₃ | (CH₂)ₐ | 0 to 20 | Me | Me | SCF₃ | (CH₂)ₐ | 0 to 20 | Me | 5 to 100 | 0 |
| 448 | CF₂CH₃ | (CH₂)ₐ | 0 to 20 | Me | Me | SCF₃ | (CH₂)ₐ | 0 to 20 | Me | 5 to 100 | 0 |
| 449 | (CF₂)₂H | (CH₂)ₐ | 0 to 20 | Me | Me | SCF₃ | (CH₂)ₐ | 0 to 20 | Me | 5 to 100 | 0 |
| 450 | (CF₂)₂CH₃ | (CH₂)ₐ | 0 to 20 | Me | Me | SCF₃ | (CH₂)ₐ | 0 to 20 | Me | 5 to 100 | 0 |
| 451 | (CF₂)₄H | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 441 | Me | Me | (CH₂)_{b} | 0 to 20 | NHC(═O)CH₂CH | (CH₂)_{c} | 1 to 20 | Si(OMe)₃ | 2 |
| 442 | Me | Me | (CH₂)_{b} | 0 to 20 | NHC(═O)CH₂CH | (CH₂)_{c} | 1 to 20 | Si(OMe)₃ | 2 |
| 443 | Me | Me | (CH₂)_{b} | 0 to 20 | NHC(═O)CH₂CH | (CH₂)_{c} | 1 to 20 | Si(OMe)₃ | 2 |
| 444 | Me | Me | (CH₂)_{b} | 0 to 20 | NHC(═O)CH₂CH | (CH₂)_{c} | 1 to 20 | Si(OMe)₃ | 2 |
| 445 | Me | Me | (CH₂)_{b} | 0 to 20 | NHC(═O)CH₂CH | (CH₂)_{c} | 1 to 20 | Si(OMe)₃ | 2 |
| 446 | Me | Me | (CH₂)_{b} | 0 to 20 | NHC(═O)CH₂CH | (CH₂)_{c} | 1 to 20 | Si(OMe)₃ | 2 |
| 447 | Me | Me | (CH₂)_{b} | 0 to 20 | NHC(═O)CH₂CH | (CH₂)_{c} | 1 to 20 | Si(OMe)₃ | 2 |
| 448 | Me | Me | (CH₂)_{b} | 0 to 20 | NHC(═O)CH₂CH | (CH₂)_{c} | 1 to 20 | Si(OMe)₃ | 2 |
| 449 | Me | Me | (CH₂)_{b} | 0 to 20 | NHC(═O)CH₂CH | (CH₂)_{c} | 1 to 20 | Si(OMe)₃ | 2 |
| 450 | Me | Me | (CH₂)_{b} | 0 to 20 | NHC(═O)CH₂CH | (CH₂)_{c} | 1 to 20 | Si(OMe)₃ | 2 |
| 451 | Me | Me | (CH₂)_{b} | 0 to 20 | NHC(═O)CH₂CH | (CH₂)_{c} | 1 to 20 | Si(OMe)₃ | 2 |

TABLE 218

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 452 | C₆F₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 453 | 4-CF₃C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 454 | 4-SF₅C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 455 | 3,5-CF₃C₆F₃ | (CH₂)ₐ | 0 to 20 | Me | Me | SCF₃ | (CH₂)ₐ | 0 to 20 | Me | 5 to 100 | 0 | \|Me | Me | (CH₂)_{b} | 0 to 20 | NHC(═O)CH₂CH | (CH₂)_{c} | 1 to 20 | Si(OMe)₃ | 2 |
| 456 | 3,5-SF₅C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 457 | 4-CF₃C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 458 | 4-SF₅C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 459 | 3,5-CF₃C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 460 | 3,5-SF₅C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 461 | 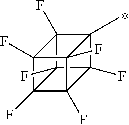 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 462 | 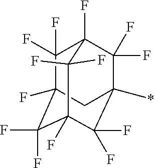 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 219

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 463 | 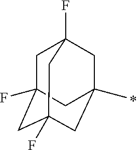 | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 464 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 465 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 466 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 467 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 468 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 469 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 470 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 471 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 472 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 473 | C₄F₉ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 220

| No. | R²¹ | | a | R²² | R²³ | R²⁴ | | | R²⁵ | z21 | z22 |
|---|---|---|---|---|---|---|---|---|---|---|---|
| 474 | C₈F₁₇ | (CH₂)ₐ | 0 to 20 | Me | Me | N(CF₃)₂ | (CH₂)ₐ | 0 to 20 | Me | 5 to 100 | 0 |
| 475 | c-C₆F₁₁ | (CH₂)ₐ | 0 to 20 | Me | Me | N(CF₃)₂ | (CH₂)ₐ | 0 to 20 | Me | 5 to 100 | 0 |
| 476 | CHF₂ | (CH₂)ₐ | 0 to 20 | Me | Me | N(CF₃)₂ | (CH₂)ₐ | 0 to 20 | Me | 5 to 100 | 0 |
| 477 | CClF₂ | (CH₂)ₐ | 0 to 20 | Me | Me | N(CF₃)₂ | (CH₂)ₐ | 0 to 20 | Me | 5 to 100 | 0 |
| 478 | CBrF₂ | (CH₂)ₐ | 0 to 20 | Me | Me | N(CF₃)₂ | (CH₂)ₐ | 0 to 20 | Me | 5 to 100 | 0 |
| 479 | ClF₂ | (CH₂)ₐ | 0 to 20 | Me | Me | N(CF₃)₂ | (CH₂)ₐ | 0 to 20 | Me | 5 to 100 | 0 |
| 480 | CF═CF₂ | (CH₂)ₐ | 0 to 20 | Me | Me | N(CF₃)₂ | (CH₂)ₐ | 0 to 20 | Me | 5 to 100 | 0 |
| 481 | CF═CFCF₃ | (CH₂)ₐ | 0 to 20 | Me | Me | N(CF₃)₂ | (CH₂)ₐ | 0 to 20 | Me | 5 to 100 | 0 |
| 482 | CF═CFCF═CF₂ | (CH₂)ₐ | 0 to 20 | Me | Me | N(CF₃)₂ | (CH₂)ₐ | 0 to 20 | Me | 5 to 100 | 0 |
| 483 | C≡CCF₃ | (CH₂)ₐ | 0 to 20 | Me | Me | N(CF₃)₂ | (CH₂)ₐ | 0 to 20 | Me | 5 to 100 | 0 |
| 484 | CF₂CH₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 474 | Me | Me | (CH₂)_{b} | 0 to 20 | NHC(═O)CH₂CH | (CH₂)_{c} | 1 to 20 | Si(OMe)₃ | 2 |
| 475 | Me | Me | (CH₂)_{b} | 0 to 20 | NHC(═O)CH₂CH | (CH₂)_{c} | 1 to 20 | Si(OMe)₃ | 2 |
| 476 | Me | Me | (CH₂)_{b} | 0 to 20 | NHC(═O)CH₂CH | (CH₂)_{c} | 1 to 20 | Si(OMe)₃ | 2 |
| 477 | Me | Me | (CH₂)_{b} | 0 to 20 | NHC(═O)CH₂CH | (CH₂)_{c} | 1 to 20 | Si(OMe)₃ | 2 |
| 478 | Me | Me | (CH₂)_{b} | 0 to 20 | NHC(═O)CH₂CH | (CH₂)_{c} | 1 to 20 | Si(OMe)₃ | 2 |
| 479 | Me | Me | (CH₂)_{b} | 0 to 20 | NHC(═O)CH₂CH | (CH₂)_{c} | 1 to 20 | Si(OMe)₃ | 2 |
| 480 | Me | Me | (CH₂)_{b} | 0 to 20 | NHC(═O)CH₂CH | (CH₂)_{c} | 1 to 20 | Si(OMe)₃ | 2 |
| 481 | Me | Me | (CH₂)_{b} | 0 to 20 | NHC(═O)CH₂CH | (CH₂)_{c} | 1 to 20 | Si(OMe)₃ | 2 |
| 482 | Me | Me | (CH₂)_{b} | 0 to 20 | NHC(═O)CH₂CH | (CH₂)_{c} | 1 to 20 | Si(OMe)₃ | 2 |
| 483 | Me | Me | (CH₂)_{b} | 0 to 20 | NHC(═O)CH₂CH | (CH₂)_{c} | 1 to 20 | Si(OMe)₃ | 2 |
| 484 | Me | Me | (CH₂)_{b} | 0 to 20 | NHC(═O)CH₂CH | (CH₂)_{c} | 1 to 20 | Si(OMe)₃ | 2 |

TABLE 221

| No. | R²¹ | | a | R²² | R²³ | R²⁴ | | | R²⁵ | z21 | z22 |
|---|---|---|---|---|---|---|---|---|---|---|---|
| 485 | (CF₂)₂H | (CH₂)ₐ | 0 to 20 | Me | Me | N(CF₃)₂ | (CH₂)ₐ | 0 to 20 | Me | 5 to 100 | 0 |
| 486 | (CF₂)₂CH₃ | (CH₂)ₐ | 0 to 20 | Me | Me | N(CF₃)₂ | (CH₂)ₐ | 0 to 20 | Me | 5 to 100 | 0 |
| 487 | (CF₂)₄H | (CH₂)ₐ | 0 to 20 | Me | Me | SCF₃ | (CH₂)ₐ | 0 to 20 | Me | 5 to 100 | 0 |
| 488 | C₆F₅ | (CH₂)ₐ | 0 to 20 | Me | Me | N(CF₃)₂ | (CH₂)ₐ | 0 to 20 | Me | 5 to 100 | 0 |
| 489 | 4-CF₃C₆F₄ | (CH₂)ₐ | 0 to 20 | Me | Me | N(CF₃)₂ | (CH₂)ₐ | 0 to 20 | Me | 5 to 100 | 0 |
| 490 | 4-SF₅C₆F₄ | (CH₂)ₐ | 0 to 20 | Me | Me | N(CF₃)₂ | (CH₂)ₐ | 0 to 20 | Me | 5 to 100 | 0 |
| 491 | 3,5-CF₃C₆F₃ | (CH₂)ₐ | 0 to 20 | Me | Me | N(CF₃)₂ | (CH₂)ₐ | 0 to 20 | Me | 5 to 100 | 0 |
| 492 | 3,5-SF₅C₆F₃ | (CH₂)ₐ | 0 to 20 | Me | Me | N(CF₃)₂ | (CH₂)ₐ | 0 to 20 | Me | 5 to 100 | 0 |
| 493 | 4-CF₃C₆H₄ | (CH₂)ₐ | 0 to 20 | Me | Me | N(CF₃)₂ | (CH₂)ₐ | 0 to 20 | Me | 5 to 100 | 0 |
| 494 | 4-SF₅C₆H₄ | (CH₂)ₐ | 0 to 20 | Me | Me | N(CF₃)₂ | (CH₂)ₐ | 0 to 20 | Me | 5 to 100 | 0 |
| 495 | 3,5-CF₃C₆H₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 485 | Me | Me | (CH₂)_{b} | 0 to 20 | NHC(═O)CH₂CH | (CH₂)_{c} | 1 to 20 | Si(OMe)₃ | 2 |
| 486 | Me | Me | (CH₂)_{b} | 0 to 20 | NHC(═O)CH₂CH | (CH₂)_{c} | 1 to 20 | Si(OMe)₃ | 2 |
| 487 | Me | Me | (CH₂)_{b} | 0 to 20 | NHC(═O)CH₂CH | (CH₂)_{c} | 1 to 20 | Si(OMe)₃ | 2 |
| 488 | Me | Me | (CH₂)_{b} | 0 to 20 | NHC(═O)CH₂CH | (CH₂)_{c} | 1 to 20 | Si(OMe)₃ | 2 |
| 489 | Me | Me | (CH₂)_{b} | 0 to 20 | NHC(═O)CH₂CH | (CH₂)_{c} | 1 to 20 | Si(OMe)₃ | 2 |
| 490 | Me | Me | (CH₂)_{b} | 0 to 20 | NHC(═O)CH₂CH | (CH₂)_{c} | 1 to 20 | Si(OMe)₃ | 2 |
| 491 | Me | Me | (CH₂)_{b} | 0 to 20 | NHC(═O)CH₂CH | (CH₂)_{c} | 1 to 20 | Si(OMe)₃ | 2 |
| 492 | Me | Me | (CH₂)_{b} | 0 to 20 | NHC(═O)CH₂CH | (CH₂)_{c} | 1 to 20 | Si(OMe)₃ | 2 |
| 493 | Me | Me | (CH₂)_{b} | 0 to 20 | NHC(═O)CH₂CH | (CH₂)_{c} | 1 to 20 | Si(OMe)₃ | 2 |
| 494 | Me | Me | (CH₂)_{b} | 0 to 20 | NHC(═O)CH₂CH | (CH₂)_{c} | 1 to 20 | Si(OMe)₃ | 2 |
| 495 | Me | Me | (CH₂)_{b} | 0 to 20 | NHC(═O)CH₂CH | (CH₂)_{c} | 1 to 20 | Si(OMe)₃ | 2 |

TABLE 222

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 496 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 497 | 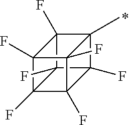 | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 498 | 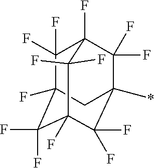 | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 499 | 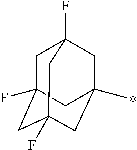 | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 500 | SF₅ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 501 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 502 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 503 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |
| 504 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | NHC(═O)CH₂CH | (CH₂)_{c} | 1 to 20 | Si(OMe)₃ | 2 |

TABLE 223

| No. | R²¹ | | a | R²² | R²³ | R²⁴ | | | R²⁵ | z21 | z22 |
|---|---|---|---|---|---|---|---|---|---|---|---|
| 505 | Me | (CH₂)ₐ | 0 to 20 | Me | Me | CF₃ | (CH₂)ₐ | 0 to 20 | Me | 5 to 100 | 0 |
| 506 | CF₃ | (CH₂)ₐ | 0 to 20 | Me | Me | CF₃ | (CH₂)ₐ | 0 to 20 | Me | 5 to 100 | 0 |
| 507 | (CF₃)₂CF | (CH₂)ₐ | 0 to 20 | Me | Me | CF₃ | (CH₂)ₐ | 0 to 20 | Me | 5 to 100 | 0 |
| 508 | (CF₃)₃C | (CH₂)ₐ | 0 to 20 | Me | Me | CF₃ | (CH₂)ₐ | 0 to 20 | Me | 5 to 100 | 0 |
| 509 | C₄F₉ | (CH₂)ₐ | 0 to 20 | Me | Me | CF₃ | (CH₂)ₐ | 0 to 20 | Me | 5 to 100 | 0 |
| 510 | C₈F₁₇ | (CH₂)ₐ | 0 to 20 | Me | Me | CF₃ | (CH₂)ₐ | 0 to 20 | Me | 5 to 100 | 0 |
| 511 | c-C₆F₁₁ | (CH₂)ₐ | 0 to 20 | Me | Me | CF₃ | (CH₂)ₐ | 0 to 20 | Me | 5 to 100 | 0 |
| 512 | CHF₂ | (CH₂)ₐ | 0 to 20 | Me | Me | CF₃ | (CH₂)ₐ | 0 to 20 | Me | 5 to 100 | 0 |
| 513 | CClF₂ | (CH₂)ₐ | 0 to 20 | Me | Me | CF₃ | (CH₂)ₐ | 0 to 20 | Me | 5 to 100 | 0 |
| 514 | CBrF₂ | (CH₂)ₐ | 0 to 20 | Me | Me | CF₃ | (CH₂)ₐ | 0 to 20 | Me | 5 to 100 | 0 |
| 515 | ClF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 505 | Me | Me | (CH₂)_{b} | 0 to 20 | SiMe | (CH₂)_{c} | 1 to 20 | Si(OMe)₃ | 2 |
| 506 | Me | Me | (CH₂)_{b} | 0 to 20 | SiMe | (CH₂)_{c} | 1 to 20 | Si(OMe)₃ | 2 |
| 507 | Me | Me | (CH₂)_{b} | 0 to 20 | SiMe | (CH₂)_{c} | 1 to 20 | Si(OMe)₃ | 2 |
| 508 | Me | Me | (CH₂)_{b} | 0 to 20 | SiMe | (CH₂)_{c} | 1 to 20 | Si(OMe)₃ | 2 |
| 509 | Me | Me | (CH₂)_{b} | 0 to 20 | SiMe | (CH₂)_{c} | 1 to 20 | Si(OMe)₃ | 2 |
| 510 | Me | Me | (CH₂)_{b} | 0 to 20 | SiMe | (CH₂)_{c} | 1 to 20 | Si(OMe)₃ | 2 |
| 511 | Me | Me | (CH₂)_{b} | 0 to 20 | SiMe | (CH₂)_{c} | 1 to 20 | Si(OMe)₃ | 2 |
| 512 | Me | Me | (CH₂)_{b} | 0 to 20 | SiMe | (CH₂)_{c} | 1 to 20 | Si(OMe)₃ | 2 |
| 513 | Me | Me | (CH₂)_{b} | 0 to 20 | SiMe | (CH₂)_{c} | 1 to 20 | Si(OMe)₃ | 2 |
| 514 | Me | Me | (CH₂)_{b} | 0 to 20 | SiMe | (CH₂)_{c} | 1 to 20 | Si(OMe)₃ | 2 |
| 515 | Me | Me | (CH₂)_{b} | 0 to 20 | SiMe | (CH₂)_{c} | 1 to 20 | Si(OMe)₃ | 2 |

TABLE 224

| No. | R²¹ | | a | R²² | R²³ | R²⁴ | | | R²⁵ | z21 | z22 |
|---|---|---|---|---|---|---|---|---|---|---|---|
| 516 | CF═CF₂ | (CH₂)ₐ | 0 to 20 | Me | Me | CF₃ | (CH₂)ₐ | 0 to 20 | Me | 5 to 100 | 0 |
| 517 | CF═CFCF₃ | (CH₂)ₐ | 0 to 20 | Me | Me | CF₃ | (CH₂)ₐ | 0 to 20 | Me | 5 to 100 | 0 |
| 518 | CF═CFCF═CF₂ | (CH₂)ₐ | 0 to 20 | Me | Me | CF₃ | (CH₂)ₐ | 0 to 20 | Me | 5 to 100 | 0 |
| 519 | C≡CCF₃ | (CH₂)ₐ | 0 to 20 | Me | Me | CF₃ | (CH₂)ₐ | 0 to 20 | Me | 5 to 100 | 0 |
| 520 | CF₂CH₃ | (CH₂)ₐ | 0 to 20 | Me | Me | CF₃ | (CH₂)ₐ | 0 to 20 | Me | 5 to 100 | 0 |
| 521 | (CF₂)₂H | (CH₂)ₐ | 0 to 20 | Me | Me | CF₃ | (CH₂)ₐ | 0 to 20 | Me | 5 to 100 | 0 |
| 522 | (CF₂)₂CH₃ | (CH₂)ₐ | 0 to 20 | Me | Me | CF₃ | (CH₂)ₐ | 0 to 20 | Me | 5 to 100 | 0 |
| 523 | (CF₂)₄H | (CH₂)ₐ | 0 to 20 | Me | Me | CF₃ | (CH₂)ₐ | 0 to 20 | Me | 5 to 100 | 0 |
| 524 | C₆F₅ | (CH₂)ₐ | 0 to 20 | Me | Me | CF₃ | (CH₂)ₐ | 0 to 20 | Me | 5 to 100 | 0 |
| 525 | 4-CF₃C₆F₄ | (CH₂)ₐ | 0 to 20 | Me | Me | CF₃ | (CH₂)ₐ | 0 to 20 | Me | 5 to 100 | 0 |
| 526 | 4-SF₅C₆F₄ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 516 | Me | Me | (CH₂)_{b} | 0 to 20 | SiMe | (CH₂)_{c} | 1 to 20 | Si(OMe)₃ | 2 |
| 517 | Me | Me | (CH₂)_{b} | 0 to 20 | SiMe | (CH₂)_{c} | 1 to 20 | Si(OMe)₃ | 2 |
| 518 | Me | Me | (CH₂)_{b} | 0 to 20 | SiMe | (CH₂)_{c} | 1 to 20 | Si(OMe)₃ | 2 |
| 519 | Me | Me | (CH₂)_{b} | 0 to 20 | SiMe | (CH₂)_{c} | 1 to 20 | Si(OMe)₃ | 2 |
| 520 | Me | Me | (CH₂)_{b} | 0 to 20 | SiMe | (CH₂)_{c} | 1 to 20 | Si(OMe)₃ | 2 |
| 521 | Me | Me | (CH₂)_{b} | 0 to 20 | SiMe | (CH₂)_{c} | 1 to 20 | Si(OMe)₃ | 2 |
| 522 | Me | Me | (CH₂)_{b} | 0 to 20 | SiMe | (CH₂)_{c} | 1 to 20 | Si(OMe)₃ | 2 |
| 523 | Me | Me | (CH₂)_{b} | 0 to 20 | SiMe | (CH₂)_{c} | 1 to 20 | Si(OMe)₃ | 2 |
| 524 | Me | Me | (CH₂)_{b} | 0 to 20 | SiMe | (CH₂)_{c} | 1 to 20 | Si(OMe)₃ | 2 |
| 525 | Me | Me | (CH₂)_{b} | 0 to 20 | SiMe | (CH₂)_{c} | 1 to 20 | Si(OMe)₃ | 2 |
| 526 | Me | Me | (CH₂)_{b} | 0 to 20 | SiMe | (CH₂)_{c} | 1 to 20 | Si(OMe)₃ | 2 |

TABLE 225

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 527 | 3,5-CF₃C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 528 | 3,5-SFC₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 529 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 530 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 531 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 532 | 3,5-SF₅C₆H₃ | (CH₂)ₐ | 0 to 20 | Me | Me | CF₃ | (CH₂)ₐ | 0 to 20 | Me | 5 to 100 | 0 | \|Me | Me | (CH₂)_{b} | 0 to 20 | SiMe | (CH₂)_{c} | 1 to 20 | Si(OMe)₃ | 2 |
| 533 | 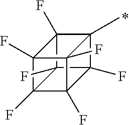 | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 534 | 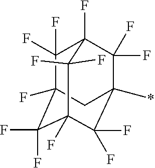 | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 535 | 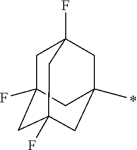 | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 536 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 537 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |

TABLE 226

| No. | R²¹ | | a | R²² | R²³ | R²⁴ | | | R²⁵ | z21 | z22 |
|---|---|---|---|---|---|---|---|---|---|---|---|
| 538 | SCF₃ | (CH₂)ₐ | 0 to 20 | Me | Me | CF₃ | (CH₂)ₐ | 0 to 20 | Me | 5 to 100 | 0 |
| 539 | N(CH₂CF₃)₂ | (CH₂)ₐ | 0 to 20 | Me | Me | CF₃ | (CH₂)ₐ | 0 to 20 | Me | 5 to 100 | 0 |
| 540 | N(CF₃)₂ | (CH₂)ₐ | 0 to 20 | Me | Me | CF₃ | (CH₂)ₐ | 0 to 20 | Me | 5 to 100 | 0 |
| 541 | Me | (CH₂)ₐ | 0 to 20 | Me | Me | CHF₂ | (CH₂)ₐ | 0 to 20 | Me | 5 to 100 | 0 |
| 542 | CF₃ | (CH₂)ₐ | 0 to 20 | Me | Me | CHF₂ | (CH₂)ₐ | 0 to 20 | Me | 5 to 100 | 0 |
| 543 | (CF₃)₂CF | (CH₂)ₐ | 0 to 20 | Me | Me | CHF₂ | (CH₂)ₐ | 0 to 20 | Me | 5 to 100 | 0 |
| 544 | (CF₃)₃C | (CH₂)ₐ | 0 to 20 | Me | Me | CHF₂ | (CH₂)ₐ | 0 to 20 | Me | 5 to 100 | 0 |
| 545 | C₄F₉ | (CH₂)ₐ | 0 to 20 | Me | Me | CHF₂ | (CH₂)ₐ | 0 to 20 | Me | 5 to 100 | 0 |
| 546 | C₈F₁₇ | (CH₂)ₐ | 0 to 20 | Me | Me | CHF₂ | (CH₂)ₐ | 0 to 20 | Me | 5 to 100 | 0 |
| 547 | c-C₆F₁₁ | (CH₂)ₐ | 0 to 20 | Me | Me | CHF₂ | (CH₂)ₐ | 0 to 20 | Me | 5 to 100 | 0 |
| 548 | CHF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 538 | Me | Me | (CH₂)_{b} | 0 to 20 | SiMe | (CH₂)_{c} | 1 to 20 | Si(OMe)₃ | 2 |
| 539 | Me | Me | (CH₂)_{b} | 0 to 20 | SiMe | (CH₂)_{c} | 1 to 20 | Si(OMe)₃ | 2 |
| 540 | Me | Me | (CH₂)_{b} | 0 to 20 | SiMe | (CH₂)_{c} | 1 to 20 | Si(OMe)₃ | 2 |
| 541 | Me | Me | (CH₂)_{b} | 0 to 20 | SiMe | (CH₂)_{c} | 1 to 20 | Si(OMe)₃ | 2 |
| 542 | Me | Me | (CH₂)_{b} | 0 to 20 | SiMe | (CH₂)_{c} | 1 to 20 | Si(OMe)₃ | 2 |
| 543 | Me | Me | (CH₂)_{b} | 0 to 20 | SiMe | (CH₂)_{c} | 1 to 20 | Si(OMe)₃ | 2 |
| 544 | Me | Me | (CH₂)_{b} | 0 to 20 | SiMe | (CH₂)_{c} | 1 to 20 | Si(OMe)₃ | 2 |
| 545 | Me | Me | (CH₂)_{b} | 0 to 20 | SiMe | (CH₂)_{c} | 1 to 20 | Si(OMe)₃ | 2 |
| 546 | Me | Me | (CH₂)_{b} | 0 to 20 | SiMe | (CH₂)_{c} | 1 to 20 | Si(OMe)₃ | 2 |
| 547 | Me | Me | (CH₂)_{b} | 0 to 20 | SiMe | (CH₂)_{c} | 1 to 20 | Si(OMe)₃ | 2 |
| 548 | Me | Me | (CH₂)_{b} | 0 to 20 | SiMe | (CH₂)_{c} | 1 to 20 | Si(OMe)₃ | 2 |

TABLE 229

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 571 | 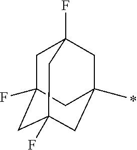 | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 572 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 573 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 574 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 575 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 576 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 577 | Me | (CH₂)ₐ | 0 to 20 | Me | Me | 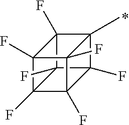 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 578 | CF₃ | (CH₂)ₐ | 0 to 20 | Me | Me | 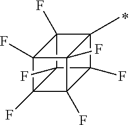 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 579 | (CF₃)₂CF | (CH₂)ₐ | 0 to 20 | Me | Me | 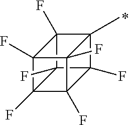 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 580 | (CF₃)₃C | (CH₂)ₐ | 0 to 20 | Me | Me | 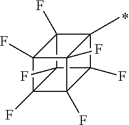 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 581 | C₄F₉ | (CH₂)ₐ | 0 to 20 | Me | Me | 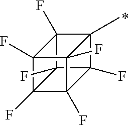 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |

TABLE 230

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 582 | C₈F₁₇ | (CH₂)ₐ | 0 to 20 | Me | Me | 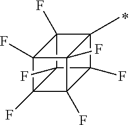 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 583 | c-C₆F₁₁ | (CH₂)ₐ | 0 to 20 | Me | Me | 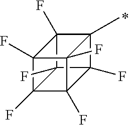 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 584 | CHF₂ | (CH₂)ₐ | 0 to 20 | Me | Me | 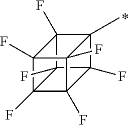 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 585 | CClF₂ | (CH₂)ₐ | 0 to 20 | Me | Me | 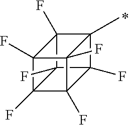 | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 586 | CBrF₂ | (CH₂)ₐ | 0 to 20 | Me | Me | 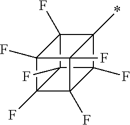 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 587 | ClF₂ | (CH₂)ₐ | 0 to 20 | Me | Me | 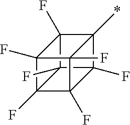 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 588 | CF═CF₂ | (CH₂)ₐ | 0 to 20 | Me | Me | 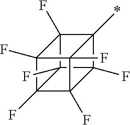 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 589 | CF═CFCF₃ | (CH₂)ₐ | 0 to 20 | Me | Me | 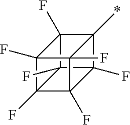 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 590 | CF═CFCF═CF₂ | (CH₂)ₐ | 0 to 20 | Me | Me | 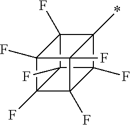 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 591 | C≡CCF₃ | (CH₂)ₐ | 0 to 20 | Me | Me | 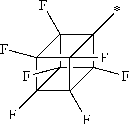 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 592 | CF₂CH₃ | (CH₂)ₐ | 0 to 20 | Me | Me | 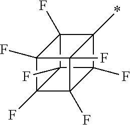 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |

TABLE 231

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 593 | (CF₂)₂H | (CH₂)ₐ | 0 to 20 | Me | Me | 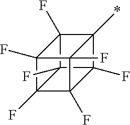 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 594 | (CF₂)₂CH₃ | (CH₂)ₐ | 0 to 20 | Me | Me | 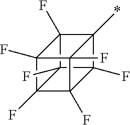 [SMILES: *C12C3(F)C4(F)C1(F)C1(F)C2(F)C3(F)C41F] | (CH₂)ₐ | 0 to 20 | Me | 5 to 100 | 0\| | Me | Me | (CH₂)_{b} | 0 to 20 | SiMe | (CH₂)_{c} | 1 to 20 | Si(OMe)₃ | 2 |
| 595 | (CF₂)₄H | (CH₂)ₐ | 0 to 20 | Me | Me | 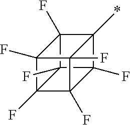 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 596 | C₆F₅ | (CH₂)ₐ | 0 to 20 | Me | Me | 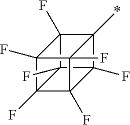 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 597 | 4-CF₃C₆F₄ | (CH₂)ₐ | 0 to 20 | Me | Me | 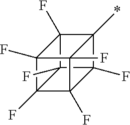 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 598 | 4-SF₅C₆F₄ | (CH₂)ₐ | 0 to 20 | Me | Me | 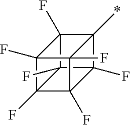 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 599 | 3,5-CF₃C₆F₃ | (CH₂)ₐ | 0 to 20 | Me | Me | 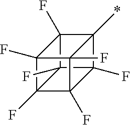 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 600 | 3,5-SF₅C₆F₃ | (CH₂)ₐ | 0 to 20 | Me | Me | 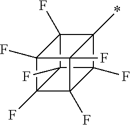 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 601 | 4-CF₃C₆H₄ | (CH₂)ₐ | 0 to 20 | Me | Me | 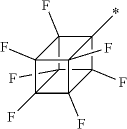 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 602 | 4-SF₅C₆H₄ | (CH₂)ₐ | 0 to 20 | Me | Me | 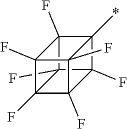 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 603 | 3,5-CF₃C₆H₃ | (CH₂)ₐ | 0 to 20 | Me | Me | 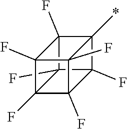 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |

TABLE 232

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 604 | 3,5-SF₅C₆H₃ | (CH₂)ₐ | 0 to 20 | Me | Me | 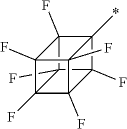 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 605 | 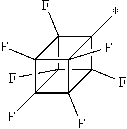 [SMILES: *C12C3(F)C4(F)C1(F)C1(F)C2(F)C3(F)C41F] | (CH₂)ₐ | 0 to 20 | Me | Me | 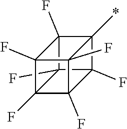 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 606 | 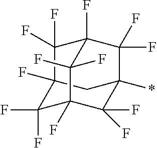 [SMILES: *C12CC3(F)C(F)(F)C(F)(C1(F)F)C(F)(F)C(F)(C2(F)F)C3(F)F] | (CH₂)ₐ | 0 to 20 | Me | Me | 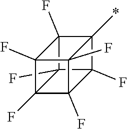 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 607 | 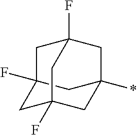 [SMILES: *C12CC3(F)CC(F)(C1)CC(F)(C2)C3] | (CH₂)ₐ | 0 to 20 | Me | Me | 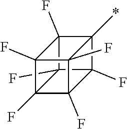 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 608 | SF₅ | (CH₂)ₐ | 0 to 20 | Me | Me | 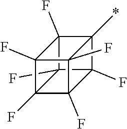 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 609 | OCF₃ | (CH₂)ₐ | 0 to 20 | Me | \|Me | 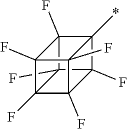 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 610 | SCF₃ | (CH₂)ₐ | 0 to 20 | Me | Me | 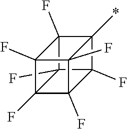 [SMILES: *C12C3(F)C4(F)C1(F)C1(F)C2(F)C3(F)C41F] | (CH₂)ₐ | 0 to 20 | Me | 5 to 100 | 0 | Me \| | Me | (CH₂)_{b} | 0 to 20 | SiMe | (CH₂)_{c} | 1 to 20 | Si(OMe)₃ | 2 |
| 611 | N(CH₂CF₃)₂ | (CH₂)ₐ | 0 to 20 | Me | Me | 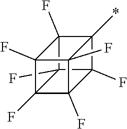 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 612 | N(CF₃)₂ | (CH₂)ₐ | 0 to 20 | Me | Me | 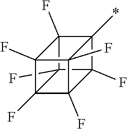 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 613 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |
| 614 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | SiMe | (CH₂)_{c} | 1 to 20 | Si(OMe)₃ | 2 |

TABLE 233

| No. | R²¹ | | a | R²² | R²³ | R²⁴ | | | R²⁵ | z21 | z22 |
|---|---|---|---|---|---|---|---|---|---|---|---|
| 615 | (CF₃)₂CF | (CH₂)ₐ | 0 to 20 | Me | Me | SF₅ | (CH₂)ₐ | 0 to 20 | Me | 5 to 100 | 0 |
| 616 | (CF₃)₃C | (CH₂)ₐ | 0 to 20 | Me | Me | SF₅ | (CH₂)ₐ | 0 to 20 | Me | 5 to 100 | 0 |
| 617 | C₄F₉ | (CH₂)ₐ | 0 to 20 | Me | Me | SF₅ | (CH₂)ₐ | 0 to 20 | Me | 5 to 100 | 0 |
| 618 | C₈F₁₇ | (CH₂)ₐ | 0 to 20 | Me | Me | SF₅ | (CH₂)ₐ | 0 to 20 | Me | 5 to 100 | 0 |
| 619 | c-C₆F₁₁ | (CH₂)ₐ | 0 to 20 | Me | Me | SF₅ | (CH₂)ₐ | 0 to 20 | Me | 5 to 100 | 0 |
| 620 | CHF₂ | (CH₂)ₐ | 0 to 20 | Me | Me | SF₅ | (CH₂)ₐ | 0 to 20 | Me | 5 to 100 | 0 |
| 621 | CClF₂ | (CH₂)ₐ | 0 to 20 | Me | Me | SF₅ | (CH₂)ₐ | 0 to 20 | Me | 5 to 100 | 0 |
| 622 | CBrF₂ | (CH₂)ₐ | 0 to 20 | Me | Me | SF₅ | (CH₂)ₐ | 0 to 20 | Me | 5 to 100 | 0 |
| 623 | ClF₂ | (CH₂)ₐ | 0 to 20 | Me | Me | SF₅ | (CH₂)ₐ | 0 to 20 | Me | 5 to 100 | 0 |
| 624 | CF═CF₂ | (CH₂)ₐ | 0 to 20 | Me | Me | SF₅ | (CH₂)ₐ | 0 to 20 | Me | 5 to 100 | 0 |
| 625 | CF═CFCF₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 615 | Me | Me | (CH₂)_{b} | 0 to 20 | SiMe | (CH₂)_{c} | 1 to 20 | Si(OMe)₃ | 2 |
| 616 | Me | Me | (CH₂)_{b} | 0 to 20 | SiMe | (CH₂)_{c} | 1 to 20 | Si(OMe)₃ | 2 |
| 617 | Me | Me | (CH₂)_{b} | 0 to 20 | SiMe | (CH₂)_{c} | 1 to 20 | Si(OMe)₃ | 2 |
| 618 | Me | Me | (CH₂)_{b} | 0 to 20 | SiMe | (CH₂)_{c} | 1 to 20 | Si(OMe)₃ | 2 |
| 619 | Me | Me | (CH₂)_{b} | 0 to 20 | SiMe | (CH₂)_{c} | 1 to 20 | Si(OMe)₃ | 2 |
| 620 | Me | Me | (CH₂)_{b} | 0 to 20 | SiMe | (CH₂)_{c} | 1 to 20 | Si(OMe)₃ | 2 |
| 621 | Me | Me | (CH₂)_{b} | 0 to 20 | SiMe | (CH₂)_{c} | 1 to 20 | Si(OMe)₃ | 2 |
| 622 | Me | Me | (CH₂)_{b} | 0 to 20 | SiMe | (CH₂)_{c} | 1 to 20 | Si(OMe)₃ | 2 |
| 623 | Me | Me | (CH₂)_{b} | 0 to 20 | SiMe | (CH₂)_{c} | 1 to 20 | Si(OMe)₃ | 2 |
| 624 | Me | Me | (CH₂)_{b} | 0 to 20 | SiMe | (CH₂)_{c} | 1 to 20 | Si(OMe)₃ | 2 |
| 625 | Me | Me | (CH₂)_{b} | 0 to 20 | SiMe | (CH₂)_{c} | 1 to 20 | Si(OMe)₃ | 2 |

TABLE 234

| No. | R²¹ | | a | R²² | R²³ | R²⁴ | | | R²⁵ | z21 | z22 |
|---|---|---|---|---|---|---|---|---|---|---|---|
| 626 | CF═CFCF═CF₂ | (CH₂)ₐ | 0 to 20 | Me | Me | SF₅ | (CH₂)ₐ | 0 to 20 | Me | 5 to 100 | 0 |
| 627 | C≡CCF₃ | (CH₂)ₐ | 0 to 20 | Me | Me | SF₅ | (CH₂)ₐ | 0 to 20 | Me | 5 to 100 | 0 |
| 628 | CF₂CH₃ | (CH₂)ₐ | 0 to 20 | Me | Me | SF₅ | (CH₂)ₐ | 0 to 20 | Me | 5 to 100 | 0 |
| 629 | (CF₂)₂H | (CH₂)ₐ | 0 to 20 | Me | Me | SF₅ | (CH₂)ₐ | 0 to 20 | Me | 5 to 100 | 0 |
| 630 | (CF₂)₂CH₃ | (CH₂)ₐ | 0 to 20 | Me | Me | SF₅ | (CH₂)ₐ | 0 to 20 | Me | 5 to 100 | 0 |
| 631 | (CF₂)₄H | (CH₂)ₐ | 0 to 20 | Me | Me | SF₅ | (CH₂)ₐ | 0 to 20 | Me | 5 to 100 | 0 |
| 632 | C₆F₅ | (CH₂)ₐ | 0 to 20 | Me | Me | SF₅ | (CH₂)ₐ | 0 to 20 | Me | 5 to 100 | 0 |
| 633 | 4-CF₃C₆F₄ | (CH₂)ₐ | 0 to 20 | Me | Me | SF₅ | (CH₂)ₐ | 0 to 20 | Me | 5 to 100 | 0 |
| 634 | 4-SF₅C₆F₄ | (CH₂)ₐ | 0 to 20 | Me | Me | SF₅ | (CH₂)ₐ | 0 to 20 | Me | 5 to 100 | 0 |
| 635 | 3,5-CF₃C₆F₃ | (CH₂)ₐ | 0 to 20 | Me | Me | SF₅ | (CH₂)ₐ | 0 to 20 | Me | 5 to 100 | 0 |
| 636 | 3,5-SF₅C₆F₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 626 | Me | Me | (CH₂)_{b} | 0 to 20 | SiMe | (CH₂)_{c} | 1 to 20 | Si(OMe)₃ | 2 |
| 627 | Me | Me | (CH₂)_{b} | 0 to 20 | SiMe | (CH₂)_{c} | 1 to 20 | Si(OMe)₃ | 2 |
| 628 | Me | Me | (CH₂)_{b} | 0 to 20 | SiMe | (CH₂)_{c} | 1 to 20 | Si(OMe)₃ | 2 |
| 629 | Me | Me | (CH₂)_{b} | 0 to 20 | SiMe | (CH₂)_{c} | 1 to 20 | Si(OMe)₃ | 2 |
| 630 | Me | Me | (CH₂)_{b} | 0 to 20 | SiMe | (CH₂)_{c} | 1 to 20 | Si(OMe)₃ | 2 |
| 631 | Me | Me | (CH₂)_{b} | 0 to 20 | SiMe | (CH₂)_{c} | 1 to 20 | Si(OMe)₃ | 2 |
| 632 | Me | Me | (CH₂)_{b} | 0 to 20 | SiMe | (CH₂)_{c} | 1 to 20 | Si(OMe)₃ | 2 |
| 633 | Me | Me | (CH₂)_{b} | 0 to 20 | SiMe | (CH₂)_{c} | 1 to 20 | Si(OMe)₃ | 2 |
| 634 | Me | Me | (CH₂)_{b} | 0 to 20 | SiMe | (CH₂)_{c} | 1 to 20 | Si(OMe)₃ | 2 |
| 635 | Me | Me | (CH₂)_{b} | 0 to 20 | SiMe | (CH₂)_{c} | 1 to 20 | Si(OMe)₃ | 2 |
| 636 | Me | Me | (CH₂)_{b} | 0 to 20 | SiMe | (CH₂)_{c} | 1 to 20 | Si(OMe)₃ | 2 |

TABLE 235

| No. | R^{f1} | | a | R²² | R²³ | R²⁴ | | | R²⁵ | z21 | z22 |
|---|---|---|---|---|---|---|---|---|---|---|---|
| 637 | 4-CF₃C₆H₄ | (CH₂)ₐ | 0 to 20 | Me | Me | SF₃ | (CH₂)ₐ | 0 to 20 | Me | 5 to 100 | 0 |
| 638 | 4-SF₅C₆H₄ | (CH₂)ₐ | 0 to 20 | Me | Me | SF₅ | (CH₂)ₐ | 0 to 20 | Me | 5 to 100 | 0 |
| 639 | 3,5-CF₃C₆H₃ | (CH₂)ₐ | 0 to 20 | Me | Me | SF₅ | (CH₂)ₐ | 0 to 20 | Me | 5 to 100 | 0 |
| 640 | 3,5-SF₅C₆H₃ | (CH₂)ₐ | 0 to 20 | Me | Me | SF₅ | (CH₂)ₐ | 0 to 20 | Me | 5 to 100 | 0 |
| 641 | 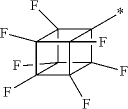 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 |
| 642 | 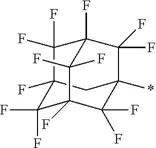 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 |
| 643 | 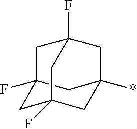 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 |
| 644 | SF₅ | (CH₂)ₐ | 0 to 20 | Me | Me | SF₅ | (CH₂)ₐ | 0 to 20 | Me | 5 to 100 | 0 |
| 645 | OCF₃ | (CH₂)ₐ | 0 to 20 | Me | Me | SF₅ | (CH₂)ₐ | 0 to 20 | Me | 5 to 100 | 0 |
| 646 | SCF₃ | (CH₂)ₐ | 0 to 20 | Me | Me | SF₅ | (CH₂)ₐ | 0 to 20 | Me | 5 to 100 | 0 |
| 647 | N(CH₂CF₃)₂ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 637 | Me | Me | (CH₂)_{b} | 0 to 20 | SiMe | (CH₂)_{c} | 1 to 20 | Si(OMe)₃ | 2 |
| 638 | Me | Me | (CH₂)_{b} | 0 to 20 | SiMe | (CH₂)_{c} | 1 to 20 | Si(OMe)₃ | 2 |
| 639 | Me | Me | (CH₂)_{b} | 0 to 20 | SiMe | (CH₂)_{c} | 1 to 20 | Si(OMe)₃ | 2 |
| 640 | Me | Me | (CH₂)_{b} | 0 to 20 | SiMe | (CH₂)_{c} | 1 to 20 | Si(OMe)₃ | 2 |
| 641 | Me | Me | (CH₂)_{b} | 0 to 20 | SiMe | (CH₂)_{c} | 1 to 20 | Si(OMe)₃ | 2 |
| 642 | Me | Me | (CH₂)_{b} | 0 to 20 | SiMe | (CH₂)_{c} | 1 to 20 | Si(OMe)₃ | 2 |
| 643 | Me | Me | (CH₂)_{b} | 0 to 20 | SiMe | (CH₂)_{c} | 1 to 20 | Si(OMe)₃ | 2 |
| 644 | Me | Me | (CH₂)_{b} | 0 to 20 | SiMe | (CH₂)_{c} | 1 to 20 | Si(OMe)₃ | 2 |
| 645 | Me | Me | (CH₂)_{b} | 0 to 20 | SiMe | (CH₂)_{c} | 1 to 20 | Si(OMe)₃ | 2 |
| 646 | Me | Me | (CH₂)_{b} | 0 to 20 | SiMe | (CH₂)_{c} | 1 to 20 | Si(OMe)₃ | 2 |
| 647 | Me | Me | (CH₂)_{b} | 0 to 20 | SiMe | (CH₂)_{c} | 1 to 20 | Si(OMe)₃ | 2 |

TABLE 236

| No. | R²¹ | | a | R²² | R²³ | R²⁴ | | | R²⁵ | z21 | z22 |
|---|---|---|---|---|---|---|---|---|---|---|---|
| 648 | N(CF₃)₂ | (CH₂)ₐ | 0 to 20 | Me | Me | SF₅ | (CH₂)ₐ | 0 to 20 | Me | 5 to 100 | 0 |
| 649 | Me | (CH₂)ₐ | 0 to 20 | Me | Me | OCF₃ | (CH₂)ₐ | 0 to 20 | Me | 5 to 100 | 0 |
| 650 | CF₃ | (CH₂)ₐ | 0 to 20 | Me | Me | OCF₃ | (CH₂)ₐ | 0 to 20 | Me | 5 to 100 | 0 |
| 651 | (CF₃)₂CF | (CH₂)ₐ | 0 to 20 | Me | Me | OCF₃ | (CH₂)ₐ | 0 to 20 | Me | 5 to 100 | 0 |
| 652 | (CF₃)₃C | (CH₂)ₐ | 0 to 20 | Me | Me | OCF₃ | (CH₂)ₐ | 0 to 20 | Me | 5 to 100 | 0 |
| 653 | C₄F₉ | (CH₂)ₐ | 0 to 20 | Me | Me | OCF₃ | (CH₂)ₐ | 0 to 20 | Me | 5 to 100 | 0 |
| 654 | C₈F₁₇ | (CH₂)ₐ | 0 to 20 | Me | Me | OCF₃ | (CH₂)ₐ | 0 to 20 | Me | 5 to 100 | 0 |
| 655 | c-C₆F₁₁ | (CH₂)ₐ | 0 to 20 | Me | Me | OCF₃ | (CH₂)ₐ | 0 to 20 | Me | 5 to 100 | 0 |
| 656 | CHF₂ | (CH₂)ₐ | 0 to 20 | Me | Me | OCF₃ | (CH₂)ₐ | 0 to 20 | Me | 5 to 100 | 0 |
| 657 | CClF₂ | (CH₂)ₐ | 0 to 20 | Me | Me | OCF₃ | (CH₂)ₐ | 0 to 20 | Me | 5 to 100 | 0 |
| 658 | CBrF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 648 | Me | Me | (CH₂)_{b} | 0 to 20 | SiMe | (CH₂)_{c} | 1 to 20 | Si(OMe)₃ | 2 |
| 649 | Me | Me | (CH₂)_{b} | 0 to 20 | SiMe | (CH₂)_{c} | 1 to 20 | Si(OMe)₃ | 2 |
| 650 | Me | Me | (CH₂)_{b} | 0 to 20 | SiMe | (CH₂)_{c} | 1 to 20 | Si(OMe)₃ | 2 |
| 651 | Me | Me | (CH₂)_{b} | 0 to 20 | SiMe | (CH₂)_{c} | 1 to 20 | Si(OMe)₃ | 2 |
| 652 | Me | Me | (CH₂)_{b} | 0 to 20 | SiMe | (CH₂)_{c} | 1 to 20 | Si(OMe)₃ | 2 |
| 653 | Me | Me | (CH₂)_{b} | 0 to 20 | SiMe | (CH₂)_{c} | 1 to 20 | Si(OMe)₃ | 2 |
| 654 | Me | Me | (CH₂)_{b} | 0 to 20 | SiMe | (CH₂)_{c} | 1 to 20 | Si(OMe)₃ | 2 |
| 655 | Me | Me | (CH₂)_{b} | 0 to 20 | SiMe | (CH₂)_{c} | 1 to 20 | Si(OMe)₃ | 2 |
| 656 | Me | Me | (CH₂)_{b} | 0 to 20 | SiMe | (CH₂)_{c} | 1 to 20 | Si(OMe)₃ | 2 |
| 657 | Me | Me | (CH₂)_{b} | 0 to 20 | SiMe | (CH₂)_{c} | 1 to 20 | Si(OMe)₃ | 2 |
| 658 | Me | Me | (CH₂)_{b} | 0 to 20 | SiMe | (CH₂)_{c} | 1 to 20 | Si(OMe)₃ | 2 |

TABLE 237

| No. | R²¹ | | a | R²² | R²³ | R²⁴ | | | R²⁵ | z21 | z22 |
|---|---|---|---|---|---|---|---|---|---|---|---|
| 659 | ClF₂ | (CH₂)ₐ | 0 to 20 | Me | Me | OCF₃ | (CH₂)ₐ | 0 to 20 | Me | 5 to 100 | 0 |
| 660 | CF═CF₂ | (CH₂)ₐ | 0 to 20 | Me | Me | OCF₃ | (CH₂)ₐ | 0 to 20 | Me | 5 to 100 | 0 |
| 661 | CF═CFCF₃ | (CH₂)ₐ | 0 to 20 | Me | Me | OCF₃ | (CH₂)ₐ | 0 to 20 | Me | 5 to 100 | 0 |
| 662 | CF═CFCF═CF₂ | (CH₂)ₐ | 0 to 20 | Me | Me | OCF₃ | (CH₂)ₐ | 0 to 20 | Me | 5 to 100 | 0 |
| 663 | C≡CCF₃ | (CH₂)ₐ | 0 to 20 | Me | Me | OCF₃ | (CH₂)ₐ | 0 to 20 | Me | 5 to 100 | 0 |
| 664 | CF₂CH₃ | (CH₂)ₐ | 0 to 20 | Me | Me | OCF₃ | (CH₂)ₐ | 0 to 20 | Me | 5 to 100 | 0 |
| 665 | (CF₂)₂H | (CH₂)ₐ | 0 to 20 | Me | Me | OCF₃ | (CH₂)ₐ | 0 to 20 | Me | 5 to 100 | 0 |
| 666 | (CF₂)₂CH₃ | (CH₂)ₐ | 0 to 20 | Me | Me | OCF₃ | (CH₂)ₐ | 0 to 20 | Me | 5 to 100 | 0 |
| 667 | (CF₂)₄H | (CH₂)ₐ | 0 to 20 | Me | Me | OCF | (CH₂)ₐ | 0 to 20 | Me | 5 to 100 | 0 |
| 668 | C₆F₅ | (CH₂)ₐ | 0 to 20 | Me | Me | OCF₃ | (CH₂)ₐ | 0 to 20 | Me | 5 to 100 | 0 |
| 669 | 4-CF₃C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 659 | Me | Me | (CH₂)_{b} | 0 to 20 | SiMe | (CH₂)_{c} | 1 to 20 | Si(OMe)₃ | 2 |
| 660 | Me | Me | (CH₂)_{b} | 0 to 20 | SiMe | (CH₂)_{c} | 1 to 20 | Si(OMe)₃ | 2 |
| 661 | Me | Me | (CH₂)_{b} | 0 to 20 | SiMe | (CH₂)_{c} | 1 to 20 | Si(OMe)₃ | 2 |
| 662 | Me | Me | (CH₂)_{b} | 0 to 20 | SiMe | (CH₂)_{c} | 1 to 20 | Si(OMe)₃ | 2 |
| 663 | Me | Me | (CH₂)_{b} | 0 to 20 | SiMe | (CH₂)_{c} | 1 to 20 | Si(OMe)₃ | 2 |
| 664 | Me | Me | (CH₂)_{b} | 0 to 20 | SiMe | (CH₂)_{c} | 1 to 20 | Si(OMe)₃ | 2 |
| 665 | Me | Me | (CH₂)_{b} | 0 to 20 | SiMe | (CH₂)_{c} | 1 to 20 | Si(OMe)₃ | 2 |
| 666 | Me | Me | (CH₂)_{b} | 0 to 20 | SiMe | (CH₂)_{c} | 1 to 20 | Si(OMe)₃ | 2 |
| 667 | Me | Me | (CH₂)_{b} | 0 to 20 | SiMe | (CH₂)_{c} | 1 to 20 | Si(OMe)₃ | 2 |
| 668 | Me | Me | (CH₂)_{b} | 0 to 20 | SiMe | (CH₂)_{c} | 1 to 20 | Si(OMe)₃ | 2 |
| 669 | Me | Me | (CH₂)_{b} | 0 to 20 | SiMe | (CH₂)_{c} | 1 to 20 | Si(OMe)₃ | 2 |

TABLE 238

| No. | R²¹ | | a | R²² | R²³ | R²⁴ | | | R²⁵ | z21 | z22 |
|---|---|---|---|---|---|---|---|---|---|---|---|
| 670 | 4-SF₅C₆F | (CH₂)ₐ | 0 to 20 | Me | Me | OCF₃ | (CH₂)ₐ | 0 to 20 | Me | 5 to 100 | 0 |
| 671 | 3,5-CF₃C₆F₃ | (CH₂)ₐ | 0 to 20 | Me | Me | OCF₃ | (CH₂)ₐ | 0 to 20 | Me | 5 to 100 | 0 |
| 672 | 3,5-SF₅C₆F₃ | (CH₂)ₐ | 0 to 20 | Me | Me | OCF₃ | (CH₂)ₐ | 0 to 20 | Me | 5 to 100 | 0 |
| 673 | 4-CF₃C₆H₄ | (CH₂)ₐ | 0 to 20 | Me | Me | OCF₃ | (CH₂)ₐ | 0 to 20 | Me | 5 to 100 | 0 |
| 674 | 4-SF₅C₆H₄ | (CH₂)ₐ | 0 to 20 | Me | Me | OCF₃ | (CH₂)ₐ | 0 to 20 | Me | 5 to 100 | 0 |
| 675 | 3,5-CF₃C₆H₃ | (CH₂)ₐ | 0 to 20 | Me | Me | OCF₃ | (CH₂)ₐ | 0 to 20 | Me | 5 to 100 | 0 |
| 676 | 3,5-SF₅C₆H₃ | (CH₂)ₐ | 0 to 20 | Me | Me | OCF₃ | (CH₂)ₐ | 0 to 20 | Me | 5 to 100 | 0 |
| 677 | 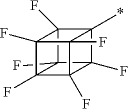 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 |
| 678 | 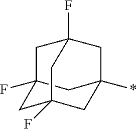 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 |
| 679 | 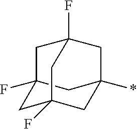 [SMILES: *C12CC3(F)CC(F)(C1)CC(F)(C2)C3] | (CH₂)ₐ | 0 t o20 | Me | Me | OCF₃ | (CH₂)ₐ | 0 to 20 | Me | 5 to 100 | 0 |
| 680 | SF₅ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 670 | Me | Me | (CH₂)_{b} | 0 to 20 | SiMe | (CH₂)_{c} | 1 to 20 | Si(OMe)₃ | 2 |
| 671 | Me | Me | (CH₂)_{b} | 0 to 20 | SiMe | (CH₂)_{c} | 1 to 20 | Si(OMe)₃ | 2 |
| 672 | Me | Me | (CH₂)_{b} | 0 to 20 | SiMe | (CH₂)_{c} | 1 to 20 | Si(OMe)₃ | 2 |
| 673 | Me | Me | (CH₂)_{b} | 0 to 20 | SiMe | (CH₂)_{c} | 1 to 20 | Si(OMe)₃ | 2 |
| 674 | Me | Me | (CH₂)_{b} | 0 to 20 | SiMe | (CH₂)_{c} | 1 to 20 | Si(OMe)₃ | 2 |
| 675 | Me | Me | (CH₂)_{b} | 0 to 20 | SiMe | (CH₂)_{c} | 1 to 20 | Si(OMe)₃ | 2 |
| 676 | Me | Me | (CH₂)_{b} | 0 to 20 | SiMe | (CH₂)_{c} | 1 to 20 | Si(OMe)₃ | 2 |
| 677 | Me | Me | (CH₂)_{b} | 0 to 20 | SiMe | (CH₂)_{c} | 1 to 20 | Si(OMe)₃ | 2 |
| 678 | Me | Me | (CH₂)_{b} | 0 to 20 | SiMe | (CH₂)_{c} | 1 to 20 | Si(OMe)₃ | 2 |
| 679 | Me | Me | (CH₂)_{b} | 0 to 20 | SiMe | (CH₂)_{c} | 1 to 20 | Si(OMe)₃ | 2 |
| 680 | Me | Me | (CH₂)_{b} | 0 to 20 | SiMe | (CH₂)_{c} | 1 to 20 | Si(OMe)₃ | 2 |

TABLE 239

| No. | R²¹ | | a | R²² | R²³ | R²⁴ | | | R²⁵ | z21 | z22 |
|---|---|---|---|---|---|---|---|---|---|---|---|
| 681 | OCF₃ | (CH₂)ₐ | 0 to 20 | Me | Me | OCF₃ | (CH₂)ₐ | 0 to 20 | Me | 5 to 100 | 0 |
| 682 | SCF₃ | (CH₂)ₐ | 0 to 20 | Me | Me | OCF₃ | (CH₂)ₐ | 0 to 20 | Me | 5 to 100 | 0 |
| 683 | N(CH₂CF₃)₂ | (CH₂)ₐ | 0 to 20 | Me | Me | OCF₃ | (CH₂)ₐ | 0 to 20 | Me | 5 to 100 | 0 |
| 684 | N(CF₃)₂ | (CH₂)ₐ | 0 to 20 | Me | Me | OCF₃ | (CH₂)ₐ | 0 to 20 | Me | 5 to 100 | 0 |
| 685 | Me | (CH₂)ₐ | 0 to 20 | Me | Me | SCF₃ | (CH₂)ₐ | 0 to 20 | Me | 5 to 100 | 0 |
| 686 | CF₃ | (CH₂)ₐ | 0 to 20 | Me | Me | SCF₃ | (CH₂)ₐ | 0 to 20 | Me | 5 to 100 | 0 |
| 687 | (CF₃)₂CF | (CH₂)ₐ | 0 to 20 | Me | Me | SCF₃ | (CH₂)ₐ | 0 to 20 | Me | 5 to 100 | 0 |
| 688 | (CF₃)₃C | (CH₂)ₐ | 0 to 20 | Me | Me | SCF₃ | (CH₂)ₐ | 0 to 20 | Me | 5 to 100 | 0 |
| 689 | C₄F₉ | (CH₂)ₐ | 0 to 20 | Me | Me | SCF₃ | (CH₂)ₐ | 0 to 20 | Me | 5 to 100 | 0 |
| 690 | C₈F₁₇ | (CH₂)ₐ | 0 to 20 | Me | Me | SCF₃ | (CH₂)ₐ | 0 to 20 | Me | 5 to 100 | 0 |
| 691 | c-C₆F₁₁ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 681 | Me | Me | (CH₂)_{b} | 0 to 20 | SiMe | (CH₂)_{c} | 1 to 20 | Si(OMe)₃ | 2 |
| 682 | Me | Me | (CH₂)_{b} | 0 to 20 | SiMe | (CH₂)_{c} | 1 to 20 | Si(OMe)₃ | 2 |
| 683 | Me | Me | (CH₂)_{b} | 0 to 20 | SiMe | (CH₂)_{c} | 1 to 20 | Si(OMe)₃ | 2 |
| 684 | Me | Me | (CH₂)_{b} | 0 to 20 | SiMe | (CH₂)_{c} | 1 to 20 | Si(OMe)₃ | 2 |
| 685 | Me | Me | (CH₂)_{b} | 0 to 20 | SiMe | (CH₂)_{c} | 1 to 20 | Si(OMe)₃ | 2 |
| 686 | Me | Me | (CH₂)_{b} | 0 to 20 | SiMe | (CH₂)_{c} | 1 to 20 | Si(OMe)₃ | 2 |
| 687 | Me | Me | (CH₂)_{b} | 0 to 20 | SiMe | (CH₂)_{c} | 1 to 20 | Si(OMe)₃ | 2 |
| 688 | Me | Me | (CH₂)_{b} | 0 to 20 | SiMe | (CH₂)_{c} | 1 to 20 | Si(OMe)₃ | 2 |
| 689 | Me | Me | (CH₂)_{b} | 0 to 20 | SiMe | (CH₂)_{c} | 1 to 20 | Si(OMe)₃ | 2 |
| 690 | Me | Me | (CH₂)_{b} | 0 to 20 | SiMe | (CH₂)_{c} | 1 to 20 | Si(OMe)₃ | 2 |
| 691 | Me | Me | (CH₂)_{b} | 0 to 20 | SiMe | (CH₂)_{c} | 1 to 20 | Si(OMe)₃ | 2 |

TABLE 240

| No. | R²¹ | | a | R²² | R²³ | R²⁴ | | | R²⁵ | z21 | z22 |
|---|---|---|---|---|---|---|---|---|---|---|---|
| 692 | CHF₂ | (CH₂)ₐ | 0 to 20 | Me | Me | SCF₃ | (CH₂)ₐ | 0 to 20 | Me | 5 to 100 | 0 |
| 693 | CClF₂ | (CH₂)ₐ | 0 to 20 | Me | Me | SCF₃ | (CH₂)ₐ | 0 to 20 | Me | 5 to 100 | 0 |
| 694 | CBrF₂ | (CH₂)ₐ | 0 to 20 | Me | Me | SCF₃ | (CH₂)ₐ | 0 to 20 | Me | 5 to 100 | 0 |
| 695 | ClF₂ | (CH₂)ₐ | 0 to 20 | Me | Me | SCF₃ | (CH₂)ₐ | 0 to 20 | Me | 5 to 100 | 0 |
| 696 | CF═CF₂ | (CH₂)ₐ | 0 to 20 | Me | Me | SCF₃ | (CH₂)ₐ | 0 to 20 | Me | 5 to 100 | 0 |
| 697 | CF═CFCF₃ | (CH₂)ₐ | 0 to 20 | Me | Me | SCF₃ | (CH₂)ₐ | 0 to 20 | Me | 5 to 100 | 0 |
| 698 | CF═CFCF═CF₂ | (CH₂)ₐ | 0 to 20 | Me | Me | SCF₃ | (CH₂)ₐ | 0 to 20 | Me | 5 to 100 | 0 |
| 699 | C≡CCF₃ | (CH₂)ₐ | 0 to 20 | Me | Me | SCF₃ | (CH₂)ₐ | 0 to 20 | Me | 5 to 100 | 0 |
| 700 | CF₂CH₃ | (CH₂)ₐ | 0 to 20 | Me | Me | SCF₃ | (CH₂)ₐ | 0 to 20 | Me | 5 to 100 | 0 |
| 701 | (CF₂)₂H | (CH₂)ₐ | 0 to 20 | Me | Me | SCF₃ | (CH₂)ₐ | 0 to 20 | Me | 5 to 100 | 0 |
| 702 | (CF₂)₂CH₃ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 692 | Me | Me | (CH₂)_{b} | 0 to 20 | SiMe | (CH₂)_{c} | 1 to 20 | Si(OMe)₃ | 2 |
| 693 | Me | Me | (CH₂)_{b} | 0 to 20 | SiMe | (CH₂)_{c} | 1 to 20 | Si(OMe)₃ | 2 |
| 694 | Me | Me | (CH₂)_{b} | 0 to 20 | SiMe | (CH₂)_{c} | 1 to 20 | Si(OMe)₃ | 2 |
| 695 | Me | Me | (CH₂)_{b} | 0 to 20 | SiMe | (CH₂)_{c} | 1 to 20 | Si(OMe)₃ | 2 |
| 696 | Me | Me | (CH₂)_{b} | 0 to 20 | SiMe | (CH₂)_{c} | 1 to 20 | Si(OMe)₃ | 2 |
| 697 | Me | Me | (CH₂)_{b} | 0 to 20 | SiMe | (CH₂)_{c} | 1 to 20 | Si(OMe)₃ | 2 |
| 698 | Me | Me | (CH₂)_{b} | 0 to 20 | SiMe | (CH₂)_{c} | 1 to 20 | Si(OMe)₃ | 2 |
| 699 | Me | Me | (CH₂)_{b} | 0 to 20 | SiMe | (CH₂)_{c} | 1 to 20 | Si(OMe)₃ | 2 |
| 700 | Me | Me | (CH₂)_{b} | 0 to 20 | SiMe | (CH₂)_{c} | 1 to 20 | Si(OMe)₃ | 2 |
| 701 | Me | Me | (CH₂)_{b} | 0 to 20 | SiMe | (CH₂)_{c} | 1 to 20 | Si(OMe)₃ | 2 |
| 702 | Me | Me | (CH₂)_{b} | 0 to 20 | SiMe | (CH₂)_{c} | 1 to 20 | Si(OMe)₃ | 2 |

TABLE 241

| No. | R²¹ | | a | R²² | R²³ | R²⁴ | | | R²⁵ | z21 | z22 |
|---|---|---|---|---|---|---|---|---|---|---|---|
| 703 | (CF₂)₄H | (CH₂)ₐ | 0 to 20 | Me | Me | SCF₃ | (CH₂)ₐ | 0 to 20 | Me | 5 to 100 | 0 |
| 704 | C₆F₅ | (CH₂)ₐ | 0 to 20 | Me | Me | SCF₃ | (CH₂)ₐ | 0 to 20 | Me | 5 to 100 | 0 |
| 705 | 4-CF₃C₆F₄ | (CH₂)ₐ | 0 to 20 | Me | Me | SCF₃ | (CH₂)ₐ | 0 to 20 | Me | 5 to 100 | 0 |
| 706 | 4-SF₅C₆F₄ | (CH₂)ₐ | 0 to 20 | Me | Me | SCF₃ | (CH₂)ₐ | 0 to 20 | Me | 5 to 100 | 0 |
| 707 | 3,5-CF₃C₆F₃ | (CH₂)ₐ | 0 to 20 | Me | Me | SCF₃ | (CH₂)ₐ | 0 to 20 | Me | 5 to 100 | 0 |
| 708 | 3,5-SF₅C₆F₃ | (CH₂)ₐ | 0 to 20 | Me | Me | SCF₃ | (CH₂)ₐ | 0 to 20 | Me | 5 to 100 | 0 |
| 709 | 4-CF₃C₆H₄ | (CH₂)ₐ | 0 to 20 | Me | Me | SCF₃ | (CH₂)ₐ | 0 to 20 | Me | 5 to 100 | 0 |
| 710 | 4-SF₅C₆H₄ | (CH₂)ₐ | 0 to 20 | Me | Me | SCF₃ | (CH₂)ₐ | 0 to 20 | Me | 5 to 100 | 0 |
| 711 | 3,5-CF₃C₆H₃ | (CH₂)ₐ | 0 to 20 | Me | Me | SCF₃ | (CH₂)ₐ | 0 to 20 | Me | 5 to 100 | 0 |
| 712 | 3,5-SF₅C₆H₃ | (CH2)ₐ | 0 to 20 | Me | Me | SCF₃ | (CH₂)ₐ | 0 to 20 | Me | 5 to 100 | 0 |
| 713 | 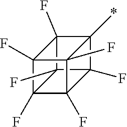 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 703 | Me | Me | (CH₂)_{b} | 0 to 20 | SiMe | (CH₂)_{c} | 1 to 20 | Si(OMe)₃ | 2 |
| 704 | Me | Me | (CH₂)_{b} | 0 to 20 | SiMe | (CH₂)_{c} | 1 to 20 | Si(OMe)₃ | 2 |
| 705 | Me | Me | (CH₂)_{b} | 0 to 20 | SiMe | (CH₂)_{c} | 1 to 20 | Si(OMe)₃ | 2 |
| 706 | Me | Me | (CH₂)_{b} | 0 to 20 | SiMe | (CH₂)_{c} | 1 to 20 | Si(OMe)₃ | 2 |
| 707 | Me | Me | (CH₂)_{b} | 0 to 20 | SiMe | (CH₂)_{c} | 1 to 20 | Si(OMe)₃ | 2 |
| 708 | Me | Me | (CH₂)_{b} | 0 to 20 | SiMe | (CH₂)_{c} | 1 to 20 | Si(OMe)₃ | 2 |
| 709 | Me | Me | (CH₂)_{b} | 0 to 20 | SiMe | (CH₂)_{c} | 1 to 20 | Si(OMe)₃ | 2 |
| 710 | Me | Me | (CH₂)_{b} | 0 to 20 | SiMe | (CH₂)_{c} | 1 to 20 | Si(OMe)₃ | 2 |
| 711 | Me | Me | (CH₂)_{b} | 0 to 20 | SiMe | (CH₂)_{c} | 1 to 20 | Si(OMe)₃ | 2 |
| 712 | Me | Me | (CH₂)_{b} | 0 to 20 | SiMe | (CH₂)_{c} | 1 to 20 | Si(OMe)₃ | 2 |
| 713 | Me | Me | (CH₂)_{b} | 0 to 20 | SiMe | (CH₂)_{c} | 1 to 20 | Si(OMe)₃ | 2 |

TABLE 242

| No. | R²¹ | | a | R²² | R²³ | R²⁴ | | | R²⁵ | z21 | z22 |
|---|---|---|---|---|---|---|---|---|---|---|---|
| 714 | 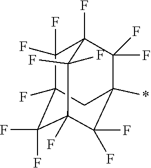 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 50 to 100 | 0 |
| 715 | 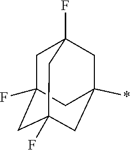 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 |
| 716 | SF₅ | (CH₂)ₐ | 0 to 20 | Me | Me | SCF₃ | (CH₂)ₐ | 0 to 20 | Me | 5 to 100 | 0 |
| 717 | OCF₃ | (CH₂)ₐ | 0 to 20 | Me | Me | SCF₃ | (CH₂)ₐ | 0 to 20 | Me | 5 to 100 | 0 |
| 718 | SCF₃ | (CH₂)ₐ | 0 to 20 | Me | Me | SCF₃ | (CH₂)ₐ | 0 to 20 | Me | 5 to 100 | 0 |
| 719 | N(CH₂CF₃)₂ | (CH₂)ₐ | 0 to 20 | Me | Me | SCF₃ | (CH₂)ₐ | 0 to 20 | Me | 5 to 100 | 0 |
| 720 | N(CF₃)₂ | (CH₂)ₐ | 0 to 20 | Me | Me | SCF₃ | (CH₂)ₐ | 0 to 20 | Me | 5 to 100 | 0 |
| 721 | Me | (CH₂)ₐ | 0 to 20 | Me | Me | N(CF₃)₂ | (CH₂)ₐ | 0 to 20 | Me | 5 to 100 | 0 |
| 722 | CF₃ | (CH₂)ₐ | 0 to 20 | Me | Me | N(CF₃)₂ | (CH₂)ₐ | 0 to 20 | Me | 5 to 100 | 0 |
| 723 | (CF₃)₂CF | (CH₂)ₐ | 0 to 20 | Me | Me | N(CF₃)₂ | (CH₂)ₐ | 0 to 20 | Me | 5 to 100 | 0 |
| 724 | (CF₃)₃C | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | R¹ | x1 |
|---|---|---|---|---|---|---|---|---|---|
| 714 | Me | Me | (CH₂)_{b} | 0 to 20 | SiMe | (CH₂)_{c} | 1 to 20 | Si(OMe)₃ | 2 |
| 715 | Me | Me | (CH₂)_{b} | 0 to 20 | SiMe | (CH₂)_{c} | 1 to 20 | Si(OMe)₃ | 2 |
| 716 | Me | Me | (CH₂)_{b} | 0 to 20 | SiMe | (CH₂)_{c} | 1 to 20 | Si(OMe)₃ | 2 |
| 717 | Me | Me | (CH₂)_{b} | 0 to 20 | SiMe | (CH₂)_{c} | 1 to 20 | Si(OMe)₃ | 2 |
| 718 | Me | Me | (CH₂)_{b} | 0 to 20 | SiMe | (CH₂)_{c} | 1 to 20 | Si(OMe)₃ | 2 |
| 719 | Me | Me | (CH₂)_{b} | 0 to 20 | SiMe | (CH₂)_{c} | 1 to 20 | Si(OMe)₃ | 2 |
| 720 | Me | Me | (CH₂)_{b} | 0 to 20 | SiMe | (CH₂)_{c} | 1 to 20 | Si(OMe)₃ | 2 |
| 721 | Me | Me | (CH₂)_{b} | 0 to 20 | SiMe | (CH₂)_{c} | 1 to 20 | Si(OMe)₃ | 2 |
| 722 | Me | Me | (CH₂)_{b} | 0 to 20 | SiMe | (CH₂)_{c} | 1 to 20 | Si(OMe)₃ | 2 |
| 723 | Me | Me | (CH₂)_{b} | 0 to 20 | SiMe | (CH₂)_{c} | 1 to 20 | Si(OMe)₃ | 2 |
| 724 | Me | Me | (CH₂)_{b} | 0 to 20 | SiMe | (CH₂)_{c} | 1 to 20 | Si(OMe)₃ | 2 |

TABLE 243

| No. | R²¹ | | a | R²² | R²³ | R²⁴ | | | R²⁵ | z21 |
|---|---|---|---|---|---|---|---|---|---|---|
| 725 | C₄F₉ | (CH₂)ₐ | 0 to 20 | Me | Me | N(CF₃)₂ | (CH₂)ₐ | 0 to 20 | Me | 5 to 100 |
| 726 | C₈F₁₇ | (CH₂)ₐ | 0 to 20 | Me | Me | N(CF₃)₂ | (CH₂)ₐ | 0 to 20 | Me | 5 to 100 |
| 727 | c-C₆F₁₁ | (CH₂)ₐ | 0 to 20 | Me | Me | N(CF₃)₂ | (CH₂)ₐ | 0 to 20 | Me | 5 to 100 |
| 728 | CHF₂ | (CH₂)ₐ | 0 to 20 | Me | Me | N(CF₃)₂ | (CH₂)ₐ | 0 to 20 | Me | 5 to 100 |
| 729 | CClF₂ | (CH₂)ₐ | 0 to 20 | Me | Me | N(CF₃)₂ | (CH₂)ₐ | 0 to 20 | Me | 5 to 100 |
| 730 | CBrF₂ | (CH₂)ₐ | 0 to 20 | Me | Me | N(CF₃)₂ | (CH₂)ₐ | 0 to 20 | Me | 5 to 100 |
| 731 | ClF₂ | (CH₂)ₐ | 0 to 20 | Me | Me | N(CF₃)₂ | (CH₂)ₐ | 0 to 20 | Me | 5 to 100 |
| 732 | CF═CF₂ | (CH₂)ₐ | 0 to 20 | Me | Me | N(CF₃)₂ | (CH₂)ₐ | 0 to 20 | Me | 5 to 100 |
| 733 | CF═CFCF₃ | (CH₂)ₐ | 0 to 20 | Me | Me | N(CF₃)₂ | (CH₂)ₐ | 0 to 20 | Me | 5 to 100 |
| 734 | CF═CFCF═CF₂ | (CH₂)ₐ | 0 to 20 | Me | Me | N(CF₃)₂ | (CH₂)ₐ | 0 to 20 | Me | 5 to 100 |
| 735 | C≡CCF₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 725 | 0 | Me | Me | (CH₂)_{b} | 0 to 20 | SiMe | (CH₂)_{c} | 1 to 20 | Si(OMe)₃ | 2 |
| 726 | 0 | Me | Me | (CH₂)_{b} | 0 to 20 | SiMe | (CH₂)_{c} | 1 to 20 | Si(OMe)₃ | 2 |
| 727 | 0 | Me | Me | (CH₂)_{b} | 0 to 20 | SiMe | (CH₂)_{c} | 1 to 20 | Si(OMe)₃ | 2 |
| 728 | 0 | Me | Me | (CH₂)_{b} | 0 to 20 | SiMe | (CH₂)_{c} | 1 to 20 | Si(OMe)₃ | 2 |
| 729 | 0 | Me | Me | (CH₂)_{b} | 0 to 20 | SiMe | (CH₂)_{c} | 1 to 20 | Si(OMe)₃ | 2 |
| 730 | 0 | Me | Me | (CH₂)_{b} | 0 to 20 | SiMe | (CH₂)_{c} | 1 to 20 | Si(OMe)₃ | 2 |
| 731 | 0 | Me | Me | (CH₂)_{b} | 0 to 20 | SiMe | (CH₂)_{c} | 1 to 20 | Si(OMe)₃ | 2 |
| 732 | 0 | Me | Me | (CH₂)_{b} | 0 to 20 | SiMe | (CH₂)_{c} | 1 to 20 | Si(OMe)₃ | 2 |
| 733 | 0 | Me | Me | (CH₂)_{b} | 0 to 20 | SiMe | (CH₂)_{c} | 1 to 20 | Si(OMe)₃ | 2 |
| 734 | 0 | Me | Me | (CH₂)_{b} | 0 to 20 | SiMe | (CH₂)_{c} | 1 to 20 | Si(OMe)₃ | 2 |
| 735 | 0 | Me | Me | (CH₂)_{b} | 0 to 20 | SiMe | (CH₂)_{c} | 1 to 20 | Si(OMe)₃ | 2 |

TABLE 244

| No. | R²¹ | | a | R²² | R²³ | R²⁴ | | | R²⁵ | z21 |
|---|---|---|---|---|---|---|---|---|---|---|
| 736 | CF₂CH₃ | (CH₂)ₐ | 0 to 20 | Me | Me | N(CF₃)₂ | (CH₂)ₐ | 0 to 20 | Me | 5 to 100 |
| 737 | (CF₂)₂H | (CH₂)ₐ | 0 to 20 | Me | Me | N(CF₃)₂ | (CH₂)ₐ | 0 to 20 | Me | 5 to 100 |
| 738 | (CF₂)₂CH₃ | (CH₂)ₐ | 0 to 20 | Me | Me | N(CF₃)₂ | (CH₂)ₐ | 0 to 20 | Me | 5 to 100 |
| 739 | (CF₂)₄H | (CH₂)ₐ | 0 to 20 | Me | Me | SCF₃ | (CH₂)ₐ | 0 to 20 | Me | 5 to 100 |
| 740 | C₆F₅ | (CH₂)ₐ | 0 to 20 | Me | Me | N(CF₃)₂ | (CH₂)ₐ | 0 to 20 | Me | 5 to 100 |
| 741 | 4-CF₃C₆F₄ | (CH₂)ₐ | 0 to 20 | Me | Me | N(CF₃)₂ | (CH₂)ₐ | 0 to 20 | Me | 5 to 100 |
| 742 | 4-SF₅C₆F₄ | (CH₂)ₐ | 0 to 20 | Me | Me | N(CF₃)₂ | (CH₂)ₐ | 0 to 20 | Me | 5 to 100 |
| 743 | 3,5-CF₃C₆F₃ | (CH₂)ₐ | 0 to 20 | Me | Me | N(CF₃)₂ | (CH₂)ₐ | 0 to 20 | Me | 5 to 100 |
| 744 | 3,5-SF₅C₆F₃ | (CH₂)ₐ | 0 to 20 | Me | Me | N(CF₃)₂ | (CH₂)ₐ | 0 to 20 | Me | 5 to 100 |
| 745 | 4-CF₃C₆H₄ | (CH₂)ₐ | 0 to 20 | Me | Me | N(CF₃)₂ | (CH₂)ₐ | 0 to 20 | Me | 5 to 100 |
| 746 | 4-SF₅C₆H₄ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 736 | 0 | Me | Me | (CH₂)_{b} | 0 to 20 | SiMe | (CH₂)_{c} | 1 to 20 | Si(OMe)₃ | 2 |
| 737 | 0 | Me | Me | (CH₂)_{b} | 0 to 20 | SiMe | (CH₂)_{c} | 1 to 20 | Si(OMe)₃ | 2 |
| 738 | 0 | Me | Me | (CH₂)_{b} | 0 to 20 | SiMe | (CH₂)_{c} | 1 to 20 | Si(OMe)₃ | 2 |
| 739 | 0 | Me | Me | (CH₂)_{b} | 0 to 20 | SiMe | (CH₂)_{c} | 1 to 20 | Si(OMe)₃ | 2 |
| 740 | 0 | Me | Me | (CH₂)_{b} | 0 to 20 | SiMe | (CH₂)_{c} | 1 to 20 | Si(OMe)₃ | 2 |
| 741 | 0 | Me | Me | (CH₂)_{b} | 0 to 20 | SiMe | (CH₂)_{c} | 1 to 20 | Si(OMe)₃ | 2 |
| 742 | 0 | Me | Me | (CH₂)_{b} | 0 to 20 | SiMe | (CH₂)_{c} | 1 to 20 | Si(OMe)₃ | 2 |
| 743 | 0 | Me | Me | (CH₂)_{b} | 0 to 20 | SiMe | (CH₂)_{c} | 1 to 20 | Si(OMe)₃ | 2 |
| 744 | 0 | Me | Me | (CH₂)_{b} | 0 to 20 | SiMe | (CH₂)_{c} | 1 to 20 | Si(OMe)₃ | 2 |
| 745 | 0 | Me | Me | (CH₂)_{b} | 0 to 20 | SiMe | (CH₂)_{c} | 1 to 20 | Si(OMe)₃ | 2 |
| 746 | 0 | Me | Me | (CH₂)_{b} | 0 to 20 | SiMe | (CH₂)_{c} | 1 to 20 | Si(OMe)₃ | 2 |

TABLE 245

| No. | R²¹ | | a | R²² | R²³ | R²⁴ | | | R²⁵ | z21 | z22 |
|---|---|---|---|---|---|---|---|---|---|---|---|
| 747 | 3,5-CF₃C₆H₃ | (CH₂)ₐ | 0 to 20 | Me | Me | N(CF₃)₂ | (CH₂)ₐ | 0 to 20 | Me | 5 to 100 | 0 |
| 748 | 3,5-SF₅C₆H₃ | (CH₂)ₐ | 0 to 20 | Me | Me | N(CF₃)₂ | (CH₂)ₐ | 0 to 20 | Me | 5 to 100 | 0 |
| 749 | 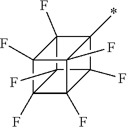 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 |
| 750 | 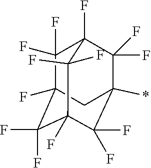 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 |
| 751 | 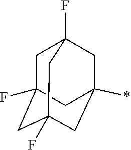 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 |
| 752 | SF₅ | (CH₂)ₐ | 0 to 20 | Me | Me | N(CF₃)₂ | (CH2)ₐ | 0 to 20 | Me | 5 to 100 | 0 |
| 753 | OCF₃ | (CH₂)ₐ | 0 to 20 | Me | Me | N(CF₃)₂ | (CH₂)ₐ | 0 to 20 | Me | 5 to 100 | 0 |
| 754 | SCFR₃ | (CH₂)ₐ | 0 to 20 | Me | Me | N(CF₃)₂ | (CH₂)ₐ | 0 to 20 | Me | 5 to 100 | 0 |
| 755 | N(CH₂CF₃)₂ | (CH₂)ₐ | 0 to 20 | ME | Me | N(CF₃)₂ | (CH₂)ₐ | 0 to 20 | Me | 5 to 100 | 0 |
| 756 | N(CF₃)₂ | (CH₂)ₐ | 0 to 20 | Me | Me | N(CF₃)₂ | (CH₂)ₐ | 0 to 20 | Me | 5 to 100 | 0 |
| 757 | Me | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 747 | Me | Me | (CH₂)_{b} | 0 to 20 | SiMe | (CH₂)_{c} | 1 to 20 | Si(OMe)₃ | 2 |
| 748 | Me | Me | (CH₂)_{b} | 0 to 20 | SiMe | (CH₂)_{c} | 1 to 20 | Si(OMe)₃ | 2 |
| 749 | Me | Me | (CH₂)_{b} | 0 to 20 | SiMe | (CH₂)_{c} | 1 to 20 | Si(OMe)₃ | 2 |
| 750 | Me | Me | (CH₂)_{b} | 0 to 20 | SiMe | (CH₂)_{c} | 1 to 20 | Si(OMe)₃ | 2 |
| 751 | Me | Me | (CH₂)_{b} | 0 to 20 | SiMe | (CH₂)_{c} | 1 to 20 | Si(OMe)₃ | 2 |
| 752 | Me | Me | (CH₂)_{b} | 0 to 20 | SiMe | (CH₂)_{c} | 1 to 20 | Si(OMe)₃ | 2 |
| 753 | Me | Me | (CH₂)_{b} | 0 to 20 | SiMe | (CH₂)_{c} | 1 to 20 | Si(OMe)₃ | 2 |
| 754 | Me | Me | (CH₂)_{b} | 0 to 20 | SiMe | (CH₂)_{c} | 1 to 20 | Si(OMe)₃ | 2 |
| 755 | Me | Me | (CH₂)_{b} | 0 to 20 | SiMe | (CH₂)_{c} | 1 to 20 | Si(OMe)₃ | 2 |
| 756 | Me | Me | (CH₂)_{b} | 0 to 20 | SiMe | (CH₂)_{c} | 1 to 20 | Si(OMe)₃ | 2 |
| 757 | Me | Me | (CH₂)_{b} | 0 to 20 | SiMe | (CH₂)_{c} | 1 to 20 | Si(OMe)₃ | 2 |

TABLE 246

| No. | R²¹ | | a | R²² | R²³ | R²⁴ | | | R²⁵ | z21 |
|---|---|---|---|---|---|---|---|---|---|---|
| 758 | CF₃ | (CH₂)ₐ | 0 to 20 | Me | Me | CF₃ | (CH₂)ₐ | 0 to 20 | Me | 5 to 100 |
| 759 | (CF₃)₂CF | (CH₂)ₐ | 0 to 20 | Me | Me | CF₃ | (CH₂)ₐ | 0 to 20 | Me | 5 to 100 |
| 760 | (CF₃)₃C | (CH₂)ₐ | 0 to 20 | Me | Me | CF₃ | (CH₂)ₐ | 0 to 20 | Me | 5 to 100 |
| 761 | C₄F₉ | (CH₂)ₐ | 0 to 20 | Me | Me | CF₃ | (CH₂)ₐ | 0 to 20 | Me | 5 to 100 |
| 762 | C₈F₁₇ | (CH₂)ₐ | 0 to 20 | Me | Me | CF₃ | (CH₂)ₐ | 0 to 20 | Me | 5 to 100 |
| 763 | c-C₆F₁₁ | (CH₂)ₐ | 0 to 20 | Me | Me | CF₃ | (CH₂)ₐ | 0 to 20 | Me | 5 to 100 |
| 764 | CHF₂ | (CH₂)ₐ | 0 to 20 | Me | Me | CF₃ | (CH₂)ₐ | 0 to 20 | Me | 5 to 100 |
| 765 | CClF₂ | (CH₂)ₐ | 0 to 20 | Me | Me | CF₃ | (CH₂)ₐ | 0 to 20 | Me | 5 to 100 |
| 766 | CBrF₂ | (CH₂)ₐ | 0 to 20 | Me | Me | CF₃ | (CH₂)ₐ | 0 to 20 | Me | 5 to 100 |
| 767 | ClF₂ | (CH₂)ₐ | 0 to 20 | Me | Me | CF₃ | (CH₂)ₐ | 0 to 20 | Me | 5 to 100 |
| 768 | CF═CF₂ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 758 | 0 | Me | Me | (CH₂)_{b} | 0 to 20 | CH | (CH₂)_{c} | 1 to 20 | Si(OMe)₃ | 2 |
| 759 | 0 | Me | Me | (CH₂)_{b} | 0 to 20 | CH | (CH₂)_{c} | 1 to 20 | Si(OMe)₃ | 2 |
| 760 | 0 | Me | Me | (CH₂)_{b} | 0 to 20 | CH | (CH₂)_{c} | 1 to 20 | Si(OMe)₃ | 2 |
| 761 | 0 | Me | Me | (CH₂)_{b} | 0 to 20 | CH | (CH₂)_{c} | 1 to 20 | Si(OMe)₃ | 2 |
| 762 | 0 | Me | Me | (CH₂)_{b} | 0 to 20 | CH | (CH₂)_{c} | 1 to 20 | Si(OMe)₃ | 2 |
| 763 | 0 | Me | Me | (CH₂)_{b} | 0 to 20 | CH | (CH₂)_{c} | 1 to 20 | Si(OMe)₃ | 2 |
| 764 | 0 | Me | Me | (CH₂)_{b} | 0 to 20 | CH | (CH₂)_{c} | 1 to 20 | Si(OMe)₃ | 2 |
| 765 | 0 | Me | Me | (CH₂)_{b} | 0 to 20 | CH | (CH₂)_{c} | 1 to 20 | Si(OMe)₃ | 2 |
| 766 | 0 | Me | Me | (CH₂)_{b} | 0 to 20 | CH | (CH₂)_{c} | 1 to 20 | Si(OMe)₃ | 2 |
| 767 | 0 | Me | Me | (CH₂)_{b} | 0 to 20 | CH | (CH₂)_{c} | 1 to 20 | Si(OMe)₃ | 2 |
| 768 | 0 | Me | Me | (CH₂)_{b} | 0 to 20 | CH | (CH₂)_{c} | 1 to 20 | Si(OMe)₃ | 2 |

TABLE 247

| No. | R²¹ | | a | R²² | R²³ | R²⁴ | | | R²⁵ | z21 |
|---|---|---|---|---|---|---|---|---|---|---|
| 769 | CF═CFCF₃ | (CH₂)ₐ | 0 to 20 | Me | Me | CF₃ | (CH₂)ₐ | 0 to 20 | Me | 5 to 100 |
| 770 | CF═CFCF═CF₂ | (CH₂)ₐ | 0 to 20 | Me | Me | CF₃ | (CH₂)ₐ | 0 to 20 | Me | 5 to 100 |
| 771 | C≡CCF₃ | (CH₂)ₐ | 0 to 20 | Me | Me | CF₃ | (CH₂)ₐ | 0 to 20 | Me | 5 to 100 |
| 772 | CF₂CH₃ | (CH₂)ₐ | 0 to 20 | Me | Me | CF₃ | (CH₂)ₐ | 0 to 20 | Me | 5 to 100 |
| 773 | (CF₂)₂H | (CH₂)ₐ | 0 to 20 | Me | Me | CF₃ | (CH₂)ₐ | 0 to 20 | Me | 5 to 100 |
| 774 | (CF₂)₂CH₃ | (CH₂)ₐ | 0 to 20 | Me | Me | CF₃ | (CH₂)ₐ | 0 to 20 | Me | 5 to 100 |
| 775 | (CF₂)₄H | (CH₂)ₐ | 0 to 20 | Me | Me | CF₃ | (CH₂)ₐ | 0 to 20 | Me | 5 to 100 |
| 776 | C₆F₅ | (CH₂)ₐ | 0 to 20 | Me | Me | CF₃ | (CH₂)ₐ | 0 to 20 | Me | 5 to 100 |
| 777 | 4-CF₃C₆F₄ | (CH₂)ₐ | 0 to 20 | Me | Me | CF₃ | (CH₂)ₐ | 0 to 20 | Me | 5 to 100 |
| 778 | 4-SF₅C₆F₄ | (CH₂)ₐ | 0 to 20 | Me | Me | CF₃ | (CH₂)ₐ | 0 to 20 | Me | 5 to 100 |
| 779 | 3,5-CF₃C₆F₃ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 769 | 0 | Me | Me | (CH₂)_{b} | 0 to 20 | CH | (CH₂)_{c} | 1 to 20 | Si(OMe)₃ | 2 |
| 770 | 0 | Me | Me | (CH₂)_{b} | 0 to 20 | CH | (CH₂)_{c} | 1 to 20 | Si(OMe)₃ | 2 |
| 771 | 0 | Me | Me | (CH₂)_{b} | 0 to 20 | CH | (CH₂)_{c} | 1 to 20 | Si(OMe)₃ | 2 |
| 772 | 0 | Me | Me | (CH₂)_{b} | 0 to 20 | CH | (CH₂)_{c} | 1 to 20 | Si(OMe)₃ | 2 |
| 773 | 0 | Me | Me | (CH₂)_{b} | 0 to 20 | CH | (CH₂)_{c} | 1 to 20 | Si(OMe)₃ | 2 |
| 774 | 0 | Me | Me | (CH₂)_{b} | 0 to 20 | CH | (CH₂)_{c} | 1 to 20 | Si(OMe)₃ | 2 |
| 775 | 0 | Me | Me | (CH₂)_{b} | 0 to 20 | CH | (CH₂)_{c} | 1 to 20 | Si(OMe)₃ | 2 |
| 776 | 0 | Me | Me | (CH₂)_{b} | 0 to 20 | CH | (CH₂)_{c} | 1 to 20 | Si(OMe)₃ | 2 |
| 777 | 0 | Me | Me | (CH₂)_{b} | 0 to 20 | CH | (CH₂)_{c} | 1 to 20 | Si(OMe)₃ | 2 |
| 778 | 0 | Me | Me | (CH₂)_{b} | 0 to 20 | CH | (CH₂)_{c} | 1 to 20 | Si(OMe)₃ | 2 |
| 779 | 0 | Me | Me | (CH₂)_{b} | 0 to 20 | CH | (CH₂)_{c} | 1 to 20 | Si(OMe)₃ | 2 |

TABLE 248

| No. | R²¹ | | a | R²² | R²³ | R²⁴ | | | R²⁵ | z21 | z22 |
|---|---|---|---|---|---|---|---|---|---|---|---|
| 780 | 3,5-SF₅C₆F₃ | (CH₂)ₐ | 0 to 20 | Me | Me | CF₃ | (CH₂)ₐ | 0 to 20 | Me | 5 to 100 | 0 |
| 781 | 4-CF₃C₆H₄ | (CH₂)ₐ | 0 to 20 | Me | Me | CF₃ | (CH₂)ₐ | 0 to 20 | Me | 5 to 100 | 0 |
| 782 | 4-SF₅C₆H₄ | (CH₂)ₐ | 0 to 20 | Me | Me | CF₃ | (CH₂)ₐ | 0 to 20 | Me | 5 to 100 | 0 |
| 783 | 3,5-CF₃C₆H₃ | (CH₂)ₐ | 0 to 20 | Me | Me | CF₃ | (CH₂)ₐ | 0 to 20 | Me | 5 to 100 | 0 |
| 784 | 3,5-SF₅C₆H₃ | (CH₂)ₐ | 0 to 20 | Me | Me | CF₃ | (CH₂)ₐ | 0 to 20 | Me | 5 to 100 | 0 |
| 785 | 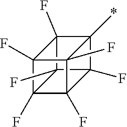 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 |
| 786 | 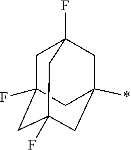 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 |
| 787 | 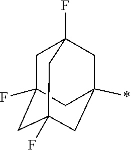 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 |
| 788 | SF₅ | (CH₂)ₐ | 0 to 20 | Me | Me | CF₃ | (CH₂)ₐ | 0 to 20 | Me | 5 to 100 | 0 |
| 789 | OCF₃ | (CH₂)ₐ | 0 to 20 | Me | Me | CF₃ | (CH₂)ₐ | 0 to 20 | Me | 5 to 100 | 0 |
| 790 | SCF₃ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 780 | Me | Me | (CH₂)_{b} | 0 to 20 | CH | (CH₂)_{c} | 1 to 20 | Si(OMe)₃ | 2 |
| 781 | Me | Me | (CH₂)_{b} | 0 to 20 | CH | (CH₂)_{c} | 1 to 20 | Si(OMe)₃ | 2 |
| 782 | Me | Me | (CH₂)_{b} | 0 to 20 | CH | (CH₂)_{c} | 1 to 20 | Si(OMe)₃ | 2 |
| 783 | Me | Me | (CH₂)_{b} | 0 to 20 | CH | (CH₂)_{c} | 1 to 20 | Si(OMe)₃ | 2 |
| 784 | Me | Me | (CH₂)_{b} | 0 to 20 | CH | (CH₂)_{c} | 1 to 20 | Si(OMe)₃ | 2 |
| 785 | Me | Me | (CH₂)_{b} | 0 to 20 | CH | (CH₂)_{c} | 1 to 20 | Si(OMe)₃ | 2 |
| 786 | Me | Me | (CH₂)_{b} | 0 to 20 | CH | (CH₂)_{c} | 1 to 20 | Si(OMe)₃ | 2 |
| 787 | Me | Me | (CH₂)_{b} | 0 to 20 | CH | (CH₂)_{c} | 1 to 20 | Si(OMe)₃ | 2 |
| 788 | Me | Me | (CH₂)_{b} | 0 to 20 | CH | (CH₂)_{c} | 1 to 20 | Si(OMe)₃ | 2 |
| 789 | Me | Me | (CH₂)_{b} | 0 to 20 | CH | (CH₂)_{c} | 1 to 20 | Si(OMe)₃ | 2 |
| 790 | Me | Me | (CH₂)_{b} | 0 to 20 | CH | (CH₂)_{c} | 1 to 20 | Si(OMe)₃ | 2 |

TABLE 249

| No. | R²¹ | | a | R²² | R²³ | R²⁴ | | | R²⁵ | z21 |
|---|---|---|---|---|---|---|---|---|---|---|
| 791 | N(CH₂CF₃)₂ | (CH₂)ₐ | 0 to 20 | Me | Me | CF₃ | (CH₂)ₐ | 0 to 20 | Me | 5 to 100 |
| 792 | N(CF₃)₂ | (CH₂)ₐ | 0 to 20 | Me | Me | CF₃ | (CH₂)ₐ | 0 to 20 | Me | 5 to 100 |
| 793 | Me | (CH₂)ₐ | 0 to 20 | Me | Me | CHF₂ | (CH₂)ₐ | 0 to 20 | Me | 5 to 100 |
| 794 | CF₃ | (CH₂)ₐ | 0 to 20 | Me | Me | CHF₂ | (CH₂)ₐ | 0 to 20 | Me | 5 to 100 |
| 795 | (CF₃)₂CF | (CH₂)ₐ | 0 to 20 | Me | Me | CHF₂ | (CH₂)ₐ | 0 to 20 | Me | 5 to 100 |
| 796 | (CF₃)₃C | (CH₂)ₐ | 0 to 20 | Me | Me | CHF₂ | (CH₂)ₐ | 0 to 20 | Me | 5 to 100 |
| 797 | C₄F₉ | (CH₂)ₐ | 0 to 20 | Me | Me | CHF₂ | (CH₂)ₐ | 0 to 20 | Me | 5 to 100 |
| 798 | C₈F₁₇ | (CH₂)ₐ | 0 to 20 | Me | Me | CHF₂ | (CH₂)ₐ | 0 to 20 | Me | 5 to 100 |
| 799 | c-C₆F₁₁ | (CH₂)ₐ | 0 to 20 | Me | Me | CHF₂ | (CH₂)ₐ | 0 to 20 | Me | 5 to 100 |
| 800 | CHF₂ | (CH₂)ₐ | 0 to 20 | Me | Me | CHF₂ | (CH₂)ₐ | 0 to 20 | Me | 5 to 100 |
| 801 | CClF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 791 | 0 | Me | Me | (CH₂)_{b} | 0 to 20 | CH | (CH₂)_{c} | 1 to 20 | Si(OMe)₃ | 2 |
| 792 | 0 | Me | Me | (CH₂)_{b} | 0 to 20 | CH | (CH₂)_{c} | 1 to 20 | Si(OMe)₃ | 2 |
| 793 | 0 | Me | Me | (CH₂)_{b} | 0 to 20 | CH | (CH₂)_{c} | 1 to 20 | Si(OMe)₃ | 2 |
| 794 | 0 | Me | Me | (CH₂)_{b} | 0 to 20 | CH | (CH₂)_{c} | 1 to 20 | Si(OMe)₃ | 2 |
| 795 | 0 | Me | Me | (CH₂)_{b} | 0 to 20 | CH | (CH₂)_{c} | 1 to 20 | Si(OMe)₃ | 2 |
| 796 | 0 | Me | Me | (CH₂)_{b} | 0 to 20 | CH | (CH₂)_{c} | 1 to 20 | Si(OMe)₃ | 2 |
| 797 | 0 | Me | Me | (CH₂)_{b} | 0 to 20 | CH | (CH₂)_{c} | 1 to 20 | Si(OMe)₃ | 2 |
| 798 | 0 | Me | Me | (CH₂)_{b} | 0 to 20 | CH | (CH₂)_{c} | 1 to 20 | Si(OMe)₃ | 2 |
| 799 | 0 | Me | Me | (CH₂)_{b} | 0 to 20 | CH | (CH₂)_{c} | 1 to 20 | Si(OMe)₃ | 2 |
| 800 | 0 | Me | Me | (CH₂)_{b} | 0 to 20 | CH | (CH₂)_{c} | 1 to 20 | Si(OMe)₃ | 2 |
| 801 | 0 | Me | Me | (CH₂)_{b} | 0 to 20 | CH | (CH₂)_{c} | 1 to 20 | Si(OMe)₃ | 2 |

TABLE 250

| No. | R²¹ | | a | R²² | R²³ | R²⁴ | | | R²⁵ | z21 |
|---|---|---|---|---|---|---|---|---|---|---|
| 802 | CBrF₂ | (CH₂)ₐ | 0 to 20 | Me | Me | CHF₂ | (CH₂)ₐ | 0 to 20 | Me | 5 to 100 |
| 803 | ClF₂ | (CH₂)ₐ | 0 to 20 | Me | Me | CHF₂ | (CH₂)ₐ | 0 to 20 | Me | 5 to 100 |
| 804 | CF═CF₂ | (CH₂)ₐ | 0 to 20 | Me | Me | CHF₂ | (CH₂)ₐ | 0 to 20 | Me | 5 to 100 |
| 805 | CF═CFCF₃ | (CH₂)ₐ | 0 to 20 | Me | Me | CHF₂ | (CH₂)ₐ | 0 to 20 | Me | 5 to 100 |
| 806 | CF═CFCF═CF₂ | (CH₂)ₐ | 0 to 20 | Me | Me | CHF₂ | (CH₂)ₐ | 0 to 20 | Me | 5 to 100 |
| 807 | C≡CCF₃ | (CH₂)ₐ | 0 to 20 | Me | Me | CHF₂ | (CH₂)ₐ | 0 to 20 | Me | 5 to 100 |
| 806 | CF₂CH₃ | (CH₂)ₐ | 0 to 20 | Me | Me | CHF₂ | (CH₂)ₐ | 0 to 20 | Me | 5 to 100 |
| 809 | (CF₂)₂H | (CH₂)ₐ | 0 to 20 | Me | Me | CHF₂ | (CH₂)ₐ | 0 to 20 | Me | 5 to 100 |
| 810 | (CF₂)₂CH₃ | (CH₂)ₐ | 0 to 20 | Me | Me | CHF₂ | (CH₂)ₐ | 0 to 20 | Me | 5 to 100 |
| 811 | (CF₂)₄H | (CH₂)ₐ | 0 to 20 | Me | Me | CHF₂ | (CH₂)ₐ | 0 to 20 | Me | 5 to 100 |
| 812 | C₆F₅ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 802 | 0 | Me | Me | (CH₂)_{b} | 0 to 20 | CH | (CH₂)_{c} | 1 to 20 | Si(OMe)₃ | 2 |
| 803 | 0 | Me | Me | (CH₂)_{b} | 0 to 20 | CH | (CH₂)_{c} | 1 to 20 | Si(OMe)₃ | 2 |
| 804 | 0 | Me | Me | (CH₂)_{b} | 0 to 20 | CH | (CH₂)_{c} | 1 to 20 | Si(OMe)₃ | 2 |
| 805 | 0 | Me | Me | (CH₂)_{b} | 0 to 20 | CH | (CH₂)_{c} | 1 to 20 | Si(OMe)₃ | 2 |
| 806 | 0 | Me | Me | (CH₂)_{b} | 0 to 20 | CH | (CH₂)_{c} | 1 to 20 | Si(OMe)₃ | 2 |
| 807 | 0 | Me | Me | (CH₂)_{b} | 0 to 20 | CH | (CH₂)_{c} | 1 to 20 | Si(OMe)₃ | 2 |
| 806 | 0 | Me | Me | (CH₂)_{b} | 0 to 20 | CH | (CH₂)_{c} | 1 to 20 | Si(OMe)₃ | 2 |
| 809 | 0 | Me | Me | (CH₂)_{b} | 0 to 20 | CH | (CH₂)_{c} | 1 to 20 | Si(OMe)₃ | 2 |
| 810 | 0 | Me | Me | (CH₂)_{b} | 0 to 20 | CH | (CH₂)_{c} | 1 to 20 | Si(OMe)₃ | 2 |
| 811 | 0 | Me | Me | (CH₂)_{b} | 0 to 20 | CH | (CH₂)_{c} | 1 to 20 | Si(OMe)₃ | 2 |
| 812 | 0 | Me | Me | (CH₂)_{b} | 0 to 20 | CH | (CH₂)_{c} | 1 to 20 | Si(OMe)₃ | 2 |

TABLE 251

| No. | R²¹ | | a | R²² | R²³ | R²⁴ | | | R²⁵ | z21 | z22 |
|---|---|---|---|---|---|---|---|---|---|---|---|
| 813 | 4-CF₃C₆F₄ | (CH₂)ₐ | 0 to 20 | Me | Me | CHF₂ | (CH₂)ₐ | 0 to 20 | Me | 5 to 100 | 0 |
| 814 | 4-SF₅C₆F₄ | (CH₂)ₐ | 0 to 20 | Me | Me | CHF₂ | (CH₂)ₐ | 0 to 20 | Me | 5 to 100 | 0 |
| 815 | 3,5-CF₃C₆F₃ | (CH₂)ₐ | 0 to 20 | Me | Me | CHF₂ | (CH₂)ₐ | 0 to 20 | Me | 5 to 100 | 0 |
| 816 | 3,5-SF₅C₆F₃ | (CH₂)ₐ | 0 to 20 | Me | Me | CHF₂ | (CH₂)ₐ | 0 to 20 | Me | 5 to 100 | 0 |
| 817 | 4-CF₃C₆H₄ | (CH₂)ₐ | 0 to 20 | Me | Me | CHF₂ | (CH₂)ₐ | 0 to 20 | Me | 5 to 100 | 0 |
| 818 | 4-SF₅C₆H₄ | (CH₂)ₐ | 0 to 20 | Me | Me | CHF₂ | (CH₂)ₐ | 0 to 20 | Me | 5 to 100 | 0 |
| 819 | 3,5-CF₃C₆H₃ | (CH₂)ₐ | 0 to 20 | Me | Me | CHF₂ | (CH₂)ₐ | 0 to 20 | Me | 5 to 100 | 0 |
| 820 | 3,5-SF₅C₆H₃ | (CH₂)ₐ | 0 to 20 | Me | Me | CHF₂ | (CH₂)ₐ | 0 to 20 | Me | 5 to 100 | 0 |
| 821 | 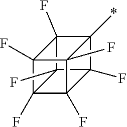 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 |
| 822 | 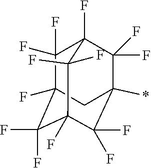 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 |
| 823 | 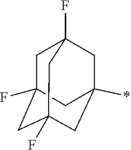 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T² | x1 |
|---|---|---|---|---|---|---|---|---|---|
| 813 | Me | Me | (CH₂)_{b} | 0 to 20 | CH | (CH₂)_{c} | 1 to 20 | Si(OMe)₂ | 2 |
| 814 | Me | Me | (CH₂)_{b} | 0 to 20 | CH | (CH₂)_{c} | 1 to 20 | Si(OMe)₂ | 2 |
| 815 | Me | Me | (CH₂)_{b} | 0 to 20 | CH | (CH₂)_{c} | 1 to 20 | Si(OMe)₂ | 2 |
| 816 | Me | Me | (CH₂)_{b} | 0 to 20 | CH | (CH₂)_{c} | 1 to 20 | Si(OMe)₂ | 2 |
| 817 | Me | Me | (CH₂)_{b} | 0 to 20 | CH | (CH₂)_{c} | 1 to 20 | Si(OMe)₂ | 2 |
| 818 | Me | Me | (CH₂)_{b} | 0 to 20 | CH | (CH₂)_{c} | 1 to 20 | Si(OMe)₂ | 2 |
| 819 | Me | Me | (CH₂)_{b} | 0 to 20 | CH | (CH₂)_{c} | 1 to 20 | Si(OMe)₂ | 2 |
| 820 | Me | Me | (CH₂)_{b} | 0 to 20 | CH | (CH₂)_{c} | 1 to 20 | Si(OMe)₂ | 2 |
| 821 | Me | Me | (CH₂)_{b} | 0 to 20 | CH | (CH₂)_{c} | 1 to 20 | Si(OMe)₂ | 2 |
| 822 | Me | Me | (CH₂)_{b} | 0 to 20 | CH | (CH₂)_{c} | 1 to 20 | Si(OMe)₂ | 2 |
| 823 | Me | Me | (CH₂)_{b} | 0 to 20 | CH | (CH₂)_{c} | 1 to 20 | Si(OMe)₂ | 2 |

TABLE 252

| No. | R²¹ | | a | R²² | R²³ | R²⁴ | | | R²⁵ | z21 | z22 |
|---|---|---|---|---|---|---|---|---|---|---|---|
| 824 | SF₅ | (CH₂)ₐ | 0 to 20 | Me | Me | CHF₂ | (CH₂)ₐ | 0 to 20 | Me | 5 to 100 | 0 |
| 825 | OCF₃ | (CH₂)ₐ | 0 to 20 | Me | Me | CHF₃ | (CH₂)ₐ | 0 to 20 | Me | 5 to 100 | 0 |
| 826 | SCF₃ | (CH₂)ₐ | 0 to 20 | Me | Me | CHF₂ | (CH₂)ₐ | 0 to 20 | Me | 5 to 100 | 0 |
| 827 | N(CH₂CF₃)₂ | (CH₂)ₐ | 0 to 20 | Me | Me | CHF₂ | (CH₂)ₐ | 0 to 20 | Me | 5 to 100 | 0 |
| 828 | N(CF₃)₂ | (CH₂)ₐ | 0 to 20 | Me | Me | CHF₂ | (CH₂)ₐ | 0 to 20 | Me | 5 to 100 | 0 |
| 829 | Me | (CH₂)ₐ | 0 to 20 | Me | Me | 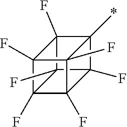 [SMILES: *C12C3(F)C4(F)C1(F)C1(F)C2(F)C3(F)C41F] | (CH₂)ₐ | 0 to 20 | Me | 5 to 100 | 0 |
| 830 | CF₃ | (CH₂)ₐ | 0 to 20 | Me | Me | 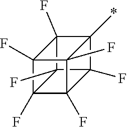 [SMILES: *C12C3(F)C4(F)C1(F)C1(F)C2(F)C3(F)C41F] | (CH₂)ₐ | 0 to 20 | Me | 5 to 100 | 0 |
| 831 | (CF₃)₂CF | (CH₂)₄ | 0 to 20 | Me | Me | 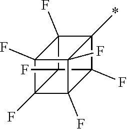 [SMILES: *C12C3(F)C4(F)C1(F)C1(F)C2(F)C3(F)C41F] | (CH₂)ₐ | 0 to 20 | Me | 5 to 100 | 0 |
| 832 | (CF₃)₃C | (CH₂)ₐ | 0 to 20 | Me | Me | 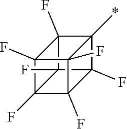 [SMILES: *C12C3(F)C4(F)C1(F)C1(F)C2(F)C3(F)C41F] | (CH₂)₄ | 0 to 20 | Me | 5 to 100 | 0 |
| 833 | C₄F₉ | (CH2)ₐ | 0 to 20 | Me | Me | 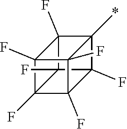 [SMILES: *C12C3(F)C4(F)C1(F)C1(F)C2(F)C3(F)C41F] | (CH₂)ₐ | 0 to 20 | Me | 5 to 100 | 0 |
| 834 | C₈F₁₇ | (CH₂)ₐ | 0 to 20 | Me | Me | 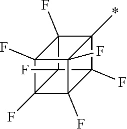 [SMILES: *C12C3(F)C4(F)C1(F)C1(F)C2(F)C3(F)C41F] | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 824 | Me | Me | (CH₂)_{b} | 0 to 20 | CH | (CH₂)_{c} | 1 to 20 | Si(OMe)₃ | 2 |
| 825 | Me | Me | (CH₂)_{b} | 0 to 20 | CH | (CH₂)_{c} | 1 to 20 | Si(OMe)₃ | 2 |
| 826 | Me | Me | (CH₂)_{b} | 0 to 20 | CH | (CH₂)_{c} | 1 to 20 | Si(OMe)₃ | 2 |
| 827 | Me | Me | (CH₂)_{b} | 0 to 20 | CH | (CH₂)_{c} | 1 to 20 | Si(OMe)₃ | 2 |
| 828 | Me | Me | (CH₂)_{b} | 0 to 20 | CH | (CH₂)_{c} | 1 to 20 | Si(OMe)₃ | 2 |
| 829 | Me | Me | (CH₂)_{b} | 0 to 20 | CH | (CH₂)_{c} | 1 to 20 | Si(OMe)₃ | 2 |
| 830 | Me | Me | (CH₂)_{b} | 0 to 20 | CH | (CH₂)_{c} | 1 to 20 | Si(OMe)₃ | 2 |
| 831 | Me | Me | (CH₂)_{b} | 0 to 20 | CH | (CH₂)_{c} | 1 to 20 | Si(OMe)₃ | 2 |
| 832 | Me | Me | (CH₂)_{b} | 0 to 20 | CH | (CH₂)_{c} | 1 to 20 | Si(OMe)₃ | 2 |
| 833 | Me | Me | (CH₂)_{b} | 0 to 20 | CH | (CH₂)_{c} | 1 to 20 | Si(OMe)₃ | 2 |
| 834 | Me | Me | (CH₂)_{b} | 0 to 20 | CH | (CH₂)_{c} | 1 to 20 | Si(OMe)₃ | 2 |

TABLE 253

| No. | R²¹ | | a | R²² | R²³ | R²⁴ | | | R²⁵ | z21 | z22 |
|---|---|---|---|---|---|---|---|---|---|---|---|
| 835 | c-C₆F₁₁ | (CH₂)ₐ | 0 to 20 | Me | Me | 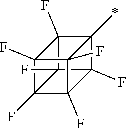 [SMILES: *C12C3(F)C4(F)C1(F)C1(F)C2(F)C3(F)C41F] | (CH₂)ₐ | 0 to 20 | Me | 5 to 100 | 0 |
| 836 | CHF₂ | (CH₂)ₐ | 0 to 20 | Me | Me | 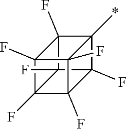 [SMILES: *C12C3(F)C4(F)C1(F)C1(F)C2(F)C3(F)C41F] | (CH₂)ₐ | 0 to 20 | Me | 5 to 100 | 0 |
| 837 | CClF₂ | (CH₂)ₐ | 0 to 20 | Me | Me | 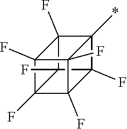 [SMILES: *C12C3(F)C4(F)C1(F)C1(F)C2(F)C3(F)C41F] | (CH₂)ₐ | 0 to 20 | Me | 5 to 100 | 0 |
| 838 | CBrF₂ | (CH₂)ₐ | 0 to 20 | Me | Me | 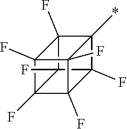 [SMILES: *C12C3(F)C4(F)C1(F)C1(F)C2(F)C3(F)C41F] | (CH₂)ₐ | 0 to 20 | Me | 5 to 100 | 0 |
| 839 | ClF₂ | (CH₂)ₐ | 0 to 20 | Me | Me | 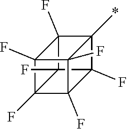 [SMILES: *C12C3(F)C4(F)C1(F)C1(F)C2(F)C3(F)C41F] | (CH₂)ₐ | 0 to 20 | Me | 5 to 100 | 0 |
| 840 | CF═CF₂ | (CH₂)ₐ | 0 to 20 | Me | Me | 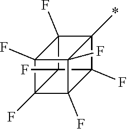 [SMILES: *C12C3(F)C4(F)C1(F)C1(F)C2(F)C3(F)C41F] | (CH₂)ₐ | 0 to 20 | Me | 5 to 100 | 0 |
| 841 | CF═CFCF₂ | (CH₂)ₐ | 0 to 20 | Me | Me | 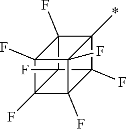 [SMILES: *C12C3(F)C4(F)C1(F)C1(F)C2(F)C3(F)C41F] | (CH₂)ₐ | 0 to 20 | Me | 5 to 100 | 0 |
| 842 | CF═CFCF═CF₂ | (CH₂)ₐ | 0 to 20 | Me | Me | 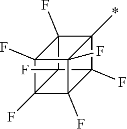 [SMILES: *C12C3(F)C4(F)C1(F)C1(F)C2(F)C3(F)C41F] | (CH₂)ₐ | 0 to 20 | Me | 5 to 100 | 0 |
| 843 | C═CCF₃ | (CH2)ₐ | 0 to 20 | Me | Me | 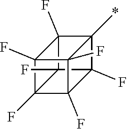 [SMILES: *C12C3(F)C4(F)C1(F)C1(F)C2(F)C3(F)C41F] | (CH₂)ₐ | 0 to 20 | Me | 5 to 100 | 0 |
| 844 | CF₂CH₃ | (CH₂)ₐ | 0 to 20 | Me | Me | 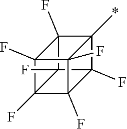 [SMILES: *C12C3(F)C4(F)C1(F)C1(F)C2(F)C3(F)C41F] | (CH₂)ₐ | 0 to 20 | Me | 5 to 100 | 0 |
| 845 | (CF₂)₂H | (CH₂)ₐ | 0 to 20 | Me | Me | 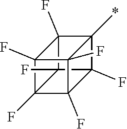 [SMILES: *C12C3(F)C4(F)C1(F)C1(F)C2(F)C3(F)C41F] | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 835 | Me | Me | (CH₂)_{b} | 0 to 20 | CH | (CH₂)_{c} | 1 to 20 | Si(OMe)₃ | 2 |
| 836 | Me | Me | (CH₂)_{b} | 0 to 20 | CH | (CH₂)_{c} | 1 to 20 | Si(OMe)₃ | 2 |
| 837 | Me | Me | (CH₂)_{b} | 0 to 20 | CH | (CH₂)_{c} | 1 to 20 | Si(OMe)₃ | 2 |
| 838 | Me | Me | (CH₂)_{b} | 0 to 20 | CH | (CH₂ )_{c} | 1 to 20 | Si(OMe)₃ | 2 |
| 839 | Me | Me | (CH₂)_{b} | 0 to 20 | CH | (CH₂)_{c} | 1 to 20 | Si(OMe)₃ | 2 |
| 840 | Me | Me | (CH₂)_{b} | 0 to 20 | CH | (CH₂)_{c} | 1 to 20 | Si(OMe)₃ | 2 |
| 841 | Me | Me | (CH₂)_{b} | 0 to 20 | CH | (CH₂)_{c} | 1 to 20 | Si(OMe)₃ | 2 |
| 842 | Me | Me | (CH₂)_{b} | 0 to 20 | CH | (CH₂)_{c} | 1 to 20 | Si(OMe)₃ | 2 |
| 843 | Me | Me | (CH₂)_{b} | 0 to 20 | CH | (CH₂)_{c} | 1 to 20 | Si(OMe)₃ | 2 |
| 844 | Me | Me | (CH₂)_{b} | 0 to 20 | CH | (CH₂)_{c} | 1 to 20 | Si(OMe)₃ | 2 |
| 845 | Me | Me | (CH₂)_{b} | 0 to 20 | CH | (CH₂)_{c} | 1 to 20 | Si(OMe)₃ | 2 |

TABLE 254

| No. | R²¹ | | a | R²² | R²³ | R²⁴ | | | R²⁵ | z21 | z22 |
|---|---|---|---|---|---|---|---|---|---|---|---|
| 846 | (CF₂)₂CH₃ | (CH₂)ₐ | 0 to 20 | Me | Me | 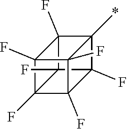 [SMILES: *C12C3(F)C4(F)C1(F)C1(F)C2(F)C3(F)C41F] | (CH₂)ₐ | 0 to 20 | Me | 5 to 100 | 0 |
| 847 | (CF₂)₄H | (CH₂)ₐ | 0 to 20 | Me | Me | 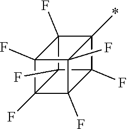 [SMILES: *C12C3(F)C4(F)C1(F)C1(F)C2(F)C3(F)C41F] | (CH₂)ₐ | 0 to 20 | Me | 5 to 100 | 0 |
| 848 | C₆F₅ | (CH₂)ₐ | 0 to 20 | Me | Me | 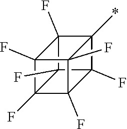 [SMILES: *C12C3(F)C4(F)C1(F)C1(F)C2(F)C3(F)C41F] | (CH₂)ₐ | 0 to 20 | Me | 5 to 100 | 0 |
| 849 | 4-CF₃C₆F₄ | (CH₂)ₐ | 0 to 20 | Me | Me | 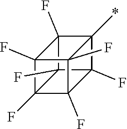 [SMILES: *C12C3(F)C4(F)C1(F)C1(F)C2(F)C3(F)C41F] | (CH₂)ₐ | 0 to 20 | Me | 5 to 100 | 0 |
| 850 | 4-SF₅C₆F₄ | (CH₂)ₐ | 0 to 20 | Me | Me | 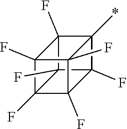 [SMILES: *C12C3(F)C4(F)C1(F)C1(F)C2(F)C3(F)C41F] | (CH₂)ₐ | 0 to 20 | Me | 5 to 100 | 0 |
| 851 | 3,5-CF₃C₆F₃ | (CH₂)ₐ | 0 to 20 | Me | Me | 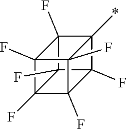 [SMILES: *C12C3(F)C4(F)C1(F)C1(F)C2(F)C3(F)C41F] | (CH₂)ₐ | 0 to 20 | Me | 5 to 100 | 0 |
| 852 | 3,5-SF₅C₆F₃ | (CH₂)ₐ | 0 to 20 | Me | Me | 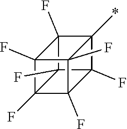 [SMILES: *C12C3(F)C4(F)C1(F)C1(F)C2(F)C3(F)C41F] | (CH₂)ₐ | 0 to 20 | Me | 5 to 100 | 0 |
| 853 | 4-CF₃C₆H₄ | (CH₂)ₐ | 0 to 20 | Me | Me | 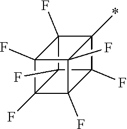 [SMILES: *C12C3(F)C4(F)C1(F)C1(F)C2(F)C3(F)C41F] | (CH₂)ₐ | 0 to 20 | Me | 5 to 100 | 0 |
| 854 | 4-CF₅C₆H₄ | (CH₂)ₐ | 0 to 20 | Me | Me | 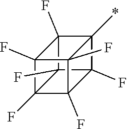 [SMILES: *C12C3(F)C4(F)C1(F)C1(F)C2(F)C3(F)C41F] | (CH₂)ₐ | 0 to 20 | Me | 5 to 100 | 0 |
| 855 | 3,5-CF₃C₆H₃ | (CH₂)ₐ | 0 to 20 | Me | Me | 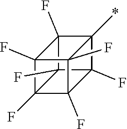 [SMILES: *C12C3(F)C4(F)C1(F)C1(F)C2(F)C3(F)C41F] | (CH₂)ₐ | 0 to 20 | Me | 5 to 100 | 0 |
| 856 | 3,5-SF₅C₆H₃ | (CH₂)₄ | 0 to 20 | Me | Me | 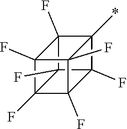 [SMILES: *C12C3(F)C4(F)C1(F)C1(F)C2(F)C3(F)C41F] | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 846 | Me | Me | (CH₂)_{b} | 0 to 20 | CH | (CH₂)_{c} | 1 to 20 | Si(OMe)₃ | 2 |
| 847 | Me | Me | (CH₂)_{b} | 0 to 20 | CH | (CH₂)_{c} | 1 to 20 | Si(OMe)₃ | 2 |
| 848 | Me | Me | (CH₂)_{b} | 0 to 20 | CH | (CH₂)_{c} | 1 to 20 | Si(OMe)₃ | 2 |
| 849 | Me | Me | (CH₂)_{b} | 0 to 20 | CH | (CH₂)_{c} | 1 to 20 | Si(OMe)₃ | 2 |
| 850 | Me | Me | (CH₂)_{b} | 0 to 20 | CH | (CH₂)_{c} | 1 to 20 | Si(OMe)₃ | 2 |
| 851 | Me | Me | (CH₂)_{b} | 0 to 20 | CH | (CH₂)_{c} | 1 to 20 | Si(OMe)₃ | 2 |
| 852 | Me | Me | (CH₂)_{b} | 0 to 20 | CH | (CH₂)_{c} | 1 to 20 | Si(OMe)₃ | 2 |
| 853 | Me | Me | (CH₂)_{b} | 0 to 20 | CH | (CH₂)_{c} | 1 to 20 | Si(OMe)₃ | 2 |
| 854 | Me | Me | (CH₂)_{b} | 0 to 20 | CH | (CH₂)_{c} | 1 to 20 | Si(OMe)₃ | 2 |
| 855 | Me | Me | (CH₂)_{b} | 0 to 20 | CH | (CH₂)_{c} | 1 to 20 | Si(OMe)₃ | 2 |
| 856 | Me | Me | (CH₂)_{b} | 0 to 20 | CH | (CH₂)_{c} | 1 to 20 | Si(OMe)₃ | 2 |

TABLE 255

| No. | R²¹ | | a | R²² | R²³ | R²⁴ | | | R²⁵ | z21 | z22 |
|---|---|---|---|---|---|---|---|---|---|---|---|
| 857 | 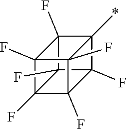 [SMILES: *C12C3(F)C4(F)C1(F)C1(F)C2(F)C3(F)C41F] | (CH₂)ₐ | 0 to 20 | Me | Me | 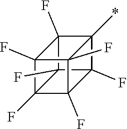 [SMILES: *C12C3(F)C4(F)C1(F)C1(F)C2(F)C3(F)C41F] | (CH₂)ₐ | 0 to 20 | Me | 5 to 100 | 0 |
| 858 | 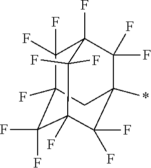 [SMILES: *C12CC3(F)C(F)(F)C(F)(C1(F)F)C(F)(F)C(F)(C2(F)F)C3(F)F] | (CH₂)ₐ | 0 to 20 | Me | Me | 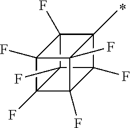 | (CH₂)ₐ | 0 to 20 | Me | 5 to 100 | 0 |
| 859 | 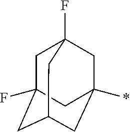 [SMILES: *C12CC3CC(F)(C1)CC(F)(C3)C2] | (CH₂)ₐ | 0 to 20 | Me | Me | 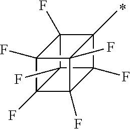 | (CH₂)ₐ | 0 to 20 | Me | 5 to 100 | 0 |
| 860 | SF₅ | (CH₂)ₐ | 0 to 20 | Me | Me | 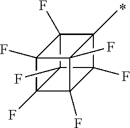 | (CH₂)ₐ | 0 to 20 | Me | 5 to 100 | 0 |
| 861 | OCF₃ | (CH₂)ₐ | 0 to 20 | Me | Me | 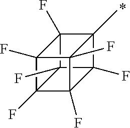 | (CH₂)ₐ | 0 to 20 | Me | 5 to 100 | 0 |
| 862 | SCF₃ | (CH₂)ₐ | 0 to 20 | Me | Me | 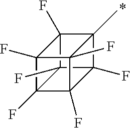 | (CH₂)ₐ | 0 to 20 | Me | 5 to 100 | 0 |
| 863 | N(CH₂CF₃)₂ | (CH₂)ₐ | 0 to 20 | Me | Me | 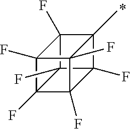 | (CH₂)ₐ | 0 to 20 | Me | 5 to 100 | 0 |
| 864 | N(CF₃)₂ | (CH₂)ₐ | 0 to 20 | Me | Me | 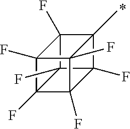 | (CH₂)ₐ | 0 to 20 | Me | 5 to 100 | 0 |
| 865 | Me | (CH₂)ₐ | 0 to 20 | Me | Me | SF₅ | (CH₂)ₐ | 0 to 20 | Me | 5 to | 0 |
| | | | | | | | | | | 100 | |
| 866 | CF₃ | (CH₂)ₐ | 0 to 20 | Me | Me | SF₅ | (CH₂)ₐ | 0 to 20 | Me | 5 to | 0 |
| | | | | | | | | | | 100 | |
| 867 | (CF₃)₂CF | (CH₂)ₐ | 0 to 20 | Me | Me | SF₅ | (CH₂)ₐ | 0 to 20 | Me | 5 to | 0 |
| | | | | | | | | | | 100 | |

| No. | R²⁸ | R²⁹ | R¹ | b | L¹ | R² | c | T¹ | x1 |
|---|---|---|---|---|---|---|---|---|---|
| 857 | Me | Me | (CH₂)_{b} | 0 to 20 | CH | (CH₂)_{c} | 1 to 20 | Si(OMe)₃ | 2 |
| 858 | Me | Me | (CH₂)_{b} | 0 to 20 | CH | (CH₂)_{c} | 1 to 20 | Si(OMe)₃ | 2 |
| 859 | Me | Me | (CH₂)_{b} | 0 to 20 | CH | (CH₂)_{c} | 1 to 20 | Si(OMe)₃ | 2 |
| 860 | Me | Me | (CH₂)_{b} | 0 to 20 | CH | (CH₂)_{c} | 1 to 20 | Si(OMe)₃ | 2 |
| 861 | Me | Me | (CH₂)_{b} | 0 to 20 | CH | (CH₂)_{c} | 1 to 20 | Si(OMe)₃ | 2 |
| 862 | Me | Me | (CH₂)_{b} | 0 to 20 | CH | (CH₂)_{c} | 1 to 20 | Si(OMe)₃ | 2 |
| 863 | Me | Me | (CH₂)_{b} | 0 to 20 | CH | (CH₂)_{c} | 1 to 20 | Si(OMe)₃ | 2 |
| 864 | Me | Me | (CH₂)_{b} | 0 to 20 | CH | (CH₂)_{c} | 1 to 20 | Si(OMe)₃ | 2 |
| 865 | Me | Me | (CH₂)_{b} | 0 to 20 | CH | (CH₂)_{c} | 1 to 20 | Si(OMe)₃ | 2 |
| 866 | Me | Me | (CH₂)_{b} | 0 to 20 | CH | (CH₂)_{c} | 1 to 20 | Si(OMe)₃ | 2 |
| 867 | Me | Me | (CH₂)_{b} | 0 to 20 | CH | (CH₂)_{c} | 1 to 20 | Si(OMe)₃ | 2 |

TABLE 256

| No. | R²¹ | | a | R²² | R²³ | R²⁴ | | | R²⁵ | z21 |
|---|---|---|---|---|---|---|---|---|---|---|
| 868 | (CF₃)₃C | (CH₂)ₐ | 0 to 20 | Me | Me | SF₅ | (CH₂)ₐ | 0 to 20 | Me | 5 to 100 |
| 869 | C₄F₉ | (CH₂)ₐ | 0 to 20 | Me | Me | SF₅ | (CH₂)ₐ | 0 to 20 | Me | 5 to 100 |
| 870 | C₈F₁₇ | (CH₂)ₐ | 0 to 20 | Me | Me | SF₅ | (CH₂)ₐ | 0 to 20 | Me | 5 to 100 |
| 871 | c-C₆F₁₁ | (CH₂)ₐ | 0 to 20 | Me | Me | SF₅ | (CH₂)ₐ | 0 to 20 | Me | 5 to 100 |
| 872 | CHF₂ | (CH₂)ₐ | 0 to 20 | Me | Me | SF₅ | (CH₂)ₐ | 0 to 20 | Me | 5 to 100 |
| 873 | CClF₂ | (CH₂)ₐ | 0 to 20 | Me | Me | SF₅ | (CH₂)ₐ | 0 to 20 | Me | 5 to 100 |
| 874 | CBrF₂ | (CH₂)ₐ | 0 to 20 | Me | Me | SF₅ | (CH₂)ₐ | 0 to 20 | Me | 5 to 100 |
| 875 | ClF₂ | (CH₂)ₐ | 0 to 20 | Me | Me | SF₅ | (CH₂)ₐ | 0 to 20 | Me | 5 to 100 |
| 876 | CF═CF₂ | (CH₂)ₐ | 0 to 20 | Me | Me | SF₅ | (CH₂)ₐ | 0 to 20 | Me | 5 to 100 |
| 877 | CF═CFCF₃ | (CH₂)ₐ | 0 to 20 | Me | Me | SF₅ | (CH₂)ₐ | 0 to 20 | Me | 5 to 100 |
| 878 | CF═CFCF═CF₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 868 | 0 | Me | Me | (CH₂)_{b} | 0 to 20 | CH | (CH₂)_{c} | 1 to 20 | Si(OMe)₃ | 2 |
| 869 | 0 | Me | Me | (CH₂)_{b} | 0 to 20 | CH | (CH₂)_{c} | 1 to 20 | Si(OMe)₃ | 2 |
| 870 | 0 | Me | Me | (CH₂)_{b} | 0 to 20 | CH | (CH₂)_{c} | 1 to 20 | Si(OMe)₃ | 2 |
| 871 | 0 | Me | Me | (CH₂)_{b} | 0 to 20 | CH | (CH₂)_{c} | 1 to 20 | Si(OMe)₃ | 2 |
| 872 | 0 | Me | Me | (CH₂)_{b} | 0 to 20 | CH | (CH₂)_{c} | 1 to 20 | Si(OMe)₃ | 2 |
| 873 | 0 | Me | Me | (CH₂)_{b} | 0 to 20 | CH | (CH₂)_{c} | 1 to 20 | Si(OMe)₃ | 2 |
| 874 | 0 | Me | Me | (CH₂)_{b} | 0 to 20 | CH | (CH₂)_{c} | 1 to 20 | Si(OMe)₃ | 2 |
| 875 | 0 | Me | Me | (CH₂)_{b} | 0 to 20 | CH | (CH₂)_{c} | 1 to 20 | Si(OMe)₃ | 2 |
| 876 | 0 | Me | Me | (CH₂)_{b} | 0 to 20 | CH | (CH₂)_{c} | 1 to 20 | Si(OMe)₃ | 2 |
| 877 | 0 | Me | Me | (CH₂)_{b} | 0 to 20 | CH | (CH₂)_{c} | 1 to 20 | Si(OMe)₃ | 2 |
| 878 | 0 | Me | Me | (CH₂)_{b} | 0 to 20 | CH | (CH₂)_{c} | 1 to 20 | Si(OMe)₃ | 2 |

TABLE 257

| No. | R²¹ | | a | R²² | R²³ | R²⁴ | | | R²⁵ | z21 |
|---|---|---|---|---|---|---|---|---|---|---|
| 879 | C≡CCF₃ | (CH₂)ₐ | 0 to 20 | Me | Me | SF₅ | (CH₂)ₐ | 0 to 20 | Me | 5 to 100 |
| 880 | CF₂CH₃ | (CH₂)ₐ | 0 to 20 | Me | Me | SF₅ | (CH₂)ₐ | 0 to 20 | Me | 5 to 100 |
| 881 | (CF₂)₂H | (CH₂)ₐ | 0 to 20 | Me | Me | SF₅ | (CH₂)ₐ | 0 to 20 | Me | 5 to 100 |
| 882 | (CF₂)₂CH₃ | (CH₂)ₐ | 0 to 20 | Me | Me | SF₅ | (CH₂)ₐ | 0 to 20 | Me | 5 to 100 |
| 883 | (CF₂)₄H | (CH₂)ₐ | 0 to 20 | Me | Me | SF₅ | (CH₂)ₐ | 0 to 20 | Me | 5 to 100 |
| 884 | C₆F₅ | (CH₂)ₐ | 0 to 20 | Me | Me | SF₅ | (CH₂)ₐ | 0 to 20 | Me | 5 to 100 |
| 885 | 4-CF₃C₆F₄ | (CH₂)ₐ | 0 to 20 | Me | Me | SF₅ | (CH₂)ₐ | 0 to 20 | Me | 5 to 100 |
| 886 | 4-SF₅C₆F₄ | (CH₂)ₐ | 0 to 20 | Me | Me | SF₅ | (CH₂)ₐ | 0 to 20 | Me | 5 to 100 |
| 887 | 3,5-CF₃C₆F₃ | (CH₂)ₐ | 0 to 20 | Me | Me | SF₅ | (CH₂)ₐ | 0 to 20 | Me | 5 to 100 |
| 888 | 3,5-SF₅C₆F₃ | (CH₂)ₐ | 0 to 20 | Me | Me | SF₅ | (CH₂)ₐ | 0 to 20 | Me | 5 to 100 |
| 889 | 4-CF₃C₆H₄ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 879 | 0 | Me | Me | (CH₂)_{b} | 0 to 20 | CH | (CH₂)_{c} | 1 to 20 | Si(OMe)₃ | 2 |
| 880 | 0 | Me | Me | (CH₂)_{b} | 0 to 20 | CH | (CH₂)_{c} | 1 to 20 | Si(OMe)₃ | 2 |
| 881 | 0 | Me | Me | (CH₂)_{b} | 0 to 20 | CH | (CH₂)_{c} | 1 to 20 | Si(OMe)₃ | 2 |
| 882 | 0 | Me | Me | (CH₂)_{b} | 0 to 20 | CH | (CH₂)_{c} | 1 to 20 | Si(OMe)₃ | 2 |
| 883 | 0 | Me | Me | (CH₂)_{b} | 0 to 20 | CH | (CH₂)_{c} | 1 to 20 | Si(OMe)₃ | 2 |
| 884 | 0 | Me | Me | (CH₂)_{b} | 0 to 20 | CH | (CH₂)_{c} | 1 to 20 | Si(OMe)₃ | 2 |
| 885 | 0 | Me | Me | (CH₂)_{b} | 0 to 20 | CH | (CH₂)_{c} | 1 to 20 | Si(OMe)₃ | 2 |
| 886 | 0 | Me | Me | (CH₂)_{b} | 0 to 20 | CH | (CH₂)_{c} | 1 to 20 | Si(OMe)₃ | 2 |
| 887 | 0 | Me | Me | (CH₂)_{b} | 0 to 20 | CH | (CH₂)_{c} | 1 to 20 | Si(OMe)₃ | 2 |
| 888 | 0 | Me | Me | (CH₂)_{b} | 0 to 20 | CH | (CH₂)_{c} | 1 to 20 | Si(OMe)₃ | 2 |
| 889 | 0 | Me | Me | (CH₂)_{b} | 0 to 20 | CH | (CH₂)_{c} | 1 to 20 | Si(OMe)₃ | 2 |

TABLE 258

| No. | R²¹ | | a | R²² | R²³ | R²⁴ | | | R²⁵ | z21 | z22 |
|---|---|---|---|---|---|---|---|---|---|---|---|
| 890 | 4-SF₅C₆H₄ | (CH₂)ₐ | 0 to 20 | Me | Me | SF₅ | (CH₂)ₐ | 0 to 20 | Me | 5 to 100 | 0 |
| 891 | 3,5-CF₃C₆H₃ | (CH₂)ₐ | 0 to 20 | Me | Me | SF₅ | (CH₂)ₐ | 0 to 20 | Me | 5 to 100 | 0 |
| 892 | 3,5-SF₅C₆H₃ | (CH₂)ₐ | 0 to 20 | Me | Me | SF₅ | (CH₂)ₐ | 0 to 20 | Me | 5 to 100 | 0 |
| 893 | 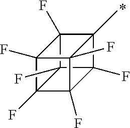 | (CH₂)ₐ | 0 to 20 | Me | Me | SF₅ | (CH₂)ₐ | 0 to 20 | Me | 5 to 100 | 0 |
| 894 | 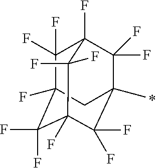 | (CH₂)ₐ | 0 to 20 | Me | Me | SF₅ | (CH₂)ₐ | 0 to 20 | Me | 5 to 100 | 0 |
| 895 | 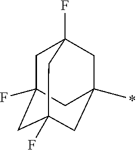 | (CH2)ₐ | 0 to 20 | Me | Me | SF₅ | (CH₂)ₐ | 0 to 20 | Me | 5 to 100 | 0 |
| 896 | SF₅ | (CH₂)ₐ | 0 to 20 | Me | Me | SF₅ | (CH₂)ₐ | 0 to 28 | Me | 5 to 100 | 0 |
| 897 | OCF₃ | (CH₂)ₐ | 0 to 20 | Me | Me | SF₅ | (CH₂)ₐ | 0 to 20 | Me | 5 to 100 | 0 |
| 898 | SCF₃ | (CH₂)ₐ | 0 to 20 | Me | Me | SF₅ | (CH₂)ₐ | 0 to 20 | Me | 5 to 100 | 0 |
| 899 | N(CH₂CF₃)₂ | (CH₂)ₐ | 0 to 20 | Me | Me | SF₅ | (CH₂)ₐ | 0 to 20 | Me | 5 to 100 | 0 |
| 900 | N(CF₃)₂ | (CH₂)ₐ | 0 to 20 | Me | Me | SF₅ | (CH₂)₄ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 890 | Me | Me | (CH₂)_{b} | 0 to 20 | CH | (CH₂)_{c} | 1 to 20 | Si(OMe)₃ | 2 |
| 891 | Me | Me | (CH₂)_{b} | 0 to 20 | CH | (CH₂)_{c} | 1 to 20 | Si(OMe)₃ | 2 |
| 892 | Me | Me | (CH₂)_{b} | 0 to 20 | CH | (CH₂)_{c} | 1 to 20 | Si(OMe)₃ | 2 |
| 893 | Me | Me | (CH₂)_{b} | 0 to 20 | CH | (CH₂)_{c} | 1 to 20 | Si(OMe)₃ | 2 |
| 894 | Me | Me | (CH₂)_{b} | 0 to 20 | CH | (CH₂)_{c} | 1 to 20 | Si(OMe)₃ | 2 |
| 895 | Me | Me | (CH₂)_{b} | 0 to 20 | CH | (CH₂)_{c} | 1 to 20 | Si(OMe)₃ | 2 |
| 896 | Me | Me | (CH₂)_{b} | 0 to 20 | CH | (CH₂)_{c} | 1 to 20 | Si(OMe)₃ | 2 |
| 897 | Me | Me | (CH₂)_{b} | 0 to 20 | CH | (CH₂)_{c} | 1 to 20 | Si(OMe)₃ | 2 |
| 898 | Me | Me | (CH₂)_{b} | 0 to 20 | CH | (CH₂)_{c} | 1 to 20 | Si(OMe)₃ | 2 |
| 899 | Me | Me | (CH₂)_{b} | 0 to 20 | CH | (CH₂)_{c} | 1 to 20 | Si(OMe)₃ | 2 |
| 900 | Me | Me | (CH₂)_{b} | 0 to 20 | CH | (CH₂)_{c} | 1 to 20 | Si(OMe)₃ | 2 |

TABLE 259

| No. | R²¹ | | a | R²² | R²³ | R²⁴ | | | R²⁵ | z21 |
|---|---|---|---|---|---|---|---|---|---|---|
| 901 | Me | (CH₂)ₐ | 0 to 20 | Me | Me | OCF₃ | (CH₂)ₐ | 0 to 20 | Me | 5 to 100 |
| 902 | CF₃ | (CH₂)ₐ | 0 to 20 | Me | Me | OCF₃ | (CH₂)ₐ | 0 to 20 | Me | 5 to 100 |
| 903 | (CF₃)₂CF | (CH₂)ₐ | 0 to 20 | Me | Me | OCF₃ | (CH₂)ₐ | 0 to 20 | Me | 5 to 100 |
| 904 | (CF₃)₃C | (CH₂)ₐ | 0 to 20 | Me | Me | OCF₃ | (CH₂)ₐ | 0 to 20 | Me | 5 to 100 |
| 905 | C₄F₉ | (CH₂)ₐ | 0 to 20 | Me | Me | OCF₃ | (CH₂)ₐ | 0 to 20 | Me | 5 to 100 |
| 906 | C₈F₁₇ | (CH₂)ₐ | 0 to 20 | Me | Me | OCF₃ | (CH₂)ₐ | 0 to 20 | Me | 5 to 100 |
| 907 | c-C₆F₁₁ | (CH₂)ₐ | 0 to 20 | Me | Me | OCF₃ | (CH₂)ₐ | 0 to 20 | Me | 5 to 100 |
| 908 | CHF₂ | (CH₂)ₐ | 0 to 20 | Me | Me | OCF₃ | (CH₂)ₐ | 0 to 20 | Me | 5 to 100 |
| 909 | CClF₂ | (CH₂)ₐ | 0 to 20 | Me | Me | OCF₃ | (CH₂)ₐ | 0 to 20 | Me | 5 to 100 |
| 910 | CBrF₂ | (CH₂)ₐ | 0 to 20 | Me | Me | OCF₃ | (CH₂)ₐ | 0 to 20 | Me | 5 to 100 |
| 911 | ClF₂ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 901 | 0 | Me | Me | (CH₂)_{b} | 0 to 20 | CH | (CH₂)_{c} | 1 to 20 | Si(OMe)₃ | 2 |
| 902 | 0 | Me | Me | (CH₂)_{b} | 0 to 20 | CH | (CH₂)_{c} | 1 to 20 | Si(OMe)₃ | 2 |
| 903 | 0 | Me | Me | (CH₂)_{b} | 0 to 20 | CH | (CH₂)_{c} | 1 to 20 | Si(OMe)₃ | 2 |
| 904 | 0 | Me | Me | (CH₂)_{b} | 0 to 20 | CH | (CH₂)_{c} | 1 to 20 | Si(OMe)₃ | 2 |
| 905 | 0 | Me | Me | (CH₂)_{b} | 0 to 20 | CH | (CH₂)_{c} | 1 to 20 | Si(OMe)₃ | 2 |
| 906 | 0 | Me | Me | (CH₂)_{b} | 0 to 20 | CH | (CH₂)_{c} | 1 to 20 | Si(OMe)₃ | 2 |
| 907 | 0 | Me | Me | (CH₂)_{b} | 0 to 20 | CH | (CH₂)_{c} | 1 to 20 | Si(OMe)₃ | 2 |
| 908 | 0 | Me | Me | (CH₂)_{b} | 0 to 20 | CH | (CH₂)_{c} | 1 to 20 | Si(OMe)₃ | 2 |
| 909 | 0 | Me | Me | (CH₂)_{b} | 0 to 20 | CH | (CH₂)_{c} | 1 to 20 | Si(OMe)₃ | 2 |
| 910 | 0 | Me | Me | (CH₂)_{b} | 0 to 20 | CH | (CH₂)_{c} | 1 to 20 | Si(OMe)₃ | 2 |
| 911 | 0 | Me | Me | (CH₂)_{b} | 0 to 20 | CH | (CH₂)_{c} | 1 to 20 | Si(OMe)₃ | 2 |

TABLE 260

| No. | R²¹ | | a | R²² | R²³ | R²⁴ | | | R²⁵ | z21 |
|---|---|---|---|---|---|---|---|---|---|---|
| 912 | CF═CF₂ | (CH₂)ₐ | 0 to 20 | Me | Me | OCF₃ | (CH₂)ₐ | 0 to 20 | Me | 5 to 100 |
| 913 | CF═CFCF₃ | (CH₂)ₐ | 0 to 20 | Me | Me | OCF₃ | (CH₂)ₐ | 0 to 20 | Me | 5 to 100 |
| 914 | CF═CFCF═CF₂ | (CH₂)ₐ | 0 to 20 | Me | Me | OCF₃ | (CH₂)ₐ | 0 to 20 | Me | 5 to 100 |
| 915 | C≡CCF₃ | (CH₂)ₐ | 0 to 20 | Me | Me | OCF₃ | (CH₂)ₐ | 0 to 20 | Me | 5 to 100 |
| 916 | CF₂CH₃ | (CH₂)ₐ | 0 to 20 | Me | Me | OCF₃ | (CH₂)ₐ | 0 to 20 | Me | 5 to 100 |
| 917 | (CF₂)₂H | (CH₂)ₐ | 0 to 20 | Me | Me | OCF₃ | (CH₂)ₐ | 0 to 20 | Me | 5 to 100 |
| 918 | (CF₂)₂CH₃ | (CH₂)ₐ | 0 to 20 | Me | Me | OCF₃ | (CH₂)ₐ | 0 to 20 | Me | 5 to 100 |
| 919 | (CF₂)₄H | (CH₂)ₐ | 0 to 20 | Me | Me | OCF₃ | (CH₂)ₐ | 0 to 20 | Me | 5 to 100 |
| 920 | C₆F₅ | (CH₂)ₐ | 0 to 20 | Me | Me | OCF₃ | (CH₂)ₐ | 0 to 20 | Me | 5 to 100 |
| 921 | 4-CF₃C₆F₄ | (CH₂)ₐ | 0 to 20 | Me | Me | OCF₃ | (CH₂)ₐ | 0 to 20 | Me | 5 to 100 |
| 922 | 4-SF₅C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 912 | 0 | Me | Me | (CH₂)_{b} | 0 to 20 | CH | (CH₂)_{c} | 1 to 20 | Si(OMe)₃ | 2 |
| 913 | 0 | Me | Me | (CH₂)_{b} | 0 to 20 | CH | (CH₂)_{c} | 1 to 20 | Si(OMe)₃ | 2 |
| 914 | 0 | Me | Me | (CH₂)_{b} | 0 to 20 | CH | (CH₂)_{c} | 1 to 20 | Si(OMe)₃ | 2 |
| 915 | 0 | Me | Me | (CH₂)_{b} | 0 to 20 | CH | (CH₂)_{c} | 1 to 20 | Si(OMe)₃ | 2 |
| 916 | 0 | Me | Me | (CH₂)_{b} | 0 to 20 | CH | (CH₂)_{c} | 1 to 20 | Si(OMe)₃ | 2 |
| 917 | 0 | Me | Me | (CH₂)_{b} | 0 to 20 | CH | (CH₂)_{c} | 1 to 20 | Si(OMe)₃ | 2 |
| 918 | 0 | Me | Me | (CH₂)_{b} | 0 to 20 | CH | (CH₂)_{c} | 1 to 20 | Si(OMe)₃ | 2 |
| 919 | 0 | Me | Me | (CH₂)_{b} | 0 to 20 | CH | (CH₂)_{c} | 1 to 20 | Si(OMe)₃ | 2 |
| 920 | 0 | Me | Me | (CH₂)_{b} | 0 to 20 | CH | (CH₂)_{c} | 1 to 20 | Si(OMe)₃ | 2 |
| 921 | 0 | Me | Me | (CH₂)_{b} | 0 to 20 | CH | (CH₂)_{c} | 1 to 20 | Si(OMe)₃ | 2 |
| 922 | 0 | Me | Me | (CH₂)_{b} | 0 to 20 | CH | (CH₂)_{c} | 1 to 20 | Si(OMe)₃ | 2 |

TABLE 261

| No. | R²¹ | | a | R²² | R²³ | R²⁴ | | | R²⁵ | z21 | z22 |
|---|---|---|---|---|---|---|---|---|---|---|---|
| 923 | 3,5-CF₃C₆F₃ | (CH₂)ₐ | 0 to 20 | Me | Me | OCF₃ | (CH₂)ₐ | 0 to 20 | Me | 5 to 100 | 0 |
| 924 | 3,5-SF₅C₆F₃ | (CH₂)ₐ | 0 to 20 | Me | Me | OCF₃ | (CH₂)ₐ | 0 to 20 | Me | 5 to 100 | 0 |
| 925 | 4-CF₃C₆H₄ | (CH₂)ₐ | 0 to 20 | Me | Me | OCF₃ | (CH₂)ₐ | 0 to 20 | Me | 5 to 100 | 0 |
| 926 | 4-CF₅C₆H₄ | (CH₂)ₐ | 0 to 20 | Me | Me | OCF₃ | (CH₂)ₐ | 0 to 20 | Me | 5 to 100 | 0 |
| 927 | 3,5-CF₃C₆H₃ | (CH₂)ₐ | 0 to 20 | Me | Me | OCF₃ | (CH₂)ₐ | 0 to 20 | Me | 5 to 100 | 0 |
| 928 | 3,5-SF₅C₆H₃ | (CH₂)ₐ | 0 to 20 | Me | Me | OCF₃ | (CH₂)ₐ | 0 to 20 | Me | 5 to 100 | 0 |
| 929 | 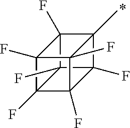 | (CH₂)ₐ | 0 to 20 | Me | Me | OCF₃ | (CH₂)ₐ | 0 to 20 | Me | 5 to 100 | 0 |
| 930 | 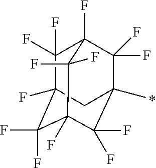 | (CH₂)ₐ | 0 to 20 | Me | Me | OCF₃ | (CH₂)ₐ | 0 to 20 | Me | 5 to 100 | 0 |
| 931 | 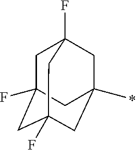 | (CH₂)ₐ | 0 to 20 | Me | Me | OCF₃ | (CH₂)ₐ | 0 to 20 | Me | 5 to 100 | 0 |
| 932 | CF₅ | (CH2)ₐ | 0 to 20 | Me | Me | OCF₃ | (CH₂)ₐ | 0 to 20 | Me | 5 to 100 | 0 |
| 933 | OCF₃ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 923 | Me | Me | (CH₂)_{b} | 0 to 20 | CH | (CH₂)_{c} | 1 to 20 | Si(OMe)₃ | 2 |
| 924 | Me | Me | (CH₂)_{b} | 0 to 20 | CH | (CH₂)_{c} | 1 to 20 | Si(OMe)₃ | 2 |
| 925 | Me | Me | (CH₂)_{b} | 0 to 20 | CH | (CH₂)_{c} | 1 to 20 | Si(OMe)₃ | 2 |
| 926 | Me | Me | (CH₂)_{b} | 0 to 20 | CH | (CH₂)_{c} | 1 to 20 | Si(OMe)₃ | 2 |
| 927 | Me | Me | (CH₂)_{b} | 0 to 20 | CH | (CH₂)_{c} | 1 to 20 | Si(OMe)₃ | 2 |
| 928 | Me | Me | (CH₂)_{b} | 0 to 20 | CH | (CH₂)_{c} | 1 to 20 | Si(OMe)₃ | 2 |
| 929 | Me | Me | (CH₂)_{b} | 0 to 20 | CH | (CH₂)_{c} | 1 to 20 | Si(OMe)₃ | 2 |
| 930 | Me | Me | (CH₂)_{b} | 0 to 20 | CH | (CH₂)_{c} | 1 to 20 | Si(OMe)₃ | 2 |
| 931 | Me | Me | (CH₂)_{b} | 0 to 20 | CH | (CH₂)_{c} | 1 to 20 | Si(OMe)₃ | 2 |
| 932 | Me | Me | (CH₂)_{b} | 0 to 20 | CH | (CH₂)_{c} | 1 to 20 | Si(OMe)₃ | 2 |
| 933 | Me | Me | (CH₂)_{b} | 0 to 20 | CH | (CH₂)_{c} | 1 to 20 | Si(OMe)₃ | 2 |

TABLE 262

| No. | R²¹ | | a | R²² | R²³ | R²⁴ | | | R²⁵ | z21 |
|---|---|---|---|---|---|---|---|---|---|---|
| 934 | SCF₃ | (CH₂)ₐ | 0 to 20 | Me | Me | OCF₃ | (CH₂)ₐ | 0 to 20 | Me | 5 to 100 |
| 935 | N(CH₂CF₃)₂ | (CH₂)ₐ | 0 to 20 | Me | Me | OCF₃ | (CH₂)ₐ | 0 to 20 | Me | 5 to 100 |
| 936 | N(CF₃)₂ | (CH₂)ₐ | 0 to 20 | Me | Me | OCF₃ | (CH₂)ₐ | 0 to 20 | Me | 5 to 100 |
| 937 | Me | (CH₂)ₐ | 0 to 20 | Me | Me | SCF₃ | (CH₂)ₐ | 0 to 20 | Me | 5 to 100 |
| 938 | CF₃ | (CH₂)ₐ | 0 to 20 | Me | Me | SCF₃ | (CH₂)ₐ | 0 to 20 | Me | 5 to 100 |
| 939 | (CF₃)₂CF | (CH₂)ₐ | 0 to 20 | Me | Me | SCF₃ | (CH₂)ₐ | 0 to 20 | Me | 5 to 100 |
| 940 | (CF₃)₃C | (CH₂)ₐ | 0 to 20 | Me | Me | SCF₃ | (CH₂)ₐ | 0 to 20 | Me | 5 to 100 |
| 941 | C₄F₉ | (CH₂)ₐ | 0 to 20 | Me | Me | SCF₃ | (CH₂)ₐ | 0 to 20 | Me | 5 to 100 |
| 942 | C₈F₁₇ | (CH₂)ₐ | 0 to 20 | Me | Me | SCF₃ | (CH₂)ₐ | 0 to 20 | Me | 5 to 100 |
| 943 | c-C₆F₁₁ | (CH₂)ₐ | 0 to 20 | Me | Me | SCF₃ | (CH₂)ₐ | 0 to 20 | Me | 5 to 100 |
| 944 | CHF₂ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 934 | 0 | Me | Me | (CH₂)_{b} | 0 to 20 | CH | (CH₂)_{c} | 1 to 20 | Si(OMe)₃ | 2 |
| 935 | 0 | Me | Me | (CH₂)_{b} | 0 to 20 | CH | (CH₂)_{c} | 1 to 20 | Si(OMe)₃ | 2 |
| 936 | 0 | Me | Me | (CH₂)_{b} | 0 to 20 | CH | (CH₂)_{c} | 1 to 20 | Si(OMe)₃ | 2 |
| 937 | 0 | Me | Me | (CH₂)_{b} | 0 to 20 | CH | (CH₂)_{c} | 1 to 20 | Si(OMe)₃ | 2 |
| 938 | 0 | Me | Me | (CH₂)_{b} | 0 to 20 | CH | (CH₂)_{c} | 1 to 20 | Si(OMe)₃ | 2 |
| 939 | 0 | Me | Me | (CH₂)_{b} | 0 to 20 | CH | (CH₂)_{c} | 1 to 20 | Si(OMe)₃ | 2 |
| 940 | 0 | Me | Me | (CH₂)_{b} | 0 to 20 | CH | (CH₂)_{c} | 1 to 20 | Si(OMe)₃ | 2 |
| 941 | 0 | Me | Me | (CH₂)_{b} | 0 to 20 | CH | (CH₂)_{c} | 1 to 20 | Si(OMe)₃ | 2 |
| 942 | 0 | Me | Me | (CH₂)_{b} | 0 to 20 | CH | (CH₂)_{c} | 1 to 20 | Si(OMe)₃ | 2 |
| 943 | 0 | Me | Me | (CH₂)_{b} | 0 to 20 | CH | (CH₂)_{c} | 1 to 20 | Si(OMe)₃ | 2 |
| 944 | 0 | Me | Me | (CH₂)_{b} | 0 to 20 | CH | (CH₂)_{c} | 1 to 20 | Si(OMe)₃ | 2 |

TABLE 263

| No. | R²¹ | | a | R²² | R²³ | R²⁴ | | | R²⁵ | z21 |
|---|---|---|---|---|---|---|---|---|---|---|
| 945 | CClF₂ | (CH₂)ₐ | 0 to 20 | Me | Me | SCF₃ | (CH₂)ₐ | 0 to 20 | Me | 5 to 100 |
| 946 | CBrF₂ | (CH₂)ₐ | 0 to 20 | Me | Me | SCF₃ | (CH₂)ₐ | 0 to 20 | Me | 5 to 100 |
| 947 | ClF₂ | (CH₂)ₐ | 0 to 20 | Me | Me | SCF₃ | (CH₂)ₐ | 0 to 20 | Me | 5 to 100 |
| 948 | CF═CF₂ | (CH₂)ₐ | 0 to 20 | Me | Me | SCF₃ | (CH₂)ₐ | 0 to 20 | Me | 5 to 100 |
| 949 | CF═CFCF₃ | (CH₂)ₐ | 0 to 20 | Me | Me | SCF₃ | (CH₂)ₐ | 0 to 20 | Me | 5 to 100 |
| 950 | CF═CFCF═CF₂ | (CH₂)ₐ | 0 to 20 | Me | Me | SCF₃ | (CH₂)ₐ | 0 to 20 | Me | 5 to 100 |
| 951 | C≡CCF₃ | (CH₂)ₐ | 0 to 20 | Me | Me | SCF₃ | (CH₂)ₐ | 0 to 20 | Me | 5 to 100 |
| 952 | CF₂CH₃ | (CH₂)ₐ | 0 to 20 | Me | Me | SCF₃ | (CH₂)ₐ | 0 to 20 | Me | 5 to 100 |
| 953 | (CF₂)₂H | (CH₂)ₐ | 0 to 20 | Me | Me | SCF₃ | (CH₂)ₐ | 0 to 20 | Me | 5 to 100 |
| 954 | (CF₂)₂CH₃ | (CH₂)ₐ | 0 to 20 | Me | Me | SCF₃ | (CH₂)ₐ | 0 to 20 | Me | 5 to 100 |
| 955 | (CF₂)₄H | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 945 | 0 | Me | Me | (CH₂)_{b} | 0 to 20 | CH | (CH₂)_{c} | 1 to 20 | Si(OMe)₃ | 2 |
| 946 | 0 | Me | Me | (CH₂)_{b} | 0 to 20 | CH | (CH₂)_{c} | 1 to 20 | Si(OMe)₃ | 2 |
| 947 | 0 | Me | Me | (CH₂)_{b} | 0 to 20 | CH | (CH₂)_{c} | 1 to 20 | Si(OMe)₃ | 2 |
| 948 | 0 | Me | Me | (CH₂)_{b} | 0 to 20 | CH | (CH₂)_{c} | 1 to 20 | Si(OMe)₃ | 2 |
| 949 | 0 | Me | Me | (CH₂)_{b} | 0 to 20 | CH | (CH₂)_{c} | 1 to 20 | Si(OMe)₃ | 2 |
| 950 | 0 | Me | Me | (CH₂)_{b} | 0 to 20 | CH | (CH₂)_{c} | 1 to 20 | Si(OMe)₃ | 2 |
| 951 | 0 | Me | Me | (CH₂)_{b} | 0 to 20 | CH | (CH₂)_{c} | 1 to 20 | Si(OMe)₃ | 2 |
| 952 | 0 | Me | Me | (CH₂)_{b} | 0 to 20 | CH | (CH₂)_{c} | 1 to 20 | Si(OMe)₃ | 2 |
| 953 | 0 | Me | Me | (CH₂)_{b} | 0 to 20 | CH | (CH₂)_{c} | 1 to 20 | Si(OMe)₃ | 2 |
| 954 | 0 | Me | Me | (CH₂)_{b} | 0 to 20 | CH | (CH₂)_{c} | 1 to 20 | Si(OMe)₃ | 2 |
| 955 | 0 | Me | Me | (CH₂)_{b} | 0 to 20 | CH | (CH₂)_{c} | 1 to 20 | Si(OMe)₃ | 2 |

TABLE 264

| No. | R²¹ | | a | R²² | R²³ | R²⁴ | | | R²⁵ | z21 | z22 |
|---|---|---|---|---|---|---|---|---|---|---|---|
| 956 | C₆F₅ | (CH₂)ₐ | 0 to 20 | Me | Me | SCF₃ | (CH2)ₐ | 0 to 20 | Me | 5 to 100 | 0 |
| 957 | 4-CF₃C₆F | (CH₂)ₐ | 0 to 20 | Me | Me | SCF₃ | (CH2)ₐ | 0 to 20 | Me | 5 to 100 | 0 |
| 958 | 4-SF₅C₆F₄ | (CH₂)ₐ | 0 to 20 | Me | Me | SCF₃ | (CH₂)ₐ | 0 to 20 | Me | 5 to 100 | 0 |
| 959 | 3,5-CF₃C₆F₃ | (CH₂)ₐ | 0 to 20 | Me | Me | SCF₃ | (CH₂)ₐ | 0 to 20 | Me | 5 to 100 | 0 |
| 960 | 3,5-SF₅C₆F₃ | (CH₂)ₐ | 0 to 20 | Me | Me | SCF₃ | (CH₂)ₐ | 0 to 20 | Me | 5 to 100 | 0 |
| 961 | 4-CF₃C₆H₄ | (CH₂)ₐ | 0 to 20 | Me | Me | SCF₃ | (CH2)ₐ | 0 to 20 | Me | 5 to 100 | 0 |
| 962 | 4-SF₅C₆H₄ | (CH₂)ₐ | 0 to 20 | Me | Me | SCF₃ | (CH₂)ₐ | 0 to 20 | Me | 5 to 100 | 0 |
| 963 | 3,5-CF₃C₆H₃ | (CH₂)ₐ | 0 to 20 | Me | Me | SCF₃ | (CH₂)ₐ | 0 to 20 | Me | 5 to 100 | 0 |
| 964 | 3,5-SF₅C₆H₃ | (CH₂)ₐ | 0 to 20 | Me | Me | SCF₃ | (CH₂)ₐ | 0 to 20 | Me | 5 to 100 | 0 |
| 965 | 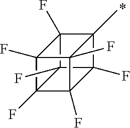 | (CH₂)ₐ | 0 to 20 | Me | Me | SCF₃ | (CH₂)ₐ | 0 to 20 | Me | 5 to 100 | 0 |
| 966 | 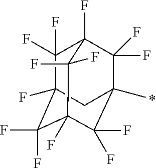 | (CH₂)ₐ | 0 to 20 | Me | Me | SCF₃ | (CH₂)ₐ | 0 t0 20 | Me | 5 to 100 | 0 |

| No. | R²⁸ | R²⁹ | R¹ | b | L¹ | R² | c | T¹ | x1 |
|---|---|---|---|---|---|---|---|---|---|
| 956 | Me | Me | (CH₂)_{b} | 0 to 20 | CH | (CH₂)_{c} | 1 to 20 | Si(OMe)₃ | 2 |
| 957 | Me | Me | (CH₂)_{b} | 0 to 20 | CH | (CH₂)_{c} | 1 to 20 | Si(OMe)₃ | 2 |
| 958 | Me | Me | (CH₂)_{b} | 0 to 20 | CH | (CH₂)_{c} | 1 to 20 | Si(OMe)₃ | 2 |
| 959 | Me | Me | (CH₂)_{b} | 0 to 20 | CH | (CH₂)_{c} | 1 to 20 | Si(OMe)₃ | 2 |
| 960 | Me | Me | (CH₂)_{b} | 0 to 20 | CH | (CH₂)_{c} | 1 to 20 | Si(OMe)₃ | 2 |
| 961 | Me | Me | (CH₂)_{b} | 0 to 20 | CH | (CH₂)_{c} | 1 to 20 | Si(OMe)₃ | 2 |
| 962 | Me | Me | (CH₂)_{b} | 0 to 20 | CH | (CH₂)_{c} | 1 to 20 | Si(OMe)₃ | 2 |
| 963 | Me | Me | (CH₂)_{b} | 0 to 20 | CH | (CH₂)_{c} | 1 to 20 | Si(OMe)₃ | 2 |
| 964 | Me | Me | (CH₂)_{b} | 0 to 20 | CH | (CH₂)_{c} | 1 to 20 | Si(OMe)₃ | 2 |
| 965 | Me | Me | (CH₂)_{b} | 0 to 20 | CH | (CH₂)_{c} | 1 to 20 | Si(OMe)₃ | 2 |
| 966 | Me | Me | (CH₂)_{b} | 0 to 20 | CH | (CH₂)_{c} | 1 to 20 | Si(OMe)₃ | 2 |

TABLE 265

| No. | R²¹ | | a | R²² | R²³ | R²⁴ | | | R²⁵ | z21 | z22 |
|---|---|---|---|---|---|---|---|---|---|---|---|
| 967 | 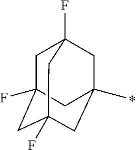 | (CH₂)ₐ | 0 to 20 | Me | Me | SCF₃ | (CH₂)ₐ | 0 to 20 | Me | 5 to 100 | 0 |
| 968 | SF₅ | (CH₂)ₐ | 0 to 20 | Me | Me | SCF₃ | (CH₂)ₐ | 0 to 20 | Me | 5 to 100 | 0 |
| 969 | OCF₃ | (CH₂)ₐ | 0 to 20 | Me | Me | SCF₃ | (CH₂)ₐ | 0 to 20 | Me | 5 to 100 | 0 |
| 970 | SCF₃ | (CH₂)ₐ | 0 to 20 | Me | Me | SCF3 | (CH₂)ₐ | 0 to 20 | Me | 5 to 100 | 0 |
| 971 | N(CH₂CF₃)₂ | (CH₂)ₐ | 0 to 20 | Me | Me | SCF₃ | (CH₂)ₐ | 0 to 20 | Me | 5 to 100 | 0 |
| 972 | N(CF₃)₂ | (CH₂)ₐ | 0 to 20 | Me | Me | SCF₃ | (CH₂)ₐ | 0 to 20 | Me | 5 to 100 | 0 |
| 973 | Me | (CH₂)ₐ | 0 to 20 | Me | Me | N(CF₃)₂ | (CH₂)₄ | 0 to 20 | Me | 5 to 100 | 0 |
| 974 | CF₃ | (CH₂)ₐ | 0 to 20 | Me | Me | N(CF₃)₂ | (CH₂)ₐ | 0 to 20 | Me | 5 to 100 | 0 |
| 975 | (CF₃)₂CF | (CH₂)ₐ | 0 to 20 | Me | Me | N(CF₃)₂ | (CH₂)ₐ | 0 to 20 | Me | 5 to 100 | 0 |
| 976 | (CF₃)₃C | (CH₂)ₐ | 0 to 20 | Me | Me | N(CF₃)₂ | (CH₂)ₐ | 0 to 20 | Me | 5 to 100 | 0 |
| 977 | C₄F₉ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 967 | Me | Me | (CH₂)_{b} | 0 to 20 | CH | (CH₂)_{c} | 1 to 20 | Si(OMe)₃ | 2 |
| 968 | Me | Me | (CH₂)_{b} | 0 to 20 | CH | (CH₂)_{c} | 1 to 20 | Si(OMe)₃ | 2 |
| 969 | Me | Me | (CH₂)_{b} | 0 to 20 | CH | (CH₂)_{c} | 1 to 20 | Si(OMe)₃ | 2 |
| 970 | Me | Me | (CH₂)_{b} | 0 to 20 | CH | (CH₂)_{c} | 1 to 20 | Si(OMe)₃ | 2 |
| 971 | Me | Me | (CH₂)_{b} | 0 to 20 | CH | (CH₂)_{c} | 1 to 20 | Si(OMe)₃ | 2 |
| 972 | Me | Me | (CH₂)_{b} | 0 to 20 | CH | (CH₂)_{c} | 1 to 20 | Si(OMe)₃ | 2 |
| 973 | Me | Me | (CH₂)_{b} | 0 to 20 | CH | (CH₂)_{c} | 1 to 20 | Si(OMe)₃ | 2 |
| 974 | Me | Me | (CH₂)_{b} | 0 to 20 | CH | (CH₂)_{c} | 1 to 20 | Si(OMe)₃ | 2 |
| 975 | Me | Me | (CH₂)_{b} | 0 to 20 | CH | (CH₂)_{c} | 1 to 20 | Si(OMe)₃ | 2 |
| 976 | Me | Me | (CH₂)_{b} | 0 to 20 | CH | (CH₂)_{c} | 1 to 20 | Si(OMe)₃ | 2 |
| 977 | Me | Me | (CH₂)_{b} | 0 to 20 | CH | (CH₂)_{c} | 1 to 20 | Si(OMe)₃ | 2 |

TABLE 266

| No. | R²¹ | | a | R²² | R²³ | R²⁴ | | | R²⁵ | z21 |
|---|---|---|---|---|---|---|---|---|---|---|
| 978 | C₈F₁₇ | (CH₂)ₐ | 0 to 20 | Me | Me | N(CF₃)₂ | (CH₂)ₐ | 0 to 20 | Me | 5 to 100 |
| 979 | c-C₆F₁₁ | (CH₂)ₐ | 0 to 20 | Me | Me | N(CF₃)₂ | (CH₂)ₐ | 0 to 20 | Me | 5 to 100 |
| 980 | CHF₂ | (CH₂)ₐ | 0 to 20 | Me | Me | N(CF₃)₂ | (CH₂)ₐ | 0 to 20 | Me | 5 to 100 |
| 981 | CClF₂ | (CH₂)ₐ | 0 to 20 | Me | Me | N(CF₃)₂ | (CH₂)ₐ | 0 to 20 | Me | 5 to 100 |
| 982 | CBrF₂ | (CH₂)ₐ | 0 to 20 | Me | Me | N(CF₃)₂ | (CH₂)ₐ | 0 to 20 | Me | 5 to 100 |
| 983 | ClF₂ | (CH₂)ₐ | 0 to 20 | Me | Me | N(CF₃)₂ | (CH₂)ₐ | 0 to 20 | Me | 5 to 100 |
| 984 | CF═CF₂ | (CH₂)ₐ | 0 to 20 | Me | Me | N(CF₃)₂ | (CH₂)ₐ | 0 to 20 | Me | 5 to 100 |
| 985 | CF═CFCF₃ | (CH₂)ₐ | 0 to 20 | Me | Me | N(CF₃)₂ | (CH₂)ₐ | 0 to 20 | Me | 5 to 100 |
| 986 | CF═CFCF═CF₂ | (CH₂)ₐ | 0 to 20 | Me | Me | N(CF₃)₂ | (CH₂)ₐ | 0 to 20 | Me | 5 to 100 |
| 987 | C≡CCF₃ | (CH₂)ₐ | 0 to 20 | Me | Me | N(CF₃)₂ | (CH₂)ₐ | 0 to 20 | Me | 5 to 100 |
| 988 | CF₂CH₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 978 | 0 | Me | Me | (CH₂)_{b} | 0 to 20 | CH | (CH₂)_{c} | 1 to 20 | Si(OMe)₃ | 2 |
| 979 | 0 | Me | Me | (CH₂)_{b} | 0 to 20 | CH | (CH₂)_{c} | 1 to 20 | Si(OMe)₃ | 2 |
| 980 | 0 | Me | Me | (CH₂)_{b} | 0 to 20 | CH | (CH₂)_{c} | 1 to 20 | Si(OMe)₃ | 2 |
| 981 | 0 | Me | Me | (CH₂)_{b} | 0 to 20 | CH | (CH₂)_{c} | 1 to 20 | Si(OMe)₃ | 2 |
| 982 | 0 | Me | Me | (CH₂)_{b} | 0 to 20 | CH | (CH₂)_{c} | 1 to 20 | Si(OMe)₃ | 2 |
| 983 | 0 | Me | Me | (CH₂)_{b} | 0 to 20 | CH | (CH₂)_{c} | 1 to 20 | Si(OMe)₃ | 2 |
| 984 | 0 | Me | Me | (CH₂)_{b} | 0 to 20 | CH | (CH₂)_{c} | 1 to 20 | Si(OMe)₃ | 2 |
| 985 | 0 | Me | Me | (CH₂)_{b} | 0 to 20 | CH | (CH₂)_{c} | 1 to 20 | Si(OMe)₃ | 2 |
| 986 | 0 | Me | Me | (CH₂)_{b} | 0 to 20 | CH | (CH₂)_{c} | 1 to 20 | Si(OMe)₃ | 2 |
| 987 | 0 | Me | Me | (CH₂)_{b} | 0 to 20 | CH | (CH₂)_{c} | 1 to 20 | Si(OMe)₃ | 2 |
| 988 | 0 | Me | Me | (CH₂)_{b} | 0 to 20 | CH | (CH₂)_{c} | 1 to 20 | Si(OMe)₃ | 2 |

TABLE 267

| No. | R²¹ | | a | R²² | R²³ | R²⁴ | | | R²⁵ | z21 |
|---|---|---|---|---|---|---|---|---|---|---|
| 989 | (CF₂)₂H | (CH₂)ₐ | 0 to 20 | Me | Me | N(CF₃)₂ | (CH₂)ₐ | 0 to 20 | Me | 5 to 100 |
| 990 | (CF₂)₂CH₃ | (CH₂)ₐ | 0 to 20 | Me | Me | N(CF₃)₂ | (CH₂)ₐ | 0 to 20 | Me | 5 to 100 |
| 991 | (CF₂)₄H | (CH₂)ₐ | 0 to 20 | Me | Me | SCF₃ | (CH₂)ₐ | 0 to 20 | Me | 5 to 100 |
| 992 | C₆F₅ | (CH₂)ₐ | 0 to 20 | Me | Me | N(CF₃)₂ | (CH₂)ₐ | 0 to 20 | Me | 5 to 100 |
| 993 | 4-CF₃C₆F₄ | (CH₂)ₐ | 0 to 20 | Me | Me | N(CF₃)₂ | (CH₂)ₐ | 0 to 20 | Me | 5 to 100 |
| 994 | 4-SF₅C₆F₄ | (CH₂)ₐ | 0 to 20 | Me | Me | N(CF₃)₂ | (CH₂)ₐ | 0 to 20 | Me | 5 to 100 |
| 995 | 3,5-CF₃C₆F₃ | (CH₂)ₐ | 0 to 20 | Me | Me | N(CF₃)₂ | (CH₂)ₐ | 0 to 20 | Me | 5 to 100 |
| 996 | 3,5-SF₅C₆F₃ | (CH₂)ₐ | 0 to 20 | Me | Me | N(CF₃)₂ | (CH₂)ₐ | 0 to 20 | Me | 5 to 100 |
| 997 | 4-CF₃C₆H₄ | (CH₂)ₐ | 0 to 20 | Me | Me | N(CF₃)₂ | (CH₂)ₐ | 0 to 20 | Me | 5 to 100 |
| 998 | 4-SF₅C₆H₄ | (CH₂)ₐ | 0 to 20 | Me | Me | N(CF₃)₂ | (CH₂)ₐ | 0 to 20 | Me | 5 to 100 |
| 999 | 3,5-CF₃C₆H₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 989 | 0 | Me | Me | (CH₂)_{b} | 0 to 20 | CH | (CH₂)_{c} | 1 to 20 | Si(OMe)₃ | 2 |
| 990 | 0 | Me | Me | (CH₂)_{b} | 0 to 20 | CH | (CH₂)_{c} | 1 to 20 | Si(OMe)₃ | 2 |
| 991 | 0 | Me | Me | (CH₂)_{b} | 0 to 20 | CH | (CH₂)_{c} | 1 to 20 | Si(OMe)₃ | 2 |
| 992 | 0 | Me | Me | (CH₂)_{b} | 0 to 20 | CH | (CH₂)_{c} | 1 to 20 | Si(OMe)₃ | 2 |
| 993 | 0 | Me | Me | (CH₂)_{b} | 0 to 20 | CH | (CH₂)_{c} | 1 to 20 | Si(OMe)₃ | 2 |
| 994 | 0 | Me | Me | (CH₂)_{b} | 0 to 20 | CH | (CH₂)_{c} | 1 to 20 | Si(OMe)₃ | 2 |
| 995 | 0 | Me | Me | (CH₂)_{b} | 0 to 20 | CH | (CH₂)_{c} | 1 to 20 | Si(OMe)₃ | 2 |
| 996 | 0 | Me | Me | (CH₂)_{b} | 0 to 20 | CH | (CH₂)_{c} | 1 to 20 | Si(OMe)₃ | 2 |
| 997 | 0 | Me | Me | (CH₂)_{b} | 0 to 20 | CH | (CH₂)_{c} | 1 to 20 | Si(OMe)₃ | 2 |
| 998 | 0 | Me | Me | (CH₂)_{b} | 0 to 20 | CH | (CH₂)_{c} | 1 to 20 | Si(OMe)₃ | 2 |
| 999 | 0 | Me | Me | (CH₂)_{b} | 0 to 20 | CH | (CH₂)_{c} | 1 to 20 | Si(OMe)₃ | 2 |

TABLE 268

| No. | R²¹ | | a | R²² | R²³ | R²⁴ | | | R²⁵ |
|---|---|---|---|---|---|---|---|---|---|
| 1000 | 3,5-SF₅C₆H₃ | (CH₂)ₐ | 0 to 20 | Me | Me | N(CF₃)₂ | (CH₂)ₐ | 0 to 20 | Me |
| 1001 | 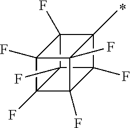 | (CH₂)ₐ | 0 to 20 | Me | Me | N(CF₃)₂ | (CH₂)ₐ | 0 to 20 | Me |
| 1002 | 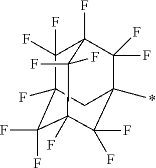 | (CH₂)ₐ | 0 to 20 | Me | Me | N(CF₃)₂ | (CH₂)ₐ | 0 to 20 | Me |
| 1003 | 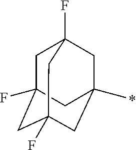 | (CH₂)ₐ | 0 to 20 | Me | Me | N(CF₃)₂ | (CH₂)ₐ | 0 to 20 | Me |
| 1004 | SF₅ | (CH₂)ₐ | 0 to 20 | Me | Me | N(CF₃)₂ | (CH₂)ₐ | 0 to 20 | Me |
| 1005 | OCF₃ | (CH₂)ₐ | 0 to 20 | Me | Me | N(CF₃)₂ | (CH₂)ₐ | 0 to 20 | Me |
| 1006 | SCF₃ | (CH₂)ₐ | 0 to 20 | Me | Me | N(CF₃)₂ | (CH₂)ₐ | 0 to 20 | Me |
| 1007 | N(CH₂CF₃)₂ | (CH₂)ₐ | 0 to 20 | Me | Me | N(CF₃)₂ | (CH₂)ₐ | 0 to 20 | Me |
| 1008 | N(CF₃)₂ | (CH₂)ₐ | 0 to 20 | Me | Me | N(CF₃)₂ | (CH₂)ₐ | 0 to 20 | Me |

| No. | z21 | z22 | R²⁸ | R²⁹ | R¹ | b | L¹ | R² | c | T¹ | x1 |
|---|---|---|---|---|---|---|---|---|---|---|---|
| 1000 | 5 to 100 | 0 | Me | Me | (CH₂)_{b} | 0 to 20 | CH | (CH₂)_{c} | 1 to 20 | Si(OMe)₃ | 2 |
| 1001 | 5 to 100 | 0 | Me | Me | (CH₂)_{b} | 0 to 20 | CH | (CH₂)_{c} | 1 to 20 | Si(OMe)₃ | 2 |
| 1002 | 5 to 100 | 0 | Me | Me | (CH₂)_{b} | 0 to 20 | CH | (CH₂)_{c} | 1 to 20 | Si(OMe)₃ | 2 |
| 1003 | 5 to 100 | 0 | Me | Me | (CH₂)_{b} | 0 to 20 | CH | (CH₂)_{c} | 1 to 20 | Si(OMe)₃ | 2 |
| 1004 | 5 to 100 | 0 | Me | Me | (CH₂)_{b} | 0 to 20 | CH | (CH₂)_{c} | 1 to 20 | Si(OMe)₃ | 2 |
| 1005 | 5 to 100 | 0 | Me | Me | (CH₂)_{b} | 0 to 20 | CH | (CH₂)_{c} | 1 to 20 | Si(OMe)₃ | 2 |
| 1006 | 5 to 100 | 0 | Me | Me | (CH₂)_{b} | 0 to 20 | CH | (CH₂)_{c} | 1 to 20 | Si(OMe)₃ | 2 |
| 1007 | 5 to 100 | 0 | Me | Me | (CH₂)_{b} | 0 to 20 | CH | (CH₂)_{c} | 1 to 20 | Si(OMe)₃ | 2 |
| 1008 | 5 to 100 | 0 | Me | Me | (CH₂)_{b} | 0 to 20 | CH | (CH₂)_{c} | 1 to 20 | Si(OMe)₃ | 2 |

TABLE 269

| No. | R²¹ | | a | R²² | R²³ | R²⁴ | | | R²⁵ | z21 | z22 |
|---|---|---|---|---|---|---|---|---|---|---|---|
| 1 | Me | (CH₂)ₐ | 0 to 20 | Me | Me | CF₃ | (CH₂)ₐ | 0 to 20 | Me | 5 to 100 | 0 |
| 2 | CF₃ | (CH₂)ₐ | 0 to 20 | Me | Me | CF₃ | (CH₂)ₐ | 0 to 20 | Me | 5 to 100 | 0 |
| 3 | (CF₃)₂CF | (CH₂)ₐ | 0 to 20 | Me | Me | CF₃ | (CH₂)ₐ | 0 to 20 | Me | 5 to 100 | 0 |
| 4 | (CF₃)₃C | (CH₂)ₐ | 0 to 20 | Me | Me | CF₃ | (CH₂)ₐ | 0 to 20 | Me | 5 to 100 | 0 |
| 5 | C₄F₉ | (CH₂)ₐ | 0 to 20 | Me | Me | CF₃ | (CH₂)ₐ | 0 to 20 | Me | 5 to 100 | 0 |
| 6 | C₈F₁₇ | (CH₂)ₐ | 0 to 20 | Me | Me | CF₃ | (CH₂)ₐ | 0 to 20 | Me | 5 to 100 | 0 |
| 7 | c-C₆F₁₁ | (CH₂)ₐ | 0 to 20 | Me | Me | CF₃ | (CH₂)ₐ | 0 to 20 | Me | 5 to 100 | 0 |
| 8 | CHF₂ | (CH₂)ₐ | 0 to 20 | Me | Me | CF₃ | (CH₂)ₐ | 0 to 20 | Me | 5 to 100 | 0 |
| 9 | CClF₂ | (CH₂)ₐ | 0 to 20 | Me | Me | CF₃ | (CH₂)ₐ | 0 to 20 | Me | 5 to 100 | 0 |
| 10 | CBrF₂ | (CH₂)ₐ | 0 to 20 | Me | Me | CF₃ | (CH₂)ₐ | 0 to 20 | Me | 5 to 100 | 0 |
| 11 | ClF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 1 | Me | Me | (CH₂)_{b} | 0 to 20 | C(═O)NHCH₂C | (CH₂)_{c} | 1 to 20 | Si(OMe)₃ | 3 |
| 2 | Me | Me | (CH₂)_{b} | 0 to 20 | C(═O)NHCH₂C | (CH₂)_{c} | 1 to 20 | Si(OMe)₃ | 3 |
| 3 | Me | Me | (CH₂)_{b} | 0 to 20 | C(═O)NHCH₂C | (CH₂)_{c} | 1 to 20 | Si(OMe)₃ | 3 |
| 4 | Me | Me | (CH₂)_{b} | 0 to 20 | C(═O)NHCH₂C | (CH₂)_{c} | 1 to 20 | Si(OMe)₃ | 3 |
| 5 | Me | Me | (CH₂)_{b} | 0 to 20 | C(═O)NHCH₂C | (CH₂)_{c} | 1 to 20 | Si(OMe)₃ | 3 |
| 6 | Me | Me | (CH₂)_{b} | 0 to 20 | C(═O)NHCH₂C | (CH₂)_{c} | 1 to 20 | Si(OMe)₃ | 3 |
| 7 | Me | Me | (CH₂)_{b} | 0 to 20 | C(═O)NHCH₂C | (CH₂)_{c} | 1 to 20 | Si(OMe)₃ | 3 |
| 8 | Me | Me | (CH₂)_{b} | 0 to 20 | C(═O)NHCH₂C | (CH₂)_{c} | 1 to 20 | Si(OMe)₃ | 3 |
| 9 | Me | Me | (CH₂)_{b} | 0 to 20 | C(═O)NHCH₂C | (CH₂)_{c} | 1 to 20 | Si(OMe)₃ | 3 |
| 10 | Me | Me | (CH₂)_{b} | 0 to 20 | C(═O)NHCH₂C | (CH₂)_{c} | 1 to 20 | Si(OMe)₃ | 3 |
| 11 | Me | Me | (CH₂)_{b} | 0 to 20 | C(═O)NHCH₂C | (CH₂)_{c} | 1 to 20 | Si(OMe)₃ | 3 |

TABLE 270

| No. | R²¹ | | a | R²² | R²³ | R²⁴ | | | R²⁵ | z21 |
|---|---|---|---|---|---|---|---|---|---|---|
| 12 | CF═CF₂ | (CH₂)ₐ | 0 to 20 | Me | Me | CF₃ | (CH₂)ₐ | 0 to 20 | Me | 5 to 100 |
| 13 | CF═CFCF₃ | (CH₂)ₐ | 0 to 20 | Me | Me | CF₃ | (CH₂)ₐ | 0 to 20 | Me | 5 to 100 |
| 14 | CF═CFCF═CF₂ | (CH₂)ₐ | 0 to 20 | Me | Me | CF₃ | (CH₂)ₐ | 0 to 20 | Me | 5 to 100 |
| 15 | C═CCF₃ | (CH₂)ₐ | 0 to 20 | Me | Me | CF₃ | (CH₂)ₐ | 0 to 20 | Me | 5 to 100 |
| 16 | CF₂CH₃ | (CH₂)ₐ | 0 to 20 | Me | Me | CF₃ | (CH₂)ₐ | 0 to 20 | Me | 5 to 100 |
| 17 | (CF₂)₂H | (CH₂)ₐ | 0 to 20 | Me | Me | CF₃ | (CH₂)ₐ | 0 to 20 | Me | 5 to 100 |
| 18 | (CF₂)₂CH₃ | (CH₂)ₐ | 0 to 20 | Me | Me | CF₃ | (CH₂)ₐ | 0 to 20 | Me | 5 to 100 |
| 19 | (CF₂)₄H | (CH₂)ₐ | 0 to 20 | Me | Me | CF₃ | (CH₂)ₐ | 0 to 20 | Me | 5 to 100 |
| 20 | C₆F₅ | (CH₂)ₐ | 0 to 20 | Me | Me | CF₃ | (CH₂)ₐ | 0 to 20 | Me | 5 to 100 |
| 21 | 4-CF₃C₆F₄ | (CH₂)ₐ | 0 to 20 | Me | Me | CF₃ | (CH₂)ₐ | 0 to 20 | Me | 5 to 100 |
| 22 | 4-SF₅C₆F₄ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 12 | 0 | Me | Me | (CH₂)_{b} | 0 to 20 | C(═O)NHCH₂C | (CH₂)_{c} | 1 to 20 | Si(OMe)₃ | 3 |
| 13 | 0 | Me | Me | (CH₂)_{b} | 0 to 20 | C(═O)NHCH₂C | (CH₂)_{c} | 1 to 20 | Si(OMe)₃ | 3 |
| 14 | 0 | Me | Me | (CH₂)_{b} | 0 to 20 | C(═O)NHCH₂C | (CH₂)_{c} | 1 to 20 | Si(OMe)₃ | 3 |
| 15 | 0 | Me | Me | (CH₂)_{b} | 0 to 20 | C(═O)NHCH₂C | (CH₂)_{c} | 1 to 20 | Si(OMe)₃ | 3 |
| 16 | 0 | Me | Me | (CH₂)_{b} | 0 to 20 | C(═O)NHCH₂C | (CH₂)_{c} | 1 to 20 | Si(OMe)₃ | 3 |
| 17 | 0 | Me | Me | (CH₂)_{b} | 0 to 20 | C(═O)NHCH₂C | (CH₂)_{c} | 1 to 20 | Si(OMe)₃ | 3 |
| 18 | 0 | Me | Me | (CH₂)_{b} | 0 to 20 | C(═O)NHCH₂C | (CH₂)_{c} | 1 to 20 | Si(OMe)₃ | 3 |
| 19 | 0 | Me | Me | (CH₂)_{b} | 0 to 20 | C(═O)NHCH₂C | (CH₂)_{c} | 1 to 20 | Si(OMe)₃ | 3 |
| 20 | 0 | Me | Me | (CH₂)_{b} | 0 to 20 | C(═O)NHCH₂C | (CH₂)_{c} | 1 to 20 | Si(OMe)₃ | 3 |
| 21 | 0 | Me | Me | (CH₂)_{b} | 0 to 20 | C(═O)NHCH₂C | (CH₂)_{c} | 1 to 20 | Si(OMe)₃ | 3 |
| 22 | 0 | Me | Me | (CH₂)_{b} | 0 to 20 | C(═O)NHCH₂C | (CH₂)_{c} | 1 to 20 | Si(OMe)₃ | 3 |

TABLE 271

| No. | R²¹ | | a | R²² | R²³ | R²⁴ | | | R²⁵ |
|---|---|---|---|---|---|---|---|---|---|
| 23 | 3,5-CF₃C₆F₃ | (CH₂)ₐ | 0 to 20 | Me | Me | CF₃ | (CH₂)ₐ | 0 to 20 | Me |
| 24 | 3,5-SF₅C₆F₃ | (CH₂)ₐ | 0 to 20 | Me | Me | CF₃ | (CH₂)ₐ | 0 to 20 | Me |
| 25 | 4-CF₃C₆H₄ | (CH₂)ₐ | 0 to 20 | Me | Me | CF₃ | (CH₂)ₐ | 0 to 20 | Me |
| 26 | 4-SF₅C₆H₄ | (CH₂)ₐ | 0 to 20 | Me | Me | CF₃ | (CH₂)ₐ | 0 to 20 | Me |
| 27 | 3,5-CF₃C₆H₃ | (CH₂)ₐ | 0 to 20 | Me | Me | CF₃ | (CH₂)ₐ | 0 to 20 | Me |
| 28 | 3,5-SF₅C₆H₃ | (CH₂)ₐ | 0 to 20 | Me | Me | CF₃ | (CH₂)ₐ | 0 to 20 | Me |
| 29 | 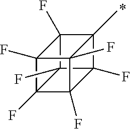 | (CH₂)ₐ | 0 to 20 | Me | Me | CF₃ | (CH₂)ₐ | 0 to 20 | Me |
| 30 | 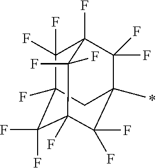 | (CH₂)ₐ | 0 to 20 | Me | Me | CF₃ | (CH₂)ₐ | 0 to 20 | Me |
| 31 | 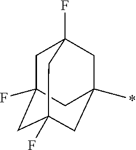 | (CH₂)ₐ | 0 to 20 | Me | Me | CF₃ | (CH₂)ₐ | 0 to 20 | Me |
| 32 | SF₅ | (CH₂)ₐ | 0 to 20 | Me | Me | CF₃ | (CH₂)ₐ | 0 to 20 | Me |
| 33 | OCF₃ | (CH₂)ₐ | 0 to 20 | Me | Me | CF₃ | (CH₂)ₐ | 0 to 20 | Me |

| No. | z21 | z22 | R²⁸ | R²⁹ | R¹ | b | L¹ | R² | c | T¹ | x1 |
|---|---|---|---|---|---|---|---|---|---|---|---|
| 23 | 5 to 100 | 0 | Me | Me | (CH₂)_{b} | 0 to 20 | C(═O)NHCH₂C | (CH₂)_{c} | 1 to 20 | Si(OMe)₃ | 3 |
| 24 | 5 to 100 | 0 | Me | Me | (CH₂)_{b} | 0 to 20 | C(═O)NHCH₂C | (CH₂)_{c} | 1 to 20 | Si(OMe)₃ | 3 |
| 25 | 5 to 100 | 0 | Me | Me | (CH₂)_{b} | 0 to 20 | C(═O)NHCH₂C | (CH₂)_{c} | 1 to 20 | Si(OMe)₃ | 3 |
| 26 | 5 to 100 | 0 | Me | Me | (CH₂)_{b} | 0 to 20 | C(═O)NHCH₂C | (CH₂)_{c} | 1 to 20 | Si(OMe)₃ | 3 |
| 27 | 5 to 100 | 0 | Me | Me | (CH₂)_{b} | 0 to 20 | C(═O)NHCH₂C | (CH₂)_{c} | 1 to 20 | Si(OMe)₃ | 3 |
| 28 | 5 to 100 | 0 | Me | Me | (CH₂)_{b} | 0 to 20 | C(═O)NHCH₂C | (CH₂)_{c} | 1 to 20 | Si(OMe)₃ | 3 |
| 29 | 5 to 100 | 0 | Me | Me | (CH₂)_{b} | 0 to 20 | C(═O)NHCH₂C | (CH₂)_{c} | 1 to 20 | Si(OMe)₃ | 3 |
| 30 | 5 to 100 | 0 | Me | Me | (CH₂)_{b} | 0 to 20 | C(═O)NHCH₂C | (CH₂)_{c} | 1 to 20 | Si(OMe)₃ | 3 |
| 31 | 5 to 100 | 0 | Me | Me | (CH₂)_{b} | 0 to 20 | C(═O)NHCH₂C | (CH₂)_{c} | 1 to 20 | Si(OMe)₃ | 3 |
| 32 | 5 to 100 | 0 | Me | Me | (CH₂)_{b} | 0 to 20 | C(═O)NHCH₂C | (CH₂)_{c} | 1 to 20 | Si(OMe)₃ | 3 |
| 33 | 5 to 100 | 0 | Me | Me | (CH₂)_{b} | 0 to 20 | C(═O)NHCH₂C | (CH₂)_{c} | 1 to 20 | Si(OMe)₃ | 3 |

TABLE 272

| No. | R²¹ | | a | R²² | R²³ | R²⁴ | | | R²⁵ | z21 | z22 |
|---|---|---|---|---|---|---|---|---|---|---|---|
| 34 | SCF₃ | (CH₂)ₐ | 0 to 20 | Me | Me | CF₃ | (CH₂)ₐ | 0 to 20 | Me | 5 to 100 | 0 |
| 35 | N(CH₂CF₃)₂ | (CH₂)ₐ | 0 to 20 | Me | Me | CF₃ | (CH₂)ₐ | 0 to 20 | Me | 5 to 100 | 0 |
| 36 | N(CF₃)₂ | (CH₂)ₐ | 0 to 20 | Me | Me | CF₃ | (CH₂)ₐ | 0 to 20 | Me | 5 to 100 | 0 |
| 37 | Me | (CH₂)ₐ | 0 to 20 | Me | Me | CHF₂ | (CH₂)ₐ | 0 to 20 | Me | 5 to 100 | 0 |
| 38 | CF₃ | (CH₂)ₐ | 0 to 20 | Me | Me | CHF₂ | (CH₂)ₐ | 0 to 20 | Me | 5 to 100 | 0 |
| 39 | (CF₃)₂CF | (CH₂)ₐ | 0 to 20 | Me | Me | CHF₂ | (CH₂)ₐ | 0 to 20 | Me | 5 to 100 | 0 |
| 40 | (CF₃)₃C | (CH₂)ₐ | 0 to 20 | Me | Me | CHF₂ | (CH₂)ₐ | 0 to 20 | Me | 5 to 100 | 0 |
| 41 | C₄F₉ | (CH₂)ₐ | 0 to 20 | Me | Me | CHF₂ | (CH₂)ₐ | 0 to 20 | Me | 5 to 100 | 0 |
| 42 | C₈F₁₇ | (CH₂)ₐ | 0 to 20 | Me | Me | CHF₂ | (CH₂)ₐ | 0 to 20 | Me | 5 to 100 | 0 |
| 43 | c-C₆F₁₁ | (CH₂)ₐ | 0 to 20 | Me | Me | CHF₂ | (CH₂)ₐ | 0 to 20 | Me | 5 to 100 | 0 |
| 44 | CHF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 34 | Me | Me | (CH₂)_{b} | 0 to 20 | C(═O)NHCH₂C | (CH₂)_{c} | 1 to 20 | Si(OMe)₃ | 3 |
| 35 | Me | Me | (CH₂)_{b} | 0 to 20 | C(═O)NHCH₂C | (CH₂)_{c} | 1 to 20 | Si(OMe)₃ | 3 |
| 36 | Me | Me | (CH₂)_{b} | 0 to 20 | C(═O)NHCH₂C | (CH₂)_{c} | 1 to 20 | Si(OMe)₃ | 3 |
| 37 | Me | Me | (CH₂)_{b} | 0 to 20 | C(═O)NHCH₂C | (CH₂)_{c} | 1 to 20 | Si(OMe)₃ | 3 |
| 38 | Me | Me | (CH₂)_{b} | 0 to 20 | C(═O)NHCH₂C | (CH₂)_{c} | 1 to 20 | Si(OMe)₃ | 3 |
| 39 | Me | Me | (CH₂)_{b} | 0 to 20 | C(═O)NHCH₂C | (CH₂)_{c} | 1 to 20 | Si(OMe)₃ | 3 |
| 40 | Me | Me | (CH₂)_{b} | 0 to 20 | C(═O)NHCH₂C | (CH₂)_{c} | 1 to 20 | Si(OMe)₃ | 3 |
| 41 | Me | Me | (CH₂)_{b} | 0 to 20 | C(═O)NHCH₂C | (CH₂)_{c} | 1 to 20 | Si(OMe)₃ | 3 |
| 42 | Me | Me | (CH₂)_{b} | 0 to 20 | C(═O)NHCH₂C | (CH₂)_{c} | 1 to 20 | Si(OMe)₃ | 3 |
| 43 | Me | Me | (CH₂)_{b} | 0 to 20 | C(═O)NHCH₂C | (CH₂)_{c} | 1 to 20 | Si(OMe)₃ | 3 |
| 44 | Me | Me | (CH₂)_{b} | 0 to 20 | C(═O)NHCH₂C | (CH₂)_{c} | 1 to 20 | Si(OMe)₃ | 3 |

TABLE 273

| No. | R²¹ | | a | R²² | R²³ | R²⁴ | | | R²⁵ | z21 |
|---|---|---|---|---|---|---|---|---|---|---|
| 45 | CCIF₂ | (CH₂)ₐ | 0 to 20 | Me | Me | CHF₂ | (CH₂)ₐ | 0 to 20 | Me | 5 to 100 |
| 46 | CBrF₂ | (CH₂)ₐ | 0 to 20 | Me | Me | CHF₂ | (CH₂)ₐ | 0 to 20 | Me | 5 to 100 |
| 47 | CIF₂ | (CH₂)ₐ | 0 to 20 | Me | Me | CHF₂ | (CH₂)ₐ | 0 to 20 | Me | 5 to 100 |
| 48 | CF═CF₂ | (CH₂)ₐ | 0 to 20 | Me | Me | CHF₂ | (CH₂)ₐ | 0 to 20 | Me | 5 to 100 |
| 49 | CF═CFCF₃ | (CH₂)ₐ | 0 to 20 | Me | Me | CHF₂ | (CH₂)ₐ | 0 to 20 | Me | 5 to 100 |
| 50 | CF═CFCF═CF₂ | (CH₂)ₐ | 0 to 20 | Me | Me | CHF₂ | (CH₂)ₐ | 0 to 20 | Me | 5 to 100 |
| 51 | C═CCF₃ | (CH₂)ₐ | 0 to 20 | Me | Me | CHF₂ | (CH₂)ₐ | 0 to 20 | Me | 5 to 100 |
| 52 | CF₂CH₃ | (CH₂)ₐ | 0 to 20 | Me | Me | CHF₂ | (CH₂)ₐ | 0 to 20 | Me | 5 to 100 |
| 53 | (CF₂)₂H | (CH₂)ₐ | 0 to 20 | Me | Me | CHF₂ | (CH₂)ₐ | 0 to 20 | Me | 5 to 100 |
| 54 | (CF₂)₂CH₃ | (CH₂)ₐ | 0 to 20 | Me | Me | CHF₂ | (CH₂)ₐ | 0 to 20 | Me | 5 to 100 |
| 55 | (CF₂)₄H | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 45 | 0 | Me | Me | (CH₂)_{b} | 0 to 20 | C(═O)NHCH₂C | (CH₂)_{c} | 1 to 20 | Si(OMe)₃ | 3 |
| 46 | 0 | Me | Me | (CH₂)_{b} | 0 to 20 | C(═O)NHCH₂C | (CH₂)_{c} | 1 to 20 | Si(OMe)₃ | 3 |
| 47 | 0 | Me | Me | (CH₂)_{b} | 0 to 20 | C(═O)NHCH₂C | (CH₂)_{c} | 1 to 20 | Si(OMe)₃ | 3 |
| 48 | 0 | Me | Me | (CH₂)_{b} | 0 to 20 | C(═O)NHCH₂C | (CH₂)_{c} | 1 to 20 | Si(OMe)₃ | 3 |
| 49 | 0 | Me | Me | (CH₂)_{b} | 0 to 20 | C(═O)NHCH₂C | (CH₂)_{c} | 1 to 20 | Si(OMe)₃ | 3 |
| 50 | 0 | Me | Me | (CH₂)_{b} | 0 to 20 | C(═O)NHCH₂C | (CH₂)_{c} | 1 to 20 | Si(OMe)₃ | 3 |
| 51 | 0 | Me | Me | (CH₂)_{b} | 0 to 20 | C(═O)NHCH₂C | (CH₂)_{c} | 1 to 20 | Si(OMe)₃ | 3 |
| 52 | 0 | Me | Me | (CH₂)_{b} | 0 to 20 | C(═O)NHCH₂C | (CH₂)_{c} | 1 to 20 | Si(OMe)₃ | 3 |
| 53 | 0 | Me | Me | (CH₂)_{b} | 0 to 20 | C(═O)NHCH₂C | (CH₂)_{c} | 1 to 20 | Si(OMe)₃ | 3 |
| 54 | 0 | Me | Me | (CH₂)_{b} | 0 to 20 | C(═O)NHCH₂C | (CH₂)_{c} | 1 to 20 | Si(OMe)₃ | 3 |
| 55 | 0 | Me | Me | (CH₂)_{b} | 0 to 20 | C(═O)NHCH₂C | (CH₂)_{c} | 1 to 20 | Si(OMe)₃ | 3 |

TABLE 274

| No. | R²¹ | | a | R²² | R²³ | R²⁴ | | | R²⁵ |
|---|---|---|---|---|---|---|---|---|---|
| 56 | C₆F₅ | (CH₂)ₐ | 0 to 20 | Me | Me | CHF₂ | (CH₂)ₐ | 0 to 20 | Me |
| 57 | 4-CF₃C₆F₄ | (CH₂)ₐ | 0 to 20 | Me | Me | CHF₂ | (CH₂)ₐ | 0 to 20 | Me |
| 58 | 4-SF₅C₆F₄ | (CH₂)ₐ | 0 to 20 | Me | Me | CHF₂ | (CH₂)ₐ | 0 to 20 | Me |
| 59 | 3,5-CF₃C₆F₃ | (CH₂)ₐ | 0 to 20 | Me | Me | CHF₂ | (CH₂)ₐ | 0 to 20 | Me |
| 60 | 3,5-SFC₆F₃ | (CH₂)ₐ | 0 to 20 | Me | Me | CHF₂ | (CH₂)ₐ | 0 to 20 | Me |
| 61 | 4-CF₃C₆H₄ | (CH₂)ₐ | 0 to 20 | Me | Me | CHF₂ | (CH₂)ₐ | 0 to 20 | Me |
| 62 | 4-SF₅C₆H₄ | (CH₂)ₐ | 0 to 20 | Me | Me | CHF₂ | (CH₂)ₐ | 0 to 20 | Me |
| 63 | 3,5-CF₃C₆H₃ | (CH₂)ₐ | 0 to 20 | Me | Me | CHF₂ | (CH₂)ₐ | 0 to 20 | Me |
| 64 | 3,5-SF₅C₆H₃ | (CH₂)ₐ | 0 to 20 | Me | Me | CHF₂ | (CH₂)ₐ | 0 to 20 | Me |
| 65 | 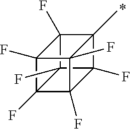 | (CH₂)ₐ | 0 to 20 | Me | Me | CHF₂ | (CH₂)ₐ | 0 to 20 | Me |
| 66 | 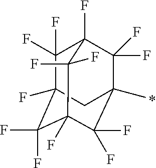 | (CH₂)ₐ | 0 to 20 | Me | Me | CHF₂ | (CH₂)ₐ | 0 to 20 | Me |

| No. | z21 | z22 | R²⁸ | R²⁹ | R¹ | b | L¹ | R² | c | T¹ | x1 |
|---|---|---|---|---|---|---|---|---|---|---|---|
| 56 | 5 to 100 | 0 | Me | Me | (CH₂)_{b} | 0 to 20 | C(═O)NHCH₂C | (CH₂)_{c} | 1 to 20 | Si(OMe)₃ | 3 |
| 57 | 5 to 100 | 0 | Me | Me | (CH₂)_{b} | 0 to 20 | C(═O)NHCH₂C | (CH₂)_{c} | 1 to 20 | Si(OMe)₃ | 3 |
| 58 | 5 to 100 | 0 | Me | Me | (CH₂)_{b} | 0 to 20 | C(═O)NHCH₂C | (CH₂)_{c} | 1 to 20 | Si(OMe)₃ | 3 |
| 59 | 5 to 100 | 0 | Me | Me | (CH₂)_{b} | 0 to 20 | C(═O)NHCH₂C | (CH₂)_{c} | 1 to 20 | Si(OMe)₃ | 3 |
| 60 | 5 to 100 | 0 | Me | Me | (CH₂)_{b} | 0 to 20 | C(═O)NHCH₂C | (CH₂)_{c} | 1 to 20 | Si(OMe)₃ | 3 |
| 61 | 5 to 100 | 0 | Me | Me | (CH₂)_{b} | 0 to 20 | C(═O)NHCH₂C | (CH₂)_{c} | 1 to 20 | Si(OMe)₃ | 3 |
| 62 | 5 to 100 | 0 | Me | Me | (CH₂)_{b} | 0 to 20 | C(═O)NHCH₂C | (CH₂)_{c} | 1 to 20 | Si(OMe)₃ | 3 |
| 63 | 5 to 100 | 0 | Me | Me | (CH₂)_{b} | 0 to 20 | C(═O)NHCH₂C | (CH₂)_{c} | 1 to 20 | Si(OMe)₃ | 3 |
| 64 | 5 to 100 | 0 | Me | Me | (CH₂)_{b} | 0 to 20 | C(═O)NHCH₂C | (CH₂)_{c} | 1 to 20 | Si(OMe)₃ | 3 |
| 65 | 5 to 100 | 0 | Me | Me | (CH₂)_{b} | 0 to 20 | C(═O)NHCH₂C | (CH₂)_{c} | 1 to 20 | Si(OMe)₃ | 3 |
| 66 | 5 to 100 | 0 | Me | Me | (CH₂)_{b} | 0 to 20 | C(═O)NHCH₂C | (CH₂)_{c} | 1 to 20 | Si(OMe)₃ | 3 |

TABLE 275

| No. | R²¹ | | a | R²² | R²³ | R²⁴ | | | R²⁵ | z21 |
|---|---|---|---|---|---|---|---|---|---|---|
| 67 | 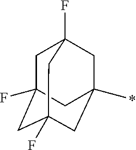 | (CH₂)ₐ | 0 to 20 | Me | Me | CHF₂ | (CH₂)ₐ | 0 to 20 | Me | 5 to 100 |
| 68 | SF₅ | (CH₂)ₐ | 0 to 20 | Me | Me | CHF₂ | (CH₂)ₐ | 0 to 20 | Me | 5 to 100 |
| 69 | OCF₃ | (CH₂)ₐ | 0 to 20 | Me | Me | CHF₂ | (CH₂)ₐ | 0 to 20 | Me | 5 to 100 |
| 70 | SCF₃ | (CH₂)ₐ | 0 to 20 | Me | Me | CHF₂ | (CH₂)ₐ | 0 to 20 | Me | 5 to 100 |
| 71 | N(CH₂CF₃)₂ | (CH₂)ₐ | 0 to 20 | Me | Me | CHF₂ | (CH₂)ₐ | 0 to 20 | Me | 5 to 100 |
| 72 | N(CF₃)₂ | (CH₂)ₐ | 0 to 20 | Me | Me | CHF₂ | (CH₂)ₐ | 0 to 20 | Me | 5 to 100 |
| 73 | Me | (CH₂)ₐ | 0 to 20 | Me | Me | 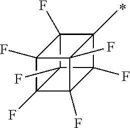 | (CH₂)ₐ | 0 to 20 | Me | 5 to 100 |
| 74 | CF₃ | (CH₂)ₐ | 0 to 20 | Me | Me | 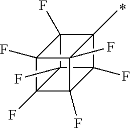 | (CH₂)ₐ | 0 to 20 | Me | 5 to 100 |
| 75 | (CF₃)₂CF | (CH₂)ₐ | 0 to 20 | Me | Me | 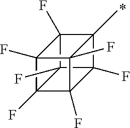 | (CH₂)ₐ | 0 to 20 | Me | 5 to 100 |
| 76 | (CF₃)₃C | (CH₂)ₐ | 0 to 20 | Me | Me | 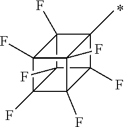 | (CH₂)ₐ | 0 to 20 | Me | 5 to 100 |
| 77 | C₄F₉ | (CH₂)ₐ | 0 to 20 | Me | Me | 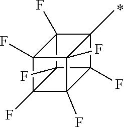 | (CH₂)ₐ | 0 to 20 | Me | 5 to 100 |

| No. | z22 | R²⁸ | R²⁹ | R¹ | b | 11 | R² | c | T¹ | x1 |
|---|---|---|---|---|---|---|---|---|---|---|
| 67 | 0 | Me | Me | (CH₂)_{b} | 0 to 20 | C(═O)NHCH₂C | (CH₂)_{c} | 1 to 20 | Si(OMe)₃ | 3 |
| 68 | 0 | Me | Me | (CH₂)_{b} | 0 to 20 | C(═O)NHCH₂C | (CH₂)_{c} | 1 to 20 | Si(OMe)₃ | 3 |
| 69 | 0 | Me | Me | (CH₂)_{b} | 0 to 20 | C(═O)NHCH₂C | (CH₂)_{c} | 1 to 20 | Si(OMe)₃ | 3 |
| 70 | 0 | Me | Me | (CH₂)_{b} | 0 to 20 | C(═O)NHCH₂C | (CH₂)_{c} | 1 to 20 | Si(OMe)₃ | 3 |
| 71 | 0 | Me | Me | (CH₂)_{b} | 0 to 20 | C(═O)NHCH₂C | (CH₂)_{c} | 1 to 20 | Si(OMe)₃ | 3 |
| 72 | 0 | Me | Me | (CH₂)_{b} | 0 to 20 | C(═O)NHCH₂C | (CH₂)_{c} | 1 to 20 | Si(OMe)₃ | 3 |
| 73 | 0 | Me | Me | (CH₂)_{b} | 0 to 20 | C(═O)NHCH₂C | (CH₂)_{c} | 1 to 20 | Si(OMe)₃ | 3 |
| 74 | 0 | Me | Me | (CH₂)_{b} | 0 to 20 | C(═O)NHCH₂C | (CH₂)_{c} | 1 to 20 | Si(OMe)₃ | 3 |
| 75 | 0 | Me | Me | (CH₂)_{b} | 0 to 20 | C(═O)NHCH₂C | (CH₂)_{c} | 1 to 20 | Si(OMe)₃ | 3 |
| 76 | 0 | Me | Me | (CH₂)_{b} | 0 to 20 | C(═O)NHCH₂C | (CH₂)_{c} | 1 to 20 | Si(OMe)₃ | 3 |
| 77 | 0 | Me | Me | (CH₂)_{b} | 0 to 20 | C(═O)NHCH₂C | (CH₂)_{c} | 1 to 20 | Si(OMe)₃ | 3 |

TABLE 276

| No. | R²¹ | | a | R²² | R²³ | R²⁴ | | | R²⁵ | z21 |
|---|---|---|---|---|---|---|---|---|---|---|
| 78 | C₈F₁₇ | (CH₂)ₐ | 0 to 20 | Me | Me | 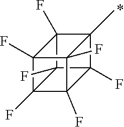 | (CH₂)ₐ | 0 to 20 | Me | 5 to 100 |
| 79 | c-C₆F₁₁ | (CH₂)ₐ | 0 to 20 | Me | Me | 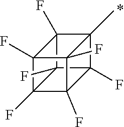 | (CH₂)ₐ | 0 to 20 | Me | 5 to 100 |
| 80 | CHF₂ | (CH₂)ₐ | 0 to 20 | Me | Me | 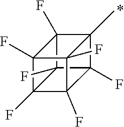 | (CH₂)ₐ | 0 to 20 | Me | 5 to 100 |
| 81 | CClF₂ | (CH₂)ₐ | 0 to 20 | Me | Me | 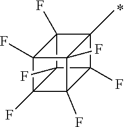 | (CH₂)ₐ | 0 to 20 | Me | 5 to 100 |
| 82 | CBrF₂ | (CH₂)ₐ | 0 to 20 | Me | Me | 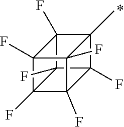 | (CH₂)ₐ | 0 to 20 | Me | 5 to 100 |
| 83 | ClF₂ | (CH₂)ₐ | 0 to 20 | Me | Me | 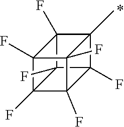 | (CH₂)ₐ | 0 to 20 | Me | 5 to 100 |
| 84 | CF═CF₂ | (CH₂)ₐ | 0 to 20 | Me | Me | 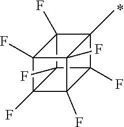 | (CH₂)ₐ | 0 to 20 | Me | 5 to 100 |
| 85 | CF═CFCF₃ | (CH₂)ₐ | 0 to 20 | Me | Me | 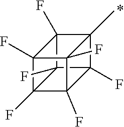 | (CH₂)ₐ | 0 to 20 | Me | 5 to 100 |
| 86 | CF═CFCF═CF₂ | (CH₂)ₐ | 0 to 20 | Me | Me | 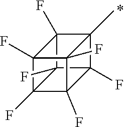 | (CH₂)ₐ | 0 to 20 | Me | 5 to 100 |

| | | | | | | | | | | |
|---|---|---|---|---|---|---|---|---|---|---|
| 87 | C═CCF₃ | (CH₂)ₐ | 0 to 20 | Me | Me | 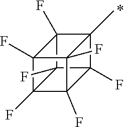 | (CH₂)ₐ | 0 to 20 | Me | 5 to 100 |
| 88 | CF₂CH₃ | (CH₂)ₐ | 0 to 20 | Me | Me | 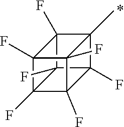 | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 78 | 0 | Me | Me | (CH₂)_{b} | 0 to 20 | C(═O)NHCH₂C | (CH₂)_{c} | 1 to 20 | Si(OMe)₃ | 3 |
| 79 | 0 | Me | Me | (CH₂)_{b} | 0 to 20 | C(═O)NHCH₂C | (CH₂)_{c} | 1 to 20 | Si(OMe)₃ | 3 |
| 80 | 0 | Me | Me | (CH₂)_{b} | 0 to 20 | C(═O)NHCH₂C | (CH₂)_{c} | 1 to 20 | Si(OMe)₃ | 3 |
| 81 | 0 | Me | Me | (CH₂)_{b} | 0 to 20 | C(═O)NHCH₂C | (CH₂)_{c} | 1 to 20 | Si(OMe)₃ | 3 |
| 82 | 0 | Me | Me | (CH₂)_{b} | 0 to 20 | C(═O)NHCH₂C | (CH₂)_{c} | 1 to 20 | Si(OMe)₃ | 3 |
| 83 | 0 | Me | Me | (CH₂)_{b} | 0 to 20 | C(═O)NHCH₂C | (CH₂)_{c} | 1 to 20 | Si(OMe)₃ | 3 |
| 84 | 0 | Me | Me | (CH₂)_{b} | 0 to 20 | C(═O)NHCH₂C | (CH₂)_{c} | 1 to 20 | Si(OMe)₃ | 3 |
| 85 | 0 | Me | Me | (CH₂)_{b} | 0 to 20 | C(═O)NHCH₂C | (CH₂)_{c} | 1 to 20 | Si(OMe)₃ | 3 |
| 86 | 0 | Me | Me | (CH₂)_{b} | 0 to 20 | C(═O)NHCH₂C | (CH₂)_{c} | 1 to 20 | Si(OMe)₃ | 3 |
| 87 | 0 | Me | Me | (CH₂)_{b} | 0 to 20 | C(═O)NHCH₂C | (CH₂)_{c} | 1 to 20 | Si(OMe)₃ | 3 |
| 88 | 0 | Me | Me | (CH₂)_{b} | 0 to 20 | C(═O)NHCH₂C | (CH₂)_{c} | 1 to 20 | Si(OMe)₃ | 3 |

TABLE 277

| No. | R²¹ | | a | R²² | R²³ | R²⁴ | | | R²⁵ | z21 |
|---|---|---|---|---|---|---|---|---|---|---|
| 89 | (CF₂)₂H | (CH₂)ₐ | 0 to 20 | Me | Me | 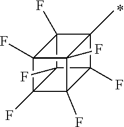 | (CH₂)ₐ | 0 to 20 | Me | 5 to 100 |
| 90 | (CF₂)₂CH₃ | (CH₂)ₐ | 0 to 20 | Me | Me | 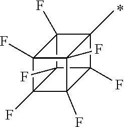 | (CH₂)ₐ | 0 to 20 | Me | 5 to 100 |
| 91 | (CF₂)₄H | (CH₂)ₐ | 0 to 20 | Me | Me | 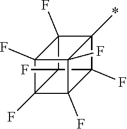 [SMILES: *C12C3(F)C4(F)C1(F)C1(F)C2(F)C3(F)C41F] | (CH₂)ₐ | 0 to 20 | Me | 5 to 100 |
| 92 | C₆F₅ | (CH₂)ₐ | 0 to 20 | Me | Me | 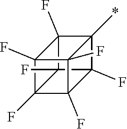 [SMILES: *C12C3(F)C4(F)C1(F)C1(F)C2(F)C3(F)C41F] | (CH₂)ₐ | 0 to 20 | Me | 5 to 100 |
| 93 | 4-CF₃C₆F₄ | (CH₂)ₐ | 0 to 20 | Me | Me | 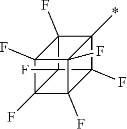 [SMILES: *C12C3(F)C4(F)C1(F)C1(F)C2(F)C3(F)C41F] | (CH₂)ₐ | 0 to 20 | Me | 5 to 100 |
| 94 | 4-SF₅C₆F₄ | (CH₂)ₐ | 0 to 20 | Me | Me | 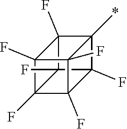 [SMILES: *C12C3(F)C4(F)C1(F)C1(F)C2(F)C3(F)C41F] | (CH₂)ₐ | 0 to 20 | Me | 5 to 100 |
| 95 | 3,5-CF₃C₆F₃ | (CH₂)ₐ | 0 to 20 | Me | Me | 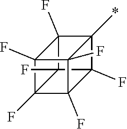 [SMILES: *C12C3(F)C4(F)C1(F)C1(F)C2(F)C3(F)C41F] | (CH₂)ₐ | 0 to 20 | Me | 5 to 100 |
| 96 | 3,5-SFC₆F₃ | (CH₂)ₐ | 0 to 20 | Me | Me | 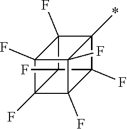 [SMILES: *C12C3(F)C4(F)C1(F)C1(F)C2(F)C3(F)C41F] | (CH₂)ₐ | 0 to 20 | Me | 5 to 100 |
| 97 | 4-CF₃C₆H₄ | (CH₂)ₐ | 0 to 20 | Me | Me | 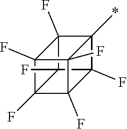 [SMILES: *C12C3(F)C4(F)C1(F)C1(F)C2(F)C3(F)C41F] | (CH₂)ₐ | 0 to 20 | Me | 5 to 100 |
| 98 | 4-SF₅C₆H₄ | (CH₂)ₐ | 0 to 20 | Me | Me | 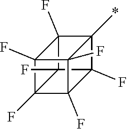 [SMILES: *C12C3(F)C4(F)C1(F)C1(F)C2(F)C3(F)C41F] | (CH₂)ₐ | 0 to 20 | Me | 5 to 100 |
| 99 | 3,5-CF₃C₆H₃ | (CH₂)ₐ | 0 to 20 | Me | Me | 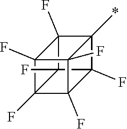 [SMILES: *C12C3(F)C4(F)C1(F)C1(F)C2(F)C3(F)C41F] | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 89 | 0 | Me | Me | (CH₂)_{b} | 0 to 20 | C(═O)NHCH₂C | (CH₂)_{c} | 1 to 20 | Si(OMe)₃ | 3 |
| 90 | 0 | Me | Me | (CH₂)_{b} | 0 to 20 | C(═O)NHCH₂C | (CH₂)_{c} | 1 to 20 | Si(OMe)₃ | 3 |
| 91 | 0 | Me | Me | (CH₂)_{b} | 0 to 20 | C(═O)NHCH₂C | (CH₂)_{c} | 1 to 20 | Si(OMe)₃ | 3 |
| 92 | 0 | Me | Me | (CH₂)_{b} | 0 to 20 | C(═O)NHCH₂C | (CH₂)_{c} | 1 to 20 | Si(OMe)₃ | 3 |
| 93 | 0 | Me | Me | (CH₂)_{b} | 0 to 20 | C(═O)NHCH₂C | (CH₂)_{c} | 1 to 20 | Si(OMe)₃ | 3 |
| 94 | 0 | Me | Me | (CH₂)_{b} | 0 to 20 | C(═O)NHCH₂C | (CH₂)_{c} | 1 to 20 | Si(OMe)₃ | 3 |
| 95 | 0 | Me | Me | (CH₂)_{b} | 0 to 20 | C(═O)NHCH₂C | (CH₂)_{c} | 1 to 20 | Si(OMe)₃ | 3 |
| 96 | 0 | Me | Me | (CH₂)_{b} | 0 to 20 | C(═O)NHCH₂C | (CH₂)_{c} | 1 to 20 | Si(OMe)₃ | 3 |
| 97 | 0 | Me | Me | (CH₂)_{b} | 0 to 20 | C(═O)NHCH₂C | (CH₂)_{c} | 1 to 20 | Si(OMe)₃ | 3 |
| 98 | 0 | Me | Me | (CH₂)_{b} | 0 to 20 | C(═O)NHCH₂C | (CH₂)_{c} | 1 to 20 | Si(OMe)₃ | 3 |
| 99 | 0 | Me | Me | (CH₂)_{b} | 0 to 20 | C(═O)NHCH₂C | (CH₂)_{c} | 1 to 20 | Si(OMe)₃ | 3 |

TABLE 278

| No. | R²¹ | | a | R²² | R²³ | R²⁴ | | |
|---|---|---|---|---|---|---|---|---|
| 100 | 3,5-SF₅C₆H₃ | (CH₂)ₐ | 0 to 20 | Me | Me | 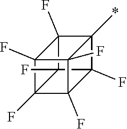 [SMILES: *C12C3(F)C4(F)C1(F)C1(F)C2(F)C3(F)C41F] | (CH₂)ₐ | 0 to 20 |
| 101 | 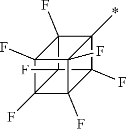 [SMILES: *C12C3(F)C4(F)C1(F)C1(F)C2(F)C3(F)C41F] | (CH₂)ₐ | 0 to 20 | Me | Me | 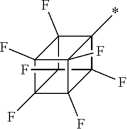 [SMILES: *C12C3(F)C4(F)C1(F)C1(F)C2(F)C3(F)C41F] | (CH₂)ₐ | 0 to 20 |
| 102 | 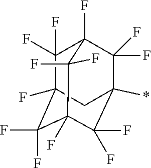 [SMILES: *C12CC3(F)C(F)(F)C(F)(C1(F)F)C(F)(F)C(F)(C2(F)F)C3(F)F] | (CH₂)ₐ | 0 to 20 | Me | Me | 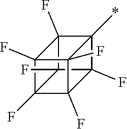 [SMILES: *C12C3(F)C4(F)C1(F)C1(F)C2(F)C3(F)C41F] | (CH₂)ₐ | 0 to 20 |
| 103 | 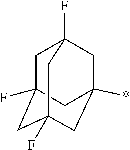 [SMILES: *C12CC3(F)CC(F)(C1)CC(F)(C2)C3] | (CH₂)ₐ | 0 to 20 | Me | Me | 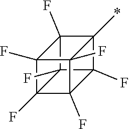 [SMILES: *C12C3(F)C4(F)C1(F)C1(F)C2(F)C3(F)C41F] | (CH₂)ₐ | 0 to 20 |
| 104 | SF₅ | (CH₂)ₐ | 0 to 20 | Me | Me | 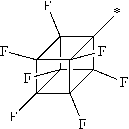 [SMILES: *C12C3(F)C4(F)C1(F)C1(F)C2(F)C3(F)C41F] | (CH₂)ₐ | 0 to 20 |
| 105 | OCF₃ | (CH₂)ₐ | 0 to 20 | Me | Me | 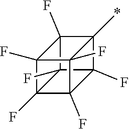 [SMILES: *C12C3(F)C4(F)C1(F)C1(F)C2(F)C3(F)C41F] | (CH₂)ₐ | 0 to 20 |
| 106 | SCF₃ | (CH₂)ₐ | 0 to 20 | Me | Me | 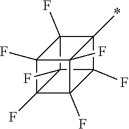 [SMILES: *C12C3(F)C4(F)C1(F)C1(F)C2(F)C3(F)C41F] | (CH₂)ₐ | 0 to 20 |
| 107 | N(CH₂CF₃)₂ | (CH₂)ₐ | 0 to 20 | Me | Me | 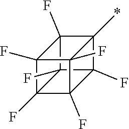 [SMILES: *C12C3(F)C4(F)C1(F)C1(F)C2(F)C3(F)C41F] | (CH₂)ₐ | 0 to 20 |
| 108 | N(CF₃)₂ | (CH₂)ₐ | 0 to 20 | Me | Me | 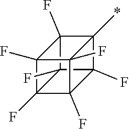 [SMILES: *C12C3(F)C4(F)C1(F)C1(F)C2(F)C3(F)C41F] | (CH₂)ₐ | 0 to 20 |
| 109 | Me | (CH₂)ₐ | 0 to 20 | Me | Me | SF₅ | (CH₂)ₐ | 0 to 20 |
| 110 | CF₃ | (CH₂)ₐ | 0 to 20 | Me | Me | SF₅ | (CH₂)ₐ | 0 to 20 |

| No. | R²⁵ | z21 | z22 | R²⁸ | R²⁹ | R¹ | b | L¹ | R² | c | T¹ | x1 |
|---|---|---|---|---|---|---|---|---|---|---|---|---|
| 100 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 101 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 102 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 103 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 104 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 105 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 106 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 107 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 108 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 109 | Me | 5 to 100 | 0 | Me | Me | (CH₂)_{b} | 0 to 20 | C(═O)NHCH₂C | (CH₂)_{c} | 1 to 20 | Si(OMe)₃ | 3 |
| 110 | Me | 5 to 100 | 0 | Me | Me | (CH₂)_{b} | 0 to 20 | C(═O)NHCH₂C | (CH₂)_{c} | 1 to 20 | Si(OMe)₃ | 3 |

TABLE 279

| No. | R²¹ | | a | R²² | R²³ | R²⁴ | | | R²⁵ | z21 | z22 |
|---|---|---|---|---|---|---|---|---|---|---|---|
| 111 | (CF₃)₂CF | (CH₂)ₐ | 0 to 20 | Me | Me | SF₅ | (CH₂)ₐ | 0 to 20 | Me | 5 to 100 | 0 |
| 112 | (CF₃)₃C | (CH₂)ₐ | 0 to 20 | Me | Me | SF₅ | (CH₂)ₐ | 0 to 20 | Me | 5 to 100 | 0 |
| 113 | C₄F₉ | (CH₂)ₐ | 0 to 20 | Me | Me | SF₅ | (CH₂)ₐ | 0 to 20 | Me | 5 to 100 | 0 |
| 114 | C₈F₁₇ | (CH₂)ₐ | 0 to 20 | Me | Me | SF₅ | (CH₂)ₐ | 0 to 20 | Me | 5 to 100 | 0 |
| 115 | c-C₆F₁₁ | (CH₂)ₐ | 0 to 20 | Me | Me | SF₅ | (CH₂)ₐ | 0 to 20 | Me | 5 to 100 | 0 |
| 116 | CHF₂ | (CH₂)ₐ | 0 to 20 | Me | Me | SF₅ | (CH₂)ₐ | 0 to 20 | Me | 5 to 100 | 0 |
| 117 | CCIF₂ | (CH₂)ₐ | 0 to 20 | Me | Me | SF₅ | (CH₂)ₐ | 0 to 20 | Me | 5 to 100 | 0 |
| 118 | CBrF₂ | (CH₂)ₐ | 0 to 20 | Me | Me | SF₅ | (CH₂)ₐ | 0 to 20 | Me | 5 to 100 | 0 |
| 119 | CIF₂ | (CH₂)ₐ | 0 to 20 | Me | Me | SF₅ | (CH₂)ₐ | 0 to 20 | Me | 5 to 100 | 0 |
| 120 | CF═CF₂ | (CH₂)ₐ | 0 to 20 | Me | Me | SF₅ | (CH₂)ₐ | 0 to 20 | Me | 5 to 100 | 0 |
| 121 | CF═CFCF₃ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 111 | Me | Me | (CH₂)_{b} | 0 to 20 | C(═O)NHCH₂C | (CH₂)_{c} | 1 to 20 | Si(OMe)₃ | 3 |
| 112 | Me | Me | (CH₂)_{b} | 0 to 20 | C(═O)NHCH₂C | (CH₂)_{c} | 1 to 20 | Si(OMe)₃ | 3 |
| 113 | Me | Me | (CH₂)_{b} | 0 to 20 | C(═O)NHCH₂C | (CH₂)_{c} | 1 to 20 | Si(OMe)₃ | 3 |
| 114 | Me | Me | (CH₂)_{b} | 0 to 20 | C(═O)NHCH₂C | (CH₂)_{c} | 1 to 20 | Si(OMe)₃ | 3 |
| 115 | Me | Me | (CH₂)_{b} | 0 to 20 | C(═O)NHCH₂C | (CH₂)_{c} | 1 to 20 | Si(OMe)₃ | 3 |
| 116 | Me | Me | (CH₂)_{b} | 0 to 20 | C(═O)NHCH₂C | (CH₂)_{c} | 1 to 20 | Si(OMe)₃ | 3 |
| 117 | Me | Me | (CH₂)_{b} | 0 to 20 | C(═O)NHCH₂C | (CH₂)_{c} | 1 to 20 | Si(OMe)₃ | 3 |
| 118 | Me | Me | (CH₂)_{b} | 0 to 20 | C(═O)NHCH₂C | (CH₂)_{c} | 1 to 20 | Si(OMe)₃ | 3 |
| 119 | Me | Me | (CH₂)_{b} | 0 to 20 | C(═O)NHCH₂C | (CH₂)_{c} | 1 to 20 | Si(OMe)₃ | 3 |
| 120 | Me | Me | (CH₂)_{b} | 0 to 20 | C(═O)NHCH₂C | (CH₂)_{c} | 1 to 20 | Si(OMe)₃ | 3 |
| 121 | Me | Me | (CH₂)_{b} | 0 to 20 | C(═O)NHCH₂C | (CH₂)_{c} | 1 to 20 | Si(OMe)₃ | 3 |

TABLE 280

| No. | R²¹ | | a | R²² | R²³ | R²⁴ | | | R²⁵ | z21 |
|---|---|---|---|---|---|---|---|---|---|---|
| 122 | CF═CFCF═CF₂ | (CH₂)ₐ | 0 to 20 | Me | Me | SF₅ | (CH₂)ₐ | 0 to 20 | Me | 5 to 100 |
| 123 | C═CCF₃ | (CH₂)ₐ | 0 to 20 | Me | Me | SF₅ | (CH₂)ₐ | 0 to 20 | Me | 5 to 100 |
| 124 | CF₂CH₃ | (CH₂)ₐ | 0 to 20 | Me | Me | SF₅ | (CH₂)ₐ | 0 to 20 | Me | 5 to 100 |
| 125 | (CF₂)₂H | (CH₂)ₐ | 0 to 20 | Me | Me | SF₅ | (CH₂)ₐ | 0 to 20 | Me | 5 to 100 |
| 126 | (CF₂)₂CH₃ | (CH₂)ₐ | 0 to 20 | Me | Me | SF₅ | (CH₂)ₐ | 0 to 20 | Me | 5 to 100 |
| 127 | (CF₂)₄H | (CH₂)ₐ | 0 to 20 | Me | Me | SF₅ | (CH₂)ₐ | 0 to 20 | Me | 5 to 100 |
| 128 | C₆F₅ | (CH₂)ₐ | 0 to 20 | Me | Me | SF₅ | (CH₂)ₐ | 0 to 20 | Me | 5 to 100 |
| 129 | 4-CF₃C₆F₄ | (CH₂)ₐ | 0 to 20 | Me | Me | SF₅ | (CH₂)ₐ | 0 to 20 | Me | 5 to 100 |
| 130 | 4-SF₅C₆F₄ | (CH₂)ₐ | 0 to 20 | Me | Me | SF₅ | (CH₂)ₐ | 0 to 20 | Me | 5 to 100 |
| 131 | 3,5-CF₃C₆F₃ | (CH₂)ₐ | 0 to 20 | Me | Me | SF₅ | (CH₂)ₐ | 0 to 20 | Me | 5 to 100 |
| 132 | 3,5-SF₅C₆F₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 122 | 0 | Me | Me | (CH₂)_{b} | 0 to 20 | C(═O)NHCH₂C | (CH₂)_{c} | 1 to 20 | Si(OMe)₃ | 3 |
| 123 | 0 | Me | Me | (CH₂)_{b} | 0 to 20 | C(═O)NHCH₂C | (CH₂)_{c} | 1 to 20 | Si(OMe)₃ | 3 |
| 124 | 0 | Me | Me | (CH₂)_{b} | 0 to 20 | C(═O)NHCH₂C | (CH₂)_{c} | 1 to 20 | Si(OMe)₃ | 3 |
| 125 | 0 | Me | Me | (CH₂)_{b} | 0 to 20 | C(═O)NHCH₂C | (CH₂)_{c} | 1 to 20 | Si(OMe)₃ | 3 |
| 126 | 0 | Me | Me | (CH₂)_{b} | 0 to 20 | C(═O)NHCH₂C | (CH₂)_{c} | 1 to 20 | Si(OMe)₃ | 3 |
| 127 | 0 | Me | Me | (CH₂)_{b} | 0 to 20 | C(═O)NHCH₂C | (CH₂)_{c} | 1 to 20 | Si(OMe)₃ | 3 |
| 128 | 0 | Me | Me | (CH₂)_{b} | 0 to 20 | C(═O)NHCH₂C | (CH₂)_{c} | 1 to 20 | Si(OMe)₃ | 3 |
| 129 | 0 | Me | Me | (CH₂)_{b} | 0 to 20 | C(═O)NHCH₂C | (CH₂)_{c} | 1 to 20 | Si(OMe)₃ | 3 |
| 130 | 0 | Me | Me | (CH₂)_{b} | 0 to 20 | C(═O)NHCH₂C | (CH₂)_{c} | 1 to 20 | Si(OMe)₃ | 3 |
| 131 | 0 | Me | Me | (CH₂)_{b} | 0 to 20 | C(═O)NHCH₂C | (CH₂)_{c} | 1 to 20 | Si(OMe)₃ | 3 |
| 132 | 0 | Me | Me | (CH₂)_{b} | 0 to 20 | C(═O)NHCH₂C | (CH₂)_{c} | 1 to 20 | Si(OMe)₃ | 3 |

TABLE 281

| No. | R²¹ | | a | R²² | R²³ | R²⁴ | | | R²⁵ | z21 |
|---|---|---|---|---|---|---|---|---|---|---|
| 133 | 4-CF₃C₆H₄ | (CH₂)ₐ | 0 to 20 | Me | Me | SF₅ | (CH₂)ₐ | 0 to 20 | Me | 5 to 100 |
| 134 | 4-SF₅C₆H₄ | (CH₂)ₐ | 0 to 20 | Me | Me | SF₅ | (CH₂)ₐ | 0 to 20 | Me | 5 to 100 |
| 135 | 3,5-CF₃C₆H₃ | (CH₂)ₐ | 0 to 20 | Me | Me | SF₅ | (CH₂)ₐ | 0 to 20 | Me | 5 to 100 |
| 136 | 3,5-SF₅C₆H₃ | (CH₂)ₐ | 0 to 20 | Me | Me | SF₅ | (CH₂)ₐ | 0 to 20 | Me | 5 to 100 |
| 137 | 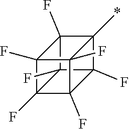 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 |
| 138 | 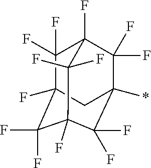 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 |
| 139 | 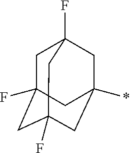 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 |
| 140 | SF₅ | (CH₂)ₐ | 0 to 20 | Me | Me | SF₅ | (CH₂)ₐ | 0 to 20 | Me | 5 to 100 |
| 141 | OCF₃ | (CH₂)ₐ | 0 to 20 | Me | Me | SF₅ | (CH₂)ₐ | 0 to 20 | Me | 5 to 100 |
| 142 | SCF₃ | (CH₂)ₐ | 0 to 20 | Me | Me | SF₅ | (CH₂)ₐ | 0 to 20 | Me | 5 to 100 |
| 143 | N(CH₂CF₃)₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 133 | 0 | Me | Me | (CH₂)_{b} | 0 to 20 | C(═O)NHCH₂C | (CH₂)_{c} | 1 to 20 | Si(OMe)₃ | 3 |
| 134 | 0 | Me | Me | (CH₂)_{b} | 0 to 20 | C(═O)NHCH₂C | (CH₂)_{c} | 1 to 20 | Si(OMe)₃ | 3 |
| 135 | 0 | Me | Me | (CH₂)_{b} | 0 to 20 | C(═O)NHCH₂C | (CH₂)_{c} | 1 to 20 | Si(OMe)₃ | 3 |
| 136 | 0 | Me | Me | (CH₂)_{b} | 0 to 20 | C(═O)NHCH₂C | (CH₂)_{c} | 1 to 20 | Si(OMe)₃ | 3 |
| 137 | 0 | Me | Me | (CH₂)_{b} | 0 to 20 | C(═O)NHCH₂C | (CH₂)_{c} | 1 to 20 | Si(OMe)₃ | 3 |
| 138 | 0 | Me | Me | (CH₂)_{b} | 0 to 20 | C(═O)NHCH₂C | (CH₂)_{c} | 1 to 20 | Si(OMe)₃ | 3 |
| 139 | 0 | Me | Me | (CH₂)_{b} | 0 to 20 | C(═O)NHCH₂C | (CH₂)_{c} | 1 to 20 | Si(OMe)₃ | 3 |
| 140 | 0 | Me | Me | (CH₂)_{b} | 0 to 20 | C(═O)NHCH₂C | (CH₂)_{c} | 1 to 20 | Si(OMe)₃ | 3 |
| 141 | 0 | Me | Me | (CH₂)_{b} | 0 to 20 | C(═O)NHCH₂C | (CH₂)_{c} | 1 to 20 | Si(OMe)₃ | 3 |
| 142 | 0 | Me | Me | (CH₂)_{b} | 0 to 20 | C(═O)NHCH₂C | (CH₂)_{c} | 1 to 20 | Si(OMe)₃ | 3 |
| 143 | 0 | Me | Me | (CH₂)_{b} | 0 to 20 | C(═O)NHCH₂C | (CH₂)_{c} | 1 to 20 | Si(OMe)₃ | 3 |

TABLE 282

| No. | R²¹ | | a | R²² | R²³ | R²⁴ | | | R²⁵ | z21 | z22 |
|---|---|---|---|---|---|---|---|---|---|---|---|
| 144 | N(CF₃)₂ | (CH₂)ₐ | 0 to 20 | Me | Me | SF₅ | (CH₂)ₐ | 0 to 20 | Me | 5 to 100 | 0 |
| 145 | Me | (CH₂)ₐ | 0 to 20 | Me | Me | OCF₃ | (CH₂)ₐ | 0 to 20 | Me | 5 to 100 | 0 |
| 146 | CF₃ | (CH₂)ₐ | 0 to 20 | Me | Me | OCF₃ | (CH₂)ₐ | 0 to 20 | Me | 5 to 100 | 0 |
| 147 | (CF₃)₂CF | (CH₂)ₐ | 0 to 20 | Me | Me | OCF₃ | (CH₂)ₐ | 0 to 20 | Me | 5 to 100 | 0 |
| 148 | (CF₃)₃C | (CH₂)ₐ | 0 to 20 | Me | Me | OCF₃ | (CH₂)ₐ | 0 to 20 | Me | 5 to 100 | 0 |
| 149 | C₄F₉ | (CH₂)ₐ | 0 to 20 | Me | Me | OCF₃ | (CH₂)ₐ | 0 to 20 | Me | 5 to 100 | 0 |
| 150 | C₈F₁₇ | (CH₂)ₐ | 0 to 20 | Me | Me | OCF₃ | (CH₂)ₐ | 0 to 20 | Me | 5 to 100 | 0 |
| 151 | c-C₆F₁₁ | (CH₂)ₐ | 0 to 20 | Me | Me | OCF₃ | (CH₂)ₐ | 0 to 20 | Me | 5 to 100 | 0 |
| 152 | CHF₂ | (CH₂)ₐ | 0 to 20 | Me | Me | OCF₃ | (CH₂)ₐ | 0 to 20 | Me | 5 to 100 | 0 |
| 153 | CCIF₂ | (CH₂)ₐ | 0 to 20 | Me | Me | OCF₃ | (CH₂)ₐ | 0 to 20 | Me | 5 to 100 | 0 |
| 154 | CBrF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 144 | Me | Me | (CH₂)_{b} | 0 to 20 | C(═O)NHCH₂C | (CH₂)_{c} | 1 to 20 | Si(OMe)₃ | 3 |
| 145 | Me | Me | (CH₂)_{b} | 0 to 20 | C(═O)NHCH₂C | (CH₂)_{c} | 1 to 20 | Si(OMe)₃ | 3 |
| 146 | Me | Me | (CH₂)_{b} | 0 to 20 | C(═O)NHCH₂C | (CH₂)_{c} | 1 to 20 | Si(OMe)₃ | 3 |
| 147 | Me | Me | (CH₂)_{b} | 0 to 20 | C(═O)NHCH₂C | (CH₂)_{c} | 1 to 20 | Si(OMe)₃ | 3 |
| 148 | Me | Me | (CH₂)_{b} | 0 to 20 | C(═O)NHCH₂C | (CH₂)_{c} | 1 to 20 | Si(OMe)₃ | 3 |
| 149 | Me | Me | (CH₂)_{b} | 0 to 20 | C(═O)NHCH₂C | (CH₂)_{c} | 1 to 20 | Si(OMe)₃ | 3 |
| 150 | Me | Me | (CH₂)_{b} | 0 to 20 | C(═O)NHCH₂C | (CH₂)_{c} | 1 to 20 | Si(OMe)₃ | 3 |
| 151 | Me | Me | (CH₂)_{b} | 0 to 20 | C(═O)NHCH₂C | (CH₂)_{c} | 1 to 20 | Si(OMe)₃ | 3 |
| 152 | Me | Me | (CH₂)_{b} | 0 to 20 | C(═O)NHCH₂C | (CH₂)_{c} | 1 to 20 | Si(OMe)₃ | 3 |
| 153 | Me | Me | (CH₂)_{b} | 0 to 20 | C(═O)NHCH₂C | (CH₂)_{c} | 1 to 20 | Si(OMe)₃ | 3 |
| 154 | Me | Me | (CH₂)_{b} | 0 to 20 | C(═O)NHCH₂C | (CH₂)_{c} | 1 to 20 | Si(OMe)₃ | 3 |

TABLE 283

| No. | R²¹ | | a | R²² | R²³ | R²⁴ | | | R²⁵ | z21 | z22 |
|---|---|---|---|---|---|---|---|---|---|---|---|
| 155 | CIF₂ | (CH₂)ₐ | 0 to 20 | Me | Me | OCF₃ | (CH₂)ₐ | 0 to 20 | Me | 5 to 100 | 0 |
| 156 | CF═CF₂ | (CH₂)ₐ | 0 to 20 | Me | Me | OCF₃ | (CH₂)ₐ | 0 to 20 | Me | 5 to 100 | 0 |
| 157 | CF═CFCF₃ | (CH₂)ₐ | 0 to 20 | Me | Me | OCF₃ | (CH₂)ₐ | 0 to 20 | Me | 5 to 100 | 0 |
| 158 | CF═CFCF═CF₂ | (CH₂)ₐ | 0 to 20 | Me | Me | OCF₃ | (CH₂)ₐ | 0 to 20 | Me | 5 to 100 | 0 |
| 159 | C═CCF₃ | (CH₂)ₐ | 0 to 20 | Me | Me | OCF₃ | (CH₂)ₐ | 0 to 20 | Me | 5 to 100 | 0 |
| 160 | CF₂CH₃ | (CH₂)ₐ | 0 to 20 | Me | Me | OCF₃ | (CH₂)ₐ | 0 to 20 | Me | 5 to 100 | 0 |
| 161 | (CF₂)₂H | (CH₂)ₐ | 0 to 20 | Me | Me | OCF₃ | (CH₂)ₐ | 0 to 20 | Me | 5 to 100 | 0 |
| 162 | (CF₂)₂CH₃ | (CH₂)ₐ | 0 to 20 | Me | Me | OCF₃ | (CH₂)ₐ | 0 to 20 | Me | 5 to 100 | 0 |
| 163 | (CF₂)₄H | (CH₂)ₐ | 0 to 20 | Me | Me | OCF₃ | (CH₂)ₐ | 0 to 20 | Me | 5 to 100 | 0 |
| 164 | C₆F₅ | (CH₂)ₐ | 0 to 20 | Me | Me | OCF₃ | (CH₂)ₐ | 0 to 20 | Me | 5 to 100 | 0 |
| 165 | 4-CF₃C₆F₄ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 155 | Me | Me | (CH₂)_{b} | 0 to 20 | C(═O)NHCH₂C | (CH₂)_{c} | 1 to 20 | Si(OMe)₃ | 3 |
| 156 | Me | Me | (CH₂)_{b} | 0 to 20 | C(═O)NHCH₂C | (CH₂)_{c} | 1 to 20 | Si(OMe)₃ | 3 |
| 157 | Me | Me | (CH₂)_{b} | 0 to 20 | C(═O)NHCH₂C | (CH₂)_{c} | 1 to 20 | Si(OMe)₃ | 3 |
| 158 | Me | Me | (CH₂)_{b} | 0 to 20 | C(═O)NHCH₂C | (CH₂)_{c} | 1 to 20 | Si(OMe)₃ | 3 |
| 159 | Me | Me | (CH₂)_{b} | 0 to 20 | C(═O)NHCH₂C | (CH₂)_{c} | 1 to 20 | Si(OMe)₃ | 3 |
| 160 | Me | Me | (CH₂)_{b} | 0 to 20 | C(═O)NHCH₂C | (CH₂)_{c} | 1 to 20 | Si(OMe)₃ | 3 |
| 161 | Me | Me | (CH₂)_{b} | 0 to 20 | C(═O)NHCH₂C | (CH₂)_{c} | 1 to 20 | Si(OMe)₃ | 3 |
| 162 | Me | Me | (CH₂)_{b} | 0 to 20 | C(═O)NHCH₂C | (CH₂)_{c} | 1 to 20 | Si(OMe)₃ | 3 |
| 163 | Me | Me | (CH₂)_{b} | 0 to 20 | C(═O)NHCH₂C | (CH₂)_{c} | 1 to 20 | Si(OMe)₃ | 3 |
| 164 | Me | Me | (CH₂)_{b} | 0 to 20 | C(═O)NHCH₂C | (CH₂)_{c} | 1 to 20 | Si(OMe)₃ | 3 |
| 165 | Me | Me | (CH₂)_{b} | 0 to 20 | C(═O)NHCH₂C | (CH₂)_{c} | 1 to 20 | Si(OMe)₃ | 3 |

TABLE 284

| No. | R²¹ | | a | R²² | R²³ | R²⁴ | | | R²⁵ | z21 |
|---|---|---|---|---|---|---|---|---|---|---|
| 166 | 4-SF₅C₆F₄ | (CH₂)ₐ | 0 to 20 | Me | Me | OCF₃ | (CH₂)ₐ | 0 to 20 | Me | 5 to 100 |
| 167 | 3,5-CF₃C₆F₃ | (CH₂)ₐ | 0 to 20 | Me | Me | OCF₃ | (CH₂)ₐ | 0 to 20 | Me | 5 to 100 |
| 168 | 3,5-SF₅C₆F₃ | (CH₂)ₐ | 0 to 20 | Me | Me | OCF₃ | (CH₂)ₐ | 0 to 20 | Me | 5 to 100 |
| 169 | 4-CF₃C₆H₄ | (CH₂)ₐ | 0 to 20 | Me | Me | OCF₃ | (CH₂)ₐ | 0 to 20 | Me | 5 to 100 |
| 170 | 4-SF₅C₆H₄ | (CH₂)ₐ | 0 to 20 | Me | Me | OCF₃ | (CH₂)ₐ | 0 to 20 | Me | 5 to 100 |
| 171 | 3,5-CF₃C₆H₃ | (CH₂)ₐ | 0 to 20 | Me | Me | OCF₃ | (CH₂)ₐ | 0 to 20 | Me | 5 to 100 |
| 172 | 3,5-SF₅C₆H₃ | (CH₂)ₐ | 0 to 20 | Me | Me | OCF₃ | (CH₂)ₐ | 0 to 20 | Me | 5 to 100 |
| 173 | 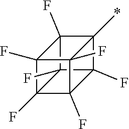 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 |
| 174 | 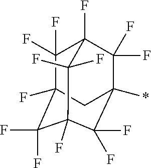 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 |
| 175 | 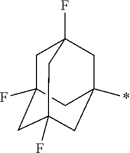 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 |
| 176 | SF₅ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | C | T¹ | ×1 |
|---|---|---|---|---|---|---|---|---|---|---|
| 166 | 0 | Me | Me | (CH₂)_{b} | 0 to 20 | C(═O)NHCH₂C | (CH₂)_{c} | 1 to 20 | Si(OMe)₃ | 3 |
| 167 | 0 | Me | Me | (CH₂)_{b} | 0 to 20 | C(═O)NHCH₂C | (CH₂)_{c} | 1 to 20 | Si(OMe)₃ | 3 |
| 168 | 0 | Me | Me | (CH₂)_{b} | 0 to 20 | C(═O)NHCH₂C | (CH₂)_{c} | 1 to 20 | Si(OMe)₃ | 3 |
| 169 | 0 | Me | Me | (CH₂)_{b} | 0 to 20 | C(═O)NHCH₂C | (CH₂)_{c} | 1 to 20 | Si(OMe)₃ | 3 |
| 170 | 0 | Me | Me | (CH₂)_{b} | 0 to 20 | C(═O)NHCH₂C | (CH₂)_{c} | 1 to 20 | Si(OMe)₃ | 3 |
| 171 | 0 | Me | Me | (CH₂)_{b} | 0 to 20 | C(═O)NHCH₂C | (CH₂)_{c} | 1 to 20 | Si(OMe)₃ | 3 |
| 172 | 0 | Me | Me | (CH₂)_{b} | 0 to 20 | C(═O)NHCH₂C | (CH₂)_{c} | 1 to 20 | Si(OMe)₃ | 3 |
| 173 | 0 | Me | Me | (CH₂)_{b} | 0 to 20 | C(═O)NHCH₂C | (CH₂)_{c} | 1 to 20 | Si(OMe)₃ | 3 |
| 174 | 0 | Me | Me | (CH₂)_{b} | 0 to 20 | C(═O)NHCH₂C | (CH₂)_{c} | 1 to 20 | Si(OMe)₃ | 3 |
| 175 | 0 | Me | Me | (CH₂)_{b} | 0 to 20 | C(═O)NHCH₂C | (CH₂)_{c} | 1 to 20 | Si(OMe)₃ | 3 |
| 176 | 0 | Me | Me | (CH₂)_{b} | 0 to 20 | C(═O)NHCH₂C | (CH₂)_{c} | 1 to 20 | Si(OMe)₃ | 3 |

TABLE 285

| No. | R²¹ | | a | R²² | R²³ | R²⁴ | | | R²⁵ | z21 | z22 |
|---|---|---|---|---|---|---|---|---|---|---|---|
| 177 | OCF₃ | (CH₂)ₐ | 0 to 20 | Me | Me | OCF₃ | (CH₂)ₐ | 0 to 20 | Me | 5 to 100 | 0 |
| 178 | SCF₃ | (CH₂)ₐ | 0 to 20 | Me | Me | OCF₃ | (CH₂)ₐ | 0 to 20 | Me | 5 to 100 | 0 |
| 179 | N(CH₂CF₃)₂ | (CH₂)ₐ | 0 to 20 | Me | Me | OCF₃ | (CH₂)ₐ | 0 to 20 | Me | 5 to 100 | 0 |
| 180 | N(CF₃)₂ | (CH₂)ₐ | 0 to 20 | Me | Me | OCF₃ | (CH₂)ₐ | 0 to 20 | Me | 5 to 100 | 0 |
| 181 | Me | (CH₂)ₐ | 0 to 20 | Me | Me | SCF₃ | (CH₂)ₐ | 0 to 20 | Me | 5 to 100 | 0 |
| 182 | CF₃ | (CH₂)ₐ | 0 to 20 | Me | Me | SCF₃ | (CH₂)ₐ | 0 to 20 | Me | 5 to 100 | 0 |
| 183 | (CF₃)₂CF | (CH₂)ₐ | 0 to 20 | Me | Me | SCF₃ | (CH₂)ₐ | 0 to 20 | Me | 5 to 100 | 0 |
| 184 | (CF₃)₃C | (CH₂)ₐ | 0 to 20 | Me | Me | SCF₃ | (CH₂)ₐ | 0 to 20 | Me | 5 to 100 | 0 |
| 185 | C₄F₉ | (CH₂)ₐ | 0 to 20 | Me | Me | SCF₃ | (CH₂)ₐ | 0 to 20 | Me | 5 to 100 | 0 |
| 186 | C₈F₁₇ | (CH₂)ₐ | 0 to 20 | Me | Me | SCF₃ | (CH₂)ₐ | 0 to 20 | Me | 5 to 100 | 0 |
| 187 | c-C₆F₁₁ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 177 | Me | Me | (CH₂)_{b} | 0 to 20 | C(═O)NHCH₂C | (CH₂)_{c} | 1 to 20 | Si(OMe)₃ | 3 |
| 178 | Me | Me | (CH₂)_{b} | 0 to 20 | C(═O)NHCH₂C | (CH₂)_{c} | 1 to 20 | Si(OMe)₃ | 3 |
| 179 | Me | Me | (CH₂)_{b} | 0 to 20 | C(═O)NHCH₂C | (CH₂)_{c} | 1 to 20 | Si(OMe)₃ | 3 |
| 180 | Me | Me | (CH₂)_{b} | 0 to 20 | C(═O)NHCH₂C | (CH₂)_{c} | 1 to 20 | Si(OMe)₃ | 3 |
| 181 | Me | Me | (CH₂)_{b} | 0 to 20 | C(═O)NHCH₂C | (CH₂)_{c} | 1 to 20 | Si(OMe)₃ | 3 |
| 182 | Me | Me | (CH₂)_{b} | 0 to 20 | C(═O)NHCH₂C | (CH₂)_{c} | 1 to 20 | Si(OMe)₃ | 3 |
| 183 | Me | Me | (CH₂)_{b} | 0 to 20 | C(═O)NHCH₂C | (CH₂)_{c} | 1 to 20 | Si(OMe)₃ | 3 |
| 184 | Me | Me | (CH₂)_{b} | 0 to 20 | C(═O)NHCH₂C | (CH₂)_{c} | 1 to 20 | Si(OMe)₃ | 3 |
| 185 | Me | Me | (CH₂)_{b} | 0 to 20 | C(═O)NHCH₂C | (CH₂)_{c} | 1 to 20 | Si(OMe)₃ | 3 |
| 186 | Me | Me | (CH₂)_{b} | 0 to 20 | C(═O)NHCH₂C | (CH₂)_{c} | 1 to 20 | Si(OMe)₃ | 3 |
| 187 | Me | Me | (CH₂)_{b} | 0 to 20 | C(═O)NHCH₂C | (CH₂)_{c} | 1 to 20 | Si(OMe)₃ | 3 |

TABLE 286

| No. | R²¹ | | a | R²² | R²³ | R²⁴ | | | R²⁵ | z21 | z22 |
|---|---|---|---|---|---|---|---|---|---|---|---|
| 188 | CHF₂ | (CH₂)ₐ | 0 to 20 | Me | Me | SCF₃ | (CH₂)ₐ | 0 to 20 | Me | 5 to 100 | 0 |
| 189 | CCIF₂ | (CH₂)ₐ | 0 to 20 | Me | Me | SCF₃ | (CH₂)ₐ | 0 to 20 | Me | 5 to 100 | 0 |
| 190 | CBrF₂ | (CH₂)ₐ | 0 to 20 | Me | Me | SCF₃ | (CH₂)ₐ | 0 to 20 | Me | 5 to 100 | 0 |
| 191 | CIF₂ | (CH₂)ₐ | 0 to 20 | Me | Me | SCF₃ | (CH₂)ₐ | 0 to 20 | Me | 5 to 100 | 0 |
| 192 | CF═CF₂ | (CH₂)ₐ | 0 to 20 | Me | Me | SCF₃ | (CH₂)ₐ | 0 to 20 | Me | 5 to 100 | 0 |
| 193 | CF═CFCF₃ | (CH₂)ₐ | 0 to 20 | Me | Me | SCF₃ | (CH₂)ₐ | 0 to 20 | Me | 5 to 100 | 0 |
| 194 | CF═CFCF═CF₂ | (CH₂)ₐ | 0 to 20 | Me | Me | SCF₃ | (CH₂)ₐ | 0 to 20 | Me | 5 to 100 | 0 |
| 195 | C═CCF₃ | (CH₂)ₐ | 0 to 20 | Me | Me | SCF₃ | (CH₂)ₐ | 0 to 20 | Me | 5 to 100 | 0 |
| 196 | CF₂CH₃ | (CH₂)ₐ | 0 to 20 | Me | Me | SCF₃ | (CH₂)ₐ | 0 to 20 | Me | 5 to 100 | 0 |
| 197 | (CF₂)₂H | (CH₂)ₐ | 0 to 20 | Me | Me | SCF₃ | (CH₂)ₐ | 0 to 20 | Me | 5 to 100 | 0 |
| 198 | (CF₂)₂CH₃ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 188 | Me | Me | (CH₂)_{b} | 0 to 20 | C(═O)NHCH₂C | (CH₂)_{c} | 1 to 20 | Si(OMe)₃ | 3 |
| 189 | Me | Me | (CH₂)_{b} | 0 to 20 | C(═O)NHCH₂C | (CH₂)_{c} | 1 to 20 | Si(OMe)₃ | 3 |
| 190 | Me | Me | (CH₂)_{b} | 0 to 20 | C(═O)NHCH₂C | (CH₂)_{c} | 1 to 20 | Si(OMe)₃ | 3 |
| 191 | Me | Me | (CH₂)_{b} | 0 to 20 | C(═O)NHCH₂C | (CH₂)_{c} | 1 to 20 | Si(OMe)₃ | 3 |
| 192 | Me | Me | (CH₂)_{b} | 0 to 20 | C(═O)NHCH₂C | (CH₂)_{c} | 1 to 20 | Si(OMe)₃ | 3 |
| 193 | Me | Me | (CH₂)_{b} | 0 to 20 | C(═O)NHCH₂C | (CH₂)_{c} | 1 to 20 | Si(OMe)₃ | 3 |
| 194 | Me | Me | (CH₂)_{b} | 0 to 20 | C(═O)NHCH₂C | (CH₂)_{c} | 1 to 20 | Si(OMe)₃ | 3 |
| 195 | Me | Me | (CH₂)_{b} | 0 to 20 | C(═O)NHCH₂C | (CH₂)_{c} | 1 to 20 | Si(OMe)₃ | 3 |
| 196 | Me | Me | (CH₂)_{b} | 0 to 20 | C(═O)NHCH₂C | (CH₂)_{c} | 1 to 20 | Si(OMe)₃ | 3 |
| 197 | Me | Me | (CH₂)_{b} | 0 to 20 | C(═O)NHCH₂C | (CH₂)_{c} | 1 to 20 | Si(OMe)₃ | 3 |
| 198 | Me | Me | (CH₂)_{b} | 0 to 20 | C(═O)NHCH₂C | (CH₂)_{c} | 1 to 20 | Si(OMe)₃ | 3 |

TABLE 287

| No. | R²¹ | | a | R²² | R²³ | R²⁴ | | | R²⁵ | z21 |
|---|---|---|---|---|---|---|---|---|---|---|
| 199 | (CF₂)₄H | (CH₂)ₐ | 0 to 20 | Me | Me | SCF₃ | (CH₂)ₐ | 0 to 20 | Me | 5 to 100 |
| 200 | C₆F₅ | (CH₂)ₐ | 0 to 20 | Me | Me | SCF₃ | (CH₂)ₐ | 0 to 20 | Me | 5 to 100 |
| 201 | 4-CF₃C₆F₄ | (CH₂)ₐ | 0 to 20 | Me | Me | SCF₃ | (CH₂)ₐ | 0 to 20 | Me | 5 to 100 |
| 202 | 4-SF₅C₆F₄ | (CH₂)ₐ | 0 to 20 | Me | Me | SCF₃ | (CH₂)ₐ | 0 to 20 | Me | 5 to 100 |
| 203 | 3,5-CF₃C₆F₃ | (CH₂)ₐ | 0 to 20 | Me | Me | SCF₃ | (CH₂)ₐ | 0 to 20 | Me | 5 to 100 |
| 204 | 3,5-SF₅C₆F₃ | (CH₂)ₐ | 0 to 20 | Me | Me | SCF₃ | (CH₂)ₐ | 0 to 20 | Me | 5 to 100 |
| 205 | 4-CF₃C₆H₄ | (CH₂)ₐ | 0 to 20 | Me | Me | SCF₃ | (CH₂)ₐ | 0 to 20 | Me | 5 to 100 |
| 206 | 4-SF₅C₆H₄ | (CH₂)ₐ | 0 to 20 | Me | Me | SCF₃ | (CH₂)ₐ | 0 to 20 | Me | 5 to 100 |
| 207 | 3,5-CF₃C₆H₃ | (CH₂)ₐ | 0 to 20 | Me | Me | SCF₃ | (CH₂)ₐ | 0 to 20 | Me | 5 to 100 |
| 208 | 3,5-SF₅C₆H₃ | (CH₂)ₐ | 0 to 20 | Me | Me | SCF₃ | (CH₂)ₐ | 0 to 20 | Me | 5 to 100 |
| 209 | 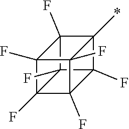 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 199 | 0 | Me | Me | (CH₂)_{b} | 0 to 20 | C(═O)NHCH₂C | (CH₂)_{c} | 1 to 20 | Si(OMe)₃ | 3 |
| 200 | 0 | Me | Me | (CH₂)_{b} | 0 to 20 | C(═O)NHCH₂C | (CH₂)_{c} | 1 to 20 | Si(OMe)₃ | 3 |
| 201 | 0 | Me | Me | (CH₂)_{b} | 0 to 20 | C(═O)NHCH₂C | (CH₂)_{c} | 1 to 20 | Si(OMe)₃ | 3 |
| 202 | 0 | Me | Me | (CH₂)_{b} | 0 to 20 | C(═O)NHCH₂C | (CH₂)_{c} | 1 to 20 | Si(OMe)₃ | 3 |
| 203 | 0 | Me | Me | (CH₂)_{b} | 0 to 20 | C(═O)NHCH₂C | (CH₂)_{c} | 1 to 20 | Si(OMe)₃ | 3 |
| 204 | 0 | Me | Me | (CH₂)_{b} | 0 to 20 | C(═O)NHCH₂C | (CH₂)_{c} | 1 to 20 | Si(OMe)₃ | 3 |
| 205 | 0 | Me | Me | (CH₂)_{b} | 0 to 20 | C(═O)NHCH₂C | (CH₂)_{c} | 1 to 20 | Si(OMe)₃ | 3 |
| 206 | 0 | Me | Me | (CH₂)_{b} | 0 to 20 | C(═O)NHCH₂C | (CH₂)_{c} | 1 to 20 | Si(OMe)₃ | 3 |
| 207 | 0 | Me | Me | (CH₂)_{b} | 0 to 20 | C(═O)NHCH₂C | (CH₂)_{c} | 1 to 20 | Si(OMe)₃ | 3 |
| 208 | 0 | Me | Me | (CH₂)_{b} | 0 to 20 | C(═O)NHCH₂C | (CH₂)_{c} | 1 to 20 | Si(OMe)₃ | 3 |
| 209 | 0 | Me | Me | (CH₂)_{b} | 0 to 20 | C(═O)NHCH₂C | (CH₂)_{c} | 1 to 20 | Si(OMe)₃ | 3 |

TABLE 288

| No. | R²¹ | | a | R²² | R²³ | R²⁴ | | | R²⁵ | z21 |
|---|---|---|---|---|---|---|---|---|---|---|
| 210 | 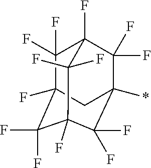 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 |
| 211 | 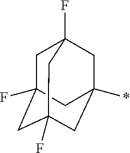 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 |
| 212 | SF₅ | (CH₂)ₐ | 0 to 20 | Me | Me | SCF₃ | (CH₂)ₐ | 0 to 20 | Me | 5 to 100 |
| 213 | OCF₃ | (CH₂)ₐ | 0 to 20 | Me | Me | SCF₃ | (CH₂)ₐ | 0 to 20 | Me | 5 to 100 |
| 214 | SCF₃ | (CH₂)ₐ | 0 to 20 | Me | Me | SCF₃ | (CH₂)ₐ | 0 to 20 | Me | 5 to 100 |
| 215 | N(CH₂CF₃)₂ | (CH₂)ₐ | 0 to 20 | Me | Me | SCF₃ | (CH₂)ₐ | 0 to 20 | Me | 5 to 100 |
| 216 | N(CF₃)₂ | (CH₂)ₐ | 0 to 20 | Me | Me | SCF₃ | (CH₂)ₐ | 0 to 20 | Me | 5 to 100 |
| 217 | Me | (CH₂)ₐ | 0 to 20 | Me | Me | N(CF₃)₂ | (CH₂)ₐ | 0 to 20 | Me | 5 to 100 |
| 218 | CF₃ | (CH₂)ₐ | 0 to 20 | Me | Me | N(CF₃)₂ | (CH₂)ₐ | 0 to 20 | Me | 5 to 100 |
| 219 | (CF₃)₂CF | (CH₂)ₐ | 0 to 20 | Me | Me | N(CF₃)₂ | (CH₂)ₐ | 0 to 20 | Me | 5 to 100 |
| 220 | (CF₃)₃C | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | ×1 |
|---|---|---|---|---|---|---|---|---|---|---|
| 210 | 0 | Me | Me | (CH₂)_{b} | 0 to 20 | C(═O)NHCH₂C | (CH₂)_{c} | 1 to 20 | Si(OMe)₃ | 3 |
| 211 | 0 | Me | Me | (CH₂)_{b} | 0 to 20 | C(═O)NHCH₂C | (CH₂)_{c} | 1 to 20 | Si(OMe)₃ | 3 |
| 212 | 0 | Me | Me | (CH₂)_{b} | 0 to 20 | C(═O)NHCH₂C | (CH₂)_{c} | 1 to 20 | Si(OMe)₃ | 3 |
| 213 | 0 | Me | Me | (CH₂)_{b} | 0 to 20 | C(═O)NHCH₂C | (CH₂)_{c} | 1 to 20 | Si(OMe)₃ | 3 |
| 214 | 0 | Me | Me | (CH₂)_{b} | 0 to 20 | C(═O)NHCH₂C | (CH₂)_{c} | 1 to 20 | Si(OMe)₃ | 3 |
| 215 | 0 | Me | Me | (CH₂)_{b} | 0 to 20 | C(═O)NHCH₂C | (CH₂)_{c} | 1 to 20 | Si(OMe)₃ | 3 |
| 216 | 0 | Me | Me | (CH₂)_{b} | 0 to 20 | C(═O)NHCH₂C | (CH₂)_{c} | 1 to 20 | Si(OMe)₃ | 3 |
| 217 | 0 | Me | Me | (CH₂)_{b} | 0 to 20 | C(═O)NHCH₂C | (CH₂)_{c} | 1 to 20 | Si(OMe)₃ | 3 |
| 218 | 0 | Me | Me | (CH₂)_{b} | 0 to 20 | C(═O)NHCH₂C | (CH₂)_{c} | 1 to 20 | Si(OMe)₃ | 3 |
| 219 | 0 | Me | Me | (CH₂)_{b} | 0 to 20 | C(═O)NHCH₂C | (CH₂)_{c} | 1 to 20 | Si(OMe)₃ | 3 |
| 220 | 0 | Me | Me | (CH₂)_{b} | 0 to 20 | C(═O)NHCH₂C | (CH₂)_{c} | 1 to 20 | Si(OMe)₃ | 3 |

TABLE 289

| No. | R²¹ | | a | R²² | R²³ | R²⁴ | | | R²⁵ | z21 | z22 |
|---|---|---|---|---|---|---|---|---|---|---|---|
| 221 | C₄F₉ | (CH₂)ₐ | 0 to 20 | Me | Me | N(CF₃)₂ | (CH₂)ₐ | 0 to 20 | Me | 5 to 100 | 0 |
| 222 | C₈F₁₇ | (CH₂)ₐ | 0 to 20 | Me | Me | N(CF₃)₂ | (CH₂)ₐ | 0 to 20 | Me | 5 to 100 | 0 |
| 223 | c-C₆F₁₁ | (CH₂)ₐ | 0 to 20 | Me | Me | N(CF₃)₂ | (CH₂)ₐ | 0 to 20 | Me | 5 to 100 | 0 |
| 224 | CHF₂ | (CH₂)ₐ | 0 to 20 | Me | Me | N(CF₃)₂ | (CH₂)ₐ | 0 to 20 | Me | 5 to 100 | 0 |
| 225 | CCIF₂ | (CH₂)ₐ | 0 to 20 | Me | Me | N(CF₃)₂ | (CH₂)ₐ | 0 to 20 | Me | 5 to 100 | 0 |
| 226 | CBrF₂ | (CH₂)ₐ | 0 to 20 | Me | Me | N(CF₃)₂ | (CH₂)ₐ | 0 to 20 | Me | 5 to 100 | 0 |
| 227 | CIF₂ | (CH₂)ₐ | 0 to 20 | Me | Me | N(CF₃)₂ | (CH₂)ₐ | 0 to 20 | Me | 5 to 100 | 0 |
| 228 | CF═CF₂ | (CH₂)ₐ | 0 to 20 | Me | Me | N(CF₃)₂ | (CH₂)ₐ | 0 to 20 | Me | 5 to 100 | 0 |
| 229 | CF═CFCF₃ | (CH₂)ₐ | 0 to 20 | Me | Me | N(CF₃)₂ | (CH₂)ₐ | 0 to 20 | Me | 5 to 100 | 0 |
| 230 | CF═CFCF═CF₂ | (CH₂)ₐ | 0 to 20 | Me | Me | N(CF₃)₂ | (CH₂)ₐ | 0 to 20 | Me | 5 to 100 | 0 |
| 231 | C═CCF₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 221 | Me | Me | (CH₂)_{b} | 0 to 20 | C(═O)NHCH₂C | (CH₂)_{c} | 1 to 20 | Si(OMe)₃ | 3 |
| 222 | Me | Me | (CH₂)_{b} | 0 to 20 | C(═O)NHCH₂C | (CH₂)_{c} | 1 to 20 | Si(OMe)₃ | 3 |
| 223 | Me | Me | (CH₂)_{b} | 0 to 20 | C(═O)NHCH₂C | (CH₂)_{c} | 1 to 20 | Si(OMe)₃ | 3 |
| 224 | Me | Me | (CH₂)_{b} | 0 to 20 | C(═O)NHCH₂C | (CH₂)_{c} | 1 to 20 | Si(OMe)₃ | 3 |
| 225 | Me | Me | (CH₂)_{b} | 0 to 20 | C(═O)NHCH₂C | (CH₂)_{c} | 1 to 20 | Si(OMe)₃ | 3 |
| 226 | Me | Me | (CH₂)_{b} | 0 to 20 | C(═O)NHCH₂C | (CH₂)_{c} | 1 to 20 | Si(OMe)₃ | 3 |
| 227 | Me | Me | (CH₂)_{b} | 0 to 20 | C(═O)NHCH₂C | (CH₂)_{c} | 1 to 20 | Si(OMe)₃ | 3 |
| 228 | Me | Me | (CH₂)_{b} | 0 to 20 | C(═O)NHCH₂C | (CH₂)_{c} | 1 to 20 | Si(OMe)₃ | 3 |
| 229 | Me | Me | (CH₂)_{b} | 0 to 20 | C(═O)NHCH₂C | (CH₂)_{c} | 1 to 20 | Si(OMe)₃ | 3 |
| 230 | Me | Me | (CH₂)_{b} | 0 to 20 | C(═O)NHCH₂C | (CH₂)_{c} | 1 to 20 | Si(OMe)₃ | 3 |
| 231 | Me | Me | (CH₂)_{b} | 0 to 20 | C(═O)NHCH₂C | (CH₂)_{c} | 1 to 20 | Si(OMe)₃ | 3 |

TABLE 290

| No. | R²¹ | | a | R²² | R²³ | R²⁴ | | | R²⁵ | z21 | z22 |
|---|---|---|---|---|---|---|---|---|---|---|---|
| 232 | CF₂CH₃ | (CH₂)ₐ | 0 to 20 | Me | Me | N(CF₃)₂ | (CH₂)ₐ | 0 to 20 | Me | 5 to 100 | 0 |
| 233 | (CF₂)₂H | (CH₂)ₐ | 0 to 20 | Me | Me | N(CF₃)₂ | (CH₂)ₐ | 0 to 20 | Me | 5 to 100 | 0 |
| 234 | (CF₂)₂CH₃ | (CH₂)ₐ | 0 to 20 | Me | Me | N(CF₃)₂ | (CH₂)ₐ | 0 to 20 | Me | 5 to 100 | 0 |
| 235 | (CF₂)₄H | (CH₂)ₐ | 0 to 20 | Me | Me | SCF₃ | (CH₂)ₐ | 0 to 20 | Me | 5 to 100 | 0 |
| 236 | C₆F₅ | (CH₂)ₐ | 0 to 20 | Me | Me | N(CF₃)₂ | (CH₂)ₐ | 0 to 20 | Me | 5 to 100 | 0 |
| 237 | 4-CF₃C₆F₄ | (CH₂)ₐ | 0 to 20 | Me | Me | N(CF₃)₂ | (CH₂)ₐ | 0 to 20 | Me | 5 to 100 | 0 |
| 238 | 4-SF₅C₆F₄ | (CH₂)ₐ | 0 to 20 | Me | Me | N(CF₃)₂ | (CH₂)ₐ | 0 to 20 | Me | 5 to 100 | 0 |
| 239 | 3,5-CF₃C₆F₃ | (CH₂)ₐ | 0 to 20 | Me | Me | N(CF₃)₂ | (CH₂)ₐ | 0 to 20 | Me | 5 to 100 | 0 |
| 240 | 3,5-SF₅C₆F₃ | (CH₂)ₐ | 0 to 20 | Me | Me | N(CF₃)₂ | (CH₂)ₐ | 0 to 20 | Me | 5 to 100 | 0 |
| 241 | 4-CF₃C₆H₄ | (CH₂)ₐ | 0 to 20 | Me | Me | N(CF₃)₂ | (CH₂)ₐ | 0 to 20 | Me | 5 to 100 | 0 |
| 242 | 4-SF₅C₆H₄ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 232 | Me | Me | (CH₂)_{b} | 0 to 20 | C(═O)NHCH₂C | (CH₂)_{c} | 1 to 20 | Si(OMe)₃ | 3 |
| 233 | Me | Me | (CH₂)_{b} | 0 to 20 | C(═O)NHCH₂C | (CH₂)_{c} | 1 to 20 | Si(OMe)₃ | 3 |
| 234 | Me | Me | (CH₂)_{b} | 0 to 20 | C(═O)NHCH₂C | (CH₂)_{c} | 1 to 20 | Si(OMe)₃ | 3 |
| 235 | Me | Me | (CH₂)_{b} | 0 to 20 | C(═O)NHCH₂C | (CH₂)_{c} | 1 to 20 | Si(OMe)₃ | 3 |
| 236 | Me | Me | (CH₂)_{b} | 0 to 20 | C(═O)NHCH₂C | (CH₂)_{c} | 1 to 20 | Si(OMe)₃ | 3 |
| 237 | Me | Me | (CH₂)_{b} | 0 to 20 | C(═O)NHCH₂C | (CH₂)_{c} | 1 to 20 | Si(OMe)₃ | 3 |
| 238 | Me | Me | (CH₂)_{b} | 0 to 20 | C(═O)NHCH₂C | (CH₂)_{c} | 1 to 20 | Si(OMe)₃ | 3 |
| 239 | Me | Me | (CH₂)_{b} | 0 to 20 | C(═O)NHCH₂C | (CH₂)_{c} | 1 to 20 | Si(OMe)₃ | 3 |
| 240 | Me | Me | (CH₂)_{b} | 0 to 20 | C(═O)NHCH₂C | (CH₂)_{c} | 1 to 20 | Si(OMe)₃ | 3 |
| 241 | Me | Me | (CH₂)_{b} | 0 to 20 | C(═O)NHCH₂C | (CH₂)_{c} | 1 to 20 | Si(OMe)₃ | 3 |
| 242 | Me | Me | (CH₂)_{b} | 0 to 20 | C(═O)NHCH₂C | (CH₂)_{c} | 1 to 20 | Si(OMe)₃ | 3 |

TABLE 291

| No. | R²¹ | | a | R²² | R²³ | R²⁴ | | | R²⁵ | z21 |
|---|---|---|---|---|---|---|---|---|---|---|
| 243 | 3,5-CF₃C₆H₃ | (CH₂)ₐ | 0 to 20 | Me | Me | N(CF₃)₂ | (CH₂)ₐ | 0 to 20 | Me | 5 to 100 |
| 244 | 3,5-SF₅C₆H₃ | (CH₂)ₐ | 0 to 20 | Me | Me | N(CF₃)₂ | (CH₂)ₐ | 0 to 20 | Me | 5 to 100 |
| 245 | 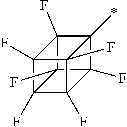 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 |
| 246 | 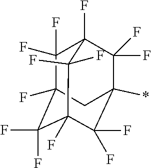 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 |
| 247 | 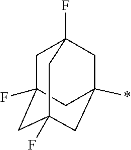 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 |
| 248 | SF₅ | (CH₂)ₐ | 0 to 20 | Me | Me | N(CF₃)₂ | (CH₂)ₐ | 0 to 20 | Me | 5 to 100 |
| 249 | OCF₃ | (CH₂)ₐ | 0 to 20 | Me | Me | N(CF₃)₂ | (CH₂)ₐ | 0 to 20 | Me | 5 to 100 |
| 250 | SCF₃ | (CH₂)ₐ | 0 to 20 | Me | Me | N(CF₃)₂ | (CH₂)ₐ | 0 to 20 | Me | 5 to 100 |
| 251 | N(CH₂CF₃)₂ | (CH₂)ₐ | 0 to 20 | Me | Me | N(CF₃)₂ | (CH₂)ₐ | 0 to 20 | Me | 5 to 100 |
| 252 | N(CF₃)₂ | (CH₂)ₐ | 0 to 20 | Me | Me | N(CF₃)₂ | (CH₂)ₐ | 0 to 20 | Me | 5 to 100 |
| 253 | Me | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 243 | 0 | Me | Me | (CH₂)_{b} | 0 to 20 | C(═O)NHCH₂C | (CH₂)_{c} | 1 to 20 | Si(OMe)₃ | 3 |
| 244 | 0 | Me | Me | (CH₂)_{b} | 0 to 20 | C(═O)NHCH₂C | (CH₂)_{c} | 1 to 20 | Si(OMe)₃ | 3 |
| 245 | 0 | Me | Me | (CH₂)_{b} | 0 to 20 | C(═O)NHCH₂C | (CH₂)_{c} | 1 to 20 | Si(OMe)₃ | 3 |
| 246 | 0 | Me | Me | (CH₂)_{b} | 0 to 20 | C(═O)NHCH₂C | (CH₂)_{c} | 1 to 20 | Si(OMe)₃ | 3 |
| 247 | 0 | Me | Me | (CH₂)_{b} | 0 to 20 | C(═O)NHCH₂C | (CH₂)_{c} | 1 to 20 | Si(OMe)₃ | 3 |
| 248 | 0 | Me | Me | (CH₂)_{b} | 0 to 20 | C(═O)NHCH₂C | (CH₂)_{c} | 1 to 20 | Si(OMe)₃ | 3 |
| 249 | 0 | Me | Me | (CH₂)_{b} | 0 to 20 | C(═O)NHCH₂C | (CH₂)_{c} | 1 to 20 | Si(OMe)₃ | 3 |
| 250 | 0 | Me | Me | (CH₂)_{b} | 0 to 20 | C(═O)NHCH₂C | (CH₂)_{c} | 1 to 20 | Si(OMe)₃ | 3 |
| 251 | 0 | Me | Me | (CH₂)_{b} | 0 to 20 | C(═O)NHCH₂C | (CH₂)_{c} | 1 to 20 | Si(OMe)₃ | 3 |
| 252 | 0 | Me | Me | (CH₂)_{b} | 0 to 20 | C(═O)NHCH₂C | (CH₂)_{c} | 1 to 20 | Si(OMe)₃ | 3 |
| 253 | 0 | Me | Me | (CH₂)_{b} | 0 to 20 | NHC(═O)CH₂C | (CH₂)_{c} | 1 to 20 | Si(OMe)₃ | 3 |

TABLE 292

| No. | R²¹ | | a | R²² | R²³ | R²⁴ | | | R²⁵ | z21 | z22 |
|---|---|---|---|---|---|---|---|---|---|---|---|
| 254 | CF₃ | (CH₂)ₐ | 0 to 20 | Me | Me | CF₃ | (CH₂)ₐ | 0 to 20 | Me | 5 to 100 | 0 |
| 255 | (CF₃)₂CF | (CH₂)ₐ | 0 to 20 | Me | Me | CF₃ | (CH₂)ₐ | 0 to 20 | Me | 5 to 100 | 0 |
| 256 | (CF₃)₃C | (CH₂)ₐ | 0 to 20 | Me | Me | CF₃ | (CH₂)ₐ | 0 to 20 | Me | 5 to 100 | 0 |
| 257 | C₄F₉ | (CH₂)ₐ | 0 to 20 | Me | Me | CF₃ | (CH₂)ₐ | 0 to 20 | Me | 5 to 100 | 0 |
| 258 | C₈F₁₇ | (CH₂)ₐ | 0 to 20 | Me | Me | CF₃ | (CH₂)ₐ | 0 to 20 | Me | 5 to 100 | 0 |
| 259 | c-C₆F₁₁ | (CH₂)ₐ | 0 to 20 | Me | Me | CF₃ | (CH₂)ₐ | 0 to 20 | Me | 5 to 100 | 0 |
| 260 | CHF₂ | (CH₂)ₐ | 0 to 20 | Me | Me | CF₃ | (CH₂)ₐ | 0 to 20 | Me | 5 to 100 | 0 |
| 261 | CCIF₂ | (CH₂)ₐ | 0 to 20 | Me | Me | CF₃ | (CH₂)ₐ | 0 to 20 | Me | 5 to 100 | 0 |
| 262 | CBrF₂ | (CH₂)ₐ | 0 to 20 | Me | Me | CF₃ | (CH₂)ₐ | 0 to 20 | Me | 5 to 100 | 0 |
| 263 | CIF₂ | (CH₂)ₐ | 0 to 20 | Me | Me | CF₃ | (CH₂)ₐ | 0 to 20 | Me | 5 to 100 | 0 |
| 264 | CF═CF₂ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 254 | Me | Me | (CH₂)_{b} | 0 to 20 | NHC(═O)CH₂C | (CH₂)_{c} | 1 to 20 | Si(OMe)₃ | 3 |
| 255 | Me | Me | (CH₂)_{b} | 0 to 20 | NHC(═O)CH₂C | (CH₂)_{c} | 1 to 20 | Si(OMe)₃ | 3 |
| 256 | Me | Me | (CH₂)_{b} | 0 to 20 | NHC(═O)CH₂C | (CH₂)_{c} | 1 to 20 | Si(OMe)₃ | 3 |
| 257 | Me | Me | (CH₂)_{b} | 0 to 20 | NHC(═O)CH₂C | (CH₂)_{c} | 1 to 20 | Si(OMe)₃ | 3 |
| 258 | Me | Me | (CH₂)_{b} | 0 to 20 | NHC(═O)CH₂C | (CH₂)_{c} | 1 to 20 | Si(OMe)₃ | 3 |
| 259 | Me | Me | (CH₂)_{b} | 0 to 20 | NHC(═O)CH₂C | (CH₂)_{c} | 1 to 20 | Si(OMe)₃ | 3 |
| 260 | Me | Me | (CH₂)_{b} | 0 to 20 | NHC(═O)CH₂C | (CH₂)_{c} | 1 to 20 | Si(OMe)₃ | 3 |
| 261 | Me | Me | (CH₂)_{b} | 0 to 20 | NHC(═O)CH₂C | (CH₂)_{c} | 1 to 20 | Si(OMe)₃ | 3 |
| 262 | Me | Me | (CH₂)_{b} | 0 to 20 | NHC(═O)CH₂C | (CH₂)_{c} | 1 to 20 | Si(OMe)₃ | 3 |
| 263 | Me | Me | (CH₂)_{b} | 0 to 20 | NHC(═O)CH₂C | (CH₂)_{c} | 1 to 20 | Si(OMe)₃ | 3 |
| 264 | Me | Me | (CH₂)_{b} | 0 to 20 | NHC(═O)CH₂C | (CH₂)_{c} | 1 to 20 | Si(OMe)₃ | 3 |

TABLE 293

| No. | R²¹ | | a | R²² | R²³ | R²⁴ | | | R²⁵ | z21 | z22 |
|---|---|---|---|---|---|---|---|---|---|---|---|
| 265 | CF═CFCF₃ | (CH₂)ₐ | 0 to 20 | Me | Me | CF₃ | (CH₂)ₐ | 0 to 20 | Me | 5 to 100 | 0 |
| 266 | CF═CFCF═CF₂ | (CH₂)ₐ | 0 to 20 | Me | Me | CF₃ | (CH₂)ₐ | 0 to 20 | Me | 5 to 100 | 0 |
| 267 | C═CCF₃ | (CH₂)ₐ | 0 to 20 | Me | Me | CF₃ | (CH₂)ₐ | 0 to 20 | Me | 5 to 100 | 0 |
| 268 | CF₂CH₃ | (CH₂)ₐ | 0 to 20 | Me | Me | CF₃ | (CH₂)ₐ | 0 to 20 | Me | 5 to 100 | 0 |
| 269 | (CF₂)₂H | (CH₂)ₐ | 0 to 20 | Me | Me | CF₃ | (CH₂)ₐ | 0 to 20 | Me | 5 to 100 | 0 |
| 270 | (CF₂)₂CH₃ | (CH₂)ₐ | 0 to 20 | Me | Me | CF₃ | (CH₂)ₐ | 0 to 20 | Me | 5 to 100 | 0 |
| 271 | (CF₂)₄H | (CH₂)ₐ | 0 to 20 | Me | Me | CF₃ | (CH₂)ₐ | 0 to 20 | Me | 5 to 100 | 0 |
| 272 | C₆F₅ | (CH₂)ₐ | 0 to 20 | Me | Me | CF₃ | (CH₂)ₐ | 0 to 20 | Me | 5 to 100 | 0 |
| 273 | 4-CF₃C₆F₄ | (CH₂)ₐ | 0 to 20 | Me | Me | CF₃ | (CH₂)ₐ | 0 to 20 | Me | 5 to 100 | 0 |
| 274 | 4-SF₅C₆F₄ | (CH₂)ₐ | 0 to 20 | Me | Me | CF₃ | (CH₂)ₐ | 0 to 20 | Me | 5 to 100 | 0 |
| 275 | 3,5-CF₃C₆F₃ | (CH₂)ₐ | 0 to 20 | Me | Me | CF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 265 | Me | Me | (CH₂)_{b} | 0 to 20 | NHC(═O)CH₂C | (CH₂)_{c} | 1 to 20 | Si(OMe)₃ | 3 |
| 266 | Me | Me | (CH₂)_{b} | 0 to 20 | NHC(═O)CH₂C | (CH₂)_{c} | 1 to 20 | Si(OMe)₃ | 3 |
| 267 | Me | Me | (CH₂)_{b} | 0 to 20 | NHC(═O)CH₂C | (CH₂)_{c} | 1 to 20 | Si(OMe)₃ | 3 |
| 268 | Me | Me | (CH₂)_{b} | 0 to 20 | NHC(═O)CH₂C | (CH₂)_{c} | 1 to 20 | Si(OMe)₃ | 3 |
| 269 | Me | Me | (CH₂)_{b} | 0 to 20 | NHC(═O)CH₂C | (CH₂)_{c} | 1 to 20 | Si(OMe)₃ | 3 |
| 270 | Me | Me | (CH₂)_{b} | 0 to 20 | NHC(═O)CH₂C | (CH₂)_{c} | 1 to 20 | Si(OMe)₃ | 3 |
| 271 | Me | Me | (CH₂)_{b} | 0 to 20 | NHC(═O)CH₂C | (CH₂)_{c} | 1 to 20 | Si(OMe)₃ | 3 |
| 272 | Me | Me | (CH₂)_{b} | 0 to 20 | NHC(═O)CH₂C | (CH₂)_{c} | 1 to 20 | Si(OMe)₃ | 3 |
| 273 | Me | Me | (CH₂)_{b} | 0 to 20 | NHC(═O)CH₂C | (CH₂)_{c} | 1 to 20 | Si(OMe)₃ | 3 |
| 274 | Me | Me | (CH₂)_{b} | 0 to 20 | NHC(═O)CH₂C | (CH₂)_{c} | 1 to 20 | Si(OMe)₃ | 3 |
| 275 | Me | Me | (CH₂)_{b} | 0 to 20 | NHC(═O)CH₂C | (CH₂)_{c} | 1 to 20 | Si(OMe)₃ | 3 |

TABLE 294

| No. | R²¹ | | a | R²² | R²³ | R²⁴ | | | R²⁵ | z21 |
|---|---|---|---|---|---|---|---|---|---|---|
| 276 | 3,5-SF₅C₆F₃ | (CH₂)ₐ | 0 to 20 | Me | Me | CF₃ | (CH₂)ₐ | 0 to 20 | Me | 5 to 100 |
| 277 | 4-CF₃C₆H₄ | (CH₂)ₐ | 0 to 20 | Me | Me | CF₃ | (CH₂)ₐ | 0 to 20 | Me | 5 to 100 |
| 278 | 4-SF₅C₆H₄ | (CH₂)ₐ | 0 to 20 | Me | Me | CF₃ | (CH₂)ₐ | 0 to 20 | Me | 5 to 100 |
| 279 | 3,5-CF₃C₆H₃ | (CH₂)ₐ | 0 to 20 | Me | Me | CF₃ | (CH₂)ₐ | 0 to 20 | Me | 5 to 100 |
| 280 | 3,5-SF₅C₆H₃ | (CH₂)ₐ | 0 to 20 | Me | Me | CF₃ | (CH₂)ₐ | 0 to 20 | Me | 5 to 100 |
| 281 | 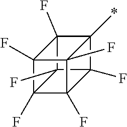 [SMILES: *C12C3(F)C4(F)C1(F)C1(F)C2(F)C3(F)C41F] | (CH₂)ₐ | 0 to 20 | Me | Me | CF₃ | (CH₂)a | 0 to 20 | Me | 5 to 100 |
| 282 | 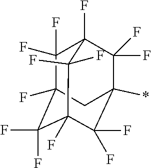 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 |
| 283 | 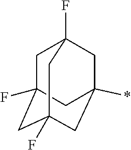 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 |
| 284 | SF₅ | (CH₂)ₐ | 0 to 20 | Me | Me | CF₃ | (CH₂)ₐ | 0 to 20 | Me | 5 to 100 |
| 285 | OCF₃ | (CH₂)ₐ | 0 to 20 | Me | Me | CF₃ | (CH₂)ₐ | 0 to 20 | Me | 5 to 100 |
| 286 | SCF₃ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 276 | 0 | Me | Me | (CH₂)_{b} | 0 to 20 | NHC(═O)CH₂C | (CH₂)_{c} | 1 to 20 | Si(OMe)₃ | 3 |
| 277 | 0 | Me | Me | (CH₂)_{b} | 0 to 20 | NHC(═O)CH₂C | (CH₂)_{c} | 1 to 20 | Si(OMe)₃ | 3 |
| 278 | 0 | Me | Me | (CH₂)_{b} | 0 to 20 | NHC(═O)CH₂C | (CH₂)_{c} | 1 to 20 | Si(OMe)₃ | 3 |
| 279 | 0 | Me | Me | (CH₂)_{b} | 0 to 20 | NHC(═O)CH₂C | (CH₂)_{c} | 1 to 20 | Si(OMe)₃ | 3 |
| 280 | 0 | Me | Me | (CH₂)_{b} | 0 to 20 | NHC(═O)CH₂C | (CH₂)_{c} | 1 to 20 | Si(OMe)₃ | 3 |
| 281 | 0 | Me | Me | (CH₂)_{b} | 0 to 20 | NHC(═O)CH₂C | (CH₂)_{c} | 1 to 20 | Si(OMe)₃ | 3 |
| 282 | 0 | Me | Me | (CH₂)_{b} | 0 to 20 | NHC(═O)CH₂C | (CH₂)_{c} | 1 to 20 | Si(OMe)₃ | 3 |
| 283 | 0 | Me | Me | (CH₂)_{b} | 0 to 20 | NHC(═O)CH₂C | (CH₂)_{c} | 1 to 20 | Si(OMe)₃ | 3 |
| 284 | 0 | Me | Me | (CH₂)_{b} | 0 to 20 | NHC(═O)CH₂C | (CH₂)_{c} | 1 to 20 | Si(OMe)₃ | 3 |
| 285 | 0 | Me | Me | (CH₂)_{b} | 0 to 20 | NHC(═O)CH₂C | (CH₂)_{c} | 1 to 20 | Si(OMe)₃ | 3 |
| 286 | 0 | Me | Me | (CH₂)_{b} | 0 to 20 | NHC(═O)CH₂C | (CH₂)_{c} | 1 to 20 | Si(OMe)₃ | 3 |

TABLE 295

| No. | R²¹ | | a | R²² | R²³ | R²⁴ | | | R²⁵ | z21 | z22 |
|---|---|---|---|---|---|---|---|---|---|---|---|
| 287 | N(CH₂CF₃)₂ | (CH₂)ₐ | 0 to 20 | Me | Me | CF₃ | (CH₂)ₐ | 0 to 20 | Me | 5 to 100 | 0 |
| 288 | N(CF₃)₂ | (CH₂)ₐ | 0 to 20 | Me | Me | CF₃ | (CH₂)ₐ | 0 to 20 | Me | 5 to 100 | 0 |
| 289 | Me | (CH₂)ₐ | 0 to 20 | Me | Me | CHF₂ | (CH₂)ₐ | 0 to 20 | Me | 5 to 100 | 0 |
| 290 | CF₃ | (CH₂)ₐ | 0 to 20 | Me | Me | CHF₂ | (CH₂)ₐ | 0 to 20 | Me | 5 to 100 | 0 |
| 291 | (CF₃)₂CF | (CH₂)ₐ | 0 to 20 | Me | Me | CHF₂ | (CH₂)ₐ | 0 to 20 | Me | 5 to 100 | 0 |
| 292 | (CF₃)₃C | (CH₂)ₐ | 0 to 20 | Me | Me | CHF₂ | (CH₂)ₐ | 0 to 20 | Me | 5 to 100 | 0 |
| 293 | C₄F₉ | (CH₂)ₐ | 0 to 20 | Me | Me | CHF₂ | (CH₂)ₐ | 0 to 20 | Me | 5 to 100 | 0 |
| 294 | C₈F₁₇ | (CH₂)ₐ | 0 to 20 | Me | Me | CHF₂ | (CH₂)ₐ | 0 to 20 | Me | 5 to 100 | 0 |
| 295 | c-C₆F₁₁ | (CH₂)ₐ | 0 to 20 | Me | Me | CHF₂ | (CH₂)ₐ | 0 to 20 | Me | 5 to 100 | 0 |
| 296 | CHF₂ | (CH₂)ₐ | 0 to 20 | Me | Me | CHF₂ | (CH₂)ₐ | 0 to 20 | Me | 5 to 100 | 0 |
| 297 | CCIF₂ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 287 | Me | Me | (CH₂)_{b} | 0 to 20 | NHC(═O)CH₂C | (CH₂)_{c} | 1 to 20 | Si(OMe)₃ | 3 |
| 288 | Me | Me | (CH₂)_{b} | 0 to 20 | NHC(═O)CH₂C | (CH₂)_{c} | 1 to 20 | Si(OMe)₃ | 3 |
| 289 | Me | Me | (CH₂)_{b} | 0 to 20 | NHC(═O)CH₂C | (CH₂)_{c} | 1 to 20 | Si(OMe)₃ | 3 |
| 290 | Me | Me | (CH₂)_{b} | 0 to 20 | NHC(═O)CH₂C | (CH₂)_{c} | 1 to 20 | Si(OMe)₃ | 3 |
| 291 | Me | Me | (CH₂)_{b} | 0 to 20 | NHC(═O)CH₂C | (CH₂)_{c} | 1 to 20 | Si(OMe)₃ | 3 |
| 292 | Me | Me | (CH₂)_{b} | 0 to 20 | NHC(═O)CH₂C | (CH₂)_{c} | 1 to 20 | Si(OMe)₃ | 3 |
| 293 | Me | Me | (CH₂)_{b} | 0 to 20 | NHC(═O)CH₂C | (CH₂)_{c} | 1 to 20 | Si(OMe)₃ | 3 |
| 294 | Me | Me | (CH₂)_{b} | 0 to 20 | NHC(═O)CH₂C | (CH₂)_{c} | 1 to 20 | Si(OMe)₃ | 3 |
| 295 | Me | Me | (CH₂)_{b} | 0 to 20 | NHC(═O)CH₂C | (CH₂)_{c} | 1 to 20 | Si(OMe)₃ | 3 |
| 296 | Me | Me | (CH₂)_{b} | 0 to 20 | NHC(═O)CH₂C | (CH₂)_{c} | 1 to 20 | Si(OMe)₃ | 3 |
| 297 | Me | Me | (CH₂)_{b} | 0 to 20 | NHC(═O)CH₂C | (CH₂)_{c} | 1 to 20 | Si(OMe)₃ | 3 |

TABLE 296

| No. | R²¹ | | a | R²² | R²³ | R²⁴ | | | R²⁵ | z21 | z22 |
|---|---|---|---|---|---|---|---|---|---|---|---|
| 298 | CBrF₂ | (CH₂)ₐ | 0 to 20 | Me | Me | CHF₂ | (CH₂)ₐ | 0 to 20 | Me | 5 to 100 | 0 |
| 299 | CIF₂ | (CH₂)ₐ | 0 to 20 | Me | Me | CHF₂ | (CH₂)ₐ | 0 to 20 | Me | 5 to 100 | 0 |
| 300 | CF═CF₂ | (CH₂)ₐ | 0 to 20 | Me | Me | CHF₂ | (CH₂)ₐ | 0 to 20 | Me | 5 to 100 | 0 |
| 301 | CF═CFCF₃ | (CH₂)ₐ | 0 to 20 | Me | Me | CHF₂ | (CH₂)ₐ | 0 to 20 | Me | 5 to 100 | 0 |
| 302 | CF═CFCF═CF₂ | (CH₂)ₐ | 0 to 20 | Me | Me | CHF₂ | (CH₂)ₐ | 0 to 20 | Me | 5 to 100 | 0 |
| 303 | C═CCF₃ | (CH₂)ₐ | 0 to 20 | Me | Me | CHF₂ | (CH₂)ₐ | 0 to 20 | Me | 5 to 100 | 0 |
| 304 | CF₂CH₃ | (CH₂)ₐ | 0 to 20 | Me | Me | CHF₂ | (CH₂)ₐ | 0 to 20 | Me | 5 to 100 | 0 |
| 305 | (CF₂)₂H | (CH₂)ₐ | 0 to 20 | Me | Me | CHF₂ | (CH₂)ₐ | 0 to 20 | Me | 5 to 100 | 0 |
| 306 | (CF₂)₂CH₃ | (CH₂)ₐ | 0 to 20 | Me | Me | CHF₂ | (CH₂)ₐ | 0 to 20 | Me | 5 to 100 | 0 |
| 307 | (CF₂)₄H | (CH₂)ₐ | 0 to 20 | Me | Me | CHF₂ | (CH₂)ₐ | 0 to 20 | Me | 5 to 100 | 0 |
| 308 | C₆F₅ | (CH₂)ₐ | 0 to 20 | Me | Me | CHF₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 298 | Me | Me | (CH₂)_{b} | 0 to 20 | NHC(═O)CH₂C | (CH₂)_{c} | 1 to 20 | Si(OMe)₃ | 3 |
| 299 | Me | Me | (CH₂)_{b} | 0 to 20 | NHC(═O)CH₂C | (CH₂)_{c} | 1 to 20 | Si(OMe)₃ | 3 |
| 300 | Me | Me | (CH₂)_{b} | 0 to 20 | NHC(═O)CH₂C | (CH₂)_{c} | 1 to 20 | Si(OMe)₃ | 3 |
| 301 | Me | Me | (CH₂)_{b} | 0 to 20 | NHC(═O)CH₂C | (CH₂)_{c} | 1 to 20 | Si(OMe)₃ | 3 |
| 302 | Me | Me | (CH₂)_{b} | 0 to 20 | NHC(═O)CH₂C | (CH₂)_{c} | 1 to 20 | Si(OMe)₃ | 3 |
| 303 | Me | Me | (CH₂)_{b} | 0 to 20 | NHC(═O)CH₂C | (CH₂)_{c} | 1 to 20 | Si(OMe)₃ | 3 |
| 304 | Me | Me | (CH₂)_{b} | 0 to 20 | NHC(═O)CH₂C | (CH₂)_{c} | 1 to 20 | Si(OMe)₃ | 3 |
| 305 | Me | Me | (CH₂)_{b} | 0 to 20 | NHC(═O)CH₂C | (CH₂)_{c} | 1 to 20 | Si(OMe)₃ | 3 |
| 306 | Me | Me | (CH₂)_{b} | 0 to 20 | NHC(═O)CH₂C | (CH₂)_{c} | 1 to 20 | Si(OMe)₃ | 3 |
| 307 | Me | Me | (CH₂)_{b} | 0 to 20 | NHC(═O)CH₂C | (CH₂)_{c} | 1 to 20 | Si(OMe)₃ | 3 |
| 308 | Me | Me | (CH₂)_{b} | 0 to 20 | NHC(═O)CH₂C | (CH₂)_{c} | 1 to 20 | Si(OMe)₃ | 3 |

TABLE 297

| No. | R²¹ | | a | R²² | R²³ | R²⁴ | | | R²⁵ | z21 |
|---|---|---|---|---|---|---|---|---|---|---|
| 309 | 4-CF₃C₆F₄ | (CH₂)ₐ | 0 to 20 | Me | Me | CHF₂ | (CH₂)ₐ | 0 to 20 | Me | 5 to 100 |
| 310 | 4-SF₅C₆F₄ | (CH₂)ₐ | 0 to 20 | Me | Me | CHF₂ | (CH₂)ₐ | 0 to 20 | Me | 5 to 100 |
| 311 | 3,5-CF₃C₆F₃ | (CH₂)ₐ | 0 to 20 | Me | Me | CHF₂ | (CH₂)ₐ | 0 to 20 | Me | 5 to 100 |
| 312 | 3,5-SFC₆F₃ | (CH₂)ₐ | 0 to 20 | Me | Me | CHF₂ | (CH₂)ₐ | 0 to 20 | Me | 5 to 100 |
| 313 | 4-CF₃C₆H₄ | (CH₂)ₐ | 0 to 20 | Me | Me | CHF₂ | (CH₂)ₐ | 0 to 20 | Me | 5 to 100 |
| 314 | 4-SF₅C₆H₄ | (CH₂)ₐ | 0 to 20 | Me | Me | CHF₂ | (CH₂)ₐ | 0 to 20 | Me | 5 to 100 |
| 315 | 3,5-CF₃C₆H₃ | (CH₂)ₐ | 0 to 20 | Me | Me | CHF₂ | (CH₂)ₐ | 0 to 20 | Me | 5 to 100 |
| 316 | 3,5-SF₅C₆H₃ | (CH₂)ₐ | 0 to 20 | Me | Me | CHF₂ | (CH₂)ₐ | 0 to 20 | Me | 5 to 100 |
| 317 | 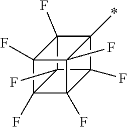 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 |
| 318 | 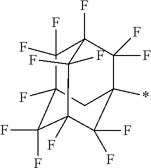 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 |
| 319 | 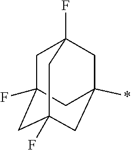 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | C | T¹ | x1 |
|---|---|---|---|---|---|---|---|---|---|---|
| 309 | 0 | Me | Me | (CH₂)_{b} | 0 to 20 | NHC(═O)CH₂C | (CH₂)_{c} | 1 to 20 | Si(OMe)₃ | 3 |
| 310 | 0 | Me | Me | (CH₂)_{b} | 0 to 20 | NHC(═O)CH₂C | (CH₂)_{c} | 1 to 20 | Si(OMe)₃ | 3 |
| 311 | 0 | Me | Me | (CH₂)_{b} | 0 to 20 | NHC(═O)CH₂C | (CH₂)_{c} | 1 to 20 | Si(OMe)₃ | 3 |
| 312 | 0 | Me | Me | (CH₂)_{b} | 0 to 20 | NHC(═O)CH₂C | (CH₂)_{c} | 1 to 20 | Si(OMe)₃ | 3 |
| 313 | 0 | Me | Me | (CH₂)_{b} | 0 to 20 | NHC(═O)CH₂C | (CH₂)_{c} | 1 to 20 | Si(OMe)₃ | 3 |
| 314 | 0 | Me | Me | (CH₂)_{b} | 0 to 20 | NHC(═O)CH₂C | (CH₂)_{c} | 1 to 20 | Si(OMe)₃ | 3 |
| 315 | 0 | Me | Me | (CH₂)_{b} | 0 to 20 | NHC(═O)CH₂C | (CH₂)_{c} | 1 to 20 | Si(OMe)₃ | 3 |
| 316 | 0 | Me | Me | (CH₂)_{b} | 0 to 20 | NHC(═O)CH₂C | (CH₂)_{c} | 1 to 20 | Si(OMe)₃ | 3 |
| 317 | 0 | Me | Me | (CH₂)_{b} | 0 to 20 | NHC(═O)CH₂C | (CH₂)_{c} | 1 to 20 | Si(OMe)₃ | 3 |
| 318 | 0 | Me | Me | (CH₂)_{b} | 0 to 20 | NHC(═O)CH₂C | (CH₂)_{c} | 1 to 20 | Si(OMe)₃ | 3 |
| 319 | 0 | Me | Me | (CH₂)_{b} | 0 to 20 | NHC(═O)CH₂C | (CH₂)_{c} | 1 to 20 | Si(OMe)₃ | 3 |

TABLE 298

| No. | R²¹ | | a | R²² | R²³ | R²⁴ | | | R²⁵ | z21 |
|---|---|---|---|---|---|---|---|---|---|---|
| 320 | SF₅ | (CH₂)ₐ | 0 to 20 | Me | Me | CHF₂ | (CH₂)ₐ | 0 to 20 | Me | 5 to 100 |
| 321 | OCF₃ | (CH₂)ₐ | 0 to 20 | Me | Me | CHF₂ | (CH₂)ₐ | 0 to 20 | Me | 5 to 100 |
| 322 | SCF₃ | (CH₂)ₐ | 0 to 20 | Me | Me | CHF₂ | (CH₂)ₐ | 0 to 20 | Me | 5 to 100 |
| 323 | N(CH₂CF₃)₂ | (CH₂)ₐ | 0 to 20 | Me | Me | CHF₂ | (CH₂)ₐ | 0 to 20 | Me | 5 to 100 |
| 324 | N(CF₃)₂ | (CH₂)ₐ | 0 to 20 | Me | Me | CHF₂ | (CH₂)ₐ | 0 to 20 | Me | 5 to 100 |
| 325 | Me | (CH₂)ₐ | 0 to 20 | Me | Me | 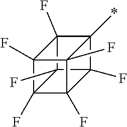 [SMILES: *C12C3(F)C4(F)C1(F)C1(F)C2(F)C3(F)C41F] | (CH₂)ₐ | 0 to 20 | Me | 5 to 100 |
| 326 | CF₃ | (CH₂)ₐ | 0 to 20 | Me | Me | 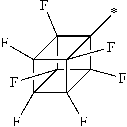 [SMILES: *C12C3(F)C4(F)C1(F)C1(F)C2(F)C3(F)C41F] | (CH₂)ₐ | 0 to 20 | Me | 5 to 100 |
| 327 | (CF₃)₂CF | (CH₂)ₐ | 0 to 20 | Me | Me | 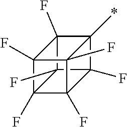 [SMILES: *C12C3(F)C4(F)C1(F)C1(F)C2(F)C3(F)C41F] | (CH₂)ₐ | 0 to 20 | Me | 5 to 100 |
| 328 | (CF₃)₃C | (CH₂)ₐ | 0 to 20 | Me | Me | 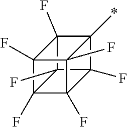 [SMILES: *C12C3(F)C4(F)C1(F)C1(F)C2(F)C3(F)C41F] | (CH₂)ₐ | 0 to 20 | Me | 5 to 100 |
| 329 | C₄F₉ | (CH₂)ₐ | 0 to 20 | Me | Me | 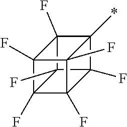 [SMILES: *C12C3(F)C4(F)C1(F)C1(F)C2(F)C3(F)C41F] | (CH₂)ₐ | 0 to 20 | Me | 5 to 100 |
| 330 | C₈F₁₇ | (CH₂)ₐ | 0 to 20 | Me | Me | 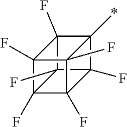 [SMILES: *C12C3(F)C4(F)C1(F)C1(F)C2(F)C3(F)C41F] | (CH₂)ₐ | 0 to 20 | Me | 5 to 100 |

| No. | z22 | R²⁸ | R²⁹ | R¹ | b | L¹ | R² | C | T¹ | x1 |
|---|---|---|---|---|---|---|---|---|---|---|
| 320 | 0 | Me | Me | (CH₂)_{b} | 0 to 20 | NHC(═O)CH₂C | (CH₂)_{c} | 1 to 20 | Si(OMe)₃ | 3 |
| 321 | 0 | Me | Me | (CH₂)_{b} | 0 to 20 | NHC(═O)CH₂C | (CH₂)_{c} | 1 to 20 | Si(OMe)₃ | 3 |
| 322 | 0 | Me | Me | (CH₂)_{b} | 0 to 20 | NHC(═O)CH₂C | (CH₂)_{c} | 1 to 20 | Si(OMe)₃ | 3 |
| 323 | 0 | Me | Me | (CH₂)_{b} | 0 to 20 | NHC(═O)CH₂C | (CH₂)_{c} | 1 to 20 | Si(OMe)₃ | 3 |
| 324 | 0 | Me | Me | (CH₂)_{b} | 0 to 20 | NHC(═O)CH₂C | (CH₂)_{c} | 1 to 20 | Si(OMe)₃ | 3 |
| 325 | 0 | Me | Me | (CH₂)_{b} | 0 to 20 | NHC(═O)CH₂C | (CH₂)_{c} | 1 to 20 | Si(OMe)₃ | 3 |
| 326 | 0 | Me | Me | (CH₂)_{b} | 0 to 20 | NHC(═O)CH₂C | (CH₂)_{c} | 1 to 20 | Si(OMe)₃ | 3 |
| 327 | 0 | Me | Me | (CH₂)_{b} | 0 to 20 | NHC(═O)CH₂C | (CH₂)_{c} | 1 to 20 | Si(OMe)₃ | 3 |
| 328 | 0 | Me | Me | (CH₂)_{b} | 0 to 20 | NHC(═O)CH₂C | (CH₂)_{c} | 1 to 20 | Si(OMe)₃ | 3 |
| 329 | 0 | Me | Me | (CH₂)_{b} | 0 to 20 | NHC(═O)CH₂C | (CH₂)_{c} | 1 to 20 | Si(OMe)₃ | 3 |
| 330 | 0 | Me | Me | (CH₂)_{b} | 0 to 20 | NHC(═O)CH₂C | (CH₂)_{c} | 1 to 20 | Si(OMe)₃ | 3 |

TABLE 299

| No. | R²¹ | | a | R²² | R²³ | R²⁴ | | | R²⁵ | z21 | z22 |
|---|---|---|---|---|---|---|---|---|---|---|---|
| 331 | c-C₆F₁₁ | (CH₂)ₐ | 0 to 20 | Me | Me | 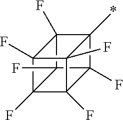 [SMILES: *C12C3(F)C4(F)C1(F)C1(F)C2(F)C3(F)C41F] | (CH₂)ₐ | 0 to 20 | Me | 5 to 100 | 0 |
| 332 | CHF₂ | (CH₂)ₐ | 0 to 20 | Me | Me | 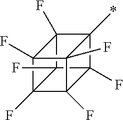 [SMILES: *C12C3(F)C4(F)C1(F)C1(F)C2(F)C3(F)C41F] | (CH₂)ₐ | 0 to 20 | Me | 5 to 100 | 0 |
| 333 | CClF₂ | (CH₂)ₐ | 0 to 20 | Me | Me | 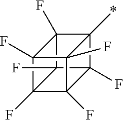 [SMILES: *C12C3(F)C4(F)C1(F)C1(F)C2(F)C3(F)C41F] | (CH₂)ₐ | 0 to 20 | Me | 5 to 100 | 0 |
| 334 | CBrF₂ | (CH₂)ₐ | 0 to 20 | Me | Me | 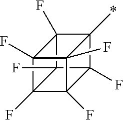 [SMILES: *C12C3(F)C4(F)C1(F)C1(F)C2(F)C3(F)C41F] | (CH₂)ₐ | 0 to 20 | Me | 5 to 100 | 0 |
| 335 | ClF₂ | (CH₂)ₐ | 0 to 20 | Me | Me | 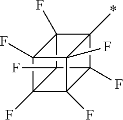 [SMILES: *C12C3(F)C4(F)C1(F)C1(F)C2(F)C3(F)C41F] | (CH₂)ₐ | 0 to 20 | Me | 5 to 100 | 0 |
| 336 | CF═CF₂ | (CH₂)ₐ | 0 to 20 | Me | Me | 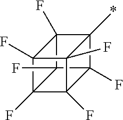 [SMILES: *C12C3(F)C4(F)C1(F)C1(F)C2(F)C3(F)C41F] | (CH₂)ₐ | 0 to 20 | Me | 5 to 100 | 0 |
| 337 | CF═CFCF₃ | (CH₂)ₐ | 0 to 20 | Me | Me | 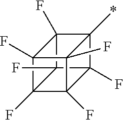 [SMILES: *C12C3(F)C4(F)C1(F)C1(F)C2(F)C3(F)C41F] | (CH₂)ₐ | 0 to 20 | Me | 5 to 100 | 0 |
| 338 | CF═CFCF═CF₂ | (CH₂)ₐ | 0 to 20 | Me | Me | 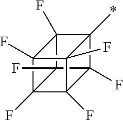 [SMILES: *C12C3(F)C4(F)C1(F)C1(F)C2(F)C3(F)C41F] | (CH₂)ₐ | 0 to 20 | Me | 5 to 100 | 0 |
| 339 | C≡CF₃ | (CH₂)ₐ | 0 to 20 | Me | Me | 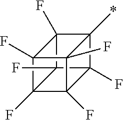 [SMILES: *C12C3(F)C4(F)C1(F)C1(F)C2(F)C3(F)C41F] | (CH₂)ₐ | 0 to 20 | Me | 5 to 100 | 0 |
| 340 | CF₂CH₃ | (CH₂)ₐ | 0 to 20 | Me | Me | 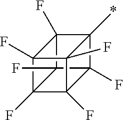 [SMILES: *C12C3(F)C4(F)C1(F)C1(F)C2(F)C3(F)C41F] | (CH₂)ₐ | 0 to 20 | Me | 5 to 100 | 0 |
| 341 | (CF₂)₂H | (CH₂)ₐ | 0 to 20 | Me | Me | 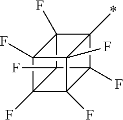 [SMILES: *C12C3(F)C4(F)C1(F)C1(F)C2(F)C3(F)C41F] | (CH₂)ₐ | 0 to 20 | Me | 5 to 100 | 0 |

| No. | R²⁸ | R²⁹ | R¹ | b | L¹ | R² | c | T¹ | × 1 |
|---|---|---|---|---|---|---|---|---|---|
| 331 | Me | Me | (CH₂)_{b} | 0 to 20 | NHC(═O)CH₂C | (CH₂)_{c} | 1 to 20 | Si(OMe)₃ | 3 |
| 332 | Me | Me | (CH₂)_{b} | 0 to 20 | NHC(═O)CH₂C | (CH₂)_{c} | 1 to 20 | Si(OMe)₃ | 3 |
| 333 | Me | Me | (CH₂)_{b} | 0 to 20 | NHC(═O)CH₂C | (CH₂)_{c} | 1 to 20 | Si(OMe)₃ | 3 |
| 334 | Me | Me | (CH₂)_{b} | 0 to 20 | NHC(═O)CH₂C | (CH₂)_{c} | 1 to 20 | Si(OMe)₃ | 3 |
| 335 | Me | Me | (CH₂)_{b} | 0 to 20 | NHC(═O)CH₂C | (CH₂)_{c} | 1 to 20 | Si(OMe)₃ | 3 |
| 336 | Me | Me | (CH₂)_{b} | 0 to 20 | NHC(═O)CH₂C | (CH₂)_{c} | 1 to 20 | Si(OMe)₃ | 3 |
| 337 | Me | Me | (CH₂)_{b} | 0 to 20 | NHC(═O)CH₂C | (CH₂)_{c} | 1 to 20 | Si(OMe)₃ | 3 |
| 338 | Me | Me | (CH₂)_{b} | 0 to 20 | NHC(═O)CH₂C | (CH₂)_{c} | 1 to 20 | Si(OMe)₃ | 3 |
| 339 | Me | Me | (CH₂)_{b} | 0 to 20 | NHC(═O)CH₂C | (CH₂)_{c} | 1 to 20 | Si(OMe)₃ | 3 |
| 340 | Me | Me | (CH₂)_{b} | 0 to 20 | NHC(═O)CH₂C | (CH₂)_{c} | 1 to 20 | Si(OMe)₃ | 3 |
| 341 | Me | Me | (CH₂)_{b} | 0 to 20 | NHC(═O)CH₂C | (CH₂)_{c} | 1 to 20 | Si(OMe)₃ | 3 |

TABLE 300

| No. | R²¹ | | a | R²² | R²³ | R²⁴ | | | R²⁵ | z21 | z22 |
|---|---|---|---|---|---|---|---|---|---|---|---|
| 342 | (CF₂)₂CH₃ | (CH₂)ₐ | 0 to 20 | Me | Me | 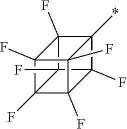 [SMILES: *C12C3(F)C4(F)C1(F)C1(F)C2(F)C3(F)C41F] | (CH₂)ₐ | 0 to 20 | Me | 5 to 100 | 0 |
| 343 | (CF₂)₄H | (CH₂)ₐ | 0 to 20 | Me | Me | 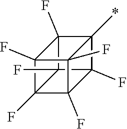 [SMILES: *C12C3(F)C4(F)C1(F)C1(F)C2(F)C3(F)C41F] | (CH₂)ₐ | 0 to 20 | Me | 5 to 100 | 0 |
| 344 | C₆F₅ | (CH₂)ₐ | 0 to 20 | Me | Me | 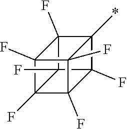 [SMILES: *C12C3(F)C4(F)C1(F)C1(F)C2(F)C3(F)C41F] | (CH₂)ₐ | 0 to 20 | Me | 5 to 100 | 0 |
| 345 | 4-CF₃C₆F₄ | (CH₂)ₐ | 0 to 20 | Me | Me | 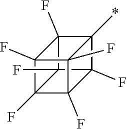 [SMILES: *C12C3(F)C4(F)C1(F)C1(F)C2(F)C3(F)C41F] | (CH₂)ₐ | 0 to 20 | Me | 5 to 100 | 0 |
| 346 | 4-SF₅C₆F₄ | (CH₂)ₐ | 0 to 20 | Me | Me | 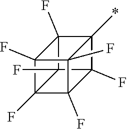 [SMILES: *C12C3(F)C4(F)C1(F)C1(F)C2(F)C3(F)C41F] | (CH₂)ₐ | 0 to 20 | Me | 5 to 100 | 0 |
| 347 | 3,5-CF₃C₆ F₃ | (CH₂)ₐ | 0 to 20 | Me | Me | 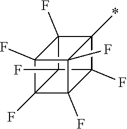 [SMILES: *C12C3(F)C4(F)C1(F)C1(F)C2(F)C3(F)C41F] | (CH₂)ₐ | 0 to 20 | Me | 5 to 100 | 0 |
| 348 | 3,5-SF₅C₆F₃ | (CH₂)ₐ | 0 to 20 | Me | Me | 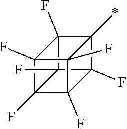 [SMILES: *C12C3(F)C4(F)C1(F)C1(F)C2(F)C3(F)C41F] | (CH₂)ₐ | 0 to 20 | Me | 5 to 100 | 0 |
| 349 | 4-CF₃C₆H₄ | (CH₂)ₐ | 0 to 20 | Me | Me | 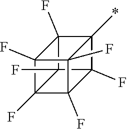 [SMILES: *C12C3(F)C4(F)C1(F)C1(F)C2(F)C3(F)C41F] | (CH₂)ₐ | 0 to 20 | Me | 5 to 100 | 0 |
| 350 | 4-SF₅C₆H₄ | (CH₂)ₐ | 0 to 20 | Me | Me | 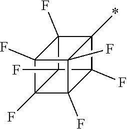 [SMILES: *C12C3(F)C4(F)C1(F)C1(F)C2(F)C3(F)C41F] | (CH₂)ₐ | 0 to 20 | Me | 5 to 100 | 0 |
| 351 | 3,5-CF₃C₆H₃ | (CH₂)ₐ | 0 to 20 | Me | Me | 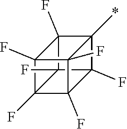 [SMILES: *C12C3(F)C4(F)C1(F)C1(F)C2(F)C3(F)C41F] | (CH₂)ₐ | 0 to 20 | Me | 5 to 100 | 0 |
| 352 | 3,5-SF₅C₆H₃ | (CH₂)ₐ | 0 to 20 | Me | Me | 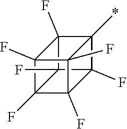 [SMILES: *C12C3(F)C4(F)C1(F)C1(F)C2(F)C3(F)C41F] | (CH₂)ₐ | 0 to 20 | Me | 5 to 100 | 0 |
| | | No. | R²⁸ | R²⁹ | R¹ | b | L¹ | R² | c | T¹ | × 1 |
| | | 342 | Me | Me | (CH₂)_{b} | 0 to 20 | NHC(═O)CH₂C | (CH₂)_{c} | 1 to 20 | Si(OMe)₃ | 3 |
| | | 343 | Me | Me | (CH₂)_{b} | 0 to 20 | NHC(═O)CH₂C | (CH₂)_{c} | 1 to 20 | Si(OMe)₃ | 3 |
| | | 344 | Me | Me | (CH₂)_{b} | 0 to 20 | NHC(═O)CH₂C | (CH₂)_{c} | 1 to 20 | Si(OMe)₃ | 3 |
| | | 345 | Me | Me | (CH₂)_{b} | 0 to 20 | NHC(═O)CH₂C | (CH₂)_{c} | 1 to 20 | Si(OMe)₃ | 3 |
| | | 346 | Me | Me | (CH₂)_{b} | 0 to 20 | NHC(═O)CH₂C | (CH₂)_{c} | 1 to 20 | Si(OMe)₃ | 3 |
| | | 347 | Me | Me | (CH₂)_{b} | 0 to 20 | NHC(═O)CH₂C | (CH₂)_{c} | 1 to 20 | Si(OMe)₃ | 3 |
| | | 348 | Me | Me | (CH₂)_{b} | 0 to 20 | NHC(═O)CH₂C | (CH₂)_{c} | 1 to 20 | Si(OMe)₃ | 3 |
| | | 349 | Me | Me | (CH₂)_{b} | 0 to 20 | NHC(═O)CH₂C | (CH₂)_{c} | 1 to 20 | Si(OMe)₃ | 3 |
| | | 350 | Me | Me | (CH₂)_{b} | 0 to 20 | NHC(═O)CH₂C | (CH₂)_{c} | 1 to 20 | Si(OMe)₃ | 3 |
| | | 351 | Me | Me | (CH₂)_{b} | 0 to 20 | NHC(═O)CH₂C | (CH₂)_{c} | 1 to 20 | Si(OMe)₃ | 3 |
| | | 352 | Me | Me | (CH₂)_{b} | 0 to 20 | NHC(═O)CH₂C | (CH₂)_{c} | 1 to 20 | Si(OMe)₃ | 3 |

TABLE 301

| No. | R²¹ | | a | R²² | R²³ | R²⁴ | | | R²⁵ | z21 | z22 |
|---|---|---|---|---|---|---|---|---|---|---|---|
| 353 | 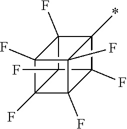 [SMILES: *C12C3(F)C4(F)C1(F)C1(F)C2(F)C3(F)C41F] | (CH₂)ₐ | 0 to 20 | Me | Me | 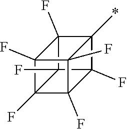 [SMILES: *C12C3(F)C4(F)C1(F)C1(F)C2(F)C3(F)C41F] | (CH₂)ₐ | 0 to 20 | Me | 5 to 100 | 0 |
| 354 | 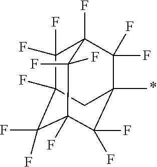 | (CH₂)ₐ | 0 to 20 | Me | Me | 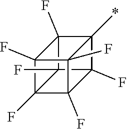 [SMILES: *C12C3(F)C4(F)C1(F)C1(F)C2(F)C3(F)C41F] | (CH₂)ₐ | 0 to 20 | Me | 5 to 100 | 0 |
| 355 | 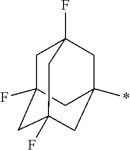 [SMILES: *C12CC3(F)CC(F)(C1)CC(F)(C2)C3] | (CH₂)ₐ | 0 to 20 | Me | Me | 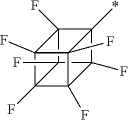 [SMILES: *C12C3(F)C4(F)C1(F)C1(F)C2(F)C3(F)C41F] | (CH₂)ₐ | 0 to 20 | Me | 5 to 100 | 0 |
| 356 | SF₅ | (CH₂)ₐ | 0 to 20 | Me | Me | 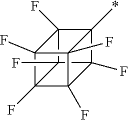 [SMILES: *C12C3(F)C4(F)C1(F)C1(F)C2(F)C3(F)C41F] | (CH₂)ₐ | 0 to 20 | Me | 5 to 100 | 0 |
| 357 | OCF₃ | (CH₂)ₐ | 0 to 20 | Me | Me | 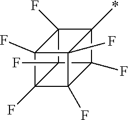 [SMILES: *C12C3(F)C4(F)C1(F)C1(F)C2(F)C3(F)C41F] | (CH₂)ₐ | 0 to 20 | Me | 5 to 100 | 0 |
| 358 | SCF₃ | (CH₂)ₐ | 0 to 20 | Me | Me | 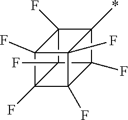 [SMILES: *C12C3(F)C4(F)C1(F)C1(F)C2(F)C3(F)C41F] | (CH₂)ₐ | 0 to 20 | Me | 5 to 100 | 0 |
| 359 | N(CH₂CF₃)₂ | (CH₂)ₐ | 0 to 20 | Me | Me | 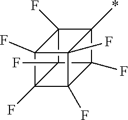 [SMILES: *C12C3(F)C4(F)C1(F)C1(F)C2(F)C3(F)C41F] | (CH₂)ₐ | 0 to 20 | Me | 5 to 100 | 0 |
| 360 | N(CF₃)₂ | (CH₂)ₐ | 0 to 20 | Me | Me | 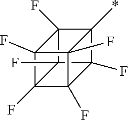 [SMILES: *C12C3(F)C4(F)C1(F)C1(F)C2(F)C3(F)C41F] | (CH₂)ₐ | 0 to 20 | Me | 5 to 100 | 0 |
| 361 | Me | (CH₂)ₐ | 0 to 20 | Me | Me | SF₅ | (CH₂)ₐ | 0 to 20 | Me | 5 to 100 | 0 |
| 362 | CF₃ | (CH₂)ₐ | 0 to 20 | Me | Me | SF₅ | (CH₂)ₐ | 0 to 20 | Me | 5 to 100 | 0 |
| 363 | (CF₃)₂CF | (CH₂)ₐ | 0 to 20 | Me | Me | SF₅ | (CH₂)ₐ | 0 to 20 | Me | 5 to 100 | 0 |
| | | No. | R²⁸ | R²⁹ | R¹ | b | L¹ | R² | c | T¹ | × 1 |
| | | 353 | Me | Me | (CH₂)_{b} | 0 to 20 | NHC(═O)CH₂C | (CH₂)_{c} | 1 to 20 | Si(OMe)₃ | 3 |
| | | 354 | Me | Me | (CH₂)_{b} | 0 to 20 | NHC(═O)CH₂C | (CH₂)_{c} | 1 to 20 | Si(OMe)₃ | 3 |
| | | 355 | Me | Me | (CH₂)_{b} | 0 to 20 | NHC(═O)CH₂C | (CH₂)_{c} | 1 to 20 | Si(OMe)₃ | 3 |
| | | 356 | Me | Me | (CH₂)_{b} | 0 to 20 | NHC(═O)CH₂C | (CH₂)_{c} | 1 to 20 | Si(OMe)₃ | 3 |
| | | 357 | Me | Me | (CH₂)_{b} | 0 to 20 | NHC(═O)CH₂C | (CH₂)_{c} | 1 to 20 | Si(OMe)₃ | 3 |
| | | 358 | Me | Me | (CH₂)_{b} | 0 to 20 | NHC(═O)CH₂C | (CH₂)_{c} | 1 to 20 | Si(OMe)₃ | 3 |
| | | 359 | Me | Me | (CH₂)_{b} | 0 to 20 | NHC(═O)CH₂C | (CH₂)_{c} | 1 to 20 | Si(OMe)₃ | 3 |
| | | 360 | Me | Me | (CH₂)_{b} | 0 to 20 | NHC(═O)CH₂C | (CH₂)_{c} | 1 to 20 | Si(OMe)₃ | 3 |
| | | 361 | Me | Me | (CH₂)_{b} | 0 to 20 | NHC(═O)CH₂C | (CH₂)_{c} | 1 to 20 | Si(OMe)₃ | 3 |
| | | 362 | Me | Me | (CH₂)_{b} | 0 to 20 | NHC(═O)CH₂C | (CH₂)_{c} | 1 to 20 | Si(OMe)₃ | 3 |
| | | 363 | Me | Me | (CH₂)_{b} | 0 to 20 | NHC(═O)CH₂C | (CH₂)_{c} | 1 to 20 | Si(OMe)₃ | 3 |

TABLE 302

| No. | R²¹ | | a | R²² | R²³ | R²⁴ | | | R²⁵ | z21 |
|---|---|---|---|---|---|---|---|---|---|---|
| 364 | (CF₃)₃C | (CH₂)ₐ | 0 to 20 | Me | Me | SF₅ | (CH₂)ₐ | 0 to 20 | Me | 5 to 100 |
| 365 | C₄F₉ | (CH₂)ₐ | 0 to 20 | Me | Me | SF₅ | (CH₂)ₐ | 0 to 20 | Me | 5 to 100 |
| 366 | C₈F₁₇ | (CH₂)ₐ | 0 to 20 | Me | Me | SF₅ | (CH₂)ₐ | 0 to 20 | Me | 5 to 100 |
| 367 | c-C₆F₁₁ | (CH₂)ₐ | 0 to 20 | Me | Me | SF₅ | (CH₂)ₐ | 0 to 20 | Me | 5 to 100 |
| 368 | CHF₂ | (CH₂)ₐ | 0 to 20 | Me | Me | SF₅ | (CH₂)ₐ | 0 to 20 | Me | 5 to 100 |
| 369 | CClF₂ | (CH₂)ₐ | 0 to 20 | Me | Me | SF₅ | (CH₂)ₐ | 0 to 20 | Me | 5 to 100 |
| 370 | CBrF₂ | (CH₂)ₐ | 0 to 20 | Me | Me | SF₅ | (CH₂)ₐ | 0 to 20 | Me | 5 to 100 |
| 371 | ClF₂ | (CH₂)ₐ | 0 to 20 | Me | Me | SF₅ | (CH₂)ₐ | 0 to 20 | Me | 5 to 100 |
| 372 | CF═CF₂ | (CH₂)ₐ | 0 to 20 | Me | Me | SF₅ | (CH₂)ₐ | 0 to 20 | Me | 5 to 100 |
| 373 | CF═CFCF₃ | (CH₂)ₐ | 0 to 20 | Me | Me | SF₅ | (CH₂)ₐ | 0 to 20 | Me | 5 to 100 |
| 374 | CF═CFCF═CF₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 364 | 0 | Me | Me | (CH₂)_{b} | 0 to 20 | NHC(═O)CH₂C | (CH₂)_{c} | 1 to 20 | Si(OMe)₃ | 3 |
| 365 | 0 | Me | Me | (CH₂)_{b} | 0 to 20 | NHC(═O)CH₂C | (CH₂)_{c} | 1 to 20 | Si(OMe)₃ | 3 |
| 366 | 0 | Me | Me | (CH₂)_{b} | 0 to 20 | NHC(═O)CH₂C | (CH₂)_{c} | 1 to 20 | Si(OMe)₃ | 3 |
| 367 | 0 | Me | Me | (CH₂)_{b} | 0 to 20 | NHC(═O)CH₂C | (CH₂)_{c} | 1 to 20 | Si(OMe)₃ | 3 |
| 368 | 0 | Me | Me | (CH₂)_{b} | 0 to 20 | NHC(═O)CH₂C | (CH₂)_{c} | 1 to 20 | Si(OMe)₃ | 3 |
| 369 | 0 | Me | Me | (CH₂)_{b} | 0 to 20 | NHC(═O)CH₂C | (CH₂)_{c} | 1 to 20 | Si(OMe)₃ | 3 |
| 370 | 0 | Me | Me | (CH₂)_{b} | 0 to 20 | NHC(═O)CH₂C | (CH₂)_{c} | 1 to 20 | Si(OMe)₃ | 3 |
| 371 | 0 | Me | Me | (CH₂)_{b} | 0 to 20 | NHC(═O)CH₂C | (CH₂)_{c} | 1 to 20 | Si(OMe)₃ | 3 |
| 372 | 0 | Me | Me | (CH₂)_{b} | 0 to 20 | NHC(═O)CH₂C | (CH₂)_{c} | 1 to 20 | Si(OMe)₃ | 3 |
| 373 | 0 | Me | Me | (CH₂)_{b} | 0 to 20 | NHC(═O)CH₂C | (CH₂)_{c} | 1 to 20 | Si(OMe)₃ | 3 |
| 374 | 0 | Me | Me | (CH₂)_{b} | 0 to 20 | NHC(═O)CH₂C | (CH₂)_{c} | 1 to 20 | Si(OMe)₃ | 3 |

TABLE 303

| No. | R²¹ | | a | R²² | R²³ | R²⁴ | | | R²⁵ | z21 | z22 |
|---|---|---|---|---|---|---|---|---|---|---|---|
| 375 | C≡CCF₃ | (CH₂)ₐ | 0 to 20 | Me | Me | SF₅ | (CH₂)ₐ | 0 to 20 | Me | 5 to 100 | 0 |
| 376 | CF₂CH₃ | (CH₂)ₐ | 0 to 20 | Me | Me | SF₅ | (CH₂)ₐ | 0 to 20 | Me | 5 to 100 | 0 |
| 377 | (CF₂)₂H | (CH₂)ₐ | 0 to 20 | Me | Me | SF₅ | (CH₂)ₐ | 0 to 20 | Me | 5 to 100 | 0 |
| 378 | (CF₂)₂CH₃ | (CH₂)ₐ | 0 to 20 | Me | Me | SF₅ | (CH₂)ₐ | 0 to 20 | Me | 5 to 100 | 0 |
| 379 | (CF₂)₄H | (CH₂)ₐ | 0 to 20 | Me | Me | SF₅ | (CH₂)ₐ | 0 to 20 | Me | 5 to 100 | 0 |
| 380 | C₆F₅ | (CH₂)ₐ | 0 to 20 | Me | Me | SF₅ | (CH₂)ₐ | 0 to 20 | Me | 5 to 100 | 0 |
| 381 | 4-CF₃C₆F₄ | (CH₂)ₐ | 0 to 20 | Me | Me | SF₅ | (CH₂)ₐ | 0 to 20 | Me | 5 to 100 | 0 |
| 382 | 4-SF₅C₆F₄ | (CH₂)ₐ | 0 to 20 | Me | Me | SF₅ | (CH₂)ₐ | 0 to 20 | Me | 5 to 100 | 0 |
| 383 | 3,5-CF₃C₆F₃ | (CH₂)ₐ | 0 to 20 | Me | Me | SF₅ | (CH₂)ₐ | 0 to 20 | Me | 5 to 100 | 0 |
| 384 | 3,5-SF₅C₆F₃ | (CH₂)ₐ | 0 to 20 | Me | Me | SF₅ | (CH₂)ₐ | 0 to 20 | Me | 5 to 100 | 0 |
| 385 | 4-CF₃C₆H₄ | (CH₂)ₐ | 0 to 20 | Me | Me | SF₅ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 375 | Me | Me | (CH₂)_{b} | 0 to 20 | NHC(═O)CH₂C | (CH₂)_{c} | 1 to 20 | Si(OMe)₃ | 3 |
| 376 | Me | Me | (CH₂)_{b} | 0 to 20 | NHC(═O)CH₂C | (CH₂)_{c} | 1 to 20 | Si(OMe)₃ | 3 |
| 377 | Me | Me | (CH₂)_{b} | 0 to 20 | NHC(═O)CH₂C | (CH₂)_{c} | 1 to 20 | Si(OMe)₃ | 3 |
| 378 | Me | Me | (CH₂)_{b} | 0 to 20 | NHC(═O)CH₂C | (CH₂)_{c} | 1 to 20 | Si(OMe)₃ | 3 |
| 379 | Me | Me | (CH₂)_{b} | 0 to 20 | NHC(═O)CH₂C | (CH₂)_{c} | 1 to 20 | Si(OMe)₃ | 3 |
| 380 | Me | Me | (CH₂)_{b} | 0 to 20 | NHC(═O)CH₂C | (CH₂)_{c} | 1 to 20 | Si(OMe)₃ | 3 |
| 381 | Me | Me | (CH₂)_{b} | 0 to 20 | NHC(═O)CH₂C | (CH₂)_{c} | 1 to 20 | Si(OMe)₃ | 3 |
| 382 | Me | Me | (CH₂)_{b} | 0 to 20 | NHC(═O)CH₂C | (CH₂)_{c} | 1 to 20 | Si(OMe)₃ | 3 |
| 383 | Me | Me | (CH₂)_{b} | 0 to 20 | NHC(═O)CH₂C | (CH₂)_{c} | 1 to 20 | Si(OMe)₃ | 3 |
| 384 | Me | Me | (CH₂)_{b} | 0 to 20 | NHC(═O)CH₂C | (CH₂)_{c} | 1 to 20 | Si(OMe)₃ | 3 |
| 385 | Me | Me | (CH₂)_{b} | 0 to 20 | NHC(═O)CH₂C | (CH₂)_{c} | 1 to 20 | Si(OMe)₃ | 3 |

TABLE 304

| No. | R²¹ | | a | R²² | R²³ | R²⁴ | | | R²⁵ | z21 | z22 |
|---|---|---|---|---|---|---|---|---|---|---|---|
| 386 | 4-SF₅C₆H₄ | (CH₂)ₐ | 0 to 20 | Me | Me | SF₅ | (CH₂)ₐ | 0 to 20 | Me | 5 to 100 | 0 |
| 387 | 3,5-CF₃C₆H₃ | (CH₂)ₐ | 0 to 20 | Me | Me | SF₅ | (CH₂)ₐ | 0 to 20 | Me | 5 to 100 | 0 |
| 388 | 3,5-SF₅C₆H₃ | (CH₂)ₐ | 0 to 20 | Me | Me | SF₅ | (CH₂)ₐ | 0 to 20 | Me | 5 to 100 | 0 |
| 389 | 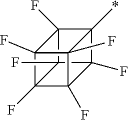 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 |
| 390 | 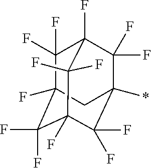 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 |
| 391 | 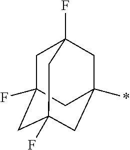 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 |
| 392 | SF₅ | (CH₂)ₐ | 0 to 20 | Me | Me | SF₅ | (CH₂)ₐ | 0 to 20 | Me | 5 to 100 | 0 |
| 393 | OCF₃ | (CH₂)ₐ | 0 to 20 | Me | Me | SF₅ | (CH₂)ₐ | 0 to 20 | Me | 5 to 100 | 0 |
| 394 | SCF₃ | (CH₂)ₐ | 0 to 20 | Me | Me | SF₅ | (CH₂)ₐ | 0 to 20 | Me | 5 to 100 | 0 |
| 395 | N(CH₂CF₃)₂ | (CH₂)ₐ | 0 to 20 | Me | Me | SF₅ | (CH₂)ₐ | 0 to 20 | Me | 5 to 100 | 0 |
| 396 | N(CF₃)₂ | (CH₂)ₐ | 0 to 20 | Me | Me | SF₅ | (CH₂)ₐ | 0 to 20 | Me | 5 to 100 | 0 |
| | | No. | R²⁸ | R²⁹ | R¹ | b | L¹ | R² | c | T¹ | × 1 |
| | | 386 | Me | Me | (CH₂)_{b} | 0 to 20 | NHC(═O)CH₂C | (CH₂)_{c} | 1 to 20 | Si(OMe)₃ | 3 |
| | | 387 | Me | Me | (CH₂)_{b} | 0 to 20 | NHC(═O)CH₂C | (CH₂)_{c} | 1 to 20 | Si(OMe)₃ | 3 |
| | | 388 | Me | Me | (CH₂)_{b} | 0 to 20 | NHC(═O)CH₂C | (CH₂)_{c} | 1 to 20 | Si(OMe)₃ | 3 |
| | | 389 | Me | Me | (CH₂)_{b} | 0 to 20 | NHC(═O)CH₂C | (CH₂)_{c} | 1 to 20 | Si(OMe)₃ | 3 |
| | | 390 | Me | Me | (CH₂)_{b} | 0 to 20 | NHC(═O)CH₂C | (CH₂)_{c} | 1 to 20 | Si(OMe)₃ | 3 |
| | | 391 | Me | Me | (CH₂)_{b} | 0 to 20 | NHC(═O)CH₂C | (CH₂)_{c} | 1 to 20 | Si(OMe)₃ | 3 |
| | | 392 | Me | Me | (CH₂)_{b} | 0 to 20 | NHC(═O)CH₂C | (CH₂)_{c} | 1 to 20 | Si(OMe)₃ | 3 |
| | | 393 | Me | Me | (CH₂)_{b} | 0 to 20 | NHC(═O)CH₂C | (CH₂)_{c} | 1 to 20 | Si(OMe)₃ | 3 |
| | | 394 | Me | Me | (CH₂)_{b} | 0 to 20 | NHC(═O)CH₂C | (CH₂)_{c} | 1 to 20 | Si(OMe)₃ | 3 |
| | | 395 | Me | Me | (CH₂)_{b} | 0 to 20 | NHC(═O)CH₂C | (CH₂)_{c} | 1 to 20 | Si(OMe)₃ | 3 |
| | | 396 | Me | Me | (CH₂)_{b} | 0 to 20 | NHC(═O)CH₂C | (CH₂)_{c} | 1 to 20 | Si(OMe)₃ | 3 |

TABLE 305

| No. | R²¹ | | a | R²² | R²³ | R²⁴ | | | R²⁵ | z21 | z22 |
|---|---|---|---|---|---|---|---|---|---|---|---|
| 397 | Me | (CH₂)ₐ | 0 to 20 | Me | Me | OCF₃ | (CH₂)ₐ | 0 to 20 | Me | 5 to 100 | 0 |
| 398 | CF₃ | (CH₂)ₐ | 0 to 20 | Me | Me | OCF₃ | (CH₂)ₐ | 0 to 20 | Me | 5 to 100 | 0 |
| 399 | (CF₃)₂CF | (CH₂)ₐ | 0 to 20 | Me | Me | OCF₃ | (CH₂)ₐ | 0 to 20 | Me | 5 to 100 | 0 |
| 400 | (CF₃)₃C | (CH₂)ₐ | 0 to 20 | Me | Me | OCF₃ | (CH₂)ₐ | 0 to 20 | Me | 5 to 100 | 0 |
| 401 | C₄F₉ | (CH₂)ₐ | 0 to 20 | Me | Me | OCF₃ | (CH₂)ₐ | 0 to 20 | Me | 5 to 100 | 0 |
| 402 | C₈F₁₇ | (CH₂)ₐ | 0 to 20 | Me | Me | OCF₃ | (CH₂)ₐ | 0 to 20 | Me | 5 to 100 | 0 |
| 403 | c-C₆F₁₁ | (CH₂)ₐ | 0 to 20 | Me | Me | OCF₃ | (CH₂)ₐ | 0 to 20 | Me | 5 to 100 | 0 |
| 404 | CHF₂ | (CH₂)ₐ | 0 to 20 | Me | Me | OCF₃ | (CH₂)ₐ | 0 to 20 | Me | 5 to 100 | 0 |
| 405 | CClF₂ | (CH₂)ₐ | 0 to 20 | Me | Me | OCF₃ | (CH₂)ₐ | 0 to 20 | Me | 5 to 100 | 0 |
| 406 | CBrF₂ | (CH₂)ₐ | 0 to 20 | Me | Me | OCF₃ | (CH₂)ₐ | 0 to 20 | Me | 5 to 100 | 0 |
| 407 | ClF₂ | (CH₂)ₐ | 0 to 20 | Me | Me | OCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 397 | Me | Me | (CH₂)_{b} | 0 to 20 | NHC(═O)CH₂C | (CH₂)_{c} | 1 to 20 | Si(OMe)₃ | 3 |
| 398 | Me | Me | (CH₂)_{b} | 0 to 20 | NHC(═O)CH₂C | (CH₂)_{c} | 1 to 20 | Si(OMe)₃ | 3 |
| 399 | Me | Me | (CH₂)_{b} | 0 to 20 | NHC(═O)CH₂C | (CH₂)_{c} | 1 to 20 | Si(OMe)₃ | 3 |
| 400 | Me | Me | (CH₂)_{b} | 0 to 20 | NHC(═O)CH₂C | (CH₂)_{c} | 1 to 20 | Si(OMe)₃ | 3 |
| 401 | Me | Me | (CH₂)_{b} | 0 to 20 | NHC(═O)CH₂C | (CH₂)_{c} | 1 to 20 | Si(OMe)₃ | 3 |
| 402 | Me | Me | (CH₂)_{b} | 0 to 20 | NHC(═O)CH₂C | (CH₂)_{c} | 1 to 20 | Si(OMe)₃ | 3 |
| 403 | Me | Me | (CH₂)_{b} | 0 to 20 | NHC(═O)CH₂C | (CH₂)_{c} | 1 to 20 | Si(OMe)₃ | 3 |
| 404 | Me | Me | (CH₂)_{b} | 0 to 20 | NHC(═O)CH₂C | (CH₂)_{c} | 1 to 20 | Si(OMe)₃ | 3 |
| 405 | Me | Me | (CH₂)_{b} | 0 to 20 | NHC(═O)CH₂C | (CH₂)_{c} | 1 to 20 | Si(OMe)₃ | 3 |
| 406 | Me | Me | (CH₂)_{b} | 0 to 20 | NHC(═O)CH₂C | (CH₂)_{c} | 1 to 20 | Si(OMe)₃ | 3 |
| 407 | Me | Me | (CH₂)_{b} | 0 to 20 | NHC(═O)CH₂C | (CH₂)_{c} | 1 to 20 | Si(OMe)₃ | 3 |

TABLE 306

| No. | R²¹ | | a | R²² | R²³ | R²⁴ | | | R²⁵ | z21 |
|---|---|---|---|---|---|---|---|---|---|---|
| 408 | CF═CF₂ | (CH2)ₐ | 0 to 20 | Me | Me | OCF₃ | (CH₂)ₐ | 0 to 20 | Me | 5 to 100 |
| 409 | CF═CFCF₃ | (CH2)ₐ | 0 to 20 | Me | Me | OCF₃ | (CH₂)ₐ | 0 to 20 | Me | 5 to 100 |
| 410 | CF═CFCF═CF₂ | (CH2)ₐ | 0 to 20 | Me | Me | OCF₃ | (CH₂)ₐ | 0 to 20 | Me | 5 to 100 |
| 411 | C≡CCF₃ | (CH2)ₐ | 0 to 20 | Me | Me | OCF₃ | (CH₂)ₐ | 0 to 20 | Me | 5 to 100 |
| 412 | CF₂CH₃ | (CH2)ₐ | 0 to 20 | Me | Me | OCF₃ | (CH₂)ₐ | 0 to 20 | Me | 5 to 100 |
| 413 | (CF₂)₂H | (CH2)ₐ | 0 to 20 | Me | Me | OCF₃ | (CH₂)ₐ | 0 to 20 | Me | 5 to 100 |
| 414 | (CF₂)₂CH₃ | (CH2)ₐ | 0 to 20 | Me | Me | OCF₃ | (CH₂)ₐ | 0 to 20 | Me | 5 to 100 |
| 415 | (CF₂)₄H | (CH2)ₐ | 0 to 20 | Me | Me | OCF₃ | (CH₂)ₐ | 0 to 20 | Me | 5 to 100 |
| 416 | C₆F₅ | (CH2)ₐ | 0 to 20 | Me | Me | OCF₃ | (CH₂)ₐ | 0 to 20 | Me | 5 to 100 |
| 417 | 4-CF₃C₆F₄ | (CH2)ₐ | 0 to 20 | Me | Me | OCF₃ | (CH₂)ₐ | 0 to 20 | Me | 5 to 100 |
| 418 | 4-SF₅C₆F₄ | (CH2)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 408 | 0 | Me | Me | (CH₂)_{b} | 0 to 20 | NHC(═O)CH₂C | (CH₂)_{c} | 1 to 20 | Si(OMe)₃ | 3 |
| 409 | 0 | Me | Me | (CH₂)_{b} | 0 to 20 | NHC(═O)CH₂C | (CH₂)_{c} | 1 to 20 | Si(OMe)₃ | 3 |
| 410 | 0 | Me | Me | (CH₂)_{b} | 0 to 20 | NHC(═O)CH₂C | (CH₂)_{c} | 1 to 20 | Si(OMe)₃ | 3 |
| 411 | 0 | Me | Me | (CH₂)_{b} | 0 to 20 | NHC(═O)CH₂C | (CH₂)_{c} | 1 to 20 | Si(OMe)₃ | 3 |
| 412 | 0 | Me | Me | (CH₂)_{b} | 0 to 20 | NHC(═O)CH₂C | (CH₂)_{c} | 1 to 20 | Si(OMe)₃ | 3 |
| 413 | 0 | Me | Me | (CH₂)_{b} | 0 to 20 | NHC(═O)CH₂C | (CH₂)_{c} | 1 to 20 | Si(OMe)₃ | 3 |
| 414 | 0 | Me | Me | (CH₂)_{b} | 0 to 20 | NHC(═O)CH₂C | (CH₂)_{c} | 1 to 20 | Si(OMe)₃ | 3 |
| 415 | 0 | Me | Me | (CH₂)_{b} | 0 to 20 | NHC(═O)CH₂C | (CH₂)_{c} | 1 to 20 | Si(OMe)₃ | 3 |
| 416 | 0 | Me | Me | (CH₂)_{b} | 0 to 20 | NHC(═O)CH₂C | (CH₂)_{c} | 1 to 20 | Si(OMe)₃ | 3 |
| 417 | 0 | Me | Me | (CH₂)_{b} | 0 to 20 | NHC(═O)CH₂C | (CH₂)_{c} | 1 to 20 | Si(OMe)₃ | 3 |
| 418 | 0 | Me | Me | (CH₂)_{b} | 0 to 20 | NHC(═O)CH₂C | (CH₂)_{c} | 1 to 20 | Si(OMe)₃ | 3 |

TABLE 307

| No. | R²¹ | | a | R²² | R²³ | R²⁴ | | | R²⁵ | z21 | z22 |
|---|---|---|---|---|---|---|---|---|---|---|---|
| 419 | 3,5-CF₃C₆F₃ | (CH₂)ₐ | 0 to 20 | Me | Me | OCF₃ | (CH₂)ₐ | 0 to 20 | Me | 5 to 100 | 0 |
| 420 | 3,5-SF₅C₆F₃ | (CH₂)ₐ | 0 to 20 | Me | Me | OCF₃ | (CH₂)ₐ | 0 to 20 | Me | 5 to 100 | 0 |
| 421 | 4-CF₃C₆H₄ | (CH₂)ₐ | 0 to 20 | Me | Me | OCF₃ | (CH₂)ₐ | 0 to 20 | Me | 5 to 100 | 0 |
| 422 | 4-SF₅C₆H₄ | (CH₂)ₐ | 0 to 20 | Me | Me | OCF₃ | (CH₂)ₐ | 0 to 20 | Me | 5 to 100 | 0 |
| 423 | 3,5-CF₃C₆H₃ | (CH₂)ₐ | 0 to 20 | Me | Me | OCF₃ | (CH₂)ₐ | 0 to 20 | Me | 5 to 100 | 0 |
| 424 | 3,5-SF₅C₆H₃ | (CH₂)ₐ | 0 to 20 | Me | Me | OCF₃ | (CH₂)ₐ | 0 to 20 | Me | 5 to 100 | 0 |
| 425 | 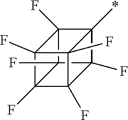 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 |
| 426 | 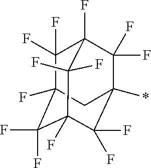 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 |
| 427 | 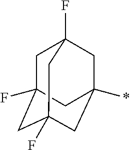 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 |
| 428 | SF₅ | (CH₂)ₐ | 0 to 20 | Me | Me | OCF₃ | (CH₂)ₐ | 0 to 20 | Me | 5 to 100 | 0 |
| 429 | OCF₃ | (CH₂)ₐ | 0 to 20 | Me | Me | OCF₃ | (CH₂)ₐ | 0 to 20 | Me | 5 to 100 | 0 |
| | | No. | R²⁸ | R²⁹ | R¹ | b | L¹ | R² | c | T¹ | × 1 |
| | | 419 | Me | Me | (CH₂)_{b} | 0 to 20 | NHC(═O)CH₂C | (CH₂)_{c} | 1 to 20 | Si(OMe)₃ | 3 |
| | | 420 | Me | Me | (CH₂)_{b} | 0 to 20 | NHC(═O)CH₂C | (CH₂)_{c} | 1 to 20 | Si(OMe)₃ | 3 |
| | | 421 | Me | Me | (CH₂)_{b} | 0 to 20 | NHC(═O)CH₂C | (CH₂)_{c} | 1 to 20 | Si(OMe)₃ | 3 |
| | | 422 | Me | Me | (CH₂)_{b} | 0 to 20 | NHC(═O)CH₂C | (CH₂)_{c} | 1 to 20 | Si(OMe)₃ | 3 |
| | | 423 | Me | Me | (CH₂)_{b} | 0 to 20 | NHC(═O)CH₂C | (CH₂)_{c} | 1 to 20 | Si(OMe)₃ | 3 |
| | | 424 | Me | Me | (CH₂)_{b} | 0 to 20 | NHC(═O)CH₂C | (CH₂)_{c} | 1 to 20 | Si(OMe)₃ | 3 |
| | | 425 | Me | Me | (CH₂)_{b} | 0 to 20 | NHC(═O)CH₂C | (CH₂)_{c} | 1 to 20 | Si(OMe)₃ | 3 |
| | | 426 | Me | Me | (CH₂)_{b} | 0 to 20 | NHC(═O)CH₂C | (CH₂)_{c} | 1 to 20 | Si(OMe)₃ | 3 |
| | | 427 | Me | Me | (CH₂)_{b} | 0 to 20 | NHC(═O)CH₂C | (CH₂)_{c} | 1 to 20 | Si(OMe)₃ | 3 |
| | | 428 | Me | Me | (CH₂)_{b} | 0 to 20 | NHC(═O)CH₂C | (CH₂)_{c} | 1 to 20 | Si(OMe)₃ | 3 |
| | | 429 | Me | Me | (CH₂)_{b} | 0 to 20 | NHC(═O)CH₂C | (CH₂)_{c} | 1 to 20 | Si(OMe)₃ | 3 |

TABLE 308

| No. | R²¹ | | a | R²² | R²³ | R²⁴ | | | R²⁵ | z21 | z22 |
|---|---|---|---|---|---|---|---|---|---|---|---|
| 430 | SCF₃ | (CH₂)ₐ | 0 to 20 | Me | Me | OCF₃ | (CH₂)ₐ | 0 to 20 | Me | 5 to 100 | 0 |
| 431 | N(CH₂CF₃)₂ | (CH₂)ₐ | 0 to 20 | Me | Me | OCF₃ | (CH₂)ₐ | 0 to 20 | Me | 5 to 100 | 0 |
| 432 | N(CF₃)₂ | (CH₂)ₐ | 0 to 20 | Me | Me | OCF₃ | (CH₂)ₐ | 0 to 20 | Me | 5 to 100 | 0 |
| 433 | Me | (CH₂)ₐ | 0 to 20 | Me | Me | SCF₃ | (CH₂)ₐ | 0 to 20 | Me | 5 to 100 | 0 |
| 434 | CF₃ | (CH₂)ₐ | 0 to 20 | Me | Me | SCF₃ | (CH₂)ₐ | 0 to 20 | Me | 5 to 100 | 0 |
| 435 | (CF₃)₂CF | (CH₂)ₐ | 0 to 20 | Me | Me | SCF₃ | (CH₂)ₐ | 0 to 20 | Me | 5 to 100 | 0 |
| 436 | (CF₃)₃C | (CH₂)ₐ | 0 to 20 | Me | Me | SCF₃ | (CH₂)ₐ | 0 to 20 | Me | 5 to 100 | 0 |
| 437 | C₄F₉ | (CH₂)ₐ | 0 to 20 | Me | Me | SCF₃ | (CH₂)ₐ | 0 to 20 | Me | 5 to 100 | 0 |
| 438 | C₈F₁₇ | (CH₂)ₐ | 0 to 20 | Me | Me | SCF₃ | (CH₂)ₐ | 0 to 20 | Me | 5 to 100 | 0 |
| 439 | c-C₆F₁₁ | (CH₂)ₐ | 0 to 20 | Me | Me | SCF₃ | (CH₂)ₐ | 0 to 20 | Me | 5 to 100 | 0 |
| 440 | CHF₂ | (CH₂)ₐ | 0 to 20 | Me | Me | SCF₃ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 430 | Me | Me | (CH₂)_{b} | 0 to 20 | NHC(═O)CH₂C | (CH₂)_{c} | 1 to 20 | Si(OMe)₃ | 3 |
| 431 | Me | Me | (CH₂)_{b} | 0 to 20 | NHC(═O)CH₂C | (CH₂)_{c} | 1 to 20 | Si(OMe)₃ | 3 |
| 432 | Me | Me | (CH₂)_{b} | 0 to 20 | NHC(═O)CH₂C | (CH₂)_{c} | 1 to 20 | Si(OMe)₃ | 3 |
| 433 | Me | Me | (CH₂)_{b} | 0 to 20 | NHC(═O)CH₂C | (CH₂)_{c} | 1 to 20 | Si(OMe)₃ | 3 |
| 434 | Me | Me | (CH₂)_{b} | 0 to 20 | NHC(═O)CH₂C | (CH₂)_{c} | 1 to 20 | Si(OMe)₃ | 3 |
| 435 | Me | Me | (CH₂)_{b} | 0 to 20 | NHC(═O)CH₂C | (CH₂)_{c} | 1 to 20 | Si(OMe)₃ | 3 |
| 436 | Me | Me | (CH₂)_{b} | 0 to 20 | NHC(═O)CH₂C | (CH₂)_{c} | 1 to 20 | Si(OMe)₃ | 3 |
| 437 | Me | Me | (CH₂)_{b} | 0 to 20 | NHC(═O)CH₂C | (CH₂)_{c} | 1 to 20 | Si(OMe)₃ | 3 |
| 438 | Me | Me | (CH₂)_{b} | 0 to 20 | NHC(═O)CH₂C | (CH₂)_{c} | 1 to 20 | Si(OMe)₃ | 3 |
| 439 | Me | Me | (CH₂)_{b} | 0 to 20 | NHC(═O)CH₂C | (CH₂)_{c} | 1 to 20 | Si(OMe)₃ | 3 |
| 440 | Me | Me | (CH₂)_{b} | 0 to 20 | NHC(═O)CH₂C | (CH₂)_{c} | 1 to 20 | Si(OMe)₃ | 3 |

TABLE 309

| No. | R²¹ | | a | R²² | R²³ | R²⁴ | | | R²⁵ | z21 |
|---|---|---|---|---|---|---|---|---|---|---|
| 441 | CClF₂ | (CH₂)ₐ | 0 to 20 | Me | Me | SCF₃ | (CH₂)ₐ | 0 to 20 | Me | 5 to 100 |
| 442 | CBrF₂ | (CH₂)ₐ | 0 to 20 | Me | Me | SCF₃ | (CH₂)ₐ | 0 to 20 | Me | 5 to 100 |
| 443 | ClF₂ | (CH₂)ₐ | 0 to 20 | Me | Me | SCF₃ | (CH₂)ₐ | 0 to 20 | Me | 5 to 100 |
| 444 | CF═CF₂ | (CH₂)ₐ | 0 to 20 | Me | Me | SCF₃ | (CH₂)ₐ | 0 to 20 | Me | 5 to 100 |
| 445 | CF═CFCF₃ | (CH₂)ₐ | 0 to 20 | Me | Me | SCF₃ | (CH₂)ₐ | 0 to 20 | Me | 5 to 100 |
| 446 | CF═CFCF═CF₂ | (CH₂)ₐ | 0 to 20 | Me | Me | SCF₃ | (CH₂)ₐ | 0 to 20 | Me | 5 to 100 |
| 447 | C≡CCF₃ | (CH₂)ₐ | 0 to 20 | Me | Me | SCF₃ | (CH₂)ₐ | 0 to 20 | Me | 5 to 100 |
| 448 | CF₂CH₃ | (CH₂)ₐ | 0 to 20 | Me | Me | SCF₃ | (CH₂)ₐ | 0 to 20 | Me | 5 to 100 |
| 449 | (CF₂)₂H | (CH₂)ₐ | 0 to 20 | Me | Me | SCF₃ | (CH₂)ₐ | 0 to 20 | Me | 5 to 100 |
| 450 | (CF₂)₂CH₃ | (CH₂)ₐ | 0 to 20 | Me | Me | SCF₃ | (CH₂)ₐ | 0 to 20 | Me | 5 to 100 |
| 451 | (CF₂)₄H | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 441 | 0 | Me | Me | (CH₂)_{b} | 0 to 20 | NHC(═O)CH₂C | (CH₂)_{c} | 1 to 20 | Si(OMe)₃ | 3 |
| 442 | 0 | Me | Me | (CH₂)_{b} | 0 to 20 | NHC(═O)CH₂C | (CH₂)_{c} | 1 to 20 | Si(OMe)₃ | 3 |
| 443 | 0 | Me | Me | (CH₂)_{b} | 0 to 20 | NHC(═O)CH₂C | (CH₂)_{c} | 1 to 20 | Si(OMe)₃ | 3 |
| 444 | 0 | Me | Me | (CH₂)_{b} | 0 to 20 | NHC(═O)CH₂C | (CH₂)_{c} | 1 to 20 | Si(OMe)₃ | 3 |
| 445 | 0 | Me | Me | (CH₂)_{b} | 0 to 20 | NHC(═O)CH₂C | (CH₂)_{c} | 1 to 20 | Si(OMe)₃ | 3 |
| 446 | 0 | Me | Me | (CH₂)_{b} | 0 to 20 | NHC(═O)CH₂C | (CH₂)_{c} | 1 to 20 | Si(OMe)₃ | 3 |
| 447 | 0 | Me | Me | (CH₂)_{b} | 0 to 20 | NHC(═O)CH₂C | (CH₂)_{c} | 1 to 20 | Si(OMe)₃ | 3 |
| 448 | 0 | Me | Me | (CH₂)_{b} | 0 to 20 | NHC(═O)CH₂C | (CH₂)_{c} | 1 to 20 | Si(OMe)₃ | 3 |
| 449 | 0 | Me | Me | (CH₂)_{b} | 0 to 20 | NHC(═O)CH₂C | (CH₂)_{c} | 1 to 20 | Si(OMe)₃ | 3 |
| 450 | 0 | Me | Me | (CH₂)_{b} | 0 to 20 | NHC(═O)CH₂C | (CH₂)_{c} | 1 to 20 | Si(OMe)₃ | 3 |
| 451 | 0 | Me | Me | (CH₂)_{b} | 10 to 20 | NHC(═O)CH₂C | (CH₂)_{c} | 1 to 20 | Si(OMe)₃ | 3 |

TABLE 310

| No. | R²¹ | | a | R²² | R²³ | R²⁴ | | | R²⁵ | z21 | z22 |
|---|---|---|---|---|---|---|---|---|---|---|---|
| 452 | C₆F₅ | (CH₂)ₐ | 0 to 20 | Me | Me | SCF₃ | (CH₂)ₐ | 0 to 20 | Me | 5 to 100 | 0 |
| 453 | 4-CF₃C₆F₄ | (CH₂)ₐ | 0 to 20 | Me | Me | SCF₃ | (CH₂)ₐ | 0 to 20 | Me | 5 to 100 | 0 |
| 454 | 4-SF₅C₆F₄ | (CH₂)ₐ | 0 to 20 | Me | Me | SCF₃ | (CH₂)ₐ | 0 to 20 | Me | 5 to 100 | 0 |
| 455 | 3,5-CF₃C₆ F₃ | (CH₂)ₐ | 0 to 20 | Me | Me | SCF₃ | (CH₂)ₐ | 0 to 20 | Me | 5 to 100 | 0 |
| 456 | 3,5-SF₅C₆F₃ | (CH₂)ₐ | 0 to 20 | Me | Me | SCF₃ | (CH₂)ₐ | 0 to 20 | Me | 5 to 100 | 0 |
| 457 | 4-CF₃C₆H₄ | (CH₂)ₐ | 0 to 20 | Me | Me | SCF₃ | (CH₂)ₐ | 0 to 20 | Me | 5 to 100 | 0 |
| 458 | 4-SF₅C₆H₄ | (CH₂)ₐ | 0 to 20 | Me | Me | SCF₃ | (CH₂)ₐ | 0 to 20 | Me | 5 to 100 | 0 |
| 459 | 3,5-CF₃C₆H₃ | (CH₂)ₐ | 0 to 20 | Me | Me | SCF₃ | (CH₂)ₐ | 0 to 20 | Me | 5 to 100 | 0 |
| 460 | 3,5-SF₅C₆H₃ | (CH₂)ₐ | 0 to 20 | Me | Me | SCF₃ | (CH₂)ₐ | 0 to 20 | Me | 5 to 100 | 0 |
| 461 | 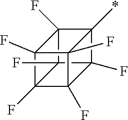 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 |
| 462 | 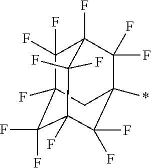 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 |
| | | No. | R²⁸ | R²⁹ | R¹ | b | L¹ | R² | c | T¹ | × 1 |
| | | 452 | Me | Me | (CH₂)_{b} | 0 to 20 | NHC(═O)CH₂C | (CH₂)_{c} | 1 to 20 | Si(OMe)₃ | 3 |
| | | 453 | Me | Me | (CH₂)_{b} | 0 to 20 | NHC(═O)CH₂C | (CH₂)_{c} | 1 to 20 | Si(OMe)₃ | 3 |
| | | 454 | Me | Me | (CH₂)_{b} | 0 to 20 | NHC(═O)CH₂C | (CH₂)_{c} | 1 to 20 | Si(OMe)₃ | 3 |
| | | 455 | Me | Me | (CH₂)_{b} | 0 to 20 | NHC(═O)CH₂C | (CH₂)_{c} | 1 to 20 | Si(OMe)₃ | 3 |
| | | 456 | Me | Me | (CH₂)_{b} | 0 to 20 | NHC(═O)CH₂C | (CH₂)_{c} | 1 to 20 | Si(OMe)₃ | 3 |
| | | 457 | Me | Me | (CH₂)_{b} | 0 to 20 | NHC(═O)CH₂C | (CH₂)_{c} | 1 to 20 | Si(OMe)₃ | 3 |
| | | 458 | Me | Me | (CH₂)_{b} | 0 to 20 | NHC(═O)CH₂C | (CH₂)_{c} | 1 to 20 | Si(OMe)₃ | 3 |
| | | 459 | Me | Me | (CH₂)_{b} | 0 to 20 | NHC(═O)CH₂C | (CH₂)_{c} | 1 to 20 | Si(OMe)₃ | 3 |
| | | 460 | Me | Me | (CH₂)_{b} | 0 to 20 | NHC(═O)CH₂C | (CH₂)_{c} | 1 to 20 | Si(OMe)₃ | 3 |
| | | 461 | Me | Me | (CH₂)_{b} | 0 to 20 | NHC(═O)CH₂C | (CH₂)_{c} | 1 to 20 | Si(OMe)₃ | 3 |
| | | 462 | Me | Me | (CH₂)_{b} | 0 to 20 | NHC(═O)CH₂C | (CH₂)_{c} | 1 to 20 | Si(OMe)₃ | 3 |

TABLE 311

| No. | R²¹ | | a | R²² | R²³ | R²⁴ | | | R²⁵ | z21 | z22 |
|---|---|---|---|---|---|---|---|---|---|---|---|
| 463 | 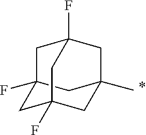 | (CH₂)ₐ | 0 to 20 | Me | Me | SCF₃ | (CH₂)ₐ | 0 to 20 | Me | 5 to 100 | 0 |
| 464 | SF₅ | (CH₂)ₐ | 0 to 20 | Me | Me | SCF₃ | (CH₂)ₐ | 0 to 20 | Me | 5 to 100 | 0 |
| 465 | OCF₃ | (CH₂)ₐ | 0 to 20 | Me | Me | SCF₃ | (CH₂)ₐ | 0 to 20 | Me | 5 to 100 | 0 |
| 466 | SCF₃ | (CH₂)ₐ | 0 to 20 | Me | Me | SCF₃ | (CH₂)ₐ | 0 to 20 | Me | 5 to 100 | 0 |
| 467 | N(CH₂CF₃)₂ | (CH₂)ₐ | 0 to 20 | Me | Me | SCF₃ | (CH₂)ₐ | 0 to 20 | Me | 5 to 100 | 0 |
| 468 | N(CF₃)₂ | (CH₂)ₐ | 0 to 20 | Me | Me | SCF₃ | (CH₂)ₐ | 0 to 20 | Me | 5 to 100 | 0 |
| 469 | Me | (CH₂)ₐ | 0 to 20 | Me | Me | N(CF₃)₂ | (CH₂)ₐ | 0 to 20 | Me | 5 to 100 | 0 |
| 470 | CF₃ | (CH₂)ₐ | 0 to 20 | Me | Me | N(CF₃)₂ | (CH₂)ₐ | 0 to 20 | Me | 5 to 100 | 0 |
| 471 | (CF₃)₂CF | (CH₂)ₐ | 0 to 20 | Me | Me | N(CF₃)₂ | (CH₂)ₐ | 0 to 20 | Me | 5 to 100 | 0 |
| 472 | (CF₃)₃C | (CH₂)ₐ | 0 to 20 | Me | Me | N(CF₃)₂ | (CH₂)ₐ | 0 to 20 | Me | 5 to 100 | 0 |
| 473 | C₄F₉ | (CH₂)ₐ | 0 to 20 | Me | Me | N(CF₃)₂ | (CH₂)ₐ | 0 to 20 | Me | 5 to 100 | 0 |
| | | No. | R²⁸ | R²⁹ | R¹ | b | L¹ | R² | c | T¹ | × 1 |
| | | 463 | Me | Me | (CH₂)_{b} | 0 to 20 | NHC(═O)CH₂C | (CH₂)_{c} | 1 to 20 | Si(OMe)₃ | 3 |
| | | 464 | Me | Me | (CH₂)_{b} | 0 to 20 | NHC(═O)CH₂C | (CH₂)_{c} | 1 to 20 | Si(OMe)₃ | 3 |
| | | 465 | Me | Me | (CH₂)_{b} | 0 to 20 | NHC(═O)CH₂C | (CH₂)_{c} | 1 to 20 | Si(OMe)₃ | 3 |
| | | 466 | Me | Me | (CH₂)_{b} | 0 to 20 | NHC(═O)CH₂C | (CH₂)_{c} | 1 to 20 | Si(OMe)₃ | 3 |
| | | 467 | Me | Me | (CH₂)_{b} | 0 to 20 | NHC(═O)CH₂C | (CH₂)_{c} | 1 to 20 | Si(OMe)₃ | 3 |
| | | 468 | Me | Me | (CH₂)_{b} | 0 to 20 | NHC(═O)CH₂C | (CH₂)_{c} | 1 to 20 | Si(OMe)₃ | 3 |
| | | 469 | Me | Me | (CH₂)_{b} | 0 to 20 | NHC(═O)CH₂C | (CH₂)_{c} | 1 to 20 | Si(OMe)₃ | 3 |
| | | 470 | Me | Me | (CH₂)_{b} | 0 to 20 | NHC(═O)CH₂C | (CH₂)_{c} | 1 to 20 | Si(OMe)₃ | 3 |
| | | 471 | Me | Me | (CH₂)_{b} | 0 to 20 | NHC(═O)CH₂C | (CH₂)_{c} | 1 to 20 | Si(OMe)₃ | 3 |
| | | 472 | Me | Me | (CH₂)_{b} | 0 to 20 | NHC(═O)CH₂C | (CH₂)_{c} | 1 to 20 | Si(OMe)₃ | 3 |
| | | 473 | Me | Me | (CH₂)_{b} | 0 to 20 | NHC(═O)CH₂C | (CH₂)_{c} | 1 to 20 | Si(OMe)₃ | 3 |

TABLE 312

| No. | R²¹ | | a | R²² | R²³ | R²⁴ | | | R²⁵ | z21 |
|---|---|---|---|---|---|---|---|---|---|---|
| 474 | C₈F₁₇ | (CH₂)ₐ | 0 to 20 | Me | Me | N(CF₃)₂ | (CH₂)ₐ | 0 to 20 | Me | 5 to 100 |
| 475 | c-C₆F₁₁ | (CH₂)ₐ | 0 to 20 | Me | Me | N(CF₃)₂ | (CH₂)ₐ | 0 to 20 | Me | 5 to 100 |
| 476 | CHF₂ | (CH₂)ₐ | 0 to 20 | Me | Me | N(CF₃)₂ | (CH₂)ₐ | 0 to 20 | Me | 5 to 100 |
| 477 | CClF₂ | (CH₂)ₐ | 0 to 20 | Me | Me | N(CF₃)₂ | (CH₂)ₐ | 0 to 20 | Me | 5 to 100 |
| 478 | CBrF₂ | (CH₂)ₐ | 0 to 20 | Me | Me | N(CF₃)₂ | (CH₂)ₐ | 0 to 20 | Me | 5 to 100 |
| 479 | ClF₂ | (CH₂)ₐ | 0 to 20 | Me | Me | N(CF₃)₂ | (CH₂)ₐ | 0 to 20 | Me | 5 to 100 |
| 480 | CF═CF₂ | (CH₂)ₐ | 0 to 20 | Me | Me | N(CF₃)₂ | (CH₂)ₐ | 0 to 20 | Me | 5 to 100 |
| 481 | CF═CFCF₃ | (CH₂)ₐ | 0 to 20 | Me | Me | N(CF₃)₂ | (CH₂)ₐ | 0 to 20 | Me | 5 to 100 |
| 482 | CF═CFCF═CF₂ | (CH₂)ₐ | 0 to 20 | Me | Me | N(CF₃)₂ | (CH₂)ₐ | 0 to 20 | Me | 5 to 100 |
| 483 | C≡CCF₃ | (CH₂)ₐ | 0 to 20 | Me | Me | N(CF₃)₂ | (CH₂)ₐ | 0 to 20 | Me | 5 to 100 |
| 484 | CF₂CH₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 474 | 0 | Me | Me | (CH₂)_{b} | 0 to 20 | NHC(═O)CH₂C | (CH₂)_{c} | 1 to 20 | Si(OMe)₃ | 3 |
| 475 | 0 | Me | Me | (CH₂)_{b} | 0 to 20 | NHC(═O)CH₂C | (CH₂)_{c} | 1 to 20 | Si(OMe)₃ | 3 |
| 476 | 0 | Me | Me | (CH₂)_{b} | 0 to 20 | NHC(═O)CH₂C | (CH₂)_{c} | 1 to 20 | Si(OMe)₃ | 3 |
| 477 | 0 | Me | Me | (CH₂)_{b} | 0 to 20 | NHC(═O)CH₂C | (CH₂)_{c} | 1 to 20 | Si(OMe)₃ | 3 |
| 478 | 0 | Me | Me | (CH₂)_{b} | 0 to 20 | NHC(═O)CH₂C | (CH₂)_{c} | 1 to 20 | Si(OMe)₃ | 3 |
| 479 | 0 | Me | Me | (CH₂)_{b} | 0 to 20 | NHC(═O)CH₂C | (CH₂)_{c} | 1 to 20 | Si(OMe)₃ | 3 |
| 480 | 0 | Me | Me | (CH₂)_{b} | 0 to 20 | NHC(═O)CH₂C | (CH₂)_{c} | 1 to 20 | Si(OMe)₃ | 3 |
| 481 | 0 | Me | Me | (CH₂)_{b} | 0 to 20 | NHC(═O)CH₂C | (CH₂)_{c} | 1 to 20 | Si(OMe)₃ | 3 |
| 482 | 0 | Me | Me | (CH₂)_{b} | 0 to 20 | NHC(═O)CH₂C | (CH₂)_{c} | 1 to 20 | Si(OMe)₃ | 3 |
| 483 | 0 | Me | Me | (CH₂)_{b} | 0 to 20 | NHC(═O)CH₂C | (CH₂)_{c} | 1 to 20 | Si(OMe)₃ | 3 |
| 484 | 0 | Me | Me | (CH₂)_{b} | 0 to 20 | NHC(═O)CH₂C | (CH₂)_{c} | 1 to 20 | Si(OMe)₃ | 3 |

TABLE 313

| No. | R²¹ | | a | R²² | R²³ | R²⁴ | | | R²⁵ | z21 | z22 |
|---|---|---|---|---|---|---|---|---|---|---|---|
| 485 | (CF₂)₂H | (CH₂)ₐ | 0 to 20 | Me | Me | N(CF₃)₂ | (CH₂)ₐ | 0 to 20 | Me | 5 to 100 | 0 |
| 486 | (CF₂)₂CH₃ | (CH₂)ₐ | 0 to 20 | Me | Me | N(CF₃)₂ | (CH₂)ₐ | 0 to 20 | Me | 5 to 100 | 0 |
| 487 | (CF₂)₄H | (CH₂)ₐ | 0 to 20 | Me | Me | SCF₃ | (CH₂)ₐ | 0 to 20 | Me | 5 to 100 | 0 |
| 488 | C₆F₅ | (CH₂)ₐ | 0 to 20 | Me | Me | N(CF₃)₂ | (CH₂)ₐ | 0 to 20 | Me | 5 to 100 | 0 |
| 489 | 4-CF₃C₆F₄ | (CH₂)ₐ | 0 to 20 | Me | Me | N(CF₃)₂ | (CH₂)ₐ | 0 to 20 | Me | 5 to 100 | 0 |
| 490 | 4-SF₅C₆F₄ | (CH₂)ₐ | 0 to 20 | Me | Me | N(CF₃)₂ | (CH₂)ₐ | 0 to 20 | Me | 5 to 100 | 0 |
| 491 | 3,5-CF₃C₆F₃ | (CH₂)ₐ | 0 to 20 | Me | Me | N(CF₃)₂ | (CH₂)ₐ | 0 to 20 | Me | 5 to 100 | 0 |
| 492 | 3,5-SF₅C₆F₃ | (CH₂)ₐ | 0 to 20 | Me | Me | N(CF₃)₂ | (CH₂)ₐ | 0 to 20 | Me | 5 to 100 | 0 |
| 493 | 4-CF₃C₆H₄ | (CH₂)ₐ | 0 to 20 | Me | Me | N(CF₃)₂ | (CH₂)ₐ | 0 to 20 | Me | 5 to 100 | 0 |
| 494 | 4-SF₅C₆H₄ | (CH₂)ₐ | 0 to 20 | Me | Me | N(CF₃)₂ | (CH₂)ₐ | 0 to 20 | Me | 5 to 100 | 0 |
| 495 | 3,5-CF₃C₆H₃ | (CH₂)ₐ | 0 to 20 | Me | Me | N(CF₃)₂ | (CH₂)ₐ | 0 to 20 | Me | 5 to 100 | 0 |

| No. | R²⁸ | R²⁹ | R¹ | b | L¹ | R² | c | T¹ | x1 |
|---|---|---|---|---|---|---|---|---|---|
| 485 | Me | Me | (CH₂)_{b} | 0 to 20 | NHC(═O)CH₂C | (CH₂)_{c} | 1 to 20 | Si(OMe)₃ | 3 |
| 486 | Me | Me | (CH₂)_{b} | 0 to 20 | NHC(═O)CH₂C | (CH₂)_{c} | 1 to 20 | Si(OMe)₃ | 3 |
| 487 | Me | Me | (CH₂)_{b} | 0 to 20 | NHC(═O)CH₂C | (CH₂)_{c} | 1 to 20 | Si(OMe)₃ | 3 |
| 488 | Me | Me | (CH₂)_{b} | 0 to 20 | NHC(═O)CH₂C | (CH₂)_{c} | 1 to 20 | Si(OMe)₃ | 3 |
| 489 | Me | Me | (CH₂)_{b} | 0 to 20 | NHC(═O)CH₂C | (CH₂)_{c} | 1 to 20 | Si(OMe)₃ | 3 |
| 490 | Me | Me | (CH₂)_{b} | 0 to 20 | NHC(═O)CH₂C | (CH₂)_{c} | 1 to 20 | Si(OMe)₃ | 3 |
| 491 | Me | Me | (CH₂)_{b} | 0 to 20 | NHC(═O)CH₂C | (CH₂)_{c} | 1 to 20 | Si(OMe)₃ | 3 |
| 492 | Me | Me | (CH₂)_{b} | 0 to 20 | NHC(═O)CH₂C | (CH₂)_{c} | 1 to 20 | Si(OMe)₃ | 3 |
| 493 | Me | Me | (CH₂)_{b} | 0 to 20 | NHC(═O)CH₂C | (CH₂)_{c} | 1 to 20 | Si(OMe)₃ | 3 |
| 494 | Me | Me | (CH₂)_{b} | 0 to 20 | NHC(═O)CH₂C | (CH₂)_{c} | 1 to 20 | Si(OMe)₃ | 3 |
| 495 | Me | Me | (CH₂)_{b} | 0 to 20 | NHC(═O)CH₂C | (CH₂)_{c} | 1 to 20 | Si(OMe)₃ | 3 |

TABLE 314

| No. | R²¹ | | a | R²² | R²³ | R²⁴ | | | R²⁵ | z21 | z22 |
|---|---|---|---|---|---|---|---|---|---|---|---|
| 496 | 3,5-SF₅C₆H₃ | (CH₂)ₐ | 0 to 20 | Me | Me | N(CF₃)₂ | (CH₂)ₐ | 0 to 20 | Me | 5 to 100 | 0 |
| 497 | 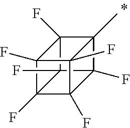 | (CH₂)ₐ | 0 to 20 | Me | Me | N(CF₃)₂ | (CH₂)ₐ | 0 to 20 | Me | 5 to 100 | 0 |
| 498 | 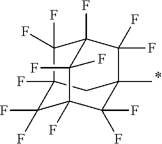 | (CH₂)ₐ | 0 to 20 | Me | Me | N(CF₃)₂ | (CH₂)ₐ | 0 to 20 | Me | 5 to 100 | 0 |
| 499 | 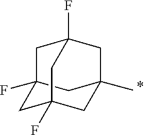 | (CH₂)ₐ | 0 to 20 | Me | Me | N(CF₃)₂ | (CH₂)ₐ | 0 to 20 | Me | 5 to 100 | 0 |
| 500 | SF₅ | (CH₂)ₐ | 0 to 20 | Me | Me | N(CF₃)₂ | (CH₂)ₐ | 0 to 20 | Me | 5 to 100 | 0 |
| 501 | OCF₃ | (CH₂)ₐ | 0 to 20 | Me | Me | N(CF₃)₂ | (CH₂)ₐ | 0 to 20 | Me | 5 to 100 | 0 |
| 502 | SCF₃ | (CH₂)ₐ | 0 to 20 | Me | Me | N(CF₃)₂ | (CH₂)ₐ | 0 to 20 | Me | 5 to 100 | 0 |
| 503 | N(CH₂CF₃)₂ | (CH₂)ₐ | 0 to 20 | Me | Me | N(CF₃)₂ | (CH₂)ₐ | 0 to 20 | Me | 5 to 100 | 0 |
| 504 | N(CF₃)₂ | (CH₂)ₐ | 0 to 20 | Me | Me | N(CF₃)₂ | (CH₂)ₐ | 0 to 20 | Me | 5 to 100 | 0 |
| | | No. | R²⁸ | R²⁹ | R¹ | b | L¹ | R² | c | T¹ | × 1 |
| | | 496 | Me | Me | (CH₂)_{b} | 0 to 20 | NHC(═O)CH₂C | (CH₂)_{c} | 1 to 20 | Si(OMe)₃ | 3 |
| | | 497 | Me | Me | (CH₂)_{b} | 0 to 20 | NHC(═O)CH₂C | (CH₂)_{c} | 1 to 20 | Si(OMe)₃ | 3 |
| | | 498 | Me | Me | (CH₂)_{b} | 0 to 20 | NHC(═O)CH₂C | (CH₂)_{c} | 1 to 20 | Si(OMe)₃ | 3 |
| | | 499 | Me | Me | (CH₂)_{b} | 0 to 20 | NHC(═O)CH₂C | (CH₂)_{c} | 1 to 20 | Si(OMe)₃ | 3 |
| | | 500 | Me | Me | (CH₂)_{b} | 0 to 20 | NHC(═O)CH₂C | (CH₂)_{c} | 1 to 20 | Si(OMe)₃ | 3 |
| | | 501 | Me | Me | (CH₂)_{b} | 0 to 20 | NHC(═O)CH₂C | (CH₂)_{c} | 1 to 20 | Si(OMe)₃ | 3 |
| | | 502 | Me | Me | (CH₂)_{b} | 0 to 20 | NHC(═O)CH₂C | (CH₂)_{c} | 1 to 20 | Si(OMe)₃ | 3 |
| | | 503 | Me | Me | (CH₂)_{b} | 0 to 20 | NHC(═O)CH₂C | (CH₂)_{c} | 1 to 20 | Si(OMe)₃ | 3 |
| | | 504 | Me | Me | (CH₂)_{b} | 0 to 20 | NHC(═O)CH₂C | (CH₂)_{c} | 1 to 20 | Si(OMe)₃ | 3 |

TABLE 315

| No. | R²¹ | | a | R²² | R²³ | R²⁴ | | | R²⁵ | z21 |
|---|---|---|---|---|---|---|---|---|---|---|
| 505 | Me | (CH₂)ₐ | 0 to 20 | Me | Me | CF₃ | (CH₂)ₐ | 0 to 20 | Me | 5 to 100 |
| 506 | CF₃ | (CH₂)ₐ | 0 to 20 | Me | Me | CF₃ | (CH₂)ₐ | 0 to 20 | Me | 5 to 100 |
| 507 | (CF₃)₂CF | (CH₂)ₐ | 0 to 20 | Me | Me | CF₃ | (CH₂)ₐ | 0 to 20 | Me | 5 to 100 |
| 508 | (CF₃)₃C | (CH₂)ₐ | 0 to 20 | Me | Me | CF₃ | (CH₂)ₐ | 0 to 20 | Me | 5 to 100 |
| 509 | C₄F₉ | (CH₂)ₐ | 0 to 20 | Me | Me | CF₃ | (CH₂)ₐ | 0 to 20 | Me | 5 to 100 |
| 510 | C₈F₁₇ | (CH₂)ₐ | 0 to 20 | Me | Me | CF₃ | (CH₂)ₐ | 0 to 20 | Me | 5 to 100 |
| 511 | c-C₆F₁₁ | (CH₂)ₐ | 0 to 20 | Me | Me | CF₃ | (CH₂)ₐ | 0 to 20 | Me | 5 to 100 |
| 512 | CHF₂ | (CH₂)ₐ | 0 to 20 | Me | Me | CF₃ | (CH₂)ₐ | 0 to 20 | Me | 5 to 100 |
| 513 | CClF₂ | (CH₂)ₐ | 0 to 20 | Me | Me | CF₃ | (CH₂)ₐ | 0 to 20 | Me | 5 to 100 |
| 514 | CBrF₂ | (CH₂)ₐ | 0 to 20 | Me | Me | CF₃ | (CH₂)ₐ | 0 to 20 | Me | 5 to 100 |
| 515 | ClF₂ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 505 | 0 | Me | Me | (CH₂)_{b} | 0 to 20 | Si | (CH₂)_{c} | 1 to 20 | Si(OMe)₃ | 3 |
| 506 | 0 | Me | Me | (CH₂)_{b} | 0 to 20 | Si | (CH₂)_{c} | 1 to 20 | Si(OMe)₃ | 3 |
| 507 | 0 | Me | Me | (CH₂)_{b} | 0 to 20 | Si | (CH₂)_{c} | 1 to 20 | Si(OMe)₃ | 3 |
| 508 | 0 | Me | Me | (CH₂)_{b} | 0 to 20 | Si | (CH₂)_{c} | 1 to 20 | Si(OMe)₃ | 3 |
| 509 | 0 | Me | Me | (CH₂)_{b} | 0 to 20 | Si | (CH₂)_{c} | 1 to 20 | Si(OMe)₃ | 3 |
| 510 | 0 | Me | Me | (CH₂)_{b} | 0 to 20 | Si | (CH₂)_{c} | 1 to 20 | Si(OMe)₃ | 3 |
| 511 | 0 | Me | Me | (CH₂)_{b} | 0 to 20 | Si | (CH₂)_{c} | 1 to 20 | Si(OMe)₃ | 3 |
| 512 | 0 | Me | Me | (CH₂)_{b} | 0 to 20 | Si | (CH₂)_{c} | 1 to 20 | Si(OMe)₃ | 3 |
| 513 | 0 | Me | Me | (CH₂)_{b} | 0 to 20 | Si | (CH₂)_{c} | 1 to 20 | Si(OMe)₃ | 3 |
| 514 | 0 | Me | Me | (CH₂)_{b} | 0 to 20 | Si | (CH₂)_{c} | 1 to 20 | Si(OMe)₃ | 3 |
| 515 | 0 | Me | Me | (CH₂)_{b} | 0 to 20 | Si | (CH₂)_{c} | 1 to 20 | Si(OMe)₃ | 3 |

TABLE 316

| No. | R²¹ | | a | R²² | R²³ | R²⁴ | | | R²⁵ | z21 |
|---|---|---|---|---|---|---|---|---|---|---|
| 516 | CF═CF₂ | (CH₂)ₐ | 0 to 20 | Me | Me | CF₃ | (CH₂)ₐ | 0 to 20 | Me | 5 to 100 |
| 517 | CF═CFCF₃ | (CH₂)ₐ | 0 to 20 | Me | Me | CF₃ | (CH₂)ₐ | 0 to 20 | Me | 5 to 100 |
| 518 | CF═CFCF═CF₂ | (CH₂)ₐ | 0 to 20 | Me | Me | CF₃ | (CH₂)ₐ | 0 to 20 | Me | 5 to 100 |
| 519 | C≡CCF₃ | (CH₂)ₐ | 0 to 20 | Me | Me | CF₃ | (CH₂)ₐ | 0 to 20 | Me | 5 to 100 |
| 520 | CF₂CH₃ | (CH₂)ₐ | 0 to 20 | Me | Me | CF₃ | (CH₂)ₐ | 0 to 20 | Me | 5 to 100 |
| 521 | (CF₂)₂H | (CH₂)ₐ | 0 to 20 | Me | Me | CF₃ | (CH₂)ₐ | 0 to 20 | Me | 5 to 100 |
| 522 | (CF₂)₂CH₃ | (CH₂)ₐ | 0 to 20 | Me | Me | CF₃ | (CH₂)ₐ | 0 to 20 | Me | 5 to 100 |
| 523 | (CF₂)₄H | (CH₂)ₐ | 0 to 20 | Me | Me | CF₃ | (CH₂)ₐ | 0 to 20 | Me | 5 to 100 |
| 524 | C₆F₅ | (CH₂)ₐ | 0 to 20 | Me | Me | CF₃ | (CH₂)ₐ | 0 to 20 | Me | 5 to 100 |
| 525 | 4-CF₃C₆F₄ | (CH₂)ₐ | 0 to 20 | Me | Me | CF₃ | (CH₂)ₐ | 0 to 20 | Me | 5 to 100 |
| 526 | 4-SF₅C₆F₄ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 516 | 0 | Me | Me | (CH₂)_{b} | 0 to 20 | Si | (CH₂)_{c} | 1 to 20 | Si(OMe)₃ | 3 |
| 517 | 0 | Me | Me | (CH₂)_{b} | 0 to 20 | Si | (CH₂)_{c} | 1 to 20 | Si(OMe)₃ | 3 |
| 518 | 0 | Me | Me | (CH₂)_{b} | 0 to 20 | Si | (CH₂)_{c} | 1 to 20 | Si(OMe)₃ | 3 |
| 519 | 0 | Me | Me | (CH₂)_{b} | 0 to 20 | Si | (CH₂)_{c} | 1 to 20 | Si(OMe)₃ | 3 |
| 520 | 0 | Me | Me | (CH₂)_{b} | 0 to 20 | Si | (CH₂)_{c} | 1 to 20 | Si(OMe)₃ | 3 |
| 521 | 0 | Me | Me | (CH₂)_{b} | 0 to 20 | Si | (CH₂)_{c} | 1 to 20 | Si(OMe)₃ | 3 |
| 522 | 0 | Me | Me | (CH₂)_{b} | 0 to 20 | Si | (CH₂)_{c} | 1 to 20 | Si(OMe)₃ | 3 |
| 523 | 0 | Me | Me | (CH₂)_{b} | 0 to 20 | Si | (CH₂)_{c} | 1 to 20 | Si(OMe)₃ | 3 |
| 524 | 0 | Me | Me | (CH₂)_{b} | 0 to 20 | Si | (CH₂)_{c} | 1 to 20 | Si(OMe)₃ | 3 |
| 525 | 0 | Me | Me | (CH₂)_{b} | 0 to 20 | Si | (CH₂)_{c} | 1 to 20 | Si(OMe)₃ | 3 |
| 526 | 0 | Me | Me | (CH₂)_{b} | 0 to 20 | Si | (CH₂)_{c} | 1 to 20 | Si(OMe)₃ | 3 |

TABLE 317

| No. | R²¹ | | a | R²² | R²³ | R²⁴ | | | R²⁵ | z21 | z22 |
|---|---|---|---|---|---|---|---|---|---|---|---|
| 527 | 3,5-CF₃C₆F₃ | (CH₂)ₐ | 0 to 20 | Me | Me | CF₃ | (CH₂)ₐ | 0 to 20 | Me | 5 to 100 | 0 |
| 528 | 3,5-SF₅C₆F₃ | (CH₂)ₐ | 0 to 20 | Me | Me | CF₃ | (CH₂)ₐ | 0 to 20 | Me | 5 to 100 | 0 |
| 529 | 4-CF₃C₆H₄ | (CH₂)ₐ | 0 to 20 | Me | Me | CF₃ | (CH₂)ₐ | 0 to 20 | Me | 5 to 100 | 0 |
| 530 | 4-SF₅C₆H₄ | (CH₂)ₐ | 0 to 20 | Me | Me | CF₃ | (CH₂)ₐ | 0 to 20 | Me | 5 to 100 | 0 |
| 531 | 3,5-CF₃C₆H₃ | (CH₂)ₐ | 0 to 20 | Me | Me | CF₃ | (CH₂)ₐ | 0 to 20 | Me | 5 to 100 | 0 |
| 532 | 3,5-SF₅C₆H₃ | (CH₂)ₐ | 0 to 20 | Me | Me | CF₃ | (CH₂)ₐ | 0 to 20 | Me | 5 to 100 | 0 |
| 533 | 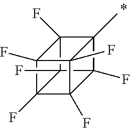 | (CH₂)ₐ | 0 to 20 | Me | Me | CF₃ | (CH₂)ₐ | 0 to 20 | Me | 5 to 100 | 0 |
| 534 | 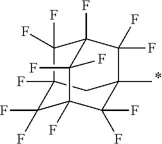 | (CH₂)ₐ | 0 to 20 | Me | Me | CF₃ | (CH₂)ₐ | 0 to 20 | Me | 5 to 100 | 0 |
| 535 | 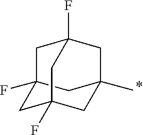 | (CH₂)ₐ | 0 to 20 | Me | Me | CF₃ | (CH₂)ₐ | 0 to 20 | Me | 5 to 100 | 0 |
| 536 | SF₅ | (CH₂)ₐ | 0 to 20 | Me | Me | CF₃ | (CH₂)ₐ | 0 to 20 | Me | 5 to 100 | 0 |
| 537 | OCF₃ | (CH₂)ₐ | 0 to 20 | Me | Me | CF₃ | (CH₂)ₐ | 0 to 20 | Me | 5 to 100 | 0 |
| | | No. | R²⁸ | R²⁹ | R¹ | b | L¹ | R² | c | T¹ | × 1 |
| | | 527 | Me | Me | (CH₂)_{b} | 0 to 20 | Si | (CH₂)_{c} | 1 to 20 | Si(OMe)₃ | 3 |
| | | 528 | Me | Me | (CH₂)_{b} | 0 to 20 | Si | (CH₂)_{c} | 1 to 20 | Si(OMe)₃ | 3 |
| | | 529 | Me | Me | (CH₂)_{b} | 0 to 20 | Si | (CH₂)_{c} | 1 to 20 | Si(OMe)₃ | 3 |
| | | 530 | Me | Me | (CH₂)_{b} | 0 to 20 | Si | (CH₂)_{c} | 1 to 20 | Si(OMe)₃ | 3 |
| | | 531 | Me | Me | (CH₂)_{b} | 0 to 20 | Si | (CH₂)_{c} | 1 to 20 | Si(OMe)₃ | 3 |
| | | 532 | Me | Me | (CH₂)_{b} | 0 to 20 | Si | (CH₂)_{c} | 1 to 20 | Si(OMe)₃ | 3 |
| | | 533 | Me | Me | (CH₂)_{b} | 0 to 20 | Si | (CH₂)_{c} | 1 to 20 | Si(OMe)₃ | 3 |
| | | 534 | Me | Me | (CH₂)_{b} | 0 to 20 | Si | (CH₂)_{c} | 1 to 20 | Si(OMe)₃ | 3 |
| | | 535 | Me | Me | (CH₂)_{b} | 0 to 20 | Si | (CH₂)_{c} | 1 to 20 | Si(OMe)₃ | 3 |
| | | 536 | Me | Me | (CH₂)_{b} | 0 to 20 | Si | (CH₂)_{c} | 1 to 20 | Si(OMe)₃ | 3 |
| | | 537 | Me | Me | (CH₂)_{b} | 0 to 20 | Si | (CH₂)_{c} | 1 to 20 | Si(OMe)₃ | 3 |

TABLE 318

| No. | R²¹ | | a | R²² | R²³ | R²⁴ | | | R²⁵ | z21 |
|---|---|---|---|---|---|---|---|---|---|---|
| 538 | SCF₃ | (CH₂)ₐ | 0 to 20 | Me | Me | CF₃ | (CH₂)ₐ | 0 to 20 | Me | 5 to 100 |
| 539 | N(CH₂CF₃)₂ | (CH₂)ₐ | 0 to 20 | Me | Me | CF₃ | (CH₂)ₐ | 0 to 20 | Me | 5 to 100 |
| 540 | N(CF₃)₂ | (CH₂)ₐ | 0 to 20 | Me | Me | CF₃ | (CH₂)ₐ | 0 to 20 | Me | 5 to 100 |
| 541 | Me | (CH₂)ₐ | 0 to 20 | Me | Me | CHF₂ | (CH₂)ₐ | 0 to 20 | Me | 5 to 100 |
| 542 | CF₃ | (CH₂)ₐ | 0 to 20 | Me | Me | CHF₂ | (CH₂)ₐ | 0 to 20 | Me | 5 to 100 |
| 543 | (CF₃)₂CF | (CH₂)ₐ | 0 to 20 | Me | Me | CHF₂ | (CH₂)ₐ | 0 to 20 | Me | 5 to 100 |
| 544 | (CF₃)₃C | (CH₂)ₐ | 0 to 20 | Me | Me | CHF₂ | (CH₂)ₐ | 0 to 20 | Me | 5 to 100 |
| 545 | C₄F₉ | (CH₂)ₐ | 0 to 20 | Me | Me | CHF₂ | (CH₂)ₐ | 0 to 20 | Me | 5 to 100 |
| 546 | C₉F₁₇ | (CH₂)ₐ | 0 to 20 | Me | Me | CHF₂ | (CH₂)ₐ | 0 to 20 | Me | 5 to 100 |
| 547 | c-C₆F₁₁ | (CH₂)ₐ | 0 to 20 | Me | Me | CHF₂ | (CH₂)ₐ | 0 to 20 | Me | 5 to 100 |
| 548 | CHF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 538 | 0 | Me | Me | (CH₂)_{b} | 0 to 20 | Si | (CH₂)_{c} | 1 to 20 | Si(OMe)₃ | 3 |
| 539 | 0 | Me | Me | (CH₂)_{b} | 0 to 20 | Si | (CH₂)_{c} | 1 to 20 | Si(OMe)₃ | 3 |
| 540 | 0 | Me | Me | (CH₂)_{b} | 0 to 20 | Si | (CH₂)_{c} | 1 to 20 | Si(OMe)₃ | 3 |
| 541 | 0 | Me | Me | (CH₂)_{b} | 0 to 20 | Si | (CH₂)_{c} | 1 to 20 | Si(OMe)₃ | 3 |
| 542 | 0 | Me | Me | (CH₂)_{b} | 0 to 20 | Si | (CH₂)_{c} | 1 to 20 | Si(OMe)₃ | 3 |
| 543 | 0 | Me | Me | (CH₂)_{b} | 0 to 20 | Si | (CH₂)_{c} | 1 to 20 | Si(OMe)₃ | 3 |
| 544 | 0 | Me | Me | (CH₂)_{b} | 0 to 20 | Si | (CH₂)_{c} | 1 to 20 | Si(OMe)₃ | 3 |
| 545 | 0 | Me | Me | (CH₂)_{b} | 0 to 20 | Si | (CH₂)_{c} | 1 to 20 | Si(OMe)₃ | 3 |
| 546 | 0 | Me | Me | (CH₂)_{b} | 0 to 20 | Si | (CH₂)_{c} | 1 to 20 | Si(OMe)₃ | 3 |
| 547 | 0 | Me | Me | (CH₂)_{b} | 0 to 20 | Si | (CH₂)_{c} | 1 to 20 | Si(OMe)₃ | 3 |
| 548 | 0 | Me | Me | (CH₂)_{b} | 0 to 20 | Si | (CH₂)_{c} | 1 to 20 | Si(OMe)₃ | 3 |

TABLE 319

| No. | R²¹ | | a | R²² | R²³ | R²⁴ | | | R²⁵ | z21 |
|---|---|---|---|---|---|---|---|---|---|---|
| 549 | CClF | (CH₂)ₐ | 0 to 20 | Me | Me | CHF₂ | (CH₂)ₐ | 0 to 20 | Me | 5 to 100 |
| 550 | CBrF₂ | (CH₂)ₐ | 0 to 20 | Me | Me | CHF₂ | (CH₂)ₐ | 0 to 20 | Me | 5 to 100 |
| 551 | ClF₂ | (CH₂)ₐ | 0 to 20 | Me | Me | CHF₂ | (CH₂)ₐ | 0 to 20 | Me | 5 to 100 |
| 552 | CF═CF₂ | (CH₂)ₐ | 0 to 20 | Me | Me | CHF₂ | (CH₂)ₐ | 0 to 20 | Me | 5 to 100 |
| 553 | CF═CFCF₃ | (CH₂)ₐ | 0 to 20 | Me | Me | CHF₂ | (CH₂)ₐ | 0 to 20 | Me | 5 to 100 |
| 554 | CF═CFCF═CF₂ | (CH₂)ₐ | 0 to 20 | Me | Me | CHF₂ | (CH₂)ₐ | 0 to 20 | Me | 5 to 100 |
| 555 | C≡CCF₃ | (CH₂)ₐ | 0 to 20 | Me | Me | CHF₂ | (CH₂)ₐ | 0 to 20 | Me | 5 to 100 |
| 556 | CF₂CH₃ | (CH₂)ₐ | 0 to 20 | Me | Me | CHF₂ | (CH₂)ₐ | 0 to 20 | Me | 5 to 100 |
| 557 | (CF₂)₂H | (CH₂)ₐ | 0 to 20 | Me | Me | CHF₂ | (CH₂)ₐ | 0 to 20 | Me | 5 to 100 |
| 558 | (CF₂)₂CH₃ | (CH₂)ₐ | 0 to 20 | Me | Me | CHF₂ | (CH₂)ₐ | 0 to 20 | Me | 5 to 100 |
| 559 | (CF₂)₄H | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 549 | 0 | Me | Me | (CH₂)_{b} | 0 to 20 | Si | (CH₂)_{c} | 1 to 20 | Si(OMe)₃ | 3 |
| 550 | 0 | Me | Me | (CH₂)_{b} | 0 to 20 | Si | (CH₂)_{c} | 1 to 20 | Si(OMe)₃ | 3 |
| 551 | 0 | Me | Me | (CH₂)_{b} | 0 to 20 | Si | (CH₂)_{c} | 1 to 20 | Si(OMe)₃ | 3 |
| 552 | 0 | Me | Me | (CH₂)_{b} | 0 to 20 | Si | (CH₂)_{c} | 1 to 20 | Si(OMe)₃ | 3 |
| 553 | 0 | Me | Me | (CH₂)_{b} | 0 to 20 | Si | (CH₂)_{c} | 1 to 20 | Si(OMe)₃ | 3 |
| 554 | 0 | Me | Me | (CH₂)_{b} | 0 to 20 | Si | (CH₂)_{c} | 1 to 20 | Si(OMe)₃ | 3 |
| 555 | 0 | Me | Me | (CH₂)_{b} | 0 to 20 | Si | (CH₂)_{c} | 1 to 20 | Si(OMe)₃ | 3 |
| 556 | 0 | Me | Me | (CH₂)_{b} | 0 to 20 | Si | (CH₂)_{c} | 1 to 20 | Si(OMe)₃ | 3 |
| 557 | 0 | Me | Me | (CH₂)_{b} | 0 to 20 | Si | (CH₂)_{c} | 1 to 20 | Si(OMe)₃ | 3 |
| 558 | 0 | Me | Me | (CH₂)_{b} | 0 to 20 | Si | (CH₂)_{c} | 1 to 20 | Si(OMe)₃ | 3 |
| 559 | 0 | Me | Me | (CH₂)_{b} | 0 to 20 | Si | (CH₂)_{c} | 1 to 20 | Si(OMe)₃ | 3 |

TABLE 320

| No. | R²¹ | | a | R²² | R²³ | R²⁴ | | | R²⁵ | z21 | z22 |
|---|---|---|---|---|---|---|---|---|---|---|---|
| 560 | C₆F₅ | (CH₂)ₐ | 0 to 20 | Me | Me | CF₃ | (CH₂)ₐ | 0 to 20 | Me | 5 to 100 | 0 |
| 561 | 4-CF₃C₆F₄ | (CH₂)ₐ | 0 to 20 | Me | Me | CF₃ | (CH₂)ₐ | 0 to 20 | Me | 5 to 100 | 0 |
| 562 | 4-SF₅C₆F₄ | (CH₂)ₐ | 0 to 20 | Me | Me | CF₃ | (CH₂)ₐ | 0 to 20 | Me | 5 to 100 | 0 |
| 563 | 3,5-CF₃C₆F₃ | (CH₂)ₐ | 0 to 20 | Me | Me | CF₃ | (CH₂)ₐ | 0 to 20 | Me | 5 to 100 | 0 |
| 564 | 3,5-SF₅C₆F₃ | (CH₂)ₐ | 0 to 20 | Me | Me | CF₃ | (CH₂)ₐ | 0 to 20 | Me | 5 to 100 | 0 |
| 565 | 4-CF₃C₆H₄ | (CH₂)ₐ | 0 to 20 | Me | Me | CF₃ | (CH₂)ₐ | 0 to 20 | Me | 5 to 100 | 0 |
| 566 | 4-SF₅C₆H₄ | (CH₂)ₐ | 0 to 20 | Me | Me | CF₃ | (CH₂)ₐ | 0 to 20 | Me | 5 to 100 | 0 |
| 567 | 3,5-CF₃C₆H₃ | (CH₂)ₐ | 0 to 20 | Me | Me | CF₃ | (CH₂)ₐ | 0 to 20 | Me | 5 to 100 | 0 |
| 568 | 3,5-SF₅C₆H₃ | (CH₂)ₐ | 0 to 20 | Me | Me | CF₃ | (CH₂)ₐ | 0 to 20 | Me | 5 to 100 | 0 |
| 569 | 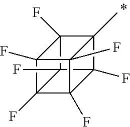 | (CH₂)ₐ | 0 to 20 | Me | Me | CF₃ | (CH₂)ₐ | 0 to 20 | Me | 5 to 100 | 0 |
| 570 | 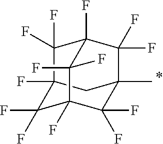 | (CH₂)ₐ | 0 to 20 | Me | Me | CF₃ | (CH₂)ₐ | 0 to 20 | Me | 5 to 100 | 0 |
| | | No. | R²⁸ | R²⁹ | R¹ | b | L¹ | R² | c | T¹ | × 1 |
| | | 560 | Me | Me | (CH₂)_{b} | 0 to 20 | Si | (CH₂)_{c} | 1 to 20 | Si(OMe)₃ | 3 |
| | | 561 | Me | Me | (CH₂)_{b} | 0 to 20 | Si | (CH₂)_{c} | 1 to 20 | Si(OMe)₃ | 3 |
| | | 562 | Me | Me | (CH₂)_{b} | 0 to 20 | Si | (CH₂)_{c} | 1 to 20 | Si(OMe)₃ | 3 |
| | | 563 | Me | Me | (CH₂)_{b} | 0 to 20 | Si | (CH₂)_{c} | 1 to 20 | Si(OMe)₃ | 3 |
| | | 564 | Me | Me | (CH₂)_{b} | 0 to 20 | Si | (CH₂)_{c} | 1 to 20 | Si(OMe)₃ | 3 |
| | | 565 | Me | Me | (CH₂)_{b} | 0 to 20 | Si | (CH₂)_{c} | 1 to 20 | Si(OMe)₃ | 3 |
| | | 566 | Me | Me | (CH₂)_{b} | 0 to 20 | Si | (CH₂)_{c} | 1 to 20 | Si(OMe)₃ | 3 |
| | | 567 | Me | Me | (CH₂)_{b} | 0 to 20 | Si | (CH₂)_{c} | 1 to 20 | Si(OMe)₃ | 3 |
| | | 568 | Me | Me | (CH₂)_{b} | 0 to 20 | Si | (CH₂)_{c} | 1 to 20 | Si(OMe)₃ | 3 |
| | | 569 | Me | Me | (CH₂)_{b} | 0 to 20 | Si | (CH₂)_{c} | 1 to 20 | Si(OMe)₃ | 3 |
| | | 570 | Me | Me | (CH₂)_{b} | 0 to 20 | Si | (CH₂)_{c} | 1 to 20 | Si(OMe)₃ | 3 |

TABLE 321

| No. | R²¹ | | a | R²² | R²³ | R²⁴ | | | R²⁵ | z21 | z22 |
|---|---|---|---|---|---|---|---|---|---|---|---|
| 571 | 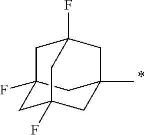 | (CH₂)ₐ | 0 to 20 | Me | Me | CHF₂ | (CH₂)ₐ | 0 to 20 | Me | 5 to 100 | 0 |
| 572 | SF₅ | (CH₂)ₐ | 0 to 20 | Me | Me | CHF₂ | (CH₂)ₐ | 0 to 20 | Me | 5 to 100 | 0 |
| 573 | OCF₃ | (CH₂)ₐ | 0 to 20 | Me | Me | CHF₂ | (CH₂)ₐ | 0 to 20 | Me | 5 to 100 | 0 |
| 574 | SCF₃ | (CH₂)ₐ | 0 to 20 | Me | Me | CHF₂ | (CH₂)ₐ | 0 to 20 | Me | 5 to 100 | 0 |
| 575 | N(CH₂CF₃)₂ | (CH₂)ₐ | 0 to 20 | Me | Me | CHF₂ | (CH₂)ₐ | 0 to 20 | Me | 5 to 100 | 0 |
| 576 | N(CF₃)₂ | (CH₂)ₐ | 0 to 20 | Me | Me | CHF₂ | (CH₂)ₐ | 0 to 20 | Me | 5 to 100 | 0 |
| 577 | Me | (CH₂)ₐ | 0 to 20 | Me | Me | 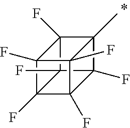 | (CH₂)ₐ | 0 to 20 | Me | 5 to 100 | 0 |
| 578 | CF₃ | (CH₂)ₐ | 0 to 20 | Me | Me | 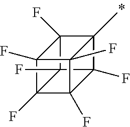 | (CH₂)ₐ | 0 to 20 | Me | 5 to 100 | 0 |
| 579 | (CF₃)₂CF | (CH₂)ₐ | 0 to 20 | Me | Me | 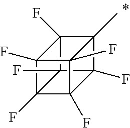 | (CH₂)ₐ | 0 to 20 | Me | 5 to 100 | 0 |
| 580 | (CF₃)₃C | (CH₂)ₐ | 0 to 20 | Me | Me | 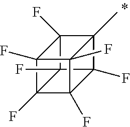 | (CH₂)ₐ | 0 to 20 | Me | 5 to 100 | 0 |
| 581 | C₄F₉ | (CH₂)ₐ | 0 to 20 | Me | Me | 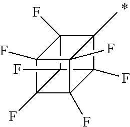 | (CH₂)ₐ | 0 to 20 | Me | 5 to 100 | 0 |
| | | No. | R²⁸ | R²⁹ | R¹ | b | L¹ | R² | c | T¹ | × 1 |
| | | 571 | Me | Me | (CH₂)_{b} | 0 to 20 | Si | (CH₂)_{c} | 1 to 20 | Si(OMe)₃ | 3 |
| | | 572 | Me | Me | (CH₂)_{b} | 0 to 20 | Si | (CH₂)_{c} | 1 to 20 | Si(OMe)₃ | 3 |
| | | 573 | Me | Me | (CH₂)_{b} | 0 to 20 | Si | (CH₂)_{c} | 1 to 20 | Si(OMe)₃ | 3 |
| | | 574 | Me | Me | (CH₂)_{b} | 0 to 20 | Si | (CH₂)_{c} | 1 to 20 | Si(OMe)₃ | 3 |
| | | 575 | Me | Me | (CH₂)_{b} | 0 to 20 | Si | (CH₂)_{c} | 1 to 20 | Si(OMe)₃ | 3 |
| | | 576 | Me | Me | (CH₂)_{b} | 0 to 20 | Si | (CH₂)_{c} | 1 to 20 | Si(OMe)₃ | 3 |
| | | 577 | Me | Me | (CH₂)_{b} | 0 to 20 | Si | (CH₂)_{c} | 1 to 20 | Si(OMe)₃ | 3 |
| | | 578 | Me | Me | (CH₂)_{b} | 0 to 20 | Si | (CH₂)_{c} | 1 to 20 | Si(OMe)₃ | 3 |
| | | 579 | Me | Me | (CH₂)_{b} | 0 to 20 | Si | (CH₂)_{c} | 1 to 20 | Si(OMe)₃ | 3 |
| | | 580 | Me | Me | (CH₂)_{b} | 0 to 20 | Si | (CH₂)_{c} | 1 to 20 | Si(OMe)₃ | 3 |
| | | 581 | Me | Me | (CH₂)_{b} | 0 to 20 | Si | (CH₂)_{c} | 1 to 20 | Si(OMe)₃ | 3 |

TABLE 322

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 582 | C₈F₁₇ | (CH₂)ₐ | 0 to 20 | Me | Me | 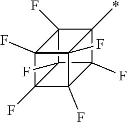 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 583 | c-C₆F₁₁ | (CH₂)ₐ | 0 to 20 | Me | Me | 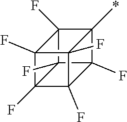 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 584 | CHF₂ | (CH₂)ₐ | 0 to 20 | Me | Me | 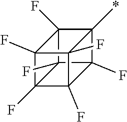 [SMILES: *C12C3(F)C4(F)C1(F)C1(F)C2(F)C3(F)C41F] | (CH₂)ₐ | 0 to 20 | \|Me | 5 to 100 | 0 | Me | Me | (CH₂)_{b} | 0 to 20 | Si | (CH₂)_{c} | 1 to 20 | Si(OMe)₃ | 3 |
| 585 | CClF₂ | (CH₂)ₐ | 0 to 20 | Me | Me | 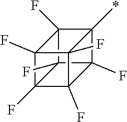 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 586 | CBrF₂ | (CH₂)ₐ | 0 to 20 | Me | Me | 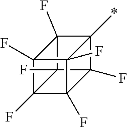 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 587 | ClF₂ | (CH₂)ₐ | 0 to 20 | Me | Me | 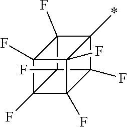 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 588 | CF═CF₂ | (CH₂)ₐ | 0 to 20 | Me | Me | 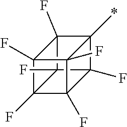 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 589 | CF═CFCF₃ | (CH₂)ₐ | 0 to 20 | Me | Me | 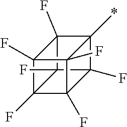 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 590 | CF═CFCF═CF₂ | (CH₂)ₐ | 0 to 20 | Me | Me | 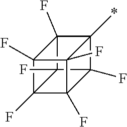 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 591 | C≡CCF₃ | (CH₂)ₐ | 0 to 20 | Me | Me | 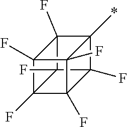 [SMILES: *C12C3(F)C4(F)C1(F)C1(F)C2(F)C3(F)C41F] | (CH₂)ₐ | 0 to 20 | Me | 5 to 100 | 0 | \|Me | Me | (CH₂)_{b} | 0 to 20 | Si | (CH₂)_{c} | 1 to 20 | Si(OMe)₃ | 3 |
| 592 | CF₂CH₃ | (CH₂)ₐ | 0 to 20 | Me | Me | 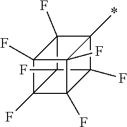 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |

TABLE 323

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 593 | (CF₂)₂H | (CH₂)ₐ | 0 to 20 | Me | Me | 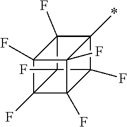 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 594 | (CF₂)₂CH₃ | (CH₂)ₐ | 0 to 20 | Me | Me | 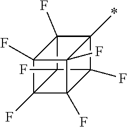 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 595 | (CF₂)₄H | (CH₂)ₐ | 0 to 20 | Me | Me | 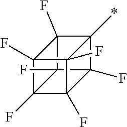 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 596 | C₈F₅ | (CH₂)ₐ | 0 to 20 | Me | Me | 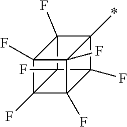 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 597 | 4-CF₃C₆F₄ | (CH₂)ₐ | 0 to 20 | Me | Me | 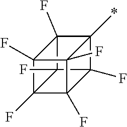 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 598 | 4-SF₅C₆F₄ | (CH₂)ₐ | 0 to 20 | Me | Me | 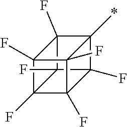 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 599 | 3,5-CF₃C₆F₃ | (CH₂)ₐ | 0 to 20 | Me | Me | 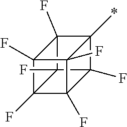 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 600 | 3,5-SF₅CF₃ | (CH₂)ₐ | 0 to 20 | Me | Me | 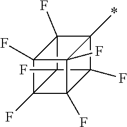 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 601 | 4-CF₃C₆H₄ | (CH₂)ₐ | 0 to 20 | Me | Me | 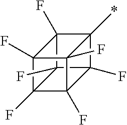 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 602 | 4-SF₅C₆H₄ | (CH₂)ₐ | 0 to 20 | Me | Me | 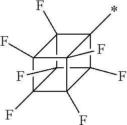 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 603 | 3,5-CF₃C₆H₃ | (CH₂)ₐ | 0 to 20 | Me | Me | 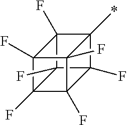 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |

TABLE 324

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 604 | 3,5-SFC₆H₃ | (CH₂)ₐ | 0 to 20 | Me | Me | 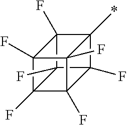 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 605 | 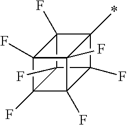 [SMILES: *C12C3(F)C4(F)C1(F)C1(F)C2(F)C3(F)C41F] | (CH₂)ₐ | 0 to 20 | Me | Me | 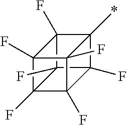 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 606 | 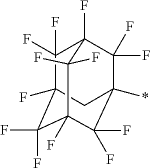 [SMILES: *C12CC3(F)C(F)(F)C(F)(C1(F)F)C(F)(F)C(F)(C2(F)F)C3(F)F] | (CH₂)ₐ | 0 to 20 | Me | Me | 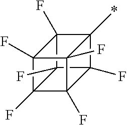 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 607 | 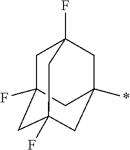 [SMILES: *C12CC3(F)CC(F)(C1)CC(F)(C2)C3] | (CH₂)ₐ | 0 to 20 | Me | Me | 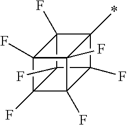 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 608 | SF₅ | (CH₂)ₐ | 0 to 20 | Me | Me | 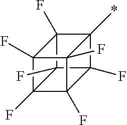 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 609 | OCF₃ | (CH₂)ₐ | 0 to 20 | Me | Me | 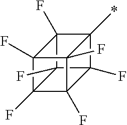 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 610 | SCF₃ | (CH₂)ₐ | 0 to 20 | Me | Me | 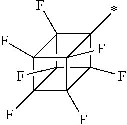 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 611 | N(CH₂CF₃)₂ | (CH₂)ₐ | 0 to 20 | Me | Me | 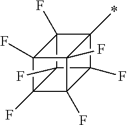 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 612 | N(CF₃)₂ | (CH₂)ₐ | 0 to 20 | Me | Me | 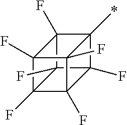 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 613 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 614 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |

TABLE 325

| No. | R²¹ | | a | R²² | R²³ | R²⁴ | | | R²⁵ | z21 |
|---|---|---|---|---|---|---|---|---|---|---|
| 615 | (CF₃)₂CF | (CH₂)ₐ | 0 to 20 | Me | Me | SF₅ | (CH₂)ₐ | 0 to 20 | Me | 5 to 100 |
| 616 | (CF₃)₃C | (CH₂)ₐ | 0 to 20 | Me | Me | SF₅ | (CH₂)ₐ | 0 to 20 | Me | 5 to 100 |
| 617 | C₄F₉ | (CH₂)ₐ | 0 to 20 | Me | Me | SF₅ | (CH₂)ₐ | 0 to 20 | Me | 5 to 100 |
| 618 | C₈F₁₇ | (CH₂)ₐ | 0 to 20 | Me | Me | SF₅ | (CH₂)ₐ | 0 to 20 | Me | 5 to 100 |
| 619 | c-C₆F₁₁ | (CH₂)ₐ | 0 to 20 | Me | Me | SF₅ | (CH₂)ₐ | 0 to 20 | Me | 5 to 100 |
| 620 | CHF₂ | (CH₂)ₐ | 0 to 20 | Me | Me | SF₅ | (CH₂)ₐ | 0 to 20 | Me | 5 to 100 |
| 621 | CClF₂ | (CH₂)ₐ | 0 to 20 | Me | Me | SF₅ | (CH₂)ₐ | 0 to 20 | Me | 5 to 100 |
| 622 | CBrF₂ | (CH₂)ₐ | 0 to 20 | Me | Me | SF₅ | (CH₂)ₐ | 0 to 20 | Me | 5 to 100 |
| 623 | ClF₂ | (CH₂)ₐ | 0 to 20 | Me | Me | SF₅ | (CH₂)ₐ | 0 to 20 | Me | 5 to 100 |
| 624 | CF═CF₂ | (CH₂)ₐ | 0 to 20 | Me | Me | SF₅ | (CH₂)ₐ | 0 to 20 | Me | 5 to 100 |
| 625 | CF═CFCF₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 615 | 0 | Me | Me | (CH₂)_{b} | 0 to 20 | Si | (CH₂)_{c} | 1 to 20 | Si(OMe)₃ | 3 |
| 616 | 0 | Me | Me | (CH₂)_{b} | 0 to 20 | Si | (CH₂)_{c} | 1 to 20 | Si(OMe)₃ | 3 |
| 617 | 0 | Me | Me | (CH₂)_{b} | 0 to 20 | Si | (CH₂)_{c} | 1 to 20 | Si(OMe)₃ | 3 |
| 618 | 0 | Me | Me | (CH₂)_{b} | 0 to 20 | Si | (CH₂)_{c} | 1 to 20 | Si(OMe)₃ | 3 |
| 619 | 0 | Me | Me | (CH₂)_{b} | 0 to 20 | Si | (CH₂)_{c} | 1 to 20 | Si(OMe)₃ | 3 |
| 620 | 0 | Me | Me | (CH₂)_{b} | 0 to 20 | Si | (CH₂)_{c} | 1 to 20 | Si(OMe)₃ | 3 |
| 621 | 0 | Me | Me | (CH₂)_{b} | 0 to 20 | Si | (CH₂)_{c} | 1 to 20 | Si(OMe)₃ | 3 |
| 622 | 0 | Me | Me | (CH₂)_{b} | 0 to 20 | Si | (CH₂)_{c} | 1 to 20 | Si(OMe)₃ | 3 |
| 623 | 0 | Me | Me | (CH₂)_{b} | 0 to 20 | Si | (CH₂)_{c} | 1 to 20 | Si(OMe)₃ | 3 |
| 624 | 0 | Me | Me | (CH₂)_{b} | 0 to 20 | Si | (CH₂)_{c} | 1 to 20 | Si(OMe)₃ | 3 |
| 625 | 0 | Me | Me | (CH₂)_{b} | 0 to 20 | Si | (CH₂)_{c} | 1 to 20 | Si(OMe)₃ | 3 |

TABLE 326

| No. | R²¹ | | a | R²² | R²³ | R²⁴ | | | R²⁵ | z21 |
|---|---|---|---|---|---|---|---|---|---|---|
| 626 | CF═CFCF═CF₂ | (CH₂)ₐ | 0 to 20 | Me | Me | SF₅ | (CH₂)ₐ | 0 to 20 | Me | 5 to 100 |
| 627 | C≡CCF₃ | (CH₂)ₐ | 0 to 20 | Me | Me | SF₅ | (CH₂)ₐ | 0 to 20 | Me | 5 to 100 |
| 628 | CF₂CH₃ | (CH₂)ₐ | 0 to 20 | Me | Me | SF₅ | (CH₂)ₐ | 0 to 20 | Me | 5 to 100 |
| 629 | (CF₂)₂H | (CH₂)ₐ | 0 to 20 | Me | Me | SF₅ | (CH₂)ₐ | 0 to 20 | Me | 5 to 100 |
| 630 | (CF₂)₂CH₃ | (CH₂)ₐ | 0 to 20 | Me | Me | SF₅ | (CH₂)ₐ | 0 to 20 | Me | 5 to 100 |
| 631 | (CF₂)₄H | (CH₂)ₐ | 0 to 20 | Me | Me | SF₅ | (CH₂)ₐ | 0 to 20 | Me | 5 to 100 |
| 632 | C₆F₅ | (CH₂)ₐ | 0 to 20 | Me | Me | SF₅ | (CH₂)ₐ | 0 to 20 | Me | 5 to 100 |
| 633 | 4-CF₃C₆F₄ | (CH₂)ₐ | 0 to 20 | Me | Me | SF₅ | (CH₂)ₐ | 0 to 20 | Me | 5 to 100 |
| 634 | 4-SF₅C₆F₄ | (CH₂)ₐ | 0 to 20 | Me | Me | SF₅ | (CH₂)ₐ | 0 to 20 | Me | 5 to 100 |
| 635 | 3,5-CF₃C₆F₃ | (CH₂)ₐ | 0 to 20 | Me | Me | SF₅ | (CH₂)ₐ | 0 to 20 | Me | 5 to 100 |
| 636 | 3,5-SFC₆F₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 626 | 0 | Me | Me | (CH₂)_{b} | 0 to 20 | Si | (CH₂)_{c} | 1 to 20 | Si(OMe)₃ | 3 |
| 627 | 0 | Me | Me | (CH₂)_{b} | 0 to 20 | Si | (CH₂)_{c} | 1 to 20 | Si(OMe)₃ | 3 |
| 628 | 0 | Me | Me | (CH₂)_{b} | 0 to 20 | Si | (CH₂)_{c} | 1 to 20 | Si(OMe)₃ | 3 |
| 629 | 0 | Me | Me | (CH₂)_{b} | 0 to 20 | Si | (CH₂)_{c} | 1 to 20 | Si(OMe)₃ | 3 |
| 630 | 0 | Me | Me | (CH₂)_{b} | 0 to 20 | Si | (CH₂)_{c} | 1 to 20 | Si(OMe)₃ | 3 |
| 631 | 0 | Me | Me | (CH₂)_{b} | 0 to 20 | Si | (CH₂)_{c} | 1 to 20 | Si(OMe)₃ | 3 |
| 632 | 0 | Me | Me | (CH₂)_{b} | 0 to 20 | Si | (CH₂)_{c} | 1 to 20 | Si(OMe)₃ | 3 |
| 633 | 0 | Me | Me | (CH₂)_{b} | 0 to 20 | Si | (CH₂)_{c} | 1 to 20 | Si(OMe)₃ | 3 |
| 634 | 0 | Me | Me | (CH₂)_{b} | 0 to 20 | Si | (CH₂)_{c} | 1 to 20 | Si(OMe)₃ | 3 |
| 635 | 0 | Me | Me | (CH₂)_{b} | 0 to 20 | Si | (CH₂)_{c} | 1 to 20 | Si(OMe)₃ | 3 |
| 636 | 0 | Me | Me | (CH₂)_{b} | 0 to 20 | Si | (CH₂)_{c} | 1 to 20 | Si(OMe)₃ | 3 |

TABLE 327

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 637 | 4-CF₃C₆H₄ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 638 | 4-SF₅C₆H₄ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 639 | 3,5-CF₃C₆H₃ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 640 | 3,5-SFC₆H₃ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 641 | 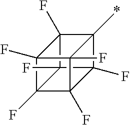 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 642 | 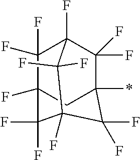 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 643 | 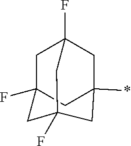 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 644 | SF₅ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 645 | OCF₃ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 646 | SCF₃ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 647 | N(CH₂CF₃)₂ | (CH₂)ₐ | 0 to | Me | Me | SF₅ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |

TABLE 328

| No. | R²¹ | | a | R²² | R²³ | R²⁴ | | | R²⁵ | z21 |
|---|---|---|---|---|---|---|---|---|---|---|
| 648 | N(CF₃)₂ | (CH₂)ₐ | 0 to 20 | Me | Me | SF₅ | (CH₂)ₐ | 0 to 20 | Me | 5 to 100 |
| 649 | Me | (CH₂)ₐ | 0 to 20 | Me | Me | OCF₃ | (CH₂)ₐ | 0 to 20 | Me | 5 to 100 |
| 650 | CF₃ | (CH₂)ₐ | 0 to 20 | Me | Me | OCF₃ | (CH₂)ₐ | 0 to 20 | Me | 5 to 100 |
| 651 | (CF₃)₂CF | (CH₂)ₐ | 0 to 20 | Me | Me | OCF₃ | (CH₂)ₐ | 0 to 20 | Me | 5 to 100 |
| 652 | (CF₃)₃C | (CH₂)ₐ | 0 to 20 | Me | Me | OCF₃ | (CH₂)ₐ | 0 to 20 | Me | 5 to 100 |
| 653 | C₄F₉ | (CH₂)ₐ | 0 to 20 | Me | Me | OCF₃ | (CH₂)ₐ | 0 to 20 | Me | 5 to 100 |
| 654 | C₈F₁₇ | (CH₂)ₐ | 0 to 20 | Me | Me | OCF₃ | (CH₂)ₐ | 0 to 20 | Me | 5 to 100 |
| 655 | c-C₆F₁₁ | (CH₂)ₐ | 0 to 20 | Me | Me | OCF₃ | (CH₂)ₐ | 0 to 20 | Me | 5 to 100 |
| 656 | CHF₂ | (CH₂)ₐ | 0 to 20 | Me | Me | OCF₃ | (CH₂)ₐ | 0 to 20 | Me | 5 to 100 |
| 657 | CClF₂ | (CH₂)ₐ | 0 to 20 | Me | Me | OCF₃ | (CH₂)ₐ | 0 to 20 | Me | 5 to 100 |
| 658 | CBrF₂ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 648 | 0 | Me | Me | (CH₂)_{b} | 0 to 20 | Si | (CH₂)_{c} | 1 to 20 | Si(OMe)₃ | 3 |
| 649 | 0 | Me | Me | (CH₂)_{b} | 0 to 20 | Si | (CH₂)_{c} | 1 to 20 | Si(OMe)₃ | 3 |
| 650 | 0 | Me | Me | (CH₂)_{b} | 0 to 20 | Si | (CH₂)_{c} | 1 to 20 | Si(OMe)₃ | 3 |
| 651 | 0 | Me | Me | (CH₂)_{b} | 0 to 20 | Si | (CH₂)_{c} | 1 to 20 | Si(OMe)₃ | 3 |
| 652 | 0 | Me | Me | (CH₂)_{b} | 0 to 20 | Si | (CH₂)_{c} | 1 to 20 | Si(OMe)₃ | 3 |
| 653 | 0 | Me | Me | (CH₂)_{b} | 0 to 20 | Si | (CH₂)_{c} | 1 to 20 | Si(OMe)₃ | 3 |
| 654 | 0 | Me | Me | (CH₂)_{b} | 0 to 20 | Si | (CH₂)_{c} | 1 to 20 | Si(OMe)₃ | 3 |
| 655 | 0 | Me | Me | (CH₂)_{b} | 0 to 20 | Si | (CH₂)_{c} | 1 to 20 | Si(OMe)₃ | 3 |
| 656 | 0 | Me | Me | (CH₂)_{b} | 0 to 20 | Si | (CH₂)_{c} | 1 to 20 | Si(OMe)₃ | 3 |
| 657 | 0 | Me | Me | (CH₂)_{b} | 0 to 20 | Si | (CH₂)_{c} | 1 to 20 | Si(OMe)₃ | 3 |
| 658 | 0 | Me | Me | (CH₂)_{b} | 0 to 20 | Si | (CH₂)_{c} | 1 to 20 | Si(OMe)₃ | 3 |

TABLE 329

| No. | R²¹ | | a | R²² | R²³ | R²⁴ | | | R²⁵ | z21 |
|---|---|---|---|---|---|---|---|---|---|---|
| 659 | ClF₂ | (CH₂)ₐ | 0 to 20 | Me | Me | OCF₃ | (CH₂)ₐ | 0 to 20 | Me | 5 to 100 |
| 660 | CF═CF₂ | (CH₂)ₐ | 0 to 20 | Me | Me | OCF₃ | (CH₂)ₐ | 0 to 20 | Me | 5 to 100 |
| 661 | CF═CFCF₃ | (CH₂)ₐ | 0 to 20 | Me | Me | OCF₃ | (CH₂)ₐ | 0 to 20 | Me | 5 to 100 |
| 662 | CF═CFCF═CF₂ | (CH₂)ₐ | 0 to 20 | Me | Me | OCF₃ | (CH₂)ₐ | 0 to 20 | Me | 5 to 100 |
| 663 | C≡CCF₃ | (CH₂)ₐ | 0 to 20 | Me | Me | OCF₃ | (CH₂)ₐ | 0 to 20 | Me | 5 to 100 |
| 664 | CF₂CH₃ | (CH₂)ₐ | 0 to 20 | Me | Me | OCF₃ | (CH₂)ₐ | 0 to 20 | Me | 5 to 100 |
| 665 | (CF₂)₂H | (CH₂)ₐ | 0 to 20 | Me | Me | OCF₃ | (CH₂)ₐ | 0 to 20 | Me | 5 to 100 |
| 666 | (CF₂)₂CH₃ | (CH₂)ₐ | 0 to 20 | Me | Me | OCF₃ | (CH₂)ₐ | 0 to 20 | Me | 5 to 100 |
| 667 | (CF₂)₄H | (CH₂)ₐ | 0 to 20 | Me | Me | OCF₃ | (CH₂)ₐ | 0 to 20 | Me | 5 to 100 |
| 668 | C₆F₅ | (CH₂)ₐ | 0 to 20 | Me | Me | OCF₃ | (CH₂)ₐ | 0 to 20 | Me | 5 to 100 |
| 669 | 4-CF₃C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 659 | 0 | Me | Me | (CH₂)_{b} | 0 to 20 | Si | (CH₂)_{c} | 1 to 20 | Si(OMe)₃ | 3 |
| 660 | 0 | Me | Me | (CH₂)_{b} | 0 to 20 | Si | (CH₂)_{c} | 1 to 20 | Si(OMe)₃ | 3 |
| 661 | 0 | Me | Me | (CH₂)_{b} | 0 to 20 | Si | (CH₂)_{c} | 1 to 20 | Si(OMe)₃ | 3 |
| 662 | 0 | Me | Me | (CH₂)_{b} | 0 to 20 | Si | (CH₂)_{c} | 1 to 20 | Si(OMe)₃ | 3 |
| 663 | 0 | Me | Me | (CH₂)_{b} | 0 to 20 | Si | (CH₂)_{c} | 1 to 20 | Si(OMe)₃ | 3 |
| 664 | 0 | Me | Me | (CH₂)_{b} | 0 to 20 | Si | (CH₂)_{c} | 1 to 20 | Si(OMe)₃ | 3 |
| 665 | 0 | Me | Me | (CH₂)_{b} | 0 to 20 | Si | (CH₂)_{c} | 1 to 20 | Si(OMe)₃ | 3 |
| 666 | 0 | Me | Me | (CH₂)_{b} | 0 to 20 | Si | (CH₂)_{c} | 1 to 20 | Si(OMe)₃ | 3 |
| 667 | 0 | Me | Me | (CH₂)_{b} | 0 to 20 | Si | (CH₂)_{c} | 1 to 20 | Si(OMe)₃ | 3 |
| 668 | 0 | Me | Me | (CH₂)_{b} | 0 to 20 | Si | (CH₂)_{c} | 1 to 20 | Si(OMe)₃ | 3 |
| 669 | 0 | Me | Me | (CH₂)_{b} | 0 to 20 | Si | (CH₂)_{c} | 1 to 20 | Si(OMe)₃ | 3 |

TABLE 330

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 670 | 4-SF₅C₆F₄ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 671 | 3,5-CF₃C₆F₃ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 672 | 3,5-SF₅C₆F₃ | (CH₂)ₐ | 0 to | Me | Me | OCF₃ | (CH₂)ₐ | 0 to | Me | 5 to | 0 | Me | \|Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 673 | 4-CF₃C₆H₄ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 674 | 4-SF₅C₆H₄ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 675 | 3,5-CF₃C₆H₃ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 676 | 3,5-SF₅C₆H₃ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 677 | 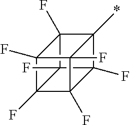 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 678 | 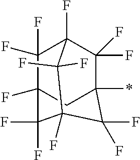 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 679 | 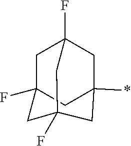 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 | \|Me | Me | (CH₂)_{b} | 0 to 20 | Si | (CH₂)_{c} | 1 to 20 | Si(OMe)₃ | 3 |
| 680 | SF₅ | (CH₂)ₐ | 0 to | Me | Me | OCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |

TABLE 331

| No. | R²¹ | | a | R²² | R²³ | R²⁴ | | | R²⁵ | z21 |
|---|---|---|---|---|---|---|---|---|---|---|
| 681 | OCF₃ | (CH₂)ₐ | 0 to 20 | Me | Me | OCF₃ | (CH₂)ₐ | 0 to 20 | Me | 5 to 100 |
| 682 | SCF₃ | (CH₂)ₐ | 0 to 20 | Me | Me | OCF₃ | (CH₂)ₐ | 0 to 20 | Me | 5 to 100 |
| 683 | N(CH₂CF₃)₂ | (CH₂)ₐ | 0 to 20 | Me | Me | OCF₃ | (CH₂)ₐ | 0 to 20 | Me | 5 to 100 |
| 684 | N(CF₃)₂ | (CH₂)ₐ | 0 to 20 | Me | Me | OCF₃ | (CH₂)ₐ | 0 to 20 | Me | 5 to 100 |
| 685 | Me | (CH₂)ₐ | 0 to 20 | Me | Me | SCF₃ | (CH₂)ₐ | 0 to 20 | Me | 5 to 100 |
| 686 | CF₃ | (CH₂)ₐ | 0 to 20 | Me | Me | SCF₃ | (CH₂)ₐ | 0 to 20 | Me | 5 to 100 |
| 687 | (CF₃)₂CF | (CH₂)ₐ | 0 to 20 | Me | Me | SCF₃ | (CH₂)ₐ | 0 to 20 | Me | 5 to 100 |
| 688 | (CF₃)₃C | (CH₂)ₐ | 0 to 20 | Me | Me | SCF₃ | (CH₂)ₐ | 0 to 20 | Me | 5 to 100 |
| 689 | C₄F₉ | (CH₂)ₐ | 0 to 20 | Me | Me | SCF₃ | (CH₂)ₐ | 0 to 20 | Me | 5 to 100 |
| 690 | C₈F₁₇ | (CH₂)ₐ | 0 to 20 | Me | Me | SCF₃ | (CH₂)ₐ | 0 to 20 | Me | 5 to 100 |
| 691 | c-C₆F₁₁ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 681 | 0 | Me | Me | (CH₂)_{b} | 0 to 20 | Si | (CH₂)_{c} | 1 to 20 | Si(OMe)₃ | 3 |
| 682 | 0 | Me | Me | (CH₂)_{b} | 0 to 20 | Si | (CH₂)_{c} | 1 to 20 | Si(OMe)₃ | 3 |
| 683 | 0 | Me | Me | (CH₂)_{b} | 0 to 20 | Si | (CH₂)_{c} | 1 to 20 | Si(OMe)₃ | 3 |
| 684 | 0 | Me | Me | (CH₂)_{b} | 0 to 20 | Si | (CH₂)_{c} | 1 to 20 | Si(OMe)₃ | 3 |
| 685 | 0 | Me | Me | (CH₂)_{b} | 0 to 20 | Si | (CH₂)_{c} | 1 to 20 | Si(OMe)₃ | 3 |
| 686 | 0 | Me | Me | (CH₂)_{b} | 0 to 20 | Si | (CH₂)_{c} | 1 to 20 | Si(OMe)₃ | 3 |
| 687 | 0 | Me | Me | (CH₂)_{b} | 0 to 20 | Si | (CH₂)_{c} | 1 to 20 | Si(OMe)₃ | 3 |
| 688 | 0 | Me | Me | (CH₂)_{b} | 0 to 20 | Si | (CH₂)_{c} | 1 to 20 | Si(OMe)₃ | 3 |
| 689 | 0 | Me | Me | (CH₂)_{b} | 0 to 20 | Si | (CH₂)_{c} | 1 to 20 | Si(OMe)₃ | 3 |
| 690 | 0 | Me | Me | (CH₂)_{b} | 0 to 20 | Si | (CH₂)_{c} | 1 to 20 | Si(OMe)₃ | 3 |
| 691 | 0 | Me | Me | (CH₂)_{b} | 0 to 20 | Si | (CH₂)_{c} | 1 to 20 | Si(OMe)₃ | 3 |

TABLE 332

| No. | R²¹ | | a | R²² | R²³ | R²⁴¹ | | | R²⁵ | z21 |
|---|---|---|---|---|---|---|---|---|---|---|
| 692 | CHF₂ | (CH₂)a | 0 to 20 | Me | Me | SCF₃ | (CH₂)ₐ | 0 to 20 | Me | 5 to 100 |
| 693 | CClF₂ | (CH₂)a | 0 to 20 | Me | Me | SCF₃ | (CH₂)ₐ | 0 to 20 | Me | 5 to 100 |
| 694 | CBrF₂ | (CH₂)a | 0 to 20 | Me | Me | SCF₃ | (CH₂)ₐ | 0 to 20 | Me | 5 to 100 |
| 695 | ClF₂ | (CH₂)a | 0 to 20 | Me | Me | SCF₃ | (CH₂)ₐ | 0 to 20 | Me | 5 to 100 |
| 696 | CF═CF₂ | (CH₂)a | 0 to 20 | Me | Me | SCF₃ | (CH₂)ₐ | 0 to 20 | Me | 5 to 100 |
| 697 | CF═CFCF₃ | (CH₂)a | 0 to 20 | Me | Me | SCF₃ | (CH₂)ₐ | 0 to 20 | Me | 5 to 100 |
| 698 | CF═CFCF═CF₂ | (CH₂)a | 0 to 20 | Me | Me | SCF₃ | (CH₂)ₐ | 0 to 20 | Me | 5 to 100 |
| 699 | C≡CCF₃ | (CH₂)a | 0 to 20 | Me | Me | SCF | (CH₂)ₐ | 0 to 20 | Me | 5 to 100 |
| 700 | CF₂CH₃ | (CH₂)a | 0 to 20 | Me | Me | SCF₃ | (CH₂)ₐ | 0 to 20 | Me | 5 to 100 |
| 701 | (CF₂)₂H | (CH₂)a | 0 to 20 | Me | Me | SCF₃ | (CH₂)ₐ | 0 to 20 | Me | 5 to 100 |
| 702 | (CF₂)₂CH₃ | (CH₂)a | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 692 | 0 | Me | Me | (CH₂)_{b} | 0 to 20 | Si | (CH₂)_{c} | 1 to 20 | Si(OMe)₃ | 3 |
| 693 | 0 | Me | Me | (CH₂)_{b} | 0 to 20 | Si | (CH₂)_{c} | 1 to 20 | Si(OMe)₃ | 3 |
| 694 | 0 | Me | Me | (CH₂)_{b} | 0 to 20 | Si | (CH₂)_{c} | 1 to 20 | Si(OMe)₃ | 3 |
| 695 | 0 | Me | Me | (CH₂)_{b} | 0 to 20 | Si | (CH₂)_{c} | 1 to 20 | Si(OMe)₃ | 3 |
| 696 | 0 | Me | Me | (CH₂)_{b} | 0 to 20 | Si | (CH₂)_{c} | 1 to 20 | Si(OMe)₃ | 3 |
| 697 | 0 | Me | Me | (CH₂)_{b} | 0 to 20 | Si | (CH₂)_{c} | 1 to 20 | Si(OMe)₃ | 3 |
| 698 | 0 | Me | Me | (CH₂)_{b} | 0 to 20 | Si | (CH₂)_{c} | 1 to 20 | Si(OMe)₃ | 3 |
| 699 | 0 | Me | Me | (CH₂)_{b} | 0 to 20 | Si | (CH₂)_{c} | 1 to 20 | Si(OMe)₃ | 3 |
| 700 | 0 | Me | Me | (CH₂)_{b} | 0 to 20 | Si | (CH₂)_{c} | 1 to 20 | Si(OMe)₃ | 3 |
| 701 | 0 | Me | Me | (CH₂)_{b} | 0 to 20 | Si | (CH₂)_{c} | 1 to 20 | Si(OMe)₃ | 3 |
| 702 | 0 | Me | Me | (CH₂)_{b} | 0 to 20 | Si | (CH₂)_{c} | 1 to 20 | Si(OMe)₃ | 3 |

TABLE 333

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 703 | (CF₂)₄H | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 704 | C₆F₅ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 705 | 4-CF₃C₆F₄ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 706 | 4-SF₅C₆F₄ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 707 | 3,5-CF₃C₆F₃ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 708 | 3,5-SFC₆F₃ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 709 | 4-CF₃C₆H₄ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 710 | 4-SF₅C₆H₄ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 711 | 3,5-CF₃C₆H₃ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 712 | 3,5-SF₅C₆H₃ | (CH₂)ₐ | 0 to | Me | Me | SCF₃ | (CH₂)ₐ | 0 to | Me | 5 to | 0 | Me | Me | (CH₂)_{b} | 0 to | Si | (CH₂)_{c} | 1 to | Si(OMe)₃ | 3 |
| | | | 20 | | | | | 20 | | 100 | | | | | 20 | | | 20 | | |
| 713 | 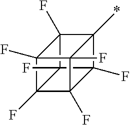 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |

TABLE 334

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 714 | 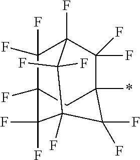 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 715 | 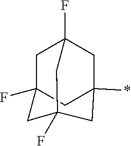 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 716 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 717 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 718 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 719 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 720 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 721 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 722 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 723 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 724 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |

TABLE 335

| No. | R²¹ | | a | R²² | R²³ | R²⁴ | | | R²⁵ | z21 |
|---|---|---|---|---|---|---|---|---|---|---|
| 725 | C₄F₉ | (CH₂)ₐ | 0 to 20 | Me | Me | N(CF₃)₂ | (CH₂)ₐ | 0 to 20 | Me | 5 to 100 |
| 726 | C₈F₁₇ | (CH₂)ₐ | 0 to 20 | Me | Me | N(CF₃)₂ | (CH₂)ₐ | 0 to 20 | Me | 5 to 100 |
| 727 | c-C₆F₁₁ | (CH₂)ₐ | 0 to 20 | Me | Me | N(CF₃)₂ | (CH₂)ₐ | 0 to 20 | Me | 5 to 100 |
| 728 | CHF₂ | (CH₂)ₐ | 0 to 20 | Me | Me | N(CF₃)₂ | (CH₂)ₐ | 0 to 20 | Me | 5 to 100 |
| 729 | CClF₂ | (CH₂)ₐ | 0 to 20 | Me | Me | N(CF₃)₂ | (CH₂)ₐ | 0 to 20 | Me | 5 to 100 |
| 730 | CBrF₂ | (CH₂)ₐ | 0 to 20 | Me | Me | N(CF₃)₂ | (CH₂)ₐ | 0 to 20 | Me | 5 to 100 |
| 731 | ClF₂ | (CH₂)ₐ | 0 to 20 | Me | Me | N(CF₃)₂ | (CH₂)ₐ | 0 to 20 | Me | 5 to 100 |
| 732 | CF═CF₂ | (CH₂)ₐ | 0 to 20 | Me | Me | N(CF₃)₂ | (CH₂)ₐ | 0 to 20 | Me | 5 to 100 |
| 733 | CF═CFCF₃ | (CH₂)ₐ | 0 to 20 | Me | Me | N(CF₃)₂ | (CH₂)ₐ | 0 to 20 | Me | 5 to 100 |
| 734 | CF═CFCF═CF₂ | (CH₂)ₐ | 0 to 20 | Me | Me | N(CF₃)₂ | (CH₂)ₐ | 0 to 20 | Me | 5 to 100 |
| 735 | C≡CCF₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 725 | 0 | Me | Me | (CH₂)_{b} | 0 to 20 | Si | (CH₂)_{c} | 1 to 20 | Si(OMe)₃ | 3 |
| 726 | 0 | Me | Me | (CH₂)_{b} | 0 to 20 | Si | (CH₂)_{c} | 1 to 20 | Si(OMe)₃ | 3 |
| 727 | 0 | Me | Me | (CH₂)_{b} | 0 to 20 | Si | (CH₂)_{c} | 1 to 20 | Si(OMe)₃ | 3 |
| 728 | 0 | Me | Me | (CH₂)_{b} | 0 to 20 | Si | (CH₂)_{c} | 1 to 20 | Si(OMe)₃ | 3 |
| 729 | 0 | Me | Me | (CH₂)_{b} | 0 to 20 | Si | (CH₂)_{c} | 1 to 20 | Si(OMe)₃ | 3 |
| 730 | 0 | Me | Me | (CH₂)_{b} | 0 to 20 | Si | (CH₂)_{c} | 1 to 20 | Si(OMe)₃ | 3 |
| 731 | 0 | Me | Me | (CH₂)_{b} | 0 to 20 | Si | (CH₂)_{c} | 1 to 20 | Si(OMe)₃ | 3 |
| 732 | 0 | Me | Me | (CH₂)_{b} | 0 to 20 | Si | (CH₂)_{c} | 1 to 20 | Si(OMe)₃ | 3 |
| 733 | 0 | Me | Me | (CH₂)_{b} | 0 to 20 | Si | (CH₂)_{c} | 1 to 20 | Si(OMe)₃ | 3 |
| 734 | 0 | Me | Me | (CH₂)_{b} | 0 to 20 | Si | (CH₂)_{c} | 1 to 20 | Si(OMe)₃ | 3 |
| 735 | 0 | Me | Me | (CH₂)_{b} | 0 to 20 | Si | (CH₂)_{c} | 1 to 20 | Si(OMe)₃ | 3 |

TABLE 336

| No. | R²¹ | | a | R²² | R²³ | R²⁴ | | | R²⁵ | z21 |
|---|---|---|---|---|---|---|---|---|---|---|
| 736 | CF₂CH₃ | (CH₂)ₐ | 0 to 20 | Me | Me | N(CF₃)₂ | (CH₂)ₐ | 0 to 20 | Me | 5 to 100 |
| 737 | (CF₂)₂H | (CH₂)ₐ | 0 to 20 | Me | Me | N(CF₃)₂ | (CH₂)ₐ | 0 to 20 | Me | 5 to 100 |
| 738 | (CF₂)₂CH₃ | (CH₂)ₐ | 0 to 20 | Me | Me | N(CF₃)₂ | (CH₂)ₐ | 0 to 20 | Me | 5 to 100 |
| 739 | (CF₂)₄H | (CH₂)ₐ | 0 to 20 | Me | Me | SCF₃ | (CH₂)ₐ | 0 to 20 | Me | 5 to 100 |
| 740 | C₆F₅ | (CH₂)ₐ | 0 to 20 | Me | Me | N(CF₃)₂ | (CH₂)ₐ | 0 to 20 | Me | 5 to 100 |
| 741 | 4-CF₃C₆F₄ | (CH₂)ₐ | 0 to 20 | Me | Me | N(CF₃)₂ | (CH₂)ₐ | 0 to 20 | Me | 5 to 100 |
| 742 | 4-SF₅C₆F₄ | (CH₂)ₐ | 0 to 20 | Me | Me | N(CF₃)₂ | (CH₂)ₐ | 0 to 20 | Me | 5 to 100 |
| 743 | 3,5-CF₃C₆F₃ | (CH₂)ₐ | 0 to 20 | Me | Me | N(CF₃)₂ | (CH₂)ₐ | 0 to 20 | Me | 5 to 100 |
| 744 | 3,5-SF₅C₆F₃ | (CH₂)ₐ | 0 to 20 | Me | Me | N(CF₃)₂ | (CH₂)ₐ | 0 to 20 | Me | 5 to 100 |
| 745 | 4-CF₃C₆H₄ | (CH₂)ₐ | 0 to 20 | Me | Me | N(CF₃)₂ | (CH₂)ₐ | 0 to 20 | Me | 5 to 100 |
| 746 | 4-SF₅C₆H₄ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 736 | 0 | Me | Me | (CH₂)_{b} | 0 to 20 | Si | (CH₂)_{c} | 1 to 20 | Si(OMe)₃ | 3 |
| 737 | 0 | Me | Me | (CH₂)_{b} | 0 to 20 | Si | (CH₂)_{c} | 1 to 20 | Si(OMe)₃ | 3 |
| 738 | 0 | Me | Me | (CH₂)_{b} | 0 to 20 | Si | (CH₂)_{c} | 1 to 20 | Si(OMe)₃ | 3 |
| 739 | 0 | Me | Me | (CH₂)_{b} | 0 to 20 | Si | (CH₂)_{c} | 1 to 20 | Si(OMe)₃ | 3 |
| 740 | 0 | Me | Me | (CH₂)_{b} | 0 to 20 | Si | (CH₂)_{c} | 1 to 20 | Si(OMe)₃ | 3 |
| 741 | 0 | Me | Me | (CH₂)_{b} | 0 to 20 | Si | (CH₂)_{c} | 1 to 20 | Si(OMe)₃ | 3 |
| 742 | 0 | Me | Me | (CH₂)_{b} | 0 to 20 | Si | (CH₂)_{c} | 1 to 20 | Si(OMe)₃ | 3 |
| 743 | 0 | Me | Me | (CH₂)_{b} | 0 to 20 | Si | (CH₂)_{c} | 1 to 20 | Si(OMe)₃ | 3 |
| 744 | 0 | Me | Me | (CH₂)_{b} | 0 to 20 | Si | (CH₂)_{c} | 1 to 20 | Si(OMe)₃ | 3 |
| 745 | 0 | Me | Me | (CH₂)_{b} | 0 to 20 | Si | (CH₂)_{c} | 1 to 20 | Si(OMe)₃ | 3 |
| 746 | 0 | Me | Me | (CH₂)_{b} | 0 to 20 | Si | (CH₂)_{c} | 1 to 20 | Si(OMe)₃ | 3 |

TABLE 337

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 747 | 3,5-CF₃C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 748 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 749 | 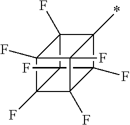 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 750 | 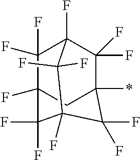 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | \|Me | Me | (CH₂)_{b} | 0 to 20 | Si | (CH₂)_{c} | 1 to 20 | Si(OMe)₃ | 3 |
| 751 | 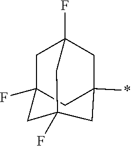 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 752 | SF₅ | (CH₂)ₐ | 0 to 20 | Me | Me | N(CF₃)₂ | (CH₂)ₐ | 0 to 20 | Me | 5 to 100 | 0 | \|Me | Me | (CH₂)_{b} | 0 to 20 | Si | (CH₂)_{c} | 1 to 20 | Si(OMe)₃ | 3 |
| 753 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 754 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 755 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 756 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | Si | (CH₂)_{c} | 1 to 20 | Si(OMe)₃ | 3 |
| 757 | Me | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | CH | (CH₂)_{c} | 1 to 20 | Si(OMe)₃ | 3 |

TABLE 338

| No. | R²¹ | | a | R²² | R²³ | R²⁴ | | | R²⁵ | z21 |
|---|---|---|---|---|---|---|---|---|---|---|
| 758 | CF₃ | (CH₂)ₐ | 0 to 20 | Me | Me | CF₃ | (CH₂)ₐ | 0 to 20 | Me | 5 to 100 |
| 759 | (CF₃)₂CF | (CH₂)ₐ | 0 to 20 | Me | Me | CF₃ | (CH₂)ₐ | 0 to 20 | Me | 5 to 100 |
| 760 | (CF₃)₃C | (CH₂)ₐ | 0 to 20 | Me | Me | CF₃ | (CH₂)ₐ | 0 to 20 | Me | 5 to 100 |
| 761 | C₄F₉ | (CH₂)ₐ | 0 to 20 | Me | Me | CF₃ | (CH₂)ₐ | 0 to 20 | Me | 5 to 100 |
| 762 | C₈F₁₇ | (CH₂)ₐ | 0 to 20 | Me | Me | CF₃ | (CH₂)ₐ | 0 to 20 | Me | 5 to 100 |
| 763 | c-C₆F₁₁ | (CH₂)ₐ | 0 to 20 | Me | Me | CF₃ | (CH₂)ₐ | 0 to 20 | Me | 5 to 100 |
| 764 | CHF₂ | (CH₂)ₐ | 0 to 20 | Me | Me | CF₃ | (CH₂)ₐ | 0 to 20 | Me | 5 to 100 |
| 765 | CClF₂ | (CH₂)ₐ | 0 to 20 | Me | Me | CF₃ | (CH₂)ₐ | 0 to 20 | Me | 5 to 100 |
| 766 | CBrF₂ | (CH₂)ₐ | 0 to 20 | Me | Me | CF₃ | (CH₂)ₐ | 0 to 20 | Me | 5 to 100 |
| 767 | ClF₂ | (CH₂)ₐ | 0 to 20 | Me | Me | CF₃ | (CH₂)ₐ | 0 to 20 | Me | 5 to 100 |
| 768 | CF═CF₂ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 758 | 0 | Me | Me | (CH₂)_{b} | 0 to 20 | CH | (CH₂)_{c} | 1 to 20 | Si(OMe)₃ | 3 |
| 759 | 0 | Me | Me | (CH₂)_{b} | 0 to 20 | CH | (CH₂)_{c} | 1 to 20 | Si(OMe)₃ | 3 |
| 760 | 0 | Me | Me | (CH₂)_{b} | 0 to 20 | C | (CH₂)_{c} | 1 to 20 | Si(OMe)₃ | 3 |
| 761 | 0 | Me | Me | (CH₂)_{b} | 0 to 20 | C | (CH₂)_{c} | 1 to 20 | Si(OMe)₃ | 3 |
| 762 | 0 | Me | Me | (CH₂)_{b} | 0 to 20 | C | (CH₂)_{c} | 1 to 20 | Si(OMe)₃ | 3 |
| 763 | 0 | Me | Me | (CH₂)_{b} | 0 to 20 | C | (CH₂)_{c} | 1 to 20 | Si(OMe)₃ | 3 |
| 764 | 0 | Me | Me | (CH₂)_{b} | 0 to 20 | C | (CH₂)_{c} | 1 to 20 | Si(OMe)₃ | 3 |
| 765 | 0 | Me | Me | (CH₂)_{b} | 0 to 20 | C | (CH₂)_{c} | 1 to 20 | Si(OMe)₃ | 3 |
| 766 | 0 | Me | Me | (CH₂)_{b} | 0 to 20 | C | (CH₂)_{c} | 1 to 20 | Si(OMe)₃ | 3 |
| 767 | 0 | Me | Me | (CH₂)_{b} | 0 to 20 | C | (CH₂)_{c} | 1 to 20 | Si(OMe)₃ | 3 |
| 768 | 0 | Me | Me | (CH₂)_{b} | 0 to 20 | C | (CH₂)_{c} | 1 to 20 | Si(OMe)₃ | 3 |

TABLE 339

| No. | R²¹ | | a | R²² | R²³ | R²⁴ | | | R²⁵ | z21 |
|---|---|---|---|---|---|---|---|---|---|---|
| 769 | CF═CFCF₃ | (CH₂)ₐ | 0 to 20 | Me | Me | CF₃ | (CH₂)ₐ | 0 to 20 | Me | 5 to 100 |
| 770 | CF═CFCF═CF₂ | (CH₂)ₐ | 0 to 20 | Me | Me | CF₃ | (CH₂)ₐ | 0 to 20 | Me | 5 to 100 |
| 771 | C≡CCF₃ | (CH₂)ₐ | 0 to 20 | Me | Me | CF₃ | (CH₂)ₐ | 0 to 20 | Me | 5 to 100 |
| 772 | CF₂CH₃ | (CH₂)ₐ | 0 to 20 | Me | Me | CF₃ | (CH₂)ₐ | 0 to 20 | Me | 5 to 100 |
| 773 | (CF₂)₂H | (CH₂)ₐ | 0 to 20 | Me | Me | CF₃ | (CH₂)ₐ | 0 to 20 | Me | 5 to 100 |
| 774 | (CF₂)₂CH₃ | (CH₂)ₐ | 0 to 20 | Me | Me | CF₃ | (CH₂)ₐ | 0 to 20 | Me | 5 to 100 |
| 775 | CF₂)₄H | (CH₂)ₐ | 0 to 20 | Me | Me | CF₃ | (CH₂)ₐ | 0 to 20 | Me | 5 to 100 |
| 776 | C₆F₅ | (CH₂)ₐ | 0 to 20 | Me | Me | CF₃ | (CH₂)ₐ | 0 to 20 | Me | 5 to 100 |
| 777 | 4-CF₃C₆F₄ | (CH₂)ₐ | 0 to 20 | Me | Me | CF₃ | (CH₂)ₐ | 0 to 20 | Me | 5 to 100 |
| 778 | 4-SF₅CF₄ | (CH₂)ₐ | 0 to 20 | Me | Me | CF₃ | (CH₂)ₐ | 0 to 20 | Me | 5 to 100 |
| 779 | 3,5-CF₃C₆F₃ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 769 | 0 | Me | Me | (CH₂)_{b} | 0 to 20 | C | (CH₂)_{c} | 1 to 20 | Si(OMe)₃ | 3 |
| 770 | 0 | Me | Me | (CH₂)_{b} | 0 to 20 | C | (CH₂)_{c} | 1 to 20 | Si(OMe)₃ | 3 |
| 771 | 0 | Me | Me | (CH₂)_{b} | 0 to 20 | C | (CH₂)_{c} | 1 to 20 | Si(OMe)₃ | 3 |
| 772 | 0 | Me | Me | (CH₂)_{b} | 0 to 20 | C | (CH₂)_{c} | 1 to 20 | Si(OMe)₃ | 3 |
| 773 | 0 | Me | Me | (CH₂)_{b} | 0 to 20 | C | (CH₂)_{c} | 1 to 20 | Si(OMe)₃ | 3 |
| 774 | 0 | Me | Me | (CH₂)_{b} | 0 to 20 | C | (CH₂)_{c} | 1 to 20 | Si(OMe)₃ | 3 |
| 775 | 0 | Me | Me | (CH₂)_{b} | 0 to 20 | C | (CH₂)_{c} | 1 to 20 | Si(OMe)₃ | 3 |
| 776 | 0 | Me | Me | (CH₂)_{b} | 0 to 20 | C | (CH₂)_{c} | 1 to 20 | Si(OMe)₃ | 3 |
| 777 | 0 | Me | Me | (CH₂)_{b} | 0 to 20 | C | (CH₂)_{c} | 1 to 20 | Si(OMe)₃ | 3 |
| 778 | 0 | Me | Me | (CH₂)_{b} | 0 to 20 | C | (CH₂)_{c} | 1 to 20 | Si(OMe)₃ | 3 |
| 779 | 0 | Me | Me | (CH₂)_{b} | 0 to 20 | C | (CH₂)_{c} | 1 to 20 | Si(OMe)₃ | 3 |

TABLE 340

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 780 | 3,5-SF₅C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 781 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 782 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 783 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 784 | 3,5-SF₅C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 785 | 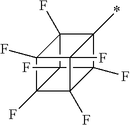 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 786 | 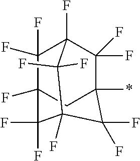 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 787 | 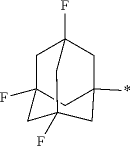 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 788 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 789 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 790\| | SCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 341

| No. | R²¹ | | a | R²² | R²³ | R²⁴ | | | R²⁵ | z21 |
|---|---|---|---|---|---|---|---|---|---|---|
| 791 | N(CH₂CF₃)₂ | (CH₂)ₐ | 0 to 20 | Me | Me | CF₃ | (CH₂)ₐ | 0 to 20 | Me | 5 to 100 |
| 792 | N(CF₃)₂ | (CH₂)ₐ | 0 to 20 | Me | Me | CF₃ | (CH₂)ₐ | 0 to 20 | Me | 5 to 100 |
| 793 | Me | (CH₂)ₐ | 0 to 20 | Me | Me | CHF₂ | (CH₂)ₐ | 0 to 20 | Me | 5 to 100 |
| 794 | CF₃ | (CH₂)ₐ | 0 to 20 | Me | Me | CHF₂ | (CH₂)ₐ | 0 to 20 | Me | 5 to 100 |
| 795 | (CF₃)₂CF | (CH₂)ₐ | 0 to 20 | Me | Me | CHF₂ | (CH₂)ₐ | 0 to 20 | Me | 5 to 100 |
| 796 | (CF₃)₃C | (CH₂)ₐ | 0 to 20 | Me | Me | CHF₂ | (CH₂)ₐ | 0 to 20 | Me | 5 to 100 |
| 797 | C₄F₉ | (CH₂)ₐ | 0 to 20 | Me | Me | CHF₂ | (CH₂)ₐ | 0 to 20 | Me | 5 to 100 |
| 798 | C₈F₁₇ | (CH₂)ₐ | 0 to 20 | Me | Me | CHF₂ | (CH₂)ₐ | 0 to 20 | Me | 5 to 100 |
| 799 | c-C₆F₁₁ | (CH₂)ₐ | 0 to 20 | Me | Me | CHF₂ | (CH₂)ₐ | 0 to 20 | Me | 5 to 100 |
| 800 | CHF₂ | (CH₂)ₐ | 0 to 20 | Me | Me | CHF₂ | (CH₂)ₐ | 0 to 20 | Me | 5 to 100 |
| 801 | CClF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 791 | 0 | Me | Me | (CH₂)_{b} | 0 to 20 | C | (CH₂)_{c} | 1 to 20 | Si(OMe)₃ | 3 |
| 792 | 0 | Me | Me | (CH₂)_{b} | 0 to 20 | C | (CH₂)_{c} | 1 to 20 | Si(OMe)₃ | 3 |
| 793 | 0 | Me | Me | (CH₂)_{b} | 0 to 20 | C | (CH₂)_{c} | 1 to 20 | Si(OMe)₃ | 3 |
| 794 | 0 | Me | Me | (CH₂)_{b} | 0 to 20 | C | (CH₂)_{c} | 1 to 20 | Si(OMe)₃ | 3 |
| 795 | 0 | Me | Me | (CH₂)_{b} | 0 to 20 | C | (CH₂)_{c} | 1 to 20 | Si(OMe)₃ | 3 |
| 796 | 0 | Me | Me | (CH₂)_{b} | 0 to 20 | C | (CH₂)_{c} | 1 to 20 | Si(OMe)₃ | 3 |
| 797 | 0 | Me | Me | (CH₂)_{b} | 0 to 20 | C | (CH₂)_{c} | 1 to 20 | Si(OMe)₃ | 3 |
| 798 | 0 | Me | Me | (CH₂)_{b} | 0 to 20 | C | (CH₂)_{c} | 1 to 20 | Si(OMe)₃ | 3 |
| 799 | 0 | Me | Me | (CH₂)_{b} | 0 to 20 | C | (CH₂)_{c} | 1 to 20 | Si(OMe)₃ | 3 |
| 800 | 0 | Me | Me | (CH₂)_{b} | 0 to 20 | C | (CH₂)_{c} | 1 to 20 | Si(OMe)₃ | 3 |
| 801 | 0 | Me | Me | (CH₂)_{b} | 0 to 20 | C | (CH₂)_{c} | 1 to 20 | Si(OMe)₃ | 3 |

TABLE 342

| No. | R²¹ | | a | R²² | R²³ | R²⁴ | | | R²⁵ | z21 |
|---|---|---|---|---|---|---|---|---|---|---|
| 802 | CBrF₂ | (CH₂)ₐ | 0 to 20 | Me | Me | CHF₂ | (CH₂)ₐ | 0 to 20 | Me | 5 to 100 |
| 803 | ClF₂ | (CH₂)ₐ | 0 to 20 | Me | Me | CHF₂ | (CH₂)ₐ | 0 to 20 | Me | 5 to 100 |
| 804 | CF═CF₂ | (CH₂)ₐ | 0 to 20 | Me | Me | CHF₂ | (CH₂)ₐ | 0 to 20 | Me | 5 to 100 |
| 805 | CF═CFCF₃ | (CH₂)ₐ | 0 to 20 | Me | Me | CHF₂ | (CH₂)ₐ | 0 to 20 | Me | 5 to 100 |
| 806 | CF═CFCF═CF₂ | (CH₂)ₐ | 0 to 20 | Me | Me | CHF₂ | (CH₂)ₐ | 0 to 20 | Me | 5 to 100 |
| 807 | C≡CCF₃ | (CH₂)ₐ | 0 to 20 | Me | Me | CHF₂ | (CH₂)ₐ | 0 to 20 | Me | 5 to 100 |
| 808 | CF₂CH₃ | (CH₂)ₐ | 0 to 20 | Me | Me | CHF₂ | (CH₂)ₐ | 0 to 20 | Me | 5 to 100 |
| 809 | (CF₂)₂H | (CH₂)ₐ | 0 to 20 | Me | Me | CHF₂ | (CH₂)ₐ | 0 to 20 | Me | 5 to 100 |
| 810 | (CF₂)₂CH₃ | (CH₂)ₐ | 0 to 20 | Me | Me | CHF₂ | (CH₂)ₐ | 0 to 20 | Me | 5 to 100 |
| 811 | (CF₂)₄H | (CH₂)ₐ | 0 to 20 | Me | Me | CHF₂ | (CH₂)ₐ | 0 to 20 | Me | 5 to 100 |
| 812 | C₆F₅ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 802 | 0 | Me | Me | (CH₂)_{b} | 0 to 20 | C | (CH₂)_{c} | 1 to 20 | Si(OMe)₃ | 3 |
| 803 | 0 | Me | Me | (CH₂)_{b} | 0 to 20 | C | (CH₂)_{c} | 1 to 20 | Si(OMe)₃ | 3 |
| 804 | 0 | Me | Me | (CH₂)_{b} | 0 to 20 | C | (CH₂)_{c} | 1 to 20 | Si(OMe)₃ | 3 |
| 805 | 0 | Me | Me | (CH₂)_{b} | 0 to 20 | C | (CH₂)_{c} | 1 to 20 | Si(OMe)₃ | 3 |
| 806 | 0 | Me | Me | (CH₂)_{b} | 0 to 20 | C | (CH₂)_{c} | 1 to 20 | Si(OMe)₃ | 3 |
| 807 | 0 | Me | Me | (CH₂)_{b} | 0 to 20 | C | (CH₂)_{c} | 1 to 20 | Si(OMe)₃ | 3 |
| 808 | 0 | Me | Me | (CH₂)_{b} | 0 to 20 | C | (CH₂)_{c} | 1 to 20 | Si(OMe)₃ | 3 |
| 809 | 0 | Me | Me | (CH₂)_{b} | 0 to 20 | C | (CH₂)_{c} | 1 to 20 | Si(OMe)₃ | 3 |
| 810 | 0 | Me | Me | (CH₂)_{b} | 0 to 20 | C | (CH₂)_{c} | 1 to 20 | Si(OMe)₃ | 3 |
| 811 | 0 | Me | Me | (CH₂)_{b} | 0 to 20 | C | (CH₂)_{c} | 1 to 20 | Si(OMe)₃ | 3 |
| 812 | 0 | Me | Me | (CH₂)_{b} | 0 to 20 | C | (CH₂)_{c} | 1 to 20 | Si(OMe)₃ | 3 |

TABLE 343

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 813 | 4-CF₃C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 814 | 4-SF₅C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 815 | 3,5-CF₃C₆F₃ | (CH₂)ₐ | 0 to 20 | Me | Me | CHF₂ | (CH₂)ₐ | 0 to 20 | Me | 5 to 100 | 0 | \|Me | Me | (CH₂)_{b} | 0 to 20 | C | (CH₂)_{c} | 1 to 20 | Si(OMe)₃ | 3 |
| 816 | 3,5-SF₅C₆F₃ | (CH₂)ₐ | 0 to 20 | Me | Me | CHF₂ | (CH₂)ₐ | 0 to 20 | Me | 5 to 100 | 0 | \|Me | Me | (CH₂)_{b} | 0 to 20 | C | (CH₂)_{c} | 1 to 20 | Si(OMe)₃ | 3 |
| 817 | 4-CF₃C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 818 | 4-SF₅C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 819 | 3,5-CF₃C₆H₃ | (CH₂)ₐ | 0 to 20 | Me | Me | CHF₂ | (CH₂)ₐ | 0 to 20 | Me | 5 to 100 | 0 | \|Me | Me | (CH₂)_{b} | 0 to 20 | C | (CH₂)_{c} | 1 to 20 | Si(OMe)₃ | 3 |
| 820 | 3,5-SF₅C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 821 | 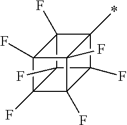 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 822 | 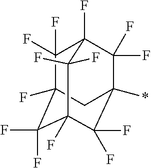 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | \|Me | Me | (CH₂)_{b} | 0 to 20 | C | (CH₂)_{c} | 1 to 20 | Si(OMe)₃ | 3 |
| 823 | 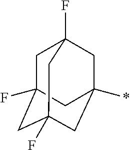 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 344

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 824 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 825 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 826 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 827 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 828 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 829 | Me | (CH₂)ₐ | 0 to 20 | Me | Me | 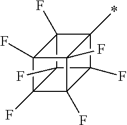 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 830 | CF₃ | (CH₂)ₐ | 0 to 20 | Me | Me | 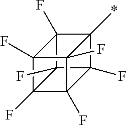 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 831 | (CF₃)₂CF | (CH₂)ₐ | 0 to 20 | Me | Me | 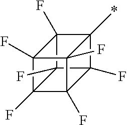 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 832 | (CF₃)₃C | (CH₂)ₐ | 0 to 20 | Me | Me | 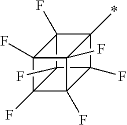 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 833 | C₄F₉ | (CH₂)ₐ | 0 to 20 | Me | Me | 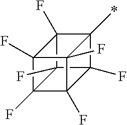 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 834 | C₈F₁₇ | (CH₂)ₐ | 0 to 20 | Me | Me | 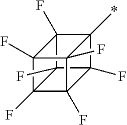 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 345

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 835 | c-C₆F₁₁ | (CH₂)ₐ | 0 to 20 | Me | Me | 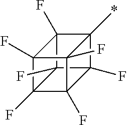 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 836 | CHF₂ | (CH₂)ₐ | 0 to 20 | Me | Me | 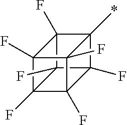 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 837 | CClF₂ | (CH₂)ₐ | 0 to 20 | Me | Me | 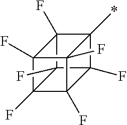 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 838 | CBrF₂ | (CH₂)ₐ | 0 to 20 | Me | Me | 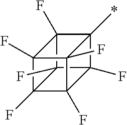 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 839 | ClF₂ | (CH₂)ₐ | 0 to 20 | Me | Me | 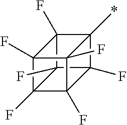 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 840 | CF═CF₂ | (CH₂)ₐ | 0 to 20 | Me | Me | 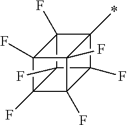 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 841 | CF═CFCF₃ | (CH₂)ₐ | 0 to 20 | Me | Me | 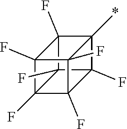 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 842 | CF═CFCF═CF₂ | (CH₂)ₐ | 0 to 20 | Me | Me | 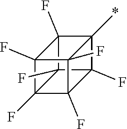 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 843 | C≡CCF₃ | (CH₂)ₐ | 0 to 20 | Me | Me | 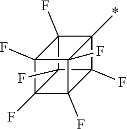 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 844 | CF₂CH₃ | (CH₂)ₐ | 0 to 20 | Me | Me | 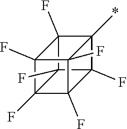 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 845 | (CF₂)₂H | (CH₂)ₐ | 0 to 20 | Me | Me | 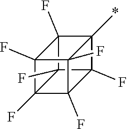 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 346

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 846 | (CF₂)₂CH₃ | (CH₂)ₐ | 0 to 20 | Me | Me | 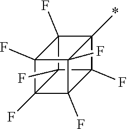 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 847 | (CF₂)₄H | (CH₂)ₐ | 0 to 20 | Me | Me | 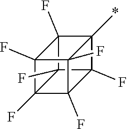 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 848 | C₆F₅ | (CH₂)ₐ | 0 to 20 | Me | Me | 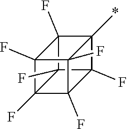 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 849 | 4-CF₃C₆F₄ | (CH₂)ₐ | 0 to 20 | Me | Me | 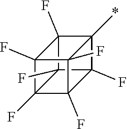 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 850 | 4-SF₅C₆F₄ | (CH₂)ₐ | 0 to 20 | Me | Me | 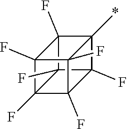 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 851 | 3,5-CF₃C₆F₃ | (CH₂)ₐ | 0 to 20 | Me | Me | 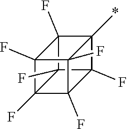 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 852 | 3,5-SF₅C₆F₃ | (CH₂)ₐ | 0 to 20 | Me | Me | 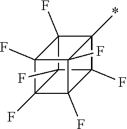 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 853 | 4-CF₃C₆H₄ | (CH₂)ₐ | 0 to 20 | Me | Me | 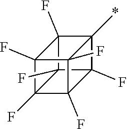 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 854 | 4-SF₅C₆H₄ | (CH₂)ₐ | 0 to 20 | Me | Me | 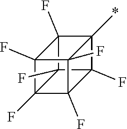 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 855 | 3,5-CF₃C₆H₃ | (CH₂)ₐ | 0 to 20 | Me | Me | 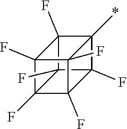 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 856 | 3,5-SF₅C₆H₃ | (CH₂)ₐ | 0 to 20 | Me | Me | 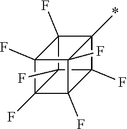 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 347

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 857 | 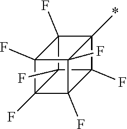 [SMILES: *C12C3(F)C4(F)C1(F)C1(F)C2(F)C3(F)C41F] | (CH₂)ₐ | 0 to 20 | Me | Me | 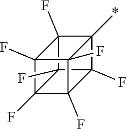 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 858 | 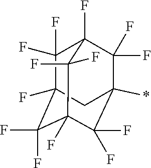 [SMILES: *C12CC3(F)C(F)(F)C(F)(C1(F)F)C(F)(F)C(F)(C2(F)F)C3(F)F] | (CH₂)ₐ | 0 to 20 | Me | Me | 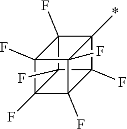 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 859 | 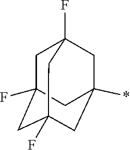 [SMILES: *C12CC3(F)CC(F)(C1)CC(F)(C2)C3] | (CH₂)ₐ | 0 to 20 | Me | Me | 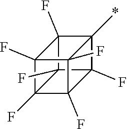 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 860 | SF₅ | (CH₂)ₐ | 0 to 20 | Me | Me | 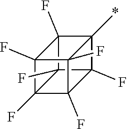 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 861 | OCF₃ | (CH₂)ₐ | 0 to 20 | Me | Me | 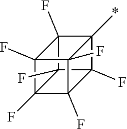 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 862 | SCF₃ | (CH₂)ₐ | 0 to 20 | Me | Me | 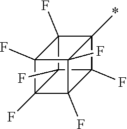 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 863 | N(CH₂CF₃)₂ | (CH₂)ₐ | 0 to 20 | Me | Me | 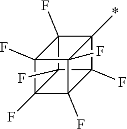 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 864 | N(CF₃)₂ | (CH₂)ₐ | 0 to 20 | Me | Me | 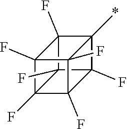 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 865 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 866 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 867 | (CF₃)₂CF | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 348

| No. | R²¹ | | a | R²² | R²³ | R²⁴ | | | R²⁵ | z21 |
|---|---|---|---|---|---|---|---|---|---|---|
| 868 | (CF₃)₃C | (CH₂)ₐ | 0 to 20 | Me | Me | SF₅ | (CH₂)ₐ | 0 to 20 | Me | 5 to 100 |
| 869 | C₄F₉ | (CH₂)ₐ | 0 to 20 | Me | Me | SF₅ | (CH₂)ₐ | 0 to 20 | Me | 5 to 100 |
| 870 | C₈F₁₇ | (CH₂)ₐ | 0 to 20 | Me | Me | SF₅ | (CH₂)ₐ | 0 to 20 | Me | 5 to 100 |
| 871 | c-C₆F₁₁ | (CH₂)ₐ | 0 to 20 | Me | Me | SF₅ | (CH₂)ₐ | 0 to 20 | Me | 5 to 100 |
| 872 | CHF₂ | (CH₂)ₐ | 0 to 20 | Me | Me | SF₅ | (CH₂)ₐ | 0 to 20 | Me | 5 to 100 |
| 873 | CClF₂ | (CH₂)ₐ | 0 to 20 | Me | Me | SF₅ | (CH₂)ₐ | 0 to 20 | Me | 5 to 100 |
| 874 | CBrF₂ | (CH₂)ₐ | 0 to 20 | Me | Me | SF₅ | (CH₂)ₐ | 0 to 20 | Me | 5 to 100 |
| 875 | ClF₂ | (CH₂)ₐ | 0 to 20 | Me | Me | SF₅ | (CH₂)ₐ | 0 to 20 | Me | 5 to 100 |
| 876 | CF═CF₂ | (CH₂)ₐ | 0 to 20 | Me | Me | SF₅ | (CH₂)ₐ | 0 to 20 | Me | 5 to 100 |
| 877 | CF═CFCF₃ | (CH₂)ₐ | 0 to 20 | Me | Me | SF₅ | (CH₂)ₐ | 0 to 20 | Me | 5 to 100 |
| 878 | CF═CFCF═CF₂ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 868 | 0 | Me | Me | (CH₂)_{b} | 0 to 20 | C | (CH₂)_{c} | 1 to 20 | Si(OMe)₃ | 3 |
| 869 | 0 | Me | Me | (CH₂)_{b} | 0 to 20 | C | (CH₂)_{c} | 1 to 20 | Si(OMe)₃ | 3 |
| 870 | 0 | Me | Me | (CH₂)_{b} | 0 to 20 | C | (CH₂)_{c} | 1 to 20 | Si(OMe)₃ | 3 |
| 871 | 0 | Me | Me | (CH₂)_{b} | 0 to 20 | C | (CH₂)_{c} | 1 to 20 | Si(OMe)₃ | 3 |
| 872 | 0 | Me | Me | (CH₂)_{b} | 0 to 20 | C | (CH₂)_{c} | 1 to 20 | Si(OMe)₃ | 3 |
| 873 | 0 | Me | Me | (CH₂)_{b} | 0 to 20 | C | (CH₂)_{c} | 1 to 20 | Si(OMe)₃ | 3 |
| 874 | 0 | Me | Me | (CH₂)_{b} | 0 to 20 | C | (CH₂)_{c} | 1 to 20 | Si(OMe)₃ | 3 |
| 875 | 0 | Me | Me | (CH₂)_{b} | 0 to 20 | C | (CH₂)_{c} | 1 to 20 | Si(OMe)₃ | 3 |
| 876 | 0 | Me | Me | (CH₂)_{b} | 0 to 20 | C | (CH₂)_{c} | 1 to 20 | Si(OMe)₃ | 3 |
| 877 | 0 | Me | Me | (CH₂)_{b} | 0 to 20 | C | (CH₂)_{c} | 1 to 20 | Si(OMe)₃ | 3 |
| 878 | 0 | Me | Me | (CH₂)_{b} | 0 to 20 | C | (CH₂)_{c} | 1 to 20 | Si(OMe)₃ | 3 |

TABLE 349

| No. | R²¹ | | a | R²² | R²³ | R²⁴ | | | R²⁵ | z21 |
|---|---|---|---|---|---|---|---|---|---|---|
| 879 | C≡CCF₃ | (CH₂)ₐ | 0 to 20 | Me | Me | SF₅ | (CH₂)ₐ | 0 to 20 | Me | 5 to 100 |
| 880 | CF₂CH₃ | (CH₂)ₐ | 0 to 20 | Me | Me | SF₅ | (CH₂)ₐ | 0 to 20 | Me | 5 to 100 |
| 881 | (CF₂)₂H | (CH₂)ₐ | 0 to 20 | Me | Me | SF₅ | (CH₂)ₐ | 0 to 20 | Me | 5 to 100 |
| 882 | (CF₂)₂CH₃ | (CH₂)ₐ | 0 to 20 | Me | Me | SF₅ | (CH₂)ₐ | 0 to 20 | Me | 5 to 100 |
| 883 | (CF₂)₄H | (CH₂)ₐ | 0 to 20 | Me | Me | SF₅ | (CH₂)ₐ | 0 to 20 | Me | 5 to 100 |
| 884 | C₆F₅ | (CH₂)ₐ | 0 to 20 | Me | Me | SF₅ | (CH₂)ₐ | 0 to 20 | Me | 5 to 100 |
| 885 | 4-CF₃CF₄ | (CH₂)ₐ | 0 to 20 | Me | Me | SF₅ | (CH₂)ₐ | 0 to 20 | Me | 5 to 100 |
| 886 | 4-SF₅C₆F₄ | (CH₂)ₐ | 0 to 20 | Me | Me | SF₅ | (CH₂)ₐ | 0 to 20 | Me | 5 to 100 |
| 887 | 3,5-CF₃C₆F₃ | (CH₂)ₐ | 0 to 20 | Me | Me | SF₅ | (CH₂)ₐ | 0 to 20 | Me | 5 to 100 |
| 888 | 3,5-SFC₆F₃ | (CH₂)ₐ | 0 to 20 | Me | Me | SF₅ | (CH₂)ₐ | 0 to 20 | Me | 5 to 100 |
| 889 | 4-CF₃C₆H₄ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 879 | 0 | Me | Me | (CH₂)_{b} | 0 to 20 | C | (CH₂)_{c} | 1 to 20 | Si(OMe)₃ | 3 |
| 880 | 0 | Me | M? | (CH₂)_{b} | 0 to 20 | C | (CH₂)_{c} | 1 to 20 | Si(OMe)₃ | 3 |
| 881 | 0 | Me | Me | (CH₂)_{b} | 0 to 20 | C | (CH₂)_{c} | 1 to 20 | Si(OMe)₃ | 3 |
| 882 | 0 | Me | Me | (CH₂)_{b} | 0 to 20 | C | (CH₂)_{c} | 1 to 20 | Si(OMe)₃ | 3 |
| 883 | 0 | Me | Me | (CH₂)_{b} | 0 to 20 | C | (CH₂)_{c} | 1 to 20 | Si(OMe)₃ | 3 |
| 884 | 0 | Me | Me | (CH₂)_{b} | 0 to 20 | C | (CH₂)_{c} | 1 to 20 | Si(OMe)₃ | 3 |
| 885 | 0 | Me | Me | (CH₂)_{b} | 0 to 20 | C | (CH₂)_{c} | 1 to 20 | Si(OMe)₃ | 3 |
| 886 | 0 | Me | Me | (CH₂)_{b} | 0 to 20 | C | (CH₂)_{c} | 1 to 20 | Si(OMe)₃ | 3 |
| 887 | 0 | Me | Me | (CH₂)_{b} | 0 to 20 | C | (CH₂)_{c} | 1 to 20 | Si(OMe)₃ | 3 |
| 888 | 0 | Me | Me | (CH₂)_{b} | 0 to 20 | C | (CH₂)_{c} | 1 to 20 | Si(OMe)₃ | 3 |
| 889 | 0 | Me | Me | (CH₂)_{b} | 0 to 20 | C | (CH₂)_{c} | 1 to 20 | Si(OMe)₃ | 3 |

TABLE 350

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 890 | 4-SF₅C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 891 | 3,5-CF₃C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 892 | 3,5-SF₅C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 893 | 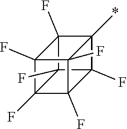 [SMILES: *C12C3(F)C4(F)C1(F)C1(F)C2(F)C3(F)C41F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 894 | 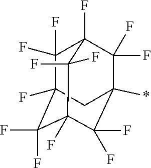 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 895 | 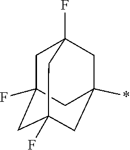 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 896 | SF₅ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 897 | OCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 898 | SCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 899 | N(CH₂CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 900 | N(CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 351

| No. | R²¹ | | a | R²² | R²³ | R²⁴ | | | R²⁵ | z21 |
|---|---|---|---|---|---|---|---|---|---|---|
| 901 | Me | (CH₂)ₐ | 0 to 20 | Me | Me | OCF₃ | (CH₂)ₐ | 0 to 20 | Me | 5 to 100 |
| 902 | CF₃ | (CH₂)ₐ | 0 to 20 | Me | Me | OCF₃ | (CH₂)ₐ | 0 to 20 | Me | 5 to 100 |
| 903 | (CF₃)₂CF | (CH₂)ₐ | 0 to 20 | Me | Me | OCF₃ | (CH₂)ₐ | 0 to 20 | Me | 5 to 100 |
| 904 | (CF₃)₃C | (CH₂)ₐ | 0 to 20 | Me | Me | OCF₃ | (CH₂)ₐ | 0 to 20 | Me | 5 to 100 |
| 905 | C₄F₉ | (CH₂)ₐ | 0 to 20 | Me | Me | OCF₃ | (CH₂)ₐ | 0 to 20 | Me | 5 to 100 |
| 906 | C₈F₁₇ | (CH₂)ₐ | 0 to 20 | Me | Me | OCF₃ | (CH₂)ₐ | 0 to 20 | Me | 5 to 100 |
| 907 | c-C₆F₁₁ | (CH₂)ₐ | 0 to 20 | Me | Me | OCF₃ | (CH₂)ₐ | 0 to 20 | Me | 5 to 100 |
| 908 | CHF₂ | (CH₂)ₐ | 0 to 20 | Me | Me | OCF₃ | (CH₂)ₐ | 0 to 20 | Me | 5 to 100 |
| 909 | CClF₂ | (CH₂)ₐ | 0 to 20 | Me | Me | OCF₃ | (CH₂)ₐ | 0 to 20 | Me | 5 to 100 |
| 910 | CBrF₂ | (CH₂)ₐ | 0 to 20 | Me | Me | OCF₃ | (CH₂)ₐ | 0 to 20 | Me | 5 to 100 |
| 911 | ClF₂ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 901 | 0 | Me | Me | (CH₂)_{b} | 0 to 20 | C | (CH₂)_{c} | 1 to 20 | Si(OMe)₃ | 3 |
| 902 | 0 | Me | Me | (CH₂)_{b} | 0 to 20 | C | (CH₂)_{c} | 1 to 20 | Si(OMe)₃ | 3 |
| 903 | 0 | Me | Me | (CH₂)_{b} | 0 to 20 | C | (CH₂)_{c} | 1 to 20 | Si(OMe)₃ | 3 |
| 904 | 0 | Me | Me | (CH₂)_{b} | 0 to 20 | C | (CH₂)_{c} | 1 to 20 | Si(OMe)₃ | 3 |
| 905 | 0 | Me | Me | (CH₂)_{b} | 0 to 20 | C | (CH₂)_{c} | 1 to 20 | Si(OMe)₃ | 3 |
| 906 | 0 | Me | Me | (CH₂)_{b} | 0 to 20 | C | (CH₂)_{c} | 1 to 20 | Si(OMe)₃ | 3 |
| 907 | 0 | Me | Me | (CH₂)_{b} | 0 to 20 | C | (CH₂)_{c} | 1 to 20 | Si(OMe)₃ | 3 |
| 908 | 0 | Me | Me | (CH₂)_{b} | 0 to 20 | C | (CH₂)_{c} | 1 to 20 | Si(OMe)₃ | 3 |
| 909 | 0 | Me | Me | (CH₂)_{b} | 0 to 20 | C | (CH₂)_{c} | 1 to 20 | Si(OMe)₃ | 3 |
| 910 | 0 | Me | Me | (CH₂)_{b} | 0 to 20 | C | (CH₂)_{c} | 1 to 20 | Si(OMe)₃ | 3 |
| 911 | 0 | Me | Me | (CH₂)_{b} | 0 to 20 | C | (CH₂)_{c} | 1 to 20 | Si(OMe)₃ | 3 |

TABLE 352

| No. | R²¹ | | a | R²² | R²³ | R²⁴ | | | R²⁵ | z21 |
|---|---|---|---|---|---|---|---|---|---|---|
| 912 | CF═CF₂ | (CH₂)ₐ | 0 to 20 | Me | Me | OCF₃ | (CH₂)ₐ | 0 to 20 | Me | 5 to 100 |
| 913 | CF═CFCF₃ | (CH₂)ₐ | 0 to 20 | Me | Me | OCF₃ | (CH₂)ₐ | 0 to 20 | Me | 5 to 100 |
| 914 | CF═CFCF═CF₂ | (CH₂)ₐ | 0 to 20 | Me | Me | OCF₃ | (CH₂)ₐ | 0 to 20 | Me | 5 to 100 |
| 915 | C≡CCF₃ | (CH₂)ₐ | 0 to 20 | Me | Me | OCF₃ | (CH₂)ₐ | 0 to 20 | Me | 5 to 100 |
| 916 | CF₂CH₃ | (CH₂)ₐ | 0 to 20 | Me | Me | OCF₃ | (CH₂)ₐ | 0 to 20 | Me | 5 to 100 |
| 917 | (CF₂)₂H | (CH₂)ₐ | 0 to 20 | Me | Me | OCF₃ | (CH₂)ₐ | 0 to 20 | Me | 5 to 100 |
| 918 | (CF₂)₂CH₃ | (CH₂)ₐ | 0 to 20 | Me | Me | OCF₃ | (CH₂)ₐ | 0 to 20 | Me | 5 to 100 |
| 919 | (CF₂)₄H | (CH₂)ₐ | 0 to 20 | Me | Me | OCF₃ | (CH₂)ₐ | 0 to 20 | Me | 5 to 100 |
| 920 | C₆F₅ | (CH₂)ₐ | 0 to 20 | Me | Me | OCF₃ | (CH₂)ₐ | 0 to 20 | Me | 5 to 100 |
| 921 | 4-CF₃C₆F₄ | (CH₂)ₐ | 0 to 20 | Me | Me | OCF₃ | (CH₂)ₐ | 0 to 20 | Me | 5 to 100 |
| 922 | 4-SF₅C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 912 | 0 | Me | Me | (CH₂)_{b} | 0 to 20 | C | (CH₂)_{c} | 1 to 20 | Si(OMe)₃ | 3 |
| 913 | 0 | Me | Me | (CH₂)_{b} | 0 to 20 | C | (CH₂)_{c} | 1 to 20 | Si(OMe)₃ | 3 |
| 914 | 0 | Me | Me | (CH₂)_{b} | 0 to 20 | C | (CH₂)_{c} | 1 to 20 | Si(OMe)₃ | 3 |
| 915 | 0 | Me | Me | (CH₂)_{b} | 0 to 20 | C | (CH₂)_{c} | 1 to 20 | Si(OMe)₃ | 3 |
| 916 | 0 | Me | Me | (CH₂)_{b} | 0 to 20 | C | (CH₂)_{c} | 1 to 20 | Si(OMe)₃ | 3 |
| 917 | 0 | Me | Me | (CH₂)_{b} | 0 to 20 | C | (CH₂)_{c} | 1 to 20 | Si(OMe)₃ | 3 |
| 918 | 0 | Me | Me | (CH₂)_{b} | 0 to 20 | C | (CH₂)_{c} | 1 to 20 | Si(OMe)₃ | 3 |
| 919 | 0 | Me | Me | (CH₂)_{b} | 0 to 20 | C | (CH₂)_{c} | 1 to 20 | Si(OMe)₃ | 3 |
| 920 | 0 | Me | Me | (CH₂)_{b} | 0 to 20 | C | (CH₂)_{c} | 1 to 20 | Si(OMe)₃ | 3 |
| 921 | 0 | Me | Me | (CH₂)_{b} | 0 to 20 | C | (CH₂)_{c} | 1 to 20 | Si(OMe)₃ | 3 |
| 922 | 0 | Me | Me | (CH₂)_{b} | 0 to 20 | C | (CH₂)_{c} | 1 to 20 | Si(OMe)₃ | 3 |

TABLE 353

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 923 | 3,5-CF₃C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 924 | 3,5-SF₅C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 925 | 4-CF₃C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 926 | 4-SF₅C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 927 | 3,5-CF₃C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 928 | 3,5-SF₅C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 929 | 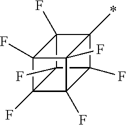 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 930 | 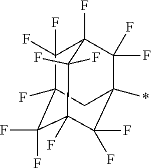 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 931 | 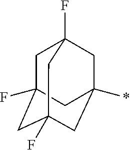 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 932 | SF₅ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 933 | OCF₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 354

| No. | R²¹ | | a | R²² | R²³ | R²⁴ | | | R²⁵ | z21 |
|---|---|---|---|---|---|---|---|---|---|---|
| 934 | SCF₃ | (CH₂)ₐ | 0 to 20 | Me | Me | OCF₃ | (CH₂)ₐ | 0 to 20 | Me | 5 to 100 |
| 935 | N(CH₂CF₃)₂ | (CH₂)ₐ | 0 to 20 | Me | Me | OCF₃ | (CH₂)ₐ | 0 to 20 | Me | 5 to 100 |
| 936 | N(CF₃)₂ | (CH₂)ₐ | 0 to 20 | Me | Me | OCF₃ | (CH₂)ₐ | 0 to 20 | Me | 5 to 100 |
| 937 | Me | (CH₂)ₐ | 0 to 20 | Me | Me | SCF₃ | (CH₂)ₐ | 0 to 20 | Me | 5 to 100 |
| 938 | CF₃ | (CH₂)ₐ | 0 to 20 | Me | Me | SCF₃ | (CH₂)ₐ | 0 to 20 | Me | 5 to 100 |
| 939 | (CF₃)₂CF | (CH₂)ₐ | 0 to 20 | Me | Me | SCF₃ | (CH₂)ₐ | 0 to 20 | Me | 5 to 100 |
| 940 | (CF₃)₃C | (CH₂)ₐ | 0 to 20 | Me | Me | SCF₃ | (CH₂)ₐ | 0 to 20 | Me | 5 to 100 |
| 941 | C₄F₉ | (CH₂)ₐ | 0 to 20 | Me | Me | SCF₃ | (CH₂)ₐ | 0 to 20 | Me | 5 to 100 |
| 942 | C₈F₁₇ | (CH₂)ₐ | 0 to 20 | Me | Me | SCF₃ | (CH₂)ₐ | 0 to 20 | Me | 5 to 100 |
| 943 | c-C₆F₁₁ | (CH₂)ₐ | 0 to 20 | Me | Me | SCF₃ | (CH₂)ₐ | 0 to 20 | Me | 5 to 100 |
| 944 | CHF₂ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 934 | 0 | Me | Me | (CH₂)_{b} | 0 to 20 | C | (CH₂)_{c} | 1 to 20 | Si(OMe)₃ | 3 |
| 935 | 0 | Me | Me | (CH₂)_{b} | 0 to 20 | C | (CH₂)_{c} | 1 to 20 | Si(OMe)₃ | 3 |
| 936 | 0 | Me | Me | (CH₂)_{b} | 0 to 20 | C | (CH₂)_{c} | 1 to 20 | Si(OMe)₃ | 3 |
| 937 | 0 | Me | Me | (CH₂)_{b} | 0 to 20 | C | (CH₂)_{c} | 1 to 20 | Si(OMe)₃ | 3 |
| 938 | 0 | Me | Me | (CH₂)_{b} | 0 to 20 | C | (CH₂)_{c} | 1 to 20 | Si(OMe)₃ | 3 |
| 939 | 0 | Me | Me | (CH₂)_{b} | 0 to 20 | C | (CH₂)_{c} | 1 to 20 | Si(OMe)₃ | 3 |
| 940 | 0 | Me | Me | (CH₂)_{b} | 0 to 20 | C | (CH₂)_{c} | 1 to 20 | Si(OMe)₃ | 3 |
| 941 | 0 | Me | Me | (CH₂)_{b} | 0 to 20 | C | (CH₂)_{c} | 1 to 20 | Si(OMe)₃ | 3 |
| 942 | 0 | Me | Me | (CH₂)_{b} | 0 to 20 | C | (CH₂)_{c} | 1 to 20 | Si(OMe)₃ | 3 |
| 943 | 0 | Me | Me | (CH₂)_{b} | 0 to 20 | C | (CH₂)_{c} | 1 to 20 | Si(OMe)₃ | 3 |
| 944 | 0 | Me | Me | (CH₂)_{b} | 0 to 20 | C | (CH₂)_{c} | 1 to 20 | Si(OMe)₃ | 3 |

TABLE 355

| No. | R²¹ | | a | R²² | R²³ | R²⁴ | | | R²⁵ | z21 |
|---|---|---|---|---|---|---|---|---|---|---|
| 945 | CClF₂ | (CH₂)ₐ | 0 to 20 | Me | Me | SCF₃ | (CH₂)ₐ | 0 to 20 | Me | 5 to 100 |
| 946 | CBrF₂ | (CH₂)ₐ | 0 to 20 | Me | Me | SCF₃ | (CH₂)ₐ | 0 to 20 | Me | 5 to 100 |
| 947 | ClF₂ | (CH₂)ₐ | 0 to 20 | Me | Me | SCF₃ | (CH₂)ₐ | 0 to 20 | Me | 5 to 100 |
| 948 | CF═CF₂ | (CH₂)ₐ | 0 to 20 | Me | Me | SCF₃ | (CH₂)ₐ | 0 to 20 | Me | 5 to 100 |
| 949 | CF═CFCF₃ | (CH₂)ₐ | 0 to 20 | Me | Me | SCF₃ | (CH₂)ₐ | 0 to 20 | Me | 5 to 100 |
| 950 | CF═CFCF═CF₂ | (CH₂)ₐ | 0 to 20 | Me | Me | SCF₃ | (CH₂)ₐ | 0 to 20 | Me | 5 to 100 |
| 951 | C≡CCF₃ | (CH₂)ₐ | 0 to 20 | Me | Me | SCF₃ | (CH₂)ₐ | 0 to 20 | Me | 5 to 100 |
| 952 | CF₂CH₃ | (CH₂)ₐ | 0 to 20 | Me | Me | SCF₃ | (CH₂)ₐ | 0 to 20 | Me | 5 to 100 |
| 953 | (CF₂)₂H | (CH₂)ₐ | 0 to 20 | Me | Me | SCF₃ | (CH₂)ₐ | 0 to 20 | Me | 5 to 100 |
| 954 | (CF₂)₂CH₃ | (CH₂)ₐ | 0 to 20 | Me | Me | SCF₃ | (CH₂)ₐ | 0 to 20 | Me | 5 to 100 |
| 955 | (CF₂)₄H | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 945 | 0 | Me | Me | (CH₂)_{b} | 0 to 20 | C | (CH₂)_{c} | 1 to 20 | Si(OMe)₃ | 3 |
| 946 | 0 | Me | Me | (CH₂)_{b} | 0 to 20 | C | (CH₂)_{c} | 1 to 20 | Si(OMe)₃ | 3 |
| 947 | 0 | Me | Me | (CH₂)_{b} | 0 to 20 | C | (CH₂)_{c} | 1 to 20 | Si(OMe)₃ | 3 |
| 948 | 0 | Me | Me | (CH₂)_{b} | 0 to 20 | C | (CH₂)_{c} | 1 to 20 | Si(OMe)₃ | 3 |
| 949 | 0 | Me | Me | (CH₂)_{b} | 0 to 20 | C | (CH₂)_{c} | 1 to 20 | Si(OMe)₃ | 3 |
| 950 | 0 | Me | Me | (CH₂)_{b} | 0 to 20 | C | (CH₂)_{c} | 1 to 20 | Si(OMe)₃ | 3 |
| 951 | 0 | Me | Me | (CH₂)_{b} | 0 to 20 | C | (CH₂)_{c} | 1 to 20 | Si(OMe)₃ | 3 |
| 952 | 0 | Me | Me | (CH₂)_{b} | 0 to 20 | C | (CH₂)_{c} | 1 to 20 | Si(OMe)₃ | 3 |
| 953 | 0 | Me | Me | (CH₂)_{b} | 0 to 20 | C | (CH₂)_{c} | 1 to 20 | Si(OMe)₃ | 3 |
| 954 | 0 | Me | Me | (CH₂)_{b} | 0 to 20 | C | (CH₂)_{c} | 1 to 20 | Si(OMe)₃ | 3 |
| 955 | 0 | Me | Me | (CH₂)_{b} | 0 to 20 | C | (CH₂)_{c} | 1 to 20 | Si(OMe)₃ | 3 |

TABLE 356

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 956 | C₆F₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 957 | 4-CF₃C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 958 | 4-SF₅CF₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 959 | 3,5-CF₃C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 960 | 3,5-SF₅CF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 961 | 4-CF₃C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 962 | 4-SF₅C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 963 | 3,5-CF₃C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 964 | 3,5-SF₅C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 965 | 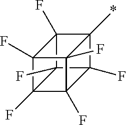 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 966 | 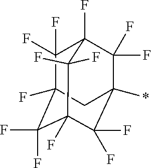 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 357

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 967 | 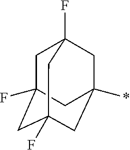 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 968 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 969 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 970 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 971 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 972 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 973 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 974 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 975 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 976 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 977 | C₄F₉ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 358

| No. | R²¹ | | a | R²² | R²³ | R²⁴ | | | R²⁵ | z21 |
|---|---|---|---|---|---|---|---|---|---|---|
| 978 | C₈F₁₇ | (CH₂)ₐ | 0 to 20 | Me | Me | N(CF₃)₂ | (CH₂)ₐ | 0 to 20 | Me | 5 to 100 |
| 979 | c-C₆F₁₁ | (CH₂)ₐ | 0 to 20 | Me | Me | N(CF₃)₂ | (CH₂)ₐ | 0 to 20 | Me | 5 to 100 |
| 980 | CHF₂ | (CH₂)ₐ | 0 to 20 | Me | Me | N(CF₃)₂ | (CH₂)ₐ | 0 to 20 | Me | 5 to 100 |
| 981 | CClF₂ | (CH₂)ₐ | 0 to 20 | Me | Me | N(CF₃)₂ | (CH₂)ₐ | 0 to 20 | Me | 5 to 100 |
| 982 | CBrF₂ | (CH₂)ₐ | 0 to 20 | Me | Me | N(CF₃)₂ | (CH₂)ₐ | 0 to 20 | Me | 5 to 100 |
| 983 | ClF₂ | (CH₂)ₐ | 0 to 20 | Me | Me | N(CF₃)₂ | (CH₂)ₐ | 0 to 20 | Me | 5 to 100 |
| 984 | CF═CF₂ | (CH₂)ₐ | 0 to 20 | Me | Me | N(CF₃)₂ | (CH₂)ₐ | 0 to 20 | Me | 5 to 100 |
| 985 | CF═CFCF₃ | (CH₂)ₐ | 0 to 20 | Me | Me | N(CF₃)₂ | (CH₂)ₐ | 0 to 20 | Me | 5 to 100 |
| 986 | CF═CFCF═CF₂ | (CH₂)ₐ | 0 to 20 | Me | Me | N(CF₃)₂ | (CH₂)ₐ | 0 to 20 | Me | 5 to 100 |
| 987 | C≡CCF₃ | (CH₂)ₐ | 0 to 20 | Me | Me | N(CF₃)₂ | (CH₂)ₐ | 0 to 20 | Me | 5 to 100 |
| 988 | CF₂CH₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 978 | 0 | Me | Me | (CH₂)_{b} | 0 to 20 | C | (CH₂)_{c} | 1 to 20 | Si(OMe)₃ | 3 |
| 979 | 0 | Me | Me | (CH₂)_{b} | 0 to 20 | C | (CH₂)_{c} | 1 to 20 | Si(OMe)₃ | 3 |
| 980 | 0 | Me | Me | (CH₂)_{b} | 0 to 20 | C | (CH₂)_{c} | 1 to 20 | Si(OMe)₃ | 3 |
| 981 | 0 | Me | Me | (CH₂)_{b} | 0 to 20 | C | (CH₂)_{c} | 1 to 20 | Si(OMe)₃ | 3 |
| 982 | 0 | Me | Me | (CH₂)_{b} | 0 to 20 | C | (CH₂)_{c} | 1 to 20 | Si(OMe)₃ | 3 |
| 983 | 0 | Me | Me | (CH₂)_{b} | 0 to 20 | C | (CH₂)_{c} | 1 to 20 | Si(OMe)₃ | 3 |
| 984 | 0 | Me | Me | (CH₂)_{b} | 0 to 20 | C | (CH₂)_{c} | 1 to 20 | Si(OMe)₃ | 3 |
| 985 | 0 | Me | Me | (CH₂)_{b} | 0 to 20 | C | (CH₂)_{c} | 1 to 20 | Si(OMe)₃ | 3 |
| 986 | 0 | Me | Me | (CH₂)_{b} | 0 to 20 | C | (CH₂)_{c} | 1 to 20 | Si(OMe)₃ | 3 |
| 987 | 0 | Me | Me | (CH₂)_{b} | 0 to 20 | C | (CH₂)_{c} | 1 to 20 | Si(OMe)₃ | 3 |
| 988 | 0 | Me | Me | (CH₂)_{b} | 0 to 20 | C | (CH₂)_{c} | 1 to 20 | Si(OMe)₃ | 3 |

TABLE 359

| No. | R²¹ | | a | R²² | R²³ | R²⁴ | | | R²⁵ | z21 |
|---|---|---|---|---|---|---|---|---|---|---|
| 989 | (CF₂)₂H | (CH₂)ₐ | 0 to 20 | Me | Me | N(CF₃)₂ | (CH₂)ₐ | 0 to 20 | Me | 5 to 100 |
| 990 | (CF₂)₂CH₃ | (CH₂)ₐ | 0 to 20 | Me | Me | N(CF₃)₂ | (CH₂)ₐ | 0 to 20 | Me | 5 to 100 |
| 991 | (CF₂)₄H | (CH₂)ₐ | 0 to 20 | Me | Me | SCF₃ | (CH₂)ₐ | 0 to 20 | Me | 5 to 100 |
| 992 | C₆F₅ | (CH₂)ₐ | 0 to 20 | Me | Me | N(CF₃)₂ | (CH₂)ₐ | 0 to 20 | Me | 5 to 100 |
| 993 | 4-CF₃C₆F₄ | (CH₂)ₐ | 0 to 20 | Me | Me | N(CF₃)₂ | (CH₂)ₐ | 0 to 20 | Me | 5 to 100 |
| 994 | 4-SF₅C₆F₄ | (CH₂)ₐ | 0 to 20 | Me | Me | N(CF₃)₂ | (CH₂)ₐ | 0 to 20 | Me | 5 to 100 |
| 995 | 3,5-CF₃C₆F₃ | (CH₂)ₐ | 0 to 20 | Me | Me | N(CF₃)₂ | (CH₂)ₐ | 0 to 20 | Me | 5 to 100 |
| 996 | 3,5-SF₅C₆F₃ | (CH₂)ₐ | 0 to 20 | Me | Me | N(CF₃)₂ | (CH₂)ₐ | 0 to 20 | Me | 5 to 100 |
| 997 | 4-CF₃C₆H₄ | (CH₂)ₐ | 0 to 20 | Me | Me | N(CF₃)₂ | (CH₂)ₐ | 0 to 20 | Me | 5 to 100 |
| 998 | 4-SF₅C₆H₄ | (CH₂)ₐ | 0 to 20 | Me | Me | N(CF₃)₂ | (CH₂)ₐ | 0 to 20 | Me | 5 to 100 |
| 999 | 3,5-CF₃C₆H₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 989 | 0 | Me | Me | (CH₂)_{b} | 0 to 20 | C | (CH₂)_{c} | 1 to 20 | Si(OMe)₃ | 3 |
| 990 | 0 | Me | Me | (CH₂)_{b} | 0 to 20 | C | (CH₂)_{c} | 1 to 20 | Si(OMe)₃ | 3 |
| 991 | 0 | Me | Me | (CH₂)_{b} | 0 to 20 | C | (CH₂)_{c} | 1 to 20 | Si(OMe)₃ | 3 |
| 992 | 0 | Me | Me | (CH₂)_{b} | 0 to 20 | C | (CH₂)_{c} | 1 to 20 | Si(OMe)₃ | 3 |
| 993 | 0 | Me | Me | (CH₂)_{b} | 0 to 20 | C | (CH₂)_{c} | 1 to 20 | Si(OMe)₃ | 3 |
| 994 | 0 | Me | Me | (CH₂)_{b} | 0 to 20 | C | (CH₂)_{c} | 1 to 20 | Si(OMe)₃ | 3 |
| 995 | 0 | Me | Me | (CH₂)_{b} | 0 to 20 | C | (CH₂)_{c} | 1 to 20 | Si(OMe)₃ | 3 |
| 996 | 0 | Me | Me | (CH₂)_{b} | 0 to 20 | C | (CH₂)_{c} | 1 to 20 | Si(OMe)₃ | 3 |
| 997 | 0 | Me | Me | (CH₂)_{b} | 0 to 20 | C | (CH₂)_{c} | 1 to 20 | Si(OMe)₃ | 3 |
| 998 | 0 | Me | Me | (CH₂)_{b} | 0 to 20 | C | (CH₂)_{c} | 1 to 20 | Si(OMe)₃ | 3 |
| 999 | 0 | Me | Me | (CH₂)_{b} | 0 to 20 | C | (CH₂)_{c} | 1 to 20 | Si(OMe)₃ | 3 |

TABLE 360

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1000 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1001 | 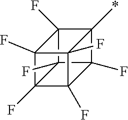 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1002 | 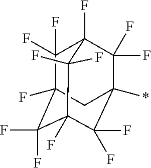 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1003 | 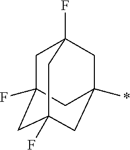 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1004 | SF₅ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1005 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1006 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1007 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |
| 1008 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C | (CH₂)_{c} | 1 to 20 | Si(OMe)₃ | 3 |

TABLE 361

| No. | R²¹ | | a | R²² | R²³ | R²⁴ | | | R²⁵ | z21 |
|---|---|---|---|---|---|---|---|---|---|---|
| 1009 | Me | (CH₂)ₐ | 0 to 20 | Me | Me | CF₃ | (CH₂)ₐ | 0 to 20 | Me | 5 to 100 |
| 1010 | CF₃ | (CH₂)ₐ | 0 to 20 | Me | Me | CF₃ | (CH₂)ₐ | 0 to 20 | Me | 5 to 100 |
| 1011 | (CF₃)₂CF | (CH₂)ₐ | 0 to 20 | Me | Me | CF₃ | (CH₂)ₐ | 0 to 20 | Me | 5 to 100 |
| 1012 | (CF₃)₃C | (CH₂)ₐ | 0 to 20 | Me | Me | CF₃ | (CH₂)ₐ | 0 to 20 | Me | 5 to 100 |
| 1013 | C₄F₉ | (CH₂)ₐ | 0 to 20 | Me | Me | CF₃ | (CH₂)ₐ | 0 to 20 | Me | 5 to 100 |
| 1014 | C₈F₁₇ | (CH₂)ₐ | 0 to 20 | Me | Me | CF₃ | (CH₂)ₐ | 0 to 20 | Me | 5 to 100 |
| 1015 | c-C₆F₁₁ | (CH₂)ₐ | 0 to 20 | Me | Me | CF₃ | (CH₂)ₐ | 0 to 20 | Me | 5 to 100 |
| 1016 | CHF₂ | (CH₂)ₐ | 0 to 20 | Me | Me | CF₃ | (CH₂)ₐ | 0 to 20 | Me | 5 to 100 |
| 1017 | CClF₂ | (CH₂)ₐ | 0 to 20 | Me | Me | CF₃ | (CH₂)ₐ | 0 to 20 | Me | 5 to 100 |
| 1018 | CBrF₂ | (CH₂)ₐ | 0 to 20 | Me | Me | CF₃ | (CH₂)ₐ | 0 to 20 | Me | 5 to 100 |
| 1019 | ClF₂ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1009 | 0 | Me | Me | (CH₂)_{b} | 0 to 20 | C(═O)N | (CH₂)_{c} | 1 to 20 | Si(OMe)₃ | 2 |
| 1010 | 0 | Me | Me | (CH₂)_{b} | 0 to 20 | C(═O)N | (CH₂)_{c} | 1 to 20 | Si(OMe)₃ | 2 |
| 1011 | 0 | Me | Me | (CH₂)_{b} | 0 to 20 | C(═O)N | (CH₂)_{c} | 1 to 20 | Si(OMe)₃ | 2 |
| 1012 | 0 | Me | Me | (CH₂)_{b} | 0 to 20 | C(═O)N | (CH₂)_{c} | 1 to 20 | Si(OMe)₃ | 2 |
| 1013 | 0 | Me | Me | (CH₂)_{b} | 0 to 20 | C(═O)N | (CH₂)_{c} | 1 to 20 | Si(OMe)₃ | 2 |
| 1014 | 0 | Me | Me | (CH₂)_{b} | 0 to 20 | C(═O)N | (CH₂)_{c} | 1 to 20 | Si(OMe)₃ | 2 |
| 1015 | 0 | Me | Me | (CH₂)_{b} | 0 to 20 | C(═O)N | (CH₂)_{c} | 1 to 20 | Si(OMe)₃ | 2 |
| 1016 | 0 | Me | Me | (CH₂)_{b} | 0 to 20 | C(═O)N | (CH₂)_{c} | 1 to 20 | Si(OMe)₃ | 2 |
| 1017 | 0 | Me | Me | (CH₂)_{b} | 0 to 20 | C(═O)N | (CH₂)_{c} | 1 to 20 | Si(OMe)₃ | 2 |
| 1018 | 0 | Me | Me | (CH₂)_{b} | 0 to 20 | C(═O)N | (CH₂)_{c} | 1 to 20 | Si(OMe)₃ | 2 |
| 1019 | 0 | Me | Me | (CH₂)_{b} | 0 to 20 | C(═O)N | (CH₂)_{c} | 1 to 20 | Si(OMe)₃ | 2 |

TABLE 362

| No. | R²¹ | | a | R²² | R²³ | R²⁴ | | | R²⁵ | z21 |
|---|---|---|---|---|---|---|---|---|---|---|
| 1020 | CF═CF₂ | (CH₂)ₐ | 0 to 20 | Me | Me | CF₃ | (CH₂)ₐ | 0 to 20 | Me | 5 to 100 |
| 1021 | CF═CFCF₃ | (CH₂)ₐ | 0 to 20 | Me | Me | CF₃ | (CH₂)ₐ | 0 to 20 | Me | 5 to 100 |
| 1022 | CF═CFCF═CF₂ | (CH₂)ₐ | 0 to 20 | Me | Me | CF₃ | (CH₂)ₐ | 0 to 20 | Me | 5 to 100 |
| 1023 | C≡CCF₃ | (CH₂)ₐ | 0 to 20 | Me | Me | CF₃ | (CH₂)ₐ | 0 to 20 | Me | 5 to 100 |
| 1024 | CF₂CH₃ | (CH₂)ₐ | 0 to 20 | Me | Me | CF₃ | (CH₂)ₐ | 0 to 20 | Me | 5 to 100 |
| 1025 | (CF₂)₂H | (CH₂)ₐ | 0 to 20 | Me | Me | CF₃ | (CH₂)ₐ | 0 to 20 | Me | 5 to 100 |
| 1026 | (CF₂)₂CH₃ | (CH₂)ₐ | 0 to 20 | Me | Me | CF₃ | (CH₂)ₐ | 0 to 20 | Me | 5 to 100 |
| 1027 | (CF₂)₄H | (CH₂)ₐ | 0 to 20 | Me | Me | CF₃ | (CH₂)ₐ | 0 to 20 | Me | 5 to 100 |
| 1028 | C₆F₅ | (CH₂)ₐ | 0 to 20 | Me | Me | CF₃ | (CH₂)ₐ | 0 to 20 | Me | 5 to 100 |
| 1029 | 4-CF₃C₆F₄ | (CH₂)ₐ | 0 to 20 | Me | Me | CF₃ | (CH₂)ₐ | 0 to 20 | Me | 5 to 100 |
| 1030 | 4-SF₅C₆F₄ | (CH₂)ₐ | 0 to 20 | Me | Me | CF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1020 | 0 | Me | Me | (CH₂)_{b} | 0 to 20 | C(═O)N | (CH₂)_{c} | 1 to 20 | Si(OMe)₃ | 2 |
| 1021 | 0 | Me | Me | (CH₂)_{b} | 0 to 20 | C(═O)N | (CH₂)_{c} | 1 to 20 | Si(OMe)₃ | 2 |
| 1022 | 0 | Me | Me | (CH₂)_{b} | 0 to 20 | C(═O)N | (CH₂)_{c} | 1 to 20 | Si(OMe)₃ | 2 |
| 1023 | 0 | Me | Me | (CH₂)_{b} | 0 to 20 | C(═O)N | (CH₂)_{c} | 1 to 20 | Si(OMe)₃ | 2 |
| 1024 | 0 | Me | Me | (CH₂)_{b} | 0 to 20 | C(═O)N | (CH₂)_{c} | 1 to 20 | Si(OMe)₃ | 2 |
| 1025 | 0 | Me | Me | (CH₂)_{b} | 0 to 20 | C(═O)N | (CH₂)_{c} | 1 to 20 | Si(OMe)₃ | 2 |
| 1026 | 0 | Me | Me | (CH₂)_{b} | 0 to 20 | C(═O)N | (CH₂)_{c} | 1 to 20 | Si(OMe)₃ | 2 |
| 1027 | 0 | Me | Me | (CH₂)_{b} | 0 to 20 | C(═O)N | (CH₂)_{c} | 1 to 20 | Si(OMe)₃ | 2 |
| 1028 | 0 | Me | Me | (CH₂)_{b} | 0 to 20 | C(═O)N | (CH₂)_{c} | 1 to 20 | Si(OMe)₃ | 2 |
| 1029 | 0 | Me | Me | (CH₂)_{b} | 0 to 20 | C(═O)N | (CH₂)_{c} | 1 to 20 | Si(OMe)₃ | 2 |
| 1030 | 0 | Me | Me | (CH₂)_{b} | 0 to 20 | C(═O)N | (CH₂)_{c} | 1 to 20 | Si(OMe)₃ | 2 |

TABLE 363

| No. | R²¹ | | a | R²² | R²³ | R²⁴ | | | R²⁵ | z21 | z22 | R²⁸ | R²⁹ | R1 | b | L¹ | R² | c | T¹ | x1 |
|---|---|---|---|---|---|---|---|---|---|---|---|---|---|---|---|---|---|---|---|---|
| 1031 | 3,5-CF₃C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1032 | 3,5-SF₅C₆F₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1033 | 4-CF₃C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1034 | 4-SF₅C₆H₄ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1035 | 3,5-CF₃C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1036 | 3,5-SF₅C₆H₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1037 | 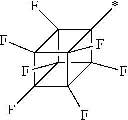 [SMILES: *C12C3(F)C4(F)C1(F)C1(F)C2(F)C3(F)C41F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1038 | 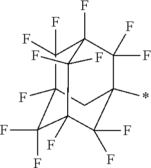 [SMILES: *C12CC3(F)C(F)(F)C(F)(C1(F)F)C(F)(F)C(F)(C2(F)F)C3(F)F] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1039 | 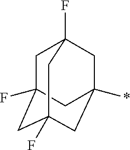 [SMILES: *C12CC3(F)CC(F)(C1)CC(F)(C2)C3] | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1040 | SF₅ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1041 | OCF₃ | (CH₂)ₐ | 0 to 20 | Me | Me | CF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 364

| No. | R²¹ | | a | R²² | R²³ | R²⁴ | | | R²⁵ | z21 |
|---|---|---|---|---|---|---|---|---|---|---|
| 1042 | SCF₃ | (CH₂)ₐ | 0 to 20 | Me | Me | CF₃ | (CH₂)ₐ | 0 to 20 | Me | 5 to 100 |
| 1043 | N(CH₂CF₃)₂ | (CH₂)ₐ | 0 to 20 | Me | Me | CF₃ | (CH₂)ₐ | 0 to 20 | Me | 5 to 100 |
| 1044 | N(CF₃)₂ | (CH₂)ₐ | 0 to 20 | Me | Me | CF₃ | (CH₂)ₐ | 0 to 20 | Me | 5 to 100 |
| 1045 | Me | (CH₂)ₐ | 0 to 20 | Me | Me | CHF₂ | (CH₂)ₐ | 0 to 20 | Me | 5 to 100 |
| 1046 | CF₃ | (CH₂)ₐ | 0 to 20 | Me | Me | CHF₂ | (CH₂)ₐ | 0 to 20 | Me | 5 to 100 |
| 1047 | (CF₃)₂CF | (CH₂)ₐ | 0 to 20 | Me | Me | CHF₂ | (CH₂)ₐ | 0 to 20 | Me | 5 to 100 |
| 1048 | (CF₃)₃C | (CH₂)ₐ | 0 to 20 | Me | Me | CHF₂ | (CH₂)ₐ | 0 to 20 | Me | 5 to 100 |
| 1049 | C₄F₉ | (CH₂)ₐ | 0 to 20 | Me | Me | CHF₂ | (CH₂)ₐ | 0 to 20 | Me | 5 to 100 |
| 1050 | C₈F₁₇ | (CH₂)ₐ | 0 to 20 | Me | Me | CHF₂ | (CH₂)ₐ | 0 to 20 | Me | 5 to 100 |
| 1051 | c-C₆F₁₁ | (CH₂)ₐ | 0 to 20 | Me | Me | CHF₂ | (CH₂)ₐ | 0 to 20 | Me | 5 to 100 |
| 1052 | CHF₂ | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1042 | 0 | Me | Me | (CH₂)_{b} | 0 to 20 | C(═O)N | (CH₂)_{c} | 1 to 20 | Si(OMe)₃ | 2 |
| 1043 | 0 | Me | Me | (CH₂)_{b} | 0 to 20 | C(═O)N | (CH₂)_{c} | 1 to 20 | Si(OMe)₃ | 2 |
| 1044 | 0 | Me | Me | (CH₂)_{b} | 0 to 20 | C(═O)N | (CH₂)_{c} | 1 to 20 | Si(OMe)₃ | 2 |
| 1045 | 0 | Me | Me | (CH₂)_{b} | 0 to 20 | C(═O)N | (CH₂)_{c} | 1 to 20 | Si(OMe)₃ | 2 |
| 1046 | 0 | Me | Me | (CH₂)_{b} | 0 to 20 | C(═O)N | (CH₂)_{c} | 1 to 20 | Si(OMe)₃ | 2 |
| 1047 | 0 | Me | Me | (CH₂)_{b} | 0 to 20 | C(═O)N | (CH₂)_{c} | 1 to 20 | Si(OMe)₃ | 2 |
| 1048 | 0 | Me | Me | (CH₂)_{b} | 0 to 20 | C(═O)N | (CH₂)_{c} | 1 to 20 | Si(OMe)₃ | 2 |
| 1049 | 0 | Me | Me | (CH₂)_{b} | 0 to 20 | C(═O)N | (CH₂)_{c} | 1 to 20 | Si(OMe)₃ | 2 |
| 1050 | 0 | Me | Me | (CH₂)_{b} | 0 to 20 | C(═O)N | (CH₂)_{c} | 1 to 20 | Si(OMe)₃ | 2 |
| 1051 | 0 | Me | Me | (CH₂)_{b} | 0 to 20 | C(═O)N | (CH₂)_{c} | 1 to 20 | Si(OMe)₃ | 2 |
| 1052 | 0 | Me | Me | (CH₂)_{b} | 0 to 20 | C(═O)N | (CH₂)_{c} | 1 to 20 | Si(OMe)₃ | 2 |

TABLE 365

| No. | R²¹ | | a | R²² | R²³ | R²⁴ | | | R²⁵ | z21 |
|---|---|---|---|---|---|---|---|---|---|---|
| 1053 | CClF₂ | (CH₂)ₐ | 0 to 20 | Me | Me | CHF₂ | (CH₂)ₐ | 0 to 20 | Me | 5 to 100 |
| 1054 | CBrF₂ | (CH₂)ₐ | 0 to 20 | Me | Me | CHF₂ | (CH₂)ₐ | 0 to 20 | Me | 5 to 100 |
| 1055 | ClF₂ | (CH₂)ₐ | 0 to 20 | Me | Me | CHF₂ | (CH₂)ₐ | 0 to 20 | Me | 5 to 100 |
| 1056 | CF═CF₂ | (CH₂)ₐ | 0 to 20 | Me | Me | CHF₂ | (CH₂)ₐ | 0 to 20 | Me | 5 to 100 |
| 1057 | CF═CFCF₃ | (CH₂)ₐ | 0 to 20 | Me | Me | CHF₂ | (CH₂)ₐ | 0 to 20 | Me | 5 to 100 |
| 1058 | CF═CFCF═CF₂ | (CH₂)ₐ | 0 to 20 | Me | Me | CHF₂ | (CH₂)ₐ | 0 to 20 | Me | 5 to 100 |
| 1059 | C≡CCF₃ | (CH₂)ₐ | 0 to 20 | Me | Me | CHF₂ | (CH₂)ₐ | 0 to 20 | Me | 5 to 100 |
| 1060 | CF₂CH₃ | (CH₂)ₐ | 0 to 20 | Me | Me | CHF₂ | (CH₂)ₐ | 0 to 20 | Me | 5 to 100 |
| 1061 | (CF₂)₂H | (CH₂)ₐ | 0 to 20 | Me | Me | CHF₂ | (CH₂)ₐ | 0 to 20 | Me | 5 to 100 |
| 1062 | (CF₂)₂CH₃ | (CH₂)ₐ | 0 to 20 | Me | Me | CHF₂ | (CH₂)ₐ | 0 to 20 | Me | 5 to 100 |
| 1063 | (CF₂)₄H | (CH₂)ₐ | 0 to 20 | Me | Me | CHF₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1053 | 0 | Me | Me | (CH₂)_{b} | 0 to 20 | C(═O)N | (CH₂)_{c} | 1 to 20 | Si(OMe)₃ | 2 |
| 1054 | 0 | Me | Me | (CH₂)_{b} | 0 to 20 | C(═O)N | (CH₂)_{c} | 1 to 20 | Si(OMe)₃ | 2 |
| 1055 | 0 | Me | Me | (CH₂)_{b} | 0 to 20 | C(═O)N | (CH₂)_{c} | 1 to 20 | Si(OMe)₃ | 2 |
| 1056 | 0 | Me | Me | (CH₂)_{b} | 0 to 20 | C(═O)N | (CH₂)_{c} | 1 to 20 | Si(OMe)₃ | 2 |
| 1057 | 0 | Me | Me | (CH₂)_{b} | 0 to 20 | C(═O)N | (CH₂)_{c} | 1 to 20 | Si(OMe)₃ | 2 |
| 1058 | 0 | Me | Me | (CH₂)_{b} | 0 to 20 | C(═O)N | (CH₂)_{c} | 1 to 20 | Si(OMe)₃ | 2 |
| 1059 | 0 | Me | Me | (CH₂)_{b} | 0 to 20 | C(═O)N | (CH₂)_{c} | 1 to 20 | Si(OMe)₃ | 2 |
| 1060 | 0 | Me | Me | (CH₂)_{b} | 0 to 20 | C(═O)N | (CH₂)_{c} | 1 to 20 | Si(OMe)₃ | 2 |
| 1061 | 0 | Me | Me | (CH₂)_{b} | 0 to 20 | C(═O)N | (CH₂)_{c} | 1 to 20 | Si(OMe)₃ | 2 |
| 1062 | 0 | Me | Me | (CH₂)_{b} | 0 to 20 | C(═O)N | (CH₂)_{c} | 1 to 20 | Si(OMe)₃ | 2 |
| 1063 | 0 | Me | Me | (CH₂)_{b} | 0 to 20 | C(═O)N | (CH₂)_{c} | 1 to 20 | Si(OMe)₃ | 2 |

TABLE 366

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1064 | C₆F₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1065 | 4-CF₃C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1066 | 4-SF₅C₆F₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1067 | 3,5-CF₃C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1068 | 3,5-SF₅C₆F₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1069 | 4-CF₃C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1070 | 4-SF₅C₆H₄ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1071 | 3,5-CF₃C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1072 | 3,5-SF₅C₆H₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1073 | 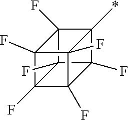 [SMILES: *C12C3(F)C4(F)C1(F)C1(F)C2(F)C3(F)C41F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1074 | 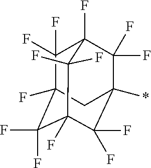 [SMILES: *C12CC3(F)C(F)(F)C(F)(C1(F)F)C(F)(F)C(F)(C2(F)F)C3(F)F] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 367

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1075 | 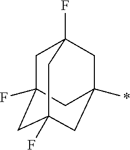 [SMILES: *C12CC3(F)CC(F)(C1)CC(F)(C2)C3] | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1076 | SF₅ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1077 | OCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1078 | SCF₃ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1079 | N(CH₂CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1080 | N(CF₃)₂ | (CH₂)ₐ | 0 to 20 | Me | Me | CHF₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1081 | Me | (CH₂)ₐ | 0 to 20 | Me | Me | 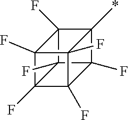 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1082 | CF₃ | (CH₂)ₐ | 0 to 20 | Me | Me | 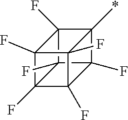 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1083 | (CF₃)₂CF | (CH₂)ₐ | 0 to 20 | Me | Me | 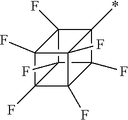 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1084 | (CF₃)₃C | (CH₂)ₐ | 0 to 20 | Me | Me | 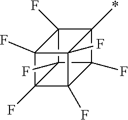 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1085 | C₄F₉ | (CH₂)ₐ | 0 to 20 | Me | Me | 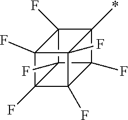 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 368

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1086 | C₈F₁₇ | (CH₂)ₐ | 0 to 20 | Me | Me | 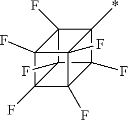 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1087 | c-C₆F₁₁ | (CH₂)ₐ | 0 to 20 | Me | Me | 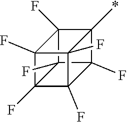 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1088 | CHF₂ | (CH₂)ₐ | 0 to 20 | Me | Me | 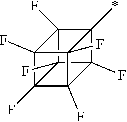 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1089 | CClF₂ | (CH₂)ₐ | 0 to 20 | Me | Me | 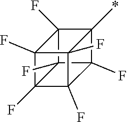 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1090 | CBrF₂ | (CH₂)ₐ | 0 to 20 | Me | Me | 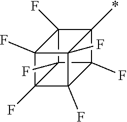 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1091 | ClF₂ | (CH₂)ₐ | 0 to 20 | Me | Me | 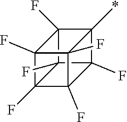 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1092 | CF═CF₂ | (CH₂)ₐ | 0 to 20 | Me | Me | 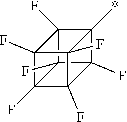 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1093 | CF═CFCF₃ | (CH₂)ₐ | 0 to 20 | Me | Me | 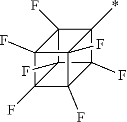 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1094 | CF═CFCF═CF₂ | (CH₂)ₐ | 0 to 20 | Me | Me | 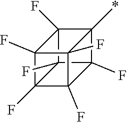 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1095 | C≡CCF₃ | (CH₂)ₐ | 0 to 20 | Me | Me | 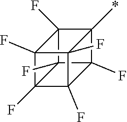 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1096 | CF₂CH₃ | (CH₂)ₐ | 0 to 20 | Me | Me | 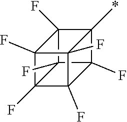 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 369

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1097 | (CF₂)₂H | (CH₂)ₐ | 0 to 20 | Me | Me | 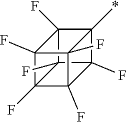 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1098 | (CF₂)₂CH₃ | (CH₂)ₐ | 0 to 20 | Me | Me | 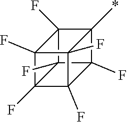 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1099 | (CF₂)₄H | (CH₂)ₐ | 0 to 20 | Me | Me | 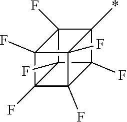 [SMILES: *C12C3(F)C4(F)C1(F)C1(F)C2(F)C3(F)C41F] | (CH₂)ₐ | 0 to 20 | Me | 5 to 100 | 0 | \|Me | Me | (CH₂)_{b} | 0 to 20 | C(═O)N | (CH₂)_{c} | 1 to 20 | Si(OMe)₃ | 2 |
| 1100 | C₆F₅ | (CH₂)ₐ | 0 to 20 | Me | Me | 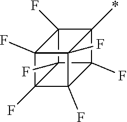 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1101 | 4-CF₃C₆F₄ | (CH₂)ₐ | 0 to 20 | Me | Me | 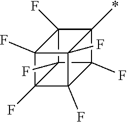 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1102 | 4-SF₅C₆F₄ | (CH₂)ₐ | 0 to 20 | Me | Me | 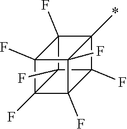 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1103 | 3,5-CF₃C₆F₃ | (CH₂)ₐ | 0 to 20 | Me | Me | 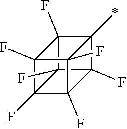 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1104 | 3,5-SF₅C₆F₃ | (CH₂)ₐ | 0 to 20 | Me | Me | 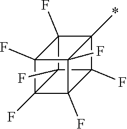 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1105 | 4-CF₃C₆H₄ | (CH₂)ₐ | 0 to 20 | Me | Me | 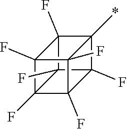 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1106 | 4-SF₅C₆H₄ | (CH₂)ₐ | 0 to 20 | Me | Me | 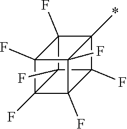 [SMILES: *C12C3(F)C4(F)C1(F)C1(F)C2(F)C3(F)C41F] | (CH₂)ₐ | 0 to 20 | Me | 5 to 100 | 0 | \|Me | Me | (CH₂)_{b} | 0 to 20 | C(═O)N | (CH₂)_{c} | 1 to 20 | Si(OMe)₃ | 2 |
| 1107 | 3,5-CF₃C₆H₃ | (CH₂)ₐ | 0 to 20 | Me | Me | 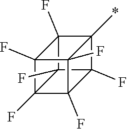 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 370

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1108 | 3,5-SF₅C₆H₃ | (CH₂)ₐ | 0 to 20 | Me | Me | 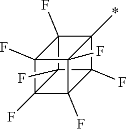 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1109 | 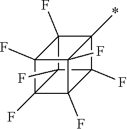 [SMILES: *C12C3(F)C4(F)C1(F)C1(F)C2(F)C3(F)C41F] | (CH₂)ₐ | 0 to 20 | Me | Me | 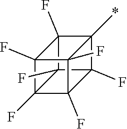 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1110 | 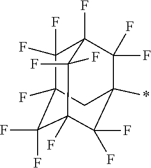 [SMILES: *C12CC3(F)C(F)(F)C(F)(C1(F)F)C(F)(F)C(F)(C2(F)F)C3(F)F] | (CH₂)ₐ | 0 to 20 | Me | Me | 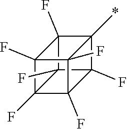 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1111 | 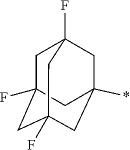 [SMILES: *C12CC3(F)CC(F)(C1)CC(F)(C2)C3] | (CH₂)ₐ | 0 to 20 | Me | Me | 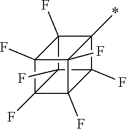 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1112 | SF₅ | (CH₂)ₐ | 0 to 20 | Me | Me | 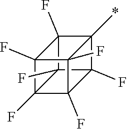 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1113 | OCF₃ | (CH₂)ₐ | 0 to 20 | Me | Me | 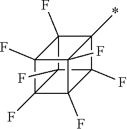 [SMILES: *C12C3(F)C4(F)C1(F)C1(F)C2(F)C3(F)C41F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1114 | SCF₃ | (CH₂)ₐ | 0 to 20 | Me | Me | 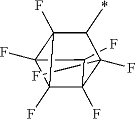 [SMILES: *C1C(C)(F)C2(F)C(F)C(F)(C1(F)CF)C2(C)F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1115 | N(CH₂CF₃)₂ | (CH₂)ₐ | 0 to 20 | Me | Me | 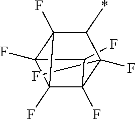 [SMILES: *C1C(C)(F)C2(F)C(F)C(F)(C1(F)CF)C2(C)F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1116 | N(CF₃)₂ | (CH₂)ₐ | 0 to 20 | Me | Me | 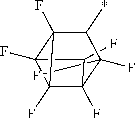 [SMILES: *C1C(C)(F)C2(F)C(F)C(F)(C1(F)CF)C2(C)F] | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1117 | Me | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1118 | CF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 371

| No. | R²¹ | | a | R²² | R²³ | R²⁴ | | | R²⁵ | z21 |
|---|---|---|---|---|---|---|---|---|---|---|
| 1119 | (CF₃)₂CF | (CH₂)ₐ | 0 to 20 | Me | Me | SF₅ | (CH₂)ₐ | 0 to 20 | Me | 5 to 100 |
| 1120 | (CF₃)₃C | (CH₂)ₐ | 0 to 20 | Me | Me | SF₅ | (CH₂)ₐ | 0 to 20 | Me | 5 to 100 |
| 1121 | C₄F₉ | (CH₂)ₐ | 0 to 20 | Me | Me | SF₅ | (CH₂)ₐ | 0 to 20 | Me | 5 to 100 |
| 1122 | C₈F₁₇ | (CH₂)ₐ | 0 to 20 | Me | Me | SF₅ | (CH₂)ₐ | 0 to 20 | Me | 5 to 100 |
| 1123 | c-C₆F₁₁ | (CH₂)ₐ | 0 to 20 | Me | Me | SF₅ | (CH₂)ₐ | 0 to 20 | Me | 5 to 100 |
| 1124 | CHF₂ | (CH₂)ₐ | 0 to 20 | Me | Me | SF₅ | (CH₂)ₐ | 0 to 20 | Me | 5 to 100 |
| 1125 | CClF₂ | (CH₂)ₐ | 0 to 20 | Me | Me | SF₅ | (CH₂)ₐ | 0 to 20 | Me | 5 to 100 |
| 1126 | CBrF₂ | (CH₂)ₐ | 0 to 20 | Me | Me | SF₅ | (CH₂)ₐ | 0 to 20 | Me | 5 to 100 |
| 1127 | ClF₂ | (CH₂)ₐ | 0 to 20 | Me | Me | SF₅ | (CH₂)ₐ | 0 to 20 | Me | 5 to 100 |
| 1128 | CF═CF₂ | (CH₂)ₐ | 0 to 20 | Me | Me | SF₅ | (CH₂)ₐ | 0 to 20 | Me | 5 to 100 |
| 1129 | CF═CFCF₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1119 | 0 | Me | Me | (CH₂)_{b} | 0 to 20 | C(═O)N | (CH₂)_{c} | 1 to 20 | Si(OMe)₃ | 2 |
| 1120 | 0 | Me | Me | (CH₂)_{b} | 0 to 20 | C(═O)N | (CH₂)_{c} | 1 to 20 | Si(OMe)₃ | 2 |
| 1121 | 0 | Me | Me | (CH₂)_{b} | 0 to 20 | C(═O)N | (CH₂)_{c} | 1 to 20 | Si(OMe)₃ | 2 |
| 1122 | 0 | Me | Me | (CH₂)_{b} | 0 to 20 | C(═O)N | (CH₂)_{c} | 1 to 20 | Si(OMe)₃ | 2 |
| 1123 | 0 | Me | Me | (CH₂)_{b} | 0 to 20 | C(═O)N | (CH₂)_{c} | 1 to 20 | Si(OMe)₃ | 2 |
| 1124 | 0 | Me | Me | (CH₂)_{b} | 0 to 20 | C(═O)N | (CH₂)_{c} | 1 to 20 | Si(OMe)₃ | 2 |
| 1125 | 0 | Me | Me | (CH₂)_{b} | 0 to 20 | C(═O)N | (CH₂)_{c} | 1 to 20 | Si(OMe)₃ | 2 |
| 1126 | 0 | Me | Me | (CH₂)_{b} | 0 to 20 | C(═O)N | (CH₂)_{c} | 1 to 20 | Si(OMe)₃ | 2 |
| 1127 | 0 | Me | Me | (CH₂)_{b} | 0 to 20 | C(═O)N | (CH₂)_{c} | 1 to 20 | Si(OMe)₃ | 2 |
| 1128 | 0 | Me | Me | (CH₂)_{b} | 0 to 20 | C(═O)N | (CH₂)_{c} | 1 to 20 | Si(OMe)₃ | 2 |
| 1129 | 0 | Me | Me | (CH₂)_{b} | 0 to 20 | C(═O)N | (CH₂)_{c} | 1 to 20 | Si(OMe)₃ | 2 |

TABLE 372

| No. | R²¹ | | a | R²² | R²³ | R²⁴ | | | R²⁵ | z21 |
|---|---|---|---|---|---|---|---|---|---|---|
| 1130 | CF═CFCF═CF₂ | (CH₂)ₐ | 0 to 20 | Me | Me | SF₅ | (CH₂)ₐ | 0 to 20 | Me | 5 to 100 |
| 1131 | C≡CCF₃ | (CH₂)ₐ | 0 to 20 | Me | Me | SF₅ | (CH₂)ₐ | 0 to 20 | Me | 5 to 100 |
| 1132 | CF₂CH₃ | (CH₂)ₐ | 0 to 20 | Me | Me | SF₅ | (CH₂)ₐ | 0 to 20 | Me | 5 to 100 |
| 1133 | (CF₂)₂H | (CH₂)ₐ | 0 to 20 | Me | Me | SF₅ | (CH₂)ₐ | 0 to 20 | Me | 5 to 100 |
| 1134 | (CF₂)₂CH₃ | (CH₂)ₐ | 0 to 20 | Me | Me | SF₅ | (CH₂)ₐ | 0 to 20 | Me | 5 to 100 |
| 1135 | (CF₂)₄H | (CH₂)ₐ | 0 to 20 | Me | Me | SF₅ | (CH₂)ₐ | 0 to 20 | Me | 5 to 100 |
| 1136 | C₆F₅ | (CH₂)ₐ | 0 to 20 | Me | Me | SF₅ | (CH₂)ₐ | 0 to 20 | Me | 5 to 100 |
| 1137 | 4-CF₃C₆F₄ | (CH₂)ₐ | 0 to 20 | Me | Me | SF₅ | (CH₂)ₐ | 0 to 20 | Me | 5 to 100 |
| 1138 | 4-SF₅C₆F₄ | (CH₂)ₐ | 0 to 20 | Me | Me | SF₅ | (CH₂)ₐ | 0 to 20 | Me | 5 to 100 |
| 1139 | 3,5-CF₃C₆F₃ | (CH₂)ₐ | 0 to 20 | Me | Me | SF₅ | (CH₂)ₐ | 0 to 20 | Me | 5 to 100 |
| 1140 | 3,5-SF₅C₆F₃ | (CH₂)ₐ | 0 to 20 | Me | Me | SF₅ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1130 | 0 | Me | Me | (CH₂)_{b} | 0 to 20 | C(═O)N | (CH₂)_{c} | 1 to 20 | Si(OMe)₃ | 2 |
| 1131 | 0 | Me | Me | (CH₂)_{b} | 0 to 20 | C(═O)N | (CH₂)_{c} | 1 to 20 | Si(OMe)₃ | 2 |
| 1132 | 0 | Me | Me | (CH₂)_{b} | 0 to 20 | C(═O)N | (CH₂)_{c} | 1 to 20 | Si(OMe)₃ | 2 |
| 1133 | 0 | Me | Me | (CH₂)_{b} | 0 to 20 | C(═O)N | (CH₂)_{c} | 1 to 20 | Si(OMe)₃ | 2 |
| 1134 | 0 | Me | Me | (CH₂)_{b} | 0 to 20 | C(═O)N | (CH₂)_{c} | 1 to 20 | Si(OMe)₃ | 2 |
| 1135 | 0 | Me | Me | (CH₂)_{b} | 0 to 20 | C(═O)N | (CH₂)_{c} | 1 to 20 | Si(OMe)₃ | 2 |
| 1136 | 0 | Me | Me | (CH₂)_{b} | 0 to 20 | C(═O)N | (CH₂)_{c} | 1 to 20 | Si(OMe)₃ | 2 |
| 1137 | 0 | Me | Me | (CH₂)_{b} | 0 to 20 | C(═O)N | (CH₂)_{c} | 1 to 20 | Si(OMe)₃ | 2 |
| 1138 | 0 | Me | Me | (CH₂)_{b} | 0 to 20 | C(═O)N | (CH₂)_{c} | 1 to 20 | Si(OMe)₃ | 2 |
| 1139 | 0 | Me | Me | (CH₂)_{b} | 0 to 20 | C(═O)N | (CH₂)_{c} | 1 to 20 | Si(OMe)₃ | 2 |
| 1140 | 0 | Me | Me | (CH₂)_{b} | 0 to 20 | C(═O)N | (CH₂)_{c} | 1 to 20 | Si(OMe)₃ | 2 |

TABLE 373

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1141 | 4-CF₃C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1142 | 4-SF₅C₆H₄ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1143 | 3,5-CF₃C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1144 | 3,5-SF₅C₆H₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1145 | 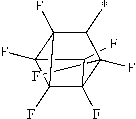 [SMILES: *C1C(C)(F)C2(F)C(F)C(F)(C1(F)CF)C2(C)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1146 | 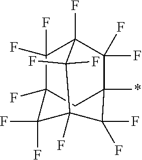 [SMILES: *C12CC3(F)C(F)(F)C(F)(C1(F)F)C(F)(F)C(F)(C2(F)F)C3(F)F] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1147 | 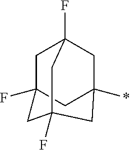 [SMILES: *C12CC3(F)CC(F)(C1)CC(F)(C2)C3] | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1148 | SF₅ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1149 | OCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1150 | SCF₃ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1151 | N(CH₂CF₃)₂ | (CH₂)ₐ | 0 to 20 | Me | Me | SF₅ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 374

| No. | R²¹ | | a | R²² | R²³ | R²⁴ | | | R²⁵ | z21 |
|---|---|---|---|---|---|---|---|---|---|---|
| 1152 | N(CF₃)₂ | (CH₂)ₐ | 0 to 20 | Me | Me | SF₅ | (CH₂)ₐ | 0 to 20 | Me | 5 to 100 |
| 1153 | Me | (CH₂)ₐ | 0 to 20 | Me | Me | OCF₃ | (CH₂)ₐ | 0 to 20 | Me | 5 to 100 |
| 1154 | CF₃ | (CH₂)ₐ | 0 to 20 | Me | Me | OCF₃ | (CH₂)ₐ | 0 to 20 | Me | 5 to 100 |
| 1155 | (CF₃)₂CF | (CH₂)ₐ | 0 to 20 | Me | Me | OCF₃ | (CH₂)ₐ | 0 to 20 | Me | 5 to 100 |
| 1156 | (CF₃)₃C | (CH₂)ₐ | 0 to 20 | Me | Me | OCF₃ | (CH₂)ₐ | 0 to 20 | Me | 5 to 100 |
| 1157 | C₄F₉ | (CH₂)ₐ | 0 to 20 | Me | Me | OCF₃ | (CH₂)ₐ | 0 to 20 | Me | 5 to 100 |
| 1158 | C₈F₁₇ | (CH₂)ₐ | 0 to 20 | Me | Me | OCF₃ | (CH₂)ₐ | 0 to 20 | Me | 5 to 100 |
| 1159 | c-C₆F₁₁ | (CH₂)ₐ | 0 to 20 | Me | Me | OCF₃ | (CH₂)ₐ | 0 to 20 | Me | 5 to 100 |
| 1160 | CHF₂ | (CH₂)ₐ | 0 to 20 | Me | Me | OCF₃ | (CH₂)ₐ | 0 to 20 | Me | 5 to 100 |
| 1161 | CClF₂ | (CH₂)ₐ | 0 to 20 | Me | Me | OCF₃ | (CH₂)ₐ | 0 to 20 | Me | 5 to 100 |
| 1162 | CBrF₂ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1152 | 0 | Me | Me | (CH₂)_{b} | 0 to 20 | C(═O)N | (CH₂)_{c} | 1 to 20 | Si(OMe)₃ | 2 |
| 1153 | 0 | Me | Me | (CH₂)_{b} | 0 to 20 | C(═O)N | (CH₂)_{c} | 1 to 20 | Si(OMe)₃ | 2 |
| 1154 | 0 | Me | Me | (CH₂)_{b} | 0 to 20 | C(═O)N | (CH₂)_{c} | 1 to 20 | Si(OMe)₃ | 2 |
| 1155 | 0 | Me | Me | (CH₂)_{b} | 0 to 20 | C(═O)N | (CH₂)_{c} | 1 to 20 | Si(OMe)₃ | 2 |
| 1156 | 0 | Me | Me | (CH₂)_{b} | 0 to 20 | C(═O)N | (CH₂)_{c} | 1 to 20 | Si(OMe)₃ | 2 |
| 1157 | 0 | Me | Me | (CH₂)_{b} | 0 to 20 | C(═O)N | (CH₂)_{c} | 1 to 20 | Si(OMe)₃ | 2 |
| 1158 | 0 | Me | Me | (CH₂)_{b} | 0 to 20 | C(═O)N | (CH₂)_{c} | 1 to 20 | Si(OMe)₃ | 2 |
| 1159 | 0 | Me | Me | (CH₂)_{b} | 0 to 20 | C(═O)N | (CH₂)_{c} | 1 to 20 | Si(OMe)₃ | 2 |
| 1160 | 0 | Me | Me | (CH₂)_{b} | 0 to 20 | C(═O)N | (CH₂)_{c} | 1 to 20 | Si(OMe)₃ | 2 |
| 1161 | 0 | Me | Me | (CH₂)_{b} | 0 to 20 | C(═O)N | (CH₂)_{c} | 1 to 20 | Si(OMe)₃ | 2 |
| 1162 | 0 | Me | Me | (CH₂)_{b} | 0 to 20 | C(═O)N | (CH₂)_{c} | 1 to 20 | Si(OMe)₃ | 2 |

TABLE 375

| No. | R²¹ | | a | R²² | R²³ | R²⁴ | | | R²⁵ | z21 |
|---|---|---|---|---|---|---|---|---|---|---|
| 1163 | ClF₂ | (CH₂)ₐ | 0 to 20 | Me | Me | OCF₃ | (CH₂)ₐ | 0 to 20 | Me | 5 to 100 |
| 1164 | CF═CF₂ | (CH₂)ₐ | 0 to 20 | Me | Me | OCF₃ | (CH₂)ₐ | 0 to 20 | Me | 5 to 100 |
| 1165 | CF═CFCF₃ | (CH₂)ₐ | 0 to 20 | Me | Me | OCF₃ | (CH₂)ₐ | 0 to 20 | Me | 5 to 100 |
| 1166 | CF═CFCF═CF₂ | (CH₂)ₐ | 0 to 20 | Me | Me | OCF₃ | (CH₂)ₐ | 0 to 20 | Me | 5 to 100 |
| 1167 | C≡CCF₃ | (CH₂)ₐ | 0 to 20 | Me | Me | OCF₃ | (CH₂)ₐ | 0 to 20 | Me | 5 to 100 |
| 1168 | CF₂CH₃ | (CH₂)ₐ | 0 to 20 | Me | Me | OCF₃ | (CH₂)ₐ | 0 to 20 | Me | 5 to 100 |
| 1169 | (CF₂)₂H | (CH₂)ₐ | 0 to 20 | Me | Me | OCF₃ | (CH₂)ₐ | 0 to 20 | Me | 5 to 100 |
| 1170 | (CF₂)₂CH₃ | (CH₂)ₐ | 0 to 20 | Me | Me | OCF₃ | (CH₂)ₐ | 0 to 20 | Me | 5 to 100 |
| 1171 | (CF₂)₄H | (CH₂)ₐ | 0 to 20 | Me | Me | OCF₃ | (CH₂)ₐ | 0 to 20 | Me | 5 to 100 |
| 1172 | C₆F₅ | (CH₂)ₐ | 0 to 20 | Me | Me | OCF₃ | (CH₂)ₐ | 0 to 20 | Me | 5 to 100 |
| 1173 | 4-CF₃C₆F₄ | (CH₂)ₐ | 0 to 20 | Me | Me | OCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1163 | 0 | Me | Me | (CH₂)_{b} | 0 to 20 | C(═O)N | (CH₂)_{c} | 1 to 20 | Si(OMe)₃ | 2 |
| 1164 | 0 | Me | Me | (CH₂)_{b} | 0 to 20 | C(═O)N | (CH₂)_{c} | 1 to 20 | Si(OMe)₃ | 2 |
| 1165 | 0 | Me | Me | (CH₂)_{b} | 0 to 20 | C(═O)N | (CH₂)_{c} | 1 to 20 | Si(OMe)₃ | 2 |
| 1166 | 0 | Me | Me | (CH₂)_{b} | 0 to 20 | C(═O)N | (CH₂)_{c} | 1 to 20 | Si(OMe)₃ | 2 |
| 1167 | 0 | Me | Me | (CH₂)_{b} | 0 to 20 | C(═O)N | (CH₂)_{c} | 1 to 20 | Si(OMe)₃ | 2 |
| 1168 | 0 | Me | Me | (CH₂)_{b} | 0 to 20 | C(═O)N | (CH₂)_{c} | 1 to 20 | Si(OMe)₃ | 2 |
| 1169 | 0 | Me | Me | (CH₂)_{b} | 0 to 20 | C(═O)N | (CH₂)_{c} | 1 to 20 | Si(OMe)₃ | 2 |
| 1170 | 0 | Me | Me | (CH₂)_{b} | 0 to 20 | C(═O)N | (CH₂)_{c} | 1 to 20 | Si(OMe)₃ | 2 |
| 1171 | 0 | Me | Me | (CH₂)_{b} | 0 to 20 | C(═O)N | (CH₂)_{c} | 1 to 20 | Si(OMe)₃ | 2 |
| 1172 | 0 | Me | Me | (CH₂)_{b} | 0 to 20 | C(═O)N | (CH₂)_{c} | 1 to 20 | Si(OMe)₃ | 2 |
| 1173 | 0 | Me | Me | (CH₂)_{b} | 0 to 20 | C(═O)N | (CH₂)_{c} | 1 to 20 | Si(OMe)₃ | 2 |

TABLE 376

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1174 | 4-SF₅C₆F₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1175 | 3,5-CF₃C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1176 | 3,5-SF₅C₆F₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1177 | 4-CF₃C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1178 | 4-SF₅C₆H₄ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1179 | 3,5-CF₃C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1180 | 3,5-SF₅C₆H₃ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1181 | 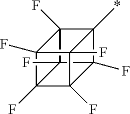 [SMILES: *C12C3(F)C4(F)C1(F)C1(F)C2(F)C3(F)C41F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1182 | 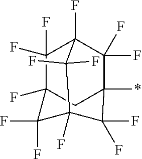 [SMILES: *C12CC3(F)C(F)(F)C(F)(C1(F)F)C(F)(F)C(F)(C2(F)F)C3(F)F] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1183 | 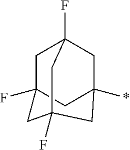 [SMILES: *C12CC3(F)CC(F)(C1)CC(F)(C2)C3] | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1184 | SF₅ | (CH₂)ₐ | 0 to 20 | Me | Me | OCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 377

| No. | R²¹ | | a | R²² | R²³ | R²⁴ | | | R²⁵ | z21 |
|---|---|---|---|---|---|---|---|---|---|---|
| 1185 | OCF₃ | (CH₂)ₐ | 0 to 20 | Me | Me | OCF₃ | (CH₂)ₐ | 0 to 20 | Me | 5 to 100 |
| 1186 | SCF₃ | (CH₂)ₐ | 0 to 20 | Me | Me | OCF₃ | (CH₂)ₐ | 0 to 20 | Me | 5 to 100 |
| 1187 | N(CH₂CF₃)₂ | (CH₂)ₐ | 0 to 20 | Me | Me | OCF₃ | (CH₂)ₐ | 0 to 20 | Me | 5 to 100 |
| 1188 | N(CF₃)₂ | (CH₂)ₐ | 0 to 20 | Me | Me | OCF₃ | (CH₂)ₐ | 0 to 20 | Me | 5 to 100 |
| 1189 | Me | (CH₂)ₐ | 0 to 20 | Me | Me | SCF₃ | (CH₂)ₐ | 0 to 20 | Me | 5 to 100 |
| 1190 | CF₃ | (CH₂)ₐ | 0 to 20 | Me | Me | SCF₃ | (CH₂)ₐ | 0 to 20 | Me | 5 to 100 |
| 1191 | (CF₃)₂CF | (CH₂)ₐ | 0 to 20 | Me | Me | SCF₃ | (CH₂)ₐ | 0 to 20 | Me | 5 to 100 |
| 1192 | (CF₃)₃C | (CH₂)ₐ | 0 to 20 | Me | Me | SCF₃ | (CH₂)ₐ | 0 to 20 | Me | 5 to 100 |
| 1193 | C₄F₉ | (CH₂)ₐ | 0 to 20 | Me | Me | SCF₃ | (CH₂)ₐ | 0 to 20 | Me | 5 to 100 |
| 1194 | C₈F₁₇ | (CH₂)ₐ | 0 to 20 | Me | Me | SCF₃ | (CH₂)ₐ | 0 to 20 | Me | 5 to 100 |
| 1195 | c-C₆F₁₁ | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1185 | 0 | Me | Me | (CH₂)_{b} | 0 to 20 | C(═O)N | (CH₂)_{c} | 1 to 20 | Si(OMe)₃ | 2 |
| 1186 | 0 | Me | Me | (CH₂)_{b} | 0 to 20 | C(═O)N | (CH₂)_{c} | 1 to 20 | Si(OMe)₃ | 2 |
| 1187 | 0 | Me | Me | (CH₂)_{b} | 0 to 20 | C(═O)N | (CH₂)_{c} | 1 to 20 | Si(OMe)₃ | 2 |
| 1188 | 0 | Me | Me | (CH₂)_{b} | 0 to 20 | C(═O)N | (CH₂)_{c} | 1 to 20 | Si(OMe)₃ | 2 |
| 1189 | 0 | Me | Me | (CH₂)_{b} | 0 to 20 | C(═O)N | (CH₂)_{c} | 1 to 20 | Si(OMe)₃ | 2 |
| 1190 | 0 | Me | Me | (CH₂)_{b} | 0 to 20 | C(═O)N | (CH₂)_{c} | 1 to 20 | Si(OMe)₃ | 2 |
| 1191 | 0 | Me | Me | (CH₂)_{b} | 0 to 20 | C(═O)N | (CH₂)_{c} | 1 to 20 | Si(OMe)₃ | 2 |
| 1192 | 0 | Me | Me | (CH₂)_{b} | 0 to 20 | C(═O)N | (CH₂)_{c} | 1 to 20 | Si(OMe)₃ | 2 |
| 1193 | 0 | Me | Me | (CH₂)_{b} | 0 to 20 | C(═O)N | (CH₂)_{c} | 1 to 20 | Si(OMe)₃ | 2 |
| 1194 | 0 | Me | Me | (CH₂)_{b} | 0 to 20 | C(═O)N | (CH₂)_{c} | 1 to 20 | Si(OMe)₃ | 2 |
| 1195 | 0 | Me | Me | (CH₂)_{b} | 0 to 20 | C(═O)N | (CH₂)_{c} | 1 to 20 | Si(OMe)₃ | 2 |

TABLE 378

| No. | R²¹ | | a | R²² | R²³ | R²⁴ | | | R²⁵ | z21 |
|---|---|---|---|---|---|---|---|---|---|---|
| 1196 | CHF₂ | (CH₂)ₐ | 0 to 20 | Me | Me | SCF₃ | (CH₂)ₐ | 0 to 20 | Me | 5 to 100 |
| 1197 | CClF₂ | (CH₂)ₐ | 0 to 20 | Me | Me | SCF₃ | (CH₂)ₐ | 0 to 20 | Me | 5 to 100 |
| 1198 | CBrF₂ | (CH₂)ₐ | 0 to 20 | Me | Me | SCF₃ | (CH₂)ₐ | 0 to 20 | Me | 5 to 100 |
| 1199 | ClF | (CH₂)ₐ | 0 to 20 | Me | Me | SCF₃ | (CH₂)ₐ | 0 to 20 | Me | 5 to 100 |
| 1200 | CF═CF₂ | (CH₂)ₐ | 0 to 20 | Me | Me | SCF₃ | (CH₂)ₐ | 0 to 20 | Me | 5 to 100 |
| 1201 | CF═CFCF₃ | (CH₂)ₐ | 0 to 20 | Me | Me | SCF₃ | (CH₂)ₐ | 0 to 20 | Me | 5 to 100 |
| 1202 | CF═CFCF═CF₂ | (CH₂)ₐ | 0 to 20 | Me | Me | SCF₃ | (CH₂)ₐ | 0 to 20 | Me | 5 to 100 |
| 1203 | C≡CCF₃ | (CH₂)ₐ | 0 to 20 | Me | Me | SCF₃ | (CH₂)ₐ | 0 to 20 | Me | 5 to 100 |
| 1204 | CF₂CH₃ | (CH₂)ₐ | 0 to 20 | Me | Me | SCF₃ | (CH₂)ₐ | 0 to 20 | Me | 5 to 100 |
| 1205 | (CF₂)₂H | (CH₂)ₐ | 0 to 20 | Me | Me | SCF₃ | (CH₂)ₐ | 0 to 20 | Me | 5 to 100 |
| 1206 | (CF₂)₂CH | (CH₂)ₐ | 0 to 20 | Me | Me | SCF₃ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1196 | 0 | Me | Me | (CH₂)_{b} | 0 to 20 | C(═O)N | (CH₂)_{c} | 1 to 20 | Si(OMe)₃ | 2 |
| 1197 | 0 | Me | Me | (CH₂)_{b} | 0 to 20 | C(═O)N | (CH₂)_{c} | 1 to 20 | Si(OMe)₃ | 2 |
| 1198 | 0 | Me | Me | (CH₂)_{b} | 0 to 20 | C(═O)N | (CH₂)_{c} | 1 to 20 | Si(OMe)₃ | 2 |
| 1199 | 0 | Me | Me | (CH₂)_{b} | 0 to 20 | C(═O)N | (CH₂)_{c} | 1 to 20 | Si(OMe)₃ | 2 |
| 1200 | 0 | Me | Me | (CH₂)_{b} | 0 to 20 | C(═O)N | (CH₂)_{c} | 1 to 20 | Si(OMe)₃ | 2 |
| 1201 | 0 | Me | Me | (CH₂)_{b} | 0 to 20 | C(═O)N | (CH₂)_{c} | 1 to 20 | Si(OMe)₃ | 2 |
| 1202 | 0 | Me | Me | (CH₂)_{b} | 0 to 20 | C(═O)N | (CH₂)_{c} | 1 to 20 | Si(OMe)₃ | 2 |
| 1203 | 0 | Me | Me | (CH₂)_{b} | 0 to 20 | C(═O)N | (CH₂)_{c} | 1 to 20 | Si(OMe)₃ | 2 |
| 1204 | 0 | Me | Me | (CH₂)_{b} | 0 to 20 | C(═O)N | (CH₂)_{c} | 1 to 20 | Si(OMe)₃ | 2 |
| 1205 | 0 | Me | Me | (CH₂)_{b} | 0 to 20 | C(═O)N | (CH₂)_{c} | 1 to 20 | Si(OMe)₃ | 2 |
| 1206 | 0 | Me | Me | (CH₂)_{b} | 0 to 20 | C(═O)N | (CH₂)_{c} | 1 to 20 | Si(OMe)₃ | 2 |

TABLE 379

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1207 | (CF₂)4H | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1208\| | CF₆ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1209 | 4-CF₃C₆F₄ | (CH₂)ₐ | 0 to 20 | Me | Me | SCF₃ | (CH₂)ₐ | 0 to 20 | Me | 5 to 100 | 0 | \|Me | Me | (CH₂)_{b} | 0 to 20 | C(═O)N | (CH₂)_{c} | 1 to 20 | Si(OMe)₃ | 2 |
| 1210 | 4-SF₅C₆F₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1211 | 3,5-CF₃C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1212 | 3,5-SF₅C₆F₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1213 | 4-CF₃C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1214 | 4-SF₅C₆H₄ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1215 | 3,5-CF₃C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1216 | 3,5-SF₅C₆H₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1217 | 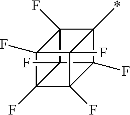 [SMILES: *C12C3(F)C4(F)C1(F)C1(F)C2(F)C3(F)C41F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 380

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1218 | 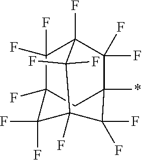 [SMILES: *C12CC3(F)C(F)(F)C(F)(C1(F)F)C(F)(F)C(F)(C2(F)F)C3(F)F] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1219 | 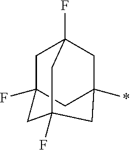 [SMILES: *C12CC3(F)CC(F)(C1)CC(F)(C2)C3] | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1220 | SF₅ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1221 | OCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1222 | SCF₃ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1223 | N(CH₂CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1224 | N(CF₃)₂ | (CH₂)ₐ | 0 to 20 | Me | Me | SCF₃ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1225 | Me | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1226 | CF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1227 | (CF₃)₂CF | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1228 | (CF₃)₃C | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

TABLE 381

| No. | R²¹ | | a | R²² | R²³ | R²⁴ | | | R²⁵ | z21 |
|---|---|---|---|---|---|---|---|---|---|---|
| 1229 | C₄F₉ | (CH₂)ₐ | 0 to 20 | Me | Me | N(CF₃)₂ | (CH₂)ₐ | 0 to 20 | Me | 5 to 100 |
| 1230 | C₈F₁₇ | (CH₂)ₐ | 0 to 20 | Me | Me | N(CF₃)₂ | (CH₂)ₐ | 0 to 20 | Me | 5 to 100 |
| 1231 | c-C₆F₁₁ | (CH₂)ₐ | 0 to 20 | Me | Me | N(CF₃)₂ | (CH₂)ₐ | 0 to 20 | Me | 5 to 100 |
| 1232 | CHF₂ | (CH₂)ₐ | 0 to 20 | Me | Me | N(CF₃)₂ | (CH₂)ₐ | 0 to 20 | Me | 5 to 100 |
| 1233 | CClF₂ | (CH₂)ₐ | 0 to 20 | Me | Me | N(CF₃)₂ | (CH₂)ₐ | 0 to 20 | Me | 5 to 100 |
| 1234 | CBrF₂ | (CH₂)ₐ | 0 to 20 | Me | Me | N(CF₃)₂ | (CH₂)ₐ | 0 to 20 | Me | 5 to 100 |
| 1235 | ClF₂ | (CH₂)ₐ | 0 to 20 | Me | Me | N(CF₃)₂ | (CH₂)ₐ | 0 to 20 | Me | 5 to 100 |
| 1236 | CF═CF₂ | (CH₂)ₐ | 0 to 20 | Me | Me | N(CF₃)₂ | (CH₂)ₐ | 0 to 20 | Me | 5 to 100 |
| 1237 | CF═CFCF₃ | (CH₂)ₐ | 0 to 20 | Me | Me | N(CF₃)₂ | (CH₂)ₐ | 0 to 20 | Me | 5 to 100 |
| 1238 | CF═CFCF═CF₂ | (CH₂)ₐ | 0 to 20 | Me | Me | N(CF₃)₂ | (CH₂)ₐ | 0 to 20 | Me | 5 to 100 |
| 1239 | C≡CCF₃ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1229 | 0 | Me | Me | (CH₂)_{b} | 0 to 20 | C(═O)N | (CH₂)_{c} | 1 to 20 | Si(OMe)₃ | 2 |
| 1230 | 0 | Me | Me | (CH₂)_{b} | 0 to 20 | C(═O)N | (CH₂)_{c} | 1 to 20 | Si(OMe)₃ | 2 |
| 1231 | 0 | Me | Me | (CH₂)_{b} | 0 to 20 | C(═O)N | (CH₂)_{c} | 1 to 20 | Si(OMe)₃ | 2 |
| 1232 | 0 | Me | Me | (CH₂)_{b} | 0 to 20 | C(═O)N | (CH₂)_{c} | 1 to 20 | Si(OMe)₃ | 2 |
| 1233 | 0 | Me | Me | (CH₂)_{b} | 0 to 20 | C(═O)N | (CH₂)_{c} | 1 to 20 | Si(OMe)₃ | 2 |
| 1234 | 0 | Me | Me | (CH₂)_{b} | 0 to 20 | C(═O)N | (CH₂)_{c} | 1 to 20 | Si(OMe)₃ | 2 |
| 1235 | 0 | Me | Me | (CH₂)_{b} | 0 to 20 | C(═O)N | (CH₂)_{c} | 1 to 20 | Si(OMe)₃ | 2 |
| 1236 | 0 | Me | Me | (CH₂)_{b} | 0 to 20 | C(═O)N | (CH₂)_{c} | 1 to 20 | Si(OMe)₃ | 2 |
| 1237 | 0 | Me | Me | (CH₂)_{b} | 0 to 20 | C(═O)N | (CH₂)_{c} | 1 to 20 | Si(OMe)₃ | 2 |
| 1238 | 0 | Me | Me | (CH₂)_{b} | 0 to 20 | C(═O)N | (CH₂)_{c} | 1 to 20 | Si(OMe)₃ | 2 |
| 1239 | 0 | Me | Me | (CH₂)_{b} | 0 to 20 | C(═O)N | (CH₂)_{c} | 1 to 20 | Si(OMe)₃ | 2 |

TABLE 382

| No. | R²¹ | | a | R²² | R²³ | R²⁴ | | | R²⁵ | z21 |
|---|---|---|---|---|---|---|---|---|---|---|
| 1240 | CF₂CH₃ | (CH₂)ₐ | 0 to 20 | Me | Me | N(CF₃)₂ | (CH₂)ₐ | 0 to 20 | Me | 5 to 100 |
| 1241 | (CF₂)₂H | (CH₂)ₐ | 0 to 20 | Me | Me | N(CF₃)₂ | (CH₂)ₐ | 0 to 20 | Me | 5 to 100 |
| 1242 | (CF₂)₂CH₃ | (CH₂)ₐ | 0 to 20 | Me | Me | N(CF₃)₂ | (CH₂)ₐ | 0 to 20 | Me | 5 to 100 |
| 1243 | (CF₂)₄H | (CH₂)ₐ | 0 to 20 | Me | Me | SCF₃ | (CH₂)ₐ | 0 to 20 | Me | 5 to 100 |
| 1244 | C₆F₅ | (CH₂)ₐ | 0 to 20 | Me | Me | N(CF₃)₂ | (CH₂)ₐ | 0 to 20 | Me | 5 to 100 |
| 1245 | 4-CF₃C₆F₄ | (CH₂)ₐ | 0 to 20 | Me | Me | N(CF₃)₂ | (CH₂)ₐ | 0 to 20 | Me | 5 to 100 |
| 1246 | 4-SF₅C₆F₄ | (CH₂)ₐ | 0 to 20 | Me | Me | N(CF₃)₂ | (CH₂)ₐ | 0 to 20 | Me | 5 to 100 |
| 1247 | 3,5-CF₃C₆F₃ | (CH₂)ₐ | 0 to 20 | Me | Me | N(CF₃)₂ | (CH₂)ₐ | 0 to 20 | Me | 5 to 100 |
| 1248 | 3,5-SF₅C₆F₃ | (CH₂)ₐ | 0 to 20 | Me | Me | N(CF₃)₂ | (CH₂)ₐ | 0 to 20 | Me | 5 to 100 |
| 1249 | 4-CF₃C₆H₄ | (CH₂)ₐ | 0 to 20 | Me | Me | N(CF₃)₂ | (CH₂)ₐ | 0 to 20 | Me | 5 to 100 |
| 1250 | 4-SF₅C₆H₄ | (CH₂)ₐ | 0 to 20 | Me | Me | N(CF₃)₂ | (CH₂)ₐ | 0 to 20 | Me | 5 to 100 |

| No. | z22 | R²⁸ | R²⁹ | R¹ | b | L¹ | R² | c | T¹ | x1 |
|---|---|---|---|---|---|---|---|---|---|---|
| 1240 | 0 | Me | Me | (CH₂)_{b} | 0 to 20 | C(═O)N | (CH₂)_{c} | 1 to 20 | Si(OMe)₃ | 2 |
| 1241 | 0 | Me | Me | (CH₂)_{b} | 0 to 20 | C(═O)N | (CH₂)_{c} | 1 to 20 | Si(OMe)₃ | 2 |
| 1242 | 0 | Me | Me | (CH₂)_{b} | 0 to 20 | C(═O)N | (CH₂)_{c} | 1 to 20 | Si(OMe)₃ | 2 |
| 1243 | 0 | Me | Me | (CH₂)_{b} | 0 to 20 | C(═O)N | (CH₂)_{c} | 1 to 20 | Si(OMe)₃ | 2 |
| 1244 | 0 | Me | Me | (CH₂)_{b} | 0 to 20 | C(═O)N | (CH₂)_{c} | 1 to 20 | Si(OMe)₃ | 2 |
| 1245 | 0 | Me | Me | (CH₂)_{b} | 0 to 20 | C(═O)N | (CH₂)_{c} | 1 to 20 | Si(OMe)₃ | 2 |
| 1246 | 0 | Me | Me | (CH₂)_{b} | 0 to 20 | C(═O)N | (CH₂)_{c} | 1 to 20 | Si(OMe)₃ | 2 |
| 1247 | 0 | Me | Me | (CH₂)_{b} | 0 to 20 | C(═O)N | (CH₂)_{c} | 1 to 20 | Si(OMe)₃ | 2 |
| 1248 | 0 | Me | Me | (CH₂)_{b} | 0 to 20 | C(═O)N | (CH₂)_{c} | 1 to 20 | Si(OMe)₃ | 2 |
| 1249 | 0 | Me | Me | (CH₂)_{b} | 0 to 20 | C(═O)N | (CH₂)_{c} | 1 to 20 | Si(OMe)₃ | 2 |
| 1250 | 0 | Me | Me | (CH₂)_{b} | 0 to 20 | C(═O)N | (CH₂)_{c} | 1 to 20 | Si(OMe)₃ | 2 |

TABLE 383

| No. | R²¹ | | a | R²² | R²³ | R²⁴ | | | R²⁵ | z21 | z22 | R²⁸ | R²⁹ | R¹ | b | L¹ | R² | c | T¹ | x1 |
|---|---|---|---|---|---|---|---|---|---|---|---|---|---|---|---|---|---|---|---|---|
| 1251 | 3,5-CF₃C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1252 | 3,5-SF₅C₆H₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1253 | 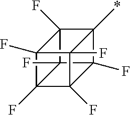 [SMILES: *C12C3(F)C4(F)C1(F)C1(F)C2(F)C3(F)C41F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1254 | 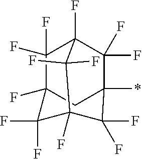 [SMILES: *C12CC3(F)C(F)(F)C(F)(C1(F)F)C(F)(F)C(F)(C2(F)F)C3(F)F] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1255 | 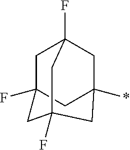 [SMILES: *C12CC3(F)CC(F)(C1)CC(F)(C2)C3] | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1256 | SF₅ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1257 | OCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1258 | SCF₃ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1259 | N(CH₂CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |
| 1260 | N(CF₃)₂ | (CH₂)ₐ | 0 to 20 | Me | Me | N(CF₃)₂ | (CH₂)ₐ | 0 to 20 | Me | 5 to 100 | 0 | Me | Me | (CH₂)_{b} | 0 to 20 | C(═O)N | (CH₂)_{c} | 1 to 20 | Si(OMe)₃ | 2 |

### Compound 1-3

The compound 1-3 is a compound represented by the below-shown Formula (1-3):

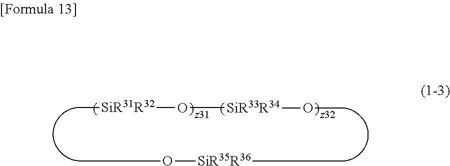

In Formula (1-3):
R³¹ is R^{f1}-L²-,
R³² is an alkyl group or R^{f1}-L²-,
R³³ and R³⁴ are each independently an alkyl group,
R³⁵ is —R¹-L¹-(R²-T¹)ₓ₁,
R³⁶ is an alkyl group,
R^{f1}, L², R¹, L¹, R², T¹, and x1 are synonymous with R^{f1}, L², R¹, L¹, R², T¹, and x1, respectively, in Formula (1),
z31 is an integer of 1 or greater,
z32 is an integer of 0 or greater,
the sum total of z31 and z32 is an integer of 2 or greater; and
when there are a plurality of R³¹, R³³, R³³, R³⁴, R² or T¹, the plurality of R³¹, R³², R³², R³⁴, R² or T¹ may be the same as each other or different from each other.

The carbon number of the alkyl group in R³³, R³², R³⁴, and R³⁶ is preferably 1 to 18, more preferably 1 to 6, and still more preferably 1 to 3. When the carbon number of the alkyl group is 3 or more, the alkyl group having a carbon number of 3 or greater may be linear, or may have a branched or ring structure.

z31 is an integer of 1 or greater, preferably 1 to 100, more preferably 1 to 30, and still more preferably 5 to 20.

z32 is an integer of 0 or greater, preferably 0 to 100, more preferably 1 to 30, and still more preferably 5 to 20.

z31+z32 is an integer of 1 or greater, preferably 1 to 200, more preferably 1 to 60, and still more preferably 10 to 40.

The bonding order of (SiR³¹R³²—O)_{z31} and (SiR³³R³⁴—O)_{z32} in Formula (1-3) is arbitrary.

z31 and z32 in Formula (1-3) represent the numbers of (SiR³¹R³²—O) and (SiR³³R³⁴—O), respectively, and do not represent the arrangements. For example, (SiR³¹R³²—O)_{z31} represents that the number of (SiR³¹R³²—O) is z31, and does not represent the block arrangement structure of (SiR³¹R³²—O)_{z31}. Similarly, the order in which (SiR³¹R³²—O) and (SiR³³R³⁴—O) are listed does not represent the bonding order of the respective units.

For example, (SiR³¹R³²—O) and (SiR³³R³⁴—O) may be alternately arranged, or (SiR³¹R³²—O) and (SiR³³R³⁴—O) may be arranged in each block. Alternatively, they may be randomly arranged.

Specific examples of the compounds 1-3 include compounds represented by the below-shown formulae. In the following table, for example, a compound “No. 1” means a compound in Formula (1-3) in which: R^{f1} in R³¹ is CF₃; L¹ in R³¹ is (CH₂)ₐ; a in (CH₂). is 0 to 20; R³² is Me; z31 is 3; z32 is 0; R¹ in R³⁵ is (CH₂)_{b}; b in (CH₂); is 0 to 20; L¹ in R³⁵ is C(═O)NH; R³ in R³⁵ is (CH₂)_{c}; C in (CH₂) c is 1 to 20; T¹ in R³⁵ is Si(OMe)₃; x1 in (R²-T¹)ₓ₁ in R³⁵ is 1; and R³⁶ is Me.

TABLE 384

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 1 | CF₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 2 | (CF₃)₂CF | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 3 | (CF₃)₃C | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 4 | C₄F₉ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 5 | C₈F₁₇ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 6 | c-C₆F₁₁ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 7 | CHF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 8 | CClF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 9 | CBrF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 10 | ClF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 11 | CF═CF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |

TABLE 385

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 12 | CF═CFCF₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 13 | CF═CFCF═CF₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 14 | C≡CCF₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 15 | CF₂CH₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 16 | (CF₂)₂H | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 17 | (CF₂)₂CH₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 18 | (CF₂)₄H | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 19 | C₆F₅ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 20 | 4-CF₃C₆F₄ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 21 | 4-SF₅C₆F₄ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 22 | 3,5-CF₃C₆F₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |

TABLE 386

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 23 | 3,5-SF₅C₆F₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 24 | 4-CF₃C₆H₄ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 25 | 4-SF₅C₆H₄ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 26 | 3,5-CF₃C₆H₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 27 | 3,5-SF₅C₆H₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 28 | 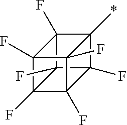 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 29 | 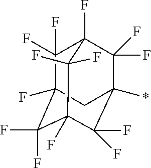 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 30 | 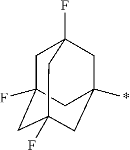 [SMILES: *C12CC3(F)CC(F)(C1)CC(F)(C2)C3] | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | \|Me |
| 31 | SF₅ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 32 | OCF₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 33 | SCF₃ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |

TABLE 387

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 34 | N(CH₂CF₃)₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 35 | N(CF₃)₂ | (CH₂)ₐ | 0 to 20 | Me | 3 | 0 | (CH₂)_{b} | 0 to 20 | C(═O)NH | (CH₂)_{c} | 1 to 20 | Si(OMe)₃ | 1 | Me |
| 36 | CF₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 37 | (CF₃)₂CF | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 38 | (CF₃)₃C | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 39 | C₄F₉ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 40 | C₈F₁₇ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 41 | c-C₆F₁₁ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 42 | CHF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 43 | CClF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 44 | CBrF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |

TABLE 388

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 45 | ClF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 46 | CF═CF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 47 | CF═CFCF₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 48 | CF═CFCF═CF₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 49 | C≡CCF₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 50 | CF₂CH₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 51 | (CF₂)₂H | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 52 | (CF₂)₂CH₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 53 | (CF₂)₄H | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 54 | C₆F₅ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 55 | 4-CF₃C₆F₄ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |

TABLE 389

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 56 | 4-SF₅C₆F₄ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 57 | 3,5-CF₃C₆F₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 58 | 3,5-SF₅C₆F₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 59 | 4-CF₃C₆H₄ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 60 | 4-SF₅C₆H₄ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 61 | 3,5-CF₃C₆H₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 62 | 3,5-SF₅C₆H₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 63 | 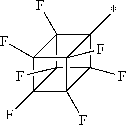 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 64 | 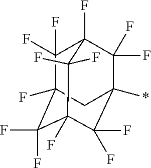 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 65 | 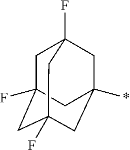 [SMILES: *C12CC3(F)CC(F)(C1)CC(F)(C2)C3] | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 66 | SF₅ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |

TABLE 390

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 67 | OCF₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 68 | SCF₃ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 69 | N(CH₂CF₃)₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 70 | N(CF₃)₂ | (CH₂)ₐ | 0 to 20 | Me | 3 | 0 | (CH₂)_{b} | 0 to 20 | NHC(═O) | (CH₂)_{c} | 1 to 20 | Si(OMe)₃ | 1 | Me |
| 71 | CF₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 72 | (CF₃)₂CF | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 73 | (CF₃)₃C | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 74 | C₄F₉ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 75 | C₈F₁₇ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 76 | c-C₆F₁₁ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 77 | CHF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |

TABLE 391

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 78 | CClF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 79 | CBrF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 80 | ClF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 81 | CF═CF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 82 | CF═CFCF₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 83 | CF═CFCF═CF₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 84 | C≡CCF₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 85 | CF₂CH₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 86 | (CF₂)₂H | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 87 | (CF₂)₂CH₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 88 | (CF₂)₄H | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |

TABLE 392

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 89 | C₆F₅ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 90 | 4-CF₃C₆F₄ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 91 | 4-SF₅C₆F₄ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 92 | 3,5-CF₃C₆F₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 93 | 3,5-SF₅C₆F₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 94 | 4-CF₃C₆H₄ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 95 | 4-SF₅C₆H₄ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 96 | 3,5-CF₃C₆H₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 97 | 3,5-SF₅C₆H₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 98 | 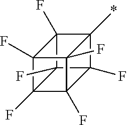 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 99 | 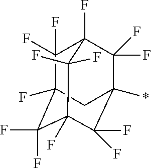 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |

TABLE 393

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 100 | 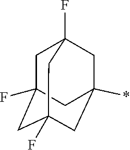 [SMILES: *C12CC3(F)CC(F)(C1)CC(F)(C2)C3] | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 101 | SF₅ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 102 | OCF₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 103 | SCF₃ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 104 | N(CH₂CF₃)₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 105 | N(CF₃)₂ | (CH₂)ₐ | 0 to 20 | Me | 3 | 0 | (CH₂)_{b} | 0 to 20 | SiMe₂ | (CH₂)_{c} | 1 to 20 | Si(OMe)₃ | 1 | Me |
| 106 | CF₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 107 | (CF₃)₂CF | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 108 | (CF₃)₃C | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 109 | C₄F₉ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 110 | C₈F₁₇ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |

TABLE 394

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 111 | c-C₆F₁₁ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 112 | CHF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 113 | CClF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 114 | CBrF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 115 | ClF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 116 | CF═CF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 117 | CF═CFCF₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 118 | CF═CFCF═CF₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 119 | C≡CCF₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 120 | CF₂CH₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 121 | (CF₂)₂H | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |

TABLE 395

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 122 | (CF₂)₂CH₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 123 | (CF₂)₄H | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 124 | C₆F₅ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 125 | 4-CF₃C₆F₄ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 126 | 4-SF₅C₆F₄ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 127 | 3,5-CF₃C₆F₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 128 | 3,5-SF₅C₆F₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 129 | 4-CF₃C₆H₄ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 130 | 4-SF₅C₆H₄ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 131 | 3,5-CF₃C₆H₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 132 | 3,5-SF₅C₆H₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |

TABLE 396

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 133 | 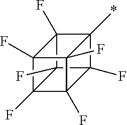 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 134 | 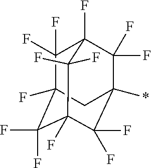 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 135 | 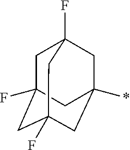 [SMILES: *C12CC3(F)CC(F)(C1)CC(F)(C2)C3] | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 136 | SF₅ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 137 | OCF₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 138 | SCF₃ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 139 | N(CH₂CF₃)₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 140 | N(CF₃)₂ | (CH₂)ₐ | 0 to 20 | Me | 3 | 0 | (CH₂)_{b} | 0 to 20 | CH₂ | (CH₂)_{c} | 1 to 20 | Si(OMe)₃ | 1 | Me |
| 141 | CF₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 142 | (CF₃)₂CF | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 143 | (CF₃)₃C | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |

TABLE 397

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 144 | C₄F₉ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 145 | C₈F₁₇ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 146 | c-C₆F₁₁ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 147 | CHF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 148 | CClF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 149 | CBrF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 150 | ClF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 151 | CF═CF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 152 | CF═CFCF₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 153 | CF═CFCF═CF₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 154 | C≡CCF₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |

TABLE 398

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 155 | CF₂CH₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 156 | (CF₂)₂H | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 157 | (CF₂)₂CH₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 158 | (CF₂)₄H | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 159 | C₆F₅ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 160 | 4-CF₃C₆F₄ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 161 | 4-SF₅C₆F₄ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 162 | 3,5-CF₃C₆F₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 163 | 3,5-SF₅C₆F₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 164 | 4-CF₃C₆H₄ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 165 | 4-SF₅C₆H₄ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |

TABLE 399

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 166 | 3,5-CF₃C₆H₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 167 | 3,5-SF₅C₆H₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 168 | 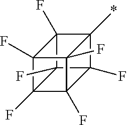 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 169 | 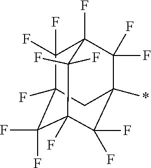 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 170 | 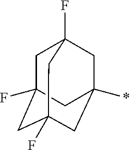 [SMILES: *C12CC3(F)CC(F)(C1)CC(F)(C2)C3] | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 171 | SF₅ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 172 | OCF₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 173 | SCF₃ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 174 | N(CH₂CF₃)₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 175 | N(CF₃)₂ | (CH₂)ₐ | 0 to 20 | Me | 3 | 0 | (CH₂)_{b} | 0 to 20 | C(═O)NHCH₂CH | (CH₂)_{c} | 1 to 20 | Si(OMe)₃ | 2 | Me |
| 176 | CF₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |

TABLE 400

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 177 | (CF₃)₂CF | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 178 | (CF₃)₃C | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 179 | C₄F₉ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 180 | C₈F₁₇ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 181 | c-C₆F₁₁ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 182 | CHF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 183 | CClF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 184 | CBrF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 185 | ClF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 186 | CF═CF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 187 | CF═CFCF₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |

TABLE 401

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 188 | CF═CFCF═CF₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 189 | C≡CCF₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 190 | CF₂CH₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 191 | (CF₂)₂H | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 192 | (CF₂)₂CH₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 193 | (CF₂)₄H | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 194 | C₆F₅ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 195 | 4-CF₃C₆F₄ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 196 | 4-SF₅C₆F₄ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 197 | 3,5-CF₃C₆F₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 198 | 3,5-SF₅C₆F₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |

TABLE 402

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 199 | 4-CF₃C₆H₄ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 200 | 4-SF₅C₆H₄ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 201 | 3,5-CF₃C₆H₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 202 | 3,5-SF₅C₆H₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 203 | 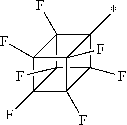 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 204 | 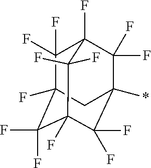 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 205 | 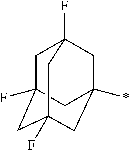 [SMILES: *C12CC3(F)CC(F)(C1)CC(F)(C2)C3] | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 206 | SF₅ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 207 | OCF₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 208 | SCF₃ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 209 | N(CH₂CF₃)₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |

TABLE 403

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 210 | N(CF₃)₂ | (CH₂)ₐ | 0 to 20 | Me | 3 | 0 | (CH₂)_{b} | 0 to 20 | NHC(═O)CH₂CH | (CH₂)_{c} | 1 to 20 | Si(OMe)₃ | 2 | Me |
| 211 | CF₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 212 | (CF₃)₂CF | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 213 | (CF₃)₃C | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 214 | C₄F₉ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 215 | C₈F₁₇ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 216 | c-C₆F₁₁ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 217 | CHF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 218 | CClF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 219 | CBrF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 220 | ClF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |

TABLE 404

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 221 | CF═CF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 222 | CF═CFCF₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 223 | CF═CFCF═CF₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 224 | C≡CCF₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 225 | CF₂CH₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 226 | (CF₂)₂H | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 227 | (CF₂)₂CH₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 228 | (CF₂)₄H | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 229 | C₆F₅ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 230 | 4-CF₃C₆F₄ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 231 | 4-SF₅C₆F₄ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |

TABLE 405

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 232 | 3,5-CF₃C₆F₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 233 | 3,5-SF₅C₆F₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 234 | 4-CF₃C₆H₄ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 235 | 4-SF₅C₆H₄ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 236 | 3,5-CF₃C₆H₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 237 | 3,5-SF₅C₆H₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 238 | 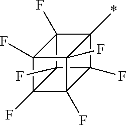 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 239 | 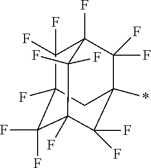 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 240 | 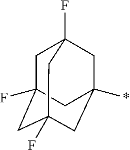 [SMILES: *C12CC3(F)CC(F)(C1)CC(F)(C2)C3] | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 241 | SF₅ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 242 | OCF₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |

TABLE 406

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 243 | SCF₃ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 244 | N(CH₂CF₃)₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 245 | N(CF₃)₂ | (CH₂)ₐ | 0 to 20 | Me | 3 | 0 | (CH₂)_{b} | 0 to 20 | SiMe | (CH₂)_{c} | 1 to 20 | Si(OMe)₃ | 2 | Me |
| 246 | CF₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 247 | (CF₃)₂CF | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 248 | (CF₃)₃C | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 249 | C₄F₉ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 250 | C₈F₁₇ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 251 | c-C₆F₁₁ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 252 | CHF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 253 | CClF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |

TABLE 407

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 254 | CBrF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 255 | ClF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 256 | CF═CF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 257 | CF═CFCF₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 258 | CF═CFCF═CF₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 259 | C≡CCF₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 260 | CF₂CH₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 261 | (CF₂)₂H | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 262 | (CF₂)₂CH₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 263 | (CF₂)₄H | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 264 | C₆F₅ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |

TABLE 408

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 265 | 4-CF₃C₆F₄ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 266 | 4-SF₅C₆F₄ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 267 | 3,5-CF₃C₆F₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 268 | 3,5-SF₅C₆F₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 269 | 4-CF₃C₆H₄ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 270 | 4-SF₅C₆H₄ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 271 | 3,5-CF₃C₆H₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 272 | 3,5-SF₅C₆H₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 273 | 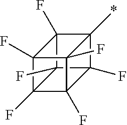 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 274 | 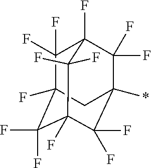 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 275 | 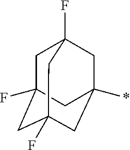 [SMILES: *C12CC3(F)CC(F)(C1)CC(F)(C2)C3] | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |

TABLE 409

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 276 | SF₅ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 277 | OCF₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 278 | SCF₃ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 279 | N(CH₂CF₃)₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 280 | N(CF₃)₂ | (CH₂)ₐ | 0 to 20 | Me | 3 | 0 | (CH₂)_{b} | 0 to 20 | CH | (CH₂)_{c} | 1 to 20 | Si(OMe)₃ | 2 | Me |
| 281 | CF₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 282 | (CF₃)₂CF | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 283 | (CF₃)₃C | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 284 | C₄F₉ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 285 | C₈F₁₇ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 286 | c-C₆F₁₁ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |

TABLE 410

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 287 | CHF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 288 | CClF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 289 | CBrF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 290 | ClF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 291 | CF═CF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 292 | CF═CFCF₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 293 | CF═CFCF═CF₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 294 | C≡CCF₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 295 | CF₂CH₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 296 | (CF₂)₂H | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 297 | (CF₂)₂CH₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |

TABLE 411

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 298 | (CF₂)₄H | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 299 | C₆F₅ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 300 | 4-CF₃C₆F₄ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 301 | 4-SF₅C₆F₄ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 302 | 3,5-CF₃C₆F₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 303 | 3,5-SF₅C₆F₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 304 | 4-CF₃C₆H₄ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 305 | 4-SF₅C₆H₄ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 306 | 3,5-CF₃C₆H₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 307 | 3,5-SF₅C₆H₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 308 | 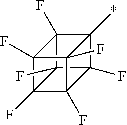 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |

TABLE 412

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 309 | 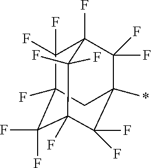 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 310 | 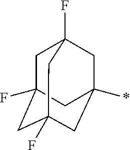 [SMILES: *C12CC3(F)CC(F)(C1)CC(F)(C2)C3] | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 311 | SF₅ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 312 | OCF₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 313 | SCF₃ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 314 | N(CH₂CF₃)₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 315 | N(CF₃)₂ | (CH₂)ₐ | 0 to 20 | Me | 3 | 0 | (CH₂)_{b} | 0 to 20 | C(═O)NHCH₂C | (CH₂)_{c} | 1 to 20 | Si(OMe)₃ | 3 | Me |
| 316 | CF₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 317 | (CF₃)₂CF | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 318 | (CF₃)₃C | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 319 | C₄F₉ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |

TABLE 413

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 320 | C₈F₁₇ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 321 | c-C₆F₁₁ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 322 | CHF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 323 | CClF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 324 | CBrF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 325 | ClF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 326 | CF═CF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 327 | CF═CFCF₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 328 | CF═CFCF═CF₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 329 | C≡CCF₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 330 | CF₂CH₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |

TABLE 414

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 331 | (CF₂)₂H | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 332 | (CF₂)₂CH₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 333 | (CF₂)₄H | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 334 | C₆F₅ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 335 | 4-CF₃C₆F₄ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 336 | 4-SF₅C₆F₄ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 337 | 3,5-CF₃C₆F₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 338 | 3,5-SF₅C₆F₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 339 | 4-CF₃C₆H₄ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 340 | 4-SF₅C₆H₄ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 341 | 3,5-CF₃C₆H₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |

TABLE 415

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 342 | 3,5-SF₅C₆H₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 343 | 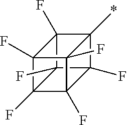 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 344 | 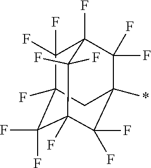 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 345 | 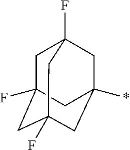 [SMILES: *C12CC3(F)CC(F)(C1)CC(F)(C2)C3] | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 346 | SF₅ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 347 | OCF₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 348 | SCF₃ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 349 | N(CH₂CF₃)₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 350 | N(CF₃)₂ | (CH₂)ₐ | 0 to 20 | Me | 3 | 0 | (CH₂)_{b} | 0 to 20 | NHC(═O)CH₂C | (CH₂)_{c} | 1 to 20 | Si(OMe)₃ | 3 | Me |
| 351 | CF₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 352 | (CF₃)₂CF | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |

TABLE 416

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 353 | (CF₃)₃C | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 354 | C₄F₉ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 355 | C₈F₁₇ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 356 | c-C₆F₁₁ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 357 | CHF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 358 | CClF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 359 | CBrF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 360 | ClF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 361 | CF═CF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 362 | CF═CFCF₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 363 | CF═CFCF═CF₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |

TABLE 417

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 364 | C≡CCF₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 365 | CF₂CH₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 366 | (CF₂)₂H | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 367 | (CF₂)₂CH₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 368 | (CF₂)₄H | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 369 | C₆F₅ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 370 | 4-CF₃C₆F₄ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 371 | 4-SF₅C₆F₄ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 372 | 3,5-CF₃C₆F₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 373 | 3,5-SF₅C₆F₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 374 | 4-CF₃C₆H₄ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |

TABLE 418

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 375 | 4-SF₅C₆H₄ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 376 | 3,5-CF₃C₆H₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 377 | 3,5-SF₅C₆H₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 378 | 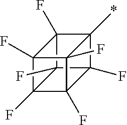 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 379 | 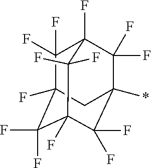 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 380 | 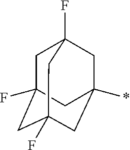 [SMILES: *C12CC3(F)CC(F)(C1)CC(F)(C2)C3] | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 381 | SF₅ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 382 | OCF₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 383 | SCF₃ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 384 | N(CH₂CF₃)₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |
| 385 | N(CF₃)₂ | (CH₂)ₐ | 0 to 20 | Me | 3 | 0 | (CH₂)_{b} | 0 to 20 | Si | (CH₂)_{c} | 1 to 20 | Si(OMe)₃ | 3 | Me |

TABLE 419

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 386 | CF₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 387 | (CF₃)₂CF | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 388 | (CF₃)₃C | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 389 | C₄F₉ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 390 | C₈F₁₇ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 391 | c-C₆F₁₁ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 392 | CHF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 393 | CClF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 394 | CBrF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 395 | ClF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 396 | CF═CF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |

TABLE 420

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 397 | CF═CFCF₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 398 | CF═CFCF═CF₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 399 | C≡CCF₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 400 | CF₂CH₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 401 | (CF₂)₂H | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 402 | (CF₂)₂CH₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 403 | (CF₂)₄H | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 404 | C₆F₅ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 405 | 4-CF₃C₆F₄ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 406 | 4-SF₅C₆F₄ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 407 | 3,5-CF₃C₆F₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |

TABLE 421

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 408 | 3,5-SF₅C₆F₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 409 | 4-CF₃C₆H₄ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 410 | 4-SF₅C₆H₄ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 411 | 3,5-CF₃C₆H₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 412 | 3,5-SF₅C₆H₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 413 | 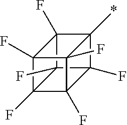 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 414 | 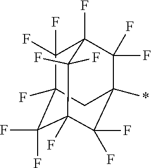 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 415 | 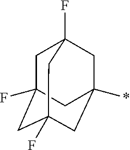 [SMILES: *C12CC3(F)CC(F)(C1)CC(F)(C2)C3] | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 416 | SF₅ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 417 | OCF₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 418 | SCF₃ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |

TABLE 422

| No. | R^{f1} | L² | a | R³² | z31 | z32 | R¹ | b | L¹ | R² | c | T¹ | x1 | R³⁶ |
|---|---|---|---|---|---|---|---|---|---|---|---|---|---|---|
| 419 | N(CH₂CF₃)₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |
| 420 | N(CF₃)₂ | (CH₂)ₐ | 0 to 20 | Me | 3 | 0 | (CH₂)_{b} | 0 to 20 | C | (CH₂)_{c} | 1 to 20 | Si(OMe)₃ | 3 | Me |

TABLE 423

| No. | R^{f1} | L² | a | R³² | Z31 | Z32 | R¹ | b | L¹ | R² | c | T¹ | x1 | R³⁶ |
|---|---|---|---|---|---|---|---|---|---|---|---|---|---|---|
| 421 | CF₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 422 | (CF₃)₂CF | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 423 | (CF₃)₃C | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 424 | C₄F₉ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 425 | C₈F₁₇ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 426 | c-C₆F₁₁ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 427 | CHF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 428 | CClF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 429 | CBrF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 430 | ClF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 431 | CF═CF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |

TABLE 424

| No. | R^{f1} | L² | a | R³² | Z31 | Z32 | R¹ | b | L¹ | R² | c | T¹ | x1 | R³⁶ |
|---|---|---|---|---|---|---|---|---|---|---|---|---|---|---|
| 432 | CF═CFCF₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 433 | CF═CFCF═CF₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 434 | C≡CCF₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 435 | CF₂CH₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 436 | (CF₂)₂H | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 437 | (CF₂)₂CH₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 438 | (CF₂)₄H | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 439 | C₆F₅ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 440 | 4-CF₃C₆F₄ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 441 | 4-SF₅C₆F₄ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 442 | 3,5-CF₃C₆F₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |

TABLE 425

| No. | R^{f1} | L² | a | R³² | Z31 | Z32 | R¹ | b | L¹ | R² | c | T¹ | x1 | R³⁶ |
|---|---|---|---|---|---|---|---|---|---|---|---|---|---|---|
| 443 | 3,5-SF₅C₆F₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 444 | 4-CF₃C₆H₄ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 445 | 4-SF₅C₆H₄ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 446 | 3,5-CF₃C₆H₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | \|Me |
| 447 | 3,5-SF₅C₆H₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 448 | 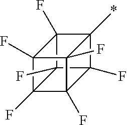 [SMILES: *C12C3(F)C4(F)C1(F)C1(F)C2(F)C3(F)C41F] | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 449 | 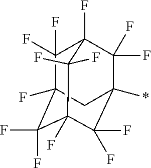 [SMILES: *C12CC3(F)C(F)(F)C(F)(C1(F)F)C(F)(F)C(F)(C2(F)F)C3(F)F] | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 450 | 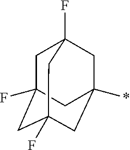 [SMILES: *C12CC3(F)CC(F)(C1)CC(F)(C2)C3] | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 451 | SF₅ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 452 | OCF₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | \|Me |
| 453 | SCF₃ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |

TABLE 426

| No. | R^{f1} | L² | a | R³² | Z31 | Z32 | R¹ | b | L¹ | R² | c | T¹ | x1 | R³⁶ |
|---|---|---|---|---|---|---|---|---|---|---|---|---|---|---|
| 454 | N(CH₂CF₃)₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |
| 455 | N(CF₃)₂ | (CH₂)ₐ | 0 to 20 | Me | 3 | 0 | (CH₂)_{b} | 0 to 20 | C(═O)N | (CH₂)_{c} | 1 to 20 | Si(OMe)₃ | 2 | Me |

### <Physical Property of Compound 1>

The number-average molecular weight (Mn) of the compound 1 is preferably 500 to 20,000, more preferably 600 to 18,000, and still more preferably 700 to 15,000.

When Mn is 500 or greater, the abrasion resistance property of the surface layer becomes excellent.

When Mn is 20,000 or smaller, the viscosity can be easily adjusted within an appropriate range, and the solubility is improved, so that the handling property during the film formation becomes excellent.

### [Surface Treatment Agent]

The surface treatment agent according to the present invention (hereinafter also referred to as “the surface treatment agent disclosed herein”) contains the compound 1.

The surface treatment agent disclosed herein is suitably used as a surface treatment agent for uses in which it is required that the performance that water/oil repellency is not lowered even when the surface layer is repeatedly rubbed by a finger (friction resistance property) and the performance that fingerprints adhered to the surface layer can be easily removed by wiping (fingerprint stain removal property) are maintained for a long period of time, such as for a member constituting the surface of a touch panel which a finger touches, lenses of eyeglass, and a display of a wearable terminal.

Further, since the surface treatment agent disclosed herein has excellent slip resistance, it is also suitably used for glass-coated housings of portable apparatuses such as smartphones and tablet terminals.

The surface treatment agent disclosed herein is also suitably used for antifouling coating agents or waterproof coating agents.

The surface treatment agent disclosed herein may further contain a liquid medium.

In the following description, a surface treatment agent discloses herein containing a liquid medium may be referred to as a coating liquid.

The coating liquid may be a liquid, a solution, or a dispersion liquid.

The coating liquid should contain at least the compound 1, and may contain impurities such as by-products generated in the manufacturing process of the compound 1.

The concentration of the compound 1 in the coating liquid is preferably 0.001 to 40 mass %, more preferably 0.01 to 20 mass %, and still more preferably 0.1 to 10 mass %.

The liquid medium is preferably an organic solvent.

The organic solvent may be a fluorine-containing organic solvent or a non-fluorine-containing organic solvent, or the liquid medium may contain both solvents.

Specific examples of the fluorine-containing organic solvent include fluorinated alkanes, fluorinated aromatic compounds, fluoroalkyl ethers, fluorinated alkylamines, fluoroalcohols, and hydrofluoroolefins (HFO).

As the fluorinated alkane, a compound having a carbon number of 4 to 8 is preferred.

Specific examples of commercial products include C₆F₁₃H (manufactured by AGC Inc., Asahiklin (Registered Trademark) AC-2000), C₆F₁₃C₂H₅ (manufactured by AGC Inc., Asahiklin (Registered Trademark) AC-6000), and C₂F₅CHFCHFCF₃ (manufactured by Chemours, Vertrel (Registered Trademark) XF).

Specific examples of fluorinated aromatic compounds include hexafluorobenzene, trifluoromethylbenzene, perfluorotoluene, and bis(trifluoromethyl)benzene.

As the fluoroalkyl ether, a compound having a carbon number 4 to 12 is preferred.

Specific examples of commercial products include CF₃CH₂OCF₂CF₂H (manufactured by AGC Inc., Asahiklin (Registered Trademark) AE-3000), C₄F₉OCH₃ (manufactured by 3M, Novec (Registered Trademark) 7100), C₄F₉OC₂H₅ (manufactured by 3M, Novec (Registered Trademark) 7200), and C₂F₅CF(OCH₃)C₃F₇ (manufactured by 3M, Novec (Registered Trademark) 7300).

Specific examples of fluorinated alkylamines include perfluorotripropylamine and perfluorotributylamine.

Specific examples of fluoroalcohols include 2, 2, 3, 3-tetrafluoropropanol, 2, 2, 2-trifluoroethanol, and hexafluoroisopropanol.

Specific examples of HFO include 1-chloro-2, 3, 3-trifluoro-1-propene (HCFO-1233 yd) (manufactured by AGC Inc., Amolea (Registered Trademark) AS-300).

Examples of non-fluorinated organic solvents include compounds consisting solely of hydrogen atoms and carbon atoms, and compounds consisting solely of hydrogen atoms, carbon atoms, and oxygen atoms, hydrocarbon-based organic solvents, alcohol-based organic solvents, ketone-based organic solvents, ether-based organic solvents, ester-based organic solvents, and glycol-based organic solvents.

Specific examples of hydrocarbon organic solvents include pentane, hexane, heptane, octane, hexadecane, isohexane, isooctane, isononane, cycloheptane, cyclohexane, bicyclohexyl, benzene, toluene, ethylbenzene, o-xylene, m-xylene, p-xylene, o-diethylbenzene, m-diethylbenzene, p-diethylbenzene, n-butylbenzene, sec-butylbenzene, and tert-butylbenzene.

Specific examples of alcohol-based organic solvents include methanol, ethanol, 1-propanol, isopropyl alcohol, n-butanol, diacetone alcohol, isobutanol, sec-butanol, tert-butanol, pentanol, 3-methyl-1,3-butanediol, 1,3-butanediol, 1,3-butylene glycol, octanediol, 2,4-diethylpentanediol, butylethylpropanediol, 2-methyl-1,3-propanediol, 4-hydroxy-4 methyl-2-pentanone, 2-ethyl-1-hexanol, 3, 5, 5-trimethyl-1-hexanol, isodecanol, isotridecanol, 3-methoxy-3-methyl-1-butanol, 2-methoxybutanol, 3-methoxybutanol, cyclohexanol, furfuryl alcohol, tetrahydrofurfuryl alcohol, benzyl alcohol, and methylcyclohexanol.

Specific examples of ketone-based organic solvents include acetone, methyl ethyl ketone, methyl isobutyl ketone, diisobutyl ketone, cyclohexanone, 2-heptanone, 4-heptanone, 3,5,5-trimethyl-2-cyclohexene-1-one, and 3, 3,5-trimethylcyclohexanone, and isophorone.

Specific examples of ether-based organic solvents include diethyl ether, cyclopentyl methyl ether, tetrahydrofuran, and 1,4-dioxane.

Specific examples of ester organic solvents include methyl acetate, ethyl acetate, propyl acetate, isopropyl acetate, butyl acetate, isobutyl acetate, tert-butyl acetate, amyl acetate, isoamyl acetate, 3-ethoxypropionic acid ethyl ester, ethyl lactate, ethylene glycol monobutyl ether acetate, diethylene glycol monobutyl ether acetate, propylene glycol monomethyl ether acetate, dipropylene glycol methyl ether acetate, 3-methoxy-3-methyl butyl acetate, 3-methoxybutyl acetate, propylene glycol monomethyl acetate, propylene glycol dimethyl acetate, ethylene glycol monoethyl ether acetate, ethylene glycol monomethyl ether acetate, diethylene glycol monoethyl ether acetate, cyclohexanol acetate, propylene glycol diacetate, Propylene glycol monomethyl ether acetate, propylene glycol monomethyl ether propionate, propylene glycol monoethyl ether acetate, propylene glycol monobutyl ether acetate, propylene glycol monopropyl ether acetate, propylene glycol diacetate, dipropylene glycol methyl ether acetate, 1,3-butylene glycol diacetate, 1,4-butanediol diacetate, 1,3-butylene glycol diacetate, 1,6-hexanediol diacetate, γ-butyrolactone, triacetin, and 2,2,4-trimethyl-1,3-pentanediol monoisobutyrate.

Specific examples of glycol-based organic solvents include ethylene glycol, ethylene glycol monobutyl ether, diethylene glycol monobutyl ether, triethylene glycol monobutyl ether, tetraethylene glycol monobutyl ether, ethylene glycol monohexyl ether, diethylene glycol monohexyl ether, ethylene glycol mono-2-ethylhexyl ether, diethylene glycol mono-2-ethylhexyl ether, propylene glycol monomethyl ether, propylene glycol monoethyl ether, propylene glycol monopropyl ether, ethylene glycol monoisopropyl ether, ethylene glycol monoethyl ether, ethylene glycol mono tert-butyl ether, ethylene glycol monopropyl ether, ethylene glycol monomethyl ether, diethylene glycol monoisopropyl ether, diethylene glycol monomethyl ether, dipropylene glycol monoethyl ether, dipropylene glycol monobutyl ether, dipropylene glycol monopropyl ether, dipropylene glycol monopropyl ether, dipropylene glycol monomethyl ether, tripropylene glycol monobutyl ether, tripropylene glycol monomethyl ether, propylene glycol monophenyl ether, 1,3-butylene glycol, propylene glycol n-propyl ether, propylene glycol n-butyl ether, diethylene glycol monoethyl ether, dipropylene glycol n-propyl ether, dipropylene glycol n-butyl ether, tripropylene glycol methyl ether, tripropylene glycol n-butyl ether, ethylene glycol dimethyl ether, ethylene glycol diethyl ether, ethylene glycol dibutyl ether, diethylene glycol diethyl ether, diethylene glycol dimethyl ether, dipropylene glycol dimethyl ether, diethylene glycol dimethyl ether, dipropylene glycol dimethyl ether, diethylene glycol dibutyl ether, tetraethylene glycol dimethyl ether, dipropylene glycol dimethyl ether pentane, triethylene glycol dimethyl ether, and polyethylene glycol dimethyl ether.

Further, examples of other organic solvents include chlorinated-based organic solvents, nitrogen-containing compounds, sulfur-containing compounds, and siloxane compounds.

Specific examples of chlorinated organic solvents include dichloromethane, chloroform, carbon tetrachloride, dichloroethane, chlorobenzene, o-chlorotoluene, m-chlorotoluene, p-chlorotoluene, m-dichlorobenzene, and 1,2,3-trichloropropane.

Specific examples of nitrogen-containing compounds include nitrobenzene, acetonitrile, benzonitrile, N, N-dimethylformamide, N,N-dimethylacetamide, N-methylpyrrolidone, and 1,3-dimethyl-2-imidazolidinone.

Specific examples of sulfur-containing compounds include carbon disulfide and dimethyl sulfoxide.

Specific examples of siloxane compounds include hexamethyldisiloxane, octamethyltrisiloxane, and decamethyltetrasiloxane.

The coating liquid preferably contains the liquid medium in 75 to 99.999 mass %, more preferably 85 to 99.99 mass %, and still more preferably 90 to 99.9 mass %.

The surface treatment agent disclosed herein may contain components other than the compound 1 and the liquid medium in a range in which the effects of the present disclosure are not impaired. Examples of other components include known additives such as acid catalysts and basic catalysts that promote the hydrolysis and the condensation reaction of the hydrolyzable silyl group.

The content of other components in the surface treatment agent disclosed herein is preferably 10 mass % or less, and more preferably 1 mass % or less.

Examples of other components also include compounds represented by the below-shown Formula (3):

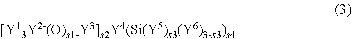

In Formula (3), Y2 is Si, Sn, or Ge,
Y¹ is a hydrocarbon group or a trialkylsilyloxy group,
s1 is 0 or 1,
Y³ is an alkylene chain or a polyalkylene oxide chain, or a combination of an alkylene chain and a divalent polysiloxane residue,
Y⁴ is a single bond or a linking group having a valence of (s2+s4),
Y⁵ is a hydrocarbon group,
Y⁶ is a hydrolyzable group or a hydroxyl group,
s3 are each independently an integer of 0 to 2, and
s2 and s4 are each independently an integer of 1 or greater.

When there are a plurality of Y¹, Y², Y³, Y⁵ and Y⁶, they each independently have the above-described definitions.

As the compound (3), a compound in which Y³ is an alkylene chain or a polyalkylene oxide chain is preferred.

Specific examples of the compound (3) include the below-shown compounds (3-1) to (3-3). In the Formula (3-3), a is preferably 9 to 50, more preferably 11 to 30, and particularly preferably 11 or 25.

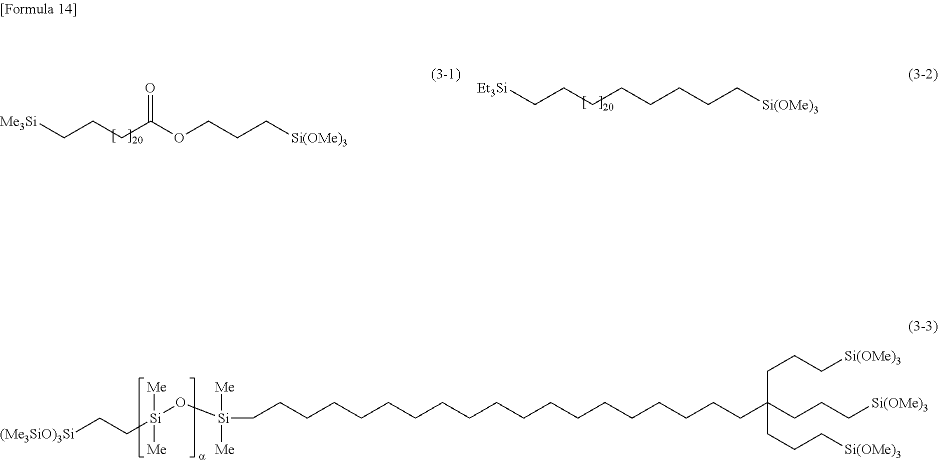

When the other component in the surface treatment agent disclosed herein is the compound (3), the content of the compound (3) is preferably 50 mass % or less, and more preferably 40 mass % or less.

The concentration of the sum total of the compound 1 and other component of the coating liquid (hereinafter also referred to as the “solid content concentration”) is preferably 0.001 to 40 mass %, more preferably 0.01 to 20 mass %, and still more preferably 0.01 to 10 mass %, and particularly preferably 0.01 to 1 mass %.

The solid content concentration of the coating liquid is a value calculated from the mass of the coating liquid before being heated and the mass thereof after being heated in a convection dryer at 120° C. for 4 hours.

### [Article]

An article according to the present invention (hereinafter also referred to as an “article disclosed herein”) has a surface layer formed of the compound 1 or the surface treatment agent disclosed herein on the surface of the substrate.

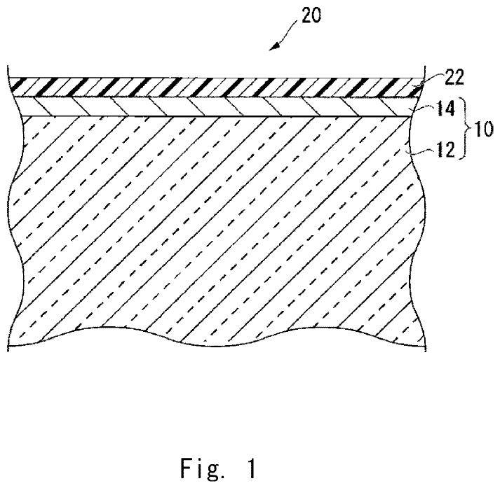

An example of the article disclosed herein will be described with reference to the drawings. FIG. 1 is a schematic cross-sectional diagram showing a first article as an example of the article disclosed herein. The first article is an article 20 including a substrate 12, an underlayer 14, and a surface layer 22 in this order, in which the underlayer 14 contains an oxide containing silicon, and the surface layer 22 contains a condensate of the compound 1.

The material and the shape of the substrate 12 may be selected as appropriate according to the use and the like of the article 20 disclosed herein. Examples of the material of the substrate 12 include glass, resins, sapphire, metals, ceramic, stone, and composite materials thereof. The glass may be chemically reinforced in advance.

In particular, in the case of the substrate 12 which is required to be water/oil repellent, examples include a substrate for a touch panel, a substrate for a display, and a substrate constituting a housing of an electronic apparatus.

The substrate for a touch panel and the substrate for a display have a transparent or translucent property. “Having a transparent or translucent property” means that the vertically-incident visible light transmittance measured in conformity with JIS R3106: 1998 (ISO 9050:1990) is 25% or higher.

Glass or a transparent resin is preferred as the material of the substrate for a touch panel.

The substrate 12 may be one in which a surface treatment such as a corona discharge treatment, a plasma treatment, or a plasma graft polymerization treatment has been performed for its surface on which the underlayer 14 is provided. The surface-treated surface has an excellent adhesive property between the substrate 12 and the underlayer 14, and as a result, the friction resistance property of the surface layer 22 is further improved.

As the surface treatment, a corona discharge treatment or a plasma treatment is preferred because the friction resistance property of the surface layer 22 is further improved.

The underlayer 14 is a layer containing at least an oxide containing silicon, and may contain other elements. As the underlayer 14 contains a silicon oxide, T¹ of the compound 1 is dehydrated and condensed, so that an Si—O—Si bond is formed between the substrate 12 and the underlayer 14, and the surface layer 22 having more excellent friction resistance property is thereby formed.

The content of silicon oxide in the underlayer 14 is preferably 65 mass % or more, more preferably 80 mass % or more, still more preferably 85 mass % or more, and particularly preferably 90 mass % or more. When the content of silicon oxide is equal to or larger than the lower limit value of the above-described range, the Si—O—Si bond is sufficiently formed in the underlayer 14, so that satisfactory mechanical properties of the underlayer 14 can be ensured.

The content of silicon oxide is the balance obtained by subtracting the total content of the other elements (in the case of the oxide, the amount in terms of oxide) from the mass of the underlayer 14.

In view of the durability of the surface layer 22, the oxide in the underlayer 14 preferably further contains one or more elements selected from alkali metal elements, alkaline earth metal elements, platinum group elements, boron, aluminum, phosphorus, titanium, zirconium, iron, nickel, chromium, molybdenum, and tungsten. By containing these elements, the bond between the underlayer 14 and the compound 1 is strengthened, so that the friction resistance property is improved.

When the underlayer 14 contains one or more elements selected from iron, nickel, and chromium, the total content of these elements is preferably 10 to 1,100 mass ppm, more preferably 50 to 1,100 mass ppm, still more preferably 50 to 500 mass ppm, and particularly preferably 50 to 250 mass ppm based on the silicon oxide.

When the underlayer 14 contains one or more elements selected from aluminum and zirconium, the total content of these elements is preferably 10 to 2,500 mass ppm, more preferably 15 to 2,000 mass ppm, and still more preferably 20 to 1,000 mass ppm.

When the underlayer 14 contains alkali metal elements, the total content of these elements is preferably 0.05 to 15% by mass, more preferably 0.1 to 13% by mass, and still more preferably 1.0 to 10% by mass. Note that examples of alkali metal elements include lithium, sodium, potassium, rubidium, and cesium.

When the underlayer 14 contains platinum-group elements, the total content of these elements is preferably 0.02 to 800 mass ppm, more preferably 0.04 to 600 mass ppm, and still more preferably 0.7 to 200 mass ppm. Note that examples of platinum-group elements include platinum, rhodium, ruthenium, palladium, osmium, and iridium.

When the underlayer 14 contains one or more elements selected from boron and phosphorus, the total content of them is preferably 0.003 to 9, more preferably 0.003 to 2, and still more preferably 0.003 to 0.5 as the ratio of the total molar concentration of boron and phosphorus to the molar concentration of silicon in view of the friction resistance property of the surface layer 22.

When the underlayer 14 contains alkaline earth metal elements, the total content of them is preferably 0.005 to 5, more preferably 0.005 to 2, and still more preferably 0.007 to 2 as the ratio of the total molar concentration of alkaline earth metal elements to the molar concentration of silicon in view of the friction resistance property of the surface layer 22. Note that examples of alkaline earth metal elements include beryllium, magnesium, calcium, strontium, barium, and radium.

The underlayer 14 is preferably a silicon oxide layer containing alkali metal atoms in order to improve the adhesive property of the surface treatment agent disclosed herein and to improve the water/oil repellency and the friction resistance property of the article 20. In the silicon oxide layer, the average concentration of alkali metal atoms in a region having a depth of 0.1 to 0.3 nm from the surface thereof in contact with the surface layer 22 is particularly preferably 2.0×10¹⁹ atoms/cm³ or higher. On the other hand, in order to ensure the sufficient mechanical properties of the silicon oxide layer, the average concentration of alkali metal atoms is preferably 4.0×10²² atoms/cm³ or lower.

The thickness of the underlayer 14 is preferably 1 to 200 nm and particularly preferably 2 to 20 nm. When the thickness of the underlayer 14 is equal to or higher than the lower limit value of the above-described range, the satisfactory effect of improving the adhesive property by the underlayer 14 can be easily obtained. When the thickness of the underlayer 14 is equal to or smaller than the upper limit value of the above-described range, the friction resistance property of the underlayer 14 itself increases.

Examples of methods for measuring the thickness of the underlayer 14 include a method for observing the cross section of the underlayer 14 with an electron microscope (such as SEM and TEM), a method using an optical interference thickness meter, a spectroscopic ellipsometer, a step gauge, or the like.

Specific examples of the method for forming the underlayer 14 include a method for vapor-depositing a vapor-deposition material having a desired composition for the underlayer 14 on the surface of the substrate 12.

Examples of the vapor-deposition method includes a vacuum vapor-deposition method.

The vacuum vapor-deposition method is a method in which a vapor-deposition material is evaporated inside a vacuum tank and then is deposited on the surface of the substrate 12.

The temperature during the vapor-deposition (e.g., in the case where a vacuum deposition apparatus is used, the temperature of the boat on which the deposition material is placed) is preferably 100 to 3,000° C., and particularly preferably 500 to 3,000° C.

The pressure during the vapor-deposition (e.g., in the case where a vacuum deposition apparatus is used, the absolute pressure inside the tank in which the vapor-deposition material is placed) is preferably 1 Pa or lower, and particularly preferably 0.1 Pa or lower.

When the underlayer 14 is formed by using the vapor-deposition material, only one vapor-deposition material may be used, or two or more vapor-deposition materials containing different elements may be used.

Examples of methods for evaporating a vapor-deposition material include a resistive heating method in which the vapor-deposition material is melted and evaporated on a resistive heating boat made of metal having a high-melting point, and an electron gun method in which the surface of the vapor-deposition material is melted and evaporated by irradiating the vapor-deposition material with an electron beam and thereby directly heating it. The electron gun method is preferred as the method for evaporating a vapor-deposition material because it can locally heat the material and thereby to evaporate even a substance having a high melting point, and because the temperature of places which are not irradiated with the electron beam is low, so there is no risk of reaction with the container and no risk of contamination with impurities. The vapor-deposition material used for the electron gun method is preferably a molten granular material or a sintered material because they are less likely to be scattered even when an air current occurs.

The surface layer 22 on the underlayer 14 contains a condensate of the compound 1. The condensate of the compound 1 include one in which a hydrolyzable silyl group or the like in the compound 1 is hydrolyzed and a silanol group (Si—OH) is thereby formed, and then, the silanol group are condensation-reacted between molecules and a Si—O—Si bond is thereby formed, and one in which the silanol group in the compound 1 is condensation-reacted with a silanol group or a Si-OM group (where M is an alkali metal element) present on the surface of the underlayer 14, and an Si—O—Si bond is thereby formed. Further, the surface layer 22 may also contain a condensate of a compound other than the compound 1 contained in the surface treatment agent disclosed herein. The surface layer 22 may contain a compound containing a reactive silyl group in a state in which some of or all the reactive silyl groups of the compound are condensation-reacted.

The thickness of the surface layer 22 is preferably 1 to 100 nm, and particularly preferably 1 to 50 nm. When the thickness of the surface layer 22 is equal to or larger than the lower limit value in the above-described range, the effects by the surface layer 22 can be sufficiently obtained. When the thickness of the surface layer 22 is equal to or smaller than the upper limit value in the above-described range, the use efficiency becomes high.

The thickness of the surface layer 22 is one that is obtained by an X-ray diffractometer for a thin film analysis. The thickness of the surface layer 22 can be obtained by obtaining an interference pattern of a reflected X-ray by an X-ray reflectance method by using an X-ray diffractometer for a thin film analysis, and then calculating the thickness from the oscillation period of the obtained interference pattern.

Other examples of the article according to the present invention include a second article.

The second article is an article 20 including a substrate 10 with an underlayer and a surface layer 22 in this order, in which the substrate 10 with the underlayer contains an oxide containing silicon, and the surface layer 22 contains a condensate of the compound 1.

In the second article, since the substrate 10 with the underlayer has the composition of the underlayer 14 of the first article, the friction resistance property of the surface layer 22 is excellent even when the surface layer 22 is directly formed on the substrate 10 with the underlayer. The material of the substrate 10 with the underlayer of the second article may be any material having the composition of the underlayer 14, and is, for example, a substrate or the like made of glass. Details of the material of the substrate 10 with the underlayer are similar to those of the substrate 12 and the underlayer 14, and therefore the descriptions thereof will be omitted. Further, since the structure of the surface layer 22 is similar to that of the first article, the description thereof will be omitted here.

Specific examples of the article according to the present invention include optical members, touch panels, antireflective films, antireflective glass, SiO₂-treated glass, tempered glass, sapphire glass, quartz substrates, and mold metals, which are used as parts of components of the below-shown products.

Products: car navigation, cellular phones, digital cameras, digital video cameras, personal digital assistants (PDA), portable audio players, car audio, game apparatuses, eyeglass lenses, camera lenses, lens filters, sunglasses, medical apparatuses (such as stomach cameras), copiers, personal computers (PCs), liquid crystal displays, organic EL displays, plasma displays, touch panel displays, protective films, antireflective films, antireflective glass, nanoimprint templates, molds, and the like.

### [Method for Manufacturing Article]

A method for manufacturing an article according to the present invention is a method for forming a surface layer by a dry coating method or a wet coating method by using the compound 1 or the surface treatment agent disclosed herein.

The compound 1 and the surface treatment agent disclosed herein can be used as they are in a dry coating method, and are suitable for forming a surface layer having an excellent adhesive property by the dry coating method. Examples of dry coating methods include vacuum vapor-deposition, CVD, and sputtering. The vacuum vapor-deposition method can be suitably used because the decomposition of the surface treatment agent disclosed herein can be suppressed and because the apparatus is simple.

For the vacuum vapor-deposition, a pellet-like material in which the compound 1 or the like is supported in a metallic porous body made of a metal material such as iron or steel may be used. The pellet-like material in which the compound 1 or the like is supported can be manufactured by impregnating a metallic porous body with a solution containing the compound 1, and drying the porous body and thereby remove the liquid medium therefrom.

The surface treatment agent disclosed herein (coating liquid) containing a liquid medium can be suitably used for a wet coating method. Examples of wet coating methods include a spin coating method, a wipe coating method, a spray coating method, a squeegee coating method, a dip coating method, a die coating method, an inkjet method, a flow coating method, a roll coating method, a casting method, a Langmuir Blodgett method, and a gravure coating method.

In order to improve the friction resistance property of the surface layer, an operation for promoting the reaction between the compound 1 and the substrate may be performed as required. Examples of such operations include heating, humidification, and light irradiation. For example, it is possible to, by heating a substrate including a surface layer formed there on in an atmosphere containing moisture, promote a hydrolysis reaction of a hydrolyzable group, a reaction between a hydroxyl group or the like present on the surface of the substrate with a silanol group, and a reaction such as formation of a siloxane bond by a condensation-reaction of a silanol group.

After the surface treatment, compounds in the surface layer that are not chemically bonded to other compounds or the substrate may be removed as required. Examples of specific methods include a method in which a solvent is poured over a surface layer, and a method in which a surface layer or the like is wiped with a cloth impregnated with a solvent.

### EXAMPLES

The present invention will be described hereinafter in detail by using examples. Examples 1 to 15 are examples according to the present disclosure, and Example 16 is a comparative example. Note that the present invention is not limited to these examples.

### Example 1

### Synthesis of Compound X1

A compound X¹ was obtained according to a method disclosed in International Patent Publication No. WO2021/054413.

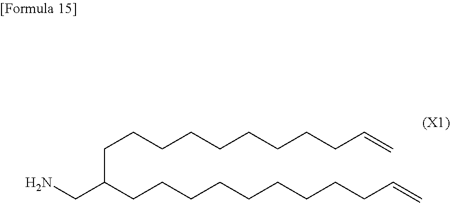 [SMILES: C=CCCCCCCCCCC(CN)CCCCCCCCCC=C]

### Synthesis of Compound X²

A THF (tetrahydrofuran) solution of 1,3,5-tris(3,3,3-trifluoropropyl)-1, 3, 5-trimethylcyclotrisiloxane (0.44M, 20 mL) was added in a 300 mL eggplant-shaped flask in a glove box, and cooled to 0° C. Next, a hexane solution of n-butyllithium (1.6M, 5.0 mL) was dropped (i.e., added), and the mixture was stirred for 1 hour. After that, a THF solution of 1,3,5-tris(3, 3, 3-trifluoropropyl)-1, 3, 5-trimethylcyclotrisiloxane (0.44M, 100 mL) was dropped, and the mixture was stirred for 2 hours. Further, chlorodimethylsilane (1.7 mL) was added, and the mixture was stirred for 2 hours. The solvent and low-boiling components were removed by evaporation, and washed with methanol (100 mL). Next, the solvent and the low-boiling components were removed by evaporation, and 14 g of a mixture of a compound X2 and a compound X2′ was thereby obtained.

From the ¹H-NMR measurement, it was confirmed that the repeating unit n was 19 (n=19).

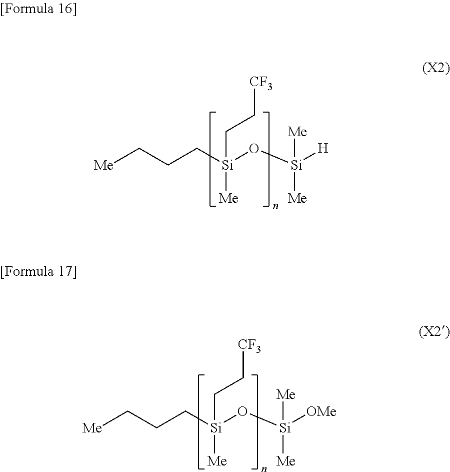

### (NMR Spectrum of Mixture of Compounds X2 and X2′)

¹H-NMR (400 MHZ, CDCl₃) δ: 4.72 (p, J=2.8 Hz, 1H), 3.49 (d, J=5.0 Hz, 1H), 2.04 (ddt, J=14.9, 10.0, 5.2 Hz, 38H), 1.41-1.23 (m, 4H), 0.89 (t, J=6.9 Hz, 3H), 0.83-0.70 (m, 37H), 0.65-0.52 (m, 2H), 0.23-0.10 (m, 57H).

¹⁹F-NMR (376 MHz, CDCl₃) δ: −68.35-−68.66 (m), −68.77.

### Synthesis of Compound X3

Toluene (5.0 g) and methyl undece-10-enoate (0.90 g) were added to a mixture of a compound X² and a compound X2′ (5.0 g). After the mixture was stirred, a toluene solution of a platinum/1,3-divinyl-1, 1,3,3-tetramethyldisiloxane complex (platinum content: 3 mass %, 31 mg) was added to the mixture, and the mixture was stirred at 25° C. for 15 minutes. After that, 1.8 g of a mixture of a compound X3, a compound X3′, and a compound X2′ was obtained by washing the mixture with methanol (20 mL) and thereby removing the solvent and low-boiling components therefrom by distillation.

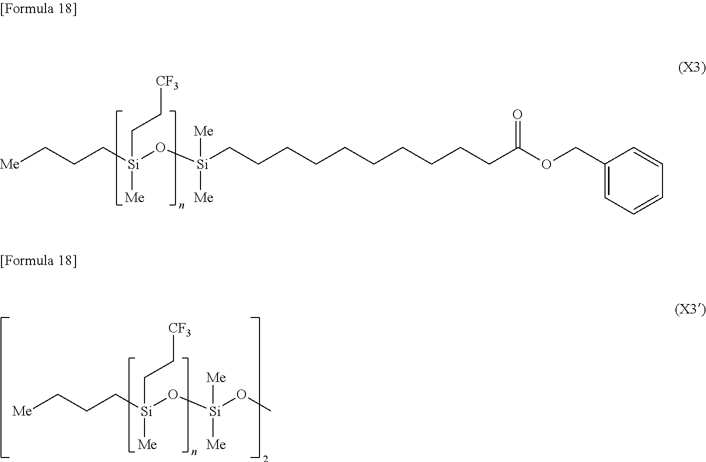

### (NMR Spectrum of Mixture of Compounds X3, X3′, and X2′)

¹H-NMR (400 MHZ, CDCl₃) δ: 7.35 (s, 3H), 5.11 (s, 2H), 3.47 (s, 1H), 2.40-2.30 (m, 3H), 2.03 (dq, J=15.0, 10.1 Hz, 133H), 1.64 (s, 2H), 1.37-1.24 (m, 29H), 0.89 (t, J=7.0 Hz, 10H), 0.82-0.66 (m, 118H), 0.65-0.48 (m, 9H), 0.19-0.06 (m, 173H).

¹⁹F-NMR (376 MHz, CDCl₃) δ: −68.87.

### Synthesis of Compound X4

THF (2.0 mL) and palladium-activated carbon (Pd: 5 mass %, 0.20 g) were added to a mixture (2.2 g) of a compound X3, a compound X3′, and a compound X2′, and the mixture was stirred at 25° C. for 2 hours under a hydrogen atmosphere. After that, celite filtration was performed, and the solvent and low-boiling components were removed by evaporation, and by doing so, 2.2 g of a mixture of a compound X4, a compound X3′, and a compound X2′ was obtained.

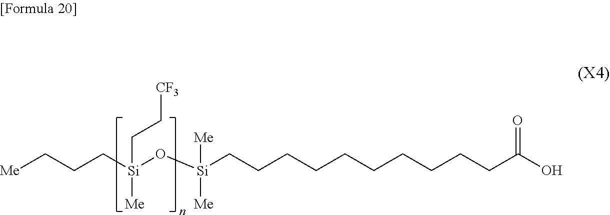

### (NMR Spectrum of Mixture of Compounds X4, X3′, and X2′)

¹H-NMR (400 MHZ, CDCl₃) δ: 3.48 (s, 1H), 2.35 (t, J=7.5 Hz, 2H), 2.12-1.94 (m, 128H), 1.39-1.22 (m, 42H), 0.89 (t, J=7.0 Hz, 8H), 0.83-0.70 (m, 98H), 0.65-0.55 (m, 5H), 0.28-0.06 (m, 157H).

¹⁹F-NMR (376 MHz, CDCl₃) δ: −68.77.

### Synthesis of Compound X5

THF (2.0 mL), a compound X¹ (0.20 g), triethylamine (0.10 g), and propylphosphonic anhydride (cyclic trimmer) (50% ethyl acetate solution, about 1.7 M, 0.37 g) were added to a mixture of a compound X4, a compound X3′, and a compound X2′ (2.2 g), and the mixture was stirred at 25° C. for 15 hours. After that, celite filtration was performed, and the solvent and low-boiling components were removed by evaporation, and by doing so, 2.2 g of a mixture of a compound X5, a compound X3′, and a compound X2′ was obtained. 0.56 g of a compound X5 was obtained by performing flash column chromatography using silica gel (developing solvent: ethyl acetate/hexane).

From the ¹H-NMR measurement, it was confirmed that the repeating unit n in Formula (X5) was 31 (n=31).

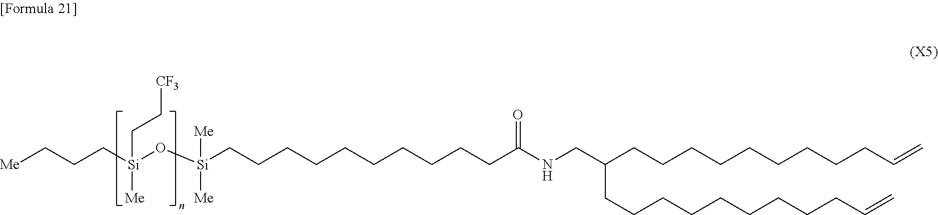

### (NMR Spectrum of Compound X5)

¹H-NMR (400 MHZ, CDCl₃) δ: 5.81 (ddt, J=16.9, 10.1, 6.6 Hz, 2H), 5.31 (s, 1H), 5.05-4.83 (m, 4H), 3.18 (t, J=6.0 Hz, 2H), 2.16 (t, J=7.6 Hz, 2H), 2.03 (qt, J=10.2, 4.9 Hz, 66H), 1.61 (t, J=7.4 Hz, 2H), 1.50-1.18 (m, 51H), 0.88 (t, J=6.9 Hz, 3H), 0.83-0.70 (m, 62H), 0.63-0.51 (m, 4H), 0.12 (d, J=30.5 Hz, 99H).

¹⁹F-NMR (376 MHz, CDCl₃) δ: −68.76.

### Synthesis of Compound 1-2A

0.54 g of a compound 1-2 A was obtained by adding a compound X5 (0.53 g), a toluene solution of a platinum/1,3-divinyl-1, 1, 3, 3-tetramethyldisiloxane complex (platinum content: 3 mass %, 1.4 mg), trimethoxysilane (0.12 g), stirring the mixture at 25° C. for 15 minutes, and then evaporating and removing the solvent under a reduced pressure.

From the ¹H-NMR measurements, it was confirmed that the repeating unit n in Formula (1-2A) was 21 (n=21).

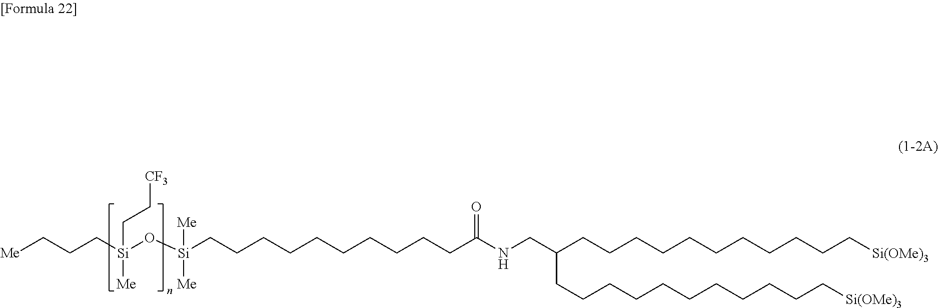

### NMR Spectrum of Compound 1-2A

¹H-NMR (400 MHZ, CDCl₃) δ: 5.31 (s, 1H), 3.57 (s, 18H), 3.18 (t, J=6.0 Hz, 2H), 2.15 (t, J=7.6 Hz, 2H), 2.02 (dq, J=20.1, 10.0 Hz, 42H), 1.62 (t, J=11.2 Hz, 2H), 1.27 (m, 59H), 0.89 (t, J=6.9 Hz, 3H), 0.83-0.47 (m, 50H), 0.40-0.18 (m, 69H).

¹⁹F-NMR (376 MHz, CDCl₃) δ: −68.87.

### Example 2

### Synthesis of Compound X6

10-undecenoyl chloride (5.0 g), pentafluorophenol (6.8 g), triethylamine (5.0 g), and THF (50 mL) were added, and the mixture was stirred at 25° C. for 2 hours. 5.2 g of a compound X6 was obtained by evaporating and removing the solvent and performing flash column chromatography using silica gel (developing solvent: dichloromethane).

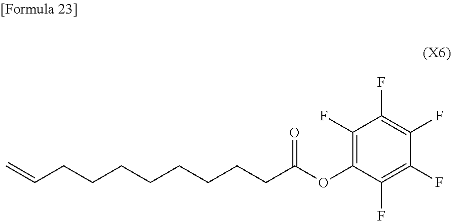 [SMILES: C=CCCCCCCCCC(=O)Oc1c(F)c(F)c(F)c(F)c1F]

### NMR Spectrum of Compound X6

¹H-NMR (400 MHZ, CDCl₃) δ (ppm): 5.81 (ddt, J=16.9, 10.2, 6.7 Hz, 1H), 5.11-4.84 (m, 2H), 2.66 (t, J=7.4 Hz, 2H), 2.12-1.95 (m, 2H), 1.50-1.14 (m, 12H).

### Synthesis of Compound X7

Dichloromethane (20 g) and 2,4,6,8 tetramethylcyclotetrasiloxane (1.9 g) were added to a compound X6 (0.40 g). After stirring the mixture, a toluene solution of a platinum/1,3-divinyl-1, 1,3,3-tetramethyldisiloxane complex (platinum content: 3 mass %, 8.3 mg) was added, and the mixture was stirred at 25° C. for 2 hours. After removing the solvent and low-boiling components by evaporation, allylpentafluorobenzene (1.2 g), a toluene solution of a platinum/1,3-divinyl-1, 1,3,3-tetramethyldisiloxane complex (platinum content: 3 mass %, 9.2 mg), and dichloromethane (20 g) were added, and the mixture was stirred at 25° C. for 2 hours. After removing the solvent and low-boiling components by evaporation, a compound X1 (2.3 g) and dichloromethane (20 g) were added, and the mixture was stirred at 25° C. for 4 hours. 0.75 g of a compound X7 was obtained by removing the solvent by evaporation, and then performing flash column chromatography using silica gel (developing solvent: dichloromethane/ethyl acetate).

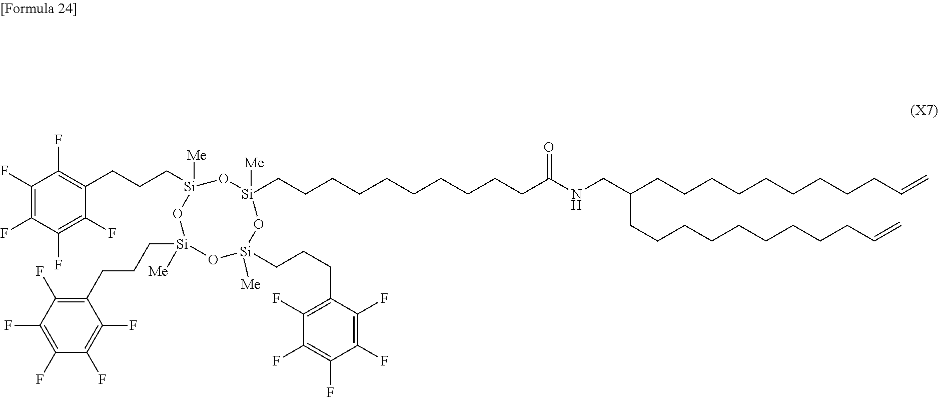 [SMILES: C=CCCCCCCCCCC(CCCCCCCCCC=C)CNC(=O)CCCCCCCCCC[Si]1(C)O[Si](C)(CCCc2c(F)c(F)c(F)c(F)c2F)O[Si](C)(CCCc2c(F)c(F)c(F)c(F)c2F)O[Si](C)(CCCc2c(F)c(F)c(F)c(F)c2F)O1]

### NMR Spectrum of Compound X7

¹H-NMR (400 MHZ, CDCl₃) δ (ppm): 5.76 (ddt, J=17.0, 10.2, 6.7 Hz, 2H), 5.29 (t, J=4.7 Hz, 1H), 5.12-4.78 (m, 4H), 3.13 (t, J=5.9 Hz, 2H), 2.75-2.46 (m, 6H), 2.11 (t, J=7.6 Hz, 2H), 2.04-1.91 (m, 4H), 1.67-1.47 (m, 11H), 1.39-1.07 (m, 44H), 0.58-0.27 (m, 8H), 0.11-0.11 (m, 12H).

### Synthesis of the compound 1-3A

0.55 g of the compound 1-3A was obtained by adding dichloromethane (10 g), a compound X7 (0.50 g), a toluene solution of a platinum/1,3-divinyl-1, 1,3,3-tetramethyldisiloxane complex (platinum content: 3 mass %, 8.3 mg), aniline (2.6 mg), and trimethoxysilane (0.50 g), stirring the mixture at 40° C. for 2 hours, and then evaporating and removing the solvent under a reduced pressure.

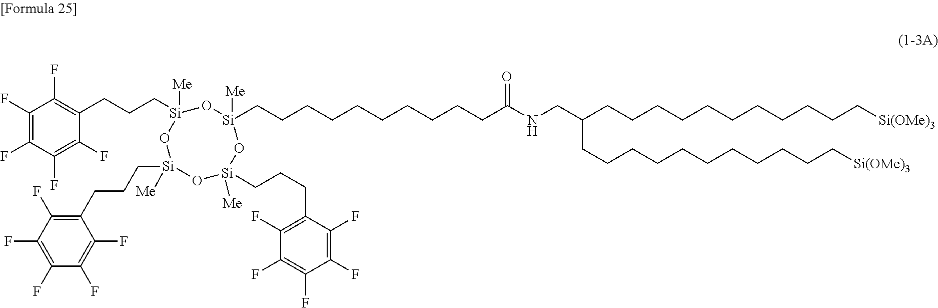

### NMR Spectrum of Compound 1-3A

¹H-NMR (400 MHZ, CDCl₃) δ (ppm): 5.29 (t, J=4.7 Hz, 1H), 3.51 (s, 18H), 3.12 (t, J=6.0 Hz, 2H), 2.73-2.52 (m, 6H), 2.10 (t, J=7.6 Hz, 2H), 1.66-1.46 (m, 11H), 1.19 (s, 52H), 0.68-0.31 (m, 12H), 0.11-0.11 (m, 12H).

### Example 3

### Synthesis of Compound X8

4-hydroxyphenyl sulfur pentafluoride (1.0 g) was dissolved in dimethyl sulfoxide (5.0 g), and potassium carbonate (1.9 g) and 4-bromo-1-butene (1.8 g) were added. After stirring the mixture at 80° C. for 16 hours, water was added, and extraction was performed by using hexane. 0.83 g of a compound X8 was obtained by removing the solvent by evaporation, and then performing flash column chromatography using silica gel (developing solvent: ethyl acetate/hexane).

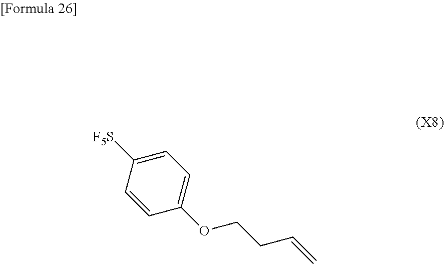

### NMR Spectrum of Compound X8

¹H-NMR (400 MHZ, CDCl₃) δ (ppm): 7.72-7.50 (m, 2H), 6.96-6.69 (m, 2H), 5.82 (ddt, J=17.0, 10.3, 6.7 Hz, 1H), 5.20-4.94 (m, 2H), 3.98 (t, J=6.7 Hz, 2H), 2.49 (qt, J=6.7, 1.4 Hz, 2H).

### <Synthesis of Compound X9

Dichloromethane (20 g) and 2,4,6,8 tetramethylcyclotetrasiloxane (1.9 g) were added to a compound X6 (0.25 g). After stirring the mixture, a toluene solution of a platinum/1,3-divinyl-1, 1,3,3-tetramethyldisiloxane complex (platinum content: 3 mass %, 8.3 mg) was added, and the mixture was stirred at 25° C. for 2 hours. After removing the solvent and low-boiling components by evaporation, a compound X8 (0.80 g), a toluene solution of a platinum/1,3-divinyl-1, 1, 3,3-tetramethyldisiloxane complex (platinum content: 3 mass %, 9.2 mg), and dichloromethane (20 g) were added, and the mixture was stirred at 25° C. for 2 hours. After removing the solvent and low-boiling components by evaporation, a compound X1 (2.3 g) and dichloromethane (20 g) were added, and the mixture was stirred at 25° C. for 4 hours. 0.45 g of a compound X9 was obtained by removing the solvent by evaporation, and then performing flash column chromatography using silica gel (developing solvent: dichloromethane/ethyl acetate).

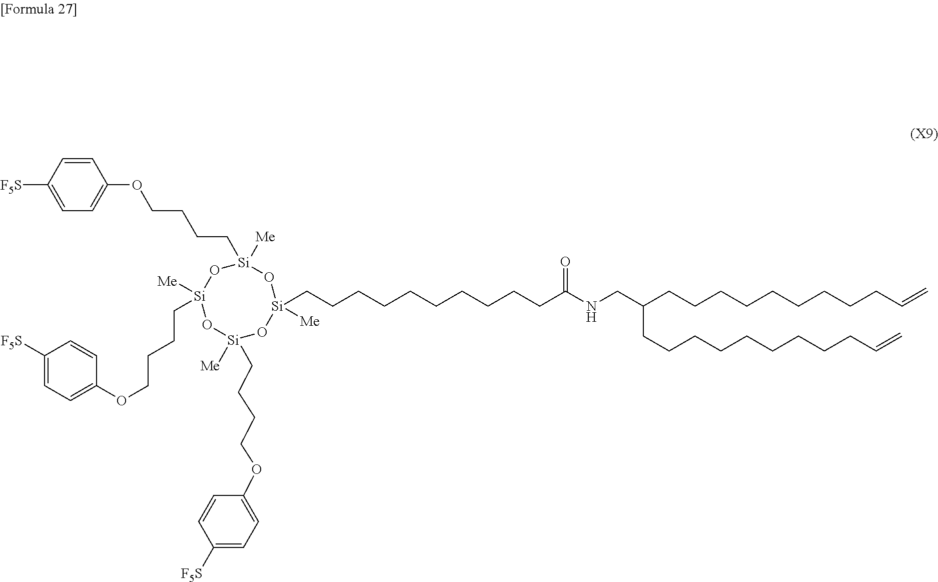

### NMR Spectrum of Compound X9

¹H-NMR (400 MHZ, CDCl₃) δ (ppm): 7.64-7.46 (m, 6H), 6.77 (qd, J=6.5, 5.7, 2.0 Hz, 6H), 5.72 (ddt, J=16.9, 10.3, 6.7 Hz, 2H), 5.29 (t, J=4.7 Hz, 1H), 5.03-4.68 (m, 4H), 4.04-3.72 (m, 6H), 3.09 (t, J=6.0 Hz, 2H), 2.05 (td, J=7.9, 3.0 Hz, 2H), 2.02-1.87 (m, 4H), 1.83-1.58 (m, 5H), 1.58-0.94 (m, 56H), 0.46 (dt, J=28.2, 8.2 Hz, 8H), 0.11-−0.11 (m, 12H).

### Synthesis of the Compound 1-3B

0.45 g of a compound 1-3B was obtained by adding dichloromethane (10 g), a compound X9 (0.40 g), a toluene solution of a platinum/1,3-divinyl-1, 1,3, 3-tetramethyldisiloxane complex (platinum content: 3 mass %, 8.3 mg), aniline (2.6 mg), and trimethoxysilane (0.50 g), stirring the mixture at 40° C. for 2 hours, and then evaporating and removing the solvent under a reduced pressure.

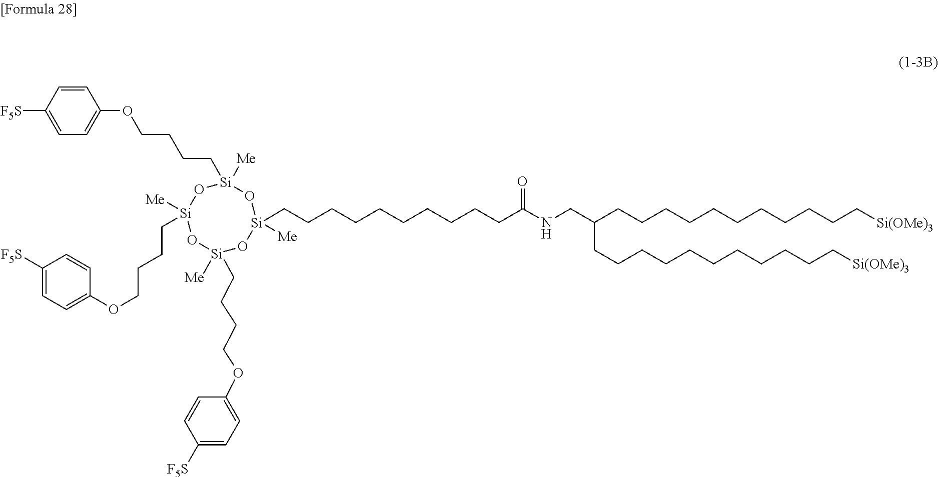

### NMR Spectrum of Compound 1-3B

¹H-NMR (400 MHZ, CDCl₃) δ (ppm): 7.64-7.37 (m, 6H), 6.77 (qd, J=6.3, 5.9, 2.1 Hz, 6H), 5.29 (t, J=4.7 Hz, 1H), 3.88 (dq, J=8.2, 6.5 Hz, 6H), 3.48 (s, 18H), 3.09 (t, J=6.0 Hz, 2H), 2.13-1.91 (m, 2H), 1.75-0.87 (m, 69H), 0.67-0.31 (m, 12H), 0.11-0.11 (m, 12H).

### Example 4

### Synthesis of Compound X10

Magnesium (2.9 g), THF (3.0 mL), and iodine (1 fragment) were added in a 300 mL three-necked flask equipped with a stirrer and a Dimroth condenser under a dried nitrogen atmosphere, and the mixture was continuously stirred until THE became clear and colorless. Next, 11-bromo-1-undecene (15 g) was dissolved and slowly added in THF (100 mL), and the solution was continuously refluxed for 1 hour. The temperature was restored to a room temperature (23° C.), and a Grignard reagent was thereby prepared.

Next, 1-iodine-4,4,4-trifluorobutane (16 g), copper bromide (I) (0.51 g), and THF (100 mL) were added in a 300 mL three-necked flask equipped with a stirrer and a Dimroth condenser under a dried nitrogen atmosphere, and the mixture was cooled to −15° C. The prepared Grignard reagent was slowly dropped into the mixture while stirring the mixture. After the dropping, the temperature was restored to a room temperature and the mixture was continuously stirred for 24 hours.

After that, a 2N hydrochloric acid aqueous solution (200 mL) was added and the liquid was thereby separated. The water layer was extracted by 200 mL of ethyl acetate. Further, the organic layer was collected, and anhydrous sodium sulfate was added.

The organic layer was filtered and then concentrated by an evaporator, and a crude solution was thereby obtained. 17 g of a compound X10 was obtained by purifying the obtained crude solution by silica gel column chromatography.

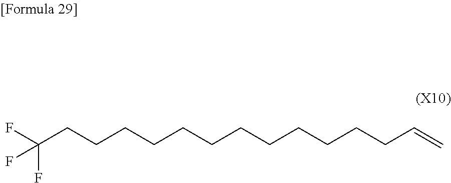 [SMILES: C=CCCCCCCCCCCCCC(F)(F)F]

### NMR Spectrum of Compound X10

¹H-NMR (400 MHZ, CDCl₃) δ: 5.84 (ddt, J=16.9, 10.2, 6.7 Hz, 1H), 5.15-4.84 (m, 2H), 2.20-1.95 (m, 4H), 1.50-1.19 (m, 20H).

### Synthesis of Compound X11

A compound X10 (0.52 g) and a toluene solution of 1,3,3-tetramethyldisiloxane complex (platinum content: 3 mass %, 2.65 mg) were added in a 10 mL eggplant-shaped flask equipped with a stirrer under a dried nitrogen atmosphere, and the stirring of the mixture was started. Next, chlorodimethylsilane (0.44 mL) was added, and the stirring was continued at a room temperature for 24 hours, and by doing so, a reaction crude solution was obtained.

THF (1.0 mL), triethylamine (1.0 mL), and water (70 μL) were added in a 10 mL eggplant-shaped flask equipped with a stirrer. After the stirring of the mixture was started in an ice bath, the reaction crude solution was slowly dropped, and the stirring was continued for 1 hour. Further, anhydrous sodium sulfate was added to the reaction crude solution and filtration was performed, and then the filtrate was concentrated.

0.55 g of a compound X11 was obtained by purifying the obtained crude solution was purified by column chromatography.

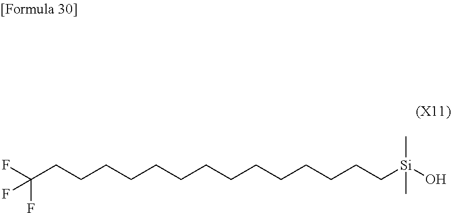 [SMILES: C[Si](C)(O)CCCCCCCCCCCCCCC(F)(F)F]

### NMR Spectrum of Compound X11

¹H-NMR (400 MHZ, CDCl₃) δ: 2.06-1.82 (m, 2H), 1.55-1.07 (m, 24H), 0.47 (dd, J=9.4, 6.0 Hz, 2H), 0.15-0.16 (m, 6H).

### <Synthesis of Compound X12

A compound X11 (0.27 g) and THF (0.80 mL) were added in a 10 mL eggplant-shaped flask equipped with a stirrer under a dried nitrogen atmosphere, and the stirring of the mixture was started in an ice bath. Next, a 1.6 mol/L normal butyllithium hexane solution (0.50 mL) was slowly added. Next, a THF solution of hexamethylcyclotrisiloxane (1.1M, 5.0 mL) was slowly added and the stirring of the mixture was continued for 24 hours. Then, chlorodimethylsilane (0.18 mL) was added and the stirring was continued for 2 hours.

After the stirring, a concentrate of the mixture was obtained by concentrating the mixture by an evaporator. After adding hexane (5.0 mL) to the obtained concentrate, it was washed with water (5.0 mL).

Then, a crude solution was obtained by adding anhydrous sodium sulfate to the organic layer, and then filtering the mixture and concentrating the filtrate by an evaporator. 1.1 g of a compound X12 was obtained by washing the obtained crude solution with methanol. From the ¹H-NMR measurement, it was confirmed that the repeating unit n in Formula (X12) was 28 (n=28).

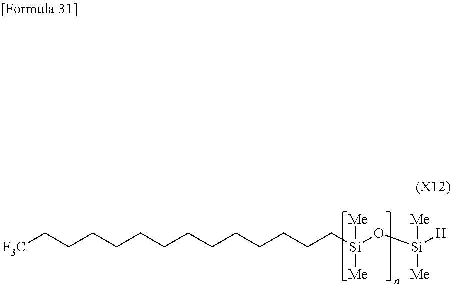

### NMR Spectrum of Compound X12

¹H-NMR (400 MHZ, CDCl₃) δ: 4.63 (p, J=2.8 Hz, 1H), 2.09-1.85 (m, 2H), 1.20 (d, J=12.5 Hz, 22H), 0.45 (t, J=7.7 Hz, 2H), 0.11 (d, J=2.8 Hz, 174H).

### Synthesis of Compound X13

A compound X12 (1.0 g), dichloromethane (1.4 g), a compound X6 (0.19 g), and a toluene solution of 1,3,3-tetramethyldisiloxane complex (platinum content: 3 mass %, 5.4 mg) were added in a 30 mL eggplant-shaped flask equipped with a stirrer under a dried nitrogen atmosphere, and the mixture was stirred at a room temperature for 3 hours.

After the stirring, the mixture was concentrated by an evaporator. Subsequently, a compound X1 (0.52 g) and THF (1.0 mL) were added, and the mixture was stirred at a room temperature for 4 hours. A crude solution was obtained by further concentrating the mixture by an evaporator. 0.22 g of a compound X13 was obtained by purifying the obtained crude solution by silica gel column chromatography.

From the ¹H-NMR measurement, it was confirmed that the repeating unit n in Formula (X13) was 21 (n=21).

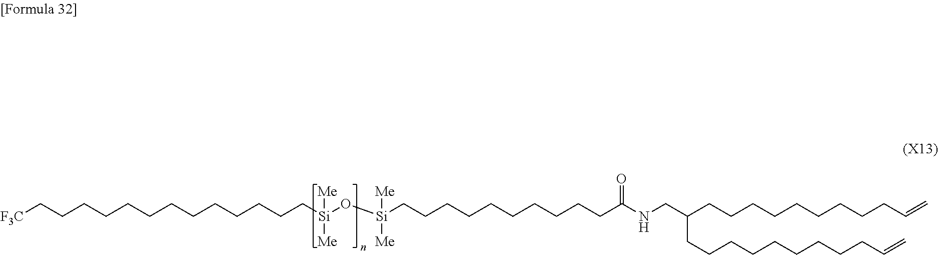

### NMR Spectrum of Compound X13

¹H-NMR (400 MHZ, CDCl₃) δ: 5.81 (ddt, J=16.9, 10.1, 6.6 Hz, 2H), 5.36 (s, 1H), 5.07-4.82 (m, 4H), 3.18 (t, J=5.9 Hz, 2H), 2.17 (t, J=7.6 Hz, 2H), 2.12-1.97 (m, 6H), 1.75-1.05 (m, 71H), 0.52 (t, J=7.4 Hz, 4H), 0.20-0.14 (m, 131H).

### Synthesis of the compound 1-1A

A compound X13 (0.20 g), a toluene solution of a platinum/1,3-divinyl-1, 1,3,3-tetramethyldisiloxane complex (platinum content: 3 mass %, 0.0010 mg), trimethoxysilane (0.024 g), aniline (0.78 mg), and dichloromethane (0.27 g) were added, and the mixture was stirred at a room temperature under a dried nitrogen atmosphere for 2 hours. After that, 0.21 g of a compound 1-1A was obtained by evaporating and removing the solvent under a reduced pressure. From the ¹H-NMR measurement, it was confirmed that the repeating unit n in Formula (X13) was 22 (n=22).

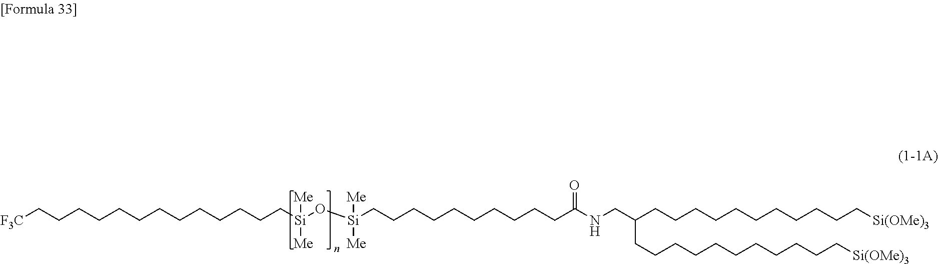

### NMR Spectrum of Compound 1-1A

¹H-NMR (400 MHZ, CDCl₃) δ: 5.36 (d, J=6.0 Hz, 1H), 3.56 (d, J=1.1 Hz, 18H), 3.18 (t, J=5.9 Hz, 2H), 2.16 (t, J=7.6 Hz, 2H), 2.13-1.96 (m, 2H), 1.70-1.03 (m, 77H), 0.72-0.55 (m, 4H), 0.52 (t, J=7.4 Hz, 4H), 0.20-0.17 (m, 138H).

### Example 5

### Synthesis of Compound X14

Dichloromethane (20 g) and 2,4,6,8 tetramethylcyclotetrasiloxane (1.9 g) were added to a compound X6 (0.40 g). After the stirring the mixture, a toluene solution of a platinum/1,3-divinyl-1, 1,3,3-tetramethyldisiloxane complex (platinum content: 3 mass %, 8.3 mg) was added, and the mixture was stirred at 25° C. for 2 hours. After removing the solvent and low-boiling components by evaporation, a dichloromethane solution of 3, 3, 3-trifluoropropene (1M, 79 mL) and a toluene solution of a platinum/1,3-divinyl-1, 1,3,3-tetramethyldisiloxane complex (platinum content: 3 mass %, 9.2 mg) were added, and the mixture was stirred at 25° C. for 2 hours.

After removing the solvent and low-boiling components by evaporation, a compound X1 (2.3 g) and dichloromethane (20 g) were added, and the mixture was stirred at 25° C. for 4 hours. After removing the solvent by evaporation, 0.75 g of a compound X14 was obtained by performing flash column chromatography using silica gel (developing solvent: dichloromethane/ethyl acetate).

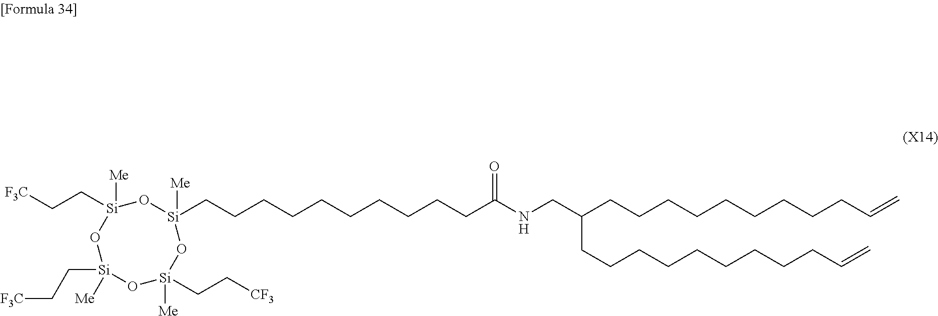 [SMILES: C=CCCCCCCCCCC(CCCCCCCCCC=C)CNC(=O)CCCCCCCCCC[Si]1(C)O[Si](C)(CCC(F)(F)F)O[Si](C)(CCC(F)(F)F)O[Si](C)(CCC(F)(F)F)O1]

### NMR Spectrum of Compound X14

¹H-NMR (400 MHZ, CDCl₃) δ (ppm): 5.76 (ddt, J=17.0, 10.2, 6.7 Hz, 2H), 5.29 (t, J=4.7 Hz, 1H), 5.12-4.78 (m, 4H), 3.13 (t, J=5.9 Hz, 2H), 2.12-1.91 (m, 8H), 1.67-1.47 (m, 5H), 1.39-1.07 (m, 48H), 0.80 (m, 6H), 0.40 (m, 2H), 0.11-0.11 (m, 12H).

### Synthesis of the compound 1-3C

0.55 g of a compound 1-3C was obtained by adding dichloromethane (10 g), a compound X14 (0.50 g), a toluene solution of a platinum/1,3-divinyl-1, 1, 3, 3-tetramethyldisiloxane complex (platinum content: 3 mass %, 8.3 mg), aniline (2.6 mg), and trimethoxysilane (0.50 g), stirring the mixture at 40° C. for 2 hours, and then evaporating and removing the solvent under a reduced pressure.

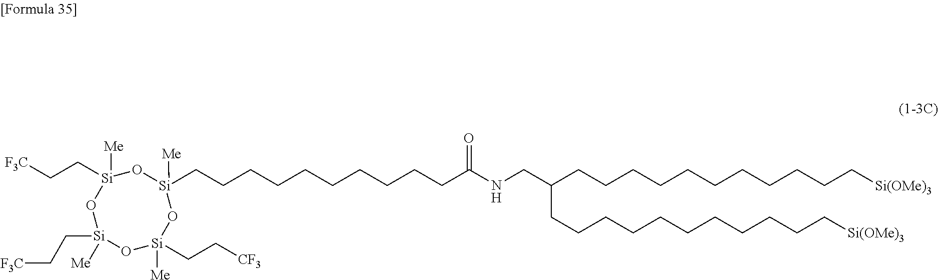

### NMR Spectrum of Compound 1-3C

¹H-NMR (400 MHZ, CDCl₃) δ (ppm): 5.29 (t, J=4.7 Hz, 1H), 3.51 (s, 18H), 3.12 (t, J=6.0 Hz, 2H), 2.12-1.91 (m, 8H), 1.66-1.46 (m, 5H), 1.19 (s, 52H), 0.80 (m, 6H), 0.68-0.31 (m, 6H), 0.11-0.11 (m, 12H).

### Example 6

### Synthesis of Compound X15

0.93 g of a compound X15 was obtained in a manner similar to that for the synthesis of the compound X14, except that 3-(trifluoromethoxy) propa-1-ene (1.4 g) was used instead of the dichloromethane solution of 3,3,3-trifluoropropene.

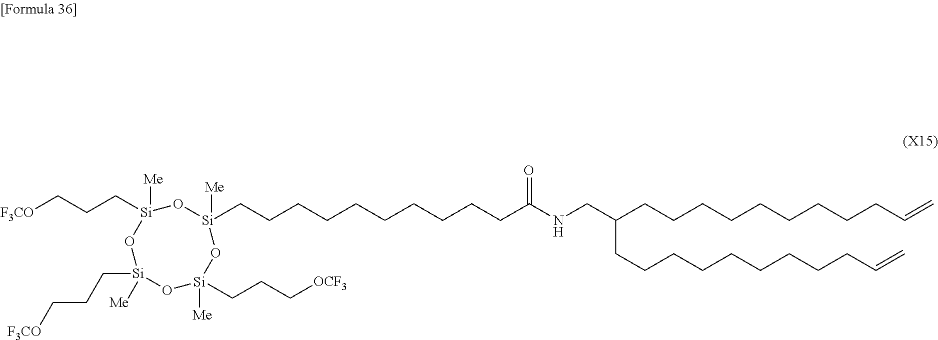 [SMILES: C=CCCCCCCCCCC(CCCCCCCCCC=C)CNC(=O)CCCCCCCCCC[Si]1(C)O[Si](C)(CCCOC(F)(F)F)O[Si](C)(CCCOC(F)(F)F)O[Si](C)(CCCOC(F)(F)F)O1]

### NMR Spectrum of Compound X15

¹H-NMR (400 MHZ, CDCl₃) δ (ppm): 5.87-5.69 (m, 2H), 5.29 (t, J=4.7 Hz, 1H), 5.15-4.88 (m, 4H), 3.63-3.59 (m, 6H), 3.07 (dd, J=6.0, 5.3 Hz, 2H), 2.23-1.99 (m, 6H), 1.78-1.06 (m, 55H), 0.88-0.80 (m, 6H), 0.80-0.73 (m, 2H), 0.11-0.11 (m, 12H).

### Synthesis of the compound 1-3D

1.10 g of a compound 1-3D was obtained in a manner similar to that for the synthesis of the compound 1-3A, except that a compound X15 (0.93 g) was used instead of the compound X7.

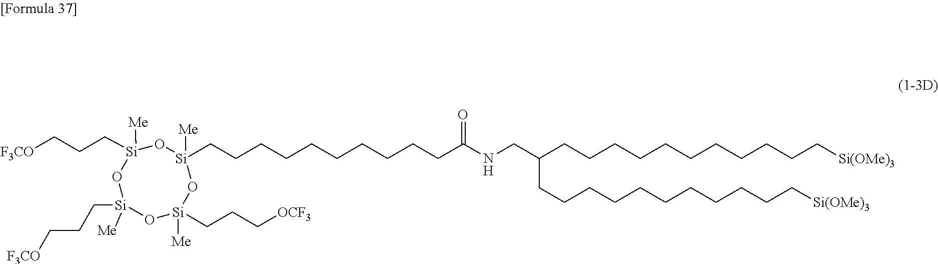

### NMR Spectrum of the Compound 1-3D

¹H-NMR (400 MHZ, CDCl₃) δ (ppm): 5.29 (t, J=4.7 Hz, 1H), 3.62-3.55 (m, 24H), 3.07 (dd, J=6.0, 5.3 Hz, 2H), 2.20 (t, J=8.4 Hz, 2H), 1.80-1.06 (m, 63H), 0.88-0.80 (m, 6H), 0.80-0.73 (m, 2H), 0.11-0.11 (m, 12H).

### Example 7

### Synthesis of Compound X16

0.84 g of a compound X16 was obtained in a manner similar to that for the synthesis of a compound X14, except that allyl (trifluoromethyl) sulfane (1.6 g) was used instead of the dichloromethane solution of 3,3,3-trifluoropropene.

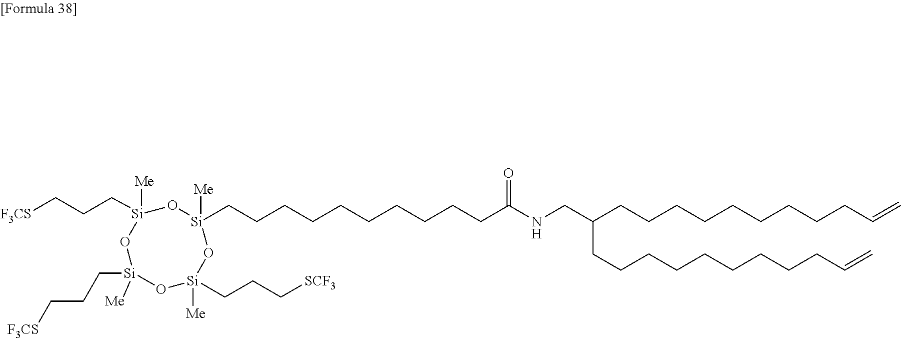

### NMR Spectrum of Compound X16

¹H-NMR (400 MHZ, CDCl₃) δ (ppm): 5.88-5.61 (m, 2H), 5.39 (t, J=4.7 Hz, 1H), 5.18-4.71 (m, 4H), 3.07 (t, J=5.3 Hz, 2H), 2.84-2.64 (m, 6H), 2.28-1.91 (m, 6H), 1.73-1.03 (m, 55H), 0.96-0.80 (m, 6H), 0.82-0.64 (m, 2H), 0.15-0.32 (m, 12H).

### Synthesis of the compound 1-3E

0.99 g of the compound 1-3E was obtained in a manner similar to that for the synthesis of the compound 1-3A, except that a compound X16 (0.84 g) was used instead of the compound X7.

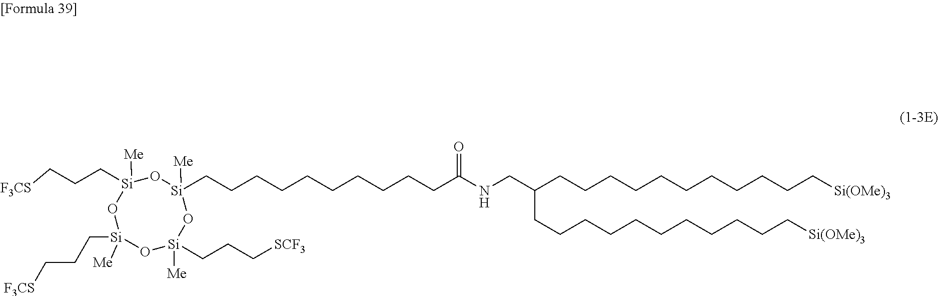

### NMR Spectrum of the Compound 1-3E

¹H-NMR (400 MHz, CDCl₃) δ (ppm): 5.39 (t, J=4.7 Hz, 1H), 3.58 (s, 18H), 3.07 (t, J=5.3 Hz, 2H), 2.80-2.66 (m, 6H), 2.20 (t, J=8.4 Hz, 2H), 1.76-1.05 (m, 63H), 0.93-0.82 (m, 6H), 0.80-0.61 (m, 6H), 0.14-0.07 (m, 12H).

### Example 8

### Synthesis of Compound X17

1.1 g of a compound X17 was obtained in a manner similar to that for the synthesis of the compound X14, except that N, N-bis(trifluoromethyl) propa-2-ene-1-amine (2.2 g) was used instead of the dichloromethane solution of 3, 3, 3-trifluoropropene.

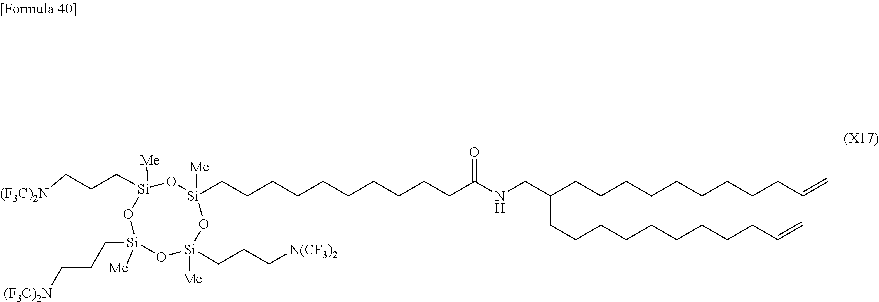

### NMR Spectrum of Compound X17

¹H-NMR (400 MHZ, CDCl₃) δ (ppm): 5.88-5.69 (m, 2H), 5.39 (t, J=4.7 Hz, 1H), 5.16-4.88 (m, 4H), 3.07 (dd, J=6.0, 5.3 Hz, 2H), 2.91-2.74 (m, 6H), 2.27-1.92 (m, 6H), 1.87-1.06 (m, 55H), 0.85-0.69 (m, 8H).

### Synthesis of the compound 1-3F

1.2 g of the compound 1-3 F was obtained in a manner similar to that for the synthesis of the compound 1-3A, except that a compound X17 (1.1 g) was used instead of the compound X7.

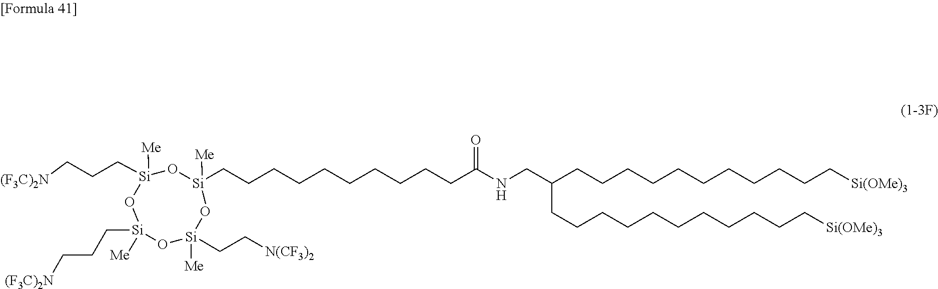

### NMR Spectrum of Compound 1-3F

¹H-NMR (400 MHZ, CDCl₃) δ (ppm): 5.39 (t, J=4.7 Hz, 1H), 3.58 (s, 18H), 3.07 (dd, J=6.0, 5.3 Hz, 2H), 2.88-2.75 (m, 6H), 2.20 (t, J=8.4 Hz, 2H), 1.83-1.04 (m, 63H), 0.86-0.71 (m, 8H), 0.70-0.58 (m, 4H), 0.13-−0.02 (m, 12H).

### Example 9

### Synthesis of 2-(pentafluoro-λ⁶-sulfanyl) acetaldehyde

2-(pentafluoro-λ⁶-sulfanyl) ethane-1-ol (50 g), 2,2, 6,6-tetramethylpiperidine 1-oxyl (0.46 g), potassium bromide (4.2 g), water (20 mL), and dichloromethane (338 g) were added in a solution of NaClO (1.6M, 300 mL) and sodium bicarbonate (10 g) at a room temperature, and the mixture was stirred for 20 minutes. After that, sodium hypochlorite (100 mL) was added and the mixture was further stirred for 15 minutes. By performing hexane extraction and distillation purification, 49 g of 2-(pentafluoro-λ⁶-sulfanyl) acetaldehyde (see below-shown formula) was obtained.

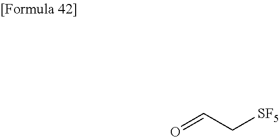

### NMR Spectrum of 2-(pentafluoro-26 sulfanyl) acetaldehyde

¹H-NMR (400 MHz, CDCl₃) δ (ppm): 9.60 (ddp, J=11.0, 7.1, 1.8 Hz, 1H), 4.01 (hd, J=20.1, 9.2 Hz, 2H).

### Synthesis of allylpentafluoro-λ⁶-sulfane

Methyltriphenylphosphonium bromide (78 g) was suspended in THF (100 mL) and cooled to −78° C. Then, an n-butyllithium hexane solution (1.6M, 330 mL) was added to the suspension. The temperature was raised to 0° C. After the stirring the mixture for 1 hour, the mixture was cooled again to −78° C. Then, a solution in which 2-(pentafluoro-λ⁶-sulfanyl) acetaldehyde (34 g) was dissolved in THF (900 mL) was added. After that, the mixture was stirred at 0° C. for 12 hours. An ammonium chloride aqueous solution was added, and extraction was performed with diethyl ether. 30 g of allylpentafluoro-λ⁶-sulfane (see below-shown formula) was obtained by, after washing the organic phase with a saturated saline solution, drying the washed organic phase with anhydrous sodium sulfate, and then performing distillation purification.

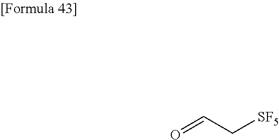

### NMR Spectrum of allylpentafluoro-λ⁶-sulfane

¹H-NMR (400 MHZ, CDCl₃) δ (ppm): 5.75-5.60 (m, 1H), 5.43-5.29 (m, 2H), 3.66 (qdt, J=20.0, 10.4, 1.5 Hz, 2H).

### Synthesis of Compound X18

Dichloromethane (20 g) and 2,4,6,8 tetramethylcyclotetrasiloxane (1.9 g) were added to a compound X6 (0.40 g). After the stirring the mixture, a toluene solution of a platinum/1,3-divinyl-1, 1, 3,3-tetramethyldisiloxane complex (platinum content: 3 mass %, 8.3 mg) was added, and the mixture was stirred at 25° C. for 2 hours. After removing the solvent and low-boiling components by evaporation, allylpentafluoro-λ⁶-sulfane (13 g) and a toluene solution of a platinum/1,3-divinyl-1, 1, 3, 3-tetramethyldisiloxane complex (platinum content: 3 mass %, 9.2 mg) were added, and the mixture was stirred at 25° C. for 2 hours. After removing the solvent and low-boiling components by evaporation, a compound X1 (2.3 g) and dichloromethane (20 g) were added, and the mixture was stirred at 25° C. for 4 hours.

0.85 g of a compound X18 was obtained by removing the solvent by evaporation, and then performing flash column chromatography using silica gel (developing solvent: hexane/ethyl acetate).

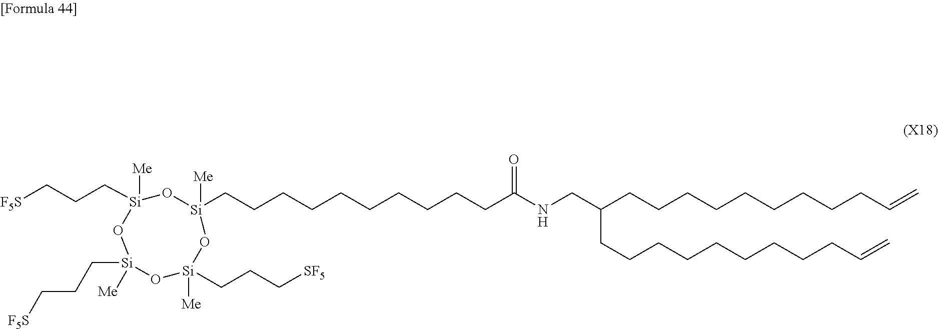

### NMR Spectrum of Compound X18

¹H-NMR (400 MHZ, CDCl₃) δ (ppm): 5.76 (ddt, J=17.0, 10.2, 6.7 Hz, 2H), 5.29 (t, J=4.7 Hz, 1H), 5.12-4.78 (m, 4H), 3.13 (t, J=5.9 Hz, 2H), 2.95 (m, 6H), 2.12 (t, 2H), 1.67-1.47 (m, 7H), 1.39-1.07 (m, 48H), 0.80 (m, 6H), 0.40 (m, 2H), 0.11-0.11 (m, 12H).

### Synthesis of the compound 1-3G

0.52 g of a compound 1-3G was obtained by adding dichloromethane (10 g), a compound X18 (0.50 g), a toluene solution of a platinum/1,3-divinyl-1, 1, 3, 3-tetramethyldisiloxane complex (platinum content: 3 mass %, 8.3 mg), aniline (2.6 mg), and trimethoxysilane (0.50 g), stirring the mixture at 40° C. for 2 hours, and then evaporating and removing the solvent under a reduced pressure.

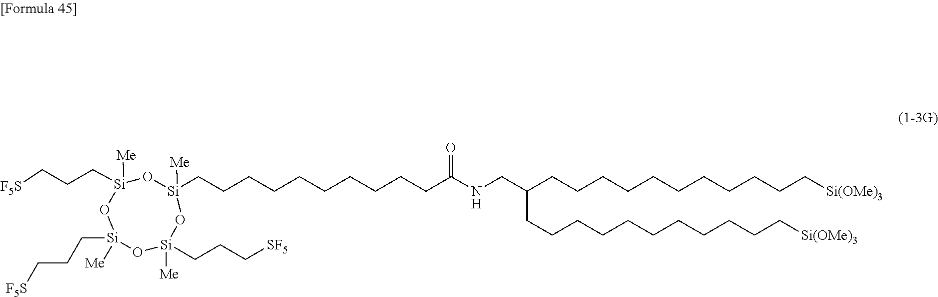

### NMR Spectrum of Compound 1-3G

¹H-NMR (400 MHZ, CDCl₃) δ (ppm): 5.29 (t, J=4.7 Hz, 1H), 3.51 (s, 18H), 3.12 (t, J=6.0 Hz, 2H), 2.95 (m, 6H), 2.12 (t, 2H), 1.66-1.46 (m, 7H), 1.19 (s, 56H), 0.80 (m, 6H), 0.68-0.31 (m, 6H), 0.11-0.11 (m, 12H).

### Example 10

### Synthesis of (2s, 3R, 4s, 5S)-2, 3, 4, 5, 6, 7, 8-heptafluorocuban-1-carboxylic acid

Ethyl acetate (30 g) and palladium-activated carbon (Pd5%, 1.0 g) were added to (2s, 3R, 4s, 5S)-2, 3, 4, 5, 6, 7, 8-heptafluorocuban-1-benzyl carboxylate (14 g), which was synthesized with reference to literature (Science, 2022, 377, 756-759), and the mixture was stirred at 25° C. for 2 hours under a hydrogen atmosphere. After that, celite filtration was performed, and the solvent and low-boiling components were removed by evaporation, and by doing so, 10 g of (2s, 3R, 4s, 5S)-2, 3, 4, 5, 6, 7, 8-heptafluorocuban-1-carboxylic acid was obtained.

### Synthesis of ((2s, 3R, 4s, 5S)-perfluorocuban-1-yl) methanol

A THF (100 mL) solution of (2s, 3R, 4s, 5S)-2, 3, 4, 5, 6, 7, 8-heptafluorocuban-1-carboxylic acid (10 g) was cooled to −15° C. under a nitrogen atmosphere, and a borane-THE solution (1M, 40 mL) was dropped. The temperature of the reaction mixture was restored to a room temperature, and the reaction mixture was stirred for 16 hours. 9.5 g of ((2s, 3R,4s, 5S)-perfluorocuban-1-yl) methanol (see the below-shown formula) was obtained by, after the reaction, quenching the mixture with methanol (50 mL), stirring the mixture for 30 minutes, removing the solvent and low-boiling components by evaporation, and performing flash column chromatography using silica gel (developing solvent: dichloromethane/methanol).

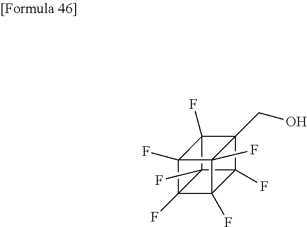 [SMILES: OCC12C3(F)C4(F)C5(F)C3(F)C1(F)C5(F)C42F]

### NMR Spectrum of ((2s,3R,4s,5S)-perfluorocuban-1-yl) methanol

¹H-NMR (400 MHz, CDCl₃) δ (ppm): 4.48 (qd, J=3.1, 1.6 Hz, 2H), 3.36 (t, J=1.6 Hz, 1H).

### Synthesis of (2R,3s,4S,5s)-1, 2, 3, 4, 5, 6, 7-heptafluoro-8-vinylcubane

7.5 g of (2R,3s,4S,5s)-1, 2, 3, 4, 5, 6, 7-heptafluoro-8-vinylcubane (see below-shown formula) was obtained in a manner similar to that for the above-described the “synthesis of 2-pentafluoro-λ⁶-sulfanyl) acetaldehyde” and the “synthesis of allylpentafluoro-λ⁶-sulfane”, except that ((2s, 3R, 4s, 5S)-perfluorocuban-1-yl) methanol was used instead of 2-(pentafluoro-λ⁶-sulfanyl) ethane-1-ol.

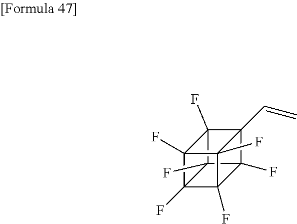 [SMILES: C=CC12C3(F)C4(F)C5(F)C3(F)C1(F)C5(F)C42F]

### NMR Spectrum of (2R,3s,4S,5s)-1, 2,3, 4, 5, 6, 7-heptafluoro-8-vinylcubane

¹H-NMR (400 MHZ, CDCl₃) δ (ppm): 6.37 (ddq, J=12.2, 7.1, 3.1 Hz, 1H), 5.41 (dd, J=12.3, 2.2 Hz, 1H), 5.31 (dd, J=7.0, 2.2 Hz, 1H).

### Synthesis of Compound 1-3H

0.3 g of a compound 1-3H was obtained in a manner similar to that for the synthesis of the compound 1-3A, except that (2R,3s,4S,5s)-1, 2, 3, 4, 5, 6, 7-heptafluoro-8-vinylcubane was used instead of the compound X7.

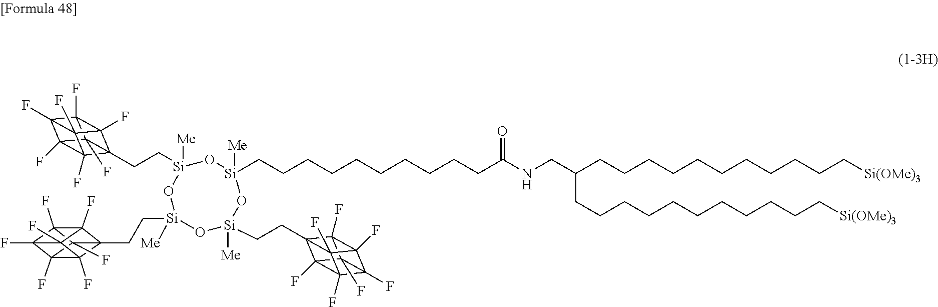

### NMR Spectrum of Compound 1-3H

¹H-NMR (400 MHZ, CDCl₃) δ (ppm): 5.29 (t, J=4.7 Hz, 1H), 3.51 (s, 18H), 3.12 (t, J=6.0 Hz, 2H), 2.54 (m, 6H), 2.12 (t, 2H), 1.66-1.46 (m, 5H), 1.19 (s, 56H), 0.80 (m, 6H), 0.68-0.31 (m, 6H), 0.11-0.11 (m, 12H).

### Example 11

### Synthesis of Compound X19

Dichloromethane (20 g) and 2,4,6-trimethylcyclotrisiloxane (2.0 g) were added to 3-(trifluoromethoxy) propa-1-ene (7.0 g). After stirring the mixture, a toluene solution of a platinum/1,3-divinyl-1, 1,3,3-tetramethyldisiloxane complex (platinum content: 3 mass %, 8.3 mg) was added, and the mixture was stirred at 25° C. for 2 hours. 5.9 g of a compound X19 was obtained by removing the solvent and low-boiling components by evaporation, and then performing flash column chromatography using silica gel (developing solvent: dichloromethane/ethyl acetate).

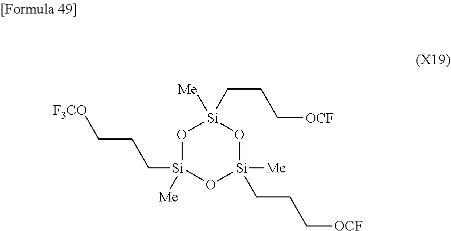

### NMR Spectrum of Compound X19

¹H-NMR (400 MHZ, CDCl₃) δ (ppm): 3.65-3.53 (m, 6H), 1.71 (tt, J=9.8, 8.3 Hz, 6H), 0.81 (t, J=8.2 Hz, 6H), 0.03 (s, 9H).

### Synthesis of Compound X20

Tetrahydrofuran (10 mL) was added in a three-necked flask under a nitrogen atmosphere, and an n-BuLi hexane solution (1.6M, 0.7 mL) was dropped at 0° C. A THF solution of a compound X19 (1.0M, 1.1 mL) was dropped. After the stirring the mixture for 5 minutes, a THE solution of the compound X19 (1.1M, 6.7 mL) was further slowly dropped over 10 minutes, and the mixture was stirred for 6 hours. After that, (2, 3,4, 5,6-pentafluorophenyl) 11-(chloro (dimethyl) silyl) undecanoate (0.75 g) was added. After the stirring the mixture for 1 hour, a compound X1 (1.7 g) was added, and the mixture was stirred for 1 hour. Hexane and ion-exchanged water were successively added to the reaction solution, and then the solution was separated and the organic layer was separated. 1.8 g of a compound X20 was obtained by evaporating and removing the solvent and low-boiling components under a reduced pressure, and then purifying it through flash column chromatography using silica gel (developing solvent: hexane/ethyl acetate). The average number of repetitions of the unit enclosed in parentheses in the formula, which was calculated from the NMR spectrum, was 21.

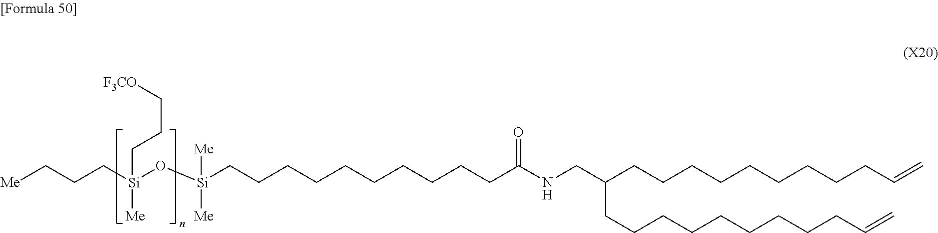

### NMR Spectrum of Compound X20

¹H-NMR (400 MHZ, CDCl₃) δ (ppm): 5.87-5.60 (m, 2H), 5.39 (t, J=4.7 Hz, 1H), 5.18-4.88 (m, 4H), 3.63-3.49 (m, 42H), 3.07 (dd, J=6.0, 5.3 Hz, 2H), 2.25-1.92 (m, 6H), 1.74-1.06 (m, 99H), 0.95 (t, J=7.1 Hz, 3H), 0.75 (t, J=8.4 Hz, 42H), 0.72-0.61 (m, 4H), 0.08-0.16 (m, 69H).

### Synthesis of Compound 1-2B

1.9 g of a compound 1-2B was obtained in a manner similar to that for the synthesis of the compound 1-3A, except that a compound X20 (1.8 g) was used instead of the compound X7. The average number of repetitions of the unit enclosed in parentheses in the formula, which was calculated from the NMR spectrum, was 21.

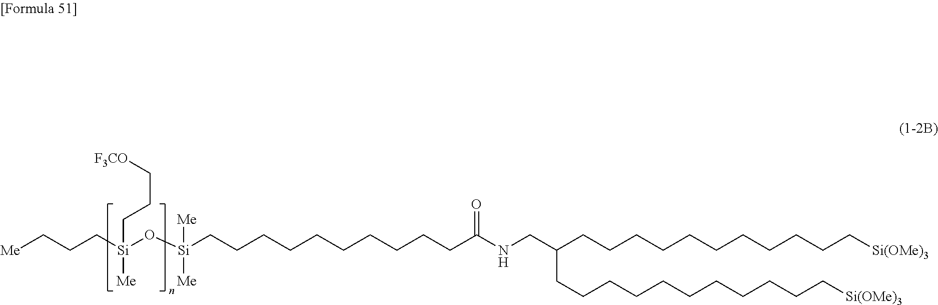

### NMR Spectrum of Compound 1-2B

¹H-NMR (400 MHZ, CDCl₃) δ (ppm): 5.39 (t, J=4.7 Hz, 1H), 3.61-3.55 (m, 60H), 3.07 (dd, J=6.0, 5.3 Hz, 2H), 2.20 (t, J=8.4 Hz, 2H), 1.77-1.06 (m, 103H), 0.95 (t, J=7.1 Hz, 3H), 0.75 (t, J=8.4 Hz, 42H), 0.73-0.62 (m, 8H), −0.06 (d, J=72.7 Hz, 69H).

### Example 12

### Synthesis of Compound X21

6.5 g of a compound X21 was obtained in a manner similar to that for the synthesis of the compound X19, except that allyl (trifluoromethyl) sulfane (7.9 g) was used instead of 3-(trifluoromethoxy) propa-1-ene.

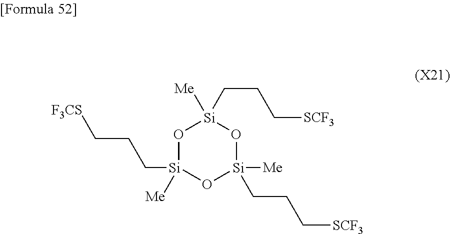

### NMR Spectrum of Compound X21

¹H-NMR (400 MHZ, CDCl₃) δ (ppm): 2.83-2.68 (m, 6H), 1.75-1.59 (m, 6H), 0.85 (t, J=7.5 Hz, 6H), 0.03 (s, 9H).

### Synthesis of Compound X22

1.8 g of a compound X22 was obtained in a manner similar to that for the synthesis of the compound X19, except that a THF solution of a compound X21 (1.0M, 7.8 mL) was used instead of the compound X19. The average number of repetitions of the unit enclosed in parentheses in the formula, which was calculated from the NMR spectrum, was 24.

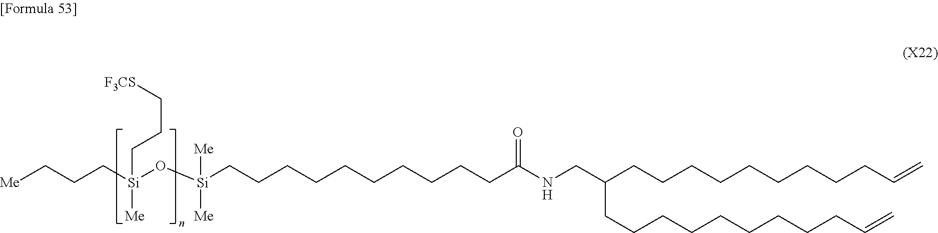

### NMR Spectrum of Compound X22

¹H-NMR (400 MHZ, CDCl₃) δ (ppm): 5.92-5.69 (m, 2H), 5.39 (t, J=4.7 Hz, 1H), 5.17-4.85 (m, 4H), 3.07 (dd, J=6.0, 5.3 Hz, 2H), 2.78-2.64 (m, 48H), 2.29-1.91 (m, 6H), 1.76-1.06 (m, 101H), 0.95 (t, J=7.1 Hz, 3H), 0.75 (t, J=7.7 Hz, 48H), 0.71-0.59 (m, 4H), 0.08-−0.26 (m, 78H).

### Synthesis of Compound 1-2C

2.1 g of a compound 1-2C was obtained in a manner similar to that for the synthesis of the compound 1-3A, except that a compound X22 (2.1 g) was used instead of the compound X7. The average number of repetitions of the unit enclosed in parentheses in the formula, which was calculated from the NMR spectrum, was 24.

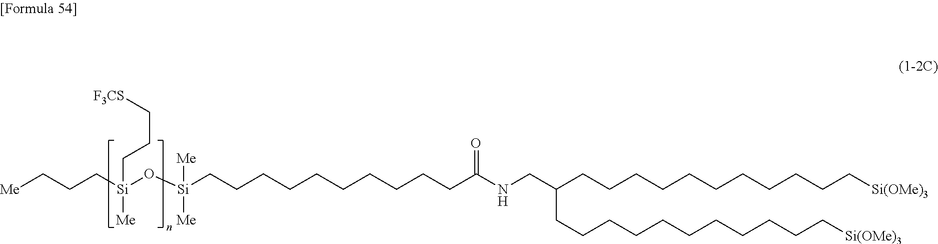

### NMR Spectrum of Compound 1-2C

¹H-NMR (400 MHZ, CDCl₃) δ (ppm): 5.39 (t, J=4.7 Hz, 1H), 3.58 (s, 18H), 3.07 (dd, J=6.0, 5.3 Hz, 2H), 2.78-2.65 (m, 48H), 2.20 (t, J=8.4 Hz, 2H), 1.71-1.05 (m, 109H), 0.95 (t, J=7.1 Hz, 3H), 0.75 (t, J=7.7 Hz, 48H), 0.72-0.59 (m, 8H), 0.11-0.22 (m, 78H).

### Example 13

### Synthesis of Compound X23

8.0 g of a compound X23 was obtained in a manner similar to that for the synthesis of the compound X19, except that N,N-bis(trifluoromethyl) propa-2-ene-1-amine (11 g) was used instead of 3-(trifluoromethoxy) propa-1-ene.

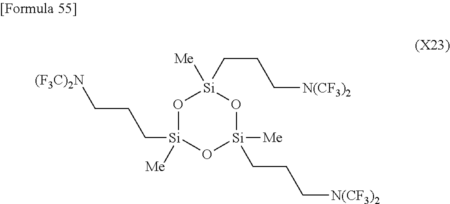

### NMR Spectrum of Compound X23

¹H-NMR (400 MHZ, CDCl₃) δ (ppm): 2.90-2.75 (m, 6H), 1.76 (tt, J=12.7, 7.7 Hz, 6H), 0.78 (t, J=7.7 Hz, 6H), 0.03 (s, 9H).

### Synthesis of Compound X24

2.6 g of a compound X24 was obtained in a manner similar to that for the synthesis of the compound X20, except that a THF solution of a compound X23 (1.0M, 7.8 mL) was used instead of the compound X19. The average number of repetitions of the unit enclosed in parentheses in the formula, which was calculated from the NMR spectrum, was 22.

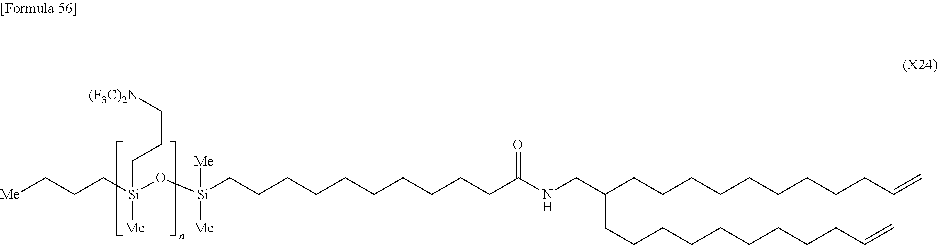

### NMR Spectrum of Compound X24

¹H-NMR (400 MHZ, CDCl₃) δ (ppm): 5.89-5.67 (m, 2H), 5.39 (t, J=4.7 Hz, 1H), 5.17-4.85 (m, 4H), 3.07 (dd, J=6.0, 5.3 Hz, 2H), 2.91-2.72 (m, 44H), 2.30-1.96 (m, 6H), 1.83-1.02 (m, 101H), 0.95 (t, J=7.1 Hz, 3H), 0.82-0.59 (m, 48H), 0.16-0.27 (m, 72H).

### Synthesis of Compound 1-2D

2.7 g of a compound 1-2D was obtained in a manner similar to that for the synthesis of the compound 1-3A, except that a compound X24 (2.6 g) was used instead of the compound X7. The average number of repetitions of the unit enclosed in parentheses in the formula, which was calculated from the NMR spectrum, was 22.

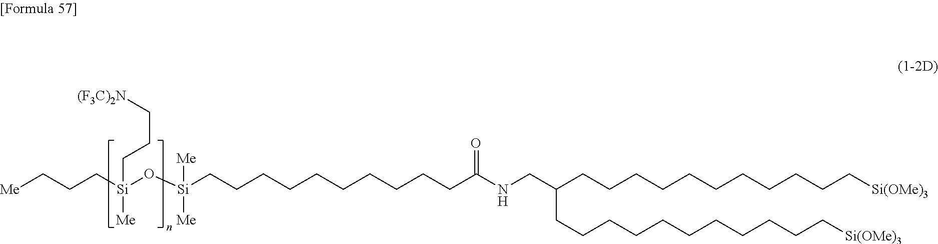

### NMR Spectrum of Compound 1-2D

¹H-NMR (400 MHZ, CDCl₃) δ (ppm): 5.39 (t, J=4.7 Hz, 1H), 3.58 (s, 18H), 3.07 (dd, J=6.0, 5.3 Hz, 2H), 2.89-2.74 (m, 44H), 2.20 (t, J=8.4 Hz, 2H), 1.77-1.05 (m, 105H), 0.95 (t, J=7.1 Hz, 3H), 0.74 (t, J=7.9 Hz, 2H), 0.70-0.61 (m, 8H), 0.07-−0.23 (m, 72H).

### Example 14

### Synthesis of Compound X25

Dichloromethane (20 g) and 2,4,6-trimethylcyclotrisiloxane (2.0 g) were added to allylpentafluoro-λ⁶-sulfane (9.3 g). After stirring the mixture, a toluene solution of a platinum/1,3-divinyl-1, 1, 3, 3-tetramethyldisiloxane complex (platinum content: 3 mass %, 8.3 mg) was added, and the mixture was stirred at 25° C. for 2 hours. 7.7 g of a compound X25 was obtained by removing the solvent and low-boiling components by evaporation, and then performing flash column chromatography using silica gel (developing solvent: dichloromethane/ethyl acetate).

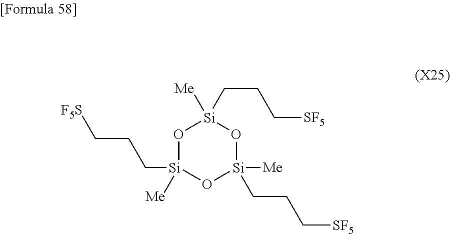

### NMR Spectrum of Compound X25

¹H-NMR (400 MHZ, CDCl₃) δ (ppm): 2.96 (ht, J=20.3, 12.0 Hz, 6H), 1.70-1.57 (m, 12H), 0.99 (t, J=9.2 Hz, 9H).

### Synthesis of Compound X26

THF (10 mL) was added in a three-necked flask under a nitrogen atmosphere, and an n-BuLi hexane solution (1.6M, 0.7 mL) was dropped at 0° C. A THF solution of a compound X25 (1.0M, 1.1 mL) was dropped. After the stirring the mixture for 5 minutes, a THF solution of the compound X25 (1.1M, 6.7 mL) was further slowly dropped over 10 minutes, and the mixture was stirred for 6 hours. After that, (2,3,4,5,6 pentafluorophenyl) 11-(chloro (dimethyl) silyl) undecanoate (0.75 g) was added. After the stirring the mixture for 1 hour, a compound X1 (1.7 g) was added, and the mixture was stirred for 1 hour. Hexane and ion-exchanged water were successively added to the reaction solution, and then the solution was separated and the organic layer was separated. 2.2 g of a compound X26 was obtained by evaporating and removing the solvent and low-boiling components under a reduced pressure, and then purifying it through flash column chromatography using silica gel (developing solvent: hexane/ethyl acetate). The average number of repetitions of the unit enclosed in parentheses in the formula, which was calculated from the NMR spectrum, was 21.

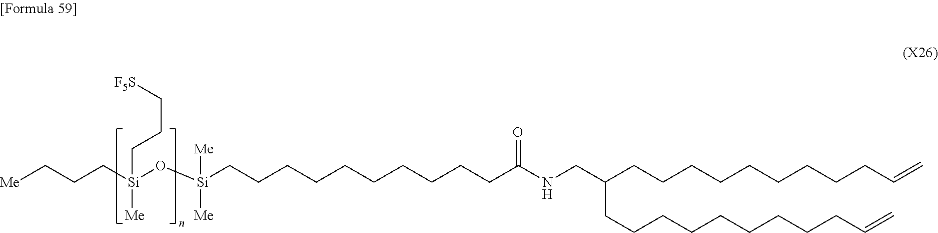

### NMR Spectrum of Compound X26

¹H-NMR (400 MHZ, CDCl₃) δ 5.81 (ddt, J=16.9, 10.1, 6.6 Hz, 2H), 5.31 (s, 1H), 5.05-4.83 (m, 4H), 3.18 (t, J=6.0 Hz, 2H), 2.96 (m, 42H), 2.16 (t, J=7.6 Hz, 2H), 2.03 (m, 57H), 1.50-1.18 (m, 42H), 0.88 (t, J=6.9 Hz, 3H), 0.83-0.70 (m, 42H), 0.63-0.51 (m, 4H), 0.12 (m, 69H).

### Synthesis of Compound 1-2E

2.1 g of a compound 1-2E was obtained from the compound X26 (2.0 g) in a manner similar to that for the compound 1-3A. The average number of repetitions of the unit enclosed in parentheses in the formula, which was calculated from the NMR spectrum, was 21.

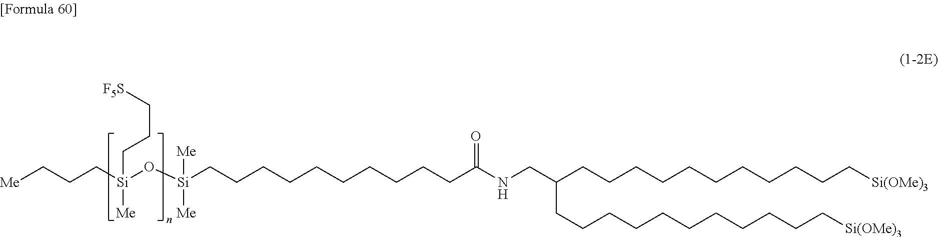

### NMR Spectrum of Compound 1-2E

¹H-NMR (400 MHZ, CDCl₃) 1H NMR (400 MHZ, CDCl₃) δ 5.31 (s, 1H), 3.57 (s, 18H), 3.18 (t, J=6.0 Hz, 2H), 2.96 (m, 42H), 2.15 (t, J=7.6 Hz, 2H), 2.02 (m, 55H), 1.62 (d, J=11.2 Hz, 2H), 1.27 (m, 42H), 0.89 (t, J=6.9 Hz, 3H), 0.83-0.47 (m, 50H), 0.40-0.18 (m, 69H).

### Example 15

### Synthesis of Compound X27

Dichloromethane (20 g) and 2,4,6-trimethylcyclotrisiloxane (2.0 g) were added to (2R,3s,4S,5s)-1, 2, 3,4, 5, 6, 7-heptafluoro-8-vinylcubane (14 g). After stirring the mixture, a toluene solution of a platinum/1,3-divinyl-1, 1,3,3-tetramethyldisiloxane complex (platinum content: 3 mass %, 8.3 mg) was added, and the mixture was stirred at 25° C. for 2 hours. 12 g of a compound X27 was obtained by removing the solvent and low-boiling components by evaporation, and then performing flash column chromatography using silica gel (developing solvent: dichloromethane/ethyl acetate).

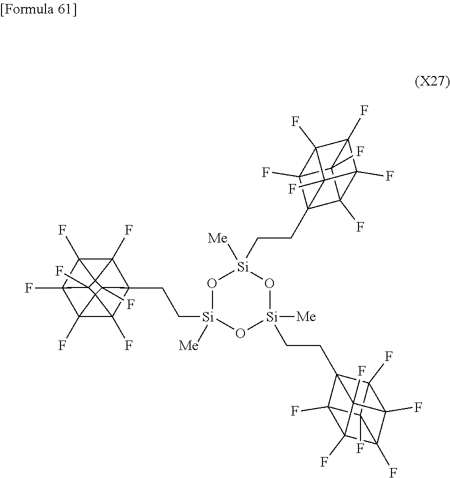 [SMILES: C[Si]1(CCC23C4(F)C5(F)C6(F)C4(F)C2(F)C6(F)C53F)O[Si](C)(CCC23C4(F)C5(F)C6(F)C4(F)C2(F)C6(F)C53F)O[Si](C)(CCC23C4(F)C5(F)C6(F)C7(F)C2(F)C72C6(F)C54C32F)O1]

### NMR Spectrum of Compound X27

¹H-NMR (400 MHZ, CDCl₃) δ (ppm): 2.44 (tq, J=8.4, 3.1 Hz, 6H), 1.20 (t, J=8.4 Hz, 6H), 0.06 (s, 9H).

### Synthesis of Compound X28

THF (10 mL) was added in a three-necked flask under a nitrogen atmosphere, and an n-BuLi hexane solution (1.6M, 0.7 mL) was dropped at 0° C. A THF solution of a compound X27 (1.0M, 1.1 mL) was dropped. After the stirring the mixture for 5 minutes, a THF solution of the compound X27 (1.1M, 6.7 mL) was further slowly dropped over 10 minutes, and the mixture was stirred for 6 hours. After that, (2, 3, 4, 5, 6 pentafluorophenyl) 11-(chloro (dimethyl) silyl) undecanoate (0.75 g) was added. After the stirring the mixture for 1 hour, a compound X1 (1.7 g) was added, and the mixture was stirred for 1 hour. Hexane and ion-exchanged water were successively added to the reaction solution, and then the solution was separated and the organic layer was separated. 2.5 g of a compound X28 was obtained by evaporating and removing the solvent and low-boiling components under a reduced pressure, and then performing flash column chromatography using silica gel (developing solvent: hexane/ethyl acetate). The average number of repetitions of the unit enclosed in parentheses in the formula, which was calculated from the NMR spectrum, was 21.

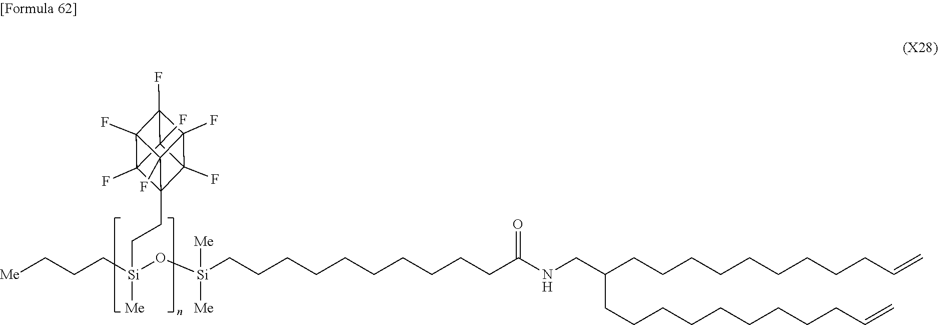

### NMR Spectrum of Compound X28

1H NMR (400 MHZ, CDCl₃) δ 5.81 (ddt, J=16.9, 10.1, 6.6 Hz, 2H), 5.31 (s, 1H), 5.05-4.83 (m, 4H), 3.18 (t, J=6.0 Hz, 2H), 2.16 (t, J=7.6 Hz, 2H), 2.03 (qt, J=10.2, 4.9 Hz, 42H), 1.61 (d, J=7.4 Hz, 2H), 1.50-1.18 (m, 55H), 0.88 (t, J=6.9 Hz, 3H), 0.83-0.70 (m, 42H), 0.63-0.51 (m, 4H), 0.12 (m, 69H).

### Synthesis of Compound 1-2F

1.9 g of a compound 1-2 F was obtained in a manner similar to that for the synthesis of the compound 1-3A, except that a compound X28 (2.0 g) was used instead of the compound X7. The average number of repetitions of the unit enclosed in parentheses in the formula, which was calculated from the NMR spectrum, was 21.

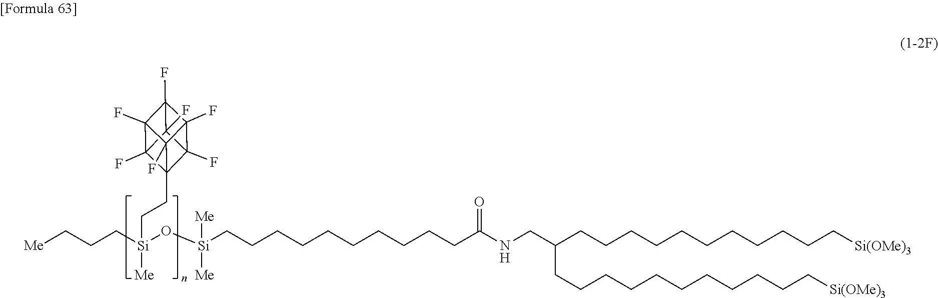

### NMR Spectrum of Compound 1-2F

¹H NMR (400 MHZ, CDCl₃) δ 5.31 (s, 1H), 3.57 (s, 18H), 3.18 (t, J=6.0 Hz, 2H), 2.15 (t, J=7.6 Hz, 2H), 2.02 (dq, J=20.1, 10.0 Hz, 42H), 1.62 (d, J=11.2 Hz, 2H), 1.27 (d, J=13.0 Hz, 59H), 0.89 (t, J=6.9 Hz, 3H), 0.83-0.47 (m, 50H), 0.40-0.18 (m, 69H).

### Example 16

In this specification, N-octadecyltrimethoxysilane described in International Patent Publication No. WO2008/016029 was referred to as a compound C1-1.

### [Manufacture of Article]

30 g of silicon oxide was placed as a vapor-deposition source on a copper hearth in a vacuum vapor-deposition apparatus (VTR-350M manufactured by ULVAC, Inc.). A glass substrate was placed in the vacuum vapor-deposition apparatus, and the inside of the vacuum vapor-deposition apparatus was evacuated to a pressure of 5×10⁻³ Pa or lower. A substrate with a silicon oxide layer having a thickness of about 20 nm was prepared by heating the above-described hearth to about 2,000° C., and vapor-depositing silicon oxide on the surface of the substrate in a vacuum.

The substrate with the silicon oxide layer was placed on a sample stage of a spray coater (API-90RS manufactured by Apeiros Co, Ltd.) in such a manner that the silicon oxide layer face upward. Next, for each of the above-described examples, 13 g of a heptane solution containing 0.2 mass % of the compound obtained in the example was charged into a syringe in a spray coater, and spray-coated at an atomization pressure of 130 kPa, a distance of 50 mm between the nozzle and the sample surface, and a scanning speed of 300 mm/see (wet coating method). After that, the substrate with the silicon oxide layer, of which the surface had been coated with the compound, was heat-treated at 140° C. for 30 minutes, and by doing so, an evaluation sample (article), in which the substrate, the silicon oxide layer, and the surface layer had been laminated in this order, was obtained.

### Evaluation

The below-shown evaluations were made by using the obtained articles. The results of the evaluation tests are shown in Table 427.

### <Water Repellency>

About 2 μL of distilled water was dropped on the surface layer of the article, and the initial water contact angle was measured by using a contact angle measuring apparatus (Product Name: DM-500, manufactured by Kyowa Interface Science Co., Ltd.). Measurements were made at five points on the surface layer, and their average value was calculated. Then, the water repellency of the surface layer was evaluated based on the below-shown criteria. Note that a 2θ method was used for the calculation of water contact angles.
A: Average water contact angle is larger than 100 degrees
B: Average water contact angle is 80 to 100 degrees
C: Average water contact angle is smaller than 80 degrees

### <Oil Repellency>

About 2 μL of oleic acid was dropped on the surface layer of the article, and the initial oil contact angle (oleic-acid contact angle) was measured by using a contact angle measuring apparatus (Product Name: DM-500, manufactured by Kyowa Interface Science Co., Ltd.). Measurements were made at five points on the surface layer, and their average value was calculated. Then, the oil repellency of the surface layer was evaluated based on the below-shown criteria. Note that a 2θ method was used for the calculation of oil contact angles.
A: Average oil contact angle is larger than 55 degrees
B: Average oil contact angle is 40 to 55 degrees
C: Average oil contact angle is smaller than 40 degrees

TABLE 427

Evaluation Result

| | Type of | Water | Oil |
|---|---|---|---|
| | Compound | Repellency | Repellency |
| Example 1 | 1-2A | B | A |
| Example 5 | 1-3C | B | A |
| Example 6 | 1-3D | B | A |
| Example 7 | 1-3E | B | A |
| Example 8 | 1-3F | B | A |
| Example 9 | 1-3G | B | A |
| Example 10 | 1-3H | B | A |
| Example 11 | 1-2B | B | A |
| Example 12 | 1-2C | B | A |
| Example 13 | 1-2D | B | A |
| Example 14 | 1-2E | B | A |
| Example 15 | 1-2F | B | A |
| Example 16 | C1-1 | A | C |

As shown in Table 427, it was confirmed that each of the compounds obtained in Examples 1 to 15 can form a surface layer excellent in oil repellency.

### INDUSTRIAL APPLICABILITY

Articles including a surface layer containing the compound 1 are useful as, for example, optical articles, touch panels, antireflective films, antireflective glass, SiO₂-treated glass, tempered glass, sapphire glass, quartz substrates, and mold metals, which are used as parts of components of the below-shown products.

Products: car navigation, cellular phones, digital cameras, digital video cameras, personal digital assistants (PDA), portable audio players, car audio, game apparatuses, eyeglass lenses, camera lenses, lens filters, sunglasses, medical apparatuses (such as stomach cameras), copiers, personal computers (PCs), liquid crystal displays, organic EL displays, plasma displays, touch panel displays, protective films, antireflective films, antireflective glass, nanoimprint templates, molds, and the like.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A compound represented by a below-shown Formula (1), 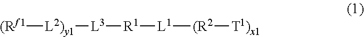
where
R^{f1} is a fluorine-containing group selected from the group consisting of a perfluoroalkyl group, —C(X¹⁰)F₂, —C(X¹⁰)₂F, —SF₅, —OCF₃, —SCF₃, a fluorovinyl group, a fluoroethynyl group, —NX¹¹X¹², a monovalent cyclic hydrocarbon group containing a fluorine atom, and a monovalent heterocyclic group containing a fluorine atom; X¹⁰ is H, Cl, Br, or I; X¹¹ is a fluoroalkyl group; and X¹² is an alkyl group or a fluoroalkyl group,
L² is a single bond or a divalent linking group,
L³ is an organopolysiloxane residue having a valence of 1+y1,
R¹ is a single bond, a fluoroalkylene group having a carbon number of 1 to 20, an alkylene group having a carbon number of 1 to 20, or an alkylene group containing an etheric oxygen atom and having a carbon number of 1 to 20,
L¹ is a single bond or a group having a valence of 1+x1,
R² is an alkylene group or an alkylene group containing an etheric oxygen atom,
T¹ is a reactive group,
y1 is an integer of 1 or greater,
x1 is an integer of 1 to 10, and
when there are a plurality of R^{f1}, L², R², T¹, or X¹⁰, the plurality of R^{f1}, L², R², T¹, or X¹⁰ may be the same as each other or different from each other.

2. The compound according to claim 1, wherein the compound represented by the above-shown Formula (1) is a compound represented by a below-shown Formula (1-1),
R^{f1}-L²-SiR¹¹R¹²—O—(SiR¹³R¹⁴—O)_{z11}—SiR¹⁵R¹⁶—R¹-L¹-(R²-T¹)ₓ₁ (1-1)
where
R¹¹ and R¹² are each independently an alkyl group or R^{f1}-L²-,
R¹³, R¹⁴, R¹⁵, and R¹⁶ are each independently an alkyl group,
R^{f1}, L², R¹, L¹, R², T¹, and x1 are synonymous with R^{f1}, L², R¹, L¹, R², T¹, and x1, respectively, in Formula (1),
z11 is an integer of 1 or greater, and
when there are a plurality of R¹³, R¹⁴, R², or T¹, the plurality of R¹³, R¹⁴, R², or T¹ may be the same as each other or different from each other.

3. The compound according to claim 1, wherein the compound represented by the above-shown Formula (1) is a compound represented by a below-shown Formula (1-2),
SiR²¹R²²R²³—O—(SiR²⁴R²⁵—O)_{z21}—(SiR²⁶R²⁷—O)_{z22}—SiR²⁸R²⁹—R¹-L¹-(R²-T¹)ₓ₁ (1-2)
where
R²¹, R²², and R²³ are each independently an alkyl group or R^{f1}-L²-,
R²⁴ is R^{f1}-L²-,
R²⁵ is an alkyl group or R^{f1}-L²-,
R²⁶ and R²⁷ are each independently an alkyl group,
R²⁸ and R²⁹ are each independently an alkyl group or R^{f1}-L²-;
and R^{f1}, L², R¹, L¹, R², T¹, and x1 are synonymous with R^{f1}, L², R¹, L¹, R², T¹, and x1, respectively, in Formula (1),
z21 is an integer of 1 or greater,
z22 is an integer of 0 or greater, and
when there are a plurality of R²⁴, R²⁵, R²⁶, R²⁷, R², or T¹, the plurality of R²⁴, R²⁵, R²⁶, R²⁷, R², or T¹ may be the same as each other or different from each other.

4. The compound according to claim 1, wherein the compound represented by the above-shown Formula (1) is a compound represented by a below-shown Formula (1-3), 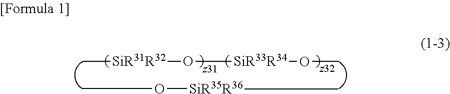
where
R³¹ is R^{f1}-L²-,
R³² is an alkyl group or R^{f1}-L²-,
R³³ and R³⁴ are each independently an alkyl group,
R³⁵ is —R¹-L¹-(R²-T¹)ₓ₁,
R³⁶ is an alkyl group,
R^{f1}, L², R¹, L¹, R², T¹, and x1 are synonymous with R^{f1}, L², R¹, L¹, R², T¹, and x1, respectively, in Formula (1),
z31 is an integer of 1 or greater,
z32 is an integer of 0 or greater,
a sum total of z31 and z32 is an integer of 2 or greater, and
when there are a plurality of R³¹, R³², R³³, R³⁴, R² or T¹, the plurality of R³¹, R³², R³³, R³⁴, R² or T¹ may be the same as each other or different from each other.

5. The compound according to claim 1, wherein
the aforementioned T¹ is one of —Ar, —SR¹⁰, —NOR¹⁰, —C(═O)R¹⁰, —N(R¹⁰)₂, —N+(R¹⁰)₃X³, —C≡N, —C(═NR¹⁰)—R¹⁰, —N+≡N, —N═NR¹⁰, —C(═O)OR¹⁰, —C(═O)OX², —C(═O)X⁴, —C(═O)OC(═O)R¹⁰, —SO₂R¹⁰, —SO₃H, —SO₃X², —O—P(═O)(—OR¹⁰)₂, —O—P(═O)(—OR¹⁰) (—OX²), —N═C═O, —SiR^{a1}_{z1}R^{a11}_{3-z1}, —C(R¹⁰)═C(R¹⁰)₂, —C≡C(R¹⁰), —C(═O)N(R¹⁰)₂, —N(R¹⁰)C(═O)R¹⁰, —Si(R¹⁰)₂—O—Si(R¹⁰)₃, —NH—C(═O)R¹⁰, —C(═O)NHR¹⁰, —I, and 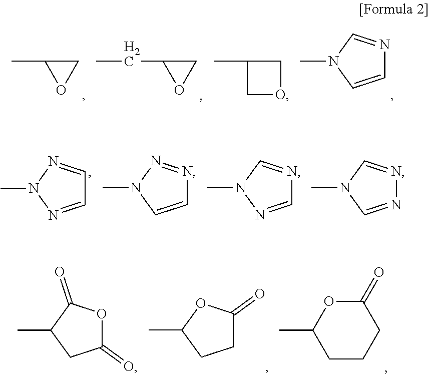
where
R¹⁰ is a hydrogen atom, an alkyl group having a carbon number of 1 to 6, which may have a substituent, a fluoroalkyl group having a carbon number of 1 to 6, which may have a substituent, or an aryl group which may have a substituent,
Ar is an aryl group which may have a substituent,
X² is an alkali metal ion or an ammonium ion,
X³ is a halide ion,
X⁴ is a halogen atom,
R^{a1} is a hydrolyzable group or a hydroxyl group,
R^{a11} is a hydrocarbon group,
z1 is an integer of 1 to 3, and
when there are a plurality of R¹⁰, R^{a1}, or R^{a11}, the plurality of R¹⁰, R^{a1}, or R^{a11} may be the same as each other or different from each other.

6. The compound according to claim 5, wherein T¹ is —SiR^{a1}_{z1}R^{a11}_{3-z1}.

7. The compound according to claim 1, wherein the monovalent cyclic hydrocarbon group containing a fluorine atom is a group represented by a below-shown Formula (g-1), a below-shown Formula (g-2), a below-shown Formula (g-3), or a below-shown Formula (g-4), 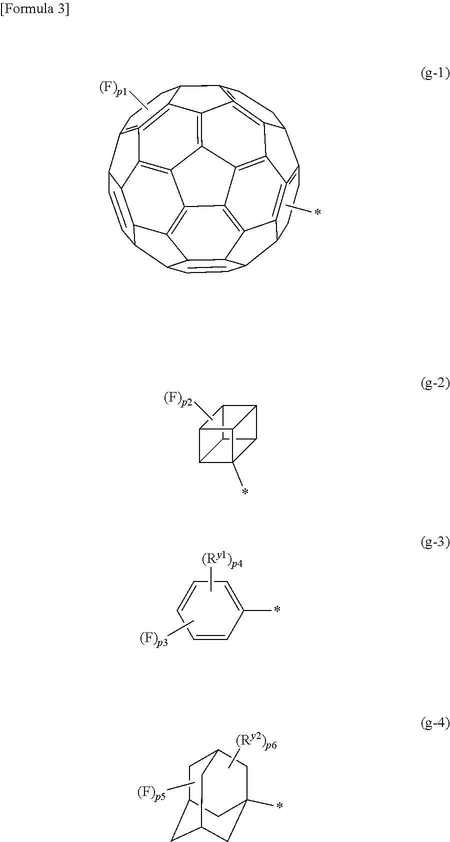
where
p1 is an integer of 1 or greater,
p2 is an integer of 1 or greater,
R^{y1} is a monovalent substituent; when R^{y1} contains a fluorine atom, each of p3 and p4 is an integer of 0 or greater, and p3+p4 is an integer of 1 or greater; and when R^{y1} does not contain a fluorine atom, p3 is an integer of 1 or greater, and p4 is an integer of 0 or greater,
R^{y2} is a monovalent substituent; when R^{y2} contains a fluorine atom, each of p5 and p6 is an integer of 0 or greater, and p5+p6 is an integer of 1 or greater; and when R^{y2} does not contain a fluorine atom, p5 is an integer of 1 or greater, and p6 is an integer of 0 or greater, and
* indicates a position of a bond with L².

8. The compound according to claim 7, wherein
the monovalent substituents in R^{y1} and R^{y2} are each independently a halogen atom other than a fluorine atom, an alkyl group, which may have an etheric oxygen atom between carbon atoms, an alkenyl group, an alkoxy group, a perfluoroalkyl group, —C(X²⁰)F₂, —C(X²⁰)₂F, —SF₅, —OCF₃, —SCF₃, a fluorovinyl group, a fluoroethynyl group, or —NX²¹X²², and
X²⁰ is H, Cl, Br, or I; when there are a plurality of X²⁰, the plurality of X²⁰ may be the same as each other or different from each other; X²¹ is a fluoroalkyl group; and X²² is an alkyl group or a fluoroalkyl group.

9. A surface treatment agent containing a compound according to claim 1.

10. The surface treatment agent according to claim 9, further containing a liquid medium.

11. The surface treatment agent according to claim 9, wherein the surface treatment agent is an antifouling coating agent or a waterproof coating agent.

12. An article comprising, on a surface of its substrate, a surface layer formed by using a compound according to claim 1.

13. The article according to claim 12, comprising the surface layer on a surface of a member constituting a surface of a touch panel which a finger touches.

14. The article according to claim 12, wherein the article is an optical member.

15. A method for manufacturing an article, wherein a surface layer is formed by a dry coating method by using a surface treatment agent according to claim 9.

16. A method for manufacturing an article, wherein a surface layer is formed by a wet coating method by using a surface treatment agent according to claim 10.
